(19) United States
(12) Patent Application Publication
(10) Pub. No.: US 2025/0190966 A1
(43) Pub. Date: Jun. 12, 2025

(54) Blockchain Synchronization and Point-of-Sale Integration Systems

(71) Applicant: Luis Eduardo Gutierrez-Sheris, Glen Rock, NJ (US)

(72) Inventor: Luis Eduardo Gutierrez-Sheris, Glen Rock, NJ (US)

(21) Appl. No.: 18/974,751

(22) Filed: Dec. 9, 2024

Related U.S. Application Data
(63) Continuation-in-part of application No. PCT/US2024/059094, filed on Dec. 8, 2024.
(63) Continuation-in-part of application No. 18/973,091, filed on Dec. 8, 2024.
(60) Provisional application No. 63/608,018, filed on Dec. 8, 2023.
(60) Provisional application No. 63/608,018, filed on Dec. 8, 2023.
(60) Provisional application No. 63/608,018, filed on Dec. 8, 2023.

(51) Int. Cl. G06Q 20/20; G06Q 20/06; G06Q 20/32

(52) U.S. Cl. CPC G06Q 20/204; G06Q 20/06; G06Q 20/3276

(57) ABSTRACT

Blockchain synchronization and point-of-sale integration systems are provided in a packet-switched computer network. The POS interfaces through the network with a consumer smartphone and a blockchain validation device. The POS shares a session identifier with the blockchain validation device by transmitting a graphic encoding of a payment request and the session identifier to the smartphone. The camera of the smartphone is configured with an image of the graphical encoding. A payment instruction is encoded to conform to the payment request including the session identifier and is transmitted to the blockchain validation device. The blockchain validation device performs a verification of the correctness and authenticity of the payment instruction encoded in the data record. The POS device receives a confirmation that the correctness and authenticity of the payment instruction encoded in the data record to confirm it has been verified.

### RELATED APPLICATION

This application claims the benefit of U.S. Provisional Application No. 63/608,018, filed on Dec. 8, 2023; and is a continuation-in-part of PCT Application No. PCT/US2024/059094, filed Dec. 8, 2024; which claims the benefit of U.S. Provisional Application No. 63/608,018, filed on Dec. 8, 2023. This application is also a continuation-in-part of U.S. application Ser. No. 18/973,091, filed on Dec. 8, 2024; which claims the benefit of U.S. Provisional Application No. 63/608,018, filed on Dec. 8, 2023. The entire teachings of these applications and appendices filed therewith are incorporated herein by reference.

### BACKGROUND

A conventional “point of sale (POS) system” may include a combination of hardware and software that businesses use to process transactions at the time of purchase. Point-of-Sale (POS) systems often suffer from data breaches due to malware infections, unauthorized access to sensitive customer information like credit card details, potential for fraudulent transactions, system vulnerabilities that can be exploited by hackers, device theft, and lack of proper encryption, especially when dealing with mobile POS systems, which can further expose data to risks.

### SUMMARY

Blockchain systems can provide increased security and transparency by improving the traceability of data across a business network, such as a point-of-sale (POS) system. While attempts have been made to ingrate blockchain systems with POS systems, they tend to face challenges including: scalability issues, high implementation costs, user adoption hurdles, regulatory uncertainty, potential for network congestion, limited interoperability between different blockchains, lack of ease of use for general consumers and the business community, and concerns about customer education regarding cryptocurrency payments, which can hinder widespread adoption in retail environments.

In some example embodiments, a blockchain point-of-sale system may be provided that can addresses challenges noted above, while offering potential benefits like robust security, transparency, and scalability. Blockchain synchronization and point-of-sale integration systems may be provided. In one example implementation, a point-of-sale (POS) computing device is configured to interface with authorized computers including a blockchain validation device in a packet-switched computer network may be provided. The POS interfaces through the network with a consumer smartphone and a blockchain validation device. The POS shares a session identifier with the blockchain validation device by transmitting a graphic encoding of a payment request and the session identifier to the smartphone. The camera of the smartphone is configured with an image of the graphical encoding. A payment instruction is encoded to conform to the payment request including the session identifier and is transmitted to the blockchain validation device. The blockchain validation device performs a verification of the correctness and authenticity of the payment instruction encoded in the data record. The POS device receives a confirmation that the correctness and authenticity of the payment instruction encoded in the data record to confirm it has been verified.

In some embodiments described herein, a system may be provided that leverages the use of payment channels and payment channel networks to optimize transaction scalability, reduce fees, and enhance privacy. In one or more embodiments, payment channels operate as time-locked escrow contracts, enabling two parties to transact off-chain while potentially utilizing the blockchain only for the opening and closing of the channel.

An embodiment is directed toward a computer-implemented blockchain system including a global state and an assemblage of blocks, each block representing a collection of state transformation records, each state transformation record describing a state transformation performed on the global state, and each block referencing one or more preceding blocks, where preceding blocks referenced by any given block contain state transformation records describing state transformations performed on the global state prior to the evaluation of the given block, and where at least one state transformation record is a zero-knowledge transformation record encoding a zero-knowledge state transformation description, which zero-knowledge transformation record includes at least the following elements: one or more addresses or paths identifying or referencing the one or more locations of the elements of a discrete data subset within the global state, which discrete data subset includes either a contiguous subset or a non-contiguous subset of the data comprised by the global state; a revised data subset, representing a new revised version of some portion of or subset of said discrete data subset; and a transition proof implemented as a non-interactive zero-knowledge proof, which transition proof proves that the transition from the discrete data subset to the revised data subset follows the established rules of the blockchain system.

In an embodiment, the zero-knowledge transformation record includes one of: the discrete data subset itself, one or more cryptographic hashes of one or more elements of the discrete data subset, or both the discrete data subset and one or more cryptographic hashes of one or more elements of the discrete data subset.

In an embodiment, the transition proof corresponds to one of a set of pre-defined transition types for which corresponding non-interactive zero-knowledge proofs may be generated.

In a further embodiment, each pre-defined transition type corresponds to an encoded state-transition implementation encoded as an algorithmic encoding, which algorithmic encoding may comprise one or more of an algebraic circuit, a virtual algebraic circuit, an algebraic intermediary representation, or other algebraic encoding or algorithmic encoding.

In a further embodiment, the encoded state-transition implementation receives certain data as input, and generates certain data as output, and where a portion of the input data is private input data, and the remainder of the input data is public input data.

In a further embodiment, the public input data includes the discrete data subset.

In a further embodiment, the public input data includes the revised data subset.

In a further embodiment, the output of the encoded state-transition implementation includes the revised data subset.

In a further embodiment, the transition proof is generated by a process that includes: a compilation step where the algorithmic encoding is compiled into a set of polynomial equations, an evaluation of the polynomial equations at one or more random points, producing values that are included in the transition proof.

In an embodiment, the transition proof is implemented as a zero-knowledge succinct non-interactive argument of knowledge (zk-SNARK).

In an embodiment, the transition proof is implemented as a zero-knowledge succinct transparent argument of knowledge (zk-STARK).

In an embodiment, an issuer of a currency denominated token is configured to hold a reserve for every corresponding unit of currency denominated tokens issued by the issuer,

In an embodiment, the reserve may be a collection of assets or a store of value.

In an embodiment, a token may be issued by a token issuer to a plurality of users, the token issuer configured to: (i) approve use of the token to at least a subset of the plurality of users, and (ii) disapprove use of the token to at least a second subset of the plurality of users.

In an embodiment, a decision indicator may be configured to mark at least a user of the plurality of users as approved, wherein only approved users may have access to a payment channel on the blockchain.

In an embodiment, the decision indicator is a user account.

An embodiment includes the decision indicator being associated with an edge node on the blockchain, the decision indicator further configured to indicate that an account belongs to an edge node or an interconnection node.

In an embodiment the token is configured with a permissioning constraint configured to permit a first interconnection account to open a payment channel with a second interconnection account, wherein the payment channel is opened by at least the first account and the second account, and wherein at least one permission constraint prohibits the payment channel transactions or records that are signed by the first account but do not reference the second account.

An embodiment includes using a first cryptographic key for sending payments across a payment channel network, and a second cryptographic key for receiving payments across the payment channel network.

In an embodiment the first cryptographic key includes a restriction disallowing funds to be removed from a wallet of a user,

In an embodiment, the first cryptographic key may be used to negotiate the receipt of payment.

In an embodiment, the first cryptographic key may be used to sign data elements sent during the receipt of payment.

An embodiment is further configured to generate, by a user, an alternative pair of cryptographic keys, provide the alternative pair of cryptographic keys to a persistent server, associate an account with at least one permissioning constraint configured to restrict the use of the alternative pair of cryptographic keys such that the pair of cryptographic keys may only be used to sign payment channel records or transactions that update payment channels in such a manner that the user's payment channel balance increases compared to the previous channel state.

An embodiment further includes one or more permissioning constraints configured to determine whether one or more cryptographic keys are permitted to authorize a payment channel record or transaction.

In an embodiment any payment negotiated using a cryptographic key is in the direction of the user.

In an embodiment the blockchain is further configured to open, close, and update payment channels on-chain through zero-knowledge payment channel records or transactions.

In an embodiment an account on the blockchain is configured with one or more private ledgers represented in a blockchain global state by one or more cryptographic hash digests.

An embodiment further includes an open payment channel configured on the blockchain with a channel private ledger, wherein the channel private ledger is configured to encode a token balance of at least two participants within the payment channel.

An embodiment further includes implementing a zero-knowledge algorithmic encoding corresponding to a pre-defined type of global state information.

An embodiment further includes an expression of a permission constraint encoding corresponding to a zero-knowledge expression encoding, wherein zero-knowledge expression encoding includes a zero-knowledge algorithmic encoding, each zero-knowledge expression encoding configured to perform an operation that is encoded by its corresponding expression.

An embodiment further includes at least one anchor block configured to limit the reorganization of blocks beyond a threshold block depth.

In an embodiment, the anchor block further configured to be spaced at regular intervals.

Another embodiment is directed toward validating and accepting zero-knowledge transformation records. The method includes a validating computer configured to store the blockchain's global state in a retrievable storage medium, a wallet computer connected to the validating computer via a computer network, the wallet computer generating a new zero-knowledge transformation record. The validating computer receiving the zero-knowledge transformation record from the wallet computer, and subsequently performing validation of the zero-knowledge transformation record. Said validation includes the validating node retrieving a retrieved data subset from the global state, which subset of global state data corresponds to the discrete data subset referenced or included in the zero-knowledge transformation record, the validating node verifying that the discrete data subset included in the zero-knowledge transformation record or referenced by the zero-knowledge transformation record is equivalent to the retrieved data subset, the validating node verifying that the non-interactive zero-knowledge proof is valid when verified combination with the discrete data subset (or retrieved data subset) and revised data subset—and possibly in combination additional Public Input Data included with the zero-knowledge record in certain cases, in the case that the non-interactive zero-knowledge proof is successfully verified and the zero-knowledge transformation record is deemed valid, the validating node replacing some portion of the discrete data subset with elements of the revised data subset, where the portion of the discrete data subset that is replaced by elements of the revised data subset is decided according to which pre-defined transition type the non-interactive zero-knowledge proof corresponds to.

In embodiments, the discrete data subset includes at least one permission encoding, which permission encoding either is itself interpretable by the encoded state-transition implementation, or transformed into an equivalent format interpretable by the encoded state-transition implementation.

In embodiments, the permission encoding, or a transformation thereof, is interpreted or evaluated within the encoded state-transition implementation.

In embodiments, a state transformation corresponding to the encoded state-transition implementation is undertaken only if the permission encoding is interpreted or evaluated with a result indicating that said state transformation is permitted.

In embodiments, the permission encoding includes a logical function encoded as interpretable or executable computer code.

In embodiments, the logical function is configured to accept one or more permission inputs and the logical function is configured to output a permission output.

In embodiments, the permission output corresponds to either a permitted transition status or a not-permitted transition status, given the one or more permission inputs. Whereby the state transformation corresponding to the encoded state-transition implementation is undertaken only in cases where the permission output given the one or more permission inputs corresponds to the permitted transition status, and the state transformation is not undertaken in cases where the permission output given the one or more permission inputs corresponds to the non-permitted transition status.

In embodiments, the one or more permission inputs comprise a subset of the public input data and private input data received by the encoded state-transition implementation.

In embodiments, the logical function, or a transformation thereof into an equivalent format interpretable by the algorithmic encoding, is interpreted or executed within the algorithmic encoding.

In embodiments, the non-interactive zero knowledge proof is deemed valid only in the case where the logical function outputs a value corresponding to the permitted transition status within the algorithmic encoding.

In embodiments, the permission encoding includes a pattern encoding, where the state transformation corresponding to the encoded state transformation implementation is permitted only in the case that the pattern encoding matches at least a portion of the private input data, or a portion of the public input data, or a combination thereof.

In embodiments, the pattern encoding, or a transformation thereof into an equivalent format interpretable by the algorithmic encoding, is compared to a portion of the input data received by the algorithmic encoding, within the algorithmic encoding itself, and in which the transition proof is verified successfully only in the case where the pattern encoding matches said input data within the algorithmic encoding.

In embodiments, the discrete data subset includes one or more account records, each account record including one or more private ledgers, each private ledger including at least one cryptographic hash digest the preimage of which is an unmasked private ledger, which at least one unmasked private ledger contains one or more token balances.

In embodiments, the at least one unmasked private ledger is implemented as a Hash Tree or Merkle Tree, where the root of the tree corresponds to the private ledger's cryptographic hash digest.

In embodiments, the at least one unmasked private ledger is implemented as a Merkle Trie or Merkle Patricia Trie, where the root of the trie corresponds to the private ledger's cryptographic hash digest.

In embodiments, the at least one unmasked private ledger is implemented as a Merkle Proof or partial Merkle Tree or partial Merkle Patricia Trie, and where the root of the proof, tree or trie corresponds to the private ledger's cryptographic hash digest.

In embodiments, the private input data includes the at least one unmasked private ledger, which at least one unmasked private ledger is excluded from the discrete data subset and from the public input data; and where the private input data also includes information regarding at least one quantity of tokens.

In embodiments, the encoded state transformation implementation includes a private state transformation. Including the encoded state transformation implementation computing at least one derived hash, which derived hash is the cryptographic hash of the at least one unmasked private ledger, the encoded state transformation implementation determining that such at least one derived hash equals the at least one cryptographic hash digest of the private ledger which corresponds to that at least one unmasked private ledger, the encoded state transformation implementation modifying the unmasked private ledger in a manner consistent with the token quantity information included in the private input data, and the encoded state transformation implementation computing a revised cryptographic hash digest of the modified unmasked private ledger, which revised cryptographic hash digest corresponds to the output of the encoded state transformation implementation.

In embodiments, the private state transformation also includes a step whereby at least one permission encoding included in the public input data is evaluated in combination with a portion of the input data received by the encoded state transformation implementation, whereby the state transformation corresponding to the encoded state transformation implementation is only undertaken if the permission encoding is interpreted or evaluated in a manner indicating that said state transformation is permitted.

In embodiments, a zero-knowledge transformation record is accepted and included in the blockchain only in the case where one or more permission encodings included in the record's discrete data subset are interpreted or evaluated in a manner indicating that the state transformation corresponding to the zero-knowledge transformation record is permitted.

In embodiments, the validating computer replaces at least one cryptographic hash digest of the one or more account record's one or more private ledgers in the global state with the revised cryptographic hash digest, in the event that the zero-knowledge transformation record is accepted and included in the blockchain.

Another embodiment is directed toward a computer implemented method of updating data of a blockchain divided into a plurality of shards, including assigning a mining node to a shard of the blockchain. Further, at the mining node, generating a candidate block representing transactions involving accounts associated with the shard, and transmitting the candidate block to a peer node assigned to the shard. Further, at the peer node, selecting among the candidate block and a plurality of other candidate blocks for inclusion in a respective one of a plurality of block sequences, the selection being based on a fitness value of the candidate block, developing the plurality of block sequences by generating subsequent blocks in each of the plurality of block sequences, selectively discarding a subset of the plurality of block sequences in response to detecting an invalid step within the block sequence, and updating the shard to include at least one of the plurality of block sequences.

An embodiment further includes, assigning the mining node to at least two shards of the blockchain including the shard, an account associated with the mining node being included in one of the at least two shards.

In an embodiment, generating the candidate block includes generating a bloom filter indicating all of the accounts with which the mining node has interacted.

In an embodiment, preventing the mining node from mining transactions involving accounts that are not included in the shards assigned to the mining node.

In an embodiment, generating the candidate block includes generating a candidate block header that indicates a quantity of fuel tokens.

In an embodiment, determining whether the candidate block header is valid based on whether the quantity of fuel tokens exceeds a quantity of fuel tokens held by an account associated with the mining node.

Another embodiment includes, performing a fraud analysis of the plurality of block sequences, wherein detecting the invalid step is based on the fraud analysis.

An embodiment is directed toward a computer-implemented blockchain sharding system. The system comprising a global state and at least two block-building nodes, wherein the global state includes at least four shards, each shard comprising a mutually exclusive portion of the global state, each block building node configured to store global state data comprising at least two shards, and at least one of the at least two block building nodes configured to store global data excluding at least two shards.

An embodiment is configured to implement a consensus procedure, the consensus procedure is performed in sequential rounds, each new block built belongs to a single round, and operates on at least two shards of the global state, and each round includes one or more new blocks operating on non-overlapping mutually exclusive shards of the global state.

In an embodiment, each new block includes a block hash of one or more preceding blocks of the preceding round, the block has configured to reference a preceding block operating on at least one of the same shards as the new block.

An embodiment is directed toward a computer-implemented blockchain sharding system. The system includes a global state and two or more block building nodes.

In an embodiment, the global state includes at least three shards. Each shard includes a mutually exclusive portion of the global state, and each block-building node is configured to store global data, excluding at least one shard.

An embodiment is configured to implement a consensus procedure performed in sequential rounds. Each new block built belongs to a specific round, operating on at least one shard of the global state, each round includes one or more new blocks operating on non-overlapping mutually exclusive shards of the global state.

In an embodiment, each new block includes a block hash of one or more preceding blocks of the preceding round, the block hash configured to reference a preceding block operating on at least one of the same shards as the new block.

An embodiment is directed toward a computer-implemented method for accepting electronic payment. The system includes a point-of-sale computer device, at least one authorization computer devices, and a consumer smartphone with at least one camera, and a processor and memory with computer code instructions stored thereon. The processor and the memory are configured to cause the system to connect the point-of-sale computer device to a packet-switched computer network, connect the at least one authorization computer devices to the packet-switched computer network, connect the consumer smartphone to the packet-switched computer network, configure the point-of-sale computer device with at least one graphical display, configure the point-of-sale computer device to share a session identifier with the at least one of the one or more authorization computer devices, display, on the point-of-sale consumer device graphical display, a graphical encoding of a payment request, wherein the graphical encoding of the payment request includes an encoding of the session identifier, capture, via the at least one camera of the consumer smart phone, an image of the graphical encoding of the payment request, display, on the consumer smart phone, a user-acceptance message, wherein the message requests acceptance of the payment request by a user of the consumer smart phone, indicate acceptance of the payment request via an indication of acceptance of the user of the consumer smart phone, construct a data record configured to encode a payment instruction to conform to the payment request, wherein the data record encoding of the payment instruction encodes the session identifier, and transmit the data record to at least one of the one ore more authorization computer devices via the packet-switched computer network. The at least one of the one or more authorization computer devices are configured to perform a verification of the correctness and authenticity of the payment instruction encoded in the data record. The point-of-sale computer device is configured to receive, via the packet-switched computer network, a confirmation that the correctness and authenticity of the payment instruction encoded in the data record has been verified.

An embodiment further includes a cryptographic signature of the data record attached to the data record prior to transmission to the one or more authorization computer devices. The cryptographic signature is generated using an asymmetric cryptographic signature algorithm. The cryptographic signature is generated using a private key corresponding to a public key stored in a data storage of at least one of the one or more authorization computer devices.

In an embodiment, the public key corresponds to a money balance stored in at least one of the one or more authorization computer devices; and wherein the verification of the correctness and authenticity of the payment instruction encoded in the data record includes a verification that the cryptographic signature is valid and was generated with a private key corresponding to said public key.

In an embodiment, at least one of the one or more authorization computer devices is a blockchain validation computer device hosting a blockchain validation software program. The blockchain validation software program is configured to maintain a connection to one or more additional blockchain validator computer devices hosting one or more additional blockchain validation software programs. The blockchain validator computer devices are connected to the packet-switched computer network. The data record is a blockchain data record, the acceptance of which by the blockchain configured to effectuate a change to a global state of the blockchain.

In an embodiment, the data storage includes an encoding of the blockchain's global state, and wherein the data record is configured to encode a transformation to the blockchain's global state.

In an embodiment, the point-of-sale computer device is configured to open a socket connection to at least one of the one or more authorization computer devices before displaying on the graphical display the graphical encoding of the payment request.

In an embodiment, the point-of-sale computer device, after displaying the graphical encoding of the payment request on the graphical display, is configured to poll at least one of the one or more authentication computer devices, sending in reference to the session ID.

In an embodiment, the point-of-sale computer device is configured as part of a cash-register system at a physical retail location.

In an embodiment, the point-of-sale computer device is a personal computer, the personal computer being configured to execute a web browser software, and wherein the graphical representation of the payment request is displayed in a graphical-user-interface window of the web browser software.

An embodiment is directed toward a distributed electronic ledger configured in the electronic memory of one or more computers in a blockchain system, the distributed electronic ledger having a plurality of backward-linked interconnected blocks, arranged as one or more instances of linear blockchain data structures, non-linear block arrangements, n-dimensional mesh or lattice data structures, or directed acyclic graphs; configuring each of the interconnected blocks to include an ordered set of individual data records, such that at least one of the records reflects a transformation of at least a portion of the global state of the distributed electronic ledger; configuring the blockchain system to comprise a peer-to-peer network of computer nodes, with one or more computers configured as wallet nodes, and with one or more computers configured as block-building nodes; configuring the one or more wallet nodes to transmit one or more of the data records to one or more block-building nodes in the peer-to-peer network; and configuring the one or more block-building nodes to construct one or more interconnected blocks in the distributed electronic ledger by selecting and ordering one or more of the data records to be included in said one or more new interconnected blocks.

An embodiment further includes the blockchain system comprising at least one or more of the following software system components: payment channel liquidity, payment channel permissioning, safe offline payment channel availability, zero-knowledge permissioning, anchor blocks, block-building and protocol validation functions, message signing protocol, consensus protocols, synchronization with traditional database systems, and integration with external off-chain payment systems.

An embodiment is directed towards a system for securing ownership of tokens, cryptocurrency, or other assets held or tracked on a blockchain by using cryptographic key pairs to sign one or more records, the system comprising at least one blockchain account having one or more cryptographic key pairs, and wherein at least one of the one or more records is configured to encode one or more transformations to a global state maintained by the blockchain.

An embodiment further includes the system for securing ownership of tokens, cryptocurrency, or other assets held or tracked on a blockchain comprising at least one of the following software system components: payment channel liquidity, payment channel permissioning, safe offline payment channel availability, zero-knowledge permissioning, anchor blocks, block-building and protocol validation functions, message signing protocol, consensus protocols, synchronization with traditional database systems, and integration with external off-chain payment systems.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating a comparison of the relative risk of reorganization occurring for an example smaller blockchain network and an example larger blockchain network.

FIG. 2 is an illustration of certain anchor block concepts, according to an embodiment.

FIG. 3 is a diagram illustrating how anchor blocks may serve as an additional risk mitigator for payment channel operations, according to an embodiment.

FIG. 4 is a payment channel network illustrating the progress of a payment in a network, and how a payment is conveyed to a recipient from a sender, according to an embodiment.

FIG. 5 is a diagram illustrating that the individual payment channels established between nodes are implemented as a payment channel structure which may be established through a sequence of defined steps and states, according to an embodiment.

FIG. 6 is a diagram illustrating a payment channel lifecycle demonstrating how two channel partners may conduct multiple value transfers while maintaining only two on-chain transactions, according to an embodiment.

FIGS. 7A-7E are diagrams illustrating that each iteration or round of a consensus process forms a “block ring” that should include blocks that incorporate transformations of mutually-exclusive shards, according to an embodiment.

FIG. 8 is a diagram of an example sharding system, according to an embodiment.

FIGS. 9A and 9B are diagrams illustrating elements of an invalid transaction fraud proof, according to an embodiment.

FIG. 10A is a diagram illustrating elements of a state-disjunction fraud proof, according to an embodiment.

FIGS. 10B and 10C are diagrams illustrating elements a of state-disjunction fraud proof, according to an embodiment.

FIG. 10D is a diagram illustrating elements of an invalid-transaction fraud proof, according to an embodiment

FIGS. 10E and 10F are diagrams illustrating elements of an invalid transaction fraud proof, according to an embodiment.

FIG. 11 is a diagram of an example sharding system, according to an embodiment.

FIGS. 12A-12B is a diagram illustrating elements of a synchronization system, according to an embodiment.

FIGS. 13A and 13B are diagrams of elements of a synchronization system architecture, according to an embodiment.

FIGS. 14A-14E are diagrams of elements of a synchronization system architecture, according to an embodiment.

FIGS. 15A and 15B are diagrams of elements of a synchronization system architecture, according to an embodiment.

FIG. 16 is a schematic view of a computer network in which embodiments may be implemented.

FIG. 17 is a block diagram illustrating an embodiment of a computer node in the computer network of FIG. 16.

FIG. 18 is a schematic illustration of a mobile device interacting with a quick response code on a computer monitor, according to an embodiment.

FIG. 19A is a block diagram of an example structure of a blockchain system utilized on a distributed data interchange network according to an example embodiment.

FIG. 19B is a simplified block diagram showing exemplary blockchain layers according to an embodiment.

### DETAILED DESCRIPTION

A description of example embodiments follows.

The teachings of all patents, published applications and references cited herein are incorporated by reference in their entirety.

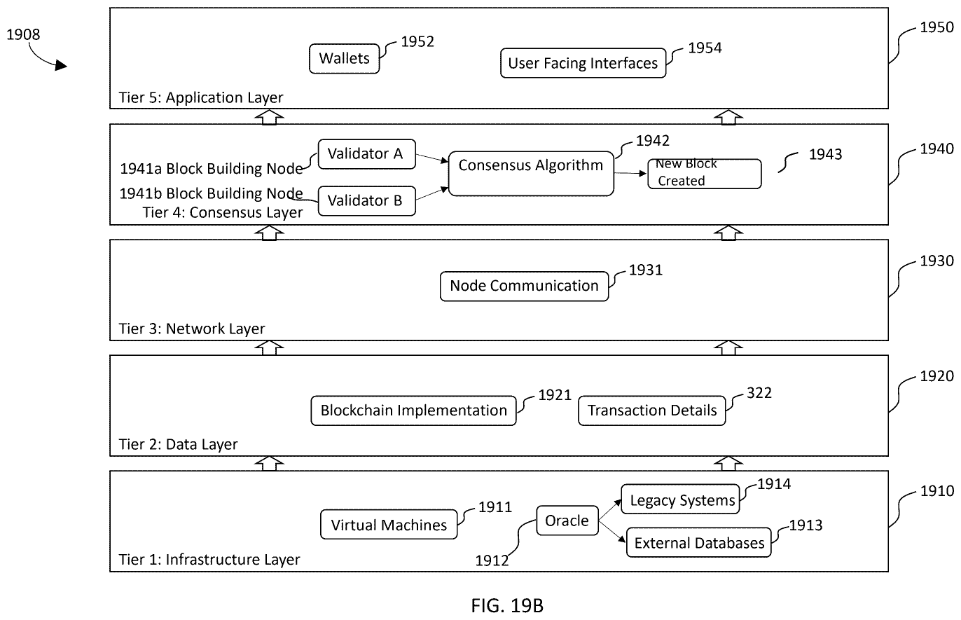

FIG. 19A is a block diagram of an example structure of a blockchain system 2000 utilized on a distributed data interchange network according to an example embodiment. In one example, the blockchain system 2000 may be configured as described in U.S. Pat. No. 11,509, 464 issued Nov. 22, 2022, the entire teachings of which are incorporated herein by reference.

A blockchain system 2000 typically includes a blockchain processing device 2010, a wallet device 2020, a blockchain data browsing device 2030, and a vendor device 2040, all of which may be connected to the internet 2090 (or a distributed network). The blockchain system may include multiple blockchain processing devices 2010, multiple wallet devices 2020, multiple blockchain data browsing devices 2030, and multiple vendor devices 2040, each connected to the internet 2090. In addition to separate blockchain processing devices 2010, separate wallet devices 2020, separate blockchain data browsing devices 2030, and separate vendor devices 2040, a blockchain system may contain combination devices that combine features and functionality of all or some portion of these devices, or that simultaneously may perform the function of all or some portion of these devices, and which are also connected to a distributed network (e.g. internet) 2090.

The blockchain processing device 2010 may be a computational device, such as a computing device, computer, mobile phone, smartphone, tablet, laptop, desktop computer, server computer, purpose-built computation device, or other type of computation device, with one or more computer processors 2012, computer memory 2014 for storing computer instructions, a database 2016 for processing blockchain information (including records and/or transactions), and a communication module 2018 for connecting to the internet 2090 and/or the distributed network. The blockchain processing device may also optionally include a display 2055 (not shown), and may consist of multiple computers or a network of computers (either directly connected or distributed), all of the same type or of different types. The wallet device 2020, the blockchain data browsing device 2030, the vendor device 2040, and the combination device typically have the same or similar components as the blockchain processing device 2010.

The blockchain processing device 2010 functions as a “block-building node”, which may be referred to as a “miner” in proof-of-work blockchains, and may be referred to as a “miner” in certain embodiments. Block-building nodes are responsible for assembling new blocks that reflect the inclusion of new records or transactions in the blockchain, and for linking those blocks to the blockchain. Block-building nodes are also responsible for algorithmically confirming whether the blocks that have been linked to the blockchain are valid, and whether records or transactions are validly included in the blockchain. Block-building nodes are also responsible for propagating blocks and data records within the network. In at least one embodiment, each block-building node may be associated with an account or address on the blockchain, to which account or address block mining rewards may be assigned. Such an account or address can be used by a block building node to securely identify itself and its activities within the network and on the chain through the use of cryptographic signatures.

In an embodiment, the wallet device 2020 functions as a wallet that acts to securely store cryptographic keys, which keys are used to cryptographically sign new data records that are proposed for inclusion in the blockchain. Cryptographic signatures can ensure that block building nodes include data records that are appropriately authorized. In addition to storing cryptographic keys and other secure data, wallets may be able to generate and cryptographically sign new data records and transmit them to one or more block-building nodes, typically via the internet 2090 or other network.

The blockchain data browsing device 2030 functions to provide users with a means to read, view or otherwise access data associated with the blockchain, on a read-only basis.

The vendor device 2040 may include one or more computers or other computer processing devices that facilitate the activity of blockchain vendors. A blockchain vendor may be an entity that offers, issues, sells or distributes any token to one or more users, or that provides services that are in some manner verified, confirmed, provided or conveyed via a blockchain—for example, identity verification services. A vendor device runs software that enables Blockchain Vendors to provide such services.

] A node may be a computational device, such as a computing device, mobile phone, smartphone, tablet, laptop, desktop computer, server computer, a purpose-built computation device or other computation device that runs blockchain peer-to-peer software and communicates with other similar computers operating on a connected distributed data interchange network like the Internet.

A node network may be a collection of computers running the same blockchain peer-to-peer software, working to build a single, shared blockchain, and connected to each other via a connected distributed data interchange network like the Internet.

Data records accepted for inclusion in a blockchain may be stored or referenced in the blocks of a distributed ledger or blockchain. Individual blocks may contain record and/or transaction data. Alternately, blocks may reference such data via a cryptographic hash or digest summarizing the data, which hash or digest may be generated by a separate data structure that contains the records and transactions, for example a Merkle tree. For cryptocurrency blockchains, cryptocurrency ownership may be linked to unique addresses or account numbers included as data within these records and transactions. In such cryptocurrency blockchains, the cryptocurrency balance associated with a particular address or account number may be derived from the entire history of records and transactions preserved by the distributed ledger or Blockchain, beginning at its origin.

### Blockchain System and Zero-Knowledge Architectures

In an embodiment, a computer-implemented blockchain system may be provided. The system may include a global state and an assemblage of blocks, where each block may be configured to represent a collection of records and/or transactions. Each record or transaction may be configured to describe a state transformation performed on the global state, and each block may be configured to reference one or more preceding blocks. Preceding blocks referenced by any given block may contain records and/or transactions which may be configured to describe state transformations performed on the global state.

In one or more embodiments, the global state is a shared or replicated distributed ledger or other data representation replicated by one or more computer nodes connected to the blockchain system, which represents the current state of data stored on the blockchain.

The terms “state transformation”, “state transition”, “transformation” and “transition” and “state change” herein refer to the process by which the global state is updated to reflect new information. These terms are used interchangeably herein to describe the same process of state change.

In certain embodiments, the terms “record” and “transaction”, as used herein, may refer to data, operations, instructions or other encoded elements submitted for inclusion in the blockchain that, when validated and incorporated into one or more new blocks by one or more block-building nodes, effectuate a state transformation. These terms are used without distinction and are intended to encompass a broad range of activities or data types, including but not limited to value transfers, state updates, instructions for smart contract execution, or any other information that may alter the global state of the blockchain. Records and/or transactions may be validated and incorporated into the blockchain in accordance with the blockchain's consensus and protocol rules and logic. In various embodiments, according to such rules and logic, records and/or transactions may be cryptographically signed, which signature, and the public key associated with the signature, is evaluated as part of the process of validating said records and/or transactions. Upon successful incorporation into a new block, a record or transaction updates the blockchain's global state to reflect the change to the global state encoded by said record or transaction according to the rules of the blockchain state transformation protocol implemented and/or enforced by the blockchain node. The terminology used herein is maximally inclusive and does not limit the type, format, or purpose of the data or actions represented by records and transactions, unless otherwise explicitly and unambiguously specified.

In one or more embodiments, the process of updating the blockchain's global state relies on the successful execution of operations defined and/or encoded by records or transactions, which may include, but are not limited to, transfers of value, modifications to stored data, the creation or execution of smart contracts, creation, configuration, issuance, minting or transfer of tokens, or other computational or state transformation tasks. These updates are effectuated by block-building nodes, which validate, organize, and append records or transactions into a new block. Each new block extends the blockchain, thereby recording the associated state transformations and effectuating that the global state be updated in a manner consistent with the protocol rules implemented and enforced by the one or more block-building nodes.

In various embodiments, terms such as tokens, balances, funds, units of value, and similar expressions, both singular and plural, are used interchangeably to describe the representation of value within the network. For the purposes of this description, references to one term should be understood to encompass embodiments of the others, as they all reflect the same underlying concept of a quantifiable measure of ownership, entitlement, or utility associated with a blockchain address or account. This interchangeable usage is intentional to streamline the explanation and avoid repetitive distinctions between terms that functionally overlap.

In certain embodiments, said blockchain system comprises a blockchain network, which may comprise a plurality of nodes, serving distinct roles to support the functionality, security, and accessibility of the system.

In certain embodiments, a node within said blockchain network is defined as a single computing device equipped with one or more processors (e.g., central processing units (CPUs) and/or graphics processing units (GPUs)), memory (e.g., volatile memory such as RAM), storage (e.g., non-volatile storage such as solid-state drives or hard disk drives), and network connectivity hardware (e.g., Ethernet or wireless communication interfaces). A node may operate by executing software configured to interact with the blockchain network. This software may include, but is not limited to, functionality for transmitting, receiving, validating, and storing blockchain data, as well as performing specific roles such as block building, transaction validation, or cryptographic signing. In various embodiments, nodes may vary in computational capability and configuration, ranging from resource-constrained devices (e.g. smart phones and hardware crypto wallets) to high-performance servers, and may operate independently or in coordination with other nodes. Nodes may also be virtual nodes, whereby one or more of the elements that constitute a physical node are implemented in software, or whereby the physical attributes of a single physical computing device or system are shared by a plurality of virtual nodes compartmentalized by software. The definition of a node is non-limiting and may encompass any computing device or system capable of executing the blockchain software and fulfilling the requirements of the protocol.

In one or more embodiments, nodes may communicate between and among themselves through one or more computer networks, network protocols and/or communication protocols, including communication protocols such as, for example, Internet Protocol (IP), Transmission Control Protocol (TCP), User Datagram Protocol (UDP), and/or various packet-switched network protocols. In one or more embodiments, various nodes and servers within a blockchain network may communicate and exchange, broadcast and/or transmit data through a decentralized, peer-to-peer (P2P) architecture, and data may be shared, transmitted, broadcast, received or exchanged through the use of a peer-to-peer communications protocol, which may be a gossip protocol or other protocol. Such network connectivity between and among nodes may allow one or more of messages, records, transactions and/or state updates to be shared, propagated, transmitted, and/or broadcast by, between and/or among the various nodes.

In one or more embodiments, nodes may include one or more of block-building nodes, validator nodes, wallet nodes, and interface servers. Individual nodes may be specialized in the role they perform, or single physical or virtual nodes may perform multiple roles, such as, for example, acting simultaneously as a block-building node, validator node, wallet node, or interface server, depending on the implementation and configuration of the system.

One or more embodiments may include Block-building nodes which function to incorporate records and/or transactions into a blockchain by incorporating said records and/or transactions into new blocks, which blocks may in turn be incorporated into said blockchain. They also act to ensure the integrity and consistency of the blockchain's state by implementing, executing and enforcing the rules of the blockchain protocol. Block-building nodes may exchange critical data such as block headers, block data, record and/or transaction encodings, transaction metadata, cryptographic proofs and other data with other nodes of the network.

Block-building nodes may also receive, send, and/or exchange data with other nodes and receive user-submitted records and/or transactions from other nodes and provide information regarding the global state.

In one or more embodiments, validator nodes may perform most of the tasks and activities of block-building nodes, but excluding some tasks, such as, for example, building new blocks and appending such blocks to the blockchain, depending on the embodiment. Validator nodes, like block-building nodes, replicate, synchronize and/or maintain at least a portion of the global state. In some embodiments, a node may serve both as a block-builder and validator, combining the tasks of producing blocks and verifying the validity of new blocks produced by other nodes in the blockchain network. In some such embodiments where the block-building node and validator node roles may overlap, the terms “validator node” and “block-building node” may be used interchangeably; however, in embodiments where the roles do not overlap, each term retains a distinct meaning.

In one or more embodiments, wallet nodes may serve as means of access for users to interact with the blockchain, providing a means for said users to access to and/or retrieve blockchain data, and enabling the creation, encoding, cryptographic signing, sharing, and/or transmission of blockchain records and/or transactions.

In one or more embodiments, wallet nodes securely store private cryptographic keys, which cryptographic keys may be used to sign records and/or transactions and thereby potentially authorize the state transformation encoded on said records and/or transactions. Wallet nodes may send signed records or transactions to block-building nodes or interface servers for processing and validation. They may also retrieve blockchain updates, such as account balances or transaction confirmations, directly from interface nodes, validator nodes, block-building nodes, or other nodes. In various embodiments, wallet nodes may be implemented in various forms, including as software applications, hardware devices, or embedded components within other systems, such as smartphones, desktop applications, or web interfaces.

In one or more embodiments, nodes referred to herein as interface servers may act as intermediaries, facilitating interactions between a blockchain and a plurality of off-chain devices, systems, services, protocols, applications and/or data (external systems). Interface servers may provide connectivity for applications and third-party systems by exposing APIs, RPC endpoints, or other interfaces that allow, for example, records and/or transactions to be submitted and blockchain data to be queried. Interface servers may handle high-level functionality, such as translating user-friendly inputs into protocol-compliant records and/or transactions, exposing or retrieving blockchain data, or aggregating blockchain data for analysis and reporting. In one or more embodiments, interface servers comprise artificially intelligent components or interface with artificially intelligence systems to perform analysis of system activity, to generate content, media or data that may be written to the blockchain, or to assist in various interactions between an interface server and other nodes within the blockchain system. In some embodiments, an interface server may also function as a wallet node, validator node or other type of node, combining roles to streamline operation.

According to various embodiments, communication between nodes may follow structured protocols designed for scalability and security. Nodes may exchange data such as transaction details, block updates, and state proofs using predefined messaging formats. For example, wallet nodes may send signed transactions to block-building nodes for validation and inclusion, while interface servers may facilitate high-volume communication by aggregating user interactions and forwarding them to appropriate nodes.

In various embodiments, the terms account and address may be used to describe elements of the blockchain system. While the terms are largely used interchangeably herein, subtle distinctions may exist depending on the nature of the embodiment. An account generally refers to a logical construct within a blockchain's global state, encompassing both an identifier (such as an address) and persistent on-chain data, such as, for example, balances, user identity data, cryptographic proofs, permissions, permissioning constraints, device identifiers, configurations, statistics, key-value data, smart contract code, cryptographic keys, or other data that may be encoded. An address, in contrast, may refer to a public-facing identifier acting as a reference to on-chain data, including account data, and which may in certain embodiments be derived from cryptographic keys. An address may also be used to designate the originator, target, or receiver of a record or transaction. In one or more embodiments the term address, like the term account, may be used both to refer to the identifier or reference associated with one or more on-chain data elements, or it may be used to refer to the on-chain data elements themselves.

In certain embodiments, for example, an address may reference an account among a plurality accounts, whereby the blockchain global state comprises persistent (although potentially mutable) state data elements or state data structures each directly associated with an account. In alternate embodiments, an address may reference unspent transaction outputs (UTXOs), which represent discrete units of value created and consumed by transactions. In UTXO-based systems, an address serves to identify the owner or recipient of these outputs, but the state is managed at the level of individual UTXOs rather than aggregated at the account level. Some embodiments may support hybrid models, where addresses may simultaneously represent and/or reference accounts, UTXOs, or other constructs depending on the context.

For the purposes of this description, where the term account is used, it should be understood that an address may be substituted where appropriate, and vice versa. This flexibility accommodates the wide variety of blockchain designs and implementations that may leverage different mechanisms for tracking and managing state. The use of these terms is non-limiting and intended to cover all configurations where accounts, addresses, UTXOs, or other analogous constructs are employed to achieve the described functionality. For example, in account-based systems, an address may map directly to an account, while in UTXO-based systems, an address may serve as a reference to multiple UTXOs. In either case, the terms account and address should be interpreted in a manner consistent with the blockchain architecture in use.

The term blockchain as used in this description is non-limiting and is intended to encompass a wide variety of distributed ledger and/or distributed database structures and implementations. The term blockchain is often associated with a sequential chain of blocks linked to each other through backwards references, with each such backwards reference (backreference) being a cryptographic hash digest of the referenced block; however, the term may also refer to other arrangements of block data, including but not limited to directed acyclic graphs (DAGs), parallel blockchains, lattice or mesh data structures, sharded chains, sidechains, or hybrid models. The use of the term blockchain is therefore intended to cover any distributed ledger technology or architecture that achieves similar objectives of decentralized, secure, and immutable recordkeeping.

In certain embodiments, the terms on-chain and off-chain are used to distinguish between various operations, data, records, transactions, processes, executable code, interactions and other elements of a blockchain system based on their relationship to the blockchain's global state. On-chain refers to various operations, data, records, transactions, processes, executable code, interactions and/or other elements that are directly incorporated into a blockchain, effectuating updates to a global state and/or becoming part of an immutable ledger. Conversely, off-chain refers to elements of the blockchain system not directly incorporated into the blockchain's global state, or not occurring as part of the evaluation, execution and application of records and/or transactions in the process of performing transformations of the global state—but which instead may exist or occur in systems or environments external to the blockchain.

Various implementations of non-interactive zero-knowledge proof systems comprise a mechanism for encoding algorithms or other computational processes, procedures or instructions in a form that may be used to generate a zero-knowledge proof. Such implementations include ZK-SNARK implementations, which may encode algorithms or other computational process, procedures or instructions as algebraic circuits and/or virtual algebraic circuits, and include ZK-STARK implementations which may encode algorithms or other computational process, procedures or instructions as algebraic intermediary representations, among other implementations. Such algebraic circuits, arithmetic circuits, and algebraic intermediary representations and other algorithm and computation encoding are herein referred to as “zero-knowledge algorithmic encodings”, “algorithmic encodings” or “algebraic encodings”. The terms “zero-knowledge algorithmic encodings”, “algorithmic encodings”, “algebraic encodings”, etc., herein include such possible encodings as algebraic circuits used by known ZK-SNARK systems, and “algebraic intermediary representations” used by known ZK-STARK systems, among others

Any embodiment, system or method herein described which comprises a non-interactive zero-knowledge proof may be optionally implemented using any ZK-SNARK system, ZK-STARK system, or other non-interactive zero-knowledge proof system, interchangeably. Likewise, any embodiment, system or method describe herein which comprises an algorithmic encoding or a zero-knowledge algorithmic encoding may be optionally implemented using any algebraic circuit, algebraic intermediary representation, or other algorithmic encoding suitable for use in the generation of a non-interactive zero-knowledge proof.

### Blockchain Synchronization With Traditional Database Systems

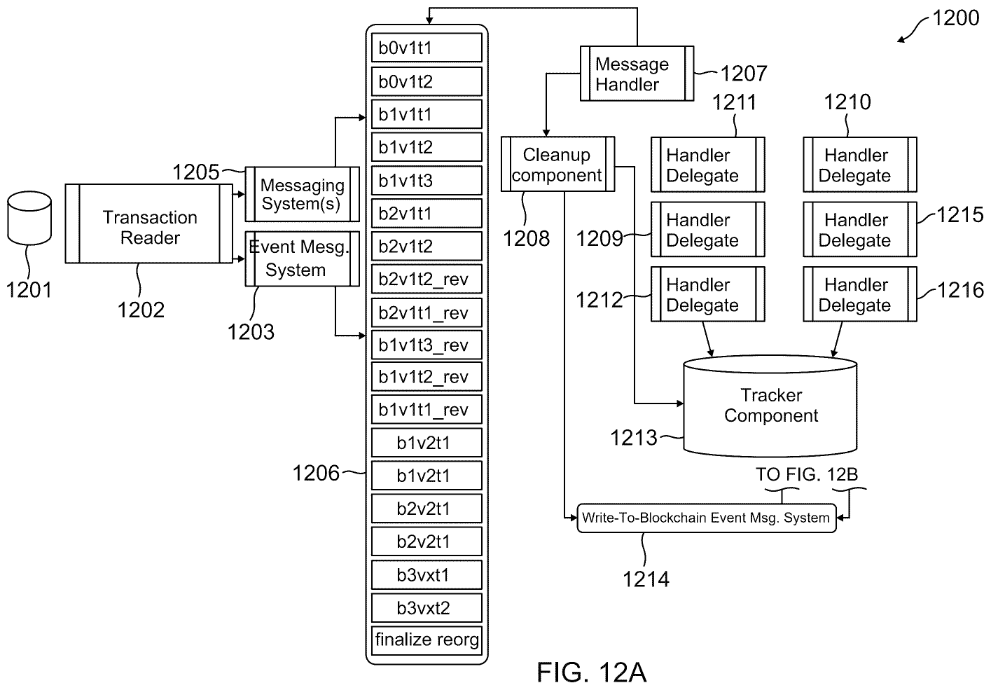

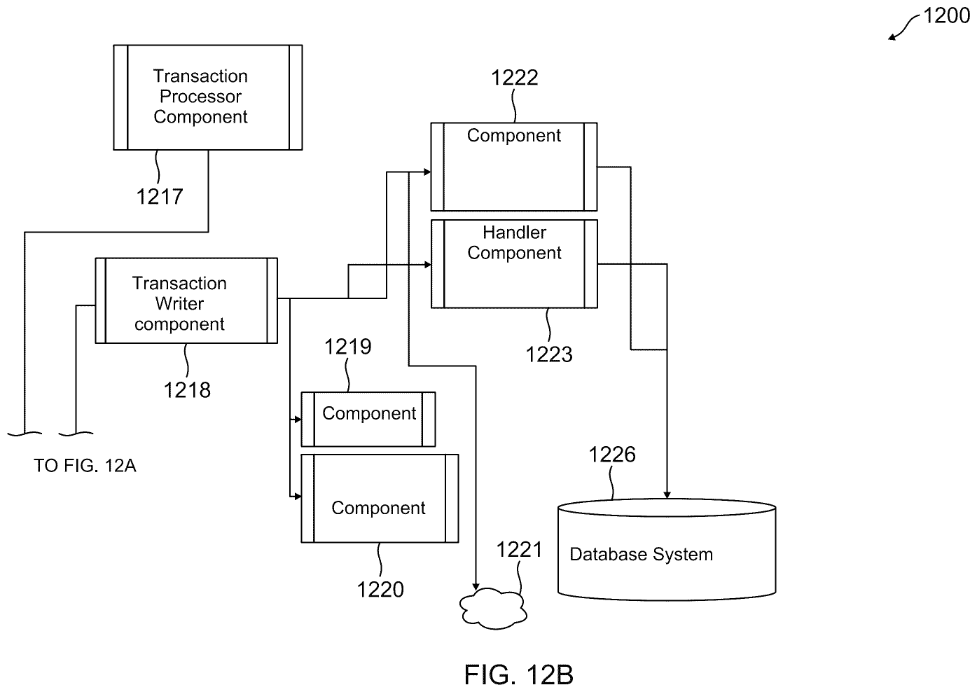

In I accordance with various embodiments of the present invention, a blockchain system may be implemented comprising one or more synchronization systems (See FIG. 12) configured to maintain consistency between a blockchain network and one or more off-chain databases or external data management systems, including such systems as relational databases, relational database management systems (RDBMS), document-oriented databases, graph databases, key-value stores, time-series databases, and other data management systems, which individually and collectively may be referred to herein as “traditional databases” or “traditional database systems”. In certain embodiments, said one or more synchronization systems may comprise one or more interface nodes and/or said traditional database systems may operate separate and apart from the block-building and protocol validation functions of the block-building and validator nodes of the blockchain system's blockchain network.

In one or more embodiments, said one or more synchronization systems may be configured to handle various operational scenarios, including, but not limited to, one or more of the following: handling of synchronous off-chain payment authorization requests; blockchain reorganization events which occurs prior blockchain finalization; reorganization events occurring after transaction finality has been reached; situations where transferred value may be unavailable due to reorganization after an external transfer has been authorized or finalized; expiration of pending transactions that have not yet been incorporated into any block; conflicts between endogenous transactions (originating from within the system) and exogenous transactions (originating from outside the system); and/or cases where messages may be lost or delayed between the blockchain network and the one or more traditional databases.

In accordance with various embodiments of the present invention, synchronization systems are configured to read data from blockchain networks and make updates to database entries in one or more traditional database systems—where these database entries are broadly defined as individual units of data stored within any type of database system, including but not limited to records or rows in relational databases, documents in document-oriented databases, key-value pairs in key-value stores, nodes and edges in graph databases, and other data structures used to represent and store information.

In at least one embodiment, the one or more synchronization systems may optionally maintain separate data structures for tracking pending transactions, finalized transactions, and/or transactions that may require reconciliation due to reorganization events. In some embodiments, the synchronization system may comprise, incorporate, interact with, connect to, and/or use one or more event streaming platforms or publish-subscribe messaging systems, which individually and collectively may be referred to herein as “event messaging systems”, and which systems may include without limitation message brokers, event logs, message buses, and other messaging infrastructures, examples of which may include, but are not limited to, Apache Kafka, RabbitMQ, Apache Pulsar, Amazon Kinesis, Google Cloud Pub/Sub, or similar capabilities implemented in a more generalized database such as an RDBMS, object oriented database, etc. In one or more embodiments, such one or more event messaging systems may provide guaranteed message delivery and order preservation, and/or may be capable of retaining messages for configurable periods of time, and/or may be designed to handle real-time data flows.

In accordance with one or more embodiments of the present invention, one or more synchronization systems may be implemented that processes both external blockchain records and/or transactions and internally-generated blockchain records and/or transactions. The synchronization system may include one or more nodes configured to detect and process blockchain records and/or transactions that are directed to one or more accounts or addresses recorded by the synchronization system, which records and/or transactions may be referred to as “exogenous” transactions in that they originate from outside of the synchronization system and its connected wallet nodes. Additionally, the synchronization system may be configured to generate and transmit to the blockchain network one or more transactions of its own, which transactions may be referred to as “endogenous” transactions in that they originate from within a synchronization system itself, or in one or more implementations from wallet nodes connected to or integrated with the synchronization system. In various embodiments, the synchronization system may include one or more interfaces through which external processes may communicate with the synchronization system, and through which requests may be received that cause the synchronization system to generate and/or transmit to the blockchain network endogenous blockchain records and/or transactions. Said synchronization systems may be configured to track the state of both exogenous and endogenous transactions as they progress through various stages of blockchain inclusion and finalization, and may maintain in one or more traditional databases entries reflecting the state of such transactions. In at least one embodiment, the synchronization system may include one or more processes for detecting and handling blockchain reorganization events that may affect either exogenous or endogenous transactions that have been previously added to the blockchain.

As a general matter, and as pertain to one or more embodiments of the present invention, certain technical challenges may arise from fundamental architectural differences between blockchain networks and traditional databases. In many implementations, a blockchain network may process all transactions asynchronously, with transactions remaining in a pending status for an indefinite period before being added to a block, and with the possibility that transactions may be reorganized or reversed even after being added to a block or otherwise incorporated into the blockchain. A blockchain network may implement logical constraints and validation rules and/or protocol rules that are enforced internally within the block-building nodes and validator nodes, potentially resulting in transactions being rejected, modified, or reordered after submission. In contrast, a traditional database system may be configured to process transactions synchronously and atomically, with immediate success/failure status, and may, in various implementations, be tightly integrated with real-time financial and business systems that require instantaneous confirmation of transaction status. Furthermore, many traditional database implementations may maintain referential integrity and transaction isolation through database-level locking mechanisms that presume reliable transaction ordering and finality. An architectural mismatch between the asynchronous, eventually-consistent nature of blockchain networks and the synchronous, immediately-consistent nature of many traditional database systems may present significant technical challenges when attempting to bridge these two paradigms, particularly in financial applications where transaction ordering, finality, and consistency are critical requirements.

Generally, and as pertain to various embodiments, technical challenges described above may be further complicated in implementations where financial institutions or payment networks may require real-time transaction confirmation and settlement, while nonetheless integrating blockchain systems for various purposes, including to leverage the benefits of blockchain networks for certain aspects of transaction processing, record keeping, or inter-institutional settlement. In at least one embodiment, special consideration may need to be given to scenarios where reorganization or reversal of blockchain transactions could impact real-world financial settlements that have already been processed through traditional banking systems. Additional, in various implementations, complexity may arise from differences in how such systems handle transaction atomicity—while a traditional database may provide some or all ACID (Atomicity, Consistency, Isolation, Durability) guarantees within a single database instance, a blockchain network may need to achieve consensus across multiple distributed nodes before transaction finality can be assured, potentially leading to temporary inconsistencies between the blockchain state and corresponding records in a traditional database.

Accordingly, various embodiments of the present invention address and resolve these issues by providing synchronization systems that manage and maintain consistency between the blockchain network and traditional database systems.

At least one embodiment of the present invention comprises a system and/or method to maintain authoritative balance tracking within a blockchain-based system while also supporting real-time payment systems. Such real-time payment systems, which may include without limitation payment card networks, point-of-sale networks, automated teller machine networks, and other transaction processing networks, typically require synchronous authorization to be obtained from an authoritative system before a transaction may be completed. However, blockchain system implementations may operate in a fundamentally asynchronous manner, whereby transactions submitted to the blockchain network may not reach finality until some number of blocks have been added to the blockchain after the block containing the transaction. This asynchronous operation may create difficulties in some implementations when attempting to use blockchain account balances as an authoritative source for real-time transaction authorization, as the state of account balances within a blockchain may be subject to reorganization or reversion for some time after a record or transaction is broadcast, shared or posted to the blockchain network. For instance, and without limitation, a first transaction appearing to authorize a payment card transaction may be superseded by a second transaction that depletes the account balance before the first transaction reaches finality, potentially creating a situation where an already-authorized payment cannot be settled.

Various embodiments of the present invention address these technical challenges through at least two distinct approaches. In a first approach, embodiments of said synchronization system may provide an interface or connection between such real-time payment systems and one or more payment channels that are constructed on top of the blockchain system. Such payment channels may, in at least one embodiment, provide synchronous transaction capability by relying on the finality characteristics of payment channel networks, which in various embodiments are able to offer instantaneous finality by relying on escrow balances that have already reached finality within escrow accounts on the blockchain. Various embodiments of the present invention comprise a connection between one or more such real-time payment systems and one or more payment channels or payment channel networks implemented as described variously elsewhere herein.

One or more embodiments may consist of a real-time payment authorization request of a real-time payment network causing a synchronization service to use a cryptographic key of an account or address to authorize a payment channel payment (wherein such payment channel payment is implemented as described variously elsewhere herein) from such account or address to an account or address which is a treasury account which holds balances which include value owed to the real-time payment network. In various embodiments, said payment may be effectuated within a single payment channel or it may be effectuated through a multi-step or multi-hop payment in a payment channel network.

One or more embodiments may consist of a computer device or mobile device which may authorize payments issued from a source account (which may be a bank, savings and loan, brokerage, pre-paid, stored-value, or other money account held in a traditional database system) issuing an instruction to a forwarding service (which may implement, incorporate or comprise one or more of a synchronization service, an interface node, or a payment channel node) with instructions to make a payment to an account or address of a payment channel network (destination account), where said forwarding service may reduce the balance of the source account, and issue a payment channel payment to the destination account, from an account or address controlled, owned or managed by said server computer device. Said account or address in various embodiments may comprise a treasury account aggregating value owned, used or controlled by the forwarding service, or said account or address may comprise a synchronized and replicated account corresponding to the source account.

In a second approach, which in one or more embodiments may be implemented either separately from or in combination with the first approach, a synchronization system may be implemented that includes one or more interface nodes. Such interface nodes may comprise or interact with traditional database systems, which traditional database systems maintain synchronized database entries that correspond to both pending and finalized blockchain transactions, in one or more embodiments enabling the interface nodes to provide synchronous responses to real-time payment systems while managing the risk that blockchain reorganizations or other blockchain events may affect the finality of transactions. The interface nodes may, in various embodiments, implement one or more strategies to ensure that real-time payment authorizations do not create undue risk of payment default, reversal or conflict when synchronized with a blockchain system, including without limitation maintaining designated treasury accounts, implementing exposure limits, and coordinating failover procedures in the event that blockchain reorganizations affect transaction finality.

In accordance with various aspects of the present invention, additional technical challenges may arise when attempting to synchronize data between a blockchain network and a traditional database system. In one or more embodiments, a blockchain reorganization event may occur when one or more blocks previously added to a blockchain are removed and replaced by one or more different blocks, which blocks may contain different sets of transactions and may reflect different transformations of the global state. Reorganization events may, in certain embodiments, create a technological challenge in maintaining synchronization between blockchain state and traditional database system state, particularly in cases where a traditional database already stores data from transactions that may have been previously incorporated into blocks that may be eliminated by the reorganization. The difficulty may be further complicated in implementations where the traditional database is being used to provide synchronous responses to user requests, such that the traditional database may need to maintain an accurate representation of account balances and transaction status even while reorganization events may occur, may have occurred, or may be in the process of occurring. This synchronization challenge may be particularly acute in cases where the reorganization affects blocks that had previously been considered “final”. In some embodiments, one or more solutions to this technical challenge may be required to ensure reliable operation of any system that connects, synchronizes or bridges blockchain networks and traditional database implementations.

Certain embodiments of the present invention may address these technical challenges by implementing one or more synchronization systems comprising one or more interface nodes configured to manage synchronization between blockchain and traditional database implementations, which interface nodes may continue to manage or maintain this synchronization even in the event of blockchain reorganization. In various embodiments, such interface nodes may comprise, incorporate, interact with, connect to, and/or use one or more traditional database systems and/or event messaging systems, and may implement a system and/or method to track both blockchain state and traditional database system state in a manner that permits recovery from reorganization events.

One or more embodiments may comprise one or more synchronization systems that implement a two-phase update process, whereby available balances may be adjusted immediately upon transaction initiation, while current (or final) balances may only be modified after transaction finality has been confirmed. In one or more embodiments, synchronization systems may maintain a principle of updating traditional database system state quickly when an update, operation or event may be protective of or may reduce financial or operational risk, may increase liability or loss, or is otherwise undesirable to the operators of said system; and updating traditional system state slowly when an operation or event may increase financial or operational risk, may decrease liability or loss, or is otherwise beneficial to the operators of said system.

The synchronization systems may, in various embodiments, maintain two distinct balance values for accounts that it manages: an “available balance” and a “current balance.” The available balance may be reduced as soon as a record or transaction that spends or otherwise decreases an account's balance is initiated, even before that transfer has been added to any block. Conversely, the available balance may be increased only when an inbound transfer or other record or transaction increasing the balance has reached finality, and the current balance may also only be modified when transactions reach finality. In various embodiments, “double spending” is prevented because various operations are blocked from occurring if they result in a negative available balance, including, for instance, providing authorization for real-time non-blockchain payments.

Nevertheless, in at least one embodiment, the available balance may potentially be less than zero in certain circumstances, for example in the case where a reorganization results in an exogenous record or transaction being added to the blockchain before an endogenous transaction that is generated to fund an already-approved external real-time payment. In various such cases, a previously-unknown exogenous record or transactions reduces account balances to less than the amount of an already-approved endogenous transaction, resulting in the settlement obligation crated by authorizing the external real-time transaction being un-funded. In certain embodiments, the on-chain balance for an account cannot be less than zero; in other embodiments, the on-chain balance can reflect a negative. One or more processes within the synchronization system may monitor accounts having negative balances (either within the traditional database, or within the blockchain, or both) and may automatically generate new blockchain transactions to reclaim value transferred to such accounts, potentially implementing one or more strategies to maximize the probability that such reclamation transactions will be successful.

### Synchronization System Components And Interactions

According to various embodiments of the present invention, one or more synchronization systems may comprise one or more of (a) a transaction processing component that receives transaction requests from wallet nodes and/or external systems and initiates various system operations; (b) a transaction writer component that submits cryptographically signed records and/or transactions to the blockchain network for inclusion in blocks, including records and/or transactions it may sign using secured private keys; (c) a transaction reader component that monitors the blockchain for new blocks and for reorganization events; (d) a message handler that processes blockchain transactions and updates traditional database system state; and/or (c) a transaction tracker component that maintains synchronization between blockchain and traditional database systems even while reorganization is occurring. Each aforementioned component, according to example embodiments, may be implemented in software running on one or more interface nodes or other computing devices, and may be run as two or more separate runtimes, or may be combined together into a single executable software.

These one or more synchronization systems may, in certain embodiments, maintain pending database entries in the one or more traditional database systems that reflect blockchain records and/or transactions that have not yet reached finality, and may update those pending database entries if a reorganization eliminates or modifies any such non-final transactions. One or more such synchronization systems may also maintain reversal database entries in certain implementations, which reversal database entries may be used to compensate for reorganizations that affect transactions previously considered final.

### Transaction Origination and Writing To The Blockchain

In accordance with various embodiments, one or more transaction processing components may comprise one or more interface nodes and/or other computer devices configured to process records and/or transactions received from one or more external systems and/or wallet nodes. Said external systems and/or wallet nodes may include, without limitation, mobile devices, desktop computers, servers, or other computing devices running software capable of connecting to and/or communicating with said transaction processing components via a computer network. In certain embodiments, said transaction processing components may write or transmit these received records and/or transactions to the blockchain network, and may also generate and write or transmit additional blockchain records and/or transactions in response to one or more events or requests. These events and requests may include, but are not limited to, payment channel open, close and update events, payment authorization requests from point-of-sale systems, account recovery requests from wallet nodes, card activation requests, transfer requests from external payment networks, withdrawal requests, identity verification events, multi-device registration events, and account configuration updates.

In certain embodiments, if said events and/or requests do not themselves comprise valid and complete cryptographically-signed blockchain requests and/or transactions, or if additional requests and/or transactions are required according to the nature of the event or request, a synchronization system may process such events and requests by generating one or more corresponding records and/or transactions, which may include without limitation payment channel records, transfer records, configuration records, account update records, or other types of blockchain records or transactions. A synchronization system may sign these generated records and/or transactions using one or more cryptographic keys associated with treasury accounts, user accounts, or other system accounts or addresses, and may submit these signed records and/or transactions to the blockchain network for inclusion in one or more blocks.

A transaction processing component may comprise one or more web servers, application servers, database servers, and associated software components that collectively provide transaction processing services, including but not limited to validating incoming transactions, maintaining account state and balances, tracking transaction status, managing user profiles and credentials, processing authorization requests, handling multi-device registration, coordinating with external payment networks, implementing identity verification workflows, and/or synchronizing state between the blockchain network and local databases. A transaction processing component may implement various means for users and external services and applications to access and interact with the synchronization system specifically and the blockchain network generally, which means of access and interaction include but are not limited to JSON-RPC APIs, REST APIs, WebSocket connections, OAuth2 authentication flows, webhook integrations, mobile application SDKs, browser-based interfaces, command-line interfaces, and programmatic library interfaces. These interfaces may enable functions including account management, transaction submission, balance queries, transaction history retrieval, blockchain status monitoring, smart contract interaction, and system configuration.

In at least one embodiment, a transaction processing component may interface with wallet nodes and/or external systems via one or more network interfaces, and a transaction writer component may manage cryptographic keys and sign blockchain transactions, which components may exchange messages or otherwise communicate with each other via one or more event messaging systems. In one or more embodiments, said transaction processing component may receive and process requests via one or more network interfaces, may maintain account state in one or more databases, and/or may generate events or messages to be processed by the transaction writer component. In various embodiments, the transaction writer component may store and manage cryptographic keys, may sign blockchain transactions, and/or may update the transaction processing component via events or messages with regards to blockchain interactions. In several embodiments, the separation of these components may enhance security by isolating cryptographic operations and key storage from public network interfaces. The event messaging system may provide reliable communication between these subsystems while maintaining their isolation, and may enable asynchronous processing of blockchain operations in a manner that is independent from request processing operations.

In various embodiments, a transaction processing component may implement one or more public API endpoints that receive and process various requests, including without limitation money transfer requests, account management requests, requests to write or transmit records and/or transactions to a blockchain network, and other operational requests from wallet nodes and/or external systems. The component may process these requests by performing one or more traditional database operations-including operations to record transaction details, perform account updates, or make configuration changes—and may generate one or more entries written to an event messaging system directing the transaction writer component to write or transmit corresponding blockchain transactions to a blockchain network. For payment-related requests, in at least one embodiment, the transaction processing component may interact with one or more payment card networks to authorize charges, process refunds, or handle other card-related operations. In certain embodiments, the component may comprise a network connection to, or a means of exchanging messages with, various types of payment networks, including, without limitation, credit card networks, debit card networks, electronic funds transfer systems, automated clearing house (ACH) networks, wire transfer systems, online payment gateways, mobile payment platforms, digital wallet services, peer-to-peer payment systems, and other financial transaction processing networks.

According to various embodiments, the transaction processing component may maintain transaction, event and account state information in one or more traditional databases, with database entries potentially having multiple possible statuses including, but not limited to, pending and final status. A pending status may indicate that a blockchain operation is still in process, with an associated record or transaction not yet added to a block, or a block not yet final, while a final or confirmed status may indicate that the corresponding blockchain operation has been completed and confirmed final. According to an embodiment, a transaction processing component specifically, and a synchronization system generally, may track multiple balance values for accounts and/or addresses, including an available balance that reflects pending operations, records and/or transactions, and a current balance that reflects only finalized operations, records and/or transactions. In certain embodiments, various account operations and record/transaction processing decisions may depend on the state of relevant database records-—for example, new records and/or transactions may be rejected if an account's available balance would become negative, even if pending transactions have not yet been finalized.

In various embodiments, for payment card and other real-time payment operations, the transaction processing component may implement interfaces to one or more payment networks to enable real-time payment authorization and settlement. According to one or more embodiments, synchronization systems may process real-time payment authorizations by one or more of the following: a transaction processing component writing traditional database entries in a pending status; a transaction writer component generating appropriate blockchain records and/or transactions; the transaction processing component updating traditional database entries based on settlement messages received from payment networks; and a transaction reader component writing updates based on on-chain blockchain activity. In one or more embodiments, the transaction processing component may support multiple types of payment operations including, but not limited to, purchases, refunds, chargebacks, and card activation requests. Each such operation may involve multiple blockchain state transformations and traditional database updates as the operation progresses through various stages of completion.

In accordance with various embodiments, a transaction writer component may perform various functions, including, but not limited to, one or more of the following: (a) it may receive fully-formed blockchain records and/or transactions via an event messaging system, and may add these to a blockchain network transaction pool for eventual inclusion in new blocks; (b) it may monitor one or more event message queues for transaction creation requests from the transaction processing subsystem, and in response to such requests, may create and cryptographically sign one or more blockchain transactions and add these to a blockchain network transaction pool; (c) it may monitor the expiration of transactions that have not yet been incorporated into any block, and may generate replacement transactions in certain circumstances; (d) it may handle blockchain reorganizations by processing transaction reversals and re-submissions.

In one or more embodiments, one or more components of synchronization systems—including but not limited to the transaction writer component, the transaction reader component, or the message handler—may transmit status updates regarding expired and replacement transactions to various other subsystems via, for example, but not limited to, event messaging systems, web service notifications, or publish-and-subscribe mechanisms. Depending on the embodiment, they may implement timeout and retry mechanisms for operations that depend on external systems or blockchain confirmation, allowing operations to be cancelled or retried if they do not complete within expected timeframes.

According to one or more embodiments, in the event of a blockchain reorganization, where previously processed blocks are replaced by a different chain of blocks, the transaction writer component may identify affected transactions and initiate appropriate remedial actions. The component may evaluate whether re-submitted transactions require modified parameters, such as updated nonces or gas prices.

In one or more embodiments, a transaction writer component may maintain transaction queues to manage the ordering and timing of transaction submissions to the blockchain network. In several embodiments, these queues may ensure proper nonce ordering for transactions from the same account and may implement rate limiting or batching of transaction submissions.

### Block And Transaction Reading

In accordance with at least one embodiment of the present invention, a synchronization system may be implemented that includes one or more transaction reader components operating on one or more interface nodes. Such transaction reader components may monitor the blockchain network for new blocks and may process the records and/or transactions contained within such blocks as the blocks are added to the blockchain.

In one or more embodiments, said transaction reader component processing said records and/or transactions comprises the transaction reader component writing entries corresponding to records and/or transactions and/or other blockchain events to an event messaging system. As said entries are written to said event messaging system, a message handler (running concurrently, in parallel, or sequentially with the transaction reader) reads each transaction in turn. As the message handler reads each record or transaction, it may update one or more database entries in the traditional database system, including without limitation updating account balances, transaction status indicators, transaction histories, account and/or address configurations, user data associated with accounts and/or addresses, order books, sale and purchase orders, new token creation events, and token configurations.

In at least one embodiment, the message handler may identify whether processed transactions originated from interface nodes within the synchronization system (“endogenous” transactions) or from external sources (“exogenous” transactions), and may update the traditional database system differently depending on the origin of such transactions. Furthermore, in various embodiments, the message handler may, upon reading an entry from the event messaging system, communicate with other systems over a network—for instance, by calling APIs, invoking webhooks, or utilizing other communication protocols—to exchange data, execute algorithms, trigger events, or coordinate operations, possibly enhancing interoperability and integration with third-party services or applications.

In various embodiments, the one or more synchronization systems may implement one or more strategies to handle blockchain reorganizations, including without limitation rewinding database updates that were performed in response to transactions that are eliminated due to blockchain reorganization. Such rewinding processes may, in at least one embodiment, distinguish between transactions that have not yet reached finality and transactions that have reached finality, implementing different reversal strategies in each case. For transactions that have not yet reached finality, the rewinding process may return database entries to their previous state and may re-queue transactions (for example, endogenous transactions) for re-submission to the blockchain. For transactions that have reached finality, the rewinding process may generate compensating database entries to reverse the effects of eliminated transactions while maintaining a record of such transactions and their reversals.

The interface nodes implementing the synchronization system may, in various embodiments, communicate with each other and with the blockchain network using one or more event messaging systems. Such event messaging systems may enable the interface nodes to coordinate their activities and to ensure that database entries remain synchronized across various synchronization systems. In at least one embodiment, an event messaging system may be used to transmit information about pending transactions, finalized transactions, and blockchain reorganizations between interface nodes. The event messaging systems may also be used to coordinate the re-submission of transactions that are eliminated due to blockchain reorganization.

In accordance with at least one embodiment of the present invention, the synchronization process may proceed in a series of one or more distinct steps. A transaction reader component operating on one or more interface nodes may first detect that a new block has been added to the blockchain. The transaction reader component may examine each record and/or transaction contained within the new block; for each record and/or transaction, the transaction reader component may generate one or more entries in an event messaging system reflecting a pending status for that blockchain record or transaction. These database entries may include one or more of the following elements, without limitation: the block number of the block containing the transaction, a transaction identifier, source and destination account information, token type and quantity information, and current status information.

In one or more embodiments, an additional type of transaction reader component may be implemented which read records and/or transactions from the pending transaction pool (mempool) of a blockchain network, before they have been included in any block. In certain embodiments, records and/or transactions read from the mempool may be added to a traditional database in a “pending but not yet accepted” status, in a similar manner as new endogenous records and transactions. By incorporating these pending transactions into the traditional database sooner, a synchronization system can prevent conflicts making provisional updates-such as updates to an account or address' available balance-before the transactions are confirmed on the blockchain. This approach allows for earlier detection of potential conflicts (such as double-spending) and enhances the consistency between the blockchain network and off-chain database systems. Conversely, exogenous transactions in certain alternate embodiments may only be known to the synchronization system when the transaction is detected within a block.

In accordance with at least one embodiment, as said records and/or transactions are written to one or more event messaging systems by one or more transaction reader components, said records and/or transactions may be read by one or more message handlers. Upon detecting a blockchain record or transaction that comprises a transfer of value between one or more accounts managed by synchronization systems, said one or more message handlers may update the traditional database, recording that transfer as a database object in a pending status. The transfer may persist in a pending status until the record or transaction reaches finality, which may occur after a configurable number of blocks have been added to the blockchain following the block containing the record or transaction, determined according to various heuristics or algorithms, depending on the embodiment. While the transfer remains in pending status, the available balance of the source/sending account may be decreased to reflect the pending outflow, but the current balance may remain unchanged until finality is deemed to be reached. After finality is deemed to be reached, according to the embodiment, the one or more synchronization systems may update the database entries to reflect that the transfer has been finalized, potentially updating both available and current balances.

Records and/or transactions that perform transformations of global blockchain state other than transfers of value may also effectuate provisional updates and insertions within the traditional database system when first read by a message handler; the traditional database entries corresponding to such records and/or transaction would only be updated to reflect a final status when such records and/or transactions are deemed final.

In certain embodiments, two message handlers may read from the same event messaging system, one at an offset from the other. The first message handler may treat each record or transaction as pending, and would make appropriate updates and insertions in the traditional database system to reflect a provisional status. The second message handler may read each transaction at an offset equal to a finalization block depth or finalization time duration, such that each transaction would be finalized when read. The second message handler would perform a finalization update for every traditional database entry corresponding to a record or transaction that had been read, so as to reflect a non-provisional or final status (for instance, by causing a balance change made to available balance to also be reflected in current balance).

In one or more embodiments, the synchronization process may vary depending on whether the record or transaction originated from within the synchronization system (“endogenous”) or from an external source (“exogenous”). For endogenous records or transactions transferring or otherwise using funds out of an account or address, an available balance may be reduced—or the traditional database state may be otherwise provisionally updated-before the transaction is submitted to the blockchain network, and a database entry tracking said endogenous records or transactions may be placed into a pending status within the database. In several embodiments, the synchronization system may update the database entries pertaining to exogenous records and/or transactions upon detection within a new block, potentially recording the block number and updating status information, but maintaining the pending status until finality is reached. In one or more embodiments, endogenous records and/or transactions may be received and/or generated by a transaction processing component or a transaction writer component, while exogenous records and/or transactions may be first detected and/or processed by a transaction reader component or a message handler.

### Reorganization Handling

In accordance with various embodiments of the present invention, one or more interface nodes of the one or more synchronization systems may implement a multi-step procedure to maintain synchronization between blockchain and traditional database systems in the event of a reorganization.

Various embodiments of the present invention may utilize an event messaging system that maintains an ordered sequence of blockchain events, including blocks, records and/or transactions, even after they have been synchronized with a traditional database system, thereby preserving the original processing order within the event messaging system itself. When interface nodes detect a blockchain reorganization event, by, for example observing that a newly-received block references a different previous block hash than the last block processed, they may append a “reorganization marker” to this ordered sequence to indicate the position of the last common block shared between the old and new blockchain forks, and then begin appending new blocks from the reorganized chain. Message handlers monitoring the data structure, upon encountering the reorganization marker, initiate a “rewind” process by iterating backwards through the preserved event sequence to the last common block, enabling precise reversal of state transitions affected by the reorganization. After completing the rewind, message handlers process the newly appended blocks, records and/or transactions following the reorganization marker, potentially comparing them against a transaction tracker component to identify transactions that may need to be regenerated or resubmitted, thus facilitating accurate reconstruction of the database state.

In some embodiments, a transaction reader component of an interface node may first detect a reorganization event by observing that a newly-received block references a different previous block hash than the last block processed. The transaction reader may then iterate backwards through previously-processed entries corresponding to records, transactions, blocks and/or other blockchain events stored by an event messaging system until discovering a “last common block” that exists in both the old and new blockchain forks. The transaction reader may also, during the same iteration, or in a separate iteration over the same data, construct a list of entries potentially subject to reversal and re-submission or re-processing (the reversal entries).

In an alternate embodiment, the transaction reader my discover the last common block and construct the list of reversal entries though a direct interaction with one or more block-building nodes; in yet another version, a message handler may undertake either approach.

Upon identifying this last common block, the transaction reader may, in some implementations, add a reorganization marker to the event messaging system with information regarding the reorganization. In one or more embodiments, the transaction reader component may append to the event messaging system each of the reversal entries, in reverse order, such that by progressing forward through the entries a consumer would move backwards through the history of the blockchain's execution. Upon adding a reorganization marker to the event messaging system and/or appending the reversal entries to the event messaging system, the transaction reader may, in one or more embodiments, re-initiate its previous block-reading activities, and process the blocks of the previously-unknown fork starting from the block following the “last common block”. In one or more embodiments, concurrent with, parallel with or subsequent to this reorganization processing by the transaction reader component, the one or more message handlers may then process the reorganization by iterating forward through the reversal entries, initiating a reversal operation of each reversal entry against corresponding data in the traditional database system.

In various embodiments, the specific nature of each reversal operation performed by the message handler may depend on whether corresponding records and/or transactions have achieved finality. For non-final records and/or transactions, the message handler may in some embodiments revert pending status of a database entry and place affected records, transactions or other blockchain events back into a “pending but not yet accepted” status, which may be indicative of records, transactions and/or other blockchain events that have been proposed but have not yet been including in any block. For final records and/or transactions, one or more message handlers may instead generate reversal records in the traditional database system while leaving the original database entries in place, potentially also applying certain modifications, but without reversing the entry entirely. In certain embodiments, account balances in may potentially be allowed to become negative, either only in the traditional database system, or in both the traditional database system and the blockchain global state. After processing the reversal entries, one or more message handlers may proceed to process entries corresponding to new blocks from the reorganized chain, potentially comparing newly-processed transactions against the records, transactions and/or blockchain events added to a transaction tracker component, so as to identify records, transactions and/or blockchain events that may potentially need to be re-applied to the traditional database state, and/or may potentially need to be re-submitted to the blockchain network.

In one or more embodiments, either the transaction reader or the message handler may potentially add individual reversed records and/or transactions to said transaction tracker component, while either process iterates through the reversal entries as per its respective process. Following a reorganization, after the message handler has processed all reversal entries and then all entries corresponding to records and/or transactions of new blocks introduced by the reorganization, the synchronization systems may initiate a process to once again add to the blockchain one or more records and/or transactions still remaining with the transaction tracker component, which process may also involve a transaction writer component or other component, depending on the embodiment.

In various embodiments of the present invention, the synchronization system may also implement special handling for endogenous transactions during reorganization processing. In certain embodiments only endogenous transactions that may be added to the transaction tracker component, particularly in embodiments where such transactions may need to be re-submitted to the blockchain. In an alternate embodiment, both endogenous and exogenous records and transactions may be added to the transaction tracker component, but endogenous transactions are handled in a different manner.

After a synchronization system attempts to submit remaining records and/or transactions of the transaction tracker component to the blockchain, the synchronization system may, in some embodiments, attempt to regenerate one or more of any remaining endogenous records and/or transactions, potentially with updated nonce values and expiration dates. This may occur in an embodiment if the original records and/or transactions have expired or have become invalid without first being successfully incorporated into a block. In certain implementations, interface nodes may also split larger transactions into one or more smaller transactions during regeneration, or may otherwise make other modifications to these replacement records and/or transactions, particularly in cases where reduced account balances or other features of said records and/or transactions may have prevented the originals from being processed. Through this coordinated processing of reorganization events, one or more embodiments of the present invention may maintain consistency between blockchain and traditional database system state while preserving the intent of endogenous transactions wherever possible.

In some embodiments of the present invention, said one or more synchronization systems may implement additional compensating actions related to reorganization processing. In certain implementations, account operations may be frozen or restricted when reorganization causes account balances to become negative. Interface nodes may also, in some embodiments, implement an “exposure limit” mechanism that caps the total value of non-final transactions that may be processed for a given account, thereby limiting potential losses from reorganization events. Various implementations may also include notification mechanisms to alert system operators and/or end users when reorganization events occur, particularly in cases where such events affect transactions previously considered final. Through these various mechanisms, operating individually, or in coordination, embodiments of the present invention may provide robust handling of blockchain reorganization events while maintaining synchronization between blockchain and traditional database systems.

### Expiration

In accordance with at least one embodiment of the present invention, blockchain records or transactions may be configured to include an expiration time or expiration block height, after which the records or transactions may no longer be considered valid according to the blockchain protocol. This expiration capability may provide significant advantages over transactions or records that do not specify any expiration, given that non-expiring transactions may potentially be executed at any time after they are signed unless explicit double-spend prevention techniques are employed. For instance, and without limitation, if a first transaction is signed but not immediately added to the blockchain, a user may have difficulty constructing a second transaction that spends or otherwise interacts with a source account's balance. In some embodiments, a second transaction cannot be included without either blocking the first transaction, or succeeding it on the blockchain, due to the known technique of implementing a sequential transaction counter for addresses and/or accounts. In other embodiments, the second transaction may not block or depend on the first, but may nonetheless use the same token balance, leading to an indefinitely confusing contingency. By incorporating expiration times or expiration block heights, various embodiments of the present invention may prevent such scenarios.

In at least one embodiment, when a transaction or record includes an expiration time or block height, the blockchain network may reject as invalid any attempt to add that transaction or record to the blockchain after the specified expiration. This may enable the synchronization system to identify and handle expired transactions without requiring complex coordination between interface nodes. For instance, and without limitation, if a transaction expires before being added to any block, the synchronization system may detect this expiration and may automatically update database entries to reflect that the transaction has been canceled. In some embodiments, the synchronization system may attempt to re-generate expired transactions with new expiration times, potentially implementing various strategies to maximize the probability that re-generated transactions will be successfully added to the blockchain.

Various embodiments may implement different strategies for selecting appropriate expiration times or expiration block heights. These strategies may be contingent on, without limitation, estimated block generation times, network congestion levels, transaction and/or record priority, blockchain fees/pricing, and historical transaction processing times. The expiration time or expiration block height may, in at least one embodiment, be selected to provide sufficient time for the transaction to be added to the blockchain under normal operating conditions while still preventing indefinite transaction validity. The synchronization system may, in several embodiments, monitor transaction expiration and may implement various strategies to handle cases where transactions are at risk of expiring, potentially including, without limitation, re-generating records and/or transactions with extended expiration times and/or increased transaction fees, or simply allowing such transactions and/or records to expire.

In accordance with at least one embodiment of the present invention, when a wallet node connected to the synchronization system, or when an interface node within the synchronization system generates a record or transaction, said record and/or transaction may be configured with an expiration time or expiration block height. An interface node may then create database entries reflecting a pending status for said record or transaction, including the expiration time or block height. In certain embodiments, these database entries may affect available balances immediately, even before the transaction is added to any block, in order to prevent duplicate spending.

Subsequently, in various embodiments, an expiration detection routine implemented in one or more interface nodes of a synchronization system may monitor both the blockchain network and pending database entries in order to identify expired transactions. Upon detecting an expired transaction, said synchronization system may initiate an expiration handling procedure.

In an embodiment, following detecting an expired transaction that has not yet been added to any block, an expiration handling procedure may include one or more of, without limitation: updating database entries to reflect that the transaction has been canceled due to expiration, reversing any changes made to available balances when the transaction was initiated, and/or potentially initiating generation of a new transaction to replace the expired transaction, depending on the nature of the embodiment, and depending on the type or configuration of the expired record or transaction. In an embodiment, the expiration handling procedure may also trigger notifying other interface nodes about the expired transaction, enabling those nodes to update their database entries accordingly.

Conversely, in possible embodiments, upon detecting a record or transaction that has been added to a block, but which has not yet reached finality, where such record or transaction has a configured expiration date occurring in the past, an interface node of said synchronization system may implement a different expiration handling procedure. This procedure may include, without limitation, monitoring subsequent blocks to determine whether the expired transaction is eliminated from the blockchain due to reorganization, and potentially initiating generation of a new transaction only if the expired transaction is subsequently eliminated. As with other records and/or transactions not yet finalized, in one or more embodiments, the synchronization system may maintain the database entry associated with such records and/or transactions in a pending status until either finality is reached, or the record or transaction is eliminated from the blockchain in a reorganization.

In at least one embodiment, the synchronization system may implement retry procedures for expired transactions. These procedures may vary depending on the circumstances of expiration. For instance, and without limitation, if a transaction expires due to network congestion before being added to any block, the synchronization system may generate a new transaction with an increased transaction fee and an extended expiration time. However, if a transaction expires after being added to a block but before reaching finality, the synchronization system may wait to determine whether that transaction will be finalized (or, alternately, removed from the blockchain in a reorganization) before attempting to generate a replacement transaction. The retry procedures may implement various strategies to prevent duplicate transactions and to ensure that replacement transactions are properly sequenced.

The synchronization system may also, in various embodiments, maintain historical records of expired transactions and their replacements. These records may be used to implement various monitoring and reporting functions, potentially including without limitation: identifying patterns of transaction expiration, evaluating the effectiveness of different expiration time selection strategies, and generating alerts when transaction expiration rates exceed configured thresholds. The historical records may also be used to prevent duplicate transaction submission and to ensure proper sequencing of replacement transactions.

In various embodiments of the present invention, the synchronization system may incorporate additional handling to address transaction and/or record expiration during reorganization processing. During reorganization processing, one or more interface nodes may need to evaluate whether tracked transactions have expired or will expire before they can be re-submitted to the blockchain network. In certain embodiments, removed/eliminated transactions that have not expired may be added again to the blockchain after a reorganization, while transactions that have already expired may require special handling or cancellation.

In accordance with certain aspects of the present invention, interface nodes may implement different expiration handling procedures depending on the type of transaction being processed. For endogenous transactions originating from interface nodes of the synchronization system or related systems, one or more interface nodes may attempt to regenerate expired transactions with new expiration values, particularly in implementations where the original transaction intent can still be fulfilled. When regenerating such transactions, interface nodes may in some embodiments also update other transaction parameters such as gas prices and nonce values to improve the probability of successful processing. For exogenous transactions originating from external sources, one or more interface nodes may instead need to cancel or reverse expired transactions and potentially initiate compensating updates to data within the traditional database system, such as reversing pending status changes or notifying external systems of the expiration.

Various embodiments of the present invention may also implement special handling for expired records and/or transactions in the event of a reorganization. In some implementations, a reorganization event may result in transactions to expiring before they can be reprocessed, particularly in cases where the original expiration values were close to the current block height. Interface nodes may, in certain embodiments, implement a “time buffer” mechanism that ensures that records and/or transactions they generate have sufficient time to be processed before expiration. Some implementations may also include retry logic that attempts to reprocess expired transactions multiple times with progressively larger expiration windows before considering them permanently failed.

### Smart Contract Synchronization

In accordance with at least one embodiment of the present invention, the synchronization system may process smart contract executions detected within blocks added to the blockchain. When processing a block containing a smart contract execution, a transaction reader component may examine log entries generated during that execution to identify token movements and other state changes affecting accounts managed and/or tracked by the synchronization system. In various implementations, these log entries may be processed to generate corresponding database entries within the synchronization system, potentially implementing various strategies to process smart contract execution pending and finalized states for effects of smart contract execution.

In accordance with various embodiments of the present invention, a smart contract is a program that executes on a blockchain network's virtual machine environment-such as the Ethereum Virtual Machine (EVM), WebAssembly (WASM), or similar execution platforms. Smart contracts may be Turing-complete, depending on a gas budget to limit execution time, or they may not be Turing-complete, potentially lacking loop or recursion capabilities, as in the case of Bitcoin Script. These programs are composed of executable code and, depending on the embodiment, may define functions and state variables. In one or more embodiments, smart contracts may perform computations, manage data storage, and interact with other contracts or accounts or addresses on the blockchain. Smart contracts operate deterministically, meaning that given the same input and state, they will produce the same output and state changes across all nodes in the network.

A contract execution record or transaction refers to the data generated when a smart contract is invoked or executed on the blockchain network through the inclusion of a specialized record or transaction in a new block. In various embodiments, this transaction may include details such as the sender's address, the recipient's address (which may be a smart contract), input data (such as function calls and parameters), and computational resource metrics such as gas budget, which may be directly specified or derived from other values. The execution of the transaction results in the execution of the smart contract, effectuating state transformations resulting from the execution of the smart contract code.

In an embodiment of the present invention, a block-building node generates a receipt in the process of executing a smart contract. This receipt may comprise details including, but not limited to: a transaction hash, a block number, gas consumed, execution status (success or failure), state changes to accounts or storage variables, execution timestamp, sender and recipient addresses, possible output data produced by the smart contract functions, and emitted logs or events. By generating and recording this receipt, the block-building node provides a verifiable record of the smart contract's execution, which can be stored on the blockchain ledger and accessed for auditing, confirming transaction outcomes, and ensuring the integrity of operations within the blockchain network.

In one or more embodiments, each state transformation effectuated by a smart contract execution may correspond to a log entry included in the receipt. Because all state transformations effectuated by a smart contract execution are encoded as log entries in the receipt, in at least one embodiment the synchronization system may not need to predict or simulate the outcome of that execution in order to synchronize said state modifications with one or more traditional database systems. Rather, the synchronization system may, in at least one embodiment, read and process said log entries in the manner described elsewhere herein as pertain to the synchronization system's record and/or transaction processing.

In one or more embodiments, the synchronization system may process smart contract state transformations in a manner equivalent to the state transformations effectuated by individual records and/or transactions. In a manner comparable to the handling of records and/or transactions, in one or more embodiments, these log entries may be read by a transaction reader, they may be written to an event management system, and upon being read by a message handler, they effectuate the creation, modification or configuration of database entries tracking value transferred between and among accounts as a result of the smart contract execution. In at least one embodiment, these database entries may include references to the original smart contract invocation, potentially enabling the synchronization system to link related elements and potentially track the provenance of value transfers resulting from smart contract execution. In certain embodiments, database entries are also configured with a reference to the individual log entries that they correspond to. In at least one embodiment, one or more state transformations that may be effectuated by a smart contract execution may correspond on a one-to-one basis to one or more analogous record or transaction types that effectuate the same one or more state transformations.

In at least one embodiment, database entries generated and configured according to this process may be assigned the block number or block height of the block containing the execution record or transaction that generated the corresponding log entries. In various embodiments, these records may be subject to the same finality requirements as other blockchain transactions, potentially remaining in a pending status until this block has been deemed final by the synchronization system.

In accordance with at least one embodiment of the present invention, the synchronization system may perform one or more different operations, including but not limited to the following: first, the synchronization system may update the database entries for the original transfer to include the block number; second, the synchronization system may examine log entries generated during the smart contract execution to identify any transfers or other effects relevant to accounts managed by the synchronization system. third, for each relevant log entry, the synchronization system may generate new database entries tracking those effects.

The transaction reader process may, in various embodiments, handle different types of log entries in specific ways. For log entries indicating transfers to managed accounts, the process may generate pending in-transfer records and may increase the available balance of the destination account. For log entries indicating transfers from managed accounts, the process may generate pending out-transfer records and may verify that sufficient balance remains available. In at least one embodiment, all database entries generated from log entries may be assigned the block number of the block containing the smart contract execution, and may remain in a pending status until that block reaches finality.

In one or more embodiments, the synchronization system may maintain detailed audit records of all smart contract interactions and their effects. Such records may include, without limitation, the original invocation transaction, all generated log entries, all subsequent database entries and balance updates, and any reorganization events affecting those records. In at least one embodiment, these audit records may enable the synchronization system to reconstruct the complete history of any smart contract interaction, potentially including all intermediate states and any subsequent modifications or reversals. This audit capability may be particularly valuable when troubleshooting complex smart contract interactions or when investigating suspected errors in the synchronization process.

### Third-Party Payment For Requests, Records, Or Transactions

In various blockchain systems, cryptographic signatures are essential for authorizing updates to the global state of a blockchain network. Specifically, any record or transaction that intends to modify the blockchain's state may need to be authenticated using a cryptographic signature. This signature may be generated using a private key associated with an originating account or address, ensuring that only the legitimate owner of an account or address can authorize actions affecting assets or data owned by, controlled by, or otherwise belonging to that account or address. The use of cryptographic signatures may serve as a security mechanism to prevent unauthorized modifications by malicious actors, thereby maintaining the integrity and trustworthiness of the blockchain network.

For example, when a user wishes to transfer tokens from their account to another, they may need to create a record or transaction and sign it with their private key. The cryptographic signature may serve to verify the authenticity of the transaction and prove that it was authorized by the account holder. Similarly, deploying a new smart contract or executing a function within an existing smart contract may require the initiator to sign the transaction. By enforcing the use of cryptographic signatures for these types of updates, blockchain networks may ensure that all changes to the global state are properly authorized and can be independently verified by all participating nodes.

In many blockchain networks, transaction fees, also called gas fees, may be required for executing and validating transactions and smart contracts. These fees may typically be paid by the originator of the transaction, who pays to cover the computational resources used. This mechanism may improve the efficient allocation of network resources and may deter malicious activities by imposing costs on network use. However, it may also present a challenge when one party wishes to pay fees on behalf of another. For example, a service provider may want to sponsor transaction fees to enhance user experience or promote adoption of a decentralized application. Known protocols require the sender's account to have enough balance to cover the fees. This complicates scenarios where end-users lack tokens required to pay fees or when simplifying blockchain interactions is desired.

To address this challenge, one or more embodiments of the present invention implement a two-phase process, whereby a blockchain record or transaction is first signed by the originator of the blockchain operation and is then signed by a separate account that pays the transaction fees.

In accordance with at least one embodiment of the present invention, a synchronization system or interface node may be implemented that enables one or more blockchain records to be submitted to a blockchain system by one or more wallet accounts, where such records may include signatures authorizing transfers or other state changes, but where blockchain processing fees for such records may be paid by one or more accounts or addresses controlled by the synchronization system or interface node, instead of accounts or addresses controlled by the one or more wallet accounts.

In at least one embodiment, the synchronization system may receive one or more signed records from a wallet account, where the one or more signed records have been cryptographically signed using a private key associated with one or more source accounts or addresses. The synchronization system may then encapsulate or wrap the records within a new blockchain transaction, which transaction may be signed by a private key controlled by the synchronization system or interface node, and which transaction may provide for payment of blockchain processing fees. The synchronization system may then transmit the new blockchain transaction to one or more blockchain nodes for validation and inclusion in a new block. In this way, wallet accounts may be relieved of the burden of maintaining a balance of native blockchain tokens used for payment of processing fees, as the synchronization system may pay such fees on behalf of the wallet accounts. The signed records submitted by wallet accounts may include, but are not limited to, transfer records moving token value between accounts, smart contract invocations, configuration records modifying account settings, updates made to identity information stored on accounts, and other records affecting blockchain state.

In at least one embodiment of the present invention, a synchronization system or interface node may receive one or more signed records submitted from one or more wallet accounts, and may aggregate or group those records as constituent records within a composite transaction. The composite transaction may then be configured by the synchronization system or interface node to ensure that blockchain processing fees are paid by accounts or addresses controlled by the synchronization system, covering the fees for executing the one or more constituent records, while the underlying constituent records remain signed by private keys controlled by the one or more wallet accounts that originated those records. This configuration enables the composite transaction to maintain cryptographic proof of authorization by the originating wallet accounts while delegating payment of processing fees to the synchronization system or interface node.

In accordance with at least one embodiment of the present invention, requests submitted by wallet nodes to an interface node may comprise one or more constituent records to be incorporated into atomic records or atomic transactions, which atomic records or atomic transactions may be encoded in a manner that ensures said one or more constituent records will be executed together along with an atomic transaction envelope, as per the blockchain protocol. The constituent records submitted to the interface node may thus be wrapped or encapsulated within an atomic transaction signed by the interface node, which atomic transaction provides for payment of blockchain processing fees by an account controlled by the interface node. In one or more embodiments, the interface node may configure atomic transaction records and atomic record chains to ensure that blockchain processing fees are paid by one or more accounts or addresses controlled by the interface node, while the underlying constituent records remain signed by private keys controlled by the one or more wallet accounts that originated those records. In this way, cryptographic proof of authorization by the wallet accounts may be maintained while delegating fee payment responsibility to the interface node. In one or more embodiments, said interface node constitutes a portion of, or comprises, a synchronization system.

In one or more embodiments, the composite transactions and/or the atomic transactions may also be configured with additional validation rules, criteria or conditions that may need to be satisfied before the constituent records may be processed, which rules, criteria or conditions may include, without limitation: requiring certain blockchain account annotations to be present; requiring certain token balances to be available; requiring certain smart contract conditions to be met; defining dependencies between constituent records that are satisfied for successful processing; requiring that the constituent records be executed on an all-or-nothing basis; requiring that the constituent records execute until the first record that fails; and/or requiring other configurable criteria to be satisfied.

In an alternate embodiment, rather than encapsulating or wrapping the original signed record with a new transaction, the synchronization system or interface node may append an additional cryptographic signature to the original record, where the additional signature is interpreted by the blockchain protocol of the blockchain network as belonging to a separate account that is responsible for paying transaction fees of the original record.

According to certain embodiments, instead of receiving signed records as part of requests submitted from wallet nodes, a synchronization system comprising one or more computer devices may read atomic transactions and/or composite transactions from a pending transaction pool of a blockchain network, and unwrap the constituent records encapsulated by said atomic transactions and/or composite transactions. The synchronization system may then encapsulate or wrap said constituent transactions again with a new atomic transaction or composite transaction, which new atomic transaction or new composite transaction may include a transaction fee paid by an account or address controlled by the synchronization system, before writing, sharing or transmitting said atomic transaction or composite transaction on the blockchain network. By this method said synchronization system may offer a service of paying for blockchain records and/or transactions without those records and/or transactions needing to be submitted directly to said synchronization system.

In various embodiments, one or more synchronization systems may accept one or more forms of compensation from the users of wallet accounts for the payment of blockchain processing fees and other services. Such compensation may be received in advance of any services being rendered, or may be received in arrears after services have been performed, or may be drawn from one or more funding accounts maintained by users with the synchronization system. The compensation may be provided in various forms including, but not limited to: official currency deposits, cryptocurrency transfers, credit card payments, automated clearing house (ACH) transfers, wire transfers, bank-to-bank transfers, prepaid value cards, electronic payment systems, mobile payment applications, digital wallet transfers, merchant services payments, remittance networks, app-store payments, mobile payments, or other electronic value transfer mechanisms. Said one or more synchronization systems may, in at least one embodiment, maintain records of services provided and fees paid, and may implement various accounting and reconciliation processes to ensure proper tracking of compensation received and services rendered; such accounting and reconciliation processes may, certain embodiments, track payments made and services rendered according to the one or more blockchain accounts or addresses of its users and/or customers. The synchronization system may optionally implement different fee structures, payment schedules, and compensation arrangements for different users, user categories, or transaction types. In some embodiments, the synchronization system may automatically draw required compensation from designated funding sources when balances fall below specified thresholds, or may implement various automated billing and collection processes for compensation owed.

According to various embodiments, a synchronization system or interface node may implement a message authentication system comprising one or more application programming interfaces (APIs) that accept requests signed using cryptographic keys associated with blockchain accounts. The system may authenticate such requests by verifying that messages have been cryptographically signed using private keys corresponding to public keys recorded within the blockchain for the accounts initiating such requests. In at least one embodiment, an API request message may include a payload containing the details of the requested operation, a signature generated by signing said payload with a private key, and information identifying the account making the request. The system may verify the signature against the public key associated with the identified account before processing the request. In an embodiment, a request may be an HTTP or HTTPS request, the payload may comprise the body of an HTTP or HTTPS message combined in a deterministic way with certain metadata and/or certain HTTP or HTTPS header data, while the cryptographic signature may be included along with the account information as one or more fields of the HTTP or HTTPS header. The message signing protocol may be implemented using various cryptographic schemes including asymmetric key cryptography, elliptic curve cryptography, or other suitable cryptographic methods. Such signed API requests may be used in various embodiments for various operations including, but not limited to: submitting transactions, querying account information, requesting blockchain status updates, managing account settings, initiating token transfers, deploying smart contracts, updating account configurations, managing identity information, and other account-related operations.

In accordance with at least one embodiment, the blockchain system may associate signed API requests with payment accounts or payment arrangements, such that requests properly signed by accounts having payment arrangements may be automatically accepted and processed. The system may maintain records linking blockchain accounts to payment methods, payment accounts, or compensation arrangements. When a signed API request is received from a wallet or other client application, the system may verify both the cryptographic signature and the existence of valid payment arrangements for the signing account. If both the signature is valid and payment arrangements are confirmed, the system may process the request and perform any associated operations, with fees being charged according to the established payment arrangements.

In at least some embodiments, a synchronization system or interface node may pay blockchain transaction fees, API request fees, or other service fees on behalf of wallet accounts without requiring direct compensation, in order to achieve various business objectives. Such objectives may include incentivizing adoption of the blockchain system by new users, encouraging increased transaction volume, promoting specific token types or smart contracts, supporting promotional campaigns, or enabling access to other revenue-generating services. The synchronization system or interface node may implement different fee payment policies for different categories of users, time periods, geographic regions, or blockchain operations. The payment of fees may be subject to various conditions such as maximum amounts, time restrictions, volume caps, or service utilization requirements. The synchronization system or interface node may dynamically adjust these policies based on factors including network congestion, fee rates, user behavior patterns, marketing objectives, or system economics.

### Synchronization System Illustrations

In accordance with at least one embodiment of the present invention, and with reference to FIGS. 12A and 12B, a synchronization system (1200) may include one or more transaction reader components (1202) that monitor a block-building node or validator node (1201) for new blocks. The transaction reader components may write information about new blocks, records and/or transactions to one or more event messaging systems (1206), which may include entries labeled in the diagram with version and fork information (e.g., blvlt1, blvlt2, etc.). The transaction reader (1202) may comprise components responsible for reading from the event messaging system(s) (1205) and for writing to the event messaging system(s) (1203). In an example implementation, said event messaging system (1206) may be implemented as an Apache Kafka instance comprising various topics. At least one message handler (1207) may read entries from the event messaging system(s) (1206). The message handler may delegate all or a portion of this responsibility to one or more handler delegates (1209, 1210, 1211, 1212, 1215, 1216) that each are implemented to handle specific types of record or transaction. The message handler and message handler delegates may be responsible for updating the traditional database system (1226) which comprises account and address data storage, so as to reflect whatever state transformation may be encoded in the event messaging system entry they are handling.

According an embodiment, the synchronization system illustrated in FIGS. 12A and 12B may implement specific procedures for handling blockchain reorganizations. When a reorganization is detected, the transaction reader (1202) may write (1203) reversal entries to the event messaging system (indicated as blvlt1_rev, blvlt2_rev, etc.) which entries are then processed by the message handler (1207) and one or more handler delegates (1210 1215, 1216) specifically responsible for reversal events. These reversal handler delegates operate on the traditional database system (1226) which (as stated above) comprises account and address data traditional database, to temporarily store reversed records and/or transactions subject to re-entry. Said message handler and handler delegates may process incoming blockchain events, validate transaction parameters, update account balances in the RDBMS, and maintain pending transaction records until finality is reached.

A cleanup component (1208) may be implicated in the reorganization-handling process at the final stage, after all the new fork's blocks, records, transactions, and/or events have been processed by the message handler (1207) and its delegates. Said cleanup component (1208) may read all the records, transactions and/or events that remain in the transaction tracker component (1213) and evaluate them for re-creation or re-introduction to the blockchain. The cleanup component will add eligible records, transactions and/or events from the transaction tracking component to a write-to-blockchain event messaging system (1214) that is monitored by a transaction writer component (1218) responsible for submitting new transactions to the blockchain network.

In addition to the cleanup component (1208), in one or more embodiments a transaction processing component (1217) may also add record, transaction, and/or event entries to the write-to-blockchain event messaging system (1214), with the intent of passing them to the transaction writer component (1218) for them to be submitted to the blockchain network.

For transactions that expire before being added to the blockchain, one or more embodiments may implement specific handling procedures through an expiration handler component (1223), which may construct new records or transactions as replacements of original expired records or transactions; in at least one embodiment, such new records and/or transactions may include an “excludes” field referencing the original transaction, potentially preventing both transactions from being added to the blockchain simultaneously. Another component (1222) may create new transactions based on system events or requirements. The system may update a traditional database system (1226) when constructing new transactions, potentially implementing various strategies to ensure that the new transaction remains valid given current blockchain state. New transactions may be submitted to the mempool of the blockchain network (1221) for inclusion into the blockchain.

The system may also include a component (1219) for writing or transmitting wallet-generated records and/or transactions with the blockchain network (1221), as well as a component (1220) for writing or transmitting records and/or transactions that need to be re-submitted to the blockchain because they were eliminated in a prior reorganization.

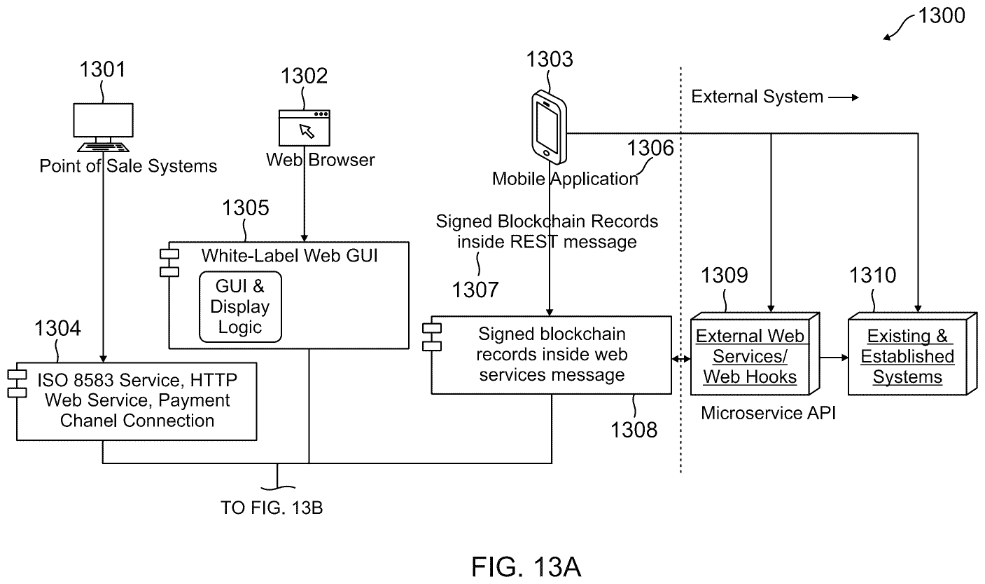

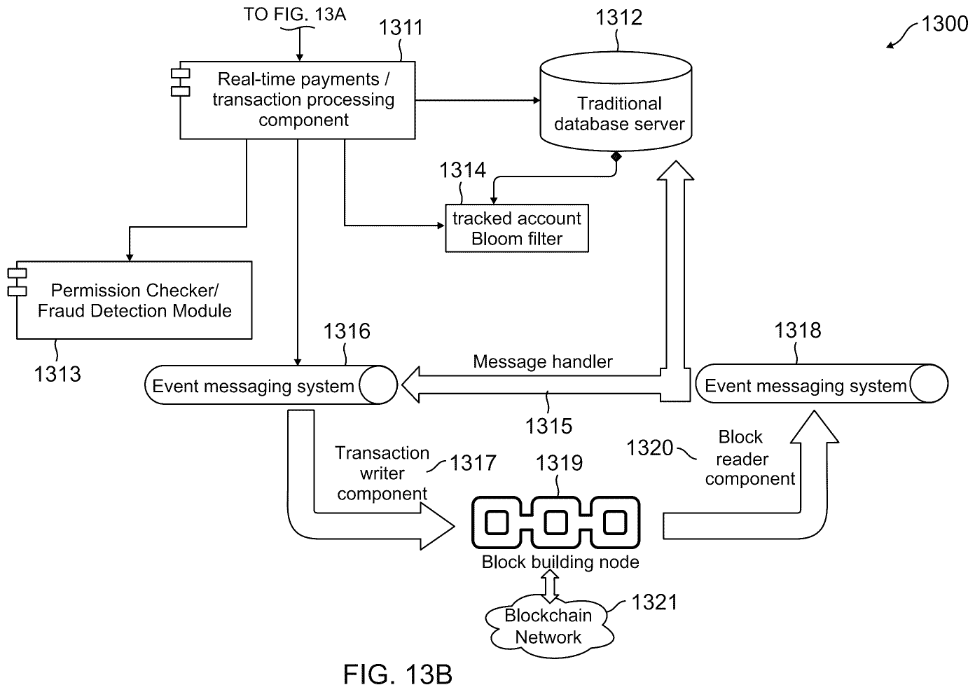

FIGS. 13A and 13B are diagrams of synchronization system (1300), according to an embodiment. The synchronization system 1300 may include a point of sale system (POS) (1301) comprising a user interface that provides means for, among other things, the acceptance and origination of payment transactions, payment messages, payment requests, and/or payment instructions. Said POS may relay such payment-related elements to—or coordinate regarding the origination of such payment-related elements with—a transaction processing component (1311) of the synchronization system (1300) using various interfaces and/or protocols, such as ISO 8583 service, HTTP web service, or payment channel connection (1304).

The synchronization system (1300) may also interface with a web browser (1302) displaying a White-Label Web GUI (1305) rendered by the synchronization system. In various embodiments, said White-Label Web GUI may implement a user interface providing user access to transaction history data and/or provide means to modify system configuration.

A mobile device (1303) acting as a wallet node may execute a mobile application (1306) which may generate, sign, send, and/or transmit one or more payment messages, payment transactions, blockchain records, blockchain transactions, and/or other messages or communications or combinations thereof. Such communications may include the transmission of signed blockchain records (1307) transmitted inside messages of a web service protocol, which in example embodiments may be implemented using, for instance, “representational state transfer” (REST) or “javascript object notation remote procedure calls” JSON-RPC or a similar HTTP or HTTPS protocol, or another networking protocol.

In certain embodiments, said mobile device (1303) may also communicate with one or more external systems (1309, 1310) which operate outside the synchronization system but connect to it via one or more web services or microservice APIs, including systems that may implement web Services and/or web hooks (1309) and other existing and established systems (1310).

In an example implementation, the POS (1301) may exchange HTTP web service message packets (or packets of another protocol) with a transaction processing component of the synchronization system (1311), in order to initiate a payment session and obtain a session identifier or request identifier. Said POS (1301) may render a QR code or other graphical encoding of payment instructions or a payment request, which may encode such details as a session identifier or request identifier. In certain embodiments, the POS may open and maintain a socket connection, which may be implemented as a WebSocket connection, with said transaction processing component, which socket connection may stay open for the duration of a payment session. The mobile device (1303) via the mobile application (1306) and using a camera of the mobile device may then capture a digital image of said QR code or said graphical encoding and interpret said payment instructions or said payment request, loading the details of said payment instructions or said payment request into a memory storage of said mobile device.

In an embodiment, said mobile application may display one or more details of said payment instructions or said payment request on a graphical display or screen of said mobile device, which details may also include merchant identifying information regarding the owner or controller of a merchant blockchain account, which merchant identifying information is also included in the details of said payment instructions or said payment request. The mobile application may retrieve account data or an account data structure of said merchant blockchain account by, for example, (a) sending a message or request—for example, in an embodiment, an HTTPS web service message such as a JSON-RPC request or REST request—to the synchronization system via the transaction processing component (1311), which may retrieve said account data or account data structure that has been cached in a traditional database server (1301), or (b) retrieving said account data structure from a blockchain global state by communicating with a block-building node integrated into the synchronization system (1319, connection not shown), or by communicating directly with another validator node or block-building node of the blockchain network (1321).

In various embodiments, the mobile application (1303) may compare the identifying information of the payment instructions or payment request with the account data or account data structure, and display a result of that comparison on the screen of said mobile device, warning a user of a mismatch and cautioning against proceeding against a transaction if there is a mismatch between the merchant identifying details encoded in the payment instructions or payment request, and the merchant identifying details encoded in the account data structure of the merchant blockchain account. In one or more embodiments, said comparison may comprise the comparison of a hash digest of a canonical encoding of said merchant identifying details, which hash digest may be calculated by the mobile application using the merchant identifying details encoded in the payment instructions or payment request, and which hash digest may be included in the account data structure of the merchant blockchain account.

In an example embodiment, said mobile application may, through a graphical user interface rendered on its graphical display or screen, present a user with an option to approve a payment conforming to the payment instructions or payment request, and upon user approval, said mobile application (1303), which may store one or more cryptographic keys of one or more wallet blockchain accounts in a memory of the mobile device, may use said one or more keys to cryptographically sign one or more blockchain records and/or transactions authorizing a transfer of tokens from a wallet blockchain account to said merchant blockchain account. Said mobile application may then encapsulate the one or more blockchain records inside one or more network messages (for example, a web service message such as a REST message or JSON-RPC message, or another type of network message) (1307) and send such messages to said transaction processing component (1311), to be processed as a payment satisfying the payment instructions or payment request of said POS (1301). In one or more embodiments, said one or more blockchain records or said one or more web service messages may incorporate or encode the session identifier or request identifier of the original payment instructions or payment request.

Said messages and/or signed blockchain records and/or transactions (1307) sent by said mobile application (1306) to said transaction processing component (1311) may be submitted by the transaction processing component to a permission checking/fraud detection module (1313), which may perform a risk assessment calculation or other evaluation to estimate or determine a probability or a risk metric that the payment effectuated by said messages, records and/or transactions may be reversed subsequent to initial acceptance, if it is accepted. In certain embodiments, said evaluation may incorporate a consultation of an available balance of said wallet blockchain account, which may or may not be tracked in a traditional database; if the available balance less the payment amount is less than zero, then the message, record or transaction will be rejected. In various embodiments, said probability or risk metric may represent a probability (a) that a blockchain record and/or transaction may become invalid or may be otherwise blocked as a result of a blockchain reorganization or other blockchain events or operations, and/or that (b) upon final asynchronous evaluation and execution by a block-building node, that the wallet blockchain account will have insufficient funds and cause the record or transaction to be invalid, blocking the payment within the blockchain. In certain embodiments, said fraud detection module may be configured to include a machine-learning model trained on a dataset that includes, for example, fraudulent and non-fraudulent messages, records and transactions, a history of blockchain records and/or transactions, a history of blockchain reorganization events, and/or other transactional or behavioral data.

In one or more embodiments, provided that said permission checking/fraud detection module (1313) calculates a probability value or a risk metric within an acceptable threshold, and otherwise does not deem a message, record or transaction invalid or unacceptable, said transaction processing component may perform one or both of the following actions: (a) insert or update various data in the traditional database server (1312); and/or (b) cause one or more messages, events, records and/or transactions to be written as entries to an event messaging system (1316), which entries will ultimately be read and processed by a transaction writer component (1317). In one or more embodiments, successful processing of said entries by said transaction writer component (1317) will result in one or more records and/or transactions being submitted to the block-building node (1319) (i.e. “endogenous payments”) for promulgation to the blockchain network (1321) and ultimate execution and inclusion into the blockchain.

In one or more embodiments, upon successfully updating the traditional database server and/or adding entries to the event messaging system, the transaction processing component (1311) may transmit a message to the POS system (1301) indicating that the payment associated with said session identifier or request identifier was completed, which session identifier or request identifier said transaction processing component may read from the messages and/or signed blockchain records and/or transactions (1307) sent by said mobile application (1306).

In certain embodiments, the mobile application (1303), upon receiving payment approval from a user, rather than sending a one or more messages, records and/or transactions (1307) to the transaction processing component (1311), the mobile application will transmit one or more blockchain records and/or transactions directly to a block building node or validator node of the blockchain network (1321) in order to satisfy the payment instructions or payment request, which record and/or transactions will ultimately be processed as exogenous transactions.

In one or more embodiments, the mobile application may submit a record or transaction directly to the blockchain network (i.e. an “exogenous payment”) in order to satisfy the payment instructions or payment request of the POS system may incorporate or encode a session identifier or request identifier corresponding to the payment instructions or payment request. An exogenous payment may be incorporated into a new block by a block-building node (1319), which block may be read by a block reader component (1320), which will write the block details, including the exogenous payment, into an event messaging system (1318). A message handler (1315) may subsequently read the exogenous payment from the event messaging system (1318) and then write to the traditional database server (1312) relevant data with regards to the exogenous payment, updating status.

The transaction processing component (1311), upon detecting an update made to the traditional database server (1312) reflecting the completion of the pending payment corresponding to the session identifier or request identifier (1312), or otherwise being notified of the exogenous payment, may then transmit a message to the POS system (1301) indicating that the payment associated with said session identifier or request identifier was completed. In an alternate embodiment, the message handler itself, or a separate component invoked by the message handler, may communicate such an update to the POS system regarding the completion of the payment associated with the session identifier or request identifier, instead of the transaction processing component.

In various embodiments, a notification regarding the completion and/or satisfaction of payment instructions or payment requests, which completion and/or satisfaction is achieved by the incorporation into the blockchain of one or more cryptographically signed blockchain records and/or transactions authorizing a transfer of tokens from a wallet blockchain account to a merchant blockchain account-which records and/or transactions may be exogenous, or, alternately, exogenous—may be sent to the POS system after the block containing said one or more records and/or transactions reaches finality, or before it reaches finality, based on a configuration of the synchronization system (1300), or based on a risk determination made by the transaction processing component or the permission checker/fraud detection model.

According to some embodiments, in the event of a reorganization, the message handler (1315) will also serve the purpose of adding to the event messaging system (1316) one or more records and/or transactions that have been removed from the blockchain as a result of the reorganization, which removed records and/or transactions may be resubmitted to the Block-building node (1319) by the transaction writer component (1317).

In at least one embodiment, the one or more synchronization systems may optionally maintain separate data structures for tracking pending transactions, finalized transactions, and/or transactions that may require reconciliation due to reorganization events. In some embodiments, the synchronization system may comprise, incorporate, interact with, connect to, and/or use one or more event streaming platforms or publish-subscribe messaging systems, which individually and collectively may be referred to herein as “event messaging systems”, and which systems may include without limitation message brokers, event logs, message buses, and other messaging infrastructures, examples of which may include, but are not limited to, Apache Kafka, RabbitMQ, Apache Pulsar, Amazon Kinesis, Google Cloud Pub/Sub, or similar capabilities implemented in a more generalized database such as an RDBMS, object oriented database, etc. In one or more embodiments, such one or more event messaging systems may provide guaranteed message delivery and order preservation, and/or may be capable of retaining messages for configurable periods of time, and/or may be designed to handle real-time data flows.

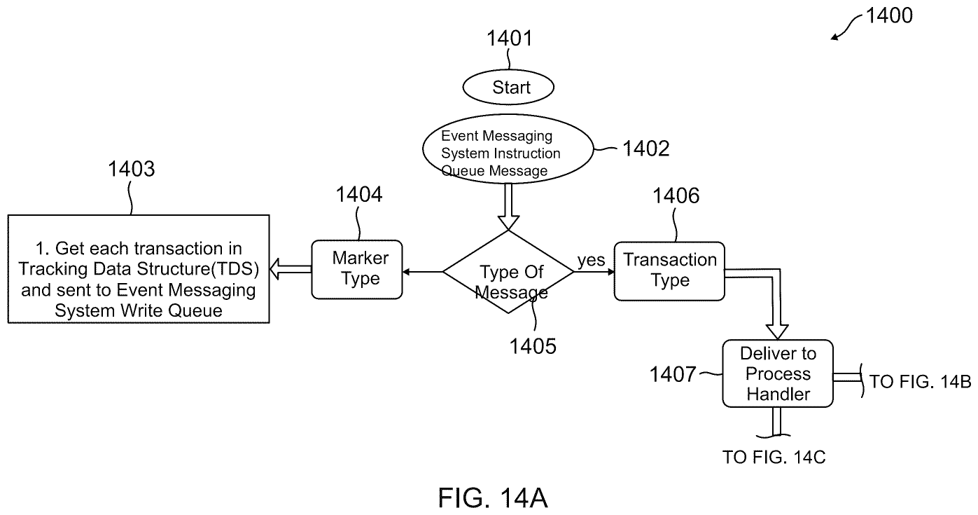

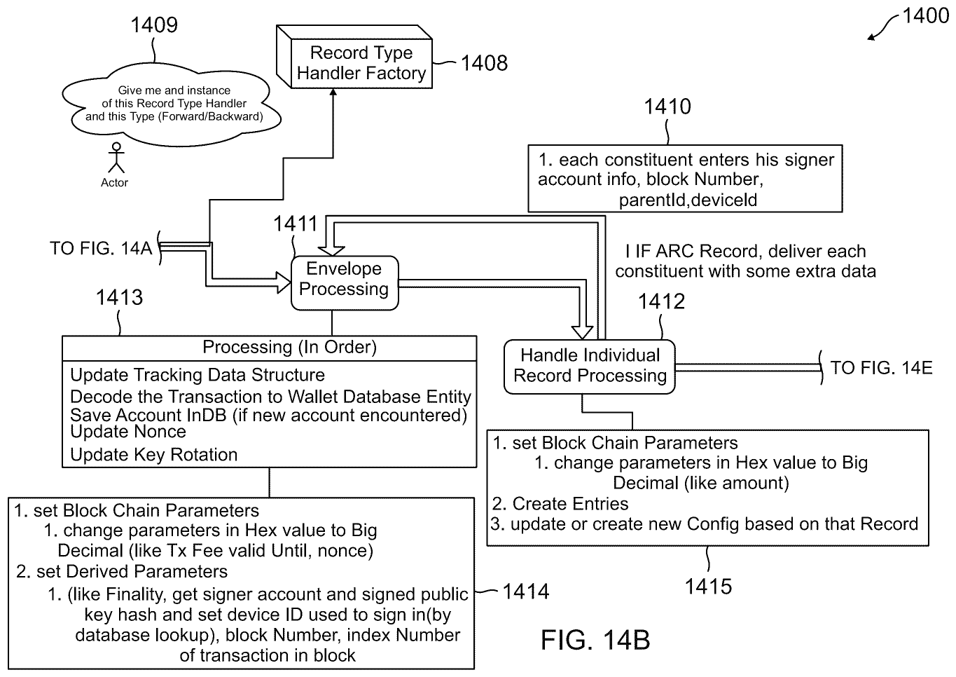

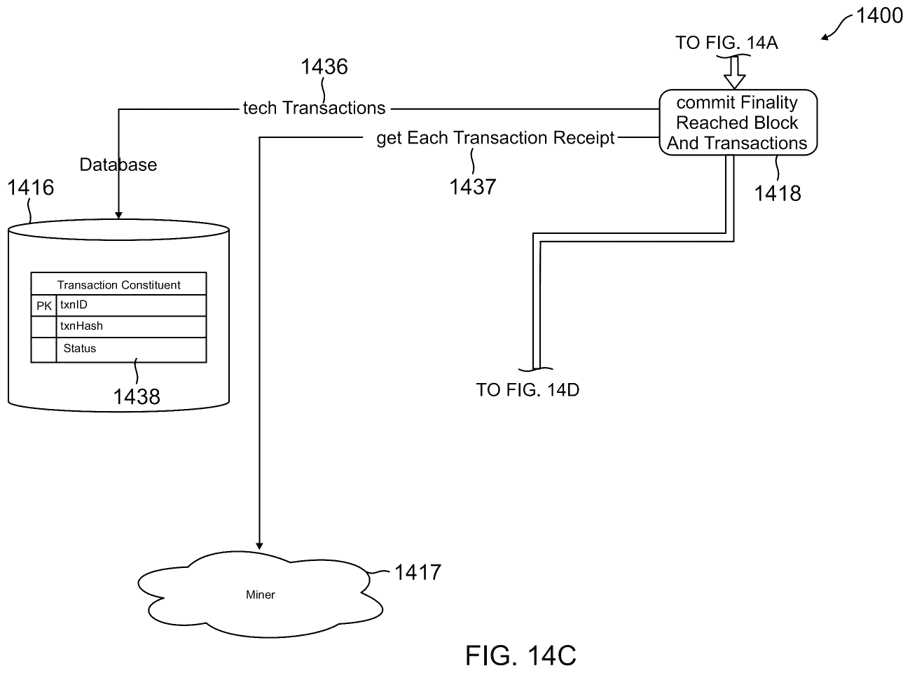

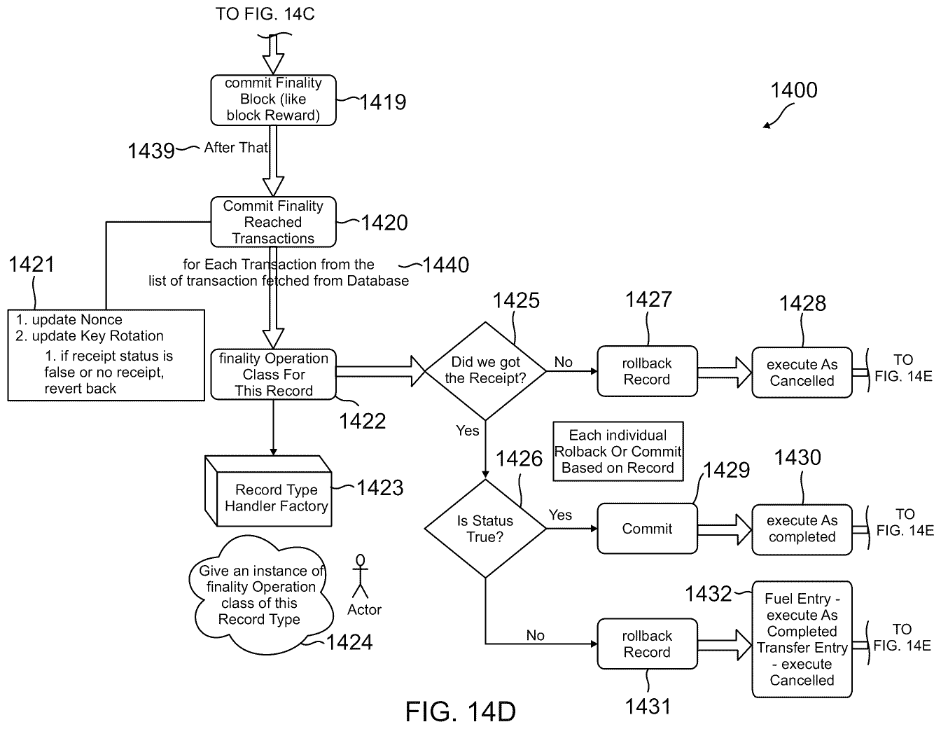

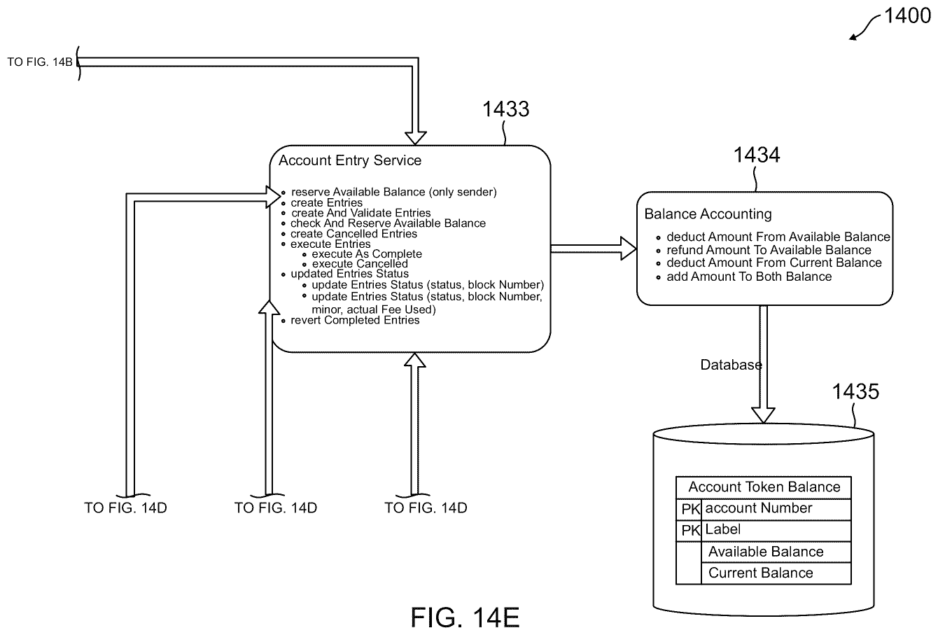

FIGS. 14A-14B are diagrams of an example implementation of a synchronization system 1400 including a distributed data streaming platform that can store, process, and analyze transaction data in real time (event messaging system), according to an embodiment. The synchronization system is initialized 1401, and the distributed data streaming platform that is configured to generate an instruction queue message 1402 (event messaging system message), such as, Apache Kafka, RabbitMQ, Apache Pulsar, Amazon Kinesis, Google Cloud Pub/Sub, or similar capabilities implemented in a more generalized database such as an RDBMS, object oriented database, etc. In an embodiment, the instruction queue message may be configured with a specific topic that acts as an instruction queue, essentially containing commands or directives for a system to perform a specific action, where each message is processed in order by one or more users within a consumer group, effectively creating a queue-like behavior within the publish-subscribe model of event messaging system.

In an embodiment, one example technical advantage of integrating an event messaging system in the synchronization system 1400 as an instruction queue is its exceptional ability to handle high volumes of messages with low latency, making it ideal for real-time data streaming and processing in the synchronization system 1400. Further, the synchronization system 1400 may be configured to utilize event messaging system messages to help improve scalability, fault tolerance, and durable message storage. In this way, the synchronization system 1400 can provide reliable data delivery even in implementations of large-scale distributed systems; this may be beneficial for this example embodiment of the synchronization system 1400 as it may be configured with event-driven architecture, while utilizing log aggregation and real-time analytics, in various embodiments.

At 1404-1406, the type of event messaging system message is assessed by the synchronization system 1400. Event messaging system messages typically consist of a variable-length header, a variable-length opaque key byte array and a variable-length opaque value byte array and have an associated API. The data type of the event messaging system message may be assessed from the event messaging system topic, from which the synchronization system 1400 can determine the message format, which provide information about, among other things, the appropriate APIs, the wire protocol, or the on disk storage associated with the event messaging system message.

For example, in a possible embodiment, event messaging system messages may be written in batches (record batches). A record batch contains one or more records. In a degenerate case, a record batch may contain a single record. When assessing the type of event messaging system message, in an embodiment the synchronization system 1400 may process the event messaging system message's CRC and CRC32. Said CRC may cover the data from the attributes to the end of the batch, and may be located after the magic byte. The synchronization system may configure the clients to parse the magic byte before deciding how to interpret the bytes between the batch length and the magic byte. In an example embodiment, the partition leader epoch field may not typically be included in the CRC computation of the event messaging system to avoid the need to recompute the CRC when this field is assigned for every batch that is received by the broker. The CRC-32C (Castagnoli) polynomial may be used for such computation, in an example implementation.

At 1403, the event messaging system tracking data structure is computed, which is a specialized data structure used to keep track of the offset (position) of a consumer within a topic partition, essentially remembering where a consumer left off reading messages within a specific partition to ensure efficient message processing and prevent data loss.

At 1407, the event messaging system message is delivered to the process handler where envelope processing 1411, 1414 is handled. At 1412, the process handler performs individual record processing, and blockchain parameters are configured at 1415. The process handler further assesses signer account info, block number, parentID, and deviceID 1410. If the event messaging system message includes ARC Record at 1412, the process handler delivers each constituent with extra data and sets the blockchain parameters at 1415. A constituent ARC record is configured as a single, individual piece of data that makes up a larger, complex message, essentially a building block within a structured event messaging system message that can be processed independently within a stream processing pipeline.

At 1433, the account entry service process of the synchronization system, 1400 is executed, which may include the following processes and configurations (1) reserving Available Balance (only sender), (2) creating entries, (3) creating and validate entries, (4) checking and reserving available balance, (5) creating cancelled entries, (6) executing the entries, (7) executing as complete, (8) executing cancelled, (9) updating entries status, (10) updating entries status (status, block number) updating entries Status (status, block Number, minor, actual fee used), and (11) reverting completed entries.

At 1434, accounting is performed by the synchronization system 1400, where the following processes and configurations may be performed (1) deducting amount from available balance, (2) refunding amount to available balance, (3) deducting amount from current balance, (4) adding Amount To Both Balance. At 1435, the account token balance is stored to one or more off-chain databases or external data management systems.

The process handler at 1418-1424 commits block finality, meaning that the transaction is confirmed and added to a blockchain's block, and the transaction receipt 1437 is sent to the minor 1417.

At 1436, this blockchain state change is recorded on the event messaging system data mesh architecture of the synchronization system 1400, including the blockchain ledger and one or more off-chain databases or external data management systems. The reward for the blockchain building node (minor) 1419 is committed, such as a reward block. At 1439, the synchronization system 1420, 1421, 1422, 1423 commits finality for each transaction fetched 1440, and the synchronization system 1400 checks ensures that a receipt is generated 1425-1432.

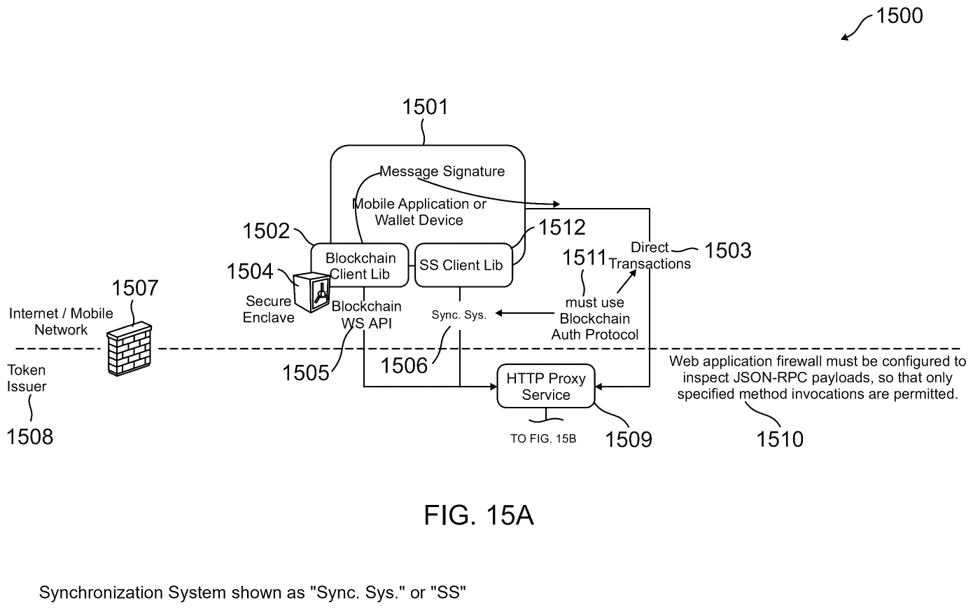

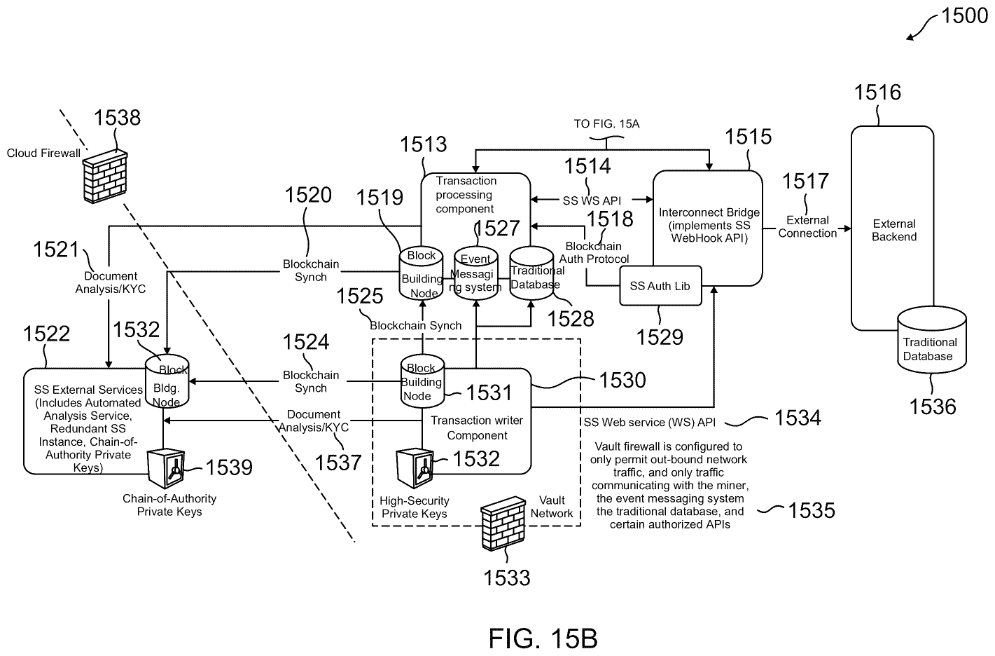

FIGS. 15A and 15B are diagrams of synchronization system architecture, according to an embodiment. The synchronization system 1500 includes a mobile application or wallet device 1501, which is configured to interface with the synchronization system client library 1512, blockchain client library 1502, and secure enclave 1504. The synchronization system 1500 configures the mobile application/wallet device 1501, client library 1502 to interface with the blockchain API 1505 and token issuer 1508 using the internet/mobile network 1507 through the HTTP Proxy Service 1509 via Wallet Link RPC API 1506. The mobile application or wallet device 1501 may be configured by the synchronization system 1500 to direct transactions 1503 to the HTTP Proxy Service 1509 with the token issuer 1508. The web application firewall 1510 at the internet/mobile network 1507 may be configured to inspect JSON-RPC payloads so that only specified method invocations are permitted. The synchronization system 1500 may be configured to interface with interconnect bridge 1515, which implements the synchronization system Webhook API. The transaction processing component 1513 can be configured to interface with a blockchain KYC utility compliance system 1521 to provide document analysis, ensure KYC compliance, limit fraud, money laundering, terrorist financing, and other illegal and other illicit activities. The synchronization system 1500 can be configured to execute external services, such as automated analysis service, redundant instance, chain-of-authority private keys at 1522 through the cloud firewall 1538. The synchronization system 1500 may include block building node 1531, transaction writer component 1532, and the chain-of-authority private keys 1539. The interconnect bridge 1515 may communicate via an external connection 1517 with the external backend 1516 and various databases 1536. The transaction processing component 1513 may interface with a block building node 1519, an event messaging system 1527, and databases 1528. Block building node 1519 processes may cause a blockchain synch 1520. Through an interconnect bridge 1515, the transaction processing component 1513 may access to a synchronization system authentication library 1529. The transaction writer component 1530 may interface with a vault network 1533, high-security vault keys 1532 and a blockchain building node 1531.

### Digital Processing Systems

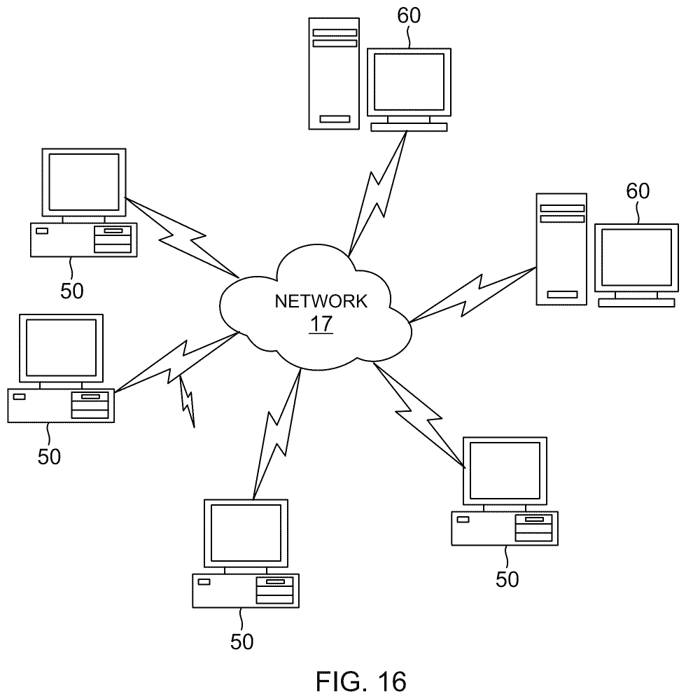

FIG. 16 is a schematic view of a computer network in which embodiments may be implemented.

Client computer(s)/devices 50 and server computer(s) 60 provide processing, storage, and input/output (I/O) devices executing application programs and the like. The server 60 may be a gateway or a persistent server. Client computer(s)/device(s) 50 can also be linked through communications network 70 to other computing devices, including other client device(s)/processor(s) 50 and server computer(s) 60. Communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are suitable.

In certain embodiment of the present invention, at least one wallet node may be implemented as software application executing on a client computer (50), which wallet node may implement a zero-knowledge proof prover. Said wallet node (50) may execute said zero-knowledge proof prover so as to generate a zero-knowledge proof; said wallet node may then incorporate said zero-knowledge proof into a zero-knowledge record, which it may then submit for processing over a computer network (17) to one or more block-building nodes comprising one or more servers (60) connected to said network. Said one or more block-building nodes may then verify said zero-knowledge proof though the use of a zero-knowledge proof verifier software executing within the computer memory of said server (60).

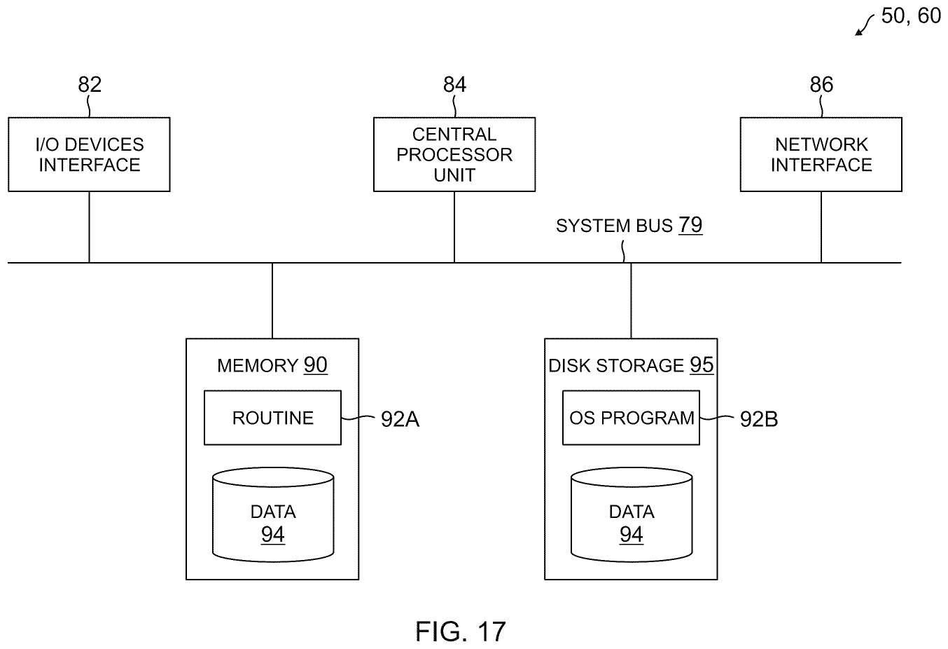

FIG. 17 is a block diagram illustrating an example embodiment of a computer node (e.g., client processor(s)/device(s) 50 or server computer(s) 60) in the computer network 70 of FIG. 16. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 16). A memory 90 provides volatile storage for computer software instructions 92a and data 94a used to implement an embodiment of the present disclosure. A disk storage 95 provides non-volatile storage for the computer software instructions 92b and data 94b used to implement an embodiment of the present disclosure. A central processor unit 84 is also attached to the system bus 79 and provides for execution of computer instructions to implement embodiments of the blockchain synchronization and point-of-sale integration systems.

Software components 92A, 92B of the computer-implemented system may be configured using any known programming language, including any high-level, object-oriented programming language or configured in firmware. The computer-implemented system may include instances of processes that enable execution of transactions and recordation of transactions. The computer-implemented system may include instances of a blockchain software components described herein, which can be implemented a computing device that communicates with the blockchain network, for example, through a blockchain protocol, secure sockets layer (SSL), or any other suitable protocol. The computer-implemented system may be configured with blockchain software components 92A, 92B that can help enable blockchain synchronization and point-of-sale integration systems and implementations disclosed herein, such as payment channel liquidity, payment channel permissioning, safe offline payment channel availability, zero-knowledge permissioning, anchor blocks, block-building and protocol validation functions, message signing protocol, and consensus protocols.

In an example mobile implementation, a mobile agent implementation may be provided. A client-server environment can be used to enable mobile services. It can use, for example, the Extensible Messaging and Presence Protocol (XMPP) to tether a wallet on the device 50. The blockchain network or a server 60 can then issue commands to the mobile device on request. The mobile user interface framework used to access certain components of the computer-implemented system may be based on XHP, Javelin, or WURFL. In another example mobile implementation for OS X and iOS operating computer-implemented systems and their respective APIs, Cocoa and Cocoa Touch may be used to implement the client-side components using Objective-C or any other high-level programming language that adds Smalltalk-style messaging to the C programming language.

An example embodiment includes device code 92A, 92B executed in the trusted execution environment (TEE) or trust platform module (TPM). The TEE or TPM is a hardware environment that runs instructions and stores data outside the main operating computer-implemented system (OS) of a device. This protects sensitive code and data from malware or snooping with purpose-built hardware governed by an computer-implemented system of endorsements, beginning with the device manufacturer. The computer-implemented system may perform checks on the TEE or TPM, such as executing BIOS checks, to verify that the folders (e.g., wallets) stored in the TEE/TPM have not been altered by malicious actors.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein.

In one embodiment, the processor routines 92a-92b and data 94a-94b are a computer program product (generally referenced as 92), including a computer readable medium (e.g., a removable storage medium such as DVD-ROM(s), CD-ROM(s), diskette(s), tape(s), etc.) that provides at least a portion of the software instructions for the disclosure system. Computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network (such as the network 70 of FIG. 16). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a Software as a Service (SaaS) implementation, or other installation or communication supporting end-users.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

### Quick Response (OR) Embodiment

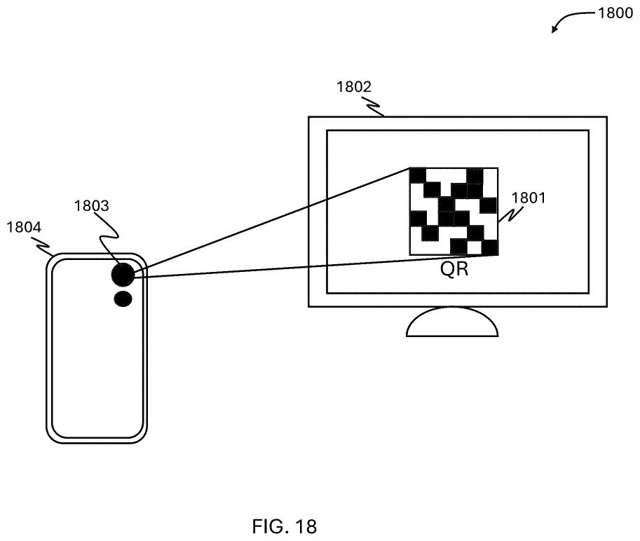

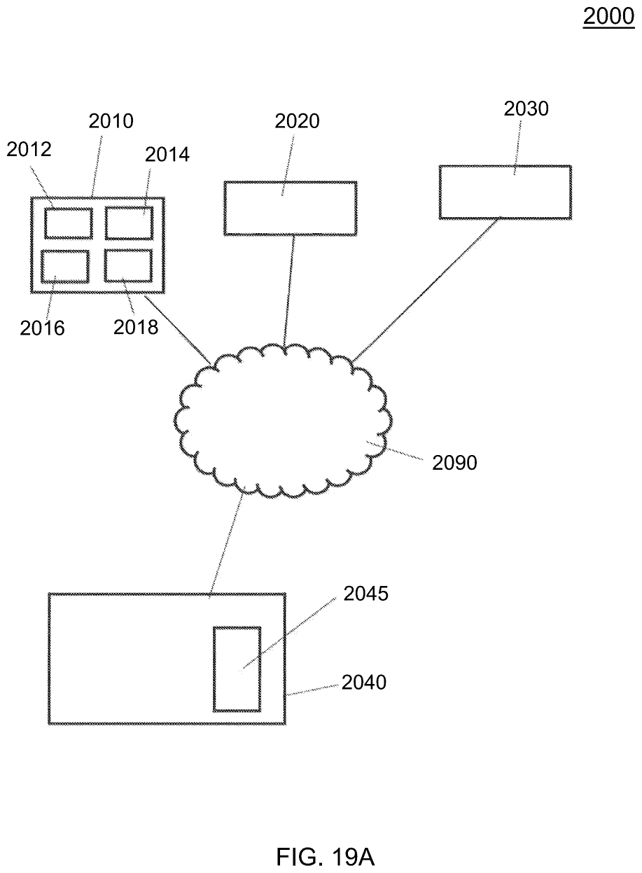

At least one embodiment is directed toward a computer-implemented method 1800 for accepting electronic payment. FIG. 18 shows a diagram illustrating an embodiment wherein a mobile device, such as a cell phone, captures a quick response (QR) code shown on a computer screen. The method includes a point-of-sale computer device 1802, at least one authorization computer devices (which in certain embodiments may constitute, comprise or form a part of a synchronization system), and a consumer smartphone 1804 with at least one camera 1803, and a processor and memory with computer code instructions stored thereon. The method connects the point-of-sale computer device to a packet-switched computer network, as well as connecting the at least one authorization computer devices to the packet-switched computer network, and the smartphone to the packet-switched computer network.

The point-of-sale computer device may have at least one graphical display. The method configures the point-of-sale computer device to share a session identifier with the at least one of the one or more authorization computer devices. The point-of-sale consumer device then will display, a graphical encoding of a payment request 1801 (e.g., a QR code), wherein the graphical encoding of the payment request comprises an encoding of the session identifier (which may also be a request identifier in certain embodiments). The smart phone will capture an image of the graphical encoding of the payment request. The smart phone will display a user-acceptance message, wherein the message requests acceptance of the payment request by a user of the consumer smart phone. The user of the smartphone may then accept the payment request using the smart phone, and the phone will indicate acceptance of the payment request.

The method constructs a data record configured to encode a payment instruction to conform to the payment request, wherein the data record encoding of the payment instruction encodes the session identifier (which in certain embodiments may be a request identifier) and transmits the data record to at least one of the one or more authorization computer devices via the packet-switched computer network. The at least one of the one or more authorization computer devices is configured to perform a verification of the correctness and authenticity of the payment instruction encoded in the data record. The point-of-sale computer device is configured to receive, via the packet-switched computer network, a confirmation that the correctness and authenticity of the payment instruction encoded in the data record has been verified.

In an embodiment, a cryptographic signature of the data record may be attached to the data record prior to transmission to the one or more authorization computer devices. The cryptographic signature may be generated using an asymmetric cryptographic signature algorithm, and the cryptographic signature may be generated using a private key corresponding to a public key stored in a data storage of at least one of the one or more authorization computer devices.

In an embodiment, the public key may correspond to a money balance stored in at least one of the one or more authorization computer devices; and wherein the verification of the correctness and authenticity of the payment instruction encoded in the data record may comprise a verification that the cryptographic signature is valid and was generated with a private key corresponding to said public key.

In an embodiment, the at least one of the one or more authorization computer devices is a blockchain validation computer device hosting a blockchain validation software program. The blockchain validation software program is configured to maintain a connection to one or more additional blockchain validator computer devices hosting one or more additional blockchain validation software programs. The blockchain validator computer devices are connected to the packet-switched computer network. The data record is a blockchain data record, the acceptance of which by the blockchain configured to effectuate a change to a global state of the blockchain.

In an embodiment, the data storage comprises an encoding of the blockchain's global state, and wherein the data record is configured to encode a transformation to the blockchain's global state.

In an embodiment, the point-of-sale computer device is configured to open a socket connection to at least one of the one or more authorization computer devices before displaying on the graphical display the graphical encoding of the payment request.

In an embodiment, the point-of-sale computer device, after displaying the graphical encoding of the payment request on the graphical display, is configured to poll at least one of the one or more authentication computer devices, sending in reference to the session ID.

In an embodiment, wherein the point-of-sale computer device is configured as part of a cash-register system at a physical retail location.

In an embodiment, wherein the point-of-sale computer device is a personal computer, the personal computer being configured to execute a web browser software, and wherein the graphical representation of the payment request is displayed in a graphical-user-interface window of the web browser software.

### Zero Knowledge Systems

In an embodiment, at least one record or transaction may be configured as a zero-knowledge record or transaction encoding of a zero-knowledge state transformation description. The encoding of the zero-knowledge record may include at least the following elements: (1) one or more addresses or paths identifying or referencing the one or more locations of the elements of a discrete data subset within the global state, which discrete data subset comprises either a contiguous subset or a non-contiguous subset of the data comprised by the global state, (2) a revised data subset, representing a new revised version of some portion of or subset of said discrete data subset, or (3) a transition proof implemented as a non-interactive zero-knowledge proof, which transition proof proves that the transition from the discrete data subset to the revised data subset follows the established rules of the blockchain system.

In an embodiment, a zero-knowledge record may include at least one of: (1) the discrete data subset itself, (2) one or more cryptographic hashes of one or more elements of the discrete data subset, or (3) both the discrete data subset and one or more cryptographic hashes of one or more elements of the discrete data subset. The transition proof may be configured to correspond to one of a set of pre-defined transition types for which corresponding non-interactive zero-knowledge proofs may be generated. Each pre-defined transition type may be configured to correspond to an encoded state-transition implementation encoded as a zero-knowledge algorithmic encoding. The encoded state-transition implementation may be configured to receive certain data as input, and generates certain data as output, and where a portion of the input data is private input data, and the remainder of the input data is public input data. The public input data may be configured to include the discrete data subset. The output of the encoded state-transition implementation is the revised data subset.

In an embodiment, the transition proof may be generated by a process that includes: (1) a compilation step where the zero-knowledge algorithmic encoding is compiled into a set of polynomial equations, and (2) evaluation of the polynomials at one or more random points, producing values that are included in the transition proof.

In one or more embodiments, said transition proof may be generated through any zero-knowledge proof system or method which implements the requisite features and capabilities, including zero-knowledge succinct non-interactive argument of knowledge (zk-SNARK) systems or methods, and/or a zero-knowledge succinct transparent argument of knowledge (zk-STARK) systems or methods. See, for example, U.S. Provisional Application No. 63/608,018, filed on Dec. 8, 2023, Appendix (Zero-Knowledge Succinct Transparent Argument of Knowledge (zk-STARK)), which is incorporated herein by reference in its entirety.

In various embodiments, methods and systems for validating and accepting zero-knowledge records and/or transactions may be provided. A validating computer may be configured to store the blockchain's global state in a retrievable storage medium. A wallet computer node, connected to the validating computer node via a computer network, may be configured to generate a new zero-knowledge record. The validating computer node may be configured to receive the zero-knowledge record from the wallet computer node, and may subsequently perform validation of the zero-knowledge record. Such validation may include configuring the validating node to retrieve a retrieved data subset from the global state, which may be a subset of global state data that corresponds to the discrete data subset referenced or included in the zero-knowledge record. The validating node may be configured to verify that the discrete data subset included in the zero-knowledge record or referenced by the zero-knowledge record is equivalent to the retrieved data subset. The validating node may be configured to verify that the non-interactive zero-knowledge proof is valid when verified combination with the discrete data subset (or retrieved data subset) and revised data subset-and possibly in combination additional Public Input Data included with the zero-knowledge record in certain cases.

In an embodiment, in the case that the non-interactive zero-knowledge proof is successfully verified and the zero-knowledge record is deemed valid, the validating node may be configured to replace some portion of the discrete data subset with elements of the revised data subset, where the portion of the discrete data subset that is replaced by elements of the revised data subset is decided according to which pre-defined transition type the non-interactive zero-knowledge proof corresponds to. The discrete data subset may be configured to include at least one permission encoding, which permission encoding either is itself interpretable by the encoded state-transition implementation, or is transformed into an equivalent format interpretable by the encoded state-transition implementation. The permission encoding, or a transformation thereof, may be interpreted or evaluated within the encoded state-transition implementation.

In an embodiment, a state transformation corresponding to the encoded state-transition implementation is undertaken only if the permission encoding is interpreted or evaluated with a result indicating that said state transformation is permitted. The permission encoding may comprise a logical function encoded as interpretable or executable computer code. The logical function may be configured to accept one or more permission inputs and the logical function is configured to output a permission output. The permission output may correspond to either a permitted transition status or a not-permitted transition status, given the one or more permission inputs. The state transformation corresponding to the encoded state-transition implementation may be undertaken only in cases where the permission output given the one or more permission inputs corresponds to the permitted transition status, and the state transformation may not be undertaken in cases where the permission output given the one or more permission inputs corresponds to the non-permitted transition status. One or more permission inputs may comprise a subset of the public input data and private input data received by the encoded state-transition implementation. The logical function, or a transformation thereof may be configured into an equivalent format interpretable by the zero-knowledge algorithmic encoding, and may be interpreted or executed within the zero-knowledge algorithmic encoding. An example implementation of a zero-knowledge algorithmic encoding (e.g., Arithmetic Circuit) is disclosed in U.S. Provisional Application No. 63/608,018, filed on Dec. 8, 2023 Appendix 4, incorporated herein by reference in its entirety. In an embodiment, the zero-knowledge algorithmic encoding may be implemented in a CPU with embedded Zero Knowledge Processing Unit (ZPU) and programmable hardware accelerator. This hybrid CPU/ZPU may be optimized to improve packet processing for verifying blockchain transactions using zk-SNARK transaction processing.

In an embodiment, the non-interactive zero knowledge proof may be deemed valid only in the case where the logical function outputs a value corresponding to the permitted transition status within the zero-knowledge algorithmic encoding. In the event the permission encoding comprises a pattern encoding, the state transformation corresponding to the encoded state transformation implementation may be permitted only in the case that the pattern encoding matches at least a portion of the private input data, or a portion of the public input data, or a combination thereof. The pattern encoding, or a transformation thereof may be configured into an equivalent format interpretable by the zero-knowledge algorithmic encoding, which may then be compared to a portion of the input data received by the zero-knowledge algorithmic encoding, within the zero-knowledge algorithmic encoding itself, and in which the transition proof is verified successfully only in the case where the pattern encoding matches said input data within the zero-knowledge algorithmic encoding. The discrete data subset may include one or more account records, each account record including one or more private ledgers, each private ledger comprising at least one cryptographic hash digest the preimage of which is an unmasked private ledger, which at least one unmasked private ledger contains one or more token balances. At least one unmasked private ledger may be implemented as a Hash Tree or Merkle Tree, where the root of the tree corresponds to the private ledger's cryptographic hash digest. At least one unmasked private ledger may be implemented as a Merkle Tric or Merkle Patricia Trie, where the root of the trie corresponds to the private ledger's cryptographic hash digest. At least one unmasked private ledger may be implemented as a Merkle Proof or partial Merkle Tree or partial Merkle Patricia Trie, and where the root of the proof, tree or trie corresponds to the private ledger's cryptographic hash digest. The private input data may include the at least one unmasked private ledger, which at least one unmasked private ledger is excluded from the discrete data subset and from the public input data; and where the private input data also includes information regarding at least one quantity of tokens.

In an embodiment, the encoded state transformation implementation may be configured as a private state transformation. The encoded state transformation implementation computing at least one derived hash, which derived hash is the cryptographic hash of the at least one unmasked private ledger. The encoded state transformation implementation may be configured to determine that such at least one derived hash equals the at least one cryptographic hash digest of the private ledger which corresponds to that at least one unmasked private ledger. The encoded state transformation implementation may be configured to modify the unmasked private ledger in a manner consistent with the token quantity information included in the private input data. The encoded state transformation implementation may be configured to compute a revised cryptographic hash digest of the modified unmasked private ledger, which revised cryptographic hash digest corresponds to the output of the encoded state transformation implementation. The private state transformation may be configured to include a computational process whereby at least one permission encoding included in the public input data is evaluated in combination with a portion of the input data received by the encoded state transformation implementation, whereby the state transformation corresponding to the encoded state transformation implementation is only undertaken if the permission encoding is interpreted or evaluated in a manner indicating that said state transformation is permitted. The zero-knowledge record may be accepted and included in the blockchain only in the case where one or more permission encodings included in the record's discrete data subset are interpreted or evaluated in a manner indicating that the state transformation corresponding to the zero-knowledge record is permitted.

In an embodiment, the validating computer may be configured to replace at least one cryptographic hash digest of the one or more account record's one or more private ledgers in the global state with the revised cryptographic hash digest if the zero-knowledge record is accepted and included in the blockchain.

### Zero-Knowledge-Encoded Global State Transformations

One or more non-limiting embodiments of the present invention comprises blockchain systems that comprise block-building nodes evaluating zero-knowledge records and/or zero-knowledge transactions which records and/or, when valid, encodes transformations to the global states of said blockchain systems.

In one or more possible such embodiments, transformations to said global state may be effectuated by the inclusion of one or more zero-knowledge records and/or zero-knowledge transactions in one or more blocks added to the blockchain. In at least one embodiment, a zero-knowledge record or zero-knowledge transaction is a blockchain record or blockchain transaction that encodes a global state transformation in the form of a non-interactive zero-knowledge proof, which non-interactive zero-knowledge proof comprises updates and modifications to the global state, to which updates and modifications to the global state may be confirmed to be valid through the verification of the zero-knowledge proof.

In one or more embodiments, said zero-knowledge records and/or transactions may improve the execution speed of blockchain systems by reducing the time required to assess the validity of records and/or transactions added to the blockchain, and by reducing the time required to apply the global state transformations encoded by said records and/or transactions. In certain configurations, said zero-knowledge records and/or transactions may also improve the privacy of blockchain systems by allowing certain values to be hidden which might otherwise be public on the blockchain. One or more embodiments of the present invention may also incorporate the interpretation of permissioning constraints into the creation and verification of zero-knowledge proofs, which zero-knowledge interpretation of permissioning constraints may permit a public proof of compliance with regulatory requirements to be publicly posted on a public blockchain without revealing publicly the details of a blockchain record and/or transaction.

In one or more embodiments, one or more zero-knowledge record types and/or zero-knowledge transaction types trigger one or more types of transformation to the global state, such that global state transformations of said type occur when records and/or transactions of said types are added to the blockchain following one or more validations of said records and/or transactions, whereby said one or more validations are performed by evaluating a non-interactive zero-knowledge proof included in the encoding of said one or more zero-knowledge records and/or transactions.

In one or more embodiments, relevant elements of the initial global state prior to state transformation may be included as public inputs to the non-interactive zero-knowledge proof's algorithmic encoding, and updates and modifications to the blockchain global state that result from said global state transformation may be included among public outputs of the algorithmic encoding. In an embodiment, a zero-knowledge record and/or transaction comprises these inputs and outputs, as well as the non-interactive zero-knowledge proof demonstrating that said state transformation is valid.

In one or more alternate embodiments, updates and modifications to the blockchain global state that result from said global state transformation may be included among public inputs of a algorithmic encoding, and a public output of the of the zero-knowledge algorithmic encoding may comprise a Boolean values, an integer, or some other data element or elements that result from a confirmation that the updates and modifications to the blockchain global state are valid transformations of the initial global state elements provided as inputs to the zero-knowledge algorithmic encoding, according to the rules of the algorithmic encoding.

In at least one embodiment, said zero-knowledge record and/or zero-knowledge transaction may comprise one or more zero-knowledge proofs, one or more algorithmic encodings or references to one or more pre-specified algorithmic encodings, one or more public inputs to the one or more algorithmic encodings, and/or one or more public outputs of the one or more algorithmic encodings, among other elements.

In one or more embodiments of the present invention, one or more public inputs and/or private inputs to a non-interactive zero-knowledge proof's algorithmic encoding may comprise one or more complex or nested data structures encoded according to a standardized format or representation—for example, according to the “Recursive Length Prefix” format utilized by the Ethereum blockchain, or the “JSON Canonicalization Scheme” specified by IETF RFC 8785, or the “Concise Binary Object Representation” specified by RFC 7049, or some other deterministically ordered and encoded data representation. In at least one embodiment, such standardized encoding format or representation is an encoding format or representation which may be deterministically transformed back and forth between other encoding formats or representations, and may be transformed back and forth to the encoding format of the blockchain's global state as it is encoded in a block-building node of the blockchain system. Complex or nested data structures encoded according to a standardized format or representation as described herein are also called “deterministic data” or “deterministic data structures”; data extracted or copied from the blockchain global state as it is encoded in a block-building node of the blockchain is also called “state data” or “state data structures”.

In one or more embodiments, a zero-knowledge proof verification implementation may be encapsulated inside an encapsulating function implemented in software, which function accepts as input one or more state data structures and/or deterministic data structures, and as output returns one or more state data structures and/or deterministic data structures. In an embodiment, the implementation of the encapsulating function may comprise one or more transformations of one or more state data structures into one or more deterministic data structures, and vice-versa, or one or more transformations between different deterministic data structures. In an embodiment, one or more data structures that can contain arrays, dictionaries, integers, strings, etc., map onto various internal data elements of one or more deterministic data structures.

In an embodiment, a zero-knowledge record or zero-knowledge transaction may be passed as an argument into said encapsulating function, which function may verify the zero-knowledge proof of the transaction along with possible other elements of the transaction. The encapsulating function may thereby authorize a block-building node to apply the global state transformation encoded by the zero-knowledge record or zero-knowledge transaction; or, alternately, if the record or transaction is deemed invalid, thereby cause the block-building node to discard the record or transaction, or add the record or transaction to a new block without applying the global state transformation.

In one or more embodiments, deterministic data structures representing token configurations or wallet accounts may be passed into a zero-knowledge algorithmic encoding, allowing an encoded permissioning constraint to be extracted from said deterministic data structures. In one or more embodiments, an interpreter of one or more encoded permissioning constraints may be implemented within the algorithmic encoding. In an embodiment, a permissioning constraint may be executed inside the algorithmic encoding, and the rules of the permissioning constraint may be enforced according to the result of said execution in the off-chain computation encoded by the non-interactive zero-knowledge proof.

In one or more embodiments of the present invention, zero-knowledge algorithmic encodings may be implemented corresponding to a variety of possible state transformations. Some such state transformations may comprise simple state transformations corresponding to simple zero-knowledge algorithmic encodings, and some such state transformations may comprise complex state transformations corresponding to more complex zero-knowledge algorithmic encodings. A non-exhaustive list of possible zero-knowledge algorithmic encodings that may or may not be implemented, and corresponding state transformations, include the following:
(a) Token transfer algorithmic encodings, which may encode transfers of tokens between and among blockchain accounts and/or addresses within the global state.
(b) Permission-constrained algorithmic encodings, which may encode various global state transformations that comprise a computational step which determines whether a permissioning constraint is satisfied or not.
(c) Privacy algorithmic encodings, which may encode global state transformations where one or more data values being transformed are subjected to a cryptographic hash before being written to the public global state encoding within a block-building node.

In an embodiment, global state transformations may be effectuated both by standard blockchain records and/or transactions on the one hand, which such records and/or transactions do not comprise any zero-knowledge proof element, and, on the other hand, zero-knowledge records and/or zero-knowledge transactions. In such an embodiment, a block-building node may evaluate one or more zero-knowledge records and/or zero-knowledge transactions for inclusion in a new block, which evaluation comprises an evaluation of the zero-knowledge proof, specified algorithmic encoding, public inputs and public outputs of said zero-knowledge records and/or transactions; in addition, within the same block, said block-building node may also evaluate for inclusion one or more blockchain records and/or transactions that do not comprise any zero-knowledge element, the evaluation of which may require the step-by-step execution of state transformation computation before the validity of such records and/or transactions can be established.

In an embodiment, a global state transformation corresponding to a zero-knowledge algorithmic encoding may be defined as a transformation made to the input data that results in the output data.

In an alternate embodiment, a global state transformation corresponding to a zero-knowledge algorithmic encoding may be defined as a transformation made to one or more input data elements of the algorithmic encoding, which transformation results in one or more other input data elements of the algorithmic encoding. In such an embodiment, one or more output data elements of said algorithmic encoding may comprise a Boolean value, an integer, or some other data element or elements that result from a confirmation that said transformation is valid.

In one or more embodiments, zero-knowledge records and/or zero-knowledge transactions may configure one or more of the following fields, among others:
(a) A list of accounts and/or addresses within the global state, which addresses correspond to public inputs to the zero-knowledge algorithmic encodings of the zero-knowledge records and/or transactions, which accounts and/or addresses may be used to retrieve the state data comprising said public inputs.
(b) A zero-knowledge algorithmic encoding type, identifying a pre-defined zero-knowledge algorithmic encoding which been used to compute a state transformation and generate a zero-knowledge proof. An embodiment may configure a separate field for algorithmic encoding type, or, alternately, a more general record type field may indirectly imply the algorithmic encoding, with a different record type for each algorithmic encoding type implemented.
(c) A non-interactive zero-knowledge proof generated by the sender of the record or transaction, generated using the algorithmic encoding type specified.
(d) One or more data elements corresponding to outputs of the zero-knowledge algorithmic encoding. In an embodiment, if the record or transaction is deemed valid, one or more of said data elements will replace global state elements located at one or more accounts and/or addresses specified in the first field above. In various embodiments said data may be simple or complex; said data may be added to the global state in its original encoding or after having been transformed into a different encoding; said data may comprise deterministic data structures or other data representations. In an alternate embodiment, said data elements may comprise output of the of the zero-knowledge algorithmic encoding a confirmation that a data transformation encoded by the algorithmic encoding is executed correctly, which output data elements may including such possibilities as a Boolean value, an integer, or some other data element or elements.
(e) One or more data elements corresponding to additional public inputs to the zero-knowledge algorithmic encoding. In an embodiment, said data elements may be deterministic data structures, and may be passed in as inputs to the algorithmic encoding either in an original state or after having been transformed into a different encoding format. In an embodiment, said input data elements may include data the formation of which results from a valid and successful data transformation encoded by the zero-knowledge algorithmic encoding.
(f) One or more cryptographic signatures generated using one or more private keys corresponding to one or more public keys associated with the accounts and/or addresses specified in the first field above.

In one or more embodiments, the processing of zero-knowledge records and/or zero-knowledge transactions by block-building nodes comprises a procedure having one or more of the following steps:
(a) It is confirmed that the one or more cryptographic signatures do in fact correspond to the appropriate accounts and/or addresses specified.
(b) The state data structures that are stored at the given accounts and/or addresses within the global state are retrieved.
(c) An encapsulating function is called, which function encapsulates the processing of the indicated algorithmic encoding, accepting as arguments the input data elements, the non-interactive zero-knowledge proof, the output data elements, and any record or transaction metadata that might be required for the processing of that particular algorithmic encoding—for instance, information regarding which addresses, accounts, or devices signed the record or transaction. Inside that function:
   i. The input data elements and output data elements are transformed into the format acceptable for the proof evaluation;
   ii. The proof inputs and outputs are assembled into the appropriate aggregate form for proof evaluation;
   iii. The proof's validity is determined, as informed by the inputs and outputs.
(d) If the proof is invalid, the function outputs an indicator of that invalidity, potentially as an error code or other computational encoding of invalidity.
(e) If the proof is valid, then the function outputs a mapping of the output data elements to one or more accounts and/or addresses within the global data structure, or to some constituent element of the state data corresponding to said one or more accounts and/or addresses.
(f) If the proof is valid, the global data structure is updated, replacing the state data structures previously corresponding with by those account addresses with the deterministic data structures specified as output.

In an embodiment, the construction of each type of zero-knowledge algorithmic encoding, and the creation of each non-interactive zero-knowledge proof that is included with each zero-knowledge record and/or transaction, are particular to the type of transformation of the sate data structure which corresponds to that specific algorithmic encoding type.

In one or more possible embodiments of the present invention, a zero-knowledge token transfer procedure may be implemented comprising one or more of the following steps:
(a) An algorithmic encoding may be implemented to accept as public input one or more state data structures of the sender and recipient accounts or addresses. The private input of the algorithmic encoding may be the details of the transfer: one or more token quantity values, and optionally one or more token types. The public output may be two new state data structures, corresponding to the blockchain accounts or addresses of each of the parties participating in the transfer. Alternately, said two new state data structures may also be among the public inputs to the algorithmic encoding, and the public output instead includes one or more indicators as to whether the transfer was successful, which indicators may comprise Boolean values, integer values, or other data elements.
(b) The algorithmic encoding may perform the operation of generating a new sender state data structure wherein the sender's balances of the indicated tokens are decreased by the indicated quantities, and a new recipient state data structure where the recipient's balances of the indicated tokens are increased by the indicated quantities.
(c) The wallet of the sender may execute this algorithmic encoding with the indicated inputs and capture the outputs and generate the non-interactive zero-knowledge proof. The wallet may then generate a zero-knowledge record comprising various data fields.
(d) The zero-knowledge record is sent to the miner/validator network, and when it is successfully verified and included in a new block, one or more sender and recipient state data structures are replaced with one or more input and/or output data elements including in the zero-knowledge record.

One or more embodiments implement the preceding zero-knowledge token transfer process, but also include the interpretation of permissioning constraints within an algorithmic encoding, also referred to as zero-knowledge permissioning. This implementation configures an interpreter of a permissioning constraint encoding to be implemented as a zero-knowledge algorithmic encoding, or a portion, aspect or sub-routine of an algorithmic encoding within a larger algorithmic encoding.

In one or more embodiments, each expression of a permissioning constraint encoding corresponds to a particular zero-knowledge expression encoding, which zero-knowledge expression encoding comprises a particular zero-knowledge algorithmic encoding, or to a particular portion, aspect or sub-routine of an algorithmic encoding, which particular zero-knowledge algorithmic encoding, or particular portion, aspect or subroutine of an algorithmic encoding may be incorporated into a larger zero-knowledge algorithmic encoding. Each zero-knowledge expression encoding within the context of a larger non-interactive zero-knowledge proof system performs the operation that is encoded by its corresponding expression. An interpreter of permissioning constraint encodings implemented within a zero-knowledge algorithmic encoding comprises a number of zero-knowledge expression encodings which operate on a permissioning constraint as it is interpreted within the zero-knowledge algorithmic encoding. Non-limiting examples of possible expressions that may correspond to particular zero-knowledge expression encodings include Boolean equivalence expressions, inequalities, negations, data retrieval operations,

In an embodiment, such zero-knowledge expression encodings may avoid implementing any non-terminating operations, or operations that may not terminate depending on input data, and therefore said zero-knowledge expression encodings may avoid implementing such operations as loops, recursive functions, and/or variable assignments. Similarly, in an embodiment, a permissioning constraint interpreter implemented in a zero-knowledge algorithmic encoding may avoid implementing any non-terminating operations, or operations that may not terminate depending on input data, and therefore said permissioning constraint interpreter implemented in a zero-knowledge algorithmic encoding may avoid implementing such operations as loops, recursive functions, and/or variable assignments.

In an embodiment, such zero-knowledge expression encodings may exclude function declarations, definitions or implementations, such that only built-in functions are available for use within permissioning constraints. Any such built-in function in such a scenario should therefore correspond to a particular zero-knowledge expression encoding.

In an embodiment, functions that operate on lists may be capped in terms of the number of iterations they are permitted to undertake. Such functions when implemented as zero-knowledge expression encodings may or may not be implemented using looping logic, depending on the capabilities of the underlying zero-knowledge algorithmic encoding system or method.

### Zero-Knowledge Privacy Ledgers

Known blockchain systems are known to make the value of tokens held by accounts and/or addresses public. If an account or address using such a blockchain system is identified as belonging to a particular person or business, the token balance information of that person or business becomes publicly known.

One or more potential embodiments of the present invention solve this problem by implementing privacy-enhancing zero-knowledge blockchain systems or methods comprising accounts which hide the value of tokens currently held by those accounts.

In one or more potential embodiments, a blockchain account or address may comprise a state data structure containing a masked privacy ledger. Said masked privacy ledger may comprise a hash digest which is a hash of an unmasked privacy ledger, which unmasked privacy leger comprises a deterministic data structure stored off-chain. Alternately, a masked privacy ledger may itself comprise a deterministic data structure comprising masked elements and unmasked elements, which masked elements comprise one or more hash digests of one or more data elements of an unmasked privacy ledger, and which unmasked elements comprise one or more data elements equivalent to one or more data elements of the unmasked privacy ledger, which unmasked privacy ledger comprises a deterministic data structure stored off-chain.

In one or more embodiments, said unmasked privacy ledger may comprise a Merkle tree or trie, herein referred to as an unmasked Merkle ledger. In one or more possible embodiments, the root of an unmasked Merkle ledger may constitute a hash digest of the masked privacy ledger. Alternately, the masked privacy ledger may comprise a masked Merkle ledger which is a Merkle tree or trie comprising a transformation of the unmasked Merkle ledger such that one or more branches or leaves of said unmasked Merkle ledger are replaced within the masked Merkle ledger by stub branches or leaves comprising individual hash digests of said branches or leaves.

In one or more embodiments, said masked Merkle ledger may be configured as a “privacy tree” comprising one or more of the following aspects:
(a) In an embodiment, one or more nodes of a privacy tree may contain unhashed original data, which nodes may have one or more siblings which are stub branches or leaves that may act as expansion points of the privacy tree.
(b) In an alternate embodiment, a privacy tree may exclude non-hashed original data, and may comprise only stub branches and leaves. One or more stub branches or leaves may each comprise a random or pseudo-random value.
(c) In an embodiment, each node comprising non-hashed original data of the privacy tree may be accompanied by two or more stub branch siblings. In such an embodiment, when new content is added to the privacy tree, it is added in a balanced way, such that nodes at a tree depth of N+1 are only added when all stub branches have already been replaced with new content at tree depth N. In other words, in such a configuration, it would only be permitted for new nodes to be added to the privacy tree in a manner that improves the tree's balance; otherwise, such an addition would be invalid.
(d) In an embodiment, only a user that owns or controls an account or address knows all the non-hashed original data of the unmasked Merkle ledger corresponding to a privacy tree constituting the privacy ledger of the account or address, but any valid private transaction moving tokens into the account may nonetheless add to the account. In such an embodiment, tokens may be transferred to said account or address in a blockchain record or transaction signed by the sender of said tokens, without requiring the signature of the recipient account or address. In an embodiment, a recipient account or address of such a transfer may use said tokens through the inclusion in the blockchain of a zero-knowledge record or transaction the zero-knowledge-proof of which comprises a transformation of the privacy tree to incorporate the received token values.

In an embodiment, a user that desires to receive a transfer from a sender may share all or a portion of their unmasked privacy ledger with the sender, which recipient's unmasked privacy ledger may be included among the private inputs to a zero-knowledge algorithmic encoding of the zero-knowledge record or transaction. Such a zero-knowledge algorithmic encoding may be of a type that includes among its outputs masked private ledger data for both sender and receiver accounts, all of which may be updated in the global state upon inclusion of the valid record or transaction in the blockchain. In an embodiment, if the unmasked privacy ledger is an unmasked Merkle ledger, then only a Merkle proof inclusive of the node comprising the token balance being updated would need to be shared, because such data in combination with public global state data would be sufficient to generate an updated masked private ledger.

In an embodiment, rather than a recipient sharing all or a portion of their unmasked private ledger with a sender, a recipient may share nothing in advance. Instead, a zero-knowledge algorithmic encoding may accept among its public inputs a masked private ledger of the recipient, and include among its outputs an updated masked private ledger which will be used to update the masked private ledger on the recipient's account. In an embodiment, the updated masked private ledger may incorporate token values received as a new unmasked element; in this embodiment, the amount transferred would public, even if the balances held by both parties arc not. In an alternate embodiment, the zero-knowledge algorithmic encoding includes among its outputs one or more unmasked elements of the unmasked private ledger, in addition to the updated masked private ledger; said unmasked elements of the masked private ledger would not be incorporated in the blockchain's global state, but instead would be transmitted privately to the recipient, to be stored privately by the recipient, and used subsequently by the recipient to retrieve said tokens received, or in an alternate embodiment, to effectuate the inclusion of the zero-knowledge record or transaction in the blockchain.

In one or more embodiments, a private zero-knowledge record or transaction may be configured as a zero-knowledge record or transaction comprising a zero knowledge proof generated using a privacy-preserving zero-knowledge algorithmic encoding, which is a zero-knowledge algorithmic encoding which includes among its private inputs the unmasked privacy ledger of one or more parties participating in the token transfer (as senders or recipients). In one or more embodiments, said privacy-preserving zero-knowledge algorithmic encoding may also include as private inputs the transfer details of the state transformation, including one or more of the following private inputs, among others: one or more token values being spent or transferred, one or more token types being spent or transferred, token configuration state data, and/or token permissioning constraints associated with one or more token types. Public inputs to said privacy-preserving zero-knowledge algorithmic encoding may include the state data structures corresponding to one or more of the accounts and/or addresses participating in the transfer. In an alternate embodiment, token type, token configuration, and/or token permissioning constraints associated with one or more tokens may instead be included among the public inputs to said privacy-preserving zero-knowledge algorithmic encoding, rather than the private inputs.

In one or more embodiments, a privacy-preserving zero-knowledge algorithmic encoding may extract one or more permissioning constraint encodings from one or more account or address state data structures or from one or more token configuration state data structures, and interpret said permissioning constraints to determine whether the transfer is permitted. Said privacy-preserving zero-knowledge algorithmic encoding may then compute the transfer instruction included in the private inputs by decrementing the value of said tokens in the unmasked privacy ledger of the sender. A new hash of the unmasked privacy ledger node from which the transfer is extracted would be generated, and that node would be updated in the masked privacy ledger, and relevant hash digests would be computed. In an embodiment, an indicator of which node of the unmasked privacy ledger is to be used to fund the transfer may be included in the private inputs.

In an embodiment, the output of a zero-knowledge algorithmic encoding comprises at least one updated masked privacy ledger derived from the unmasked privacy ledger after it has been updated within the zero-knowledge algorithmic encoding. Upon evaluation of a private zero-knowledge record or transaction, and upon verification of the validity of the zero-knowledge proof said record or transaction comprises, a block-building node may replace one or more masked ledgers of the global state with one or more updated masked ledgers output from the zero-knowledge algorithmic encoding.

In an alternate embodiment, one or more updated masked private ledgers are included among the public inputs of the zero-knowledge algorithmic encoding, which one or more updated masked private ledgers may be used by a block-building node to replace one or more masked private ledgers of the global state upon evaluation and successful validation of a private zero-knowledge record or transaction. In such an embodiment, the public output of the zero-knowledge algorithmic encoding may be a Boolean value, an integer, or some other data element or elements that result from a successful evaluation of the one or more masked private ledger inputs within the zero-knowledge algorithmic encoding, which evaluation establishes that said one or more masked private ledger public inputs are one or more valid transformations of one or more unmasked private ledger private inputs, as may be appropriate depending on the other inputs to said zero-knowledge algorithmic encoding.

In one or more embodiments, because token types and token values are included as part of the private data, the nature of a transfer encoded by a private zero-knowledge record or transaction will not be publicly known when the record or transaction is added to the chain.

In one or more alternate embodiments, the inclusion of token types and/or token configuration state data among the necessary public data reveals some information about which tokens were transferred. In an embodiment, however, type and state data pertaining to some unused additional token types may be added in order to obfuscate the question.

In one or more alternate embodiments, Token type information and token configuration state data may be included in the public data in order to simplify the evaluation of permissioning constraints. If token configuration state data and token type are public, then the permissioning constraints can be evaluated by the operation of the block-building node, rather than being interpreted within a zero-knowledge algorithmic encoding. Such an embodiment comprises a less complex implementation than the alternative.

In one or more embodiments, private zero-knowledge records and/or transactions are not able to hide the fact that one or more accounts and/or addresses have transacted with each other, in part because the masked privacy ledger of one or more accounts and/or addresses should be updated upon acceptance, execution and inclusion of said private zero-knowledge records and/or transactions in the blockchain, which implicates a global state of a public blockchain being modified to reflect updated privacy ledgers of said one or more accounts and/or addresses.

In an embodiment, a recipient's the privacy tree may add new nodes with every in-bound transfer; as a result, the size of the privacy tree may grow with every transfer into the account.

In an embodiment, a privacy tree may undergo a consolidation transformation in order to re-claim space. Such a consolidation transformation may comprise one or more of the following aspects:
(a) A zero-knowledge algorithmic encoding may be defined which algorithmic encoding performs a consolidation of a privacy tree, or, alternatively, confirms that an updated masked privacy tree is a consolidated version of an original masked privacy tree.
(b) A zero-knowledge record or transaction may be configured which corresponds to the consolidation algorithmic encoding, which zero-knowledge record and/or transaction, when it is properly formed with a valid zero-knowledge proof and is incorporated into a new block by a block-building node, effectuates a consolidation transformation of a privacy tree of an account or address of a blockchain global state.
(c) A public input to the algorithmic encoding may comprise a masked privacy tree that is undergoing a consolidation. A private input to the algorithmic encoding may comprise the unmasked version of said unconsolidated privacy tree, with all the non-hashed content directly accessible.
(d) A consolidated version of the unmasked privacy tree (unmasked consolidated privacy tree) may be included as a private input or a private output of the algorithmic encoding. A masked version of said consolidated privacy tree (masked consolidated privacy tree) may constitute a public input or public output of the algorithmic encoding.
(e) The zero-knowledge algorithmic encoding may implement one or more of the following steps:
   i. confirm that the unmasked version of the privacy tree does in fact conform to the masked version of the privacy tree;
   ii. deterministically transform the unmasked version of the original privacy tree into an unmasked consolidated privacy tree (the consolidation transformation);
   iii. transform the unmasked consolidated privacy tree into a masked consolidated privacy tree (the masking transformation);
   iv. validate that the unmasked consolidated privacy tree is in fact the correct unmasked version of the privacy tree that is included among the private inputs or private outputs of the algorithmic encoding; and/or
   v. validate that the masked consolidated privacy tree is in fact the correct masked version of the privacy tree that is included among the private inputs and/or private outputs of the algorithmic encoding.
(f) The consolidation transformation may comprise a combining of all non-hashed elements of an unmasked privacy tree pertaining to a particular token type (or other unit of value) into a single node of the privacy tree, for each token type or other units of value found in the privacy tree. Although individual transfers may result in real content nodes that comprise token ledgers containing only one token balance each, the consolidated node may potentially comprise a token ledger that contains multiple token balances; alternately, different nodes may each contain separate token balances or other units of value.
(g) This algorithmic encoding may allow portions of the unmasked privacy tree to contain masked nodes. This may be necessary to allow for the consolidation of derived from private transfers that the account/address owner was never notified of. For the account/address owner to know the unmasked content of all of the real content nodes, it would need to have been informed by senders of unmasked data corresponding to the masked data added by the senders. This data, and any token balances or other value it may correspond to, would be inaccessible to
(h) The consolidation transformation may also involve a step whereby data is discarded if the that the zero-knowledge record and/or transaction is configured to discard such data. Such discarded data may be either data present in the unmasked privacy tree in an non-hashed, unmasked state, and data that remains masked. The instructions to discard should somehow also be included in the private inputs of the circuit. Such tokens or values would effectively be destroyed.

### Two-Phase Zero-Knowledge Transfers

According to a possible set of embodiments, a blockchain account or address may correspond to a privacy ledger the masked version of which is encoded in the global state only as a hash digest. The unmasked version of said privacy ledger, which may be stored off-chain, may comprise a Merkle tree or trie, or may comprise other less complex data, such as a simple string, or a deterministic data structure that is not a Merkle tree or trie.

In one or more embodiments, a transfer of tokens or other units of value from one privacy ledger to another privacy ledger would comprise a two-step process involving two zero-knowledge records and/or transactions. The first record or transaction authorizes the movement of tokens or other value units out of a sender's privacy ledger, and the second record or transaction allows the movement of said tokens or value units into a recipient's privacy ledger.

The sender zero-knowledge record may be added to the blockchain by the sender of tokens or other units of value. The sender zero-knowledge record includes inputs and outputs of a sender zero-knowledge algorithmic encoding which algorithmic encoding corresponds to a state transformation whereby the sender's masked private ledger is transformed to an updated masked private ledger.

In an embodiment, the public inputs to the sender zero-knowledge algorithmic encoding may include an original masked private ledger extracted from a state data structure of a sender's account or address. The private inputs may include transfer details, including type, configuration and quantity information regarding transferred token values or other units of value transferred, as well as an original unmasked private ledger of the sender, which original unmasked private ledger may be hashed within the recipient zero-knowledge algorithmic encoding to produce a hash digest equivalent to the original masked private ledger.

In an embodiment, an updated masked private ledger of the sender may be included as an input or as an output of the sender zero-knowledge algorithmic encoding. If the updated masked private ledger is included as an output, said algorithmic encoding will compute this output value first by transforming the sender's original unmasked private ledger into an updated unmasked private ledger, and then by hashing said updated unmasked private ledger to produce a hash digest, which hash digest will form said output. If the updated masked private ledger is included as an input, said algorithmic encoding will first compute said hash digest, and then will compare said hash digest to the updated masked private ledger provided as input.

Similarly, in an embodiment, a transfer hash digest comprising a hash digest of the transfer's token or unit of value type, configuration and/or quantity may also be included as an input or as an output of the sender zero-knowledge algorithmic encoding. If the transfer hash digest is included as an output, said algorithmic encoding will compute this output value by computing a hash digest of the transfer's token/value type, configuration and/or quantity data included as a private input, which hash digest will form said output. If the transfer hash digest is included as an input, said algorithmic encoding will first compute a hash digest of the transfer's token/value type, configuration and/or quantity data, and then will compare said hash digest to the transfer hash digest provided as input.

In an embodiment, said sender zero-knowledge record may be generated through a first zero-knowledge proving process by which a zero-knowledge proof is generated and incorporated into said recipient zero-knowledge record. Said zero-knowledge proof comprises a non-interactive zero knowledge proof which encodes a proof of one or more of the following data relationships:
(a) the updated masked private ledger of the sender account or address is a hash digest computed by hashing the updated unmasked private ledger of the sender account or address;
(b) the updated unmasked private ledger of the sender account or address is a transformation of the original unmasked private ledger, which transformation comprises a decrease in the quantity of the transferred tokens or value units specified in the private input;
(c) the original masked private ledger of the sender account or address is a hash digest computed by hashing the original unmasked private ledger of the sender account or address;
(d) transfer hash digest is a hash digest computed by hashing the transfer's token/value type, configuration and/or quantity data included among the algorithmic encoding's private inputs

In an embodiment, when an instance of said sender zero-knowledge record/transaction is evaluated, additional validation steps will be performed on said zero-knowledge record or transaction. Such validation steps may include, among others: a confirmation that a recipient account or address is encoded in the record or transaction; a confirmation that a sender's account or address is encoded in the record or transaction; a confirmation that the original masked privacy ledger provided as an input to the sender zero-knowledge algorithmic encoding is a hash digest value equal to the hash digest value of the sender's current masked privacy ledger referenced by the sender's account or address stored in the global state. Only public inputs and outputs will be included with the record/transaction, and not any private inputs or outputs.

Upon said sender zero-knowledge record or transaction being validated successfully and incorporated into a block by a block-building node, said block-building node will cause the original masked privacy ledger of the sender to be replaced with the updated masked privacy ledger of the sender.

The recipient zero-knowledge record may be added to the blockchain after the sender zero-knowledge record is added to the blockchain. The recipient zero-knowledge record references the first transaction, and includes inputs and outputs of a recipient zero-knowledge algorithmic encoding which algorithmic encoding corresponds to a state transformation whereby the recipient's original masked private ledger is transformed to an updated masked private ledger.

In an embodiment, the public inputs to the recipient zero-knowledge algorithmic encoding may include an original masked private ledger extracted from a state data structure of a recipient's account or address. The private inputs may include transfer details, including type, configuration and quantity information regarding transferred token values or other units of value transferred, as well as an original unmasked private ledger of the recipient, which original unmasked private ledger may be hashed within the recipient zero-knowledge algorithmic encoding to produce a hash digest equivalent to the original masked private ledger.

In an embodiment, an updated masked private ledger of the recipient may be included as an input or as an output of the recipient zero-knowledge algorithmic encoding. If the updated masked private ledger is included as an output, said algorithmic encoding will compute this output value first by transforming the recipient's original unmasked private ledger into an updated unmasked private ledger, and then by hashing said updated unmasked private ledger to produce a hash digest, which hash digest will form said output. If the updated masked private ledger is included as an input, said algorithmic encoding will first compute said hash digest, and then will compare said hash digest to the updated masked private ledger provided as input.

Similarly, in an embodiment, a transfer hash digest comprising a hash digest of the transfer's token or unit of value type, configuration and/or quantity may also be included as an input or as an output of the recipient zero-knowledge algorithmic encoding. If the transfer hash digest is included as an output, said algorithmic encoding will compute this output value by computing a hash digest of the transfer's token/value type, configuration and/or quantity data included as a private input, which hash digest will form said output. If the transfer hash digest is included as an input, said algorithmic encoding will first compute a hash digest of the transfer's token/value type, configuration and/or quantity data, and then will compare said hash digest to the transfer hash digest provided as input.

In an embodiment, said recipient zero-knowledge record may be generated through a recipient zero-knowledge proving process by which a zero-knowledge proof is generated and incorporated into said recipient zero-knowledge record. Said zero-knowledge proof comprises a non-interactive zero knowledge proof which encodes a proof of one or more of the following data relationships:
(a) the updated masked private ledger of the recipient's account or address is a hash digest computed by hashing the updated unmasked private ledger of the recipient's account or address;
(b) the updated unmasked private ledger of the recipient's account or address is a transformation of the original unmasked private ledger, which transformation comprises an increase in the quantity of the transferred tokens or value units specified in the private input;
(c) the original masked private ledger of the recipient account or address is a hash digest computed by hashing the original unmasked private ledger of the recipient account or address;
(d) transfer hash digest is a hash digest computed by hashing the transfer's token/value type, configuration and/or quantity data included among the algorithmic encoding's private inputs

In an embodiment, when an instance of said recipient zero-knowledge record/transaction is evaluated, additional validation steps will be performed on said zero-knowledge record or transaction. Such validation steps may include, among others: a confirmation that a reference to or identifier of a sender zero-knowledge record or transaction is encoded in the recipient zero-knowledge record or transaction; a confirmation that the a recipient account or address encoded in the referenced sender zero-knowledge record or transaction matches the account or address of the recipient; a confirmation that the original masked privacy ledger provided as an input to the recipient zero-knowledge algorithmic encoding is a hash digest value equal to the hash digest value of the recipient's current masked privacy ledger referenced by the recipient's account or address stored in the global state. Only public inputs and outputs will be included with the record/transaction, and not any private inputs or outputs.

Upon said recipient zero-knowledge record or transaction being validated successfully and incorporated into a block by a block-building node, said block-building node will cause the original masked privacy ledger of the recipient to be replaced with the updated masked privacy ledger of the recipient.

In an embodiment, the sender and the recipient may exchange information off-chain regarding the transaction, via one or more electronic or non-electronic means, which means may include (but are not limited to) messages transmitted over a packet-switched network, messages transmitted via analogue or digital radio transmission, messages transmitted via infrared signal, messages encoded as images scanned by an optical scanning device, magnetically-encoded media, messages conveyed by sound, and other communications media. Said information shared by the sender to the recipient may include one or more of the following:
(a) One or all of the type, configuration and/or quantity of the token(s) or unit(s) of value that were transferred, hashed to produce the transfer hash digest;
(b) A reference number or transaction number the sender may use to identify the zero-knowledge record or transaction;
(c) The zero-knowledge record or transaction itself.

In an embodiment, a recipient may construct, assemble or encode a recipient zero-knowledge record or transaction by incorporating one or more information elements shared by the sender.

In an embodiment, a recipient zero-knowledge record or transaction may be added to the blockchain after a sender zero-knowledge record or transaction has already been added to the blockchain, or, optionally, the recipient zero-knowledge record or transaction may be added to the blockchain together with the sender zero-knowledge record or transaction, in combination in a manner that the second record or transaction executes immediately following the first record or transaction without any interruption, to be executed atomically in a single combined state transformation.

In an embodiment, said two-step process involving two zero-knowledge records and/or transactions may co-exist with other zero-knowledge record and/or transaction implementation described herein.

One or more of the embodiments described above may also include systems or methods of applying permissioning constraints to the process of generating and/or validating the zero-knowledge records or transactions described.

In one or more embodiments, a permissioning constraint may be executed and evaluated by a block-building node prior to validating the zero-knowledge proof and other elements of a zero-knowledge transaction or record. Said permissioning constraint may be associated, for instance, with a particular account or address, or with a particular token type, or other element of the global state which is implicated by the publicly-readable encoding of the zero-knowledge record or transaction being evaluated. In an embodiment, a permissioning constraint may evaluate whether, in a non-limiting example, a particular type of token or unit of value may be used or referenced somehow by a one or more zero-knowledge records or transactions, or, in another non-limiting example, whether a particular account or address may originate or be referenced by one or more zero-knowledge records or transactions.

In one or more embodiments, a permissioning constraint may be encoded in a manner that is interpretable executed and evaluated within a zero-knowledge algorithmic encoding associated with one or more zero-knowledge records or transactions, such that said permissioning constraint may operate on private non-public data of a zero-knowledge proof of the zero-knowledge record or transaction, and whereby said zero-knowledge proof may prove whether or not the permissioning constraint has been satisfied by the private and public data thereof.

In one or more possible embodiments described herein, the zero-knowledge algorithmic encodings used should not contain or implement any loops or recursions. A permissioning constraint interpreter may need to unroll any iterative function into a branching logic of fixed depth. In an embodiment, the number of iterations available for a permissioning constraint may be limited; alternately, the size of data structures upon which a permissioning constraint may operate may be limited so that iterations are only of a maximum length.

### Consensus And Reorganization Risk

Various embodiments disclosed herein include improvements in blockchain systems related to the management and mitigation of risks presented by probabilistic blockchain consensus mechanisms, and the optimization of transaction processes through off-chain solutions, including as payment channels. Such details described herein provide means enhance the security, scalability, and efficiency of blockchain-based systems. Each described feature is optional, and various configurations or combinations of the described features may be implemented in various embodiments.

Blockchain networks rely on consensus protocols to validate and append new blocks of transactions to the blockchain. Such protocols may include such protocols as, for example, Proof of Work (PoW), Proof of Stake (POS), Delegated Proof of Stake (DPOS), Fitness Gradient Consensus (FGC), and hybrid systems combining one or more of these mechanisms. In an example embodiment, protocols like PoW, POS, FGC, and their variants, depending on the nature of the embodiment, may be susceptible to blockchain reorganization in the event of a network partition, as nodes may create divergent chains that require reconciliation once the partition is resolved.

This susceptibility to reorganization highlights the importance of transaction finality in blockchain systems. Transaction finality refers to the assurance that a transaction, once confirmed, is permanently included in the blockchain and cannot be altered or reversed. For example, in consensus protocols like PoW, PoS and FCG, finality is probabilistic, meaning that the certainty of a transaction being final increases as more blocks are appended after it. However, during events such as, for example, network partitions or attacks, these protocols may experience temporary chain divergences, leaving transactions vulnerable to reorganization.

Reorganization occurs when a blockchain replaces a previously accepted sequence of blocks with a new, longer chain, typically due to network partitions or competing forks. Transactions in the discarded blocks are not invalidated but may be delayed, reordered, or excluded from the new chain, creating uncertainty for users. A key risk is that a reorganized transaction may result in a double-spend, where the same tokens or funds are spent in conflicting transactions on different branches of the chain. This risk is particularly significant in off-chain scenarios, such as payments for goods or services, where recipients may act on a transaction before it is final. In such cases, a double-spend could leave recipients without payment, eroding trust in the blockchain's reliability.

This highlights the importance of transaction finality, which is the point at which the probability of reorganization becomes negligible, ensuring that confirmed transactions are permanently recorded, such that transformations to the global state effectuated by said records and/or transactions cannot be altered or reversed.

One aspect of the embodiment addresses the risks posed by a blockchain reorganization generally, as well as the specific risk of a “51% attack,” a vulnerability of some probabilistic consensus protocols, and a possible vulnerability of embodiments of the present invention that utilize such probabilistic consensus protocols. A 51% attack may occur when an entity or a coordinated group of entities gains control of the majority of a network's computational power or is able to harness new computational power greater than the computational power of the network. This majority control may enable the attacker to potentially rewrite blockchain history by reorganizing blocks already incorporated into the blockchain, thereby enabling actions such as the deletion of transactions. Note, however, that random reorganizations or those caused by network partitions pose similar if not the same risks to users as a 51% attack; furthermore, networks that are not susceptible to 51% attacks may nonetheless be susceptible to reorganizations under other circumstances. Regardless of the cause, a reorganization may delay, reorder, or exclude transactions, creating uncertainty and undermining trust in the blockchain. For users, the cause of the reorganization is irrelevant—the lack of finality impacts the system's reliability and security.

The probability that a particular block will be reorganized out of existence—or that a 51% attack may succeed in effectuating a reorganization-diminishes with increasing block age and network size. Specifically, the amount of computational power that may be required to successfully execute such an attack increases for older blocks or for blockchains with larger mining networks. Thus, in embodiments involving larger blockchain networks, transactions embedded in older blocks may be less susceptible to reorganization.

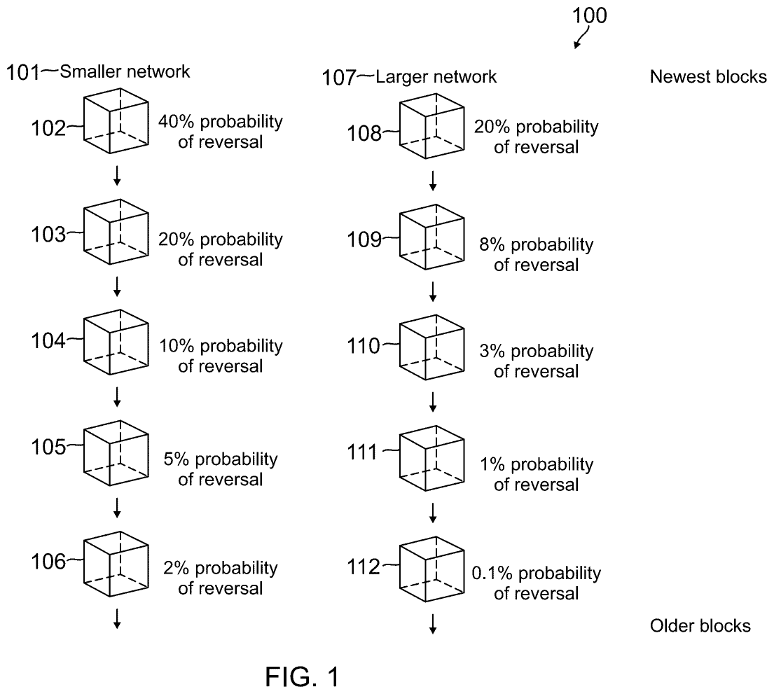

FIG. 1 illustrates a comparison 100 of the relative risk of reorganization occurring for a smaller network 101 and a larger network 107, according to various example embodiments or implementations. It should be understood that the probability values depicted in FIG. 1 are provided purely for illustrative and exemplary purposes to demonstrate relative differences in attack vulnerability between smaller networks 101 and larger networks 107. The specific numerical values shown are exemplary only and actual networks may exhibit different probability values, where the probability represents that there will be a reorganization at the same depth if there is a fork, at different times. This probability recedes as you go deeper into the blockchain, where a higher depth corresponds to a greater age of a block. For blockchain networks that may be subject to reorganization, a payment channel network may provide finality as long as the timeclock of the payment channel is longer than the likely depth of a reorganization.

These payment channels provide a solution for the finality of payments. The smaller networks 101 may exhibit a difference in reorganization vulnerability depending on the recency of the network, in an example implementation. The recent small-network block 102 may experience a probability value of 40%, the less recent small-network block 103 may experience a probability value of 20% the aging small-network block 104 may experience a probability value of 10%, the older small-network block 105 may experience a probability value of 5%, and the oldest small-network block 106 may experience a probability value of 2%. The larger networks 107 may also exhibit a difference in reorganization vulnerability depending on the recency of the block. The recent large-network block 108 may experience a probability value of 20%, the less recent large-network block 109 may experience a probability value of 8% the aging large-network block 110 may experience a probability value of 3%, the older large-network block 111 may experience a probability value of 1%, and the oldest large-network block 112 may experience a probability value of 0.1%. A key principle illustrated is that larger networks 107 generally demonstrate lower reversal probabilities than smaller networks 101 for blocks of comparable age, and that reversal probabilities generally decrease as blocks age within both network sizes, i.e., as you go deeper. The anchor block solution is that the depth can be guaranteed through an anchor. The anchor blocks have a feature that makes it harder to reorganize. In an embodiment, the anchor block may get a fitness enhancement, for example through a formal mechanical aspect that enables issuers of tokens to have extra weight when creating a block, therefore making it less likely or impossible for a reorganization to occur past the depth where one or more of these blocks have been included in the blockchain. This is important for payment channels because even in the event of a reorganization, as long as the payment channels are longer than the probabilistic limit of the length of the reorganization's new fork, the payment channel may not be removed from the blockchain. Therefore, the payment channel provides a mechanism of finality provided that the time lock on the escrow contract is longer than the length or age of the fork. The anchor block decreases the probability of a fork at that block.

The nature of reorganization risk in certain embodiments is illustrated in diagram 100 of FIG. 1 discussed herein. Depending on the nature of the embodiment, reorganization risk may be described in the form of block reversal probabilities, which may vary based on multiple factors including, but not limited to, network size and block age. For example, in some embodiments involving smaller networks 101, newer blocks may face relatively higher reversal probabilities, which is shown in the diagram to be 40% 102 in some cases. In various embodiments, such probabilities may demonstrate progressive reduction with block age, shown in the diagram to decrease to 20% 103, then to 10% 104, then to 5% 105, and potentially reaching 2% 106 for older blocks.

Some embodiments involving larger networks 107 may demonstrate a similar pattern of probability reduction with block age while maintaining comparatively lower probabilities across all block ages. For instance, in the example illustrated by the diagram, newer blocks in larger networks may face reversal probabilities of 20% 108, with such probabilities potentially decreasing to 8% 109 for somewhat older blocks, then to 3% 110, then to 1% 111, and potentially reaching 0.1% 112 for the oldest blocks. In various embodiments, this pattern may demonstrate both the enhanced security of larger networks and the increasing security of older blocks.

Nonetheless, in various embodiments, a particular “certainty value” may be assigned to blocks, indicating the likelihood of their permanence based on the observed network size and mining power distribution. Depending on the embodiment, said certainty value may be purely conceptual, or it may be computed or evaluated heuristically by participating nodes, and used to make various decisions and/or to compute various conditionals in the course of the implementation's operation.

Various embodiments of the present invention implement mitigation strategies to reduce the probability or the impact of reorganization. These modifications may reduce the time required for block confirmations and adjust computational power requirements to disincentivize majority control.

### Finality Determination

In various embodiments, systems and methods may be provided for determining blockchain consensus finality through various computational frameworks. For example, some implementations may employ calculations to determine potential reorganization probabilities based measurements or estimates of network computational power, token ownership distribution among block-building nodes, age of token ownership distribution among such nodes, the performance of a random function, or another variable or set of variables the values of which are dependent on network makeup or network performance or on a stochastically or probabilistically determined metric related to said blockchain.

Certain embodiments may implement such certainty calculations with recognition that block reversal probabilities may vary based on multiple factors including, but not limited to, network size and block age. Such probabilities may demonstrate progressive reduction with block age in some embodiments. Such calculations may, in certain embodiments, enable assignment of certainty values to individual blocks, where such certainty values may represent likelihoods that specific blocks (inclusive of subsequent blocks) may be removed from the blockchain through a reorganization. In other variated embodiments, blockchain finality is determined according to a more simple heuristic, for example whether or not a block has reached a certain depth or age.

In certain embodiments, said probability frameworks may enable implementation of dynamic confirmation threshold systems. For example, some implementations may establish one or more certainty thresholds that may be achieved at varying times depending on network characteristics. Such timing variations may, in some embodiments, result in a block and its transactions being deemed final within broad timeframes, potentially ranging from a few seconds to up to or even more than an hour or several hours or more, with specific timing potentially being determined by network size and other relevant factors. Various embodiments may implement systems whereby records and/or transactions may be designated as “confirmed” upon their containing blocks achieving designated certainty thresholds, which records and/or transactions are designated as “pending” until it's block is deemed final.

Some implementations may employ such confirmation frameworks to implement loss prevention systems. For example, certain embodiments may incorporate timing controls that maintain holds on various activities until relevant certainty thresholds are achieved. Such activities may include, but are not limited to, transmission of off-chain or external payment, initiation of shipping processes, execution of asset transfers, transmission of money-transfers, crediting of bank accounts, application of refunds, or activation of payment channels funded by on-chain transactions. Various embodiments may thereby provide protection mechanisms against potential losses that might otherwise occur during chain reorganization events. In some implementations, such protection mechanisms may be particularly relevant to high-value transactions that may require confirmation by one or more anchor blocks before being considered final.

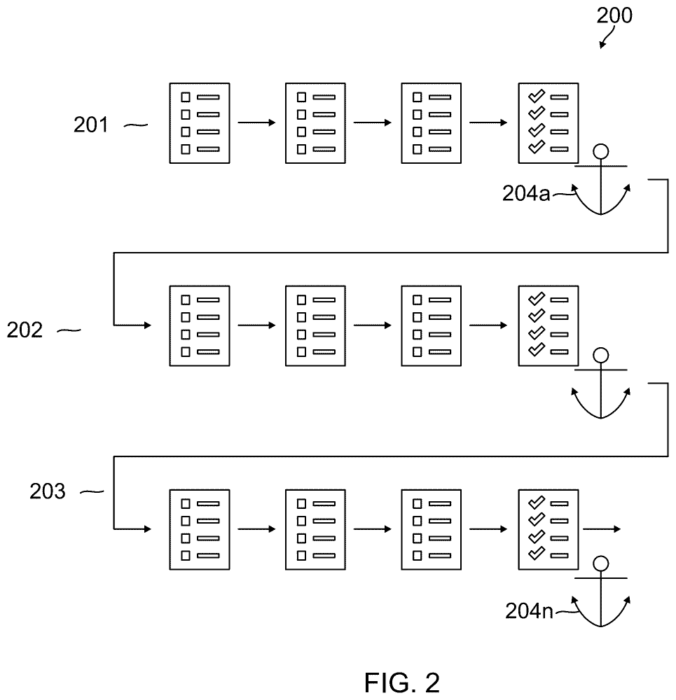

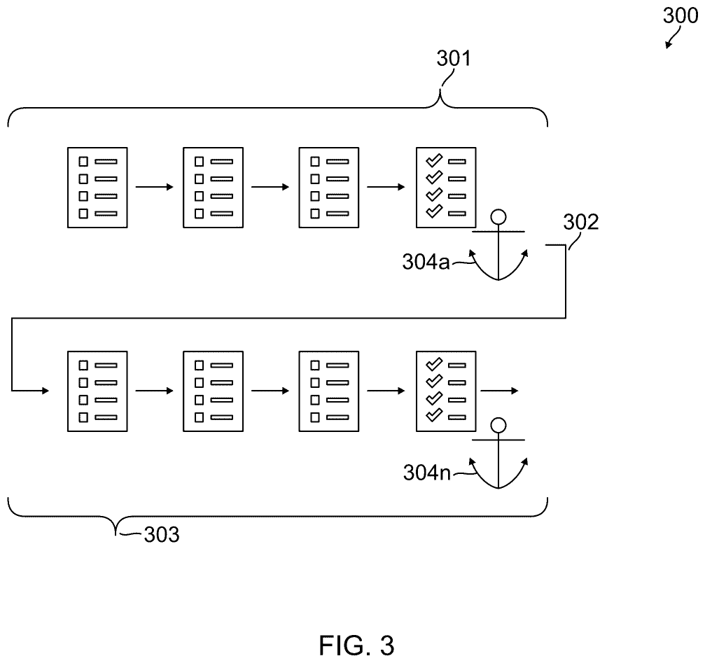

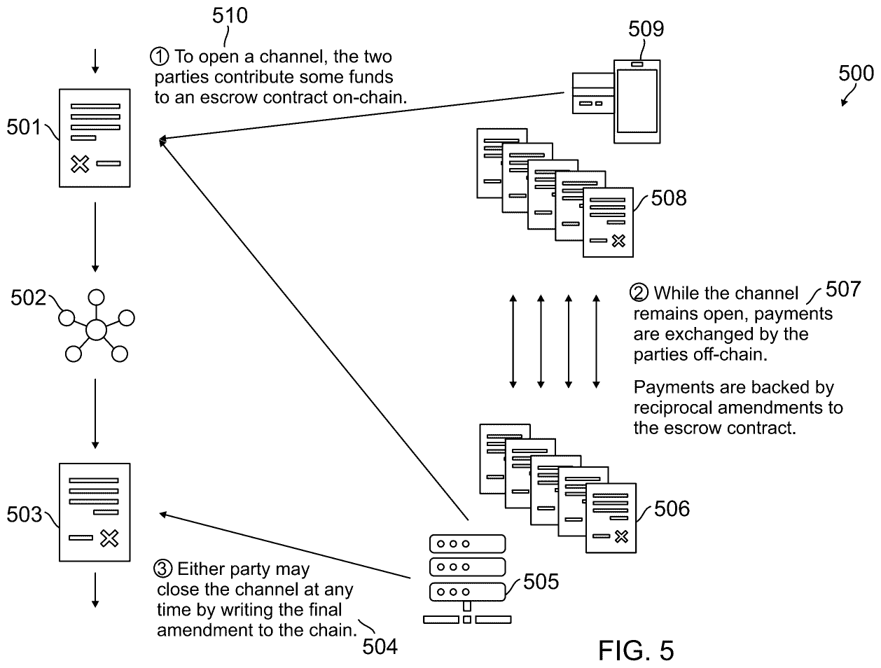

In various embodiments, such confirmation and security frameworks may be integrated with other security mechanisms including, but not limited to, anchor blocks (204a-n, 300a-n discussed below in relation to FIGS. 2 and 3, respectively) and payment channels (See, FIG. 5 discussed below). Some implementations may enable these various security mechanisms to work in concert, potentially providing enhanced protection against the potential impacts of reorganization (such as double-spends) while maintaining efficient transaction processing capabilities. Certain embodiments may employ these integrated security approaches to balance transaction speed requirements with security needs, potentially enabling rapid processing of lower-risk transactions while maintaining heightened security measures for higher-risk transactions.

### Anchor Block Backstop

Certain embodiments may employ “anchor blocks” as a means to reduce the likelihood, frequency, or impact of reorganizations. Such blocks may be periodically inserted into the blockchain, and thus act reduce the risk of reorganization of blocks preceding insertion point. The presence of anchor blocks within a blockchain restrict or reduce a maximum chain reorganization length, mitigating the risk of reorganization and of double-spend attacks. In various embodiments, anchor blocks may be validated and signed by a subset of block-building nodes explicitly designated as trusted.

In one or more embodiments, anchor blocks may act as backstops, limiting the possibility for blocks to be reorganized beyond a threshold block depth (distance from the most recent block). In one embodiment, anchor blocks may be spaced at regular intervals, and any proposed chain fork extending beyond a length of N blocks should include at least one anchor block at depth N or more recent to be accepted by the network. This approach effectively prevents malicious reorganization of the blockchain past the anchor block.

In various embodiments, the interval between anchor blocks may vary based on network parameters, such as the number of active miners and the total computational power of the network. Depending on the embodiment, in a smaller network, anchor blocks may occur, for example, as frequently as every few minutes or even multiple times in a minute, whereas in a larger network, intervals may range, for example, from days to weeks. In some embodiments, such intervals may be adjustable and configurable based on network requirements and desired security thresholds.

Certain embodiments may implement dynamic adjustment of the interval based on real-time network metrics. For example, some implementations may decrease the interval (thereby increasing anchor block frequency) if the network size decreases below certain thresholds, or increase the interval if the network grows beyond certain thresholds. Various embodiments may also consider additional factors such as network hash rate, mining difficulty, or various other metrics determinable the blockchain global state and/or on-chain data when determining appropriate intervals between anchor blocks.

In one or more embodiments, blockchain records and/or transactions achieve finality when the block containing said record or transaction is followed by a defined number of additional blocks, including one or more anchor blocks. This multi-block confirmation process ensures that transactions are secure against potential reorganizations. The inclusion of an anchor block may in some embodiments reduce reorganization risk to near zero.

FIG. 2 shows an illustration 200 of certain anchor block concepts, according to at least one example embodiment. Such anchor blocks 204a-n may, in certain implementations, be subject to additional validation requirements beyond standard consensus rules. For example, some embodiments may require that every Nth block be validated and signed by one of a limited set of trusted nodes. In certain embodiments, the system may be configured to avoid repetition in block-building responsibility among these trusted nodes, and/or it may be configured to permit said trusted nodes to compete among themselves to generate a new block. Double spends 201 may happen when forks emerge that are longer than expected. In one or more embodiments, anchor blocks 204a-n may provide an upper limit for the length of forks that may contain a double-spend attack. Unless 202 a fork is longer than length N is signed by at least one anchor node 204a-n, it that fork may not be accepted by the rest of the network. Double spends may be avoided 203 with greater certainty by not accepting a transaction's finality until the block that contains it is built upon by a chain of length N.

Depending on the embodiment, the time interval between anchor blocks may be fixed, or it be configured to vary based on some on-chain metric, for instance total network computational power, the difficulty of an algorithmic problem being solved, the aggregate value of locked tokens, or the number of block-building nodes participating in the network, with smaller networks or networks achieving lower metrics benefiting from and configuring smaller intervals than larger networks or networks achieving higher metrics.

Various embodiments may employ said anchor blocks to reduce the risk or negative impact of a reorganization that may result from a blockchain fork. For example, in some embodiments, a fork of length greater than N may be rejected by the network unless it contains at least one authorized anchor node 202 at a depth less than N, or alternately at a depth less than N+1. In certain embodiments, a blockchain network may assign higher trust values to anchor blocks they create compared to blocks created by standard nodes. This trust differential may enable anchor blocks to function as secure backstops, potentially establishing hard upper limits on record and/or transaction confirmation time that may be independent of network size.

In one or more embodiments, anchor blocks may be produced through competitive processes rather than through direct selection. For example, some implementations may allow both trusted nodes and untrusted nodes to compete to produce a block at any given block height. Various embodiments may provide trusted nodes with certain probabilistic advantages in such competition. In some embodiments, for instance within a proof-of-work system, trusted nodes may be assigned lower difficulty targets to satisfy algorithmic requirements compared to untrusted nodes. Some embodiments may implement other probabilistic selection processes wherein trusted nodes may be given higher selection probabilities compared to untrusted nodes.

In certain embodiments, while trusted nodes may enjoy competitive advantages, such advantages may be probabilistic in nature and may not guarantee selection of trusted nodes' blocks. For example, some implementations operating with larger networks may still frequently select blocks produced by untrusted nodes despite the probabilistic advantage given to trusted nodes. Various embodiments may configure trusted nodes to compete with each other on equal footing. Some implementations may distribute unequal competitive advantages among trusted nodes according to one or more objectively-determined metrics.

In various embodiments, while anchor blocks produced by trusted nodes may serve particular security functions as described herein, the competitive block production process may continue to provide opportunities for untrusted nodes to contribute blocks to the chain, even if designated anchor block heights are specified by the embodiment. Some implementations may dynamically adjust the probabilistic advantages given to trusted nodes based on network conditions such as size, security requirements, or other metrics.

In contrast, in alternate embodiments, the anchor block mechanism may, provide a deterministic approach to transaction finality by ensuring that a valid fork should contain anchor blocks.

In one or more embodiments, trusted nodes may attempt to communicate with each other outside the public blockchain protocol, in order to detect if the blockchain fork they are connecting to is also subscribed—to by a minimum threshold of trusted nodes, or if the fork may be a minority fork, an isolated fork, or may otherwise be subject to reorganization in the future. In such an embodiment, a trusted node that finds itself out-of-sync with other trusted nodes may abstain from generating any anchor blocks, and any wallet node or interface node services or activities provided in conjunction with said trusted node may be paused until said trusted node synchronizes its version of the global state with the majority fork, connected fork, or whatever other fork is likely to persist due to the participation of other trusted nodes.

### Payment Channel Networks, Structures And Processes

Embodiments described herein also contemplate the use of payment channels and payment channel networks to optimize transaction scalability, reduce fees, and enhance privacy. In one or more embodiments, payment channels operate as time-locked escrow contracts, enabling two parties to transact off-chain while potentially utilizing the blockchain only for the opening and closing of the channel.

Payment channel networks, such as the Bitcoin Lightning Network, offer substantial advantages over traditional on-chain blockchain payments by enabling faster, more cost-effective, and scalable transactions. These networks allow participants to conduct off-chain transfers, reducing congestion and transaction fees while maintaining the security of the underlying blockchain. By aggregating the value multiple payments into a single on-chain settlement, users minimize fees and optimize efficiency, particularly during periods of high blockchain activity.

A key benefit of these networks is near-instantaneous payment processing. Once a payment channel is established, value can be transferred without waiting for block confirmations, making payment channel networks ideal for applications such as retail payments, micropayments, and cross-border transfers. Additionally, payment channel networks enhance scalability by shifting many payments off-chain, potentially reducing record and/or transaction processing load of a blockchain, and increasing payment throughput of the overall system.

In one or more embodiments, payment channel networks may also provide enhanced resilience to blockchain reorganizations, which may occur, for example, in the context of a network partition, 51% attack or similar disruption. By facilitating payments off-chain, payment channels may reduce the exposure of individual payments to the risk of reversal or invalidation. In certain embodiments, only the opening and closing events of the channel are recorded on-chain, and these on-chain events may optionally incorporate additional protective mechanisms. In certain embodiments, such protective mechanisms may include anchor blocks and/or configurable confirmation delays, to further mitigate risks. This configuration allows one or more payment channels to avoid being disrupted by a blockchain reorganization, thereby reducing the likelihood of financial losses or service disruptions for participants.

Payment channels and payment channel networks also provide a significant advancement over traditional consumer payment networks, such as Visa and Mastercard, by enabling instantaneous or near-instantaneous settlement between the payer, merchant, and intermediaries. In a payment channel network, funds received can be immediately reused, even before being recorded back on the blockchain, allowing for real-time liquidity. Syncing the payment channel to the blockchain for final settlement incurs only minimal delay, ensuring rapid and seamless finalization.

Additionally, payment channels eliminate the risks of default and chargebacks that are present in traditional payment systems. Transactions within payment channels are cryptographically secured and finalized through mutually signed amendments, ensuring they are irrevocable and fraud-resistant. This design removes reliance on third-party arbitration, providing both payers and merchants with greater security, certainty, and efficiency compared to conventional payment networks.

Payment channels are created and controlled by signatures added to payment channel records and/or transactions, which signatures are generated by keys, which keys are associated with addresses or accounts. A signature signs a transaction to create an account, and a signature authorizes the various transactions that update the account.

Nodes within a payment channel network each control one or more blockchain addresses or accounts, which blockchain addresses or accounts provide the node with the ability to open channels with other nodes in the network, and exchange value within the network.

The lifecycle of a payment channel typically involves several key steps, beginning with opening the channel, where two parties contribute value to a shared escrow contract. This transaction is recorded on the blockchain as the opening transaction, establishing the initial state of the channel. During the off-chain transactions phase, the parties exchange payments privately through signed amendments that update the escrow balance without interacting with the blockchain. These amendments serve as a secure record of the transaction history, maintaining the confidentiality of individual payment details. To enhance efficiency and ensure synchronization with the blockchain, the payment channel supports periodic updates. These updates allow the current state of the channel to be recorded on the blockchain at predefined intervals or upon mutual agreement, ensuring consistency and reducing potential disputes, all without requiring the channel to be closed. Finally, in the closing phase, either party may submit the final amendment to the blockchain, prompting the escrow contract to distribute the remaining balances according to the latest agreed state, thereby concluding the channel's lifecycle.

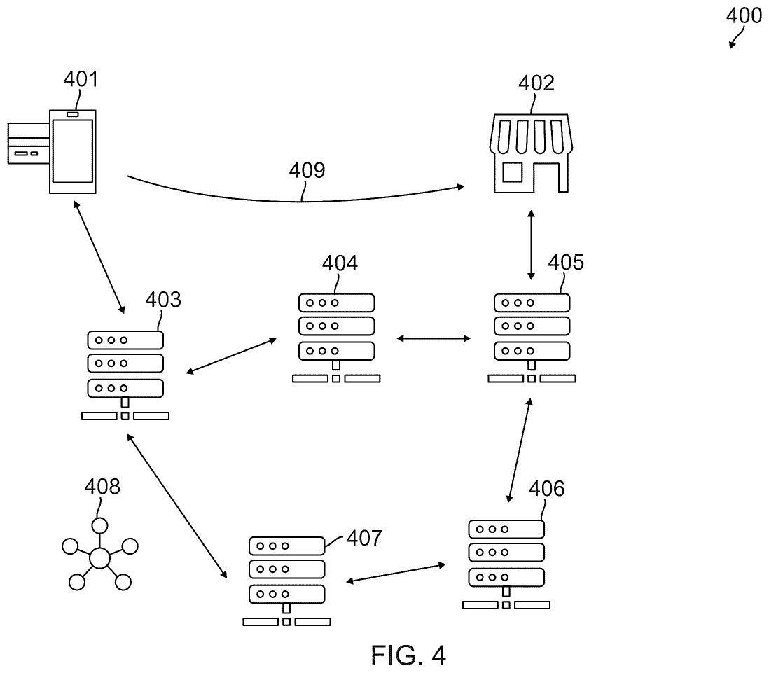

FIG. 4 shows a payment channel network 400 illustrating the progress of a payment in a network, and how a payment is conveyed to a recipient from a sender, according to at least one example embodiment. Various embodiments may implement a decentralized payment channel network structure comprising multiple interconnected components. In some implementations, the network may include one or more block-building nodes 408 that validate and process on-chain transactions, such as channel opening and closing operations, while a plurality of payment channel nodes 403, 404, 405, 406, and 407 form the core of the off-chain payment routing infrastructure, including edge nodes 403 and 405, as well as interconnection nodes 404, 407, and 406. Each payment channel node may maintain multiple payment channels with other payment channel nodes, enabling the formation of diverse payment routes through the network while reducing on-chain transactions. The payment channel node with which a node has opened a payment channel is the channel partner of that node.

According to certain embodiments, end-user components may interface with the network through specialized access points. For example, sender wallet (payment channel wallet) nodes 401 may comprise user interface elements and cryptographic capabilities that enable users to initiate payments, but such wallet nodes may interact with the network exclusively through one or more edge nodes 403. Similarly, payment channel merchant or recipient interfaces 402 may comprise point-of-sale or payment acceptance wallet nodes or interface nodes which may connect through one or more separate edge nodes 405. This structure may create an architecture where wallet nodes and interface nodes connect to edge nodes, and interconnect nodes maintain interconnected payment channels with each other, while a plurality of these components exchange data and synchronize state with block building nodes 408, which update the global state by incorporating records and/or transactions generated by the other components of the system.

In some implementations, the relationships between components may be governed by specific rules and constraints. Payment channel nodes 403, 404, 405, 406 and 407 may establish and maintain off-chain payment channels with multiple peer payment channel, creating a plurality of possible payment routes, while also serving as access points for their associated wallets and merchant interfaces. Block-building nodes 408 may process and validate the on-chain transactions that secure these payment channels, including channel creation, closure, and dispute resolution operations, without being directly involved in individual payments. This architecture may enable high-throughput payment flows while maintaining security through a combination of off-chain efficiency and on-chain settlement guarantees.

According to various embodiments, a payment flow through a decentralized payment channel network 400 may be described. Said payment flow may be initiated when a merchant or other intended recipient desires to receive payment. In some implementations, the recipient's system may generate a unique secret confirmation code and establish a conditional payment route through the network, communicating this secret code to the prospective sender through a payment initiation message 409. This secret confirmation code may serve multiple purposes: it may prove payment completion, prevent intermediate nodes from claiming funds without recipient confirmation, and ensure atomic execution of the multi-hop payment.

In certain embodiments, the payment process may begin at a sender's wallet node 401. This wallet node 401 may maintain an exclusive relationship with a specific payment channel node 403, which may serve as the wallet's sole entry point into the payment channel network. One or more embodiments may require the wallet node 401 to operate as a captive system of its associated edge node 403, necessarily accepting the fee structures and operational parameters established by that edge node; alternate embodiments allow wallet nodes to connect to multiple edge nodes. The edge node 403, upon receiving a payment request from its associated wallet node 401, may begin orchestrating the payment's journey through the network.

Various embodiments may implement various routing mechanisms as the payment propagates through the network of payment channel nodes 403, 404, 405, 406, and 407. Payment channel nodes may maintain fee schedules for routing services, and the network may employ pathfinding algorithms to identify optimal routes. These algorithms may consider multiple factors, including but not limited to: aggregate routing fees across each potential path, available channel liquidity, channel reliability metrics, and historical performance data. The system may dynamically adjust routes based on real-time network conditions and may maintain alternative routes as contingencies.

In certain embodiments, the sender 401 and recipient 402 may operate using different tokens, currencies, or other units of value, requiring currency conversion or token exchange as part of the payment flow. Some implementations may enable payment channel nodes 403, 404, 405, 406, and 407 to maintain current exchange rate information and offer different conversion rates for various token pairs or currency pairs. The pathfinding algorithms may incorporate these exchange rates alongside routing fees to optimize various payment parameters according to configured preferences. For example, some embodiments may optimize routes to maximize the value received by the recipient 402 by identifying paths with favorable combinations of exchange rates and routing fees. Other implementations may optimize to minimize the amount the sender 401 should pay to deliver a specified value to the recipient 402. Various embodiments may enable participants to specify their optimization preferences, such as fastest settlement time, lowest aggregate fees, best exchange rates, or weighted combinations thereof. The system may calculate optimal routes that satisfy these preferences while accounting for the available liquidity in each candidate payment channel and the various exchange rates and fees offered by each payment channel node 403, 404, 405, 406, and 407 along potential paths.

In certain embodiments, the payment channel nodes 403, 404, 405, 406, and 407 may implement a staged settlement protocol that ensures payment security and atomicity. Each payment channel node's channel update may be conditional upon successful completion of all subsequent hops, with the secret confirmation code serving as proof of completion. This staging mechanism may protect against partial payments, ensure that routing nodes cannot lose funds due to downstream payment failures, and maintain the atomic nature of the overall transaction.

According to some implementations, each hop in the payment route may establish conditional payment commitments that are secured by cryptographic hashes of the secret confirmation code. When the payment reaches the recipient's payment channel node 405, the recipient 402 may verify the incoming payment details and reveal the secret code to claim the funds. This revelation of the secret confirmation code may trigger a cascade of settlement operations, propagating backward through the payment route. Each participating payment channel node 405, 404, and 403 may validate the secret code, settle its incoming payment channel, and reveal the secret to its predecessor in the route, creating an atomic chain of settlements that either completes fully or fails completely.

Various implementations may employ timeouts and fallback mechanisms at each hop to handle potential failures or delays. If the recipient 402 fails to reveal the secret confirmation code within a specified timeframe, or if any intermediate node becomes unresponsive, the conditional payments may automatically cancel, releasing reserved funds and allowing nodes to attempt alternate routes. This timeout mechanism may work in conjunction with the routing system to ensure reliable payment delivery while protecting participants from locked funds or incomplete transfers.

In certain embodiments of a payment channel network, said secret confirmation code comprises a hash pre-image of a cryptographic hash function (the pre-image), which is initially shared by the sender wallet node with the recipient wallet node or interface node in a direct communication, and which in the final stage may be propagated from the recipient wallet node or interface node 402 back to the original sender, facilitating the settlement of the payment across the network of payment channels.

In various embodiments, a payment channel network payment relies on Hash Time-Locked Contracts (HTLCs), which may require the recipient of a payment to reveal the pre-image in order to claim funds. The pre-image is a piece of data that satisfies the hash condition and unlocks the payment, as per the mechanism of the HTLC. When the ultimate receiver of the payment claims the funds associated with the HTLC, the receiver wallet node or interface node may share the pre-image with their edge node, which will in turn share it with its direct channel partner, in at least one embodiment by signing and sharing an updated payment channel record or transaction that includes the pre-image and resolved HTLC. The channel partner may then reclaim their portion of the payment from the next channel in the chain, by in turn revealing the pre-image to their next channel partner in the chain, in an embodiment by signing and sharing an updated payment channel record or transaction that includes the pre-image and resolved HTLC. The propagation of the pre-image continues in a reverse sequence, with each channel partner updating their respective channel state and exchanging new transactions with their counterparty to reflect the settled HTLC.

As the pre-image propagates back toward the original sender, each intermediate channel updates its local state, reducing the locked HTLC funds and restoring available liquidity. This process ensures that each intermediary receives their portion of the payment, covering the amount they forwarded plus any fees they are entitled to for routing the payment. The final settlement results in updated channel balances for all participating nodes, ensuring that the payment is securely and efficiently processed end-to-end.

In certain embodiments, if the pre-image required to resolve HTLC is not shared, the payment cannot be settled, and the locked funds remain inaccessible until the contract expires, effectively nullifying or voiding the payment. This may occur if the recipient chooses not to claim the payment, communication fails, or the network is disrupted. The system enforces atomicity, ensuring incomplete payments do not affect channel balances, and participants can take corrective actions if needed.

In various embodiments, this propagation mechanism enables trustless, atomic multi-hop payments. It ensures that funds are only released when the ultimate receiver claims the payment and provides the required pre-image, preventing any intermediate node from being at risk of loss. This process is non-limiting and may vary in specific implementations, as alternative methods of propagating the pre-image or resolving HTLCs could be employed while maintaining the principles of atomicity, security, and decentralization.

FIG. 5 shows a diagram 500 illustrating that in various embodiments, the individual payment channels established between nodes (i.e. between channel partners) are implemented as a payment channel structure 500 which may be established through a sequence of defined steps and states. Initially, during a channel establishment phase, two participating nodes may contribute funds to an escrow contract 501 that may be recorded on a blockchain network 502 for processing. This initial escrow contract may establish starting parameters including, but not limited to, initial value allocations, time lock parameters, and penalty conditions.

Some embodiments may maintain two sets of reciprocal amendments to the initial payment channel escrow contract, wherein a first set of contract amendments 508 may be stored off-chain in a first channel partner's node 509, while a mirrored set of contract amendments 506 may be maintained at a second channel partner's node 505. Each reciprocal amendment may already be signed by one channel partner node and sent to the other channel partner node, such that either node may close and settle the escrow contract by cryptographically signing and submitting to the blockchain network the amendment shared by its counterparty 502. In at least one implementation, said contract amendments (508, 506) may be implemented as zero-knowledge payment channel records.

In certain embodiments, while the payment channel remains open, parties may exchange payments 507 through the transfer of signed reciprocal amendments to the escrow contract. These amendments may update the escrow balance to reflect the value that has been transferred. Each time a new set of reciprocal amendments is generated, prior amendments representing old escrow states may be discarded and replaced. The block-building node 502 may ultimately process these amendments during channel closing events, or, alternately, on-chain updates to the channel that do not close the channel. However, in various embodiments, all or most amendments are held off-chain while the payment channel stays open.

Various embodiments may protect against fraudulent submissions through a “token penalty” mechanism, which token penalty may be imposed by the application of a “revocation key”. If a cheating channel partner attempts to submit an outdated amendment through the blockchain network 502, the counterparty channel partner may write the revocation key to the blockchain, causing the revocation penalty to be paid to the counterparty channel partner at the expense of the cheating channel partner. This penalty mechanism may be enforced through time-locked amendments that prevent immediate settlement, providing time for a penalty record or transaction to be incorporated into the blockchain.

Some embodiments may implement settlement procedures wherein either party's node 505, 509 may initiate channel closure 504 by submitting a final contract state in the form of a final update or closing payment channel record or transaction 503 to the blockchain network 502. To enable penalty enforcement, the escrow may remain frozen during a lock period to give counterparties time to submit penalty keys if outdated amendments are broadcast.

In certain implementations, every time new amendments are exchanged between the channel partner's nodes 505, 709, revocation keys pertaining to the previous generation of amendments may also be exchanged, effectively invalidating those prior amendments and rendering them worthless if submitted to the blockchain network 502.

Various embodiments may enable the channel to remain open indefinitely, with the first channel partner node 509 and second channel partner node 505 continuing to exchange payments and amendments 507 with only the opening payment channels being incorporated into the blockchain through the block-building node 502, with a closing payment channel record being held off-chain until the point that the channel is closed. In alternate embodiments, a payment channel may remain open indefinitely, but an update payment channel record or transaction may be periodically added to the blockchain periodically; such a record may act as the equivalent of a close payment channel record or transaction immediately followed by an open payment channel record between the same channel partners.

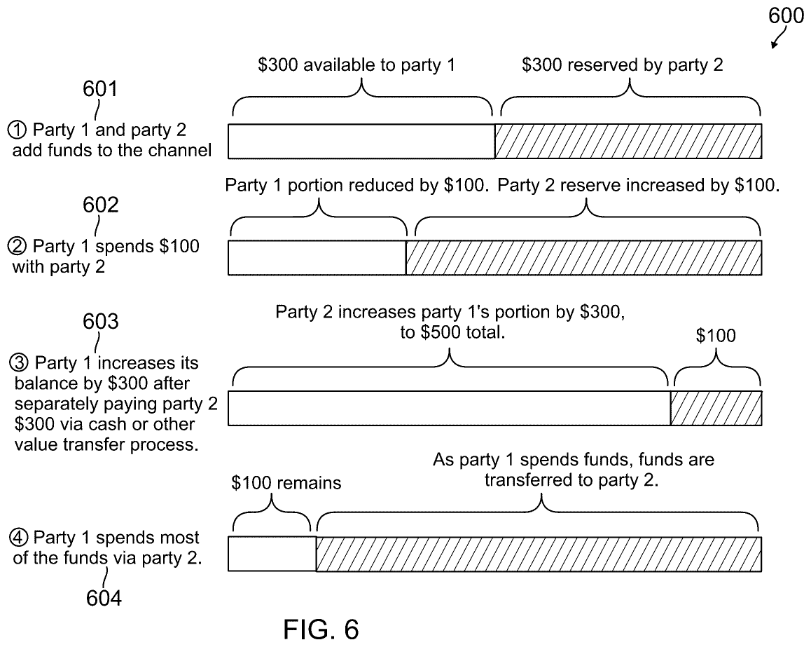

FIG. 6 shows a diagram 600 illustrating a payment channel lifecycle demonstrating how two channel partners may conduct multiple value transfers while maintaining only two on-chain transactions, according to an embodiment. During channel establishment, depicted in element 601, a first channel partner and a second channel partner may each commit value to a shared escrow contract, with the first channel partner making $300 available in its unspent portion and the second channel partner maintaining $300 in its reserve portion, in the example shown. This establishment may be recorded as a single on-chain transaction creating a cryptographically secure escrow.

In accordance with some embodiments, following establishment, the first channel partner may initiate a payment of $100 to the second channel partner as depicted 602. To effectuate this payment, the channel partners may exchange cryptographically signed state update or closing payment channel records or transactions that reflect adjusted channel balances. Through this exchange of reciprocal records, the first channel partner's available portion may be decremented by the value spent (depicted as $100 in the example shown) while the second channel partner's escrow amount may be incremented by the same amount. This modification of escrow balances may be maintained off-chain between the parties, avoiding the need to synchronize with the blockchain.

Subsequently, in some embodiments, value may shift from one channel partner to the other in response to an external payment 603. In the example shown, after the first channel partner transfers $300 to the second channel partner through a separate off-chain payment, the parties exchange updated payment channel records or transactions reflecting an increase in the first channel partner's escrow balance by $300, and a decrease in the second channel partner's escrow balance by an equivalent amount. An embodiment implementing such a method of modifying channel balances following an external provides a means for external funds to be added to a channel partner's account.

In accordance with some embodiments, as depicted in element 604, the first party may conduct multiple sequential payments through the second party. As the first party depletes their available funds, the state updates may continuously adjust the balance allocation between the parties, with each update superseding all previous states.

When all desired transfers are complete, in some embodiments, either party may initiate channel closure by broadcasting the most recent valid state to the blockchain. This settlement, representing only the second on-chain transaction in the channel's lifecycle, may distribute the escrowed funds according to the final agreed-upon allocation. Through this mechanism, the payment channel may enable an unlimited number of value transfers while requiring only two on-chain transactions-one for opening and one for closing.

It should be understood that while specific currency amounts are shown in FIG. 6 600, these values are exemplary only. Actual implementations may support any denomination of value compatible with the underlying blockchain system, bounded only by the initial channel capacity established during funding. The illustrated amounts serve primarily to demonstrate the relative relationships between sequential channel states and the preservation of total value across all state transformations.

### Payment Channels And Reorganizations

Payment channels may, in various embodiments, provide enhanced protection against blockchain reorganization through multiple coordinated timing mechanisms. In some implementations, initial protection may be achieved by requiring that no payments be processed across a payment channel until some margin of time after the on-chain transaction that opened the payment channel achieves finality (in whatever manner finality might be determined for said embodiments). After such point, subsequent payments across that payment channel may be considered to have to have immediate effective finality, effectively eliminating reorganization risk for those in-channel transactions.

The specific nature of finality for certain such embodiments is important, however. Further protection may, in some implementations, be required, which requirement may be satisfied through specification of a time-lock period for channel-closing operations that extends beyond the maximum duration typically required for on-chain finalization. Such extended time-lock periods may enable the correction of any attempted cheating, as they may provide sufficient time for payment channel penalty records or transactions to be successfully incorporated into the blockchain even if such transactions are initially reorganized out during an attack. However, depending on the embodiment, the time-lock period may need to be as long as 1x, 2x, or 3x the time required for the blockchain to reach finality, or longer, so as to eliminate the possibility of a penalty record ultimately not being incorporated into the blockchain in time.

FIG. 3 shows a diagram 300 illustrating how anchor blocks may serve as an additional risk mitigator for payment channel operations, also referred to as payment channel finalization with anchor blocks, according to an embodiment. Such anchor blocks may be implemented as specialized confirmation points created by trusted nodes, potentially providing definitive finalization of both channel-opening and channel-closing events. When channel operations achieve finalization through one or more anchor blocks, certain implementations may guarantee all payments within that channel for all participating parties, potentially providing comprehensive protection against various attack vectors including double-spend attempts and reorganizations.

According to some embodiments, blockchain records and/or transactions in general which exceed certain value thresholds may be subject to enhanced confirmation requirements 303. Depending on the nature of the embodiment, such high-value transactions may need to be followed on-chain by one or more anchor blocks before being considered final. The escrow size specified as part of open payment channel records and/or transactions may also be subject to size limitations that correspond to network security parameters, in some embodiments. The time-lock periods applied to channel escrow contracts may, in various embodiments, be coordinated with anchor block timing and network security metrics to maintain appropriate security levels throughout channel operation lifecycle 301-302.

The implementation of anchor blocks may, in various embodiments, provide a mechanism for establishing and maintaining transaction finality across different network scales and conditions. Such flexibility may enable efficient operation of payment channels while maintaining robust security against various risk scenarios.

### Payment Channel Liquidity Solutions

Various embodiments disclosed herein relate to payment channel liquidity and provide payment channel liquidity solutions.

A major challenge that confronts known payment channel networks such as the Bitcoin Lightning network is capital efficiency. This challenge emerges from the fact that tokens are placed in escrow within the individual payment channels. A payment channel protocol depends on all participating parties putting sufficient tokens in escrow to cover the maximum payment outflow each will undertake while operating the channel.

Token quantities locked in escrow on a payment channel network are not otherwise available for use-investable or spendable outside of the payment channel network-because they cannot be transferred out of escrow without closing, resetting, or modifying the channel on-chain. A frequent operating objective of payment channel networks is to avoid on-chain syncing of the payment channel state with the blockchain, so any re-allocation of escrowed tokens that may require on-chain syncing runs counter to that purpose.

Depending on the nature of the implementation, a payment channel may yield a return to a channel operator who connects multiple channels together via one or more nodes that provide connection between consumers and/or between consumers and businesses. Such nodes may be termed interconnection nodes. An interconnection node may generate a yield from the fees that are charged, or from an exchange rate margin that may be earned when payments traverse such an interconnection node (said payments constituting the node's payment flow). However, by definition, the percentage yield (which may be considered a return on capital) is inversely proportional to the value of tokens locked in such an interconnection node's payment channels. Said percentage yield (which as stated above may be considered a return on capital) is lower the greater the value of tokens locked in payment channel escrow in service of such a node, given a comparable payment flow. Inversely, the percentage yield is higher the lesser the value of tokens are locked, given a comparable payment flow. If more fees are generated with less token utilization inside the channels, the profit-per-token-value-locked is higher, meaning the percentage yield and return on capital is higher.

Businesses and investors that have the capacity to operate or fund interconnection nodes will often prefer to allocate money and/or capital (including tokens) in a manner that generates a yield. Conversely, many individual consumers and/or businesses may have a low expectation of any investment return or yield from accounts held for the purpose of every-day payments, particularly if they prioritize flexibility in the use of money and/or capital. Such consumers and/or businesses may lack a strong incentive to re-invest escrowed tokens, because there are often fewer competitive alternatives.

A category of businesses that may not require or desire a yield to be earned on some portion of tokens that they hold are the issuers of currency-denominated tokens; it is possible such issuers may themselves hold an unlimited number of such tokens they themselves have issued without incurring any opportunity cost. Such issuers may not have any requirement to hold reserves backing such tokens if they are not issued or distributed to any third party. Under various circumstances, such issuers may lack such a reserve requirement (meaning, a requirement to hold assets backing the value of tokens issued) when such tokens are issued on-chain but are held within their own “treasury” account.

An issuer of currency-denominated tokens (also called stablecoins) may be required by law, regulation, or market expectation to hold 100% reserves, meaning such an issuer is required to hold one liquid unit of currency (as, for example but not limited to, cash, government debt, and/or bank account balance) for every corresponding unit of currency-denominated tokens issued. However, in many instances no such requirement exists for tokens recorded on-chain by the issuer, but held by the issuer itself; this may be because there is no counter-party who would attempt to redeem such tokens. In fact, the process of redemption itself may involve the redeeming counter party transferring such tokens to the issuer's account on-chain before receiving the redemption payment off-chain.

Alternately, such issuers of currency-denominated tokens may lack any reserve requirement at all.

### Capital-Efficient Payment Channels

At least one possible embodiment of the present invention comprises a capital-efficient system and/or method to operate a payment channel network that processes and facilitates payments denominated in official currency or national currency.

One or more possible embodiments comprise a payment channel network configured in such a manner that currency-denominated token issuers function as operators of interconnection nodes. Such currency-denominated token issuers (also referred to herein simply as “issuers”) may be able to fund their portion of the escrow using tokens that they themselves have issued without any corresponding off-chain reserve being in place backing those tokens.

When creating such a payment channel, the counterparty of such an issuer may optionally fund the counterparty portion of the escrow using tokens issued to the counterparty by said issuer; alternately, said counterparty may fund the counterparty portion of the escrow using tokens purchased by the counterparty from the issuer or some third party.

When creating such a payment channel, an issuer may optionally fund their own portion of said escrow using tokens that have been issued to the issuer themselves.

In an embodiment, tokens held by the counterparty's escrow within such a payment channel may need to be fully-reserved by the issuer, while tokens held by the issuer's escrow within the payment channel would not implicate the issuer holding any additional reserves. This means that, in such an embodiment, only the portion of the escrow held by the issuer's counter-party would potentially carry a capital cost.

One or more possible embodiments of the present invention may comprise a mechanism that functions in such a way that a transfer of tokens from the token issuer to its counterparty via the payment channel would be accompanied by some transfer of liquid assets from the counterparty to the issuer.

In one or more embodiments, an issuer may transfer tokens to a counterparty within a payment channel after receiving notification that a credit card payment, debit card payment, or other electronic payment has been made in its favor-sent from the counterparty or from another third party to the issuer in order to fund a transfer. Such a credit-card payment would create a cash-equivalent receivable asset that would result in a bank deposit some time after the payment is originally made. In at least one such embodiment, if such a receivable is considered to be a cash-equivalent asset, said issuer's cash-equivalent assets and receivables would increase in an amount equal to the number of tokens issued and held by third-parties.

In one or more embodiments, an issuer may transfer tokens to a counterparty within a payment channel after receiving notification of the completion of a bank wire transfer or clearing house payment made in its favor-sent from the counterparty or from another party in order to fund the transfer. Such a transfer or payment may increase the balance of a bank account held by the issuer in an amount equal to the amount transferred over the payment channel.

In one or more embodiments, a token issuer may receive a transfer of third-party blockchain tokens from a counterparty, and then send a payment to the counterparty via the payment channel, while maintaining its reserve coverage requirement. In at least one such embodiment, said third-party blockchain tokens may comprise liquid currency-denominated tokens (meaning currency-denominated tokens that are redeemable at will or which can be sold and purchased at will in liquid market) which tokens are issued by another qualified issuer. In an embodiment such tokens may also satisfy reserve requirements, insofar as they function as a cash-equivalent asset.

In one or more embodiments, an issuer may transfer tokens to a first counterparty within the payment channel upon instructions being received from a second counterparty, which second counterparty shares a separate second payment channel with the issuer. This second counterparty party may transfer tokens to the issuer via this separate second payment channel, with the expectation that the issuer will forward the payment to the ultimate receiver via the first channel. In at least one such embodiment, the issuer will have gained control of currency-denominated tokens via the second payment channel in an amount equivalent to the tokens transferred via the first payment channel, reserve requirements are met.

In I one or more possible embodiments, by such a mechanism, a currency-denominated token issuer may act as a connecting node within a payment-channel network without incurring a high cost of capital:
The issuer may issue, generate or mint tokens that reside in its own treasury account or accounts on-chain. These tokens may not be reserve-backed in that they are not formally issued (meaning, they are not in the possession of third parties). Optionally, other tokens issued by the same issuer may be reserve-backed in the case that such tokens reside in third-party accounts.
The issuer may open one or more payment channels with one or more various counterparties, and may fund its own portion of each payment channel using tokens from its own treasury account. Optionally, because these escrowed tokens remain under the issuer's full control, they would not be reserve-backed. Conversely, tokens contributed by a counterparty, which may reside within the counterparty's portion of the escrow, may be reserve-backed. However, it is not necessarily required that the counterparty contribute any tokens to the escrow initially.
Upon receipt of external funding from a counterparty, the issuer may transfer tokens over the payment channel to the counterparty. Such funding may come from a bank wire or bank transfer, a credit- or debit-card payment, or other source. The proceeds of such funding may optionally be retained by the issuer and may contribute to the reserve backing the tokens transferred to the counterparty.

In an embodiment, a first counterparty may transfer funds to an issuer with instructions to forward the transfer to a second counterparty of the issuer, via a second payment channel; the issuer satisfies the instructions by forwarding the transfer to said second counterparty. Because the funds received by the issuer and funds sent by the issuer are equivalent (setting aside any fees or exchange rate conversion between unlike tokens) there is no net change to the number of tokens generated by the issuer and in the hands of third parties.

In an embodiment, a counterparty may withdraw funds from the system, by transferring tokens to the issuer via the payment channel, and requesting that the issuer give or send the counterparty an equivalent value in currency via some payment medium. The counterparty may receive such value in the form of physical cash, a bank wire or bank transfer, or other means of conveying value.

In an embodiment, either the issuer or a counterparty may close a channel, causing the tokens held in escrow to revert to each party's blockchain account. Alternately, via similar means, either the issuer or a counterparty may reduce the size of their escrow contribution. Neither such operation should affect the size of the issuer's reserve, nor would either operation change the quantity of currency-denominated tokens issued by the issuer and in the hands of third-parties.

### Permissioning Constraints, Device Cryptographic Keys, Identity Determination

One or more possible embodiments of the present invention comprise a blockchain configured to record one or more accounts or addresses within the blockchain's global state, and to associate one or more accounts and/or addresses within said global state with one or more corresponding cryptographic hash digests. Each said hash digest may be generated by performing a hash operation on an underlying data structure, which underlying data structure is a standardized representation of underlying data comprising the various details of the identity of an individual or business. A user of such a blockchain may separately hold onto said underlying data off-chain, and may share elements of the underlying data with third parties that said user may desire to reveal elements of their identity to. Said hash digest effectively stamps the identity of the user on the blockchain without revealing it publicly; the user may optionally reveal the details to select third parties, and prove that the identity details correspond to the hash digest.

In one embodiment, the user may prove that the identity details correspond to the hash digest by performing a hash operation on a standardized representation of all or a portion of the underlying data, and by comparing the hash digest output with the hash digest associated with that user's blockchain account or address.

In one or more embodiments, the underlying data structure may be constructed as a hash tree, such that hash digests are generated for different elements within the data structure individually, or aggregated together into sub-groups, which hash digests are included in the data structure, and are combined with other hash digests similarly derived from other elements of the data structure, in a tree structure, such that the ultimate hash digest of the whole data structure is ultimately derived from the penultimate nodes of the tree, and is effectively a root of the tree. A type of hash tree is a Merkle tree. In at least one embodiment, the underlying data structure is a Merkle tree.

In one or more embodiments, any individual element or aggregated group of elements that correspond to a hash digest within a hash tree can be shared with a third party in the form of a “hash tree proof”, which includes all the hashes leading from the root to the data being shared (hash nodes), along with the sibling hashes of all such hash nodes, and the sibling hashes of the data being shared, without including any data underlying these hashes, other than the data being shared. The hash tree proof may be used to demonstrate that the shared data, when combined with the hash nodes and siblings, is a contributing element of the root hash. Using a hash tree proof, an individual whose identity has been recorded on the blockchain may reveal a select portion of the underlying data, without revealing all of the information, and prove that the revealed portion of the underlying data corresponds to and is contained in the cryptographic hash digest. A type of hash tree proof is a Merkle proof. In at least one embodiment, the hash proof used is a Merkle proof.

In one or more embodiments, the blockchain may be configured to accept a decision indicator, which the decision indicator references some element or data on the blockchain. In an embodiment, the decision indicator may be used as evidence that a particular third party has taken a decision with regards to said element or data on the blockchain.

For example, a blockchain may optionally be configured to accept a decision indicator from a third party identity verifier, where the decision indicator indicates that the third party identity verifier has received the underlying data, and has verified that the cryptographic hash digest corresponding to the underlying data (as formatted in a canonical manner) is equal to the hash digest written to the blockchain, and that the underlying data does accurately reflect the identity of the owner of the blockchain account or address.

In an embodiment, the third party identity verifier knows that the owner of the account or address is the same party that has shared the underlying data with it because the identity verifier will have (a) received a cryptographically signed record or transaction which the verifier would be able to determine was signed by a cryptographic key pair corresponding to the account or address; and (b) because the underlying data would be shared along with various identity documents (potentially including digital identity documents) that are difficult or impossible for an impersonator to obtain. Because the third-party identity verifier has cryptographically signed the decision indicator using a public-private key signing scheme, third parties may reliably assume that the third-party identity verifier has verified the underlying data associated with the cryptographic hash digest, and that the underlying data is a reliable representation of the identity of the owner of the account or address.

In one or more embodiments, the blockchain may be configured to implement a permissioning system, which permissioning system filters out transactions or records that do not satisfy one or more permissioning constraints configured on the blockchain. A transaction or record that does not satisfy one or more potentially required permissioning constraints would be discarded or would be added to the blockchain, but would fail to effectuate the state transaction encoded in that transaction or record.

An alternate name for these permissioning constraints is “authorization filters” or “auth filters”. Under other circumstances, these permissioning constraints might be called “authorization subroutines”, “auth subroutines” or “authroutines”. More generally these permissioning constraints may be referred to as “permission encodings” or as a “permission encoding”.

In various alternate embodiments, these permissioning constraints may be implemented in various ways: as a pattern matching system like regular expressions; as a Turing complete programming language or execution environment; as an expression language that is lacking such programmatic elements as conditionals, loops and recursion; or as an encoding otherwise interpretable by a blockchain system.

In other possible embodiments, permissioning constraints may be configured for certain accounts or addresses, such that any transactions or records associated with those accounts or addresses would need to satisfy the permissioning constraints.

In one or more embodiments, tokens that are issued on the blockchain may be configured with permissioning constraints, such that any transaction or records associated with those tokens would need to satisfy the permissioning constraints. Using permissioning constraints associated with a token, a token issuer optionally may, for instance, restrict the utilization of the token to certain specific circumstances, which circumstances are determined according to the policies of the issuer. The token issuer may construct one or more permissioning constraints which cause one or more records to be discarded or to fail in the event that such a record did not conform to the requirements specified by the issuer.

For instance, in an embodiment a token issuer may require that the owner of an account have had its identity confirmed by the token issuer, which confirmation would be reflected by the account being associated with a cryptographic hash digest conforming to identity data that the issuer acting as an identity verifier had reviewed and confirmed, and by a decision indicator having been added by the issuer, confirming that the issuer had reviewed and confirmed the account owner's identity data.

In at least one embodiment, the token issuer may construct one or more permissioning constraints which cause one or more records to be discarded or to fail if the account or address signing that record is not associated with a cryptographic hash digest together with a decision indicator that had been added by the issuer itself.

In one or more embodiments, a blockchain may be configured such that accounts or addresses on that blockchain are associated with alternate sets of cryptographic keys in addition to the cryptographic key set first used to generate the account or address. These cryptographic keys may be held by different physical devices, giving those devices separate and independent ability to update the account or address by individually signing records that would update the account or address or some other blockchain state when added to the blockchain. An account or address may be associated with one or more device configurations, each of which device configurations is associated with a distinct cryptographic key set.

In one or more embodiments, using permissioning constraints associated with an account or address, a user may, for instance, restrict the utilization of that account or address to certain specific circumstances, which circumstances are determined according to the configuration specified by the user. Permissioning constraints may be constructed by the user which permissioning constraints cause any record to be discarded or to fail in the event that the record did not conform to the configuration specified by the user.

For example, in an embodiment, the user may configure the permissioning constraints to cause certain records or transactions to be valid if signed one set of cryptographic keys associated with an account or address, but invalid if signed by a different set of cryptographic keys associated with that account or address. Or, optionally, a record or transaction may be valid if signed by one device, but invalid if signed by another device.

### Payment Channel Permissioning

Various embodiments of the present invention may relate to payment channel permissioning. Such embodiments may provide means by which to ensure that certain legal compliance objective, risk-mitigation objectives, and other business objectives with regards to payment channel operation are satisfied.

Another known challenge faced by operators of payment channel networks is compliance with legal mandates. Bank-secrecy rules, anti-money-laundering rules, know-your-customer rules, sanctions rules, and other laws and regulations related to value transfer often mandate that individuals sending and receiving value be clearly identifiable and that any participating organization analyze activity on a platform for suspicious activity. In addition, user privacy expectations or legal mandates may dictate that customer activity be kept private and hidden from view.

One possible way to ensure compliance with legal mandates on a payment channel network is to restrict participation to entities that are explicitly authorized to participate. A network may be configured such that only authorized entities are able to operate nodes on the network.

In one or more embodiments of the present invention, a token issuer may restrict the use of its token in the network only to those nodes that the token issuer has explicitly approved. Entities controlling such nodes may act as responsible parties, fulfilling legal or regulatory compliance objectives for the network or for the token issuer. In the event that any such entity does not to fulfill its responsibilities, the token issuer may remove its authorization to operate a payment channel using that token.

In one or more embodiments, a blockchain may be configured so as to associate one or more accounts with a decision indicator that is an approval decision indicator. An approval decision indicator being associated with an account may allow the creator of the approval decision indicator to mark an account as having been approved in some capacity by that creator. In an embodiment, a token issuer may optionally associate a token with permissioning constraints that stop one or more accounts or addresses on the blockchain from opening a payment channel using that token unless said accounts or addresses are associated with an approval decision indicator created by the token issuer or some other party.

In an embodiment, by the mechanism of associating an account with an approval decision indicator in this way, the issuer of a token may implement a restriction on the accounts or addresses that are able to open or operate payment channels of that particular token. The token issuer may in this manner optionally configure the permissioning constraints to allow only approved accounts or addresses (meaning, accounts or addresses associated with an approval decision indicator) to open or otherwise interact with payment channels.

In such an embodiment, only accounts or addresses verified by the token issuer—or in an alternate embodiment, verified by another entity designated by the token issuer for such purpose-would be associated with an approval decision indicator. By this mechanism, only accounts or addresses that are used or managed in a legal and compliant manner may be permitted to interact with payment channels.

Nodes within a payment channel network may be characterized either as edge nodes or interconnection nodes. Edge nodes connect with or are managed by end-users, and interconnection nodes link edge nodes together in the network.

In various possible embodiments of the present invention, compliance requirements may differ between edge nodes and interconnection nodes. Edge nodes may be mandated to preserve and maintain records of payments across the network, including records of senders and ultimate receivers. Edge nodes may be allowed to connect with any user whose identity had been confirmed, but not users whose identity has not been confirmed. Conversely, interconnection nodes may not need to detailed records of all payments, but may be restricted in terms of the entities with which they are permitted to form payment channels.

In one or more potential embodiments of the present invention, the blockchain may be configured to associate an approval decision indicator with an edge node's blockchain account or address, with said approval decision indicator indicating that the account or address in question belongs to an edge node. Such accounts or addresses may be deemed to have been labeled as edge accounts or edge addresses. The blockchain may also be configured to associate an approval decision indicator with an interconnection node's blockchain account or address, with said approval decision indicator indicating that the account or address in question belongs to an interconnection node. Such accounts or addresses may be deemed to have been labeled as interconnection accounts or addresses.

In an embodiment, a token on such a blockchain may be configured with one or more permissioning constraints that permit interconnection accounts or addresses to open payment channels only with other interconnection accounts or addresses or with edge accounts or addresses, which payment channels are opened by each participating account or address signing one or more payment channel records or transactions, and which one or more permissioning constraints prohibit payment channel records or transactions that are signed by any interconnection account but do not also reference as counterparty an interconnection account or address or edge account or address.

In one or more possible embodiments, the blockchain may be configured with accounts or addresses that are consumer accounts or addresses.

Such consumer accounts or addresses may optionally be associated with a cryptographic hash digest together with a decision indicator that had been added by an issuer of a token on the blockchain. The issuer of said token may in some cases add such a decision indicator after it has confirmed that the cryptographic hash preimage of the cryptographic hash digest is an accurate representation of the real-world identity of the person that controls the account or address.

In at least one embodiment, a token may be configured with one or more permissioning constraints that permit edge accounts or addresses to open payment channels only with interconnection accounts or addresses, with other edge accounts or addresses, or with consumer accounts or addresses, which payment channels are opened by each participating account or address signing one or more payment channel records or transactions, and which one or more permissioning constraints prohibit payment channel records or transactions that are signed by an edge account but do not also reference as counterparty an interconnection account or address, an edge account or address, or a consumer account or address.

### Zero-Knowledge Payment Channels

Embodiments of the present invention may relate to zero-knowledge payment channels. A known privacy benefit of payment channel networks like the Bitcoin Lightning network is that payments that traverse the network are not publicly disclosed, unlike transactions or records written to a blockchain. The opening of each payment channel may be written to the blockchain, as well as the final closing of each payment channel. In between the opening and closing of a payment channel, other records or transactions pertaining to the payment channel may or may not be written to the blockchain. Information regarding the individual payments back and forth between users may only pass through the nodes necessary to traverse a route through the network, not to be reflected on the public blockchain.

A payment channel network may also provide further privacy via the implementation of an onion routing protocol, such that each node participating in a payment would only know the specific details necessary to transmit payment to the next hop in the route the payment is following to traverse the network. This privacy is maintained because only the details of the next hop are exposed to any node in the path; the details of subsequent hops are encrypted using the public cryptographic key of the next node, such that only the next node will know the next step in the route, etc.

In spite of the privacy protections present in current known payment-channel implementations, the fact that the transactions or records that effectuate (a) the funding of the channel and (b) the closing of the channel should both be written to the blockchain means that the number of tokens in the channel, the number of tokens individually contributed to the channel by each participant and the net number of tokens transferred over the channel in its lifetime are all publicly disclosed, on the blockchain. This public disclosure can be eliminated through one or more possible embodiments of the present invention, comprising a system and method involving zero-knowledge proofs.

In one or more embodiments, a blockchain may be configured to open, to close and optionally to update payment channels on-chain through zero-knowledge payment channel records or transactions, which are blockchain records or transactions that use non-interactive zero-knowledge proofs to hide the transformation of blockchain global state implicated by on-chain payment channel activity.

In an embodiment, accounts or addresses on such a blockchain may be configured with one or more private ledgers, which one or more private ledgers are represented in the blockchain global state by one or more cryptographic hash digests. Such a cryptographic hash digest is a masked private ledger of said accounts or addresses. Said cryptographic hash digest is generated by hashing a standardized, canonical representation of certain token balances held within said private ledger. This canonical representation—the cryptographic hash preimage of the masked private ledger—is the unmasked private ledger of said accounts or addresses.

In an embodiment, open payment channels may be configured on the blockchain with a channel private ledger, which channel private ledger encodes the token balances of the two participants within the payment channel. Such a channel private ledger may be represented on the blockchain by a cryptographic hash digest, which cryptographic hash digest is associated with the payment channel configured on the blockchain. This cryptographic hash digest (the masked channel private ledger) is a cryptographic hash of a standard or canonical representation of the escrow token balances of the two participants (the unmasked channel private ledger). A payment channel that includes a channel private ledger may be called a “zero-knowledge payment channel”.

In one or more embodiments, each participant in a zero-knowledge payment channel may store the unmasked private ledger of their own account or address off-chain without sharing it publicly or with the counterparty. Both participants each store the unmasked channel private ledger. Such unmasked channel private ledger may be stored in an of a variety of memory storage devices, including a rotating magnetic disk hard drive, a solid-state drive or NAND memory device, a random access memory device, a magnetic tape, or other modifiable storage device. The unmasked channel private ledger stored by the participants may be updated whenever payments are made (value is transferred) across the channel by participants.

In one or more embodiments, various zero-knowledge algorithmic encodings may be implemented, each zero-knowledge algorithmic encoding corresponding to a pre-defined type of global state transformation. Each type of global state transformation may correspond to one or more transformations of the blockchain's global state which transformation is embodied by a zero-knowledge record or transaction. Non-interactive zero-knowledge proofs may be constructed using one or more zero-knowledge algorithmic encodings through a process described elsewhere herein.

In an embodiment, an algorithmic encoding may be encoded that undertakes to move some portion of the token balance or token balances held in the private ledger of one or more of the participants to the private ledger of the payment channel.

In an embodiment, an algorithmic encoding may be encoded that undertakes to move one or more token balances from the private ledger of the payment channel to the private ledger or ledgers of one or more of the participants.

In an embodiment, an algorithmic encoding may be encoded that undertakes to move tokens within the channel private ledger of a payment channel, from one participant to the other.

### Time Locks And Zero-Knowledge Payment Channel Revocation

One essential known concept of payment channels is “time locking”. Payment channels include time locks, such that any record or transaction that closes a payment channel is delayed (i.e. locked) in its execution or is otherwise blocked until the specified time has passed. This mechanism is included in payment channel protocols to ensure that a revoked payment channel record imposes a penalty if the record or transaction is added to the blockchain after it should have been discarded.

In the event that a revoked payment channel record or transaction is added to the blockchain—with the effect that one of the two parties (the cheating party) receives an undeserved excess portion of the tokens held by the payment channel-a revocation key can be used to cause the payment channel to assign all or some portion of the cheating party's payment channel escrow balance (i.e. the token penalty comprising penalty tokens) to the other party (i.e. the non-cheating party). This mechanism creates an incentive for participants in payment channel networks such as the Bitcoin Lightning network to discard revoked records or transactions, to avoid this penalty.

In one or more embodiments of the present invention, a global state transformation embodied by a zero-knowledge payment channel record may be delayed for a certain number of blocks after the record is added to the blockchain, which delay lasts for as many blocks as may be configured on the blockchain. In the event that a revoked zero-knowledge payment channel record is added to the blockchain, the non-cheating party may intervene by adding a channel penalty record to the blockchain, which channel penalty record includes the revocation key and causes the token penalty to be imposed on the cheating party.

In one or more embodiments, zero-knowledge payment channel records that close zero-knowledge payment channels—or, optionally, that modify zero-knowledge payment channels—may include one or more of the following fields, among other fields:
A revocation key evidence, which is a data particle that can used to confirm knowledge of the revocation key. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
A payment channel reference, which is a reference to the zero-knowledge payment channel being closed or modified
Revision data, which includes any revision made to the on-chain masked channel private ledger, and which may, in the case of a channel closing record, include an update to the on-chain masked private ledger of each participant's account or address.
A first zero-knowledge channel proof, which is a non-interactive zero-knowledge proof provided by one of the two parties.
A second zero-knowledge channel proof, which is a non-interactive zero-knowledge proof provided by the other party.

In one or more possible embodiments of the present invention, a zero-knowledge payment channel record that is configured with two zero-knowledge channel proofs allows each of the payment channel participants to hide from the other their respective unmasked private ledger even when the token balances within each private ledger are being modified. Each such zero-knowledge channel proof acts as a separate proof of tokens being moved between the payment channel's private ledger and the respective participant's private ledger, exclusive of any effect on the other party's private ledger.

In one or more alternate embodiments, if only one zero-knowledge channel proof is used, then that combined zero-knowledge channel proof acts as a proof of tokens being moved among the channel's private ledger and the private ledgers of both participants. The party that generates such a combined zero-knowledge channel proof should have access to the unmasked private ledger of both participants, so that such data may be included among the private inputs to the corresponding algorithmic encoding.

In one or more embodiments, a zero-knowledge payment channel record that only moves tokens between private ledger balances within a zero-knowledge payment channel, without effectuating any change to the private ledger balances of either participant's accounts or addresses, may only configure a single zero-knowledge channel proof, not two. This may be the case when the private input to the algorithmic encoding used to generate the zero-knowledge channel proof excludes the unmasked private ledgers of the participants' accounts or addresses. The unmasked channel private ledger, which both participants hold, may be included with the private input to the algorithmic encoding used to generate said single zero-knowledge payment channel proof.

In one or more embodiments, when generating either party's zero-knowledge channel proof, various private inputs may be passed into the relevant circuit. This information may include one or more of the following: (a) that party's unmasked private ledger cryptographic hash; (b) the channel's unmasked private ledger cryptographic hash; (c) the quantity of tokens intended to be moved or transferred from one party to the other by inclusion of the zero-knowledge payment channel record on the blockchain. Public inputs passed to the circuit may include one or more masked private ledger cryptographic hash digests that have been written to the blockchain previously. The circuit output may include revision data, including replacement masked private ledger cryptographic hash digests.

In one or more embodiments, when a payment is negotiated between two participants in a zero-knowledge payment channel, through what can be called a “payment negotiation” process or method, each party provides to the other party certain information intended to stay private, and certain information that may become public. The participants retain other information—private information—that is not exchanged or disclosed at all.

In an embodiment, the party that is initiating the optional creation, modification, or closing of a zero-knowledge channel (the initiating party) may provide information to the other party (the responding party) including a zero-knowledge payment channel record. Such a record may be used by the responding party to update or close the channel if necessary at any point following the payment negotiation. This zero-knowledge payment record may include one or more of the following elements, among others:
A revocation key evidence previously shared by the responding party. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
A zero-knowledge payment channel proof generated by the initiating party, but not the zero-knowledge channel proof generated by the responding party.
The revision data related to the zero-knowledge payment channel's masked private ledger and possibly the revision data related to the initiating party's masked private ledger, but not the revision data related to the responding party's masked private ledger.

In an embodiment, prior to its inclusion on the blockchain, other elements may be added by the responding party, including, for instance, a zero-knowledge channel proof generated by the responding party, and/or revision data related to the responding party's masked private ledger.

However, in order to ensure that the elements included in this zero-knowledge payment channel record by the initiating party are not tampered with, the initiating party may cryptographically sign this zero-knowledge payment channel record before providing it to the responding party. The responding party may itself also sign the record before adding it to the blockchain.

In an embodiment, the initiating party may also provide the responding party such information as may be needed by the responding party to complete the zero-knowledge payment channel record, including such information as may be necessary for the responding party to generate its own zero-knowledge payment channel proof, with the intention of adding said proof to the zero-knowledge payment channel record shared by the initiating party. This may include one or more of the following possible private inputs to the algorithmic encoding which information is intended to remain private between the participants:
The quantity of tokens that are moving within the channel from one participant's balance to the other within the channel's private ledger.
The quantity of tokens moving between the initiating party's private ledger to the payment channel's private ledger.
The unmasked private ledger of the zero-knowledge proof.

In an embodiment, the information provided by the responding party to the initiating party may include a second zero-knowledge payment channel record. Such a record may be used by the initiating party to update or close the channel if necessary at any point following the payment negotiation. This zero-knowledge payment record may include one or more of the following elements, among others:
a revocation key evidence previously shared by the initiating party. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
a zero-knowledge payment channel proof generated by the responding party, but not the zero-knowledge channel proof generated by the initiating party.
the revision data related to the zero-knowledge payment channel's masked private ledger and possibly the revision data related to the responding party's masked private ledger, but not the revision data related to the initiating party's masked private ledger.

In an embodiment, prior to its inclusion on the blockchain, other elements may be added by the initiating party, including, for instance, a zero-knowledge channel proof generated by the initiating party, and/or revision data related to the initiating party's masked private ledger.

However, in order to ensure that the elements included in this zero-knowledge payment channel record by the responding party are not tampered with, the responding party may cryptographically sign this zero-knowledge payment channel record before providing it to the initiating party. The initiating party may itself also sign the record before adding it to the blockchain.

In an embodiment, the responding party may also provide the initiating party such information as may be needed by the initiating party to complete the zero-knowledge payment channel record, including such information as may be necessary for the initiating party to generate its own zero-knowledge payment channel proof, with the intention of adding said proof to the zero-knowledge payment channel record shared by the responding party.

However, in at least one embodiment, the initiating party may already hold at least some portion of the private inputs it would pass to an algorithmic encoding when generating the zero-knowledge payment channel proof, because it would have already passed this information to the responding party. This may include one or more of the following elements:
The quantity of tokens that are moving within the channel from one participant's balance to the other within the channel's private ledger, or
The quantity of tokens moving between the initiating party's private ledger to the payment channel's private ledger.
The unmasked private ledger of the zero-knowledge proof.

In one or more possible embodiments, in addition to the preceding exchange of information, the two parties may also provide to each other revocation keys for any zero-knowledge payment channel records previously exchanged, which revocation keys optionally may also be publicly broadcast or shared across the payment channel network or otherwise. By providing the revocation keys for these preceding records, the parties make themselves unable to cheat by adding revoked records to the blockchain, due to the fact that any cheating party that does add such a revoked record to the blockchain would expose themselves to a penalty.

Furthermore, in one or more embodiments, the parties may share with each other the revocation key evidence that may be used during the next payment negotiation to create each respective zero-knowledge payment channel record. By sharing the revocation key evidence for the next payment negotiation in advance, the parties avoid needing to exchange the revocation key evidence at the time of the next transaction. Conversely, in one or more alternate embodiments, the revocation key evidence for the next payment negotiation is not exchanged at the end of each preceding payment negotiation, and exchanging revocation key evidence constitutes a necessary first step of each payment negotiation.

### Revocation Mechanism Execution

In one or more possible embodiments of the present invention, when a zero-knowledge payment channel record is added to the blockchain, some or all of the modifications to the global state implicated by that record may be delayed if the record is configured with a time lock.

In one or more embodiments, a delayed execution ledger may be associated on-chain with a zero-knowledge payment channel. During the period of a time lock, some elements of the zero-knowledge payment channel record may be written to a delayed execution ledger associated on-chain with the zero-knowledge payment channel in question. Such elements written to said delayed execution ledger are those relevant elements sufficient to effectuate the modifications to the global state which are embodied by the zero-knowledge payment channel record.

In an embodiment, the delayed execution ledger, in addition to storing the relevant elements of the zero-knowledge payment channel record, may record an effective block height, after which block height any interaction with the payment channel may cause the zero-knowledge payment channel record to update the global state. Such an update to the global state may include updates to the private ledgers of each participant, reflected on-chain by a replacement of the masked private ledger of each participant's account or address.

In an embodiment, if a cheating party adds a revoked zero-knowledge payment channel record to the blockchain, another zero-knowledge payment channel record containing the revocation key may be added to the blockchain by the non-cheating party, or by another party. This record, a zero-knowledge payment channel penalty record, may include one or more of the following elements, possibly among others:
The revocation key, which in combination with the revocation key evidence stored in the delayed execution ledger may be used to prove that the zero-knowledge payment channel record had indeed been revoked.
Revision data, including an updated masked private ledger of the non-cheating party, which updated masked private ledger reflects the transfer of the token penalty to the non-cheating party.
A zero-knowledge channel penalty proof, which proves that the updated masked private ledger is a cryptographic hash digest derived from the new unmasked private ledger updated after receiving the token penalty from the payment channel.

In an embodiment, a zero-knowledge payment channel penalty record may be generated by a non-cheating party using private data held by the non-cheating party, as well as public data. Such a record may be used to cause the penalty tokens to be transferred to the non-cheating party any time after the revoked zero-knowledge payment channel record is added to the blockchain, provided it is before the end of the time-lock period.

In an embodiment, so as to effectuate such a transfer, a zero-knowledge payment channel penalty record may be broadcast to the blockchain network by a non-cheating party, which record, upon being incorporated in a new block, may effectuate a transformation to the blockchain's global state, which transformation comprises the transfer of penalty tokens to the non-cheating party.

The preceding described embodiments comprising one or more zero-knowledge systems or methods of opening, modifying and closing zero-knowledge payment channels allows the users of payment channel networks to enjoy the known benefits payment channel networks-fast payments, quick settlement, reduced counter-party risk—with the added benefits of maintaining privacy at the channel-opening and channel-closing stages, and of keeping their own token ledger balances private between themselves.

### Persistent Server Permissioning (Safe Off-Line Payment Channel Availability)

A further challenge faced by participants using known payment channel networks such as the Bitcoin Lightning network is that participating nodes should be online and connected to the network in order to send and receive payments. Given these limitations, if a node goes offline, then payments can neither be sent or received to or from that node.

This presents a problem if one of the participants-particularly the recipient—is using a personal device to connect to the network. For instance, if the recipient of a transaction is using a smartphone to connect to the network, if the smartphone is turned off, or is unable to connect to the internet, the transaction cannot be completed and the recipient will not receive payment. It is frequently the case, however, that recipients want to receive payment when their device is offline. Note that this is less of an issue for senders, because users in general expect to need to connect to the Internet to initiate or send an electronic payment. However, recipients typically expect to be able to receive payments when they are offline, and do not desire to connect to the network every time someone wants to send them a payment.

Per known practice, users of the Bitcoin Lightning network work around this limitation by using persistent servers to handle connections to the network. These persistent servers hold the cryptographic key or keys necessary to sign payment channel records, transactions, updates, etc., on behalf of the users of these servers. When a payment is sent to such a user, the persistent server negotiates the updates that should be made to the payment channel in order to receive the payment, which requires the use by the server of the user's cryptographic keys.

When such a user wishes to send a payment, the user sends a request to the persistent server instructing the server to initiate the payment. The persistent server updates the payment channel so as to transmit the payment, which transmission should include the negotiation of a payment channel update, which should include the use by the server of the user's cryptographic keys.

This arrangement allows users to receive payments when their personal device is offline, but at the cost of giving the cryptographic keys that control their entire payment channel to the persistent server. If such persistent server is compromised, then the entire payment channel can be drained of tokens by an attacker. Most such persistent servers are managed by third parties, who maintain payment channels on behalf of multiple users. Any such third party will need to be trusted by the users of the server that it manages, and may exploit that trust by stealing funds from those users.

One or more possible embodiments of the present invention provide a solution to this problem, comprising the use of separate cryptographic keys for the sending and receiving of payments across the payment channel network.

In such an embodiment, the payment channel records exchanged in the negotiation of a payment received are signed by cryptographic keys the use of which may be restricted to negotiating the receipt of a payment, and not the sending of a payment. Furthermore, the use of such keys may optionally also be restricted such that they cannot be used for other activities on the blockchain.

A persistent server that is limited to using keys that have one or more such restrictions will not have any ability to send funds out of a user's account or wallet, but it will be able to negotiate the receipt of funds to that user's account, which would not be possible without these restricted keys. Even if the security of such a server is compromised, it will not provide an attacker an opportunity to exfiltrate tokens from users of the server, nor will a third-party manager of such a server have any ability to steal any users' tokens.

Conversely, in one or more embodiments, initiating and sending a payment across a payment channel network may involve updating a payment channel using a separate, more privileged set of cryptographic keys, which keys may be held by the user themselves on their preferred device. In a possible embodiment, such a device may be a smartphone or other device capable of connecting to a computer network, which device may connect to the payment channel network-cither to the persistent server, or to another node on the network-when the user is initiating payment. Upon connecting, the device may use the cryptographic keys to negotiate the sending of a payment across the payment channel, and may optionally disconnect after the payment has been sent.

In an embodiment, the negotiation of an update to a payment channel may involve the exchange of records between the two participants of the payment channel. Each side signs a record updating the payment channel escrow balances such that they reflect the transfer of value from one account or address to the other.

In one or more possible embodiments, as a means of restricting the ability of a persistent server to only negotiate the receiving of payments to an account or address over the payment channel, and not the sending of payments from the account or address, the user of an account or address may:
Generate a new alternate pair of cryptographic keys and provide those keys to the persistent server; and
Associate that account or address with permissioning constraints restricting the use of that new pair of cryptographic keys such that they may only be used to sign payment channel records or transactions that update payment channels in such a manner that the user's payment channel balance increases compared to the previous channel state.

In such an embodiment, any payment negotiated using keys held by the persistent server should be in the direction of the user of said account.

In one or more embodiments of the present invention, because the previous channel balance on-chain is synced infrequently-often only at the point that the channel is opened—the direction of a particular payment within the channel may not be determinable from on-chain information. In an embodiment, one or more permissioning constraints determine whether one or more cryptographic keys are permitted to authorize a payment channel record or transaction depending on whether the new channel state is greater or less than the previous channel state. In such an embodiment, because a permissioning constraint in general may only make a determination using on-chain data and data encoded in the record or transaction being evaluated, a previous channel state should somehow be encoded in the payment channel record or transaction being evaluated.

In an embodiment, a previous off-chain channel state may be validated when validating and evaluating a payment channel transaction or record, which validation in part comprises an evaluation of the history of payments within the channel-back and forth between the parties from the last time the payment channel state was synced with the blockchain until the moment the new payment channel record or transaction is generated-which history is encoded in the payment channel record or transaction.

In an embodiment, a history of payments may be included in the payment channel record or transaction in the form of a list or array of integers, which list may represent a sequence of escrow balance states, or a sequence of payments. The directionality of the payment can be determined by comparing the new state against the preceding state as validated against this list of integers.

In an embodiment, a history of payments included in the payment channel record or transaction may include one or more cryptographic signatures of the parties. In an embodiment, said cryptographic signatures may be used to establish that the payments within the history of payments were authorized by valid and appropriate public keys of the parties.

In an embodiment, a history of payments included among the private inputs to an algorithmic encoding may include one or more cryptographic signatures of the parties.

In an embodiment, a history of payments may be included among the private inputs to an algorithmic encoding that is used to generate a non-interactive zero-knowledge proof, which non-interactive zero-knowledge proof is included with the payment channel record.

In an embodiment, in addition to a history of payments, the private inputs to an algorithmic encoding may include one or more cryptographic signatures of the parties, which cryptographic signatures may correspond to each payment included in the history of payments. In an embodiment, a non-interactive zero-knowledge proof may be used to demonstrate that the payments within the history of payments each correspond to cryptographic signatures created by valid and appropriate public keys of the parties.

In an embodiment, the directionality of the last payment may be incorporated as a public input or output to the non-interactive zero-knowledge proof, and may be used by one or more permissioning constraints applied to said record or transaction. In an alternate embodiment, whether the device signing said record or transaction is permitted to do so may be determined within logic encoded in an algorithmic encoding such that a non-interactive zero-knowledge proof only produces a valid result if the permitted device is used.

In one or more embodiments, the use of the cryptographic keys held by the persistent server may be restricted, such that said keys are only able to sign records or transactions that update payment channels that increase the user's payment channel balance. The persistent server is thereby only able to receive payment channel payments, and is unable to send payment channel payments, or to perform any other blockchain activity on behalf of that user and their account or address on-chain.

Another risk presented by the use of persistent servers by users of existing known payment channel networks is that that any entity that negotiates the processing of any payment across a channel-whether that payment be sent or received by such an entity-will have at least temporary access to revoked payment channel records, and may have a long list of said records. A malicious persistent server may collude with a malicious counterparty to purposefully write a revoked payment channel record or transaction to the blockchain, with the intention of the malicious counterparty subsequently using the revocation key to claim the penalty, which would be paid from the user's portion of the payment channel tokens.

In an embodiment of the present invention, a purposeful writing of a revoked payment channel record to the blockchain by a persistent server may be prevented by requiring that payment channel escrow transactions are signed by participants in a certain order. In such an embodiment, any payment channel escrow transaction that is first signed by a counterparty should be signed by the more privileged set of keys of the counterparty's account. A persistent server's keys may not be sufficient to sign such a payment channel record or transaction that is subject to revocation by a counterparty. In such an embodiment, a payment channel record may only be valid if signed by the keys held and controlled by the user themselves, and not the persistent server.

In an embodiment, these requirements may be implemented through the use of permissioning constraints that enforce such restrictions on payment channel records or transactions.

### Consensus Scaling Solutions

According to various embodiments of the present invention, a novel blockchain scaling system and method is implemented, which overcomes limitations of existing scaling solutions, improving the data management, performance and decentralization of high-throughput blockchain networks.

Known high-throughput blockchain systems face significant challenges related to data management, which may impact their scalability, performance, and decentralization. A rapid growth in transaction volume may lead to substantial increases in data storage utilization, making it difficult for new nodes to join and synchronize with the network. Verifying large volumes of data may also place a significant burden on consensus mechanisms, exacerbating state management issues as the size of the global state data increases. As the size of global state data grows, maintaining data availability and accessibility becomes increasingly complex, and hardware utilization increases, often necessitating centralized or permissioned solutions that compromise decentralization.

Existing solutions, such as sharding, offer partial remedies but come with certain limitations. Known sharding methods attempt to improve scalability by partitioning a blockchain network into smaller segments called shards, with the intention of processing transactions and smart contracts in parallel. Such known sharding techniques impose significant complexity in terms of cross-shard communication and transaction coordination; ensuring consistency and security across shards is challenging, and cross-shard transactions may require intricate protocols to prevent double-spending and to maintain atomicity. Additionally, such known sharding techniques can weaken security by distributing the network's validation power across multiple shards, making smaller shards more vulnerable to attacks like collusion or takeover by malicious actors.

Uniquely, one or more embodiments of the present invention divide the global state of a blockchain system into various shards, rather than dividing the blockchain network into shards. In such embodiments, block-building nodes and validator nodes comprising the blockchain system remain connected in a unified network, and cross-shard transactions are integrated as standard transactions within the protocol, avoiding complexity overhead. In addition, in contrast to known sharding methods, in at least one embodiment, the data of each shard is mutually exclusive of data of all other shards, reducing or eliminating the possibility of double-spending within the operation of the blockchain system.

In one or more embodiments, said scaling system or method may be implemented in combination with a fitness-gradient consensus methodology, a consensus mechanism designed to optimize the selection and validation of new blocks by evaluating their “fitness” based on predefined metrics. Fitness gradient consensus resolves forking conflicts by calculating the most-optimal fitness value among competing blocks, incentivizing rapid block propagation and improving both the speed and security of the network. Variants such as hash distance consensus and trust-but-verify data propagation further enhance scalability and efficiency, making it suitable for high-throughput blockchain applications.

### Fitness-Gradient Consensus

According to one or more embodiments of the present invention, a Fitness Gradient Consensus methodology is applied by determining the most-optimal fitness value among competing new blocks or blockchain segments in order decide upon which new blocks or blockchain segments will be built upon by future blocks. In certain embodiments, the selection as to which new blocks are built upon determines how block-building fees and/or rewards are allocated on-chain, which fees and/or rewards may comprise an allocation of tokens to the account of the winning block-building node.

Fitness gradient consensus, as implemented in various embodiments of the present invention, is a consensus methodology that calculates a deterministic fitness value for each block, based on the local features of that block, potentially in combination with certain mid-term-stable features of the blockchain state. In such a methodology, every fork of the blockchain has a determinable fitness value that is an aggregate of the fitness values of all blocks within that fork. In certain embodiments, a block carries its own fitness value, as well as the fitness value of a chain of which it is the head. This form of consensus allows many candidate forks to be evaluated concurrently, and may remove a limitation of Nakamoto proof-of-work consensus that only a certain limited number of forks will be evaluated at any given time by the network.

Under fitness-gradient consensus, according to certain embodiments, block headers are propagated to direct peers soon after they are validly constructed. Direct peers compare the fitness values of the block headers received, and then share the most-optimal fitness blocks or block headers onward to other peers. The network converges on a small subset of the most-optimal fitness blocks after block headers have been propagated across the network and prioritized. According to at least one embodiment, each block-building node and validator choses a small subset of blocks to validate, and it downloads the transactions for those blocks and performs validations in parallel in separate threads.

In various embodiments, the highest-fitness-value block may be most optimal; such that if a first output of a fitness algorithm calculation is higher than a second output, the first output is deemed to be a more-optimal fitness value. In alternate embodiments optimality may be determined according to some other scale. In certain embodiments, the lower output values of a fitness algorithm may be deemed more optimal than higher output values. In any case, in various embodiments, when the individual fitness of a first pair of blocks is each deemed more optimal than the individual fitness of each block of a second pair of blocks, the combined fitness of the first pair will be higher than the combined fitness of the second pair, and when the individual fitness of a first collection of blocks is each deemed more optimal than the individual fitness of each block of second collection of blocks, for instance in the case of a blockchain segment or block ring, the combined or aggregate fitness of the first collection will be higher than the combined or aggregate fitness of the second collection.

In various embodiments, potentially any formula outputting a scalar value may be used to determine a block's fitness value. One possible formula, according to several embodiments, is to calculate the block's “hash distance.” A “hash distance” nay be defined as the numerical distance between the block hash and a pre-determined target hash for that block. Depending on the embodiment, the distribution of “hash distance” values may be evenly distributed over the entire network. According to several embodiments, “hash distance” is determinable for every block without performing proof-of-work. Although extra work can be performed in order for a block-building node to reduce the “hash distance” of a given block (by incrementing some nonce included within the block to search for a block with a shorter hash distance), the instant that a block is produced may be is valid and may potentially be built upon by one or more blocks of the next round of block building. In various alternative embodiments, other formulas may also be used in order to determine fitness of blocks within a network.

### Fitness Variations

The fitness gradient consensus methodology is flexible enough to allow various means, methods and algorithms to be used in calculating a fitness value, according to various embodiments. If a raw block hash output is not suitable, in certain embodiments, the bits of the block hash may be flipped (0×1111 . . . 11111 ×or BLOCKHASH), and/or the value may be passed into a fitness function to obtain a fitness calculation. In various embodiments, a fitness value may be a discrete integer, so at the most optimal fitness level, depending on the size of the hash output, there may be ties.

According to at least one embodiment, a minimum threshold fitness value may need to be calculated, and the fitness determination may include generating a block hash for a new block, iterating over sequential “nonce” values, trying to get it as close to a target as possible. If the fitness calculation is too small, the nonce may be incremented, and the block may be re-hashed, and fitness re-calculated, iterating until a fitness threshold is reached. Alternate embodiments, however, may implement means to avoid, discourage or prevents such a re-hashing.

In various embodiments, the fitness of a block is equal to the aggregate value of the fitness calculation of all or a certain number of preceding blocks, plus the fitness value for that specific block. A recency bias may be incorporated, such that past fitness values may be discounted before being added to the fitness value of the current block. The recency bias may need to be balanced so that an old, formerly-discarded chain fork does not displace an otherwise more-optimal-fitness fork, but also so that an un-merged fork is incentivized to merge sooner than later, and trigger a reorganization, so that it doesn't lose out on its gain if it discovers a highly optimal-fitness block. A risk of an un-balanced recency bias may be the following: a low-fitness chain fork is built on by a low-compute network partition for a an extended period; after a period of low compute power, the partition increases its compute to a majority of the overall network's resources; if the low-fitness history of that fork is overly discounted, the sudden surge of compute power may allow the fork to merge and displace the primary fork of the primary partition.

In at least one alternate embodiment, a hash-distance function may somehow randomize the target hash for each block, such that each block has a radically different target; and in calculating a block's fitness, the distance of N previous blocks' hashes to that target may be averaged with along with the distance of the current block's hash to that target. By calculating a blockchain segment's fitness in this manner, the difficulty of maintaining a secret double-spend chain may be increased, and its likelihood decreased, in certain alternate variations.

Among certain alternate embodiments, an “aggregate token value” fitness function may be used instead of a hash-distance approach. An “aggregate token value” approach may act to eliminate the advantage of excess or enhanced computational power among block-building nodes, by providing a metric that is independent from pure algorithmic performance. In certain variant embodiments, aggregate token value may act as a tie-breaker used after hash-distance fitness is calculated-used only when deciding between otherwise equivalent blocks with regards to the next block to build upon; alternately, it may be incorporated into the fitness function itself, such that the aggregate token value may be reflected in the fitness of every block in a blockchain segment.

In certain embodiments, “aggregate token value” may comprise a measurement of the aggregate tokens locked or staked for a given block-either tokens in a locked state for the duration of the block, or tokens being locked or staked as part of the block's state transformation. In other embodiments, “aggregate token value” may comprise a measurement of the aggregate value of all tokens used or transferred within the execution of a block, which calculation may depend on the use of a relative pricing mechanism so as to aggregate the value of different types of tokens into a single value number.

Certain embodiments may implement consensus staking records, which records, when included in a new block, may cause a specified quantity of a sending account's tokens to be staked or locked. In at least one embodiment, staked or locked tokens may used to determine “aggregate token value” as described above; in other embodiments, staked or locked tokens may serve a different purpose. Accounts that stake or lock tokens using consensus staking records may share in block rewards or fees of certain blocks, as an incentive and reward. Such staking records may comprise one or more of the following, without limitation: (1) the block hash of the preceding block, (2) the block number of the preceding block, (3) an expiration block number that is no more than a certain number of blocks ahead of the preceding block, (4) the tokens staked, (5) the staking period (which may be short-term or long-term, or some variation thereof), (6) fee tokens bid for inclusion, and (7) the originating account.

### Bucket Consensus Variation (Hash-Distance Consensus)

In one or more embodiments, a “bucket consensus” variation of hash-distance consensus may be implemented, which variation employs a technique of using token staking in order to determine a target hash for a block, which target hash may be used to determine a fitness value of the block. According to at least one embodiment, consensus staking records may be deemed to contribute tokens to buckets according to a certain formula, and the bucket(s) that are deemed to contain the most tokens may be used to determine the target hash for a block.

In certain embodiments, the bucket that a consensus staking record belongs to may be determined by combining a preceding block hash with the hash of the originating account, which may involve operations such as bitwise XOR or concatenation followed by re-hashing. The resulting hash combination is then used to assign the staking record and staked tokens to a specific bucket, which bucket may be determined by performing a modulo operation on the hash combination, or by applying some other function to the same. According to an embodiment, the set of buckets participating in this process may be distributed evenly across the domain of possible hash values, ensuring a random assignment of staking records to buckets.

In one or more embodiments, a bucket consensus process may be implemented to incorporate one or more elements of the following procedure, without limitation:
a) The target hash for a given block N may be defined as the midpoint of the bucket with the highest aggregate value of staking records at a prior block N-G, where G is a predefined offset, enforced by the protocol, and N is the current block height.
b) The fitness of a block N may be calculated as the difference between the block hash of block N and the target hash at N-G, divided by the tokens staked within block N, and then added to the fitness of block N-1.
c) For each block, only a certain number of staking records may be included, these being the highest-bidding, unexpired, and yet-to-be-included records. This ensures prioritization of the most valuable staking records while adhering to network constraints.
d) Rewards for block building are distributed between the block-building node of the current block N and the accounts the staking records of which contributed to the target hash in block N-G. Rewards may be allocated proportionally based on the size of the stake associated with each account at block N-G, ensuring equitable distribution among contributors.
e) To maintain a consistent block creation time (Tb), block-building nodes initiate the block-building process at time TO by verifying the preceding block and iteratively attempting nonce variations to construct a new block. At a defined time Tn, the block-building node broadcasts the version of the block with the most optimal fitness (for example, the block with the lowest hash distance to the target hash). Block-building nodes may continue nonce iteration until Tb, at which point the block with the most optimal fitness—either from the block-building node's own efforts or received from the network—is finalized and used as the basis for the next block.
f) If a version of block N-1 having a more optimal fitness is discovered during this process, the block-building node may opt to build on the newly discovered block, discarding prior work on alternate chains if necessary. Any staking records from discarded blocks may be returned to the record pool for inclusion in future blocks.

### Verifiable Delay Functions

In various embodiments, a verifiable delay function (VDF) may be incorporated into the consensus process. A VDF is a cryptographic function designed to produce an output that requires a predetermined amount of sequential computation to generate, but which output can be verified for correctness efficiently and non-sequentially. Examples may include, for example, such VDF algorithms as Wesolowski's VDF, Pietrzak's VDF, and Class Group VDF.

Because the operations to be performed to produce a valid VDF output are non-parallelizable, a VDF can be used to force a certain amount of time to pass within a larger algorithm. Adding CPUs or CPU cores to an effort to compute a VDF does not speed up performance; a faster result is only possible if a CPU with a faster clock speed is employed. The validity of a verifiable delay function's output can be assessed with trivial computation, however, such that it is possible to assess almost instantaneously whether a computational delay of a certain length of time has in fact occurred.

One or more embodiments of the present invention may use VDF algorithms to ensure that block-building nodes are allowing sufficient time to pass between blocks, and/or to prevent a surge of computational power from accelerating block production. In such embodiments, a block or block header is only valid if it contains a VDF output corresponding to a minimum execution time specified by the blockchain protocol. Such a VDF requirement implemented in various embodiments may thereby force block-building nodes to ensure that a new block has not started building before a minimum amount of time has passed since a previous block started building.

In certain embodiments, the output value of a VDF can function as a tiebreaker in the event that the fitness value of two blocks is the same. In other embodiments, a VDF output may be incorporated into the fitness value calculation, for instance by including it in the block data that is hashed and then evaluated as part of a hash-distance calculation. In certain embodiments, this second approach ensures that block-building-nodes cannot try to re-calculate a fitness value by making small iterative changes to the block contents.

Various embodiments may include a VDF output in the pre-images of block hashes used to calculate fitness. Because said block hashes cannot be calculated without including VDF outputs, it should not be possible to know what the fitness value may be of a particular block with particular content until the VDF has completed its calculation. In order to obtain its VDF, each separate version of a block may utilize a separate parallel CPU core. Following such an approach, the utility of mining rigs is reduced, and the likelihood of a 51%-style double-spend attack is reduced.

Certain embodiments may incorporate VDF calculations in their implementations as follows: at the onset of building a new block, a first VDF calculation begins, with the block hash(es) of one or more previous blocks being passed in as input; simultaneously, the records and/or transactions constituting the block are selected and executed, applying the various state transformations of the new block; following the completion of both processes, the output of the VDF calculation is combined with a hash output of the block building process, said hash output comprising, for example, without limitation, the new state Merkle root, receipt Merkle root, transaction Merkle root, or some combination or transformation thereof; this combined value then forms the input of a second VDF calculation, which calculation runs until some point near to the end of the block interval. In at least one embodiment, this output is sufficient as an input to a fitness function; or it may alternatively be combined with other values of the block to generate the fitness value.

Various embodiments may configure VDF execution times so that VDFs of a new block execute for some ratio of the total time taken to process and/or execute the records and/or transactions that constitute that new block. Depending on the embodiment, a total-block-time to record/transaction-execution-time ratio of 2-to-1, 3-to-1, or 4-to-1 may be used, or some other appropriate ratio. An objective of one or more embodiments may be to configure a VDF function to execute for a long-enough duration that even a large block-building node or a large cluster of block-building nodes cannot work to build valid blocks faster than the rest of the network, due to the limitations of the VDF. A large block-building node network might be able to calculate the most-optimal next block, but it cannot run ahead. That being said, in various embodiments, some variability should be assumed among the computational units used to perform the VDF calculation, such that the same complexity target may result in a variety of calculation times; in any event, the complexity of the combined VDF of a block should be less than the maximum complexity the slowest participating computational unit is able to compute within the protocol's time interval between blocks.

Certain embodiments may implement one or more of the following (without limitation) when calibrating the complexity value that a block-building nodes use when invoking verifiable delay functions:
a) A block's gas limit may be proportional to one or more complexity values of one or more VDFs executed while building the block, such that higher complexity values determine a higher gas limit. “Gas” herein refers to approximate units of computation, and “gas limit” refers to a limit on the computation to be performed evaluating and/or executing records and/or transactions included in the block. A higher gas limit may result in more transactions or more complex transactions being included in a block, and may result in more transaction fees collected.
b) When starting to build a block, a block-building node may select one or more complexity values of one or more VDFs to be executed while building the block, provided that said complexity values exceed a minimum threshold. In some embodiments, said threshold may be defined as a weighted average of complexity values of recent blocks.
c) The complexity values of a VDF computation may be included with the VDF result, and may be used in verifying the result; blocks or block headers specifying complexity values which are below a certain threshold may be deemed invalid.
d) The initial complexity values used by a block-building node will be specified in an initial, user-modifiable node configuration, but the block-building node may gradually adjust the complexity value upward, until the total time of execution for each new block is some small margin less than (slightly less than, not exactly equal to) the block duration time, in an attempt to maximize the gas limit of the block, and the transaction fees to be earned by the block-building node.
e) In the event that the total time of execution for new blocks goes too high, the complexity value may be reduced.

### Trust-But-Verify

In one or more embodiments, new blocks may be built before all block records and/or transactions have been validated, and before the global state has been updated by processing this data. New blocks may be built on top of yet-unprocessed blocks, which new blocks may include only transactions that operate on accounts other than the accounts that were operated upon by recent prior blocks.

According to a trust-but-verify data propagation methodology, as implemented in one or more embodiments, new block headers may be shared across the network without said blocks' records and/or transactions fully propagating across the network. By using trust-but-verify consensus methodology, the new blocks may be built while records and/or transactions of previous blocks are still propagating over the network. In such an embodiment, a block-building node may share its most-optimal fitness block with its peer block-building nodes; one of said peers may respond either that the block shared is the most-optimal-fitness it has recorded, or it may respond with the details of the most-optimal-fitness block it has recorded.

According to various embodiments, blocks processed in series may need to operate on mutually-exclusive sets of accounts. One or more such embodiments may use a Bloom filter method to ensure that blocks processed in series satisfy this requirement. In an embodiment, a block may specify the accounts that it operates upon through the use of a Bloom filter, which Bloom filter may record all the account addresses operated upon in the block. As new transactions are read from the mempool's priority queue, the accounts they operate upon are searched for in one or more Bloom filters of recently preceding blocks. If those accounts are found in the one or more Bloom filters, then the transaction is placed in a retry queue of the blockchain network's mempool, rather than being included in the new block. In an embodiment, before a new block is built, the Bloom filters of preceding blocks that have not yet been processed are united into a single Bloom filter, and only that Bloom filter is searched.

The specific number of recently preceding blocks operating on mutually-exclusive sets of accounts with regards to a new block may differ among embodiments. In one or more embodiments, for example, every other block may build on overlapping subsets of the global state, such that proximate blocks operate on mutually-exclusive subsets. In certain other embodiments the time interval between blocks may be shorter (so that it takes the time duration of two blocks for a full set of transactions to propagate), and every third block may build on overlapping subsets of the global state, so that within a group of three sequential blocks the subsets of data being operated upon are mutually exclusive with each other.

In variant embodiments, if a block's transactions have been downloaded before a certain timeout, and the block has been verified, then the next block may expand beyond the limitation of the trust-but-verify Bloom filter in terms of which transactions may be added.

### Sharding

According to various embodiments, a computer-implemented blockchain sharding system is implemented, comprising a global state of a blockchain system and two or more block-building nodes of a blockchain network. In certain embodiments said global state may comprise at minimum four shards, and in other embodiments, said global state may comprise at minimum two shards, in either case each shard comprising a portion of the global state which is mutually-exclusive with the portion of the global state of all other shards.

The block-building nodes of the system, in various embodiments, each store and operate on at minimum two shards, although alternate embodiments may only require block-building nodes to store and operate on at minimum a single shard. The scalability benefits of various embodiments of the sharding system begin when at least one block-building node excludes from its storage (and from its operation) at least two shards; certain alternate embodiments, however, may experience scalability benefits when at least one block building node excludes from its storage and operation at minimum one shard.

Various embodiments implement a consensus procedure performed in sequential rounds, each new block built belonging to a specific round, operating on, at minimum, two shards of the global state, and each round comprising one or more new blocks operating on non-overlapping, mutually-exclusive shards of the global state. Each such new block may also comprise a block hash of one or more preceding blocks of the preceding round, such block hash referencing a preceding block operating on at least one of the same shards as the new block also operates on. Alternate embodiments may require that each block-building node operate only on one shard at minimum, rather than two.

In various embodiments, the shards of the global state exclude blocks, records and/or transactions. Shards, in such embodiments, comprise elements of the present global state, excluding a comprehensive record if its history. Archived and/or retained blocks, records, and/or transaction data may represent a history of state transformations previous applied to the global state; shards, by contrast, may comprise state elements to which state transformations encoded in blocks, records, and/or transaction are applied. In one or more embodiments, a block may comprise records and/or transactions which touch on, reference, operate on, read, or modify data of one or more shards which the block in question is said to comprise, or to operate on.

According to one or more embodiments, one or more shards may comprise one or more groups of data elements. Different embodiments may employ various other algorithms to distribute data among different groups, although embodiments employing algorithms that distribute data evenly may experience advantages in, for example, performance, data availability, and decentralization. In one or more embodiments, addresses or accounts may be placed in mutually-exclusive groups, with each group assignment being made according to a modulo operation of the address or account address (for example, address modulo number of groups). Each group may be encoded as a single shard data structure, with each shard data structure comprising a separate data structure (for example, without limitation, a Merkle tree or Merkle trie) having a separate root and root hash digest, which root hash digest incorporates and/or is derived from, directly or indirectly, all data contributing to the data structure. In one or more embodiments, one or more block-building nodes store, manage, and/or operate on the data of two or more shards, in which case other shards may be left to be managed by other block-building nodes.

In one or more embodiments, a block-building node processes and/or executes only records and/or transactions that touch on, reference, operate on, read, or modify the data of the shards and/or shard data structures that it stores, manages and/or operates on, and it discards or ignores other records and/or transactions. In such embodiments, when building new blocks, each such node only builds blocks that include transactions that read from or write to accounts or addresses within the shards that it manages. When verifying new blocks (and updating state) a node may have to assume the correctness and sufficiency of record and/or transaction state transformations affecting the shards and shard data structures it does not manage.

In various embodiments, each block-building node or validator node may retain records of the blocks that touch on, reference, operate on, read, or modify the data of the shards and/or shard data structures that it stores and/or manages, along with all the records and/or transactions of those blocks. In various embodiments, each block may touch on at least two shards; therefore, a block-building node or validator node may keep record of blocks that touch on, reference, operate on, read, or modify data other than and in addition to its own data. In the event that such a node performs a rebuild of its own shard data (as, for example, in a reorganization), the node will assume the correctness and sufficiency of record and/or transaction state transformations affecting the shards and shard data structures it does not manage. In some embodiments, transaction and/or record data older than a certain threshold may be discarded or purged, however.

In various embodiments of the present invention, in order to allow only a portion of a multi-shard record or transaction to be validated and executed, a receipt data structure may incorporate the output data and/or general state transformation details of smart contracts that are invoked, and/or the accounts or addresses that are touched on, referenced, operated on, read, or modified as the record or transaction is processed. Such a receipt data structure (i.e. “receipt”) may include details of the outcome of the record or transaction's state transformation sufficient for a block-building node or validator node to validate and apply the portion of said state transformation that corresponds to the node's own one or more shards, without the node needing to store or manage all shards affected by said state transformation.

A receipt is a data structure generated by a block-building node upon the execution of a record or transaction, derived from the state changes resulting from the execution of the record or transaction, and recording the outcome of the transaction, including status, logs produced, and any gas or computational resources consumed. In various embodiments, such receipts may be propagated through the network together with records and/or transactions, or separate from them, following a processing of the receipt's associated records and/or transaction; alternately, they may be propagated as part of the data of the block which comprises them. Receipt data may be consulted in various embodiments by a block-building node or a validator node as it processes or validates a record or transaction associated with said receipt. In various embodiments, when receipt information is invalid, incorrect or otherwise wrong, a block-building node or validator node may discover the error during record and/or transaction validation or processing, after which said error may be reported to the other nodes of the blockchain network. In the event that a record, transaction or block is implicated by such an error, one or more nodes of the blockchain network may designate such a record, transaction and/or block as invalid, and may discarded it. In some embodiments, this may force a reorganization in the event that said one or more nodes had already accepted and incorporated said repudiated record, transaction, and/or block.

According to various embodiments of the present invention, a consensus process may be implemented comprising various sequential rounds or iterations. During each round or iteration block-building nodes may build blocks, which blocks may be designated as belonging to said round or iteration, and may encode the round number or iteration number as a block height or block number.

### Block Rings

In one or more embodiments, each round may comprise the instantiation of a “block ring” comprising blocks generated by block-building nodes in that round, which blocks have been accepted by the network as constituting the accepted blocks of that round, and with reference to which the blocks of the subsequent round will be built. Each block of a block ring is deemed to operate on particular shards, which shards correspond to the shards operated on by the records and/or transactions of the block. In one or more embodiments, each block of a block ring may operate on mutually-exclusive shards. In certain embodiments, a block ring may incorporate blocks that operate on all the shards, without any missing shards, even if the block comprising a shard comprises no records or transactions operating on that shard; in other embodiments, however, block rings may be missing certain shards.

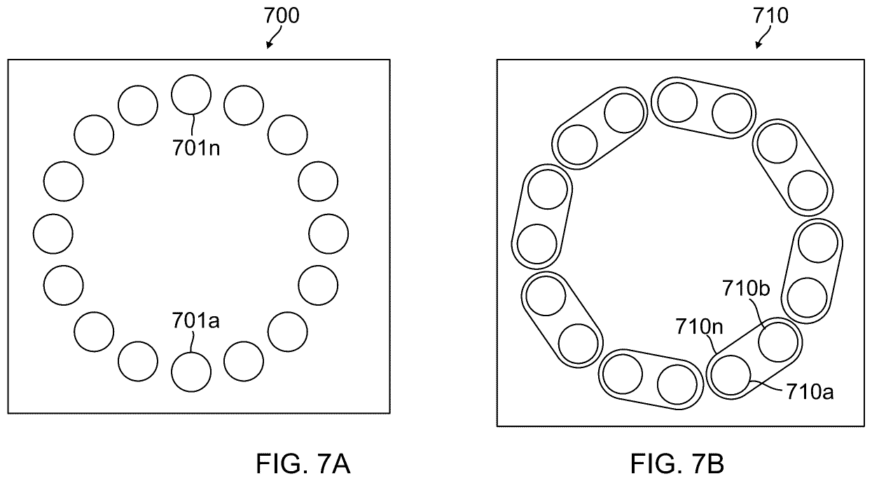

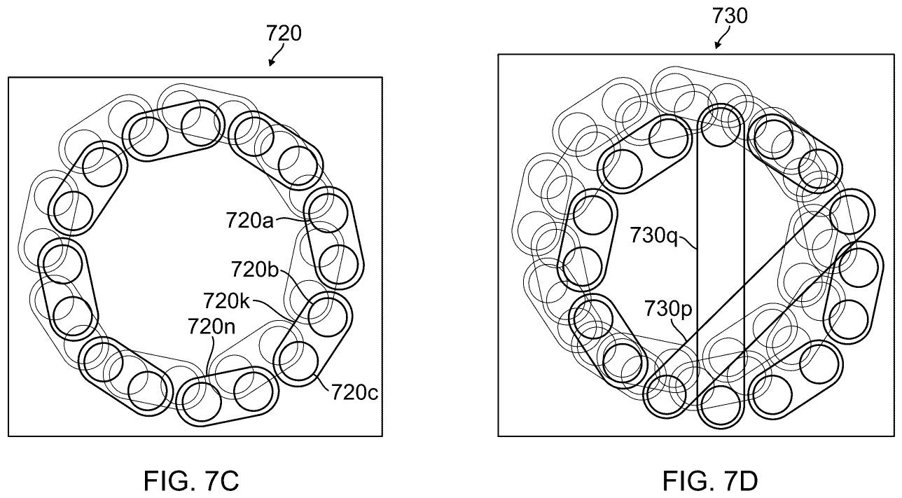

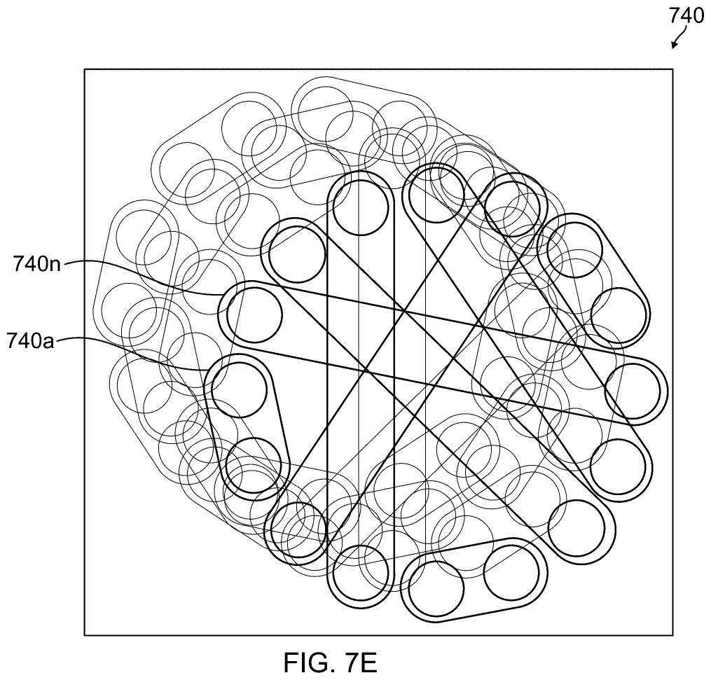

FIGS. 7A-7E show diagrams 700-740, respectively, illustrating the nature and evolution of “block ring” instances over the course of multiple sequential rounds, in an example embodiment. Said figures reflect a blockchain sharding system comprising 16 shards, although in practice any number of shards may be employed. Optimal embodiments may implement a number of shards which are a power of 2, possibly ranging, for instance, between 4 and 64 shards. FIG. 7A shows a schematic illustration 700 of said 16 shards (700a-700n), without including an illustration of any blocks. FIG. 7B shows a schematic illustration 710 of a block ring including eight blocks (for example, 710n), each block comprising two shards (including 700a-700b); note that in this illustration of an example embodiment, each shard is incorporated into one block.

According to various embodiments of the present invention, the sharding system's blockchain network should comprise at least one block-building node to manage each combination of two or more shards. In alternate embodiments, some combinations of shards may not correspond to any block-building nodes of the blockchain network, in which case records or transactions touching on, referencing, operating on, reading, or modifying one of said combinations of shards may be processed and/or executed by block-building nodes comprising supersets of said one combination. In one or more embodiments, each block-building node builds and propagates blocks incorporating state transformations pertaining to the shards that it comprises.

In various embodiments of the present invention, a different set of nodes may participate during each consensus round, resulting in the instantiation of a new block ring comprising blocks with different combinations of nodes. Each different node may operate on a different combination of shard data. In one or more embodiments, however, this behavior is an emergent characteristic resulting on each block-building node working to generate the most-optimal fitness block it can that touches on, references, operates on, reads, or modifies the data of its own shards; the particular blocks selected to constitute a block ring in such circumstances may be a combination of mutually-exclusive blocks built and propagated during that round having the best or most optimal aggregate or combined fitness value among various such combinations of the round.

In various embodiments, different nodes may operate on different combinations of shards and/or shard data structures. During each iteration, according to embodiments implementing a fitness gradient consensus, nodes may attempt to generate the most-optimal-fitness block that operates on its own shards. Between each round, or as an integral part of each round, one or more nodes may attempt to form the most-optimal-fitness block ring by evaluating combinations of the most-optimal-fitness blocks that operate on mutually-exclusive data; different rings may be proposed, but the block ring with the most optimal aggregate fitness will be built upon in the next round.

FIG. 7C shows diagram 720 illustrating, in an embodiment, the round subsequent to the round illustrated in diagram 710 of FIG. 7B, each block of the block ring comprising a different combination of shards than the combinations shown in FIG. 7B. Note that shard 720b, corresponding to shard 711b in FIG. 7B, now shares block 720k with shard 720c, rather than sharing a block with 720a, as was the case when shard 710b shared block 710n with shard 710a in the previous round illustrated in FIG. 7B. Note however, that block 720k will comprise back references to both block 710a and block 710n of FIG. 7B. In at least one embodiment, each block comprises back references to the blocks of the preceding round which blocks comprised one or more of the same shards. In this manner, for each shard, an unbroken chain of back references exists leading from the most recent round to the earliest one or more rounds of the blockchain, which unbroken chain may form a part of a larger directed-acyclic-graph or lattice structure forming the blockchain of at least one embodiment of the present invention. In certain embodiments, a new block's back references will only include references to blocks of the preceding block ring which blocks comprise one or more of the same shards and/or shard data structures; in other alternate embodiments, however, additional back references to other blocks in the preceding block ring may also be included with a block.

FIG. 7D shows diagram 730 illustrating, in an example embodiment, a consensus round subsequent to the round illustrated in FIG. 7C, with one or more blocks of the new block ring comprising new and different combinations of shards compared to blocks of the preceding round. Note, however, that, in FIG. 7D, block 730p shares the same combination of shards as block 710n of FIG. 7B, and that block 730q shares the same combination of shards as block 720n of FIG. 7C. According to one or more embodiments, it is not necessary that all of the blocks of a given block ring comprise different combinations of shards as every block of the preceding block ring; rather, among such embodiments, it is simply necessary that an optimal or near-optimal combination of mutually-exclusive blocks be selected. Nonetheless, some other, alternative embodiments may impose a non-repetition requirement.

FIG. 7E illustrates, in an example embodiment, a consensus round subsequent to the round illustrated in FIG. 7D. Note again that one or more blocks of the new block ring comprise new and different combinations of shards. Although these illustrations show blocks comprising two shards, in various embodiments blocks that include 3 or more shards may also be acceptable.

According to certain embodiments, a methodology of identifying which shards and/or shard data structures a particular record, transaction, or block touches on, references, operates on, reads, or modifies may be implemented with the use of a bitmap. As per this methodology, a bitmap comprising a byte, byte array, integer, or integer array may be encoded, which bitmap contains at least as many bits as there are shards of the global state. The particular combination of shards of a record, transaction or block may be encoded by such a bitmap; each distinct shard may corresponds to one of the bits of the bitmap, so that if a shard is touched on, referenced by, operated on, read, or modified by said record, transaction or block, that particular bit is set to one; otherwise, the bit is set to zero. For example, in at least one embodiment, a block that comprises the first, fifth, eighth and eleventh shards may also comprise a bitmap with the first, fifth, eighth and eleventh bits set to one, and the remaining bits set to zero.

In certain embodiments, each shard may be represented by a single bit within a bitmap with a size equal to the number of shards constituting the global state. A node may declare which shards it is managing by including a bitmap of those shards with the blocks that it creates.

In certain embodiments, the particular shards that a record or transaction touches on, references, operates on, reads, or modifies may be determined by performing an operation on the addresses or accounts that the record or transaction touches on, references, operates on, reads, or modifies. Specifically, each account may be determined to belong to a shard having a shard index number equal to the address modulo the number of shards, or equal to the account address modulo the number of shards, which the address or account address is itself a number. In one or more embodiments, a record or transaction touches on, references, operates on, reads, or modifies whatever shards that contain the account or address data of the accounts or addresses that the record or transaction touches on, references, operates on, reads, or modifies.

In some embodiments, a block may have a shard bitmap equal to all of the shard bitmaps of the records or transactions of that block, combined together by the iterative application of bit-wise OR operations. In the formation of a block ring, in some embodiments, a block ring may be deemed to be valid if none of the block bitmaps share any bits; an efficient algorithm may make a determination by setting an accumulator bitmap to all zeros, then iterating over all the bitmaps of the blocks, for each bitmap performing a bitwise AND with the accumulator before combining the bitmap with the accumulator with a bitwise OR, and determining that the block ring is invalid if any bitwise AND outputs any non-zero number.

In various embodiments of the present invention, as block-building round follows block-building round, block ring formation follows block building, and block building follows block ring formation, ad infinitum, until such time as the blockchain may stop operating.

The formation of a block ring—which comprises a process of selecting blocks for inclusion in a block ring-—may, in certain embodiments, be performed by one or more specialized nodes. In other embodiments, one or more non-specialized block-building nodes may perform the task of selecting blocks for inclusion in a block ring. In some embodiments, a block ring formation may be performed by either a specialized node or by a non-specialized block-building node, potentially involving one or the other from one round to the next. According at least one embodiment, each block-building node may make a local determination as to what role will play within the network, including one or more of, without limitation: whether participate in the process of forming and proposing block rings; whether to participate in the process of building and propagating blocks; and/or which shards to store, manage and operate on. In certain variations and embodiments, block rings may be formed by specialized nodes that do not themselves validate the blocks which constitute the rings being formed.

In one or more embodiments, the maximum-fitness block ring propagated across the network may be selected to be built upon by subsequent blocks; any combination of blocks may be selected, provided that the individual blocks and the block ring itself are valid. Block rings comprising blocks that do not fit together—meaning, blocks having overlapping shards-—are invalid. Among embodiments that utilize shard bitmaps, account bitmaps are guaranteed to be mutually exclusive for blocks that operate on different shards; the blocks of a block ring may be deemed to be mutually exclusive if their account bitmaps are mutually exclusive.

In some embodiments, the block ring formation process may result in the generation of a data structure comprising references to all blocks in the block ring, which data structure is incorporated in the blockchain as a ring formation block. New blocks of the subsequent round may be created with reference to the preceding rounds' ring formation block. In certain alternate embodiments, a block ring may instead be an implicit feature of the sharding system, embodied by the blocks built upon and validated by nodes of the network, computed in volatile memory during the block selection and validation process, identifiable in retrospect by observing the blocks that constitute the blockchain as it extends back to its origin, but without an explicit declaration as such in the blockchain.

In certain embodiments, block ring formation may happen through a trust-but-verify process. A verifiable delay function may be executed during each round to ensure that there is a minimum time separation between rounds. The VDF of a new round may be running while the previous one or two blocks' transactions are transmitted and downloaded, and while the previous one or two blocks are validated. Subsequent to block formation and propagation, fraud proofs shared among nodes may impeach or repudiate rings that are invalid, or may impeach or repudiate individual fraudulent or invalid blocks. In certain embodiments, a block-building node may assign reputation values to one or more other block-building nodes based on those nodes' past performance of producing valid or invalid block rings.

In one or more embodiments, the number of shards of the global state may be effectively variable, determinable based on the number of nodes participating in the consensus effort. In one such embodiment, a maximum number of shards may be set (for instance, 64, 128, or 256 shards, etc.), but the division of the global state data into separate shards may be limited according to actual usage. For instance, in certain embodiments, the block ring formation process may incorporate an evaluation whereby the number of shards referenced by blocks within the ring is proportional to the number of records and/or transactions-or, alternately, the aggregate gas usage of such records and/or transactions—that have been incorporated into blocks produced in recent consensus rounds. In such an embodiment, only if a certain gas threshold or quantity threshold has been exceeded, will a larger number of independent shards be permitted.

### 64-Bit Evolution

In one or more embodiments, an optimization approach may be implemented, such that 64 shards are configured as a maximum quantity of shards, and quantity of 8 “super-shards” forming groupings of the 64 shards may be defined. Each such super-shard groups the shards together by a numerical proximity, which may be encoded using a shard bitmap. By way of example and illustration, shards 0001 0000 0000 0000 0000 . . . , 0010 0000 0000 0000 0000 . . . , 0100 0000 0000 0000 0000, and 1000 0000 0000 0000 0000 . . . , may belong to shard group 1111 1111 0000 0000 0000 . . . , etc.

In one or more embodiments, when the aggregate amount of data of the network is below a certain limit, or, in an alternate embodiment, when the maximum size of any single shard is below a certain limit, then block-building nodes should claim shards that fully intersect with these pre-determine shard groups. During this period, according to such an embodiment, a block-building node's claimed shards (i.e. a new block's claimed shards) should overlap with the permitted shard definitions.

In various embodiments, additional thresholds may exist, such that at a higher level of system load, or a higher quantity of aggregate data present in a network or within a certain shard, smaller super-shard groups may be activated—for instance, groups of 4 shards, rather than 8 shards-such that a block-building node's claimed shards may overlap with these combinations of shards.

In various embodiments, nodes may maintain and operate on copies of at least two shards. Some nodes may maintain and operate on copies of up to 32 shards. Each node thus has a bitmap/filter that corresponds to the shards that it maintains. In one or more embodiments, pairings may be implemented of the shard bitmap modulo 4 shards; pairings may be implemented of the shard bitmap modulo 8 shards; pairings may be implemented of the shard bitmap modulo 16 shards; pairings may be implemented of the shard bitmap modulo 32 shards; pairings may be implemented of the shard bitmap modulo 64 shards

In certain embodiments, either a wallet node or the block-building node may determine the accounts or address that a record or transaction reads, modifies, or operates on. This may be translated into a bitmap representing the shards that the transaction reads, modifies, or operates on. The accounts and address that a transaction corresponds may be determined statically, in two groups-read-from accounts and address, and write-to accounts and addresses.

In one or more embodiments, shard that an account belongs to may be determined by taking the modulo 64 output of the address, and then determining the corresponding bit in a 64-bit word. This bit may then be compared to the filter of a shard using bit-wise operators in order to determine if the bit belongs to that shard. By way of example, either of the following may indicate in an example implementation that an address or account belongs to a shard (where ACCOUNT_BIT is a bitmap with only the bit corresponding to the account being set to one):
a) ACCOUNT_BIT|SHARD_FILTER==SHARD_FILTER
b) ACCOUNT_BIT & SHARD_FILTER!=0

### Shared Global Data

In certain embodiments, the sharding approach herein described may require special treatment of certain shared global data that may be commonly referenced or used across a broad set of accounts, addresses, records, transactions, or blocks (universal data).

For example, in at least one embodiment, one or more blockchain tokens may be commonly referenced or used throughout the system, such that it would be difficult or impossible to build multiple concurrent blocks that do not all reference or operate on said tokens and their configurations, potentially at the same time.

In one or more embodiments, certain smart contracts may present a similar challenge, in that they may involve state transformations to multiple shards through the same execution invocation event. Certain smart contracts in such an embodiment may comprise shared global data.

According to various embodiments, at least one separate universal shard may be implemented, separate and apart from and in addition to the other shards of the global state described herein (“standard shards”). In order to avoid conflicts with state transformations operating on standard shards, any records and/or transactions that modify data present in such a universal shard may be executed as a separate step apart from the general block-building process, and may constitute a “universal block” separate and apart from the blocks produced during the general block-building process described elsewhere herein (“standard blocks”). In this way, in such embodiments, read-only references to shared global state (such as, for example, read-only references to token configurations) may be included in any and all blocks without conflict, relying on the fact that concurrent updates will not occur until block execution terminates.

In certain embodiments, however, state transformations made to shared global state may be delayed a certain number of blocks, and records and/or transactions effectuating changes to shared global state (such as, for example, token configuration changes) may include a delayed execution parameter or an “effective block number” field, which controls the block height at which the configuration change goes into effect. In at least one embodiment, a “no earlier than” field may also be added to records and/or transactions, which field may specify a block height before which the record cannot be included in any block. This “no earlier than” field may facilitate having the record or transaction fully distributed across the network before any attempt is made to add a record to a block; this would help to ensure that all block-building nodes would tie on the first fitness criteria.

In some embodiments, if a state transformation applied to a universal shard element is combined with a transformation applied to a standard shard, for example in one atomic transaction or composite transaction that combines other records and/or transactions, or through the execution of a smart contract, then the universal shard may be included in a standard block. In certain such embodiments, each block-building node and/or validator node may store and maintain said universal shard, in addition to whatever other standard shards each block maintains and operates on. Furthermore, each block-building node may validate these universal shards, and may also participate in building universal blocks, in addition to standard blocks.

In one or more embodiments, records and/or transactions configured to effectuate state transformations to a universal shard element may be automatically prioritized for inclusion in the blockchain, and do not require a gas payment. In one or more embodiments, the fitness value or fitness determinant of a universal block may be the number of token configuration records or other universal data updates included in the block; the universal block selected in may be the block having the most such updates included.

In at least one embodiment, the records and/or transactions that update one or more universal shards may all need to be shared by every node, each of which would update one or more universal shards shared by all nodes. According to an embodiment, only the universal block would make updates to these one or more universal shards, but all nodes would perform reads against these shards. According to an alternate embodiment, certain records or transactions that implicate the universal shard and other shards may be included in one or more other blocks.

In various embodiments, token configurations may be encoded in token configuration data structures, which token configurations may be associated with the universal shard, and which token configuration data structures may be incorporated into a universal shard data structure. In certain embodiments, a token configuration data structure may be addressed within the universal shard data structure with a reference comprising a token pseudo account address, and the token configuration data structure may comprise a token pseudo account.

In one or more embodiments, a similar challenge may be presented by order book and token trading data. In a non-sharded system, such data may act as a singular system-wide source of pricing and order prioritization, with said pricing and prioritization state being updated as orders are matched during the course of the block being built and records and/or transactions being executed. In various embodiments of the sharding system described herein, updates may be localized to blocks comprising shards that only account for a portion of the global state; as a result, a trade that is available to be executed by one block will not, by definition, be available in another block to be executed, and pricing and prioritization information will not be updated during the course of a block's execution.

A solution provided by certain embodiments of the present invention may be to impellent a separate, parallel pricing and prioritization state in each shard, so that order matching and pricing may be executed within each shard, without a shared global state. By such a mechanism, each block-building node may have a separate price for a given pair of tokens or assets-or no price at all. However, a deterministic order-matching algorithm may be applied which causes purchase orders to be matched to the best-priced sale orders among the sale orders of the various shards of a block. Market-driven arbitrage activities of various users driven by profit motive may standardize prices among shards, and individual users wishing to avoid local pricing irregularities present in certain shards may specify a minimum or maximum price as part of a limit order, so that their order is only matched in a block that is able to satisfy their price.

### Implementation Approaches

### Various Features

In one more embodiments, a block reward may be allocated for each shard, so an incentive exists to mine extra shards if a block-building node has the capability to do so. However, according to certain embodiments, a two-shard block-building node may run faster, possibly giving it an advantage in improving its blocks' fitness value.

In various embodiments, when a new a block-building node first joins the blockchain network, it may choose the one shard that belongs to its own account; when selecting additional shards, it may choose one or more shards randomly, or it may decide on such shards deliberately—for instance by selecting an account that it may want to optimize a connection to. In certain embodiments, a new block-building node may download the data pertaining to each of its shards-and only its shards. Accounts may be divided among the shards, each account belonging to only one shard. Records and/or transactions may belong to one or more shards, depending on what accounts are involved with that transaction.

In one or more embodiments, a block-building node may build any block that contains only transactions that pertain to accounts within its shards. Blocks may declare which combination of shards it reads, modifies, otherwise operates on, which may be encoded in block headers. In certain embodiments a block may also contain one or more Bloom filters, encoded in a block header, representing the accounts that it has interacted with or operated on. In an embodiment, if a record or transaction reads, references, modifies or operates on any accounts that are not included in one of the block-building node's shards, then that transaction may not be included in any block created that block-building node—it will instead need to be incorporated into a block by another block-building node that includes in its various shards all of the accounts read, referenced, modified, or operated on by said record or transaction.

In certain embodiments, a record that invokes a smart contract may declare the accounts or addresses that the smart contract may read, reference, modify or otherwise operate on, and list said accounts or addresses in a smart contract execution record, in order to statically validate that the smart contract is compatible with the block-building node's shards, without first needing to execute the smart contract. Alternately, in an alternate embodiment, the block-building node may statically validate the smart contract invocation only with regards to the sender account and receiver smart contract accounts, execute the smart contract, and if the smart contract touches on any other account that is not found in one of the block-building node's shards, treat the contract invocation as invalid, and add the smart contract invocation record to the blockchain in a failed state. In at least one such embodiment, however, to save space, account annotations should only accompany a smart contract invocation that might read, reference, modify or otherwise operate on an account other than the sender account and the smart contract itself.

### One Implementation

According to various embodiments, the following example implementation of a sharding consensus procedure may be provided.

In certain embodiments, at a certain time offset within a round, each block-building node may share its most-optimal-fitness blocks to all peers. Block-building nodes may also forward block header information it has received or generated of blocks that are the most-optimal-fitness blocks for each shard. In an embodiment, said time offset may be determined through the use of a verifiable delay function, which forces the block-building nodes to wait a specific and verifiable amount of time before broadcasting any blocks (the blocks would have to contain the verifiable delay proof).

In one or more embodiments, block-building nodes may then shift to trying to find the block ring with the most optimal aggregate fitness for that generation. Finding the absolute optimum-fitness block ring combination may be beyond the computational capabilities of an embodiment, so heuristic approaches that may or may not be stochastic in nature may be taken. Therefore, an optimization result may be non-deterministic—there may be no single best result that can be known within the timeframe of the round. In an embodiment, a block-building node may share its most-optimal-fitness solution to a block-ring combination problem after a certain time has passed.

In several embodiments, a block ring that is formed may have one or more of the following qualities:
a) Every shard of the global state to be included, with at least one block covering each shard.
b) Any two blocks that cover the same shard not to have account bloom filters that intersect (each block to deal with mutually exclusive accounts)
c) All blocks to be specified or declared when identifying the block ring of that particular round.
d) The block ring to have a hash digest, comprising a cryptographic hash of a deterministically generated data structure comprising block hashes of included block.

In at least one embodiment, optimal-fitness block ring combinations may be shared when they are found. In an embodiment, more than one combination may be shared, because of the possibility that one or more of the block rings formed may be fraudulent. If the multiple block rings that are shared or proposed are mutually exclusive, such that no two blocks are shared between the competing block rings proposed, according to an embodiment, these block rings may be combined into a single block ring.

According to various embodiments, various optimization algorithms may be employed to find the most-optimal-fitness combination of already-created blocks to form a ring optimal for a round. After the block-ring fitness values and formation details are shared across the network, the network should converge on a single most-optimal-fitness ring, or on a small set of highly-optimal-fitness rings.

According to certain embodiments, block-building nodes are incentivized to share their most-optimal-fitness combinations. Few block-building nodes may be in a position to validate every shard, and therefore various nodes rely on other validator nodes and block-building nodes in the network to validate other shards. In an embodiment, the more block-building nodes that receive the shared blocks, the more likely that each block will be validated by at least one trustworthy party. According to at least one embodiment, at least one trustworthy party validates each shard of each block built.

In an embodiment, the next generation of blocks will be built in reference to the optimal block ring of the previous generation.

According one or more embodiments, each block-building node may run multiple threads:
a) A building thread for each shard and/or ring.
b) A validation thread for each shard and/or ring.

In certain embodiments, each validating thread may execute the records or transactions of the block ring block(s) corresponding to its designated shard, but it only validates the state transitions pertaining to the accounts within its designated shard; it may assume that the state transitions pertaining to the other shard(s) within the block(s) are valid.

In various embodiments, threads of a block-building node may build new blocks in parallel; additional threads may validate the shards of unverified blocks of various chains that have been selected for validation. Validation may proceed from the oldest block within each fork until the most recent block. The number of competing forks that will be simultaneously validated and built upon may be a function of how many total threads (i.e., cores) the block-building node has available. With each old block that is evaluated, a block-building node may only validate the portion of that block that corresponds to the shards that it maintains. If at any point within the validation process an invalid step is detected, then a fork including all subsequent blocks may be deemed invalid.

### Fraud Proofs And Reputation

In one or more embodiments, block-building nodes and validator nodes may only validate state transformations that affect their own shards, when evaluating records and/or transactions of new blocks built by other nodes. Block-building nodes and validator nodes, in such embodiments, should operate as if state transformations applied to other shards are valid, because said nodes do not store the state data needed to validate these state transformations. Furthermore, in embodiments that employ trust-but-verify methodologies, block-building nodes may assemble and build new blocks before the validity of preceding blocks has been verified. As a result, it may be possible to for a malicious actor propagate erroneous records and/or transactions across a blockchain network of one or more embodiments, and/or build fraudulent or invalid blocks, possibly propagating such data to nodes that are, by design, unable to fully verity such data, or which, depending on the embodiment, may be delayed in performing such a verification.

The terms “fraud” and “fraudulent”, as used in herein with regards to transactions, records, messages, blocks, block headers, block rings and other data, as implemented in one or more embodiments of the present invention, refer to such data that has been formulated or encoded by a blockchain node or other computer device in such a manner as to be invalid or unverifiable, and having potential to disrupt, interrupt, misdirect or otherwise undermine the ideal operation of the blockchain system, with the possible effect of slowing network operation, overloading blockchain nodes or other computer devices, corrupting global state data, presenting misleading information, inducing double spending, or otherwise reducing the integrity, effectiveness and reliability of the system.

Although many instances of fraud described herein may ultimately be discovered without the various mitigation techniques, time and resources may be wasted when block-building nodes are induced to build new blocks on top of fraudulent blocks that are not yet known to be fraudulent. In various embodiments, a block that is discovered to have been built on a fraudulent block should be discarded, wasting the resources that were used to build that block.

Various solutions are provided by one or more embodiments of the present invention, and are described herein. Certain embodiments implement “fraud proofs” which penalize block-building nodes that act maliciously, and thereby disincentivize the incidence of fraud. Another solution provided by one or more embodiments is a reputation-tracking mechanism, which may be used in combination with fraud proofs, or without them, to reduce or eliminate the possibility that a block-building node will tricked into building upon a fraudulent block. Various other solutions pertaining to a number of embodiments are also described herein.

### Fraud Proofs

Fraud proofs are data structures that provide cryptographic evidence of fraudulent data being included in one or more blocks. Such fraud proofs, in one or more embodiments, may comprise one or more Merkle proofs, which Merkle proofs are known cryptographic proof data structures comprising a sequence of hash values that, when combined with the hash of a revealed data element, enables the reconstruction and verification of a Merkle root within a Merkle data structure (such as a Merkle tree or a Merkle trie). A Merkle proof enables the verification of a revealed data element's inclusion within a Merkle-data-structure-encoded dataset by reconstructing the Merkle root without requiring access to the entire dataset except for the revealed data element.

A fraud proof in one or more embodiments of the present invention incorporates one or more block header data elements, along with one or more Merkle proofs, which in combination may provide a step-by-step linkage between one or more blocks and a demonstrable contradiction or violation of protocol rules encoded in the data. A blockchain node or other computer device in possession of a fraud proof is enabled to identify one or more blocks as definitively fraudulent-a result of the demonstrable contradiction or violation of protocol rules encoded in the block-without said node or device needing to have access to various other data which constitute the block.

The precise nature of a fraud proof may depend on the nature of the fraudulent block or transaction being impeached or repudiated by the fraud proof. For example, in one embodiment, if the fraud is a structural invalidity localized in a single transaction, then only a single Merkle proof revealing that structurally invalid transaction will be included in the fraud proof, along with the block header which comprises the Merkle root of the Merkle proof. More complex incidences of fraud, however, may require more than one block header, and/or more than one Merkle proof. If, for example, the structural invalidity is localized in the receipt, or if the receipt does not match the record or transaction, then Merkle proofs of both the transaction and receipt are included, along with a block header containing Merkle roots of both.

According to various embodiments of the present invention, fraud proof records may be implemented as blockchain records and/or transactions comprising one or more fraud proofs. In various embodiments, fraud proof records contain fraud proof data structures that share a portion of the block header, system state, transaction, and/or receipt data that is necessary to prove that a referenced block is fraudulent. In one or more embodiments, a fraud proof record may effectuate a transfer of tokens from an account of a malicious actor that has cryptographically signed and propagated to the blockchain network a fraudulent block, to an account that is specified within the fraud proof record.

According to certain embodiments, a block-building node may place a number of tokens “at risk” with a block that it builds, which tokens are held by an account the private key of which it uses to cryptographically sign the block or its block header. In certain embodiments embodiment, such “tokens-at-risk” may function as a “guarantee” ensuring that the block is not fraudulent; if the block is proved to be fraudulent, then the tokens-at-risk may be lost. In at least one embodiment, a proof record may seize all or a portion of the tokens-at-risk of a block, transferring all or a portion to the sender of the fraud proof, and in the process impeach, repudiate or invalidate a block for the whole network. In one or more embodiments, a block header may only be valid if the number of tokens placed at risk is greater than the number of tokens held by the block-building node account that has signed the block header.

In certain embodiments, a fraud proof record may be intercepted before being included in a block, and may be font-run by a block-building node that discovers the fraud-proof record before it has been included in the blockchain-meaning, the block-building node strips the fraud proof from the fraud proof record, and then submits the fraud proof record with its cryptographic signature, seizing the “tokens-at-risk” for the block-building node's own benefit. Therefore, it is in the interest of a block-building node only to generate and incorporate a fraud-proof record into the block that it itself decides to build. From a network perspective, however, a fraud proof record that is front-run has the same positive impact on network stability and security as an original fraud proof record.

### Types Of Fraud

### Malformed-Data Fraud

In various embodiments, a malformed-data fraud may occur, in which a record, transaction, receipt and/or other data constituting a block may not be properly structured or encoded according to the rules of the blockchain protocol. In certain embodiments, an instance of a malformed-data fraud may occur when an element within a hash-based data structure of a block (such as a Merkle tree or Merkle trie) hashes to the same hash digest that contributed to the formation of the hash-based data structure, such that the hash-based data structure itself is valid when formed inclusive of the data element in question, but where the data element itself is malformed, invalid, incorrectly encoded, or otherwise contradicts the protocol rules. An instance of malformed-data fraud may be considered an instance of block-construction fraud.

In one or more embodiments, a malformed-data fraud proof may comprise a block header and one or more cryptographic proofs (for example, one or more Merkle proofs), which cryptographic proofs provide evidence that one or more records, transactions, receipts and/or other data of a block is structurally malformed. Within each cryptographic proof, the structurally malformed data is included among the revealed data. No global state or shard data needs to be included in a malformed-data fraud proof, because by definition the invalidity is structural and unrelated to global state.

In one or more embodiments, if the structural invalidity is of a record or transaction, then only a single record- or transaction-specific cryptographic proof need be included in the fraud proof. However, if the structural invalidity is of a receipt, then a single receipt-specific cryptographic proof may need to be included; and if the structure or type of a receipt is not correct for a record or transaction associated with the receipt, then both a transaction-specific cryptographic proof and a record- or transaction-specific cryptographic proof may be included in the fraud proof. In certain embodiments, the record- or transaction-specific cryptographic proof may be implemented as Merkle proof, and/or the receipt cryptographic proof may be implemented as a Merkle proof.

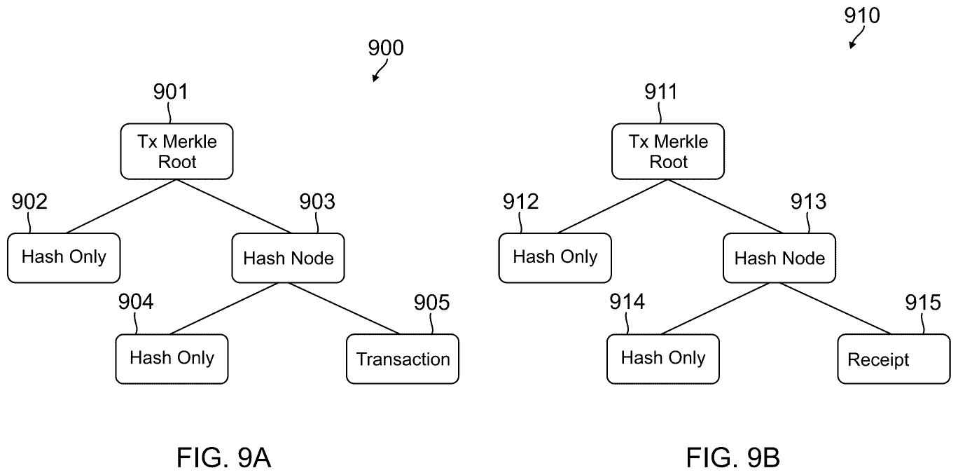

FIG. 9A illustrates a transaction-specific cryptographic proof, and FIG. 9B illustrates a receipt-specific cryptographic proof, each implemented as a binary Merkle proof in this example embodiment. A malformed transaction is shown as revealed data at 905, and a malformed receipt is shown as revealed data at 915. Merkle roots (901, 911) comprise root hash derived from the constituent leaf and branch node hash digests, according to a standard binary Merkle proof algorithm.

A blockchain node or other computation device evaluating and/or confirming a malformed-data fraud proof may implement one or more of the following steps, without limitation:
a) Compare one or more root hashes of the cryptographic proofs to one or more hash digests of the block header, to confirm that the cryptographic proofs do correspond to hash-based data structures of the block. For example, a root hash of a receipt-specific cryptographic proof may equal the hash digest of the block's receipt data structure.
b) Evaluate the revealed data in order to establish that it is, indeed, malformed.
c) In an embodiment, the block header may be cryptographically signed by the block-building node that created or built the block, in which event the block-building node or validator node may also verify the signature of the block.

### State-Disjunction Fraud

According to one or more embodiments, a receipt corresponding to a record or transaction may contain one or more hash digests of one or more global state data structures as they exist prior to execution of a record or transaction, and one or more hash digests of new versions of said one or more global state data structures as they exist after execution of the record or transaction. Normally, a new global state after executing a record or transaction is equivalent to a prior global state of the next transaction, before it executes. A state-disjunction may be deemed to occur when a hash digest of a new global state (“post-execution hash”) of a record or transaction (i.e. record or transaction T) does not match a hash digest of the corresponding prior global state (“pre-execution hash”) of the subsequent record or transaction (i.e. record or transaction T+1), as encoded by the receipts associated with said records and/or transactions. The transactions (i.e. T and T+1) in such circumstance may be considered “disjoint”; an instance of state-disjunction fraud may be considered an instance of block-construction fraud.

In one or more embodiments, a state-disjunction fraud proof may be implemented in two forms. If the state disjunction is between two sequential transactions of the same block, then the fraud proof may comprise a block header of the block and a receipt-specific cryptographic proof revealing the receipt data structures of the disjoint transactions. If the state disjunction is between the first transaction of a block, and the last transaction of a preceding block, then the fraud proof may comprise the block headers of the two blocks, and receipt-specific cryptographic proofs of each block revealing the receipt data structures of the disjoint transactions. Said cryptographic proofs may in certain embodiments be implemented as Merkle proofs of Merkle data structures such as, for example, Merkle trees or Merkle tries.

Alternately, variant embodiments may implement block headers which themselves comprise both a hash digest of an initial global state data structure (initial state hash), and a hash digest of a final global state data structure (final state hash), where said initial global state data structure is a data structure of the global state before execution of the block's functionality, and said final global state data structure is a data structure of the global state after execution of the block's functionality. In such an embodiment of the present invention, a state-disjunction fraud proof demonstrating a disjunction between the first record or transaction of a block and the last record or transaction of a preceding block may comprise block headers of said blocks, without including Merkle proofs.

In one or more embodiments that implement a multi-shard global state, each shard of a global state may comprise its own global state data structure, and may comprise its own hash digest-which hash digest may be a root hash of the shard state data structure, in the case that said state data structure is implemented as a hash-based data structure, like a Merkle tree or Merkle trie. In such an embodiment, a receipt may comprise a separate pre-execution hash and a separate post-execution hash for each shard referenced, read, modified or otherwise operated on by a record or transaction; and in certain variant embodiments, a block header may comprise a separate pre-execution hash and a separate post-execution hash for each shard referenced, read, modified or otherwise operated on by its block and/or its records and/or transactions. In various embodiments, a state-disjunction fraud proof may occur when a post-execution hash included in a receipt or block header, which post-execution hash is of a particular shard data structure, fails to match a pre-execution hash included in an immediately subsequent receipt or block header, which pre-execution hash is of the subsequent version of the same shared data structure.

A blockchain node or other computation device evaluating and/or confirming a state-disjunction fraud proof within one block may implement one or more of the following steps, without limitation:
a) Comparing the hash digest (i.e. root hash) of the receipt-specific cryptographic proof to the receipt hash digest of the block header, to confirm that the cryptographic proofs do correspond to hash-based data structures of the block.
b) Evaluating the revealed receipt data to confirm that a post-execution hash of a first receipt indeed does not match a corresponding pre-execution hash of a second receipt.
c) In an embodiment in which the block header may be cryptographically signed by the block-building node that created or built the block, verifying the validity of the cryptographic signature of the block.

A blockchain node or other computer device evaluating and/or confirming a state-disjunction fraud proof between two blocks may implement one or more of the following steps, without limitation:
a) Confirming that the more recent of the block headers includes a back reference to the older of the block headers, which back reference comprises a cryptographic hash digest of the block header.
b) In an embodiment that includes one or more receipt-specific cryptographic proofs revealing receipts of disjoint transactions, comparing the hash digest (i.e. root hash) of each receipt-specific cryptographic proof to the receipt hash digest of each corresponding block header, to confirm that the cryptographic proofs do correspond to hash-based data structures of each block.
c) In an embodiment that includes one or more receipt-specific cryptographic proofs added to the fraud proof, confirming that the post-execution hash of a first receipt in fact does not match the corresponding post-execution hash of a second receipt.
d) In an embodiment that includes one or more initial state hashes and one or more final state hashes in block headers, confirming that a final state hash of a first block header in fact does not match the corresponding initial state hash of a second block header of an immediately subsequent block.
e) In an embodiment in which the block header may be cryptographically signed by the block-building node that created or built the block, verifying the validity of the cryptographic signature of the block.

In an embodiment in which a state-disjunction fraud proof implicates a state disjunction between the last transaction of a block, and the first transaction of an immediately subsequent block, it is the immediately subsequent block that may be considered fraudulent. In an embodiment in which a valid fraud proof record comprising a state-disjunction fraud proof is added to a new block by a block-building node, and such state-disjunction fraud proof implicates a state disjunction between last transaction of a block and the first transaction of an immediately subsequent block, tokens placed at risk by a cryptographic signer of the immediately subsequent block may be transferred to a blockchain account specified by the fraud proof record.

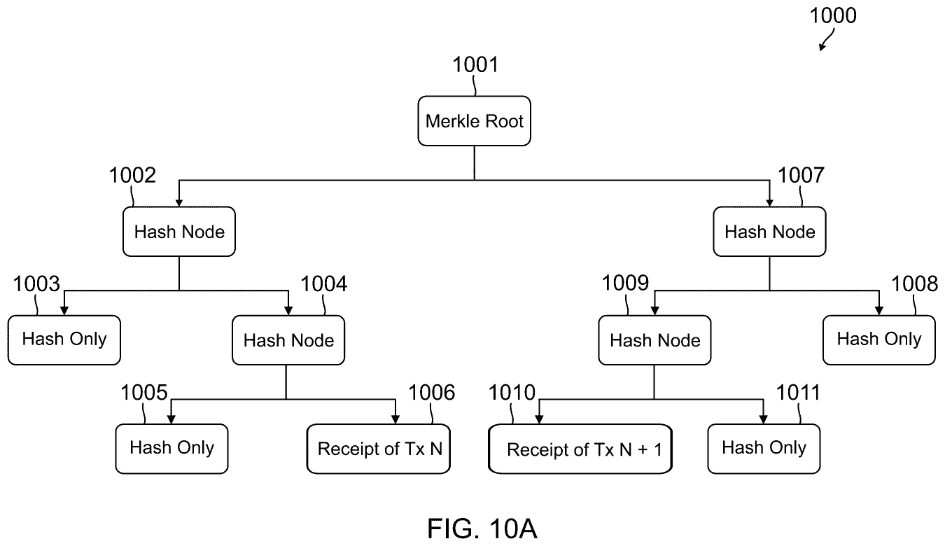

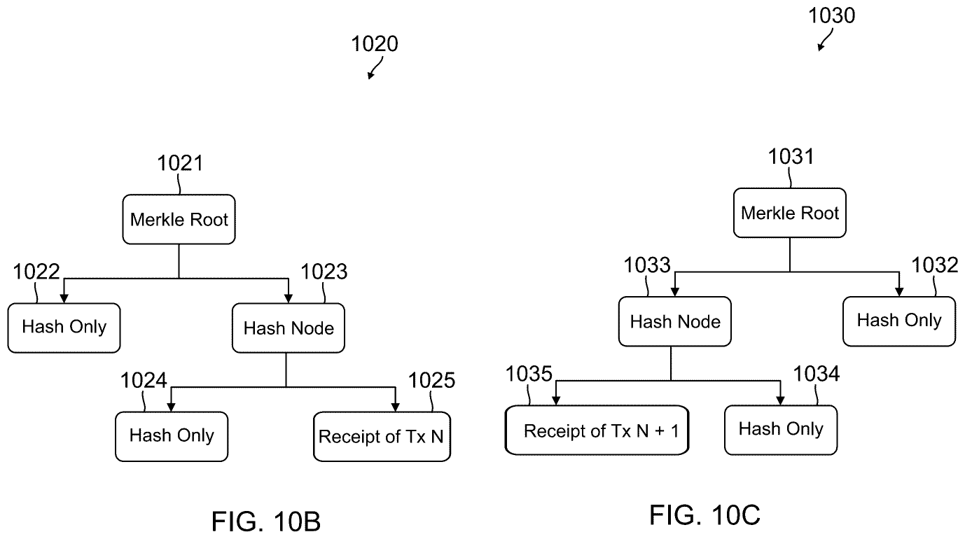

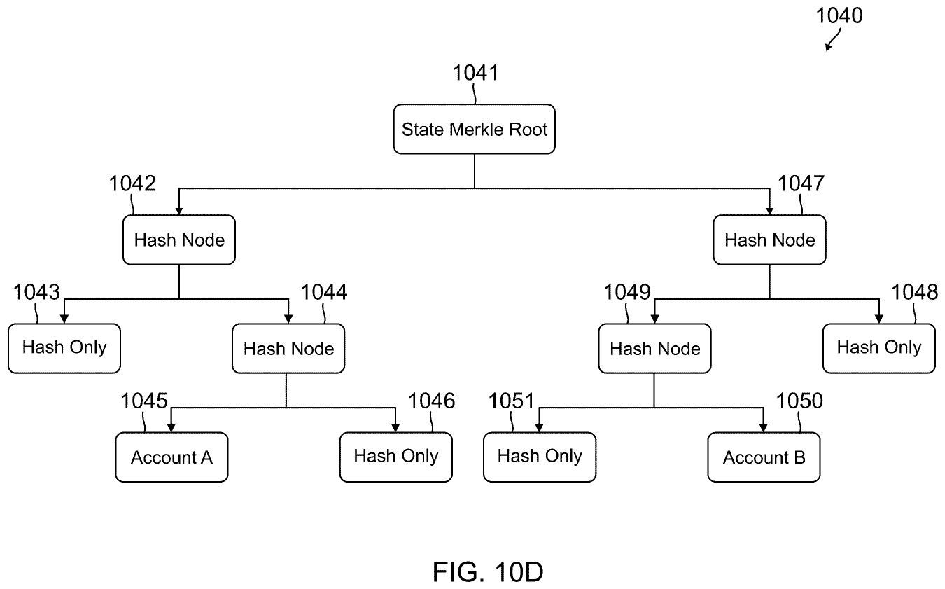

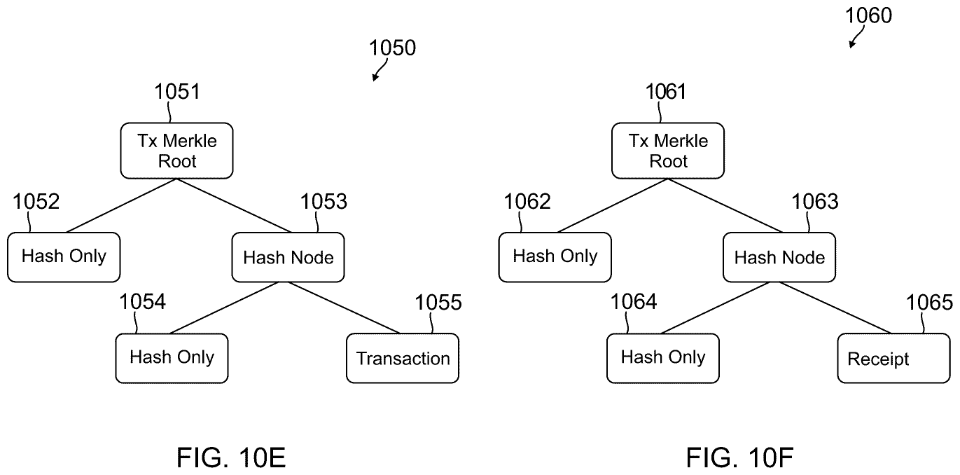

FIG. 10A illustrates Merkle proof elements that may be included in a state-disjunction fraud proof in one or more embodiments. A receipt Merkle proof is presented as a binary Merkle proof (1000), although an alternate implementation may alternate cryptographic proof data structures. Revealed data elements (1006, 1010) may include receipt data structures associated with the disjoint records and/or transactions. Other leaf nodes of the tree (1003, 1005, 1011, 1008) comprise hash digests of other data of the original hash-based data structure which is not revealed; this hidden data may not be relevant for the generation or evaluation of the fraud proof, but the included hash digests may be necessary for the verification of the Merkle proof itself. The Merkle root (1001) is calculated according to the standard known algorithm for generating the hash digests that constitute a binary Merkle proof, by first hashing all revealed data, then combining hashes of leaf and branch nodes in pairs, and hashing each pair, starting at the bottom, and proceeding upwards level-by-level, until all hashes are combined into the hash root.

FIGS. 10B and 10C illustrate, in an example embodiment, separate receipt Merkle proofs (1020, 1030) that may be included in a fraud proof created in the event of a state disjunction between two blocks are also presented; in alternate embodiments that rely on one or more hash digests included in block headers, these may be omitted. The first receipt Merkle proof comprises a revealed receipt (1025), two leaf nodes comprising hash digests of hidden data (1022, 1024), and a receipt Merkle root (1021) derived from the constituent leaf and branch node hash digests, according to a standard binary Merkle proof algorithm. The second receipt Merkle proof comprises a revealed receipt (1035), two leaf nodes comprising hash digests of hidden data (1034, 1032), and a receipt Merkle root (1031) derived from the constituent leaf and branch node hash digests, according to a standard binary Merkle proof algorithm. In various embodiments, these account Merkle roots may match hash digests of the block headers included with the fraud proof.

### Invalid-Transition Fraud

In various embodiments, a receipt may include a hash digest of a version of a global state data structure immediately prior to execution of the record or transaction associated with the receipt; said hash digest may be referred to as a pre-execution hash, and said version of the global state data structure may be referred to as a pre-execution state. A receipt may also include a hash digest of a version of the global state data structure immediately following execution of the record or transaction associated with the receipt; said hash digest may be referred to as a post-execution hash, and said version of the global state data structure may be referred to as a post-execution state.

In various embodiments, an invalid-transition fraud may occur in which a record or transaction associated with a receipt does not result in a new state reflected by the receipt. In other words, an invalid-transition fraud may occur when a pre-execution state conforming to a pre-execution hash does not transform into a version of the global state conforming to a post-execution hash when the record or transaction associated with the receipt is applied.

According to various embodiments, each record, transaction and/or receipt may also incorporate a reference to all accounts or addresses read, operated on or modified by that transaction. In certain embodiments a receipt may also include one or more hash digests of affected account or address data stored in the global state, and/or may include certain individual details of the account or address data.

In one or more embodiments, when an invalid-transition fraud occurs, data of an account or address as it exists immediately prior to the execution of a record or transaction will not be transformed into the data of the same account or address as it is hashed or encoded in the corresponding receipt. In certain embodiments, in order to prove that a transaction is fraudulent, and in turn, that a block is fraudulent, it may be sufficient to prove that one or more such account or address data transformations are inconsistent with state data hashed and encoded in a receipt. In one or more embodiments, a validator node or a block-building node performing validation of a block may construct a fraud proof through a process involving the following steps, without limitation:
a) A node identifies all elements of a pre-execution state that are read, referenced, modified by, or otherwise operated on by a fraudulent record or transaction. These elements are added to a Merkle proof, in which Merkle proof only these elements are revealed, and which proof's Merkle root hash is the same as the pre-execution hash of the block, encoded in the block header. This Merkle proof is the pre-execution Merkle proof. In order to arrive at the precise pre-execution state, in one or more embodiments, the node may need to execute all records and/or transactions preceding the fraudulent record and/or transaction.
b) The node performs a transformation of the pre-execution Merkle proof by executing the one or more state transformations embodied by the fraudulent record or transaction, and then updating the hash digests of the proof and the Merkle root hash. This results in a new Merkle proof in which the revealed data comprises the state elements that have been read, referenced, modified by or otherwise operated on by the fraudulent record or transaction. This Merkle proof is the post-execution Merkle proof.
c) The fraud is proven by demonstrating that the pre-execution Merkle proof root hash is the same pre-execution hash encoded in the fraudulent block or in the fraudulent block's block header, and that the post-execution Merkle proof's root hash differs from the post-execution hash encoded in the fraudulent block or in the fraudulent block's block header.

In one or more embodiments, an invalid-transition fraud proof may be encoded comprising one or more of the following, without limitation: the block header and block hash of the fraudulent block, the cryptographic signature of the block-building node that built the fraudulent block (if it is not directly incorporated with the block header), the fraudulent record or transaction, the associated receipt, and the pre-execution Merkle proof.

In various embodiments, a blockchain node or other computer device may evaluate and/or confirm said invalid-transition fraud proof first by confirming that a root hash of a pre-execution Merkle proof matches a pre-execution hash of a block header, then by executing one or more state transformations of a fraudulent record or transaction against the pre-execution Merkle proof revealed data elements, then by generating a confirmation Merkle proof from the results of said execution, and lastly by confirming that the confirmation Merkle proof root hash is distinct from a post-execution hash of the block header. In some embodiments, a post-execution Merkle proof may also be included in the fraud proof, to provide an additional point of comparison against the confirmation Merkle proof.

In one or more embodiments, an invalid-transition fraud proof may also include one or more Merkle proofs corresponding to each record, transaction and/or receipt referenced by or included in the fraud proof; in such an embodiment, the process of constructing a fraud proof may contain one or more steps wherein said Merkle proofs are constructed proving the presence of said records, transactions, and/or receipts in the record, transaction or receipt data structures of the block. In at least one embodiment, a process of evaluating and/or confirming a fraud proof may include one or more steps verifying that the root hashes of said one or more Merkle proofs are equal to the corresponding record, transaction, and/or receipt root hashes included in the block's block header.

In one or more embodiments that implement a multi-shard global state, each shard of a global state may comprise its own global state data structure, and may comprise its own hash digest-which hash digest may be a root hash of the shard state data structure in the case it is implemented as a hash-based data structure like a Merkle tree or Merkle trie. In such an embodiment, a receipt may comprise a separate pre-execution hash and a separate post-execution hash for each shard referenced, read, modified or otherwise operated on by a record or transaction. Likewise, a fraud proof implemented in such an embodiment may include a separate pre-execution Merkle proof for each such shard.

In an embodiment that includes additional global state data elements in a receipt, an additional verification may be performed-either in the creation of the fraud proof, or in the verification of it, or both-comparing the data elements of the confirmation Merkle proof against the global state data elements included in the block header. For example, if a receipt includes information regarding token balances of an account or address updated by a record or transaction, such data may be subject to comparison against the data of the confirmation Merkle proof; if the information is inconsistent, then an invalid-transition fraud proof may be constructed.

FIGS. 10D, 10E and 10F illustrate Merkle proof elements that may be included in an invalid-transition fraud proof in one or more embodiments. First, the pre-execution Merkle proof is presented as a binary Merkle proof (1041), although an alternate implementation may alternate cryptographic proof data structures. Revealed data elements (1045, 1050) may include account data of accounts identified as being read, referenced, modified or otherwise operated on by the fraudulent record or transaction. Other leaf nodes of the tree (1043, 1046, 1050, 1048) comprise hash digests of other data of the original hash-based data structure which is not revealed; this hidden data may not be relevant for the generation or evaluation of the fraud proof, but the hash digests may be necessary for the verification of the Merkle proof itself. The Merkle root (1041) is calculated according to the standard known algorithm for generating the hash digests that constitute a binary Merkle proof, by first hashing all revealed data, then combining hashes of leaf and branch nodes in pairs, and hashing each pair, starting at the bottom, and proceeding upwards level-by-level, until all hashes are combined into the hash root.

A transaction binary Merkle proof (1050) and a receipt binary Merkle proof (1060) are also presented; in alternate embodiments, other cryptographic proof data structures may be used instead. The transaction Merkle proof comprises a revealed transaction (1055), two leaf nodes comprising hash digests of hidden data (1052, 1054), and an transaction Merkle root (1051) derived from the constituent leaf and branch node hash digests, according to a standard binary Merkle proof algorithm. The receipt Merkle proof comprises a revealed record (1064), two leaf nodes comprising hash digests of hidden data (1062, 1065), and a receipt Merkle root (1061) derived from the constituent leaf and branch node hash digests, according to a standard binary Merkle proof algorithm. In various embodiments, this account Merkle root and this receipt Merkle root may match a transaction root hash and a record root hash of the block header included with the fraud proof.

### Missing Transaction Fraud

In various embodiments of the present invention, a “missing-transaction fraud” may occur when one or more hash roots (for example, Merkle roots) included in a block header fail to be substantiated because one or more (or all) of the records, transactions, receipts and/or other data are unavailable.

Although missing data may be attributed to network interruptions, network partitions, incompatibilities in software, hardware failure, or other innocent explanations, block data may also be unavailable when the block is entirely invented or contrived, or because data is intentionally withheld. Regardless as to its origin or explanation, however, and as to whether any intention may be attributed to it, the impact of an instance of missing-transaction fraud is likely to be the same, and the mechanics for mitigating the impact of such a fraud may remain the same. In various embodiments, at a fundamental level, an instance of missing-transaction fraud occurs because the block-building node that created or built the block header failed transmit, share or propagate said data; the response is not dependent on the explanation as to why.

In one or more embodiments, missing-transaction fraud may be definitively ruled-out by downloading all the records, transactions, receipts and/or other data of a block, performing a structural validation of those transactions, and then verifying the one or more hash roots of the block header which are derived from that data. Because full validation is not necessary for structural validation, a bock-building node or a validator node may perform a structural validation of records, transactions, receipts and/or other data belonging to shards that it does not manage or operate on. While disproving a missing-transaction fraud may be feasible, proving a missing-transaction fraud amounts to proving a negative. In various embodiments, because proof of fraud is not possible, other strategies should be employed to suppress, reduce and/or control missing transaction fraud.

Certain embodiments of the present invention may implement a universal structural verification process, such that each block-building node and validator node performs structural validation of all block data-even data that is does not retain and/or that does not interact with or operate on the shards it comprises. However, this approach may substantially increase overall network traffic of the blockchain system, and may increase the computational requirements of each block-building node and validator node.

One or more embodiments may suppress, mitigation, reduce and/or control missing transaction fraud through one or more of the following techniques (strategies), in combination or individually, without limitation:
a) by block building nodes performing structural validation of blocks that are selected to be built upon, which structural validation in various embodiments may be performed before beginning to build a subsequent block, while building a subsequent block, or after building a subsequent block (as may be the case when trust-but-verify methodologies are employed);
b) by setting a timing threshold, which timing threshold comprises duration of time after a block-building node has begun downloading a block, at the end of which all data constituting a block should have been downloaded and structurally validated, or any new blocks being built upon that block may be discarded;
c) through the use of verifiable delay functions and/or fitness gradient consensus, as noted elsewhere herein;
d) through the use of insufficiency reputation messages and related processes, as described elsewhere herein;
e) through the implementation of a reputation-tracking mechanism

In one or more embodiments, missing-transaction fraud notices (for example, insufficiency repudiation messages) sent between nodes may be unreliable-meaning that a node receiving such a message may not have sufficient information to determine its veracity. For example, an insufficiency repudiation message may be purposefully false, having the effect of causing nodes on the network to do unnecessary work, or inadvertently false, as in the case of a network partition causing a node to lose access to other nodes. In such embodiments, a block or block ring should not be assumed to be valid until all transactions are downloaded and structurally verified. In one or more embodiments, a block or block ring may be built upon simultaneously while data is being downloaded and structural validation is being performed.

Structural validation, as used herein with regards to various embodiments of the present invention, refers to the process of evaluating a record or transaction to determine if it is encoded in a manner consistent with the requirements of a blockchain protocol, without regards to the compatibility or validity of said record or transaction in relation to the global state or any data thereof. A block may be said to have been structurally validated if its records, transactions, and/or receipts have been downloaded, and if structural validation has been performed on those records, transactions and/or receipts. A block, record and/or a transaction may be said to be structurally valid if structural validation may be successfully performed thereon. A block, record and/or a transaction may be considered structurally invalid if any

### Data Withholding Attack

A data withholding attack, according to various embodiments, consists of an attack whereby one or more malicious block-building nodes transmit and propagate one or more new block headers of one or more new blocks, without transmitting, sharing or propagating the data constituting the block, such as records, transactions and/or receipts. In one or more embodiments, a data withholding attack may be a malicious and intentional result of one or more missing transaction fraud instances perpetrated by one or more block-building nodes.

In various embodiments of the present invention, block-building nodes that receive a block header may begin building on the block optimistically, working to produce one or more new blocks. However, unless all elements of block state are obtained by said nodes-including, but not limited to, records, transactions, receipts, and/or other data elements—in at least one embodiment, the global state cannot be updated, or the validity of the block cannot be determined, or both.

In certain embodiments, a data withholding attack may cause block-building nodes to waste time building on a block, the data of which may never be fully disclosed. In one or more embodiments that implement fitness-gradient consensus, a data withholding attack may induce a reorganization when data of an optimal-fitness block is withheld, if one or more block building nodes discard one or more other competing blocks because they decide to build on said optimal-fitness block at the expense of other blocks, but are ultimately unable to.

Various embodiments of the present invention may implement one or more methodologies or techniques to mitigate the disruptive effects of data withholding attacks, which mitigation techniques may include techniques and strategies implemented to suppress, mitigation, reduce and/or control missing transaction fraud.

### Reputation Tracking

Various fraud mitigation approaches implemented by various embodiments of the present invention allow fraudulent blocks to be identified, invalidated, impeached and/or repudiated in a retroactive manner. An implication of this is that even after a block or a block ring has been selected and built upon, the work performed to build upon that block or that block ring may yet need to be discarded if fraud is discovered. The success of these various fraud mitigation approaches depends on whether reputation heuristics can slow the spread of fraudulent blocks so that they do not displace valid blocks before the fraud is detected.

In one or more embodiments, a reputation-tracking block-building node (i.e. a “reputation-tracking node”) may store one or more reputation values corresponding to each of its peer block-building nodes (“peers” collectively, or individually, “peer”, referring to a node with which a block-building node maintains a connection and exchanges data), and in certain embodiments may also store a reputation value for other block-building nodes. According to various embodiments, reputation values may be separate and apart from the global state, and may consist of local data stored and maintained only the reputation-tracking node itself, although in certain embodiments the reputation data may be shared with other nodes that may be operating in combination with that node or in a cluster with that node. In one or more implementations, the blockchain protocol rules are indifferent as to the reputation-tracking methodology and reputation heuristics that each node implements; the performance of the network may be enhanced if nodes implement effective reputation tracking, but it is nonetheless only implemented conventionally by nodes at their option.

In one or more embodiments, such one or more reputation values may correspond to accounts or addresses of the various block-building nodes of the network, which block-building nodes each cryptographically sign the encoded blocks or block header data structures that are propagated across the network. Reputation values may also be stored to correspond with direct peers according to the network connection maintained between the reputation-tracking node and each peer. In certain embodiments, a peer may authenticate its affiliation or control of an on-chain account by cryptographically signing a challenge that is shared by the reputation-tracking block-building node, which challenge may be a random string or other value generated by the reputation-tracking block-building node for this purpose. This challenge-signing, which may in certain embodiments be a part of a larger peering network protocol, and in other embodiments may be part of a different protocol, may prove to a reputation-tracking block-building node that a peer does in fact control a particular blockchain account. A peer's reputation may be stored according to the connection maintained, or according to the authenticated account or address.

In one or more embodiments of the present invention, each block built may be signed by the account of the block-building node that builds it. In certain such embodiments, reputation may be tracked according to the account of the block-building node; if a block-building node changes the account or address it uses to sign blocks it builds, then its reputation resets.

According to one or more embodiments, a reputation-tracking node may improve or increase a block-building node's reputation value when one or more non-fraudulent blocks created or signed by the block-building node are validated successfully by the reputation-tracking node. In certain embodiments, a detection or awareness by a reputation-tracking node of one or more fraudulent or repudiated blocks signed by a block-building node may penalize or reduce that block-building node's reputation value stored by the reputation-tracking node.

In one or more embodiments, a reputation-tracking node may penalize or reduce the reputation of a peer if it has transmitted or shared a fraudulent or repudiated block; this may occur in certain embodiments even if said peer did not itself build or cryptographically sign the fraudulent or repudiated block. In various embodiments, a reputation-tracking node may not penalize or may not reduce the reputation of a peer that shares or transmits a fraudulent or repudiated block if said peer includes a flag or other indicator with the block indicating the block is “unverified” by the peer. A reputation-tracking node may penalize or reduce the reputation of a peer if the peer indicates a fraudulent or repudiated block received from a third party as being “verified”.

In at least one embodiment, blocks built by a block-building node having a low reputation may rarely be processed, even if those blocks have an optimal fitness in an embodiment that impalements a fitness gradient consensus. By default, a block built by a low-reputation node having a reputation value below a certain threshold may be discarded or ignored by a reputation-tracking node, such that neither the block nor its block header may be processed, validated, nor propagated by the reputation-tracking node. In certain embodiments, however, low-reputation blocks may nonetheless be processed and/or validated periodically by reputation-tracking nodes, which may serve to prevent calcification of a reputation-tracking system, and may serve to balance the influence of high-reputation nodes on a network.

In various embodiments, a reputation-tracking node may select for processing and/or for validation certain blocks built by lower-reputation block-building nodes- or by nodes having a reputation value below a rejection threshold-according to a variety of criteria, including but not limited to:
a) according to a random selection process, whereby blocks that would otherwise be discarded or ignored are randomly selected for processing regardless of the reputation score of the block-building node;
b) according to a fitness ranking function that blends or combines a separately-calculated block or blockchain segment fitness value with a reputation value, which may produce a composite ranking that discounts a more-optimal fitness value in light of a lower reputation value, but which may allow a more-optimal-fitness block produced by a lower-reputation block-building node to be selected for inclusion, to be built upon instead of a lower-fitness block produced by a higher-reputation block-building node;
c) according to a consideration of tokens or other units of value placed at risk by the lower-reputation block-building node, which “tokens-at-risk” may be claimed by one or more block-building-nodes that build subsequent blocks directly or indirectly referencing the block produced by the lower-reputation block-building node, and/or which “tokens-at-risk” may be claimed by an account signing a valid fraud proof record which fraud proof repudiates the block;
d) or a combination thereof.

In one or more of these embodiments, a process of selecting a block to build upon-which selection process considers reputation-operates independently of protocol considerations, and only utilizes local data of the reputation-tracking node. In a variety of embodiments, one or more such process may be implemented in parallel with one or more separate block-selection and block-building processes that select and build upon blocks built by higher-reputation block-building nodes.

### Reputation And Block Building

In one or more embodiments of the present invention, a reputation-tracking node may download and validate the records and/or transactions of a block after deciding as to whether the block should be built upon. In one or more embodiments, a reputation-tracking node may decide to build one or more new blocks upon a certain block as a result of making an evaluation of the reputation of the block-building node that built that block, and/or as a result of an making an evaluation of the reputation of the peer that shared the block or block-header data with the reputation-tracking node. According to various embodiments, a block-building node or a validator node may determine the validity of a block or a block ring after downloading and validating all the records and/or transactions of that block or that block ring. However, a block-building node may select a block or a block ring to be built upon before validity is determined; or, in some embodiments, a block-building node may build select a block or a block ring to be built upon without definitively determining validity.

In various embodiments, a block-building node may use one or more heuristic algorithms to decide whether a block should be built upon before all transactions may be downloaded; one such algorithm may, when selecting, give extra weight to a block that includes a tokens-at-risk payment guarantee.

In one or more embodiments, a node that forms or proposes a block ring may be referred to as a “ring formation node”, or alternately as a “ring-building node”. In certain embodiments, a ring formation node may be required to explicitly confirm and/or repudiate a block ring that it forms or proposes, within a certain number of blocks of the block height of the block ring's consensus round. In such embodiments, a block ring may be confirmed after all block headers, records, transactions and/or receipts of that block ring (meaning, of the of the blocks constituting that block ring) are download and are structurally validated by the node forming or proposing the block ring; and a block ring may be repudiated the ring formation node fails to download or is unable to download one or more block headers, records, transactions or receipts constituting of the block ring, or if any downloaded data fails structural validation.

Structural validation, as used herein with regards to various embodiments of the present invention, refers to the process of evaluating a record or transaction to determine if it is encoded in a manner consistent with the requirements of a blockchain protocol, without regards to the compatibility or validity of said record or transaction in relation to the global state or any data thereof. A block may be said to have been structurally validated if its records, transactions, and/or receipts have been downloaded, and if structural validation has been performed on those records, transactions and/or receipts. A block, record and/or a transaction may be said to be structurally valid if structural validation may be successfully performed thereon. A block, record and/or a transaction may be considered structurally invalid if any

### Repudiation Handshaking

According to various embodiments, a node may repudiate a block or a block ring under the circumstance that the node is unable to download one or more block headers, records, transactions, and/or receipts or other data elements that may constitute a block or a block ring. A repudiation of this type may be referred to as an insufficiency repudiation.

In one or more embodiments, an insufficiency repudiation may affect reputation without effectuating any on-chain transformation of a global state of the blockchain system. A fraud proof may act as a form of repudiation in certain embodiments; however, an insufficiency repudiation cannot be formed into a fraud proof, because it is not possible for a node to prove definitively that it has not received data. Rather, an insufficiency repudiation in certain embodiments may act as an indication to the network that a node is unable to confirm the existence of block headers, records, transactions and/or receipts or other data elements purported to constitute a block and/or a block ring, providing a non-definitive indicator to the network that a block and/or a block ring may be difficult or impossible to validate. According to various embodiments, an insufficiency repudiation message references the specific block that is unsubstantiated (meaning, the block that may be missing one or more block headers, records, transactions and/or receipts or other data elements).

A node that sends an insufficiency repudiation message pertaining to a block may be missing one or more records, transactions, and/or receipts or other data elements of that block for a variety of reasons, including, but not limited to:
a) the block may be purely fraudulent; for instance, there may exist no set of transactions that would validly constitute the block as it is encoded;
b) the block-building node that generated the block may be off-line and unable to transmit or share all of the data elements that constitute the block;
c) the block may be valid, but the block-building node is trying to induce one or more block-building nodes of the network to repudiate the block in order to decrease network efficiency, or possibly even induce a fork in the network.

As implemented in certain embodiments, an insufficiency repudiation message may itself constitute part of an attack by a malicious actor; such an attacker may repudiate a valid block in order to induce one or more block-building nodes to download records, transactions and/or receipts or other data elements they may not otherwise download, and then to perform structural validation of those various data elements, which may clog the network. In one or more embodiments, various methods of reducing the occurrence of this risk may be employed.

According to one or more embodiments of the present invention, an insufficiency repudiation handshaking procedure may include one or more of the following elements, without limitation:
a) If a reputation-tracking node is unable to download all the transactions of a block, it may send, share, broadcast or propagate to the blockchain network a tentative insufficiency repudiation message pertaining to the block in question. Such a message may be sent to peers, and in certain embodiments may be forwarded onward to the peers of the peers.
b) A block-building node that has performed structural validation on the block may broadcast a response message to the network, or respond directly to the reputation-tracking node, informing the reputation-tracking node that the transactions are available for download, which information in certain embodiments may be encoded in an “availability message”. Upon receipt of one or more availability messages pertaining to missing data, the reputation-tracking node may begin downloading the missing data,
c) If the reputation-tracking node is unable to download and structurally validate any of the missing block headers, records, transactions, and/or receipts or other data element of the block before a specific amount of time has passed, then it broadcasts a final insufficiency repudiation message for the block. Otherwise, the reputation-tracking node broadcasts a retraction message.
d) Upon receipt of an insufficiency repudiation message (tentative or final), other block-building nodes that have built upon the block in question may attempt to download and structurally validate the block's data, if they have not already done so; however, in certain embodiments, this act of downloading and validating the block's data may be contingent on the reputation value the other block-building nodes may have assigned to the block-building node that has issued the repudiation message.

In one or more embodiments, the reputational effects of an insufficiency repudiation handshaking procedure (such as the above) may be evaluated individually by one or more block-building nodes. In at least one embodiment, a first block-building node that receives a tentative repudiation message for a block that it has already structurally validated-meaning that the node has already downloaded all data constituting that block and can prove that the retraction is unfounded—may send an availability message. In certain embodiments, if the first block-building node does not receive a retraction message within a specific duration of time after said availability has been sent, then the first block-building node may penalize or reduce the reputation value of a second block-building node that sent the tentative repudiation message.

In various embodiments of the present invention, a block-building node that has cryptographically signed a block will be available to transmit or propagate to one or more of the other nodes of the network all the records, transactions, receipts, and/or other data that constitutes that block. In at least one embodiment, said node may respond to a tentative repudiation message by sharing, transmitting, re-transmitting or propagating one or more transactions that may be missing from the block-building node that sent to tentative repudiation message. One or more reputation-tracking nodes may penalize or lower the reputation of a block-building node that does not respond in this way to a tentative repudiation message pertaining to a block that the block-building node has signed. In at least one embodiment, a block that is successfully repudiated should result in a penalization or a reduction of a reputation value of the block-building node that built that block.

In at least one embodiment, if a block-building node having a reputation value below a certain threshold repudiates a block that is not directly in a block-building node's own shard chain-which, for example, may be a block that is in a preceding ring, but operating on different shards-then a reputation-tracking node may elect not to download the block's constituent data. Said threshold may be a function of the reputation of the block-building node signing the repudiation message.

In one or more embodiments, a ring formation node may repudiate a block of its block ring, and if the block ring is already being built upon by a second node, then that second node may download the block's transactions to verify them structurally. This may be done in certain embodiments to verify the correctness of the repudiation, so as to detect, for example, if the ring formation node is somehow being blocked from downloading one or more block headers, records, transactions, receipt, or other data. The probability that a block-building node receiving a repudiation message will act on message is determined by the reputation of the originator of the message.

In one or more embodiments, if a block is successfully repudiated, then the reputation of the original block-building node may be penalized by various reputation-tracking nodes, regardless as to which block-building node originated the repudiation message. In certain embodiments, when a parent or ancestor block is successfully repudiated by a block-building node, and said block had previously been endorsed by another block-building node as having been validated successfully, then one or more reputation-tracking nodes will penalize and lower the reputation value of the peer or other node that endorsed the block.

In at least one embodiment, when a block is proven fraudulent through a fraud proof, a reputation-tracking node will penalize or reduce the reputation value of the block-building node originating the fraudulent block. In certain embodiments, one or more “downstream” block-building nodes-block-building nodes that had built blocks on a now-impeached or-repudiated block—may also be penalized. In one such embodiment, the greater the distance from the offending block, the less the reduction of the reputation value; in an alternate embodiment, the opposite: the greater the distance from the offending block, the greater the reduction of the reputation value.

Various embodiments may implement a reputation tracking mechanism with different configurations regarding a variety of factors that may impact the effectiveness of the mechanism. Different embodiments may implement a reputation tracking mechanism with different configurations for one or more of the following elements, without limitation:
a) A configured probability that a low-reputation block will be selected for validation or to be built upon by a block-building node or a validator node, determined according to the operation of a random number generator or a pseudo random number generator;
b) A configured probability that a low-reputation block's insufficiency repudiation messages will be trusted by a reputation-tracking node, determined according to the operation of a random number generator or a pseudo random number generator;
c) A function that determines the specific reputation value or change in reputation value that a reputation-tracking node assigns to a block-building node after each evaluation of blocks created by that block-building node;
d) A reputation penalty (decrease in reputation value) levied against a block-building node for successful insufficiency repudiation of a block it has produced;
e) A reputation penalty (decrease in reputation value) levied against a block-building node is a block cryptographically signed by that node is successfully proven fraudulent through a fraud proof;
f) A reputation penalty (decrease in reputation value) levied against a downstream block-building node that directly or indirectly builds on a block that has been successfully proven fraudulent;
g) A reputation penalty (decrease in reputation value) levied against a block-building node that marks a block as validated, which block later proves to be fraudulent, or is successfully repudiated.

At least one embodiment of the present invention may implement a block-building procedure comprising one or more of the following steps, without limitation:
a) After one or more ring formation nodes formulate block rings, block ring headers (each block ring header being a block header of the ring formation block) are shared with the whole network;
b) Block-building nodes build new blocks on the most-optimal-fitness block rings comprising blocks built by the highest-reputation block-building nodes;
c) Simultaneously, block-building nodes verify and validate the one or more preceding blocks and/or block rings upon which new blocks are bult-meaning, the one or more blocks and/or block rings to which said new blocks have a back reference;
d) Individual block-building nodes validate blocks of the prior consensus round that operate on the same one or more shards as the block-building nodes;
e) Any block-building node that discovers a fraudulent or contradictory condition within the block, or that fails to download all the block data, repudiates the block
f) A repudiation message is broadcast across the network (in some embodiments, utilizing a gossip protocol) to be shared with all miners;
g) Once the various block-building nodes finish building blocks, at least one ring formation node assembles a block ring, and announces it again.

### Guarantee Avoidance

Various embodiments of the present invention herein described implement a “tokens-at-risk” mechanism, by which a block-building node may place at risk tokens of one or more addresses or accounts it controls, to be included as part of a block that it builds (an “incentivized block), in order to incentivize other block building nodes to build one or more subsequent blocks with reference back to the incentivized block. Several embodiments may implement a means by which the tokens at risk may be claimed and transferred to an account that signs a fraud proof record proving that the incentivized block is invalid.

In one or more embodiments, a blockchain system implementing “tokens-at-risk” incentives for block acceptance may be susceptible to a guarantee-avoidance attempt. In such embodiments, guarantee-avoidance is an attempt by a malicious actor operating a block-building node to avoid losing tokens placed at risk, even if a fraudulent block is produced and said tokens should be lost. One means by which a malicious actor may avoid losing tokens placed at risk, in certain embodiments, is by themselves generating, and cryptographically signing with the keys of an account they control, the fraud proof record which invalidates the block, thereby surreptitiously re-capturing the tokens placed at risk.

Another means by which a malicious actor may avoid losing tokens placed at risk, in certain embodiments, is by diverting tokens-at-risk from an account before a fraudulent block is discovered. In such event, the malicious actor may participate in building two separate forks: a first fork built by a block-building node controlled by the malicious actor, which fork includes a “tokens-at-risk” token allocation, and which fork contain a block-construction fraud; and a second fork built by another block-building node, which node may or may not be controlled by the malicious actor, and which second fork includes one or more transactions that may attempt to empty the account or address used to sign the first fork and fund the “tokens-at-risk”.

Guarantee-avoidance presents a certain risk to embodiments that implement “tokens-at-risk” incentives for block acceptance; specifically, it creates an opportunity for malicious actors to generate fraudulent blocks (for instance blocks that comprise a block-construction fraud) without needing to incur the monetary penalty that the “tokens-at-risk” mechanism is intended to impose. If malicious actors are able to avoid forfeiting the “tokens-at-risk” that they ostensibly include in fraudulent block, the “tokens-at-risk” mechanism may cease to function as an incentive against malicious action, and/or may cease to act a signaling mechanism among the block-building nodes.

A number of features implemented by various embodiments of the present invention may reduce the risk of guarantee-avoidance fraud spam, however. In a number of embodiments, a requirement to include a verifiable delay function (VDF) output of a certain complexity level in each block header imposes a computational cost on the building of every block. In such embodiments, a malicious actor may not propagate a fraudulent block to the network without first executing the VDF; if a malicious actor's block-building node does not execute the VDF in such embodiments, then any fraudulent block it creates may simply be discarded or ignored by peer nodes, and will fail to propagate widely. In one or more embodiments, the requirement to execute a VDF means that the maximum number of fraudulent blocks a malicious actor may produce may not exceed the number of computer processors or computer processor cores that the malicious actor controls and is able to operate concurrently.

Furthermore, in an embodiment that implements fitness gradient consensus in combination with VDF, the fitness value of a block—fraudulent or otherwise-—may not be known or even knowable until after the VDF has completed executing. In certain embodiments that implement the hash-distance variant of fitness-gradient consensus, the fitness value may be unaffected by any fraud attempt within the block construction; in at least one such embodiment, a fitness value may be derived entirely from the data encoded in the block header, and therefore may not be susceptible to fraud at all. Therefore, as a result, each fraudulent block produced may also need to be among the most-optimal-fitness blocks produced during a consensus round, or it may not even be evaluated.

For these reasons, in various embodiments of the present invention, a malicious actor may need to marshal significant computational resources in order to produce enough guarantee-avoidance fraud attempts- or potentially any other fraud attempts, generally-to have a meaningful impact on the blockchain system's performance. If, however, these mechanisms are insufficient to deter or limit malicious actors, additional “tokens-at-risk” mechanisms may also be employed which may provide solutions the guarantee-avoidance problem described above.

According to at least one embodiment, only a portion of the tokens placed at risk for a block may be transferred to an account that signs a fraud proof record impeaching or repudiating that block; a portion of the tokens-at-risk of a fraudulent block may, for instance, be allocated to the block-building node that built the block containing the fraud proof record- or may more generally be included in a block reward pool or transaction fee pool of the block comprising the record, to be allocated to various recipients; or may potentially be destroyed or deleted, not to be allocated to any account. In one or more embodiments of the present invention, a block reward pool may be distributed to a combination of block-building node accounts, accounts that have recently staked or locked tokens through the inclusion in the blockchain of consensus staking records, and/or other accounts.

Another mitigation strategy may also be implemented by various embodiments of the present invention. In certain embodiments, tokens placed at risk through a “tokens-at-risk” mechanism may first need to be staked or locked through the operation of a consensus staking record- or a lock record-signed by an account of the same block-building node that is placing said tokens at risk in an incentivized block. Staked or locked tokens may be eligible to be placed at risk if the beginning of the staking or locking period is a certain minimum number of blocks preceding the incentivized block, and/or if the completion of the staking or locking period is a certain minimum number of blocks following the incentivized block. In certain embodiments, staked or locked tokens are not available to be moved, spent, transferred or otherwise used for the duration of the staking or locking period, except to be placed at risk as part of the “tokens-at-risk” mechanism. In one or more embodiments, in the event that the “tokens-at-risk” are transferred to an account cryptographically signing a fraud proof that impeaches or repudiates the incentivized block comprising the tokens-at-risk, the tokens will remain staked or locked until the end of the staking or locking period; in one or more alternate embodiments, the staking or locking period would immediately end, and the tokens would be available for use.

### Token Locking

Various embodiments may implement one or more “lock” records, which records may lock a certain number of tokens for a locking period lasting a certain number of blocks, which number of tokens and number of blocks may be encoded as fields of the lock record. An account signing a lock record may lock said account's tokens for a certain number of blocks, during which time the tokens may not be sold, staked, or spent.

In certain embodiments, locked tokens may receive a portion of the block rewards, which may be paid out when the tokens are unlocked-or, alternately, when a user attempts to access or use the tokens following termination of the lock period.

In one or more embodiments, a limited number of “slots” may be available for lock records, each slot providing authorization for one account to lock tokens for a single unit of time, such that no more accounts than a number of slots defined may lock tokens at any one time. An algorithmic pricing model may be implemented to decide the price to be paid for slots; according to one embodiment, the pricing model may be implemented as an automated market maker that exchanges slots for gas; as more slots are filled, the gas price to be paid approaches infinity. In at least one embodiment, lock records may optionally be configured to opt out of earning rewards, in which case the lock transaction may have a fixed gas price rather than a price determined by an algorithm.

In one or more embodiments of the present invention, tokens-at-risk may be specified in reference to locked tokens. By specifying tokens-at-risk in terms of locked tokens, certain embodiments may prevent a cheating block-building node from avoiding a fraud penalty in the event the cheating block-building node generates a fraudulent record or transaction, or possibly generates a fraudulent receipt. Without this locking requirement, the system may be susceptible to a “nothing at risk” attack. In such embodiments, only tokens that have been locked for a certain number of blocks “N”, and which are not unlocked before “X” blocks have passed after a block is created, may be specified as tokens—at risk for that block. If the tokens-at-risk are not fully locked within the (“N”, “X”) window, then the block may not be not valid. Fraud proof records transfer the ownership of the locked tokens if the referenced block is invalid. These tokens may remain locked for the pre-specified period, and the reward may be paid to the sender of the proof.

The token locking mechanism described here is similar to the token staking mechanism described elsewhere herein. In one or more embodiments of the present invention, token locking and token staking as described herein may be combined into a single mechanism serving the purposes of both mechanisms described. In other alternate embodiments, separate token locking and token staking mechanisms may be implemented.

### Zero-Knowledge Consensus Enhancements

Various embodiments of the present invention may implement a zero-knowledge block-building methodology which reduces need for fraud mitigation techniques as described herein.

In certain embodiments, a block may comprise a zero-knowledge record, which zero-knowledge record may comprise:
a) one or more addresses and/or account addresses which reference and localize one or more data structures within the global state, which one or more data structures may be transformed by the execution of the zero-knowledge record, or which may be evaluated by or implicated by a zero-knowledge algorithmic encoding used to generate a non-interactive zero-knowledge proof of said transformation;
b) one or more pre-execution hash digests of said one or more data structures;
c) a set of data elements to be directly inserted into, or to replace elements of, said one or more data structures, so as to effectuate the state transformation embodied by said zero-knowledge record; and
d) a non-interactive zero-knowledge proof proving the validity of said state transformation.

In one or more embodiments, said set of data elements may be encoded as one or more account Merkle proofs, each account Merkle proof corresponding to one or more post-execution data structures which result from the state transformation embodied by the zero-knowledge record. Said account Merkle proofs may incorporate the data elements of the set of data elements as revealed data (i.e. non-hashed data), and may position said data elements in the relative positions they may occupy within said one or more post-execution data structures,

In one or more embodiments, said non-interactive zero-knowledge proof may be generated using a zero-knowledge algorithmic encoding which includes among its public inputs and/or outputs: the one-or more pre-execution hash digests, the set of data elements, and, optionally, one or more other data elements that may be encoded in the zero-knowledge record. In one or more embodiments, said zero-knowledge algorithmic encoding may include among its private inputs one or more data structures, which one or more data structures are elements of the global state localized at said addresses and/or account addresses prior to execution of the zero-knowledge record, and which may be cryptographically hashed to produce one or more hash digests that are equal to the pre-execution hash digests specified by the zero-knowledge record.

In certain embodiments, said zero-knowledge algorithmic encoding may also include among its private inputs other elements specific to the particular state transition type that the particular zero-knowledge algorithmic encoding corresponds to.

In one or more embodiments which implement a multi-shard global state, wherein each shard comprises a distinct global state data structure, said one or more data structures may belong to different shards, and the specified replacements and insertions may be applied to data in different shards.

In various embodiments, a validator node or a block-building node that processes such a zero-knowledge record may only insert and replace data pertaining to one or more shards that the validator node or block-building node operates on. In such embodiments, provided that the validator node or block-building node verifies that each of the applicable pre-execution hash digests is equal to the hash-digest of the corresponding data structure within the applicable shard at the time of evaluation, the specified replacements and insertions that apply to the node's one or more shards may be applied to the one or more shards directly without additional computation.

In various embodiments, when a zero-knowledge record is executed and applied, an associated receipt is generated which receipt includes one or more pre-execution hash digests of the global state prior to the execution and application of the zero-knowledge record's state transformation, and one or more post-execution hash digests of the global state following execution and application of the zero-knowledge record's state transformation. In an embodiment implementing a multi-shard global state, a separate pre-execution hash digest and post-execution hash digest would be included in the receipt for each shard.

In one or more embodiments, if a block contains only zero-knowledge records, and no other types of record or transaction, a validation of the block may be reduced to only a structural validation of the zero-knowledge records, which structural validation includes a verification of the non-interactive zero-knowledge proof of each record, and a verification that the one or more pre-execution hash digests of each record is equal to one or more hash digests of the one or more data structures as they exist within the global state at the time that each zero-knowledge record is executed and each state transformation is applied.

In one or more such embodiments, in order to allow this verification of hash digests to be reduced to a structural validation that does not require reference to the global state-or to one or more shards of the global state-one or more Merkle proofs (block Merkle proofs) may be included with the block header, each Merkle proof comprising all of the individual hash digests of the global state, and each Merkle proof corresponding to a shard data structure read, modified by, or operated on by the block. A structural validation of said zero-knowledge only blocks may proceed by first verifying the validity and internal consistency of the one or more block Merkle proofs; second confirming that the root hash(es) of the one or more block Merkle proofs are equal to one or more pre-execution global state hash digests included in the block header; third confirming that the hash digest or root hash of the set of zero-knowledge records is equal to a record hash digest of the block header, and that the hash digest or root hash of the set of associated receipts is equal to a receipt hash digest of the block header; and then iterating over each zero-knowledge record of the block and each associated receipt:
first, confirming that the one or more pre-execution hash digests specified within the zero-knowledge record match the hash digests that can be found within the one or more block Merkle proofs at the locations of the one or more addresses or account addresses specified in the zero-knowledge record;
second, verifying that the hash roots of the one or more block Merkle proofs match the corresponding pre-execution hash digest(s) of the associated receipt;
third, verifying the non-interactive zero-knowledge proof of the zero-knowledge record and confirming that the zero-knowledge record is structurally valid,
fourth, updating the block Merkle proof data, replacing the hash digests that can be found within the one or more block Merkle proofs at locations corresponding to the one or more addresses or account addresses, each hash digest to be replaced by a hash root of each account Merkle proof of the zero-knowledge record, each account Merkle proof corresponding to an address or account address of the one or more addresses or account addresses;
fifth, recalculating the various derived hashes of the one or more block Merkle proofs in light of the preceding changes, and confirming that the new hash roots of the one or more block Merkle proofs match the corresponding post-execution hash digest(s) of the associated receipt.
sixth, proceeding to the next zero-knowledge record, without resetting the data of the one or more block Merkle proof(s), such that each zero-knowledge record is evaluated with reference to the version of the block Merkle proof produced during the prior iteration; except that upon reaching the last transaction of the block, the hash root(s) of the one or more block Merkle proof may be compared to one or more post-execution global state hash digests included in the block header, to confirm that they are equal.

In one or more embodiments that implement a multi-shard global state, a separate block Merkle proof will be implemented for each shard read, referenced, modified by or operated on by a block. In such embodiments, the above-described procedure may be implemented such that each pre-execution hash digest and post-execution hash digest of each receipt is calculated with respect to a particular shard, and a separate pre-execution global state hash and a separate post-execution global state hash is included in the block header for every shard read, referenced, modified by or operated on by the block in question.

In certain embodiments, a block-building node may generate a block zero-knowledge proof, which block zero-knowledge proof is a non-interactive zero knowledge proof generated with the use of a zero-knowledge algorithmic encoding that implements the structural validation procedure described above with regards to blocks that contain only zero-knowledge records. In one or more embodiments, the public inputs of said zero-knowledge algorithmic encoding may comprise, without limitation, the one or more pre-execution global state hash digests of the block header, the one or more post-execution global state hash digests of the block header, a receipt hash digest of the block header, and a zero-knowledge record hash digest of the block header. In certain embodiments, the private inputs of said zero-knowledge algorithmic encoding may comprise, without limitation, the one or more block Merkle proofs, the list of zero-knowledge records of the block, and the list of associated receipts.

In at least one embodiment, a block-building node may generate a zero-knowledge block header, which zero-knowledge block header may include, without limitation, one or more back references to one or more preceding blocks, which back references may be implemented as hash digests of the block header or some other aspect of the preceding block (“block hashes”); the one or more pre-execution global state hash digests of the block header; the one or more post-execution global state hash digests of the block header; a receipt hash digest of the block header; a zero-knowledge record hash digest of the block header; and said block zero-knowledge proof, proving, for instance, that the zero-knowledge records and associated receipts are valid and conform to the various hash digests that constitute the block header. In one or more embodiments, a zero-knowledge block header may form the block header of a block that only contains zero-knowledge records, and no other records or transactions.

In various embodiments, a zero-knowledge block header may be evaluated and confirmed to be valid by any computer device-including any verifier node or block-builder node—that knows the block hashes of one or more preceding blocks, that knows one or more post-execution global state hashes of one or more preceding blocks, and that implements a zero-knowledge proof verifier that is compatible with the zero-knowledge prover implemented by the block-building node that created the block header. In one or more embodiments, a zero-knowledge proof verifier may be compatible with a zero-knowledge prover if, for example, they both implement the same zero-knowledge protocol, and have reference to the same zero-knowledge algorithmic circuits. Such a computer device may verify the validity of a zero-knowledge block header by verifying the non-interactive zero-knowledge proof, and by confirming that the back references and pre-execution global state hash digests of the zero-knowledge block header are consistent with one or more preceding block headers.

Because access to the global state, including any shards of the global state, is unnecessary to verify the validity of a zero-knowledge block header, a blockchain sharding system that exclusively uses zero-knowledge records in lieu of any other type of record or transaction-and that exclusively generates zero-knowledge block headers in lieu of any other type of block header-will never generate a block that requires access to the global state to be validated. In one or more embodiments, any fraudulent block scenarios may be eliminated, and a number of mechanisms intended to mitigate the impact of fraud become redundant, unnecessary or counterproductive.

Nevertheless, in various embodiments, block-building nodes which build zero-knowledge blocks nonetheless should download zero-knowledge records in order to perform specific updates to the global state, and to build new blocks and generate receipts. Although validation of zero-knowledge block headers may be possible without access to global state and without access to zero-knowledge records, the generation of a new block header requires access to zero-knowledge records that are included in the block, and access to all global state data structures that might be read, referenced, modified or operated on by said zero-knowledge records. As a result, in various embodiments, a zero-knowledge block-building methodology may still be susceptible to instances of missing transaction fraud and data withholding attacks, and may therefore benefit from the implementation of a reputation-tracking mechanism as described herein.

FIG. 19B is a simplified block diagram showing exemplary blockchain layers according to an embodiment. Blockchain layers 1908 may include infrastructure (tier 1) layer 1910, data (tier 2) layer 1920, network (tier 3) layer 1930, consensus (tier 4) layer 1940, and application (tier 5) layer 1950. The infrastructure layer 1910 may be a hardware/software/firmware layer and may include one or more virtual machines (VMs) 1911 and/or one or more oracles 1912. A virtual machine (VM) 1911 may implement the Blockchain synchronization and point-of-sale integration systems described herein. The VM may provide a runtime environment for transaction execution in the blockchain. In an embodiment, a VM 1911 may be, for example, stack-based and may enable untrusted code to be executed by a global peer-to-peer (P2P) network of computers. An oracle 1912 may provide a third-party service that connects smart contracts executing on the blockchain with off-chain data sources. For example, an oracle 1912 may query, verify, and/or authenticate one or more external data sources for the system 100 (FIG. 1) and/or system 200 (FIG. 2). According to an embodiment, external data sources may include, e.g., one or more legacy systems 314 and/or one or more external compliance systems and/or databases 1913. In an example embodiment, the blockchain system may be configured to execute blockchain synchronization and point-of-sale integration systems and embodiments disclosed herein, such as interfacing with payment channels and payment channel networks, a point of sale system 1301 (ISO 8583 Service, HTTP Web Service, Lightning/Payment Channel Connection), Microservice API external web services 1309, or off-chain databases or external data management systems, including such systems as relational databases, relational database management systems (RDBMS), document-oriented databases, graph databases, key-value stores, time-series databases, and other data management systems.

In an example embodiment, a blockchain system implementing a zero-knowledge capabilities as provided for herein may be operate within said blockchain layers (1908). A wallet comprising a wallet node (1952) may implement a zero-knowledge proof prover in software, and may execute said zero-knowledge proof prover so as to generate a zero-knowledge proof and incorporate said zero-knowledge proof in a zero-knowledge record. Said wallet node may submit said zero-knowledge record through a network message to a block-building node (1941) which may then execute a zero-knowledge proof verifier implemented as software and incorporated into the blockchain software implementation of said block-building node, which software may execute in a virtual machine (1911). In the event that said verification of said zero-knowledge proof is successful according to the execution of the zero-knowledge proof verifier, then said block-building node may incorporate said zero-knowledge record into the blockchain (1921) stored in its data layer (1920), and update the system's global state.

### Synchronization System Vault

In accordance with at least one embodiment of the present invention, a vault architecture may comprise a secure service that maintains and protects cryptographic keys. A segregated infrastructure may be configured to host one or more instances of the vault service, which may be configured to function as the sole component within the system authorized to perform cryptographic signing operations, and may be isolated from other components via one or more security boundaries. Such security boundaries may include, but need not be limited to, network segmentation, firewall policies, physical access controls, and secure authentication mechanisms. In some embodiments, the vault service may be configured to process signing requests received through a message queue system and to return signed data through separate, secure channels. The vault service may incorporate validation logic to ensure that any signing operations conform to pre-defined security policies, which policies may be stored in a secure configuration repository.

In certain embodiments, said vault architecture may be integrated into said synchronization system, and may comprise one or more transaction processing components, one or more transaction writer components, and/or one or more event messaging systems of said synchronization system.

Implementation of such a vault architecture may provide several technical advantages. By consolidating cryptographic signing operations within a segregated service, the system may achieve a substantial reduction in the potential attack surface exposed to adversaries. The vault architecture enables comprehensive audit logging and monitoring capabilities, as signing operations are required to pass through controlled channels that may be configured for detailed activity tracking. Key management processes may be simplified and made more secure, as private keys need only be stored in a single location rather than being distributed across system components. The vault architecture facilitates implementation of sophisticated access control mechanisms, including role-based access control, multi-party authorization requirements, and time-based restrictions. The centralized nature of the vault service enables efficient implementation of security policies such as rate limiting, key rotation schedules, and anomaly detection. In at least one embodiment, the vault service may maintain separate key hierarchies for different purposes, enabling granular control over key usage while simplifying key lifecycle management.

### Vault Private Key Management

In accordance with at least one embodiment of the present invention, a secure vault architecture may be implemented to manage and protect private cryptographic keys within a blockchain-based financial system. The vault architecture may include one or more dedicated secure services that execute on segregated infrastructure and control cryptographic signing operations within the system.

In at least one embodiment, a transaction writer component may be implemented as a message consumer within an event messaging system, which component contains logic requiring access to private cryptographic keys. This transaction writer component (referred to herein as the “Vault”) may be the only element of the system permitted to hold private keys in memory or access unencrypted private keys. The Vault may execute on a segregated server in a segregated network, with no inbound network access permitted, and with outbound access restricted to only essential connections such as the blockchain network, a database system, an event message queue server, and a master key management system.

The Vault may be configured to receive signing requests via a message topic within the event messaging system. When a signing operation is required by any other component of the system, such as a transaction processing component, that component may publish a signing request message to a designated message topic. The Vault may consume these messages from the topic, validate the signing request, perform the cryptographic signing operation using the appropriate private key, and then write the signed data or transaction to another message topic that may be consumed by the requesting component.

In at least one embodiment, account backup private keys may be stored in an encrypted format within a database, with decryption only performed within the Vault using master keys. These master keys may be accessible only from the segregated machine hosting the Vault service. The master keys may be implemented using a variety of key management approaches, including but not limited to hardware security modules (HSMs), secure enclaves, or other key management systems, with the specific implementation being configurable via dependency injection.

Access to the master keys may be implemented using one or more objects implementing an abstracted interface. The specific implementation may be instantiated using dependency injection, with the specific class being specified in a configuration. This abstraction layer may enable the system to adapt to different secure-enclave-type private key segregation systems, allowing the ultimate security architecture to be customized according to client preferences and requirements regarding key management.

The Vault may be configured to fully validate items added to the blockchain-writing message topic, making it as difficult as possible to corrupt the system by inserting malicious messages into the message queue. Any synchronous APIs requiring access to account keys may use the event messaging system to send signing requests to the Vault. In cases where a synchronous API response is required, the Vault may validate and sign the requested data and write it to another message topic that may be used to send messages back to the API server, which may block while waiting for the signed data to be returned via the event messaging system.

In at least one embodiment, the database used to store encrypted backup private keys may be separate from the primary transaction database, and may be configured to only be locally accessible to the Vault. However, this separation of databases may be optional, with both key storage and transaction data potentially being stored in the same database system in some implementations, subject to appropriate access controls and encryption.

### Vault Network Segregation

In accordance with at least one embodiment of the present invention, a secure transaction processing architecture may be implemented that incorporates a transaction writer component operating within a segregated computing environment. This transaction writer component may be configured to perform various cryptographic operations, including but not limited to the signing of blockchain transactions, the encryption and decryption of sensitive data, and the management of cryptographic keys. The segregated computing environment may be implemented through various combinations of hardware isolation, network segregation, and access control mechanisms.

In at least one embodiment, the transaction writer component may be deployed as a specialized consumer of an event messaging system, where the component receives and processes messages from one or more message topics or queues. The transaction writer component may be configured as the sole system element authorized to access private cryptographic keys and perform signing operations. This exclusive authorization may be enforced through various security mechanisms, including hardware-based security controls, software-based access restrictions, and network-level isolation.

The segregated computing environment may incorporate one or more dedicated computing devices that are specifically provisioned and configured for secure operation. These computing devices may be physically isolated from general-purpose computing infrastructure and may be subject to enhanced security controls. In at least one embodiment, these computing devices may be configured with specialized hardware security features, such as trusted platform modules (TPMs), hardware security modules (HSMs), or other security-focused hardware components.

Network access within the segregated environment may be strictly controlled through a combination of network security mechanisms. In at least one embodiment, inbound network connections to the transaction writer component may be prohibited by default, with this prohibition being enforced through various combinations of network firewalls, security groups, access control lists, and other network security controls. The transaction writer component may be permitted to initiate only specific types of outbound network connections, which may include but are not limited to:
Connections to one or more block-building nodes, through which signed blockchain transactions may be submitted to a blockchain network;
Connections to one or more database systems, which may be used to persist transaction records and retrieve necessary transaction data;
Connections to one or more event messaging system servers, from which transaction signing requests may be received; and
Connections to one or more key management systems, through which master encryption keys may be accessed.

The segregated environment may be implemented using various network isolation technologies, including but not limited to virtual private clouds (VPCs), software-defined networks (SDNs), virtual local area networks (VLANs), and/or other network virtualization technologies. In at least one embodiment, the segregated environment may be implemented across multiple isolated network segments, with explicit network paths defined only for authorized communication channels. All other network traffic may be blocked by default through various network security mechanisms.

Access to master encryption keys may be managed through one or more key management protocols. These master encryption keys may be stored within secure key storage systems, which may include hardware security modules, secure enclaves, or other specialized key storage mechanisms. In at least one embodiment, the transaction writer component may be required to perform multiple levels of authentication and establish secure communication channels before being granted access to these master keys. These master keys may then be used to decrypt other cryptographic keys that are required for specific transaction signing operations.

The event messaging system may function as the primary interface through which transaction signing requests are transmitted to the transaction writer component. These requests may be published to specific message topics or queues that are accessible only to authorized system components. In at least one embodiment, the transaction writer component may process these requests within the isolated environment, performing necessary cryptographic operations before transmitting signed transactions through authorized outbound channels. The event messaging system may implement various security controls, including but not limited to message encryption, access control lists, and authentication requirements.

This segregated architecture may provide enhanced security for sensitive cryptographic operations by minimizing the attack surface and strictly controlling system interactions. The combination of network isolation, access controls, and secure key management may help prevent unauthorized access to private keys and signing capabilities. The architecture may also incorporate various monitoring and auditing capabilities to detect and respond to potential security events.

### Vault Key Encryption and Validation Requirements

In various embodiments of the present invention, methods and systems are provided for securing cryptographic operations within a distributed financial transaction system through implementation of a segregated vault architecture. The vault architecture may comprise one or more dedicated services operating on segregated infrastructure, wherein these services maintain exclusive control over cryptographic signing operations.

In accordance with at least one embodiment, the system implements a multi-tiered encryption scheme for securing private keys associated with user accounts. One or more backup private keys for individual accounts may be stored in an encrypted format on one or more persistent storage devices. These backup private keys remain in an encrypted state until they are required for signing operations. The encrypted backup keys may only be decrypted and loaded into memory on one or more transaction writer components operating on segregated infrastructure. In at least one embodiment, the transaction writer components may be implemented as dedicated message consumers that process blockchain writing operations received through a distributed event messaging system.

Access to one or more master encryption keys used for decrypting the backup private keys may be strictly limited to the transaction writer components. In various embodiments, these master keys may be stored in secure hardware modules, encrypted configuration files, or other secure storage mechanisms that are only accessible from the segregated infrastructure hosting the transaction writer components. The master keys may be used to derive session keys or other temporary keys used for decrypting specific backup private keys when needed for signing operations. The system may be configured such that no other components or services have access to the master encryption keys or the ability to decrypt backup private keys.

To maintain security and prevent potential corruption of the system through malicious messages, embodiments of the invention implement comprehensive validation of items added to the transaction writing message queue. In at least one embodiment, a dedicated transaction writer component fully validates messages before processing them. The validation may include verification of message format, checking of signatures, validation of account balances and permissions, verification of transaction sequencing and nonces, and other security checks appropriate to the specific type of transaction being processed. Messages that fail validation may be rejected and logged for security monitoring purposes.

The validation process may be implemented within the transaction writer component that processes messages from the distributed event messaging system. By performing validation at this stage, the system helps prevent injection of malicious messages that could corrupt the state of the system or compromise security. The validation requirements and specific checks performed may be configurable and extensible to accommodate different types of transactions and security requirements.

In some embodiments, the validation process may include checking that messages are properly signed by authorized keys, that referenced accounts exist and have sufficient balances, that any time-based parameters like expiration timestamps are valid, and that the overall transaction meets any relevant business rules or regulatory requirements configured in the system. Additional validation steps may be added through a plugin architecture that allows for customization of the validation process while maintaining strict security boundaries.

Various embodiments may implement different subsets of these validation requirements or may implement additional validation steps beyond those described. The specific validation rules and processes may be configured based on the requirements of the particular deployment environment, regulatory regime, or business needs. In at least one embodiment, the validation rules may be updated dynamically in response to detected security threats or changing compliance requirements.

### Vault Implementation Details

In accordance with at least one embodiment of the present invention, a secure vault architecture may be implemented to manage cryptographic operations within a distributed financial system. The vault architecture may comprise one or more dedicated secure services operating on segregated infrastructure, wherein such services may be configured as the sole components authorized to perform cryptographic signing operations within the system. The vault architecture may enhance security by isolating cryptographic operations within a controlled environment.

The configuration of the secure vault service may be implemented through one or more configuration files that specify particular classes to be instantiated via dependency injection. These configuration files may define specific implementations of security interfaces, thereby enabling different security implementations to be utilized without requiring modification to the underlying vault architecture. The dependency injection pattern may facilitate the flexibility to adapt various security implementations while maintaining architectural integrity.

The vault architecture may incorporate two distinct categories of master keys. A first category may comprise one or more encryption master keys utilized to encrypt and decrypt backup private keys stored within one or more databases. A second category may comprise one or more public-private key pairs associated with the system's treasury account. The number and configuration of keys within each category may be adjustable based on specific implementation requirements and security policies.

In at least one embodiment, backup private keys may be stored in an encrypted format within a database system. The encryption of these backup private keys may be performed using one or more of the encryption master keys. The encrypted backup private keys may be configured to be decrypted only within the secure vault environment when required for signing operations, and may be purged from memory immediately following use.

Access to the master keys may be implemented through one or more objects that implement an abstracted interface. The specific implementation of this interface may be instantiated using dependency injection, with the particular class being specified in the system configuration. This abstraction layer may enable various key management implementations to be utilized without necessitating modifications to the core vault architecture.

In accordance with at least one embodiment, a separate dedicated database system may be implemented specifically for storing the encrypted backup private keys. This separate database system may be configured to be accessible only from within the secure vault environment. In particular, the database system may be configured to be locally accessible only to a transaction writer component that operates within the vault environment.

The transaction writer component may be implemented as the sole element of the system authorized to hold private keys in memory or have access to unencrypted private keys. This component may be responsible for receiving signing requests via an event messaging system, processing these requests within the secure vault environment, and returning signed data via a separate response queue. The transaction writer component may enforce strict protocols regarding the handling and lifecycle of private keys in memory.

The secure vault environment may be implemented with restrictive network access policies, wherein only specific outbound connections may be permitted. These outbound connections may include, but are not limited to, connections to one or more of: a blockchain network, a database system, an event messaging system, and a key management system. In at least one embodiment, inbound network connections to the vault environment may be prohibited, with communication occurring solely through the designated event messaging system.

The vault architecture may incorporate various additional security enhancements. These enhancements may include, but are not limited to, network segregation, hardware security modules, secure enclaves, key rotation policies, access control mechanisms, audit logging, and anomaly detection systems. The specific security enhancements implemented may be configured based on the particular security requirements of the deployment environment and applicable regulatory frameworks.

The secure vault architecture may be implemented to support both synchronous and asynchronous signing operations. For synchronous operations requiring immediate response, the vault service may utilize a dedicated response queue within the event messaging system to return signed data to the requesting service. For asynchronous operations, the signed data may be written directly to the blockchain or stored in a database system for subsequent use. The handling of synchronous versus asynchronous operations may be configurable based on the specific requirements of the operation being performed.

### Vault Synchronous API Handling

In accordance with at least one embodiment of the present invention, a secure vault architecture may be implemented that segregates cryptographic operations from other system components. The vault architecture may include one or more secure service components that execute on segregated infrastructure, wherein these secure service components are configured to be the only system elements authorized to perform certain cryptographic signing operations.

A transaction writer component may be implemented as part of the secure vault architecture in various embodiments. The transaction writer component may be configured to operate as a specialized message consumer that processes signing requests received via one or more dedicated secure messaging channels within an event messaging system. In at least one embodiment, the transaction writer component maintains exclusive control over account-related private keys and is configured to be the only system component permitted to sign transactions or messages using those private keys.

When processing API requests that require access to account keys, such as account recovery operations or other sensitive account-related functions, the system may implement specific secure message flows. In at least one embodiment, an API server or transaction processing component receiving such requests may be configured to format appropriate signing requests and transmit those requests to the transaction writer component via a dedicated secure channel within the event messaging system, rather than attempting to access private keys directly. The event messaging system may be configured to maintain strict separation between different message channels, with specific channels being designated for specific types of sensitive operations.

For API operations that require synchronous responses, the transaction writer component may be configured to perform validation of the signing request, generate appropriate digital signatures if the request is valid, and transmit the signed content to a separate secure channel within the event messaging system dedicated to signed responses. The original API server or transaction processing component may be configured to wait for the signed response to appear on this dedicated response channel before proceeding with its processing. This segregation of request and response channels may provide additional security isolation between components.

The validation performed by the transaction writer component may include, in various embodiments, one or more of: verifying that the signing request is properly formatted, confirming that the requesting component is authorized to initiate such requests, validating that sufficient account privileges exist to perform the requested operation, verifying the integrity of the message flow, and performing additional configurable security checks. The transaction writer component may be configured to reject signing requests that fail to satisfy any of the validation criteria, with rejection responses being transmitted via the dedicated response channel.

The system may implement configurable timeout mechanisms whereby the API server or transaction processing component will terminate its wait for a signed response after a specified time period has elapsed. In some embodiments, the system may be configured to retry failed signing requests according to configurable retry policies, which may include specified maximum retry attempts and customizable backoff periods between attempts. The retry behavior may be tailored to different types of signing requests, with more sensitive operations potentially having more restrictive retry policies.

Implementation of this segregated signing architecture provides enhanced security by ensuring that private keys remain isolated within the secure transaction writer component and are never exposed to potentially vulnerable public-facing components. The use of separate secure messaging channels for different types of requests and responses provides additional isolation between the secure transaction writer component and other system elements. The architecture may support various configuration options to tune the behavior of timeouts, retries, validation requirements, and other operational parameters, allowing the security model to be adapted to different deployment scenarios while maintaining core security properties.

In at least one embodiment, the transaction writer component may be configured to maintain detailed audit logs of signing operations, including both successful and failed attempts. These audit logs may be stored in a secure manner and may be made available for security analysis and compliance purposes. The audit logging functionality may be configurable to capture different levels of detail for different types of signing operations.

### Various Synchronization System Security Solutions

In accordance with certain embodiments of the present invention, a robust authentication system may be implemented using one or more cryptographic keys to authenticate different types of messages and/or to secure different digital assets. These cryptographic mechanisms may be used in a variety of embodiments to secure any number of operations, including but not limited to digital wallet transactions, account management functions, service access requests, data synchronization processes, as well as to authorize blockchain records and/or transactions, or to authenticate application programming interface (API) requests, website logins, and other types of client-server communications. Various embodiments may implement a security regime wherein frequent user interactions with online services are secured through one or more strong cryptographic mechanisms, while traditional login-based authentication procedures may be restricted to the process of installing or registering cryptographic keys, which may be made rare, and enhanced by various supplementary security enhancements.

Traditional authentication methods for securing online interactions often rely heavily on username and password combinations, which can be problematic for several reasons. Users may choose weak passwords that are easily compromised, may reuse passwords across multiple services increasing vulnerability, or may need to frequently re-authenticate even for routine operations. Furthermore, session keys used to maintain authenticated sessions between re-authentication events may be intercepted or stolen, potentially allowing attackers to impersonate legitimate users without needing to obtain the original authentication credentials. These problems are compounded in systems that handle sensitive financial transactions or valuable digital assets, where security breaches can have severe consequences. Users of digital asset systems have suffered substantial financial losses through credential theft and account takeover, including the theft of cryptocurrency holdings, unauthorized bank transfers, and fraudulent credit card charges executed through compromised authentication credentials. These challenges are addressed through various embodiments of the present invention.

In certain embodiments, the system may maintain separate authentication pathways for these different types of operations. A first authentication pathway may be optimized for frequent operations, where cryptographic signatures are verified quickly against previously-registered public keys. A second authentication pathway may be optimized for security, suitable for infrequent operations like key registration, where multiple authentication factors should be validated before the operation can proceed.

The implementation of these distinct authentication pathways may serve to mitigate various security risks. By requiring heightened security measures only for infrequent but sensitive operations, while maintaining efficient cryptographic security for frequent operations, the system may achieve both strong security and operational efficiency. This approach recognizes that the risk profile of frequent operations (which are limited in scope and secured cryptographically) differs from the risk profile of infrequent operations (which may have broader security implications and thus require additional safeguards).

### Secure Message Authentication With Blockchain Credentials

In conventional session-based authentication systems, a server authenticates a user through validation of credentials such as a username and password. Upon successful validation, the server typically generates a session identifier, which may be implemented as a cookie, token, or similar data structure. The client device stores this session identifier and includes it with subsequent requests to the server, thereby allowing the server to authenticate these requests without requiring re-entry of credentials. This approach may have certain limitations, particularly in distributed systems, as it requires the server to maintain session state and may be vulnerable to various attack vectors including session hijacking or token theft.

Various embodiments of the present invention may implement an authentication approach that utilizes secure hardware elements present in modern computing devices. In at least one embodiment, one or more private keys associated with a user's account may be stored within a secure element of one or more user devices. The secure element may comprise a hardware-based key storage and cryptographic co-processor that is physically and/or logically segregated from the device's main processor and memory. The secure element may be configured to prevent extraction or copying of the private key, even by privileged software such as the device's operating system or administrator accounts. In some embodiments, the secure element may be implemented using a trusted platform module (TPM), a hardware security module (HSM), or another form of secure enclave or secure element.

In accordance with at least one embodiment of the present invention, a blockchain account may be associated with a plurality of devices, where each device may store one or more unique private keys within its respective secure element. The blockchain may maintain a record, which may be implemented as an array, list, map, or other data structure, containing public keys corresponding to the private keys stored in the secure elements of the various devices. These public keys may be added to or removed from the blockchain through one or more types of transactions that modify the account's device data structure or device authorization records. The account owner may authorize new devices by submitting records and/or transactions that add new public keys or new device records to this data structure, may revoke access from existing devices by submitting records and/or transactions that remove their corresponding public keys, or in certain embodiments may suspend or otherwise restrict access by submitting records and/or transactions that update or modify a configuration of the account or device data structure. In some embodiments, these authorization and revocation operations may be subject to various constraints or requirements, such as timeouts, multi-signature requirements, or other security policies. In certain embodiments, any addition, removal, configuration or other operation effectuated by the submission of records and/or transactions may only be effectuated after said records and/or transactions are successfully validated and incorporated into a new block by a block building node.

### Stateless Authentication

Various embodiments of the present invention may implement a stateless authentication scheme, which scheme may comprise a sender device, a receiver device, and a message, where the sender device comprises a client device or software application that initiates requests, such as, for example, a mobile device, digital wallet software, a wallet node, or some other physical device or software; the receiver device comprises a server or service that verifies and processes those requests, such as, for example, a computer device or software, a software application or service, a server computer, or a node of a blockchain network; and the message comprises a self-contained, cryptographically-signed payload, such as, for example, a computer-transmitted message or request, a message particle or part of a message, an API request, an HTTP request, a blockchain record blockchain transaction, or a particle or portion thereof, with which has been included one or more cryptographic signatures.

Unlike traditional session-based authentication where server infrastructure maintains session state, each message in such embodiments may be individually signed using one or more private keys stored by one or more sender devices involved in creating, generating and/or sending said message. In an embodiment, upon receipt of such a message, a receiving device may authenticate the one or more accounts encoded in the message by verifying that the public keys corresponding to the cryptographic signature of the message are currently authorized for the accounts in question, which said receiving device may do, for example, by sending a query to a node of a blockchain network, or by querying blockchain data that is otherwise available to said receiving device. According to certain embodiment, the receiving computer device or software may further verify whether the authenticated accounts are authorized to undertake whatever operation may be encoded by the message.

In one or more embodiments, this approach may reduce or eliminate the need for session management infrastructure while potentially providing enhanced security through hardware-based key protection. Additionally, this approach may provide better scalability in distributed systems, as any node in the network may independently verify the authentication of any request by consulting the blockchain state. Any receiving device reject, discard, penalize or ignore a message that it fails to authenticate, or where the operation is not authorized.

In one or more embodiments, said private keys used to sign said messages may be stored in one or more secure enclaves of said sender devices, which sender devices may be wallet nodes. In at least one embodiment, at least one secure element may be configured to require one or more forms of user or application authentication before permitting use of one or more stored private keys. This authentication may include, but is not limited to, biometric verification such as fingerprint or facial recognition, passcode entry, application certificate verification, hardware token validation, or any combination thereof. These authentication requirements may be enforced by the secure element hardware, preventing programmatic or unauthorized access to the private key without proper authentication. The specific combination and configuration of required authentication factors may be customizable according to the configuration of a particular embodiment.

In one or more embodiments, a block-building node may be implemented to permit the use of a variety of supported cryptographic signature algorithms (also called “digital signature algorithms”) in the configuration of the one or more cryptographic key pairs associated with a particular account or address. When generating a new cryptographic key pair, a wallet node or other sender device or client computer device may select one of a number of different available cryptographic signature algorithms, and said wallet node may generate a public key according to its chosen algorithm. A block-building node storing a key configuration of an account may accept a cryptographic key generated by one of a number of different cryptographic algorithms. A block-building node executing or validating a record or transaction may accept a cryptographic signature authorizing that transaction which cryptographic signature may be of any of a number of different cryptographic algorithms, and not simply a single algorithm implementation. A block-building node may, for instance, implement and/or accept cryptographic signature algorithms such as, for example, classical digital signature schemes like RSA, DSA, ECDSA, EdDSA (Ed25519, Ed448), and post-quantum or quantum-safe digital signature schemes like Dilithium, Falcon, and Picnic.

Different wallet devices may implement different cryptographic signature algorithms, either at the software level or at the hardware level, within a secure element or external to a secure element, which cryptographic signature algorithms may be incompatible with each other. A single account may be associated with key pairs generated by multiple different algorithms. By permitting the use of multiple cryptographic signature algorithms to be associated with the same account, the blockchain protocol implemented by a blockchain node may permit the same account to be controlled by multiple devices that would otherwise be incompatible, and may permit an account to be transferred from a wallet node/sender device of one device type to a wallet node/sender device of a different device type, each having incompatible cryptographic signature algorithm implementations.

The authentication scheme described above may be enhanced in various embodiments through the implementation of one or more key rotation policies. For instance, a wallet node may be configured to generate new key pairs, periodically, or according to various criteria, circumstances or events that may trigger a key rotation; in an embodiment, wallet node software may generate new key pairs through an interaction or request made to a secure element. Said criteria, circumstances or events may include, but are not limited to, elapsed time periods, number of key uses, detection of potential security threats, or changes in device state or security posture. When a new key pair is generated, the new public key may be registered on the blockchain through one or more signed transactions before the old key pair is discarded or deactivated. In some embodiments, this rotation process may happen automatically according to configured policies, while in other embodiments it may be triggered manually by user action or administrative command.

### Device Registration

In accordance with at least one embodiment of the present invention, a registration process may be implemented within a distributed computing environment comprising one or more client devices in communication with at least one server system. The registration process may be initiated through various entry points, including but not limited to, a dedicated registration interface accessible via a mobile application, a web browser interface, or in response to scanning a machine-readable code such as a Quick Response (QR) code containing registration parameters.

Prior to accepting registration data, in some embodiments, the system may present the user with a language selection interface. The language selection interface may include a searchable list of supported languages, wherein selection of a language may automatically configure both the interface language and establish default regional settings. The selected language preference may be stored as part of the user's profile data and may be modifiable after registration is complete.

Following language selection, one or more embodiments may present an authentication data collection interface. This interface may comprise multiple required and optional data input fields. Required fields may include, but are not limited to: a first name field, an optional middle name field, a last name field, a password creation field, a password confirmation field, and contact information fields. Contact information fields may include an email address field, a country code selection for phone numbers, and a phone number input field. In some implementations, either an email address or a phone number may be required, while in other implementations, both may be required.

According to various embodiments, the system may implement real-time validation of input fields using a multi-tiered validation approach. A first validation tier may comprise format validation, ensuring inputs conform to expected patterns—for example, verifying that email addresses contain appropriate characters and structure, or that phone numbers contain only numerical digits and conform to expected lengths based on the selected country code. A second validation tier may comprise uniqueness validation, verifying that the provided contact information has not been previously registered within the system. A third validation tier may comprise password strength validation, which may enforce one or more password complexity requirements including, but not limited to: minimum length requirements, character type requirements, and entropy calculations.

Upon validation of all required inputs, embodiments of the system may initiate a multi-step verification process. The system may generate and transmit verification codes to one or more of the provided contact methods. In some implementations, these verification codes may have configurable expiration periods, such as three minutes from generation. If multiple verification codes are generated within this period, the system may be configured to invalidate all previously generated codes, ensuring that only the most recently generated code remains valid. The system may provide user interface elements enabling regeneration of expired codes, potentially implementing rate limiting or cooling-down periods between regeneration attempts.

Following successful verification of contact information, various embodiments may perform one or more account initialization procedures. These procedures may include, but are not limited to: generating cryptographic key pairs, creating blockchain wallet addresses, initializing account state records, establishing device trust relationships, and generating account recovery credentials. The specific procedures performed may vary based on system configuration and regulatory requirements applicable to the user's jurisdiction.

In certain embodiments, the registration process may conclude with a multi-phase data synchronization procedure. During a first phase, the system may persist user profile data, authentication credentials, and account state information across one or more databases. During a second phase, the system may generate and store cryptographic proofs of the user's identity claims on one or more blockchain networks. During a third phase, the system may initialize communication channels for subsequent notifications and alerts. The sequence and timing of these phases may be configurable and may be performed synchronously or asynchronously depending on system requirements.

In accordance with various embodiments of the present invention, methods and systems are provided for securely recovering access to accounts within a distributed computing environment. The methods and systems described herein may provide mechanisms for verifying the identity of a user requesting account recovery while protecting against various forms of unauthorized access attempts.

In at least one embodiment, an account recovery process may be initiated via a first electronic message transmitted to a server system, said first electronic message including at least a country code identifier and a phone number identifier associated with an account for which recovery is requested. The first electronic message may optionally include a passcode or other authentication credential previously registered with the account. The server system may validate the received identifiers against stored account records prior to proceeding with subsequent recovery steps.

According to at least one embodiment, upon successful validation of the first electronic message, the server system may generate and transmit a first response message containing recovery initialization data. This recovery initialization data may comprise: a master account identifier uniquely identifying the account within the distributed computing environment; a device creation kernel for generating new device credentials; an original device signature used to validate the recovery request; a private key configured to accept a new device; and optionally one or more pieces of profile information such as personal name, family name, or other account details that may be used in subsequent verification steps.

In at least one embodiment, following transmission of the first response message, the server system may initiate a second verification phase by generating a time-limited verification code. The verification code may be transmitted via one or more electronic communication channels previously registered with the account, such as via a Short Message Service (SMS) message to the registered phone number. The verification code may be configured to expire after a predetermined time period, such as three minutes, after which a new verification code should be generated and transmitted to reinitiate the second verification phase.

According to various embodiments, the account recovery system may implement once or more security mechanisms to prevent unauthorized access attempts. These security mechanisms may include, but are not limited to, enforcing a mandatory cool-down period following certain types of account modifications. During the cool-down period, which may be configurable and may last for approximately twenty minutes in at least one embodiment, account recovery functionality may be temporarily disabled. Account modifications that may trigger the cool-down period include, but are not limited to: password changes, email address modifications, phone number updates, and changes to other profile information.

In at least one embodiment, the system may implement attempt limitation controls on the account recovery process. These controls may include tracking the number of failed verification code attempts and temporarily blocking account recovery functionality after a predetermined number of failures, such as three failed attempts. The blocking period may be configurable based on various security parameters and may extend for twenty-four hours in some embodiments. The specific duration of the blocking period may be adjusted based on factors including, but not limited to, account type, risk level, and historical account activity patterns.

According to various embodiments, upon successful completion of all verification steps, the system may generate and provision a new device record associated with the recovered account. The device record may include cryptographic key pairs, device identifiers, permission settings, and access control parameters. The system may be configured to automatically deprecate or deactivate previously registered device records associated with the account upon successful recovery, though in some embodiments previous device records may be maintained in an inactive state for security audit purposes.

In at least one embodiment, the account recovery process may incorporate multiple layers of identity verification. These verification layers may include, but are not limited to: responses to previously registered security questions; biometric matching against stored identity document images; verification of device-specific characteristics; and validation of historical account activity patterns. The specific combination, sequence, and number of verification layers may be dynamically configured based on factors including account type, transaction history, risk scoring, and applicable regulatory requirements in relevant jurisdictions.

According to various embodiments, the system may implement a comprehensive notification framework for alerting relevant parties of account recovery attempts. The notification framework may transmit alert messages through multiple communication channels including, but not limited to, currently registered contact methods and contact methods that were previously associated with the account but subsequently modified. Previously registered contact methods may be maintained in the system for a configurable time period specifically to facilitate security notifications, even after being replaced with updated contact information.

### Secure Hardware Elements

In accordance with various embodiments of the present invention, a blockchain system may implement a multi-device account control architecture that permits secure account sharing across a plurality of devices while maintaining individual cryptographic security for each device. Each device may maintain an independent cryptographic identity through a device-specific private key, which private key may be secured within tamper-resistant hardware, while still being authorized to initiate transactions from a common blockchain account or collection of blockchain accounts.

A device participating in the multi-device account architecture may incorporate one or more secure hardware elements selected from: a secure element integrated into a primary processor, a discrete secure element, a trusted platform module (TPM), a hardware security module (HSM), a subscriber identity module (SIM), or another form of tamper-resistant hardware element designed to securely store cryptographic material. The secure hardware element may be configured to generate and store one or more private keys in a manner whereby the private keys may never be exposed outside of the secure hardware element in unencrypted form. The secure hardware element may provide a signing interface through which transaction data may be passed into the secure hardware element for signing using the stored private key, with the resulting cryptographic signature being returned while the private key remains secured within the hardware element.

In accordance with at least one embodiment, association between a first device and a blockchain account may be established via a cryptographically-signed device record being added to the blockchain. The device record may incorporate a public key corresponding to the private key securely stored within the first device's secure hardware element, and may also specify usage parameters controlling or restricting the first device's authority to initiate transactions. The device record may be signed by a private key already having authority over the account, such as a key controlled by an account owner or administrator. Additional device records incorporating different public keys corresponding to different private keys stored in different devices' secure hardware elements may be added to establish multi-device control over the account.

Account authorization parameters may be implemented through a configurable authorization filter that specifies permissible combinations of device signatures required to authorize different categories of transactions. By way of non-limiting example, the authorization filter may permit certain low-value transactions to be authorized by a cryptographic signature from any single authorized device, while requiring signatures from two or more authorized devices for high-value transactions. The authorization filter may assign different authorization levels to different devices, such that some devices may be restricted to specific transaction types or may be subject to lower transaction limits compared to other devices associated with the same account.

When incorporating a new device record into the blockchain in accordance with at least one embodiment, the device record may specify granular permissions and restrictions applicable to that specific device. These permissions and restrictions may be enforced through smart contracts, through the account's authorization filter, or through a combination thereof. Non-limiting examples of configurable permissions may include: transaction value limits, permitted transaction types, permitted token types, approved counterparty accounts, geographic boundaries, time-of-day windows, required multi-signature combinations, and other programmable constraints on the device's transaction authority.

Device records may incorporate temporal validity constraints including but not limited to: explicit expiration timestamps, automatic expiration after a configurable period of device inactivity, automatic invalidation upon detection of specified trigger conditions, and scheduled validity windows. Trigger conditions that may invalidate a device record may include: attempted policy violations, detected suspicious activity patterns, geographic fence breaches, or other definable security events. The account's authorization parameters may be automatically updated to revoke transaction signing authority from expired or invalidated devices.

Revocation of a device's account access may be effected through a revocation record added to the blockchain in accordance with at least one embodiment. The revocation record may be cryptographically signed by one or more devices having revocation authority as specified in the account's authorization parameters. Upon the revocation record being incorporated into the blockchain, signatures from the revoked device may no longer be considered valid for transaction authorization. The secure hardware element containing the revoked device's private key may optionally receive a secure destruction command causing the stored private key to be invalidated or securely erased.

### Adding Devices to an Account

In various embodiments, a blockchain-based account management system may enable secure multi-device access through implementation of device-specific cryptographic controls. Each device seeking to access an account may be assigned its own cryptographic key pair, which may be registered with the blockchain through one or more registration records. The system may permit any number of devices to be associated with a single account, with each device maintaining independent signing capabilities.

According to certain embodiments, device registration may be implemented through an atomic chain of blockchain records. The atomic chain may include, but is not limited to: a device creation record specifying a new public key, a device acceptance record signed by an authorized key of the account, and optionally one or more device configuration records specifying permissions and limitations. The atomic chain structure may ensure that all elements of device registration are completed as a single atomic operation, preventing partial or incomplete device registrations.

In particular embodiments, device permissions may be controlled through key-value storage associated with each device record on the blockchain. The key-value storage may specify transaction limits, permitted operation types, and other access controls. These permissions may be queried and enforced by an authorization subroutine that may be referenced by the account's authorization filter, ensuring that device permissions are enforced consistently across all blockchain operations.

According to various embodiments, the system may implement a secure device addition protocol requiring physical proximity between devices. A new device may scan a QR code displayed by an authorized device, where the QR code may encode a URL containing a device creation kernel and other registration parameters. The URL may include a unique identifier that expires after a configured time period, preventing replay attacks or delayed registration attempts.

In some embodiments, the blockchain may maintain a cryptographically-secured registry of all devices through a series of linked records and annotations. Each device record may reference preceding device records through cryptographic hashes, creating an auditable chain of device additions and removals. The registry structure may enable efficient verification of device authorization while maintaining the security properties inherent to the blockchain's consensus mechanism.

According to certain embodiments, the system may implement real-time synchronization through a message queue architecture. Updates detected through blockchain monitoring may be propagated to a message queue, which may then distribute updates to all active devices. The message queue may implement at-least-once delivery semantics, ensuring that no device updates are missed while handling temporary device disconnections or network issues.

In particular embodiments, device revocation may be implemented through blockchain records that reference specific device public keys. A revocation record may be added to the blockchain by any authorized device, causing the authorization filter to immediately reject any future transactions signed by the revoked device's key. The revocation record may optionally specify a revocation reason code and timestamp for auditing purposes.

According to various embodiments, transaction signing requirements may be enforced through smart contract logic embedded in the account's authorization filter. The smart contract may evaluate transaction parameters against configured thresholds and may require signatures from specific combinations of device keys based on transaction type, value, or other criteria. The authorization filter may be updated through appropriate blockchain records to modify these requirements as needed.

In some embodiments, device backup functionality may be implemented through encrypted key storage on the blockchain. A device's private key material may be encrypted with a backup key derived from user-provided credentials, with the encrypted backup being stored in the key-value store associated with the device record. Recovery may require both possession of the backup credentials and completion of additional verification steps configured for the account. Security model

In accordance with at least one embodiment of the present invention, a security model for account registration and recovery may be implemented within a digital transaction system. The security model may incorporate one or more multi-stage verification processes incorporating various combinations of communication channels and authentication factors. In at least one embodiment, when a user initiates account registration, the system may generate a unique device identifier and corresponding cryptographic key pair, where the private key portion may be securely stored on the user's device. The system may then initiate a verification sequence whereby one or more verification codes may be transmitted to one or more communication endpoints associated with the registering user, such verification codes being required to be correctly entered within a configurable time period before account creation is completed. The verification process may optionally include transmission of verification codes via multiple independent channels, such as SMS messages to a phone number and separate verification codes sent via email, with successful account creation being contingent on correct entry of multiple distinct verification codes.

Account recovery functionality may be implemented with additional security constraints to prevent unauthorized access. In at least one embodiment, account recovery may be blocked for a configurable time period after any modification to critical account details such as phone numbers or email addresses. The system may maintain a record of previously-validated communication endpoints, and may require verification through both current and previously-validated channels before permitting account recovery. Additionally, the system may implement a “cooling off” period after any recovery attempt, during which certain high-risk account activities may be restricted. The system may also track failed recovery attempts and implement progressive security measures, such as requiring additional verification factors or extending mandatory waiting periods after multiple failed attempts. In some embodiments, recovery attempts may be restricted based on geographic location, with attempts from new or suspicious locations triggering enhanced verification requirements.

Security measures may be further enhanced through the optional implementation of device-specific restrictions. In at least one embodiment, the system may maintain a record of authorized devices associated with each account, with each device being assigned a unique cryptographic identifier. Account recovery procedures may optionally require the presence of an existing authorized device, or may implement additional verification steps when recovery is attempted from a new device. The system may also provide functionality to revoke authorization from specific devices, and may implement a configurable delay period before a newly-authorized device can initiate certain high-risk transactions or account modifications. Additionally, the system may provide mechanisms for users to review and manage their authorized devices, including the ability to view device activity history and receive notifications of new device authorizations or suspicious activity patterns.

### Secure Account Recovery

In accordance with various embodiments of the present invention, a secure account recovery system may be implemented within a distributed computing environment that includes both centralized and decentralized components. The system may incorporate a plurality of security measures designed to prevent unauthorized account access while maintaining accessibility for legitimate users requiring account recovery services. Such security measures may be implemented across multiple system layers, including but not limited to application interfaces, centralized servers, distributed ledger networks, and client devices.

One or more embodiments may implement a comprehensive notification system that transmits status updates through multiple independent communication channels whenever account-modifying operations are initiated. Each notification may be transmitted to all communication endpoints historically associated with the account, including but not limited to phone numbers, email addresses, and authorized devices. The content of such notifications may include, in various embodiments, detailed descriptions of the specific changes being made to the account, timestamps of the activities, information about the requesting device or location, and instructions for halting unauthorized changes through appropriate security protocols.

The system may maintain, in accordance with at least one embodiment, a temporal database of historical account data that persists beyond subsequent modifications. When account data such as communication endpoints are altered, the system may retain previous values in an active but deprecated state for a configurable retention period. During this retention period, these deprecated communication endpoints may continue to receive critical security notifications, including but not limited to notifications about additional account changes, recovery attempts, or security-relevant activities. The retention period may be configurable at multiple levels, including but not limited to system-wide settings, issuer-specific settings, or individual account settings.

Various embodiments may implement a progressive authorization system for newly added communication endpoints. Such a system may enforce a configurable “change delay” period during which new communication endpoints are restricted from participating in sensitive security operations. The change delay period may begin when a new communication endpoint is added to an account and may persist for a duration that can be configured based on multiple factors, including but not limited to risk assessment scores, account history, or issuer policies. During this period, the new endpoints may be prohibited from receiving one-time passwords (OTP), authentication codes, or other security credentials used in account recovery or high-risk operations.

According to certain embodiments, modifications to account security credentials may trigger enhanced security protocols. Such modifications may include, but are not limited to, changes to PINs, passwords, security questions, or biometric credentials. The enhanced protocols may require multiple forms of authentication, including but not limited to OTP verification through existing communication endpoints, biometric verification, or manual review. Following such modifications, the system may impose a configurable lockout period during which account recovery to new devices is prohibited, regardless of the ability to provide valid credentials.

One or more embodiments may implement a secure cross-device synchronization protocol for managing security credentials across multiple authorized devices. When credential modifications occur on one device, the protocol may initiate a secure synchronization sequence that includes validation of device authorization status, secure transmission of updated credential data, and verification of successful synchronization. The protocol may incorporate mechanisms for detecting and alerting users to potentially unauthorized credential changes, including but not limited to push notifications, in-application alerts, or forced authentication challenges.

Various embodiments may implement a configurable monitoring system for newly authorized devices. The monitoring system may define an observation period that begins when a new device is added to an account. During this period, which may range from zero time to an indefinite duration, the system may generate comprehensive activity notifications that detail all operations performed by the new device. These operations may include activities at multiple system layers, including but not limited to application-level actions, centralized service operations, or blockchain transactions. The notifications may be transmitted through all available communication channels to maximize the probability of detection of unauthorized activities.

In accordance with at least one embodiment, the system may implement dynamic operational restrictions triggered by sensitive account modifications. Such restrictions may limit the types and quantities of operations that can be performed during designated cooling-off periods. The specific restrictions and durations may be configurable based on multiple factors, including but not limited to the type of modification made, risk assessment scores, or historical account patterns.

Various embodiments may implement a staged activation process for newly added devices. The process may include a mandatory waiting period during which the new device has limited or no operational capabilities. During this period, existing authorized devices may retain the ability to reject or remove the new device. The system may also implement automatic account freezing mechanisms triggered by patterns of device addition that match known attack signatures. The duration of the waiting period and the specific limitations imposed on new devices may be configurable based on multiple factors, including but not limited to account history, risk assessment scores, or issuer policies.

According to certain embodiments, the security measures described above may be implemented redundantly across multiple system layers, including but not limited to application logic, centralized service protocols, and blockchain-based authorization filters. The blockchain implementation may utilize smart contracts or other programmable elements to enforce security policies directly within the distributed ledger network, providing an additional layer of security that operates independently from centralized systems. This multi-layer security approach may help maintain system integrity even in scenarios where one or more security layers are compromised.

In accordance with various embodiments, the system may implement location-based security protocols during account recovery and device addition processes. Such protocols may incorporate geolocation data obtained from multiple sources, including but not limited to GPS coordinates, IP address geolocation, cellular tower triangulation, or wireless network identifiers. The system may enforce configurable geographical boundaries within which sensitive operations may be performed, with such boundaries potentially being defined by polygon coordinates, jurisdictional borders, or proximity to previously validated locations.

One or more embodiments may implement device authentication restrictions that limit the methods by which new devices may be authorized. Such embodiments may require that devices receiving full account permissions can only be added through direct device-to-device communication channels, such as but not limited to QR code scanning or near-field communication. The system may specifically prohibit the transmission of device authorization credentials through potentially vulnerable channels such as email or SMS messaging.

Various embodiments may incorporate application authentication protocols that verify the legitimacy of client applications attempting to access the system. Such protocols may require that application code be cryptographically signed using developer keys, with the corresponding public keys being validated during sensitive operations. The system may maintain configurable retry limits for authentication attempts, with such limits potentially applying to PIN entries, password attempts, or one-time password validations. Failed authentication attempts exceeding these limits may trigger progressively increasing lockout periods.

According to certain embodiments, the system may implement a comprehensive graphical user interface (GUI) specifically designed to prevent social engineering attacks. Such interfaces may include, but are not limited to, prominent warning messages regarding the dangers of adding unauthorized devices, mandatory confirmation screens displaying detailed device information, and persistent notifications regarding recent device additions. These GUI elements may be displayed for configurable time periods and may require explicit user acknowledgment.

One or more embodiments may implement visual security indicators that help users identify official applications and distinguish them from potentially malicious ones. Such indicators may include, but are not limited to, verification badges, security watermarks, or dynamic visual elements that are difficult to replicate. The system may also display the domain name and SSL certificate information of any server requesting sensitive operations, potentially including visual representations of how this information should appear on various device types.

Various embodiments may incorporate manual intervention capabilities for high-risk scenarios or emergency situations. Such capabilities may include, but are not limited to, customer service interfaces for investigating suspicious activities, compliance officer dashboards for monitoring recovery patterns, and administrator tools for manually unfreezing accounts. The system may enforce configurable limits on automated recovery attempts, potentially requiring human review after a specified number of failures.

In accordance with at least one embodiment, the system may implement a tiered recovery attempt tracking system. Such a system may monitor and regulate various types of recovery attempts, including but not limited to OTP validations, password resets, or device authorizations. The tracking system may maintain separate counters for different types of attempts, with configurable thresholds that may trigger additional security measures such as extended cooling-off periods, enhanced authentication requirements, or mandatory human review.

According to certain embodiments, the system may implement adaptive security measures based on risk assessment scores. Such scores may be calculated using multiple factors, including but not limited to geographical distance from known locations, time patterns of account usage, device characteristics, or network indicators. The system may automatically adjust security requirements based on these risk scores, potentially requiring additional verification steps, implementing stricter limitations, or triggering manual review processes.

One or more embodiments may implement secure storage mechanisms for recovery-related metadata. Such mechanisms may record and maintain detailed information about recovery attempts, including but not limited to timestamps, locations, device identifiers, and network characteristics. This metadata may be cryptographically protected and may be made available to authorized compliance personnel or law enforcement agencies in accordance with applicable regulations.

Various embodiments may implement emergency account recovery protocols that balance security requirements with legitimate user needs. Such protocols may include, but are not limited to, alternate verification methods for users who have lost access to primary authentication methods, multi-party authorization requirements for high-risk recovery attempts, or enhanced monitoring periods following emergency recoveries. The specific requirements and limitations of emergency recovery protocols may be configurable based on multiple factors, including but not limited to account type, risk assessment scores, or regulatory requirements.

### Identity Verification and Trust

Various embodiments of the present invention provide systems and methods for implementing secure identity verification and sharing within distributed network environments. The systems and methods may include one or more verification protocols that enable users to selectively share verified identity information while maintaining cryptographic security and personal data privacy. In accordance with various embodiments, the systems may implement multi-tiered identity propositions that segment different categories of identity information, with certain data elements being stored in plain text format while sensitive personal information is maintained in cryptographically hashed formats. The systems and methods may further incorporate one or more trusted verification networks, secure communication channels, distributed ledger implementations, and configurable user interfaces for managing identity verification status and related workflows.

Implementations of the present invention may provide significant advantages over conventional identity verification systems by enabling users to reliably verify counterparty identities through the attestations of trusted verification entities, while maintaining granular control over which specific identity information elements are shared with each counterparty. Such systems may allow a first user to share only selected portions of their verified identity information with a second user, while enabling the second user to cryptographically confirm that those selected portions have been validated by one or more trusted verification entities. This selective sharing capability may be combined with various trust establishment mechanisms, potentially allowing users to determine which verification entities they consider trustworthy and to validate that specific pieces of shared identity information have been verified by those trusted verification entities. The systems and methods may thus enable confident identity verification between parties who have no direct relationship, while preserving privacy and preventing unnecessary exposure of sensitive personal information.

### Identity Confirmation Process

In accordance with various embodiments described herein, systems and methods may be provided for enabling secure sharing of verified identity information between users within a distributed network, while maintaining confidentiality of sensitive personal data. The systems and methods may implement protocols whereby a first user can selectively share verified identity information with a second user, while preventing unauthorized access to this information by other network participants.

According to one or more embodiments, an identity proposition may be generated by or on behalf of the first user prior to any sharing of identity information. The identity proposition may segment identity information into multiple tiers or categories, with certain information being declared publicly while other information remains confidential. For example and without limitation, jurisdiction information may be stored in plain text format within the identity proposition, while personal identifying information-such as name, physical address, contact details, government identification numbers, and biometric data—may be stored in a cryptographically hashed format. The identity proposition may further include references to supporting documentation, which may comprise: government-issued identification documents, proof of address documents, biometric data records, blockchain account identifiers, and complete sets of unhashed identity data, among other forms of verification materials.

Various embodiments may permit the first user to authorize one or more trusted verification entities to evaluate and submit cryptographically-signed decision records regarding the identity proposition. The supporting documentation referenced by the identity proposition may be encrypted using public keys associated with the designated trusted verification entities. In at least one embodiment, the first user may attach an incentive payment or fee to the identity proposition to encourage timely review by the trusted verification entities. The size and format of such incentive payments may be configurable according to various parameters including, but not limited to: speed of verification required, complexity of verification task, number of trusted verification entities desired, and risk level of the identity claim.

Upon receiving an identity proposition for review, a trusted verification entity may execute one or more verification procedures according to various embodiments. These procedures may include, without limitation: retrieving the identity proposition from a distributed ledger, accessing the encrypted supporting documentation from a distributed storage system, decrypting the supporting documentation using the trusted verification entity's private key, independently calculating cryptographic hashes of the unhashed identity information contained within the supporting documentation, comparing the independently calculated hashes against the hashes included in the identity proposition, evaluating the authenticity and validity of supporting documentation, cross-referencing identity claims against government databases, public records, and other authoritative data sources, and performing additional verification steps according to predetermined security protocols.

In various embodiments, upon completing the verification procedures, the trusted verification entity may record their determination by adding a signed decision record to the distributed ledger in association with the original identity proposition. The decision record may indicate either an affirmative or negative determination regarding the accuracy and validity of the identity claims. In some embodiments, the decision record may include multiple determination factors, confidence scores, or graduated levels of verification rather than a simple binary determination. The decision record may be cryptographically linked to both the identity proposition and the trusted verification entity's own identity credentials within the distributed ledger.

According to certain embodiments, when the first user wishes to share verified identity information with a second user, their system may generate a message containing relevant account details and unencrypted identity information. This message may be encoded using one or more standardized formats, including but not limited to: binary data structures, uniform resource locators (URLs), Quick Response (QR) codes, or other machine-readable formats. The message may be transmitted via any suitable communication channel or combination of channels, such as: secure network connections, encrypted messaging services, email systems, wireless data transmissions, or optical scanning of displayed codes. The specific combination of encoding formats and communication channels may be selected based on security requirements, user convenience, and technical constraints of the deployment environment.

Various embodiments provide mechanisms whereby, upon receiving a shared identity message, the second user's system may authenticate and validate the contained information through a multi-step process. This process may include: decoding the received message, retrieving the associated account details and confirmed identity proposition from the distributed ledger, verifying the cryptographic signatures of any trusted verification entities who have attested to the identity proposition, confirming that at least one of the attesting trusted verification entities is also trusted by the second user, and validating that the unencrypted identity information provided in the message matches the cryptographically hashed information stored in the verified identity proposition.

In accordance with some embodiments, the second user may request supplementary verification directly from one or more trusted verification entities who have previously attested to the first user's identity. The first user may facilitate this process by including with their identity sharing message a cryptographically-signed authorization permitting specific trusted verification entities to share supporting evidence with the second user. Upon receiving both this authorization and a request from the second user, the trusted verification entity may establish a secure communication channel separate from the distributed ledger to share additional verification materials and supporting documentation directly with the second user.

Various embodiments of the described systems and methods may be implemented using different combinations of computing hardware, secure elements, and software components. These components may include, without limitation: mobile computing devices, personal computers, server systems, distributed ledger nodes, hardware security modules, cryptographic accelerators, secure enclaves, trusted execution environments, and data communication networks. The specific technical implementation may be tailored to particular security requirements, performance needs, and operational constraints while remaining within the scope of the invention as described herein.

### Verification Confirmation Flow

In accordance with various embodiments of the present invention, methods and systems may be implemented to enable secure sharing and verification of identity information between a first user and a second user on a blockchain network. The first user's digital wallet application, which may be implemented on a mobile device, desktop computer, or other computing platform, may construct a digital message containing account information and identity information. This message may comprise one or more data fields including, but not limited to: personal identification data, account addressing information, blockchain account identifiers, verification status indicators, timestamps, digital signatures, jurisdiction indicators, and zero or more additional identity-related data elements. The message may be encoded in various formats, including but not limited to: binary format, URL-encoded format, QR code format, or other suitable digital encoding schemes.

The second user's digital wallet application may, upon receipt of the message described above, decode and process the received message using one or more cryptographic protocols to extract the included information. The wallet application may then initiate one or more queries to one or more blockchain networks to retrieve verified identity propositions associated with the first user's blockchain account address. Such verified identity propositions may comprise various data elements including, but not limited to: one or more cryptographic hashes of identity information, jurisdiction information, verification status indicators, timestamps, block heights, trusted verification entity signatures, and zero or more records of verification decisions made by one or more trusted verification entities. The blockchain queries may be executed via direct node connections, remote procedure calls (RPCs), application programming interfaces (APIs), or other suitable blockchain interaction mechanisms.

In at least one embodiment, the second user's wallet application may perform validation of the received identity information through a multi-step process. The wallet application may generate one or more cryptographic hashes of specific portions of the identity information received in the message, employing the same cryptographic hashing algorithm or algorithms previously used to generate the hash or hashes stored in the blockchain. The wallet application may then execute a comparison between each newly generated hash and its corresponding hash retrieved from the blockchain's verified identity proposition. A match between these hash values may serve as cryptographic proof that the identity information shared in the message corresponds precisely to the information that was previously verified and recorded on the blockchain. The hashing algorithms used may include, but are not limited to: SHA-256, SHA-3, KECCAK-256, or other suitable cryptographic hash functions.

The second user's wallet application may further verify that one or more trusted verification entities have confirmed the identity information by examining verification records stored within the blockchain's distributed ledger. These verification records may comprise various elements including, but not limited to: cryptographic signatures from trusted verification entities, verification timestamps, block height indicators, verification status flags, credential information, jurisdiction data, and other verification metadata. The wallet application may be configured to establish trust in verification entities based on one or more criteria, which may include but are not limited to: computational reputation scores, regulatory status indicators, inclusion in dynamic trusted verification entity lists, historical verification performance metrics, jurisdiction-specific credentials, or other suitable indicators of verifier trustworthiness. The criteria for establishing trust may be updated dynamically based on various factors including regulatory requirements, system policies, or user preferences.

In some embodiments, the second user may initiate requests for supplementary verification information directly from one or more trusted verification entities that previously confirmed the first user's identity. The first user may include within their initial message one or more cryptographically-signed authorizations permitting specific trusted verification entities to share supporting evidence or additional verification details with the second user. These authorizations may be time-limited, scope-limited, or otherwise restricted. Upon receiving and validating such authorization, the trusted verification entity may transmit the requested verification information to the second user through one or more secure communication channels separate from the blockchain network. These secure channels may implement various encryption protocols, access controls, and authentication mechanisms to ensure confidentiality of the shared information.

The verification system described above may implement various security measures to protect against potential attacks or vulnerabilities. These security measures may include, but are not limited to: rate limiting of verification requests, mandatory timeouts between verification attempts, encryption of all transmitted data, validation of digital signatures, checking of message timestamps, verification of blockchain consensus, and monitoring for suspicious patterns of behavior. The system may also maintain audit logs of verification activities, implement automated threat detection, and provide mechanisms for revoking compromised credentials or blocking malicious actors.

### Additional Verification

Various embodiments of the present invention may implement supplementary verification procedures that extend beyond basic blockchain validation. In at least one embodiment, upon receiving shared identity information, a recipient's software application may be configured to initiate additional verification requests through secure verification protocols. Such protocols may enable direct communication between the recipient and one or more trusted verification entities that have previously validated the sender's identity information. These verification requests may be transmitted via encrypted communication channels that operate independently from the primary blockchain network, potentially utilizing separate cryptographic keys and security protocols.

In accordance with at least one embodiment, the initial identity-sharing message transmitted by the sender may incorporate one or more cryptographically-signed authorization records. These authorization records may be implemented as distinct blockchain records that specify permitted information-sharing parameters, including but not limited to: authorized trusted verification entity accounts, specific categories of evidence authorized for release, temporal constraints on the authorization, and cryptographically-secure recipient identifiers. The authorization records may be signed using the sender's private key and may incorporate additional cryptographic elements such as nonces, timestamps, or challenge-response values to prevent replay attacks or unauthorized reuse of the authorization.

Upon cryptographic validation of the sender's authorization, trusted verification entities may initiate secure evidence-sharing protocols with authorized recipients. These protocols may incorporate various security mechanisms, which may include but are not limited to: end-to-end encryption of shared evidence, cryptographic proof of receipt, granular access control mechanisms, and secure audit logging of all evidence transfers. The evidence shared through these protocols may encompass various forms of verification artifacts, potentially including but not limited to: cryptographically-signed attestation certificates, verification metadata records, timestamped validation proofs, and encrypted copies of source verification documents.

Recipients' software applications may employ multi-stage verification protocols to confirm the correspondence between directly shared identity information and blockchain-recorded verification records. Such protocols may involve, but need not be limited to:

cryptographic hash chain validation, Merkle proof verification, digital signature validation using trusted verification entities' public keys, and temporal consistency verification of blockchain records. These verification procedures may be orchestrated by configurable validation engines that execute deterministic verification rules while maintaining cryptographic integrity throughout the verification process.

Embodiments may implement hierarchical security architectures around evidence-sharing protocols. Such architectures may incorporate multiple security layers, potentially including but not limited to: hardware security module integration for cryptographic operations, multi-signature authorization requirements for evidence release, time-locked access control mechanisms, cryptographic proof of deletion capabilities, and distributed audit logging across multiple secure storage systems. The specific security mechanisms activated within the hierarchy may be determined through dynamic policy engines that evaluate multiple risk factors including but not limited to: jurisdictional requirements, participant risk profiles, evidence sensitivity classifications, and system threat assessments.

### Merkle Tree Encoding

In accordance with various embodiments of the present invention, an identity confirmation system may store identity data in a Merkle tree data structure, rather than as an array of independent hash values. The Merkle tree implementation enables selective sharing of individual identity elements while maintaining cryptographic verification capabilities. The identity elements may comprise any number of identity-related data points, including but not limited to personal information, contact details, government identifiers, biometric data, and address information.

In one or more embodiments, validation of any individual identity element may be accomplished through provision of the specific data element in combination with a corresponding Merkle proof. The Merkle proof may comprise the identity element together with a set of branch hashes forming a path to a Merkle root hash value. In various implementations, the blockchain may store only the Merkle root hash within an account annotation or other blockchain data structure, thereby reducing on-chain storage requirements while maintaining cryptographic verifiability of individual elements.

The Merkle tree structure may implement standardized ordering and positioning of identity elements in various embodiments. Each possible identity element may occupy a designated position within the tree structure based on the type and nature of the identity data. In some implementations, the Merkle tree may be intentionally constructed with an unbalanced structure to enable co-location of frequently co-shared identity elements within adjacent or nearby branches, thereby optimizing proof generation for common sharing patterns.

One or more expansion branches may be incorporated within the Merkle tree structure in certain embodiments. An expansion branch may be configured to accommodate future addition of identity elements not contemplated in the initial tree design. The expansion branch architecture may support theoretically unlimited expansion in some implementations through strategic placement within an intentionally unbalanced tree structure. The expansion capability may be particularly valuable for accommodating new types of identity elements that emerge due to regulatory changes or technological advancement.

In various embodiments, the Merkle tree may incorporate one or more dedicated biometric encoding branches. These specialized branches may store multiple biometric data objects, with each object potentially comprising encoding data, encoding standard identifiers, and metadata describing the type of biometric information encoded. The biometric branches may support integration with facial recognition systems, fingerprint scanners, retinal scanners, or other biometric verification mechanisms to enable enhanced identity confirmation and access control.

Various implementations may incorporate protective measures to prevent information leakage about non-shared identity elements when sharing occurs. Empty data fields within the Merkle tree may be populated with cryptographic salt values to prevent inference of field emptiness from the tree structure. In implementations where all fields contain valid data, the entire tree may potentially be secured using a single salt value while maintaining the desired privacy properties.

The Merkle tree implementation may enforce standardization of structure and element positioning across different system implementations. This standardization enables interoperable proof generation and verification between disparate systems without requiring transmission of tree structural information. Specific branches of the tree may be designated for particular categories of identity information in a standardized way—for instance, dedicating certain branches to basic contact details, others to government-issued identifiers, and others to biometric encoding data.

### Additional Merkle Tree Technical Details

In various embodiments, the system may store and manage profile information associated with users. The profile information may comprise multiple distinct elements that together form a complete user profile, with these elements being capable of independent storage, processing, and verification either individually or in various combinations.

According to certain embodiments, the profile information elements may include one or more identifiers such as an account number (“accNo”) that uniquely identifies the user within the system, one or more physical address components (which may include, but are not limited to, building identifiers, street addresses, city designations, state or province indicators, postal codes, and/or country designations), and one or more personal identification elements (which may comprise personal names, family names, company names, and/or other identifying information).

Various embodiments may include one or more contact information components within the profile elements, such as mobile numbers, email addresses, or other contact identifiers. The profile elements may additionally or alternatively include one or more visual identification components, such as an image UR1 (Uniform Resource Identifier) that references a profile image or other visual identifier associated with the user. Each of these elements may be stored and processed independently while maintaining appropriate linkages to the user's profile.

According to some embodiments, each profile information element may be associated with one or more pieces of metadata, such as verification statuses, timestamps, access controls, privacy settings, or other attributes that help track and manage the element's status within the system. These metadata associations may be maintained independently for each element while preserving logical relationships between related elements. The specific elements and metadata included in any particular implementation may vary based on system requirements, user preferences, security considerations, and/or other factors.

According to various aspects of the present disclosure, a profile verification system and method may implement a Merkle tree data structure to achieve secure and efficient verification of digitally stored profile elements. The Merkle tree may comprise a plurality of cryptographically linked nodes arranged in a hierarchical structure, wherein each non-leaf node stores a cryptographic hash derived from its respective child nodes, and wherein leaf nodes contain hashes of individual profile data elements.

In one or more embodiments, the Merkle tree structure may culminate in a root hash value that functions as a unique cryptographic fingerprint representing the collective state of all profile information elements. This root hash may be systematically computed through iterative hashing operations performed on adjacent pairs of nodes progressing upward through the tree hierarchy. The root hash may exhibit strict uniqueness properties such that any alteration, however minor, to any underlying profile element would necessarily propagate through the tree structure to produce a distinctly different root hash value, thereby ensuring tamper evidence.

According to certain implementations, one or more distributed ledger networks may maintain a record of Merkle root hashes associated with user profiles. The root hash may be recorded in various ways, including but not limited to: inclusion in blockchain transactions, storage in smart contract state variables, or registration in designated profile verification contracts. This distributed storage approach may create an immutable and decentralized source of verification truth against which subsequent proofs can be validated by any party with access to the blockchain network.

Embodiments of the present disclosure may enable selective sharing of profile information while preserving the ability to cryptographically demonstrate data authenticity. When sharing profile elements, a user's system may generate and transmit: (1) the requested data elements, (2) corresponding Merkle proofs comprising strategically selected hash values from the tree structure, and (3) metadata identifying the specific blockchain record containing the authoritative root hash. This collection of information may enable independent verification without requiring access to the complete profile dataset.

The tree structure may be configured to enable computationally efficient verification processes that maintain data privacy. A verifying party may confirm authenticity by: (1) computing leaf node hashes of received profile elements, (2) combining these with the provided Merkle proof values according to the tree structure, and (3) comparing the derived root hash against the blockchain-recorded value. This verification process may require only logarithmic computational complexity relative to the total number of profile elements.

Various implementations may incorporate performance optimizations including, but not limited to: parallel hashing operations, strategic caching of intermediate hash values, batch processing of multiple verifications, and compression of Merkle proofs. The system may dynamically select optimization strategies based on factors such as the number of elements being verified, available computational resources, and network conditions. These optimizations may substantially improve throughput while preserving the fundamental security properties of the Merkle tree structure.

According to further aspects, the system may support versioned profile updates by maintaining an ordered sequence of Merkle root hashes, each representing a discrete state of the profile data. Version control may be implemented through various mechanisms including: monotonically increasing sequence numbers, cryptographic timestamps, or chains of root hashes where each new version includes a reference to its predecessor. The blockchain storage layer may maintain this version history, enabling verification against historical profile states when required by specific use cases.

The foregoing Merkle tree implementation may be further enhanced through the use of specialized hash functions, custom tree balancing algorithms, or hybrid data structures combining Merkle trees with other cryptographic primitives. These enhancements may be selected based on specific requirements for verification speed, proof size, or security properties in different deployment contexts.

### Verification Display

In accordance with at least one embodiment of the present invention, a verification display system may be implemented within a digital wallet application, financial application, or similar software application that requires identity verification. The system may comprise one or more graphical user interface elements configured to display verification status information associated with user accounts, where such verification status information may be retrieved from one or more distributed ledger systems, centralized databases, or hybrid storage systems.

The verification display system may present verification status information through a multi-tiered interface hierarchy. In at least one embodiment, a primary verification status indicator may be displayed prominently within a main user interface screen, comprising one or more visual elements such as icons, badges, text indicators, or graphical representations that convey the current verification state of an account. The verification status indicator may, in some implementations, utilize a standardized visual language, potentially including color-coding where different colors represent different verification states. For instance, a first color (such as green) may represent a “verified” state, a second color (such as yellow) may represent a “pending verification” state, and a third color (such as red) may represent an “unverified” state. Additional colors or visual indicators may represent other states such as “verification expired,” “verification challenged,” or “verification revoked.”

In accordance with various embodiments, the verification display system may maintain and display a comprehensive record of trusted verification entities that have performed verification of a particular identity. Such a trusted verification entity information may be cryptographically signed by the relevant entities and stored within a distributed ledger or other secure data structure. The display of trusted verification entity information may include, but is not limited to, official institution names, registration or license numbers, jurisdiction information, timestamp data indicating when verifications were performed, specific credentials or authority under which verifications were conducted, security clearance levels, and temporal validity information such as expiration dates.

T The system may, in at least one embodiment, implement a contact management interface with integrated verification status functionality. When displaying contact information, the interface may present hierarchical verification indicators that show both current verification status and historical verification events. These indicators may utilize a standardized visual language consistent with the primary verification status display, potentially including machine-readable codes, cryptographic proofs, or other digitally verifiable elements that confirm the authenticity of the verification claims displayed.

In some embodiments, the verification display system may implement a weighted verification status model wherein different types of verification or different verifying entities may be assigned different trust scores or confidence levels. These scores or levels may be displayed through graduated visual indicators, potentially utilizing size, position, opacity, or other visual characteristics to convey relative importance or reliability of different verifications. The system may be configured to calculate and display aggregate trust scores based on multiple verifications from different entities.

The verification status display may, in various embodiments, implement an interactive layer that responds to user input events such as taps, clicks, or gesture controls. Upon detecting such interaction, the system may transition to a detailed verification view that exposes granular verification data, potentially including identity attestations, verification methodologies, underlying documentation, and cryptographic proofs. The system may implement role-based access controls to ensure that detailed verification data is only accessible to authorized viewers.

In at least one embodiment, the verification display system may incorporate a configurable privacy management subsystem that governs the visibility of verification information across different contexts and user relationships. The privacy management subsystem may implement granular controls allowing users to define custom visibility rules for different aspects of their verification status, potentially including rules based on contact groups, transaction history, or other relationship metrics. The subsystem may also manage the cryptographic keys or access tokens required to decrypt and display private verification details.

The system may also include, in various embodiments, an event monitoring and notification subsystem that tracks changes in verification status and related metadata. This subsystem may generate and display time-sensitive alerts regarding verification events such as status changes, approaching expiration dates, or required reverification procedures. The notification subsystem may implement priority levels for different types of verification events and may integrate with external notification systems such as email, SMS, or push notification services. Notifications may include actionable elements that allow users to initiate verification-related workflows directly from the notification interface.

### Secure Application Login

In accordance with various embodiments of the present invention, methods, systems, and computer-readable media are provided for managing authentication and application access through encoded references, such as, for example, URIs, URLs, quick-response (QR) codes or other optically-readable or electronically-transmissible identifiers. Various implementations may incorporate multiple authentication flows including, but not limited to, scanning of encoded authentication requests using mobile devices and direct website authentication through mobile devices. The authentication system may implement one or more security validation modules configured to detect and prevent unauthorized access attempts, including man-in-the-middle attacks, website spoofing attempts, and session hijacking, through various security measures such as, but not limited to, domain validation, and location verification.

Embodiments of the present invention may provide numerous technical advantages over conventional authentication systems. In various implementations, the systems and methods may enhance security through multiple coordinated protection layers while simultaneously improving user experience through streamlined authentication flows. The authentication system may enable selective sharing of personal information controlled by authenticating users, allowing for varying levels of pseudonymity while maintaining robust security protocols. Additional benefits may include, but are not limited to: reduced friction in cross-device authentication scenarios, enhanced protection against visual spoofing attacks through standardized security indicators, flexible session management supporting multiple authentication methods, and intelligent handling of application installation states when processing encoded references. The system may further provide mechanisms for managing branded download experiences when required applications are not present on authenticating devices, potentially incorporating customized visual themes, content templates, and dynamic adaptation based on device characteristics.

### Basic Login Flow

In accordance with various embodiments of the present invention, methods, systems, and computer-readable media are provided for secure authentication of users to network-accessible resources. The authentication may be performed using a mobile device application operating in communication with one or more server systems, whereby a first device displaying authentication information may be used to authenticate a second device requesting access to secured resources.

In at least one embodiment, a user may visit a login uniform resource locator (URL) of a website using a web browser executing on a first computing device. Upon accessing the login URL, the web browser may receive and display a webpage containing an encoded authentication request in the form of a machine-readable optical code, such as a quick response (QR) code, other two-dimensional barcode, or other encoded authentication request, such as a URL or UR1 or other encoded element. The encoded authentication request may include, but is not limited to, a reference to a login application programming interface (API) endpoint, information identifying the network resource requesting authentication, authentication requirements or preferences, and in some embodiments, cryptographic nonce values or other security-related parameters.

The webpage displayed by the web browser may, in some embodiments, establish a WebSocket connection or other bidirectional communication channel with an authentication server. The bidirectional communication channel may be maintained in an open state while awaiting completion of the authentication process. Various implementations may utilize different types of persistent network connections between the webpage and authentication server, including but not limited to server-sent events, long polling, or other real-time communication protocols.

In at least one embodiment, a user may scan the displayed authentication request using a mobile wallet application executing on a second computing device, such as a mobile device equipped with an optical sensor. The mobile wallet application may decode the machine-readable optical code to extract the encoded authentication information. In some embodiments, upon decoding the authentication request, the mobile wallet application may perform validation of the extracted information and display a prompt requesting the user to authorize authentication to the identified network resource.

The authorization prompt displayed by the mobile wallet application may include, in various embodiments, security-relevant information about the network resource requesting authentication, such as the domain name, security certificate information, certificate authority details, geographic location information, and/or other identifying or contextual details that may help the user make an informed authorization decision. The mobile wallet application may present interface elements allowing the user to review this information and explicitly authorize or deny the authentication request.

Upon receiving user authorization through the mobile wallet application, in accordance with at least one embodiment, the authentication server may create a new authenticated session associated with the user's identity. The server may generate a cryptographically secure session identifier and transmit it to the web browser via the previously established bidirectional communication channel. Various implementations may utilize different types of session identifiers, token formats, and methods of transmitting the session information while maintaining security requirements.

In at least one embodiment, the webpage, upon receiving the session identifier through the bidirectional communication channel, may create one or more secure browser cookies or other local storage objects containing the session information. The webpage may then perform a redirect operation to navigate the web browser to an authenticated area of the website, such as a user dashboard or other secured resource. In some embodiments, the redirection may occur automatically upon receipt of valid session credentials without requiring additional user interaction.

The authentication system described herein may, in various embodiments, be implemented with additional security measures such as multi-factor authentication requirements, hardware security module integration, biometric validation, anomaly detection, different types of persistent connections, alternative session management approaches, and other variations in the specific implementation details while maintaining the core secure authentication flow. The specific security measures implemented may be selected based on the security requirements of the particular deployment environment.

### Security Features

In accordance with at least one embodiment of the present invention, a secure website login system may be implemented whereby a user visiting a login webpage may scan a Quick Response (QR) code displayed on that webpage using a mobile device. The QR code displayed on the webpage may incorporate various security elements used to authenticate the login attempt and protect against various attack vectors including, but not limited to, man-in-the-middle attacks, phishing attacks, and session hijacking attempts.

The QR code may encode, in at least one embodiment, a Uniform Resource Locator (URL) containing multiple security-related data elements. These elements may include, but are not limited to: an origin domain identifier used to verify the authenticity of the application processing the scan; an expiration timestamp specifying a validity period for the login attempt; an Internet Protocol (IP) address identifying the system that requested the QR code; geographical location information derived from the requesting IP address including political jurisdiction and latitude-longitude coordinates; and a unique hash value that should match a corresponding value recorded by the authentication server. The QR code may additionally encode references to one or more authentication API endpoints that the mobile device may use to complete the authentication process.

In at least one embodiment, the expiration timestamp encoded within the QR code may be specified in Coordinated Universal Time (UTC) to avoid time zone-related authentication issues. The server may be configured with a maximum validity period for QR codes, after which they cannot be used for authentication regardless of the encoded expiration timestamp. This validity period may be adjusted based on various factors including, but not limited to, the perceived risk level of the login attempt, historical patterns of legitimate login attempts, and current system load.

Upon scanning the QR code, the mobile application may present a security verification interface to the user. In at least one embodiment, this interface may prompt the user to verify that the domain name displayed in their web browser exactly matches the origin domain encoded within the QR code. The interface may additionally display a map showing the geographical location associated with the IP address that requested the code, and may optionally warn the user if this location differs substantially from the mobile device's current location. The mobile application may be configured to require explicit user confirmation that they have verified these security elements before proceeding with the authentication attempt.

The mobile application may additionally provide visual aids to assist users in verifying the authenticity of the login attempt. In at least one embodiment, these aids may include a representation of how the domain should appear in various web browsers and operating systems, helping users identify potential visual spoofing attacks. The application may also maintain a history of previously-verified domains and alert users if the current domain differs from their usual login patterns.

The authentication server may implement various security validations when processing the login attempt. In at least one embodiment, the server may verify that the IP address attempting to complete the login matches the IP address that originally requested the QR code. The server may additionally enforce velocity limits restricting the number of QR codes that may be requested from a single IP address within a given time period, helping to prevent automated attacks. These velocity limits may be implemented with various levels of granularity, potentially considering factors such as geographical location, time of day, and historical usage patterns.

Cross-Origin Resource Sharing (CORS) protections may be implemented by the server to prevent unauthorized domains from accessing the login resources. In at least one embodiment, the server may validate the origin header of any WebSocket connections to ensure they originate from the legitimate login webpage domain. The server may implement strict CORS policies that explicitly enumerate allowed origins, methods, and headers, rejecting any requests that do not conform to these policies. Additionally, the server may implement iframe protections to prevent the login interface from being embedded within malicious websites.

The server may maintain blacklists of IP addresses and domains associated with suspicious activity. In at least one embodiment, these blacklists may be updated dynamically based on observed attack patterns and may be shared among multiple server instances to provide distributed attack protection. The server may also implement rate limiting at various levels of granularity, potentially including per-IP, per-subnet, and per-geographic-region limits.

Following successful validation of the login attempt, the server may implement session ID rotation to further enhance security. In at least one embodiment, the initial session identifier encoded within the QR code may be replaced with a new session ID when returning the final authentication response. This new session ID may be generated using a cryptographically secure random number generator and may incorporate additional entropy sources. The new session ID may then be used to establish the authenticated user session, helping to prevent session fixation attacks.

The authentication process may include additional verification steps based on various risk factors. In at least one embodiment, these factors may include, but are not limited to: the geographical distance between the QR code request location and the authentication attempt location, the time elapsed between QR code generation and authentication attempt, and any anomalies in the user's login patterns. Based on these risk factors, the system may require additional authentication steps or apply more stringent validation rules.

The security elements described above may be implemented individually or in various combinations. In at least one embodiment, additional security measures may be added to further enhance the authentication process. The specific security features enabled for a particular deployment may be configured based on the security requirements of that installation. The system may also be designed to allow for the easy addition of new security features and the modification of existing security rules as new threats emerge.

### Anti-Spoofing Measures

In accordance with at least one embodiment of the present invention, a system and method may be implemented to protect against spoofing attacks during website authentication. The system may comprise one or more security validation modules configured to detect and prevent man-in-the-middle attacks, website spoofing attempts, and unauthorized session acquisition during a login process that utilizes quick-response (QR) codes or deep links for authentication.

In at least one embodiment, when presenting a login interface to a user, the system may analyze the user's device characteristics including, but not limited to, operating system type, browser vendor, browser version, and display parameters. Based on this analysis, the system may generate and display a visual representation of an expected secure URL bar specific to that device-browser combination. This visual representation may include one or more security indicators such as protocol identifiers, domain highlighting, extended validation indicators, and security icons in their exact expected positions and styling. The visual representation may be displayed adjacent to or in close proximity to the actual URL bar to facilitate direct visual comparison by the user.

The system may incorporate one or more location-based security measures that operate independently or in conjunction with other security measures. When a login request is initiated, a location recording module may capture and securely store geographic coordinates and contextual location data from the originating device. This data may be obtained through various mechanisms including, but not limited to, IP geolocation, GPS coordinates, cellular triangulation, Wi-Fi positioning, or any combination thereof. The captured location data may include latitude, longitude, accuracy radius, timestamp, and confidence metrics.

A location visualization module may present the captured location data through an interactive map interface. In at least one embodiment, the map interface may display multiple location indicators, including but not limited to: the location of the original login request, the current location of the authenticating device, and optionally, previously authorized login locations for this user. The map visualization may incorporate different zoom levels, satellite imagery, street-level data, and interactive elements that allow users to verify location accuracy.

In at least one embodiment, a location analysis module may perform geometric and statistical analysis of the captured location data. The module may calculate the geodesic distance between the login request location and the current device location, evaluate the statistical probability of legitimate travel between the two points in the elapsed time, and consider historical login patterns. If any analyzed metrics exceed configurable thresholds, the system may execute one or more security responses, including but not limited to: displaying warning messages, requiring additional authentication factors, rate-limiting login attempts, or blocking the authentication attempt entirely.

The system may implement a location services management module that interacts with device-level location capabilities. Prior to completing authentication, this module may evaluate the availability and accuracy of location services on the authenticating device. In at least one embodiment, the module may present a series of permission requests that explain the security benefits of high-accuracy location data. These requests may be customized based on device type and operating system, and may include visual guides for enabling location services. The system may be configured with different security policies for devices with varying levels of location accuracy, including policies for devices where location services remain disabled.

A comprehensive iframe protection system may be implemented through multiple coordinated security layers. The system may generate and maintain Content Security Policy (CSP) directives that specify allowed sources for frames, scripts, styles, and other resources. In at least one embodiment, the system may implement dynamic CSP generation that creates unique policies for each authentication session. The system may also employ multiple header-based protections including, but not limited to: X-Frame-Options, X-Content-Type-Options, and Referrer-Policy headers. Additionally, the system may execute client-side JavaScript frame detection that can identify nested frame hierarchies, cross-origin frame relationships, and potential clickjacking attempts.

The system may incorporate a domain validation module that performs multi-factor domain analysis. When processing a login initiation request, whether from a QR code scan or deep link activation, the module may extract and validate domain information through multiple mechanisms. These may include, but are not limited to: comparing the initiating domain against the authentication domain, validating SSL/TLS certificate properties including certificate authority and extended validation status, evaluating domain age and reputation, and verifying DNS configurations. The domain validation module may execute these checks synchronously to block unauthorized domains or asynchronously to provide additional security signals during the authentication process.

In at least one embodiment, the various security measures may be managed through a security orchestration module that coordinates the operation of individual security components. This module may maintain security configurations, manage feature dependencies, and control the interaction between different security measures. The security orchestration module may provide interfaces for security administrators to configure individual measures, define security policies, and respond to detected threats. The module may also maintain audit logs of security decisions and provide reporting capabilities for security analysis.

### Display Elements

In accordance with at least one embodiment of the present invention, a mobile device application may implement an interface for authenticating users with network-accessible services. The application may include a display control module configured to render authentication and verification information in response to receiving authentication requests. These requests may be received by scanning encoded data such as a quick-response (QR) code, by receiving a uniform resource locator (URL), or through other data transmission mechanisms.

In at least one embodiment, the display control module may be configured to extract and prominently display domain name information from a secure socket layer (SSL) certificate associated with the requesting service. This domain information may be rendered in a manner that replicates the appearance of a web browser's address bar display, potentially including security indicators such as padlock icons, certificate authority indicators, or other visual elements that indicate the security status of the connection. The domain name may be displayed in a standardized font and format to assist users in verifying the authenticity of the requesting service. In some embodiments, the display may include additional metadata from the SSL certificate, such as the issuing authority or certificate expiration date.

Authentication requests processed by the mobile application may incorporate one or more data sharing preference indicators specified by the requesting service. These sharing preferences may be encoded within a hierarchical framework comprising multiple predefined authorization levels. In at least one embodiment, these levels may include, but are not limited to: a baseline “login only” or “pseudonymous” level wherein only authentication assertions are provided without additional personal data; an intermediate “email only” level wherein email address validation information may be transmitted; and an enhanced level that may encompass the sharing of email address information, physical address data, and telephone contact details. Additional levels incorporating different combinations of shareable data may be implemented in various embodiments.

The mobile application may implement an interface that presents these requested sharing levels while simultaneously providing mechanisms enabling the selection of reduced sharing levels compared to those requested by the service. For example, if a service requests the enhanced sharing level incorporating email, physical address and telephone information, the user interface may provide options to alternatively select the intermediate “email only” level or the baseline “login only” level. The interface may employ visual hierarchies, typography, and interactive elements to clearly distinguish between the requested sharing level and the available selection options. In some embodiments, the interface may implement progressive disclosure patterns to help users understand the implications of different sharing levels.

The sharing level interface may incorporate multiple visual and interactive elements indicating the specific categories and types of information associated with each sharing level. These elements may include, but are not limited to: iconographic representations, detailed textual descriptions, hierarchical information structures, or other indicators designed to enhance user comprehension of the data sharing implications. The interface may implement preview functionality enabling users to review the exact subset of information that would be transmitted before finalizing the authentication process. This preview may be updated dynamically as different sharing levels are selected.

In at least one embodiment, the mobile application may implement a persistent storage mechanism for retaining user preferences regarding sharing levels on a per-service or per-domain basis. These stored preferences may be utilized to provide intelligent suggestions or pre-selections for subsequent authentication requests from previously-encountered services while maintaining user agency to modify these selections. The storage mechanism may encrypt these preferences and implement appropriate security controls to prevent unauthorized access or modification.

### Personal Information Handling

In accordance with at least one embodiment of the present invention, a system and method for secure website authentication may incorporate selective sharing of personal information controlled by an authenticating user. The authentication system, which may be implemented via a server providing authentication services for one or more websites, may provide protocols and mechanisms whereby a website or other computer system requesting user authentication may indicate preferences or requirements regarding categories and quantities of personal information desired to be received from a user attempting authentication.

In at least one embodiment, an authentication request transmitted from a website to a mobile application or other software application executing on a user device may incorporate encoded parameters indicating a requested level of personal information sharing. Upon receipt of such an authentication request, the mobile application or other software application may present to the user via a graphical user interface a comprehensive enumeration of the specific categories of personal information that have been requested by the website. The application may clearly distinguish between optional and mandatory personal information fields within the display.

Various embodiments may incorporate multiple discrete authentication levels, which levels may correspond to differing quantities of personal information that may be shared with an authenticating website. Despite any specific categories of information that may have been requested by a website, the system may provide users the option to authenticate using a “pseudonymous” mode that minimizes personal information disclosure while still providing cryptographic proof of account control. In at least one embodiment, the pseudonymous mode may share only an account identifier or public key, while withholding other personal details that may have been requested.

The mobile application or other software application may present to the user, via a graphical user interface, a hierarchical arrangement of information sharing options. Such options may include, but are not limited to: (a) a “login only” option whereby no personal information beyond account verification is shared, (b) an “email only” option whereby only an email address is shared, and (c) a “full profile” option whereby comprehensive profile information is shared. In accordance with at least one embodiment, a user may select any available sharing option regardless of the level of information sharing originally requested by the website.

The system may implement protocols enabling secure website authentication without mandating disclosure of personal identifying information. For instance, the authentication process may verify a user's control over a blockchain account, digital wallet, or other cryptographic credentials through zero-knowledge proofs or similar cryptographic techniques, while maintaining user pseudonymity. This capability may enable websites to implement robust authentication protocols while preserving user privacy in circumstances where pseudonymity is desired or required.

Various embodiments may include data structures and processing logic to persist and retrieve a user's information sharing preferences on a per-website basis. Such preferences may be stored in encrypted form within secure storage on the user's device, potentially enabling consistent application of sharing preferences across multiple authentication attempts with the same website while maintaining user control over personal information disclosure. The stored preferences may be modified by the user at any time through the mobile application or other software application interface.

The selective information sharing mechanisms described herein may be implemented through one or more graphical user interfaces presented to the user via the mobile application or other software application. These interfaces may clearly indicate to the user what specific personal information would be shared as a result of proceeding with authentication under various sharing configurations. Visual indicators such as icons, colors, or other graphical elements may be employed to distinguish between different categories and sensitivity levels of personal information that may be shared.

### Authentication

In accordance with at least one embodiment of the present invention, a standardized authentication protocol may be implemented to secure communications between one or more client devices and one or more server systems. The protocol may employ JSON-RPC formatted messages transmitted via secure HTTP connections, where such messages may include one or more cryptographic signatures generated in accordance with one or more blockchain authentication schemes. The JSON-RPC messages may be structured to include, in various embodiments, a message identifier, a method name, a set of parameters, and one or more digital signatures appended to the message content.

The authentication process may include, in various embodiments, validation of one or more digital signatures attached to messages transmitted between the client device and server system. Such digital signatures may be generated using one or more private keys associated with a blockchain account, where the server system may verify the signature using a corresponding public key that has been registered on the blockchain network. The signature verification process may include, but is not limited to: confirming that the signature mathematically corresponds to the message content and the purported public key; verifying that the public key is associated with a valid account on the blockchain; and/or checking that the account has appropriate permissions to perform the requested operation.

In some embodiments, the server system may implement one or more validation criteria that should be satisfied before authentication is permitted to proceed. Such criteria may include, but are not limited to: verification that identity information provided by the client matches corresponding identity records stored on the blockchain; confirmation that the account associated with the authentication request maintains a minimum required balance of one or more specified token types; and/or validation that the account's identity information has been verified by one or more trusted verification entities on the blockchain network. The server system may maintain a configurable list of trusted verification entities whose attestations are considered valid for authentication purposes.

The server system may, in certain implementations, be configured to reject authentication attempts that fail to satisfy one or more of the validation criteria. Such rejection may occur even in cases where the digital signature accompanying the authentication request is cryptographically valid. The specific validation criteria applied may be configurable, such that different criteria may be required for different types of accounts, different token types, or different levels of access to the system. The server may maintain a hierarchy of access levels, each associated with its own set of required validation criteria.

In at least one embodiment, the authentication protocol may include mechanisms for transmitting identity information between the client device and server system in a secure manner. Such identity information may include, but is not limited to: account addresses, public keys, identity attestations, verification records, token balances, and/or other account-related data stored on the blockchain network. The transmitted identity information may be cryptographically signed to ensure its authenticity and integrity, and may optionally be encrypted to protect sensitive data during transmission.

The authentication system may implement, in various embodiments, a session management protocol whereby successful authentication results in the creation of a secure session identifier. Such session identifier may be transmitted to the client device and stored as a secure cookie or other persistent token. The session identifier may have a configurable expiration period, after which re-authentication would be required. The server system may maintain a database of active sessions, including metadata such as creation time, last access time, associated account information, and/or access level permissions.

In at least one embodiment, the authentication protocol may include rate limiting and security mechanisms to prevent unauthorized access attempts. Such mechanisms may include, but are not limited to: limiting the number of failed authentication attempts within a specified time period; implementing progressive delays between authentication attempts; maintaining a blacklist of IP addresses or accounts associated with suspicious activity; and/or requiring additional verification steps after detecting potential security threats.

The authentication system may provide, in some implementations, interfaces for administrative control and monitoring of authentication processes. Such interfaces may enable configuration of validation criteria, management of trusted verifier lists, review of authentication logs, and/or real-time monitoring of authentication attempts. Administrative actions may require multi-factor authentication and may be logged for audit purposes.

### Mobile-Specific Considerations

In accordance with at least one embodiment of the present invention, a system and method for authenticating users to a website may implement distinct authentication protocols based on the method by which authentication is initiated. The authentication flow may adapt dynamically based on whether the user accesses the authentication system via a mobile web browser, via a Quick Response (QR) code scan, or through another access method. The system may detect characteristics of the accessing device including, but not limited to, device type, operating system, browser type, and screen parameters, and may modify its authentication behavior accordingly.

In at least one embodiment, when authentication is initiated from a mobile web browser, a specialized URL scheme may be implemented that differs from authentication initiated via QR code scanning. Upon detecting access via a mobile browser, the system may generate a specialized URL containing authentication parameters. This URL, when activated, may cause a wallet application installed on the user's device to launch. The URL may incorporate one or more of: a session identifier, an authentication endpoint identifier, a domain identifier of the originating website, required authentication parameters, and a specification of identity information that the website requests the user to share.

The system may implement specialized state management to handle cases where users switch between browser and wallet applications during the authentication process. In at least one embodiment, when the wallet application is launched, the system may automatically minimize or hide the browser window to streamline the user experience. The system may maintain session state information allowing the authentication process to resume appropriately when the user switches between applications. This state information may be encrypted and may include timeout parameters to enhance security.

Authentication flows initiated via QR code scanning may incorporate additional security measures distinct from URL-based authentication. When processing a scanned QR code, the system may extract embedded authentication parameters and may perform validation steps including, but not limited to: verifying that the domain name encoded in the QR code matches the domain presenting the code, validating that the QR code has not expired, and confirming that the geographic location associated with the QR code request is within expected parameters. The system may present this validation information to the user in an intuitive format.

In at least one embodiment, the system may implement different security protocols based on the authentication initiation method. For URL-based authentication on a single device, the system may verify IP address consistency between the authentication request and the website access. For QR code scanning, which typically involves two separate devices, the system may instead focus on validating the relationship between the QR code request origin and the scanning device location. These security measures may be configurable based on the specific requirements of the implementation.

The system may incorporate multiple safeguards against potential manipulation of the authentication flow. These safeguards may include, but are not limited to: validating the origin of clicked URLs, implementing protections against programmatic QR code capture, detecting attempts to modify authentication parameters, and preventing replay attacks. In at least one embodiment, the system may implement rate limiting and other protective measures based on IP address, device identifier, or other characteristics that may indicate potential abuse.

Visual security indicators may be presented to users based on the authentication method employed. These indicators may include, but are not limited to: domain name verification displays, security certificate information, geographic location maps showing the authentication request origin, and visual representations of the time remaining before authentication expiration. The specific indicators presented may vary based on whether authentication was initiated via QR code or URL, and may be customized based on device capabilities and user preferences.

In at least one embodiment, the system may provide different fallback mechanisms depending on the authentication method. For URL-based authentication, the system may implement automatic retries or alternative authentication paths if the wallet application fails to launch. For QR code authentication, the system may provide alternative methods for entering authentication information manually. These fallback mechanisms may be configurable and may be adapted based on the specific security requirements of the implementation.

### Deep Links and Landing Pages

In various embodiments, a system and method may be provided for managing application download pages corresponding to encoded references, such as quick-response (QR) codes or other optically-readable or electronically-transmissible identifiers. Each encoded reference may include a uniform resource locator (URL) that incorporates both an application identifier indicating which software application, service or website originally generated the URL, and one or more function identifiers specifying particular functionality, features, or data within that application that should be accessed when the URL is activated. The application identifier and function identifiers may be encoded using various schemes, potentially including base32 encoding, base64 encoding, or other encoding methods that balance URL length with information density.

According to one or more embodiments, when a user activates such a URL (for instance by scanning a QR code with a mobile device camera, by clicking a link in a mobile web browser, or by receiving the URL through a wireless transmission), the system may first attempt to launch the identified software application directly to the specified functionality through a deep linking protocol implemented by the device operating system. This “deep linking” behavior may utilize operating system-specific mechanisms such as Universal Links on iOS devices or App Links on Android devices, allowing users who have already installed the appropriate software application to immediately access the intended feature or content without requiring any intermediate steps. The deep linking protocol may also pass along any contextual data or parameters encoded in the original URL to ensure the application can precisely recreate the intended functionality state.

In certain embodiments, if the system determines that the identified software application is not installed on the user's device, the URL activation may instead result in the display of a public webpage specifically configured for that encoded reference. The webpage may provide information about the particular functionality the user was attempting to access, potentially including descriptions, screenshots, or demonstrations of the feature. This contextual information may help users understand what capabilities they would gain by installing the software application. The webpage may also indicate what specific feature or content the user will be able to access after installing the application, potentially storing this intent in a secure, time-limited token that can be retrieved when the application is first launched.

According to various embodiments, each public webpage may be styled and configured based on the application identifier encoded in the URL. The system may maintain a registry service that maps application identifiers to corresponding visual themes, branding elements, and content templates. This registry service may be implemented as a distributed database with caching layers to ensure rapid response times when generating download pages. The service may also implement versioning and approval workflows to allow application providers to update their branding and content while maintaining consistent experiences for users. This may allow different software applications or organizations to maintain consistent branding and user experience even when users encounter their deep links without having the application installed.

In some embodiments, data defining the content and structure of each public webpage may be specified according to a structured data format, such as JavaScript Object Notation (JSON) Schema. The schema may define required and optional elements that may be included within the webpage, potentially including download links, branding elements, explanatory text, graphical elements, interactive components, and any other content that may be useful to guide users in obtaining and installing appropriate software. The schema may also specify how feature-specific content should be incorporated into the page based on the particular functionality referenced in the URL. The schema validation process may ensure that all required elements are present while allowing for flexible incorporation of optional elements based on the specific requirements of each application provider.

According to certain embodiments, the visual presentation of each public webpage may be controlled by one or more standardized visual themes associated with the application identifier. Such themes may define styling elements including, but not limited to, colors, fonts, spacing, layout, animations, transitions, and interactive behaviors. The themes may be implemented using cascading style sheets (CSS), JavaScript, or other web technologies, and may be configured to ensure consistent branding and user experience across multiple pages generated for the same software application. The theming system may support inheritance and override mechanisms, allowing application providers to customize specific aspects of the presentation while maintaining consistency in other areas.

In various embodiments, the content of each public webpage may be formatted and structured according to a standardized theming system that provides a framework for organizing and presenting content elements in a consistent manner. The framework may include predefined content blocks, layout templates, and component libraries that can be utilized to rapidly generate new public webpages while maintaining consistency. These components may be versioned and may implement progressive enhancement techniques to ensure appropriate functionality across different devices and browsers. The theming system may allow for customization of specific content, branding, and functionality based on both the application identifier and the specific feature or content referenced in the URL, while ensuring that all generated pages maintain a consistent structure and navigation pattern.

According to some embodiments, the system may provide a centralized registry service that maintains mappings between application identifiers and corresponding download locations, such as app store URLs or enterprise distribution endpoints. When generating a public webpage in response to a URL activation, the system may query this registry to obtain appropriate download links based on the application identifier. The registry service may support multiple download locations per application, potentially including different URLs for various device types, operating system versions, geographic regions, or user segments. This may allow software application providers to update their download locations or add new platform support without needing to modify existing encoded references or deep links.

In certain embodiments, the system may be configured to detect various attributes of the device attempting to access the encoded reference, potentially including the device type, operating system, browser capabilities, and geographic location. The system may use this information to automatically customize the public webpage content and download instructions appropriately. This may include providing platform-specific download links, displaying appropriate installation instructions, and offering alternative download methods when applicable. The system may also implement device fingerprinting or session tracking mechanisms to retain information about the original encoded reference, ensuring that users can be automatically directed to the intended functionality after installing and launching the application.

According to various embodiments, the system may support multiple different types of deep link functionality that may be encoded in the URL, such as sharing profile information between users, requesting or sending payments, viewing specific content or features, or accessing particular application states or workflows. The function identifiers in the URL may specify both the type of functionality being accessed and any parameters or data required to properly initialize that functionality. The public webpage generated when such URLs are accessed without the application installed may include contextual information specific to the type of functionality being accessed, helping users understand the value and purpose of installing the application. This contextual information may be generated dynamically based on the function identifiers and any associated parameters, potentially including personalized content or specific details about the intended interaction.

In various embodiments, as illustrated in FIG. 18, a system 1800 may be provided for managing the display and reading of payment codes or other encoded references, such as quick-response (QR) codes 1801 or other optically-readable or electronically-transmissible identifiers, which system may also implement a means for managing application download pages corresponding to encoded references. The system may include one or more display devices 1802 configured to present such encoded references and may interact with mobile devices 1804 that may be used to capture or access these references.

According to one or more embodiments, each encoded reference 1801 may be designed to trigger specific functionality depending on the state of the user's mobile device. If the corresponding software application is already installed, accessing the encoded reference—for instance, by using the mobile device camera 1803 to scan a QR code 1801 displayed on a display device 1802 or by clicking a URL in a mobile device web browser—may directly activate functionality within the application, such as initiating a payment, loading a specific feature, or displaying relevant content. Conversely, if the application is not installed, the encoded reference may redirect the user to a unique public webpage associated with the reference. This webpage would guide the user through the process of downloading and installing the application.

Open Transfers (i.e. Anonymous Transfers)

Various embodiments of the present invention provide systems and methods for transferring digital assets, including cryptocurrency tokens and other blockchain-based assets, to recipients who have not yet registered with or created accounts within the system. In accordance with at least one embodiment, these “open transfers” or “anonymous transfers” enable existing users to initiate transfers to potential new users by specifying only basic contact information, such as an email address or phone number, rather than requiring a pre-existing blockchain account address or system registration. When an open transfer is initiated, the system may generate one or more secure claim codes, which may be transmitted to the specified contact information of the intended recipient. These claim codes may have configurable expiration periods and may be required to be claimed within a specified timeframe, thus helping to ensure security and prevent indefinite pending transfers.

In accordance with various embodiments, potential recipients of open transfers may be prompted to register with the system and create their own blockchain accounts in order to claim transferred assets. This registration process may include various optional security measures, which may include, but are not limited to: identity verification, two-factor authentication, know-your-customer (KYC) procedures, and other compliance checks. The specific security measures required may be configurable based on various factors including, but not limited to: transfer amount, jurisdiction, risk level, and system policies. During the period before a transfer is claimed, the system may maintain pending open transfers in a secure holding state. The assets may be secured in one or more system-controlled accounts or smart contracts, helping to ensure that funds cannot be improperly accessed or redirected. The system may also maintain detailed records of all open transfers, including their current status, associated claim codes, and any attempts to claim them, thus providing a complete audit trail of all transfer activity.

The open transfer mechanisms described herein provide numerous advantages over traditional digital asset transfer systems. By enabling transfers to non-registered users, the system may facilitate organic network growth while maintaining security and regulatory compliance. The claim code mechanism helps ensure that only intended recipients can access transferred assets, while the registration requirement helps maintain proper record-keeping and traceability of all transfers. Additionally, the system may provide a more accessible onboarding experience for new users, who may be motivated to join the platform after receiving notification of pending transfers intended for them. This approach combines the convenience of traditional money transfer services with the security and traceability benefits of blockchain technology.

### Transfer Creation

In accordance with various embodiments of the present invention, a system and method for creating and managing open transfers may be implemented, wherein such open transfers may also be referenced as anonymous transfers in certain implementations. The system may be configured to receive, via one or more user interfaces, a transfer initiation request from a sending user. Such a request may specify at least one destination identifier selected from a group comprising a telephone number, an email address, and combinations thereof. The system may, in some embodiments, incorporate validation logic configured to verify the format and/or validity of the provided destination identifier prior to transfer creation. The validation logic may optionally query one or more external databases or services to confirm the operational status of the specified destination identifier.

Upon validation of a transfer request, the system may be configured to generate one or more secure claim identifiers. In various embodiments, each claim identifier may comprise a unique sequence selected from one or more of: an alphanumeric code, a numeric code, a cryptographic hash, or another form of unique identifier. The system may be further configured to generate at least one machine-readable representation of the claim identifier, wherein such machine-readable representation may comprise a Quick Response (QR) code, a barcode, a near-field communication (NFC) payload, or another form of encoded representation. Each claim identifier and its associated machine-readable representation may be configured with an expiration parameter, which may be determined based on one or more of: system configuration values, sending user preferences, regulatory requirements, security policies, and risk assessment factors.

The system may implement a notification subsystem configured to deliver claim information to intended recipients through one or more communication channels. When the destination identifier comprises a telephone number, the notification subsystem may be configured to transmit the claim information via at least one of: a Short Message Service (SMS) message, a multimedia message service (MMS) message, a real-time messaging protocol (RTP) message, or another mobile messaging format. When the destination identifier comprises an email address, the notification subsystem may transmit the claim information via an electronic mail protocol. Each notification may include some or all of: the claim identifier, a uniform resource locator (URL) or application deep link incorporating or referencing the claim identifier, one or more machine-readable representations of the claim identifier, claim instructions, security warnings, expiration information, and/or other data pertinent to the transfer claim process.

Various embodiments may incorporate a security subsystem configured to implement multiple security measures during transfer creation. Such security measures may comprise: encryption of claim identifiers using one or more cryptographic algorithms, validation of sender balances against one or more account databases, verification of sender authorization through multi-factor authentication, rate limiting of transfer creation, detection of suspicious patterns, and/or implementation of other security protocols. The security subsystem may maintain comprehensive audit records comprising timestamped entries for transfer creation events, wherein such records may include: IP addresses, device identifiers, geolocation data, biometric verification results, risk scores, and/or other security-relevant metadata.

The system may be configured to establish and enforce transfer conditions that should be satisfied prior to claim completion. Such conditions may be implemented through a rules engine that evaluates one or more of: recipient identity verification requirements, temporal restrictions, geographic constraints, monetary limits, regulatory compliance rules, and/or other constraints specified through system configuration or sender preferences. These conditions may be cryptographically encoded within claim identifiers, stored within one or more system databases, and/or managed through distributed ledger smart contracts associated with the transfer. The rules engine may be configured to automatically adjust condition parameters based on risk assessment algorithms, machine learning models, and/or manual administrator intervention.

### Recipient Flow

In accordance with at least one embodiment of the present invention, a system and method are provided for facilitating anonymous or “open” transfers of digital assets. The system may include one or more notification mechanisms through which a transfer recipient may be informed of a pending asset transfer, and one or more mechanisms through which the recipient may claim such transferred assets. These transfers may be particularly useful in circumstances where the sender does not have detailed knowledge of the recipient's digital wallet credentials, or where the recipient has not yet established a digital wallet account.

In at least one embodiment, upon initiation of an open transfer by a sender, the system may generate and transmit one or more notifications to the intended recipient. These notifications may include, but are not limited to, Short Message Service (SMS) messages, email messages, push notifications, instant messages, or other electronic communications. Each such notification may include a unique claim link that, when activated, initiates a process through which the recipient may claim the transferred assets. The claim link may be encoded as a Universal Resource Locator (URL), a Quick Response (QR) code, or another machine-readable format.

The system may, in various embodiments, implement different claim flows depending on whether the recipient has previously installed a digital wallet application associated with the system. When the recipient activates the claim link, the system may first determine whether the digital wallet application is present on the recipient's device. This determination may be made through operating system-level application detection, URL scheme handling, or other device-specific mechanisms.

In at least one embodiment, if the digital wallet application is not detected on the recipient's device, the system may direct the recipient through an onboarding process that includes one or more of: prompting the recipient to install the digital wallet application, guiding the recipient through an application installation process, and facilitating recipient registration within the application. The registration process may include collecting various recipient information, generating cryptographic keys, establishing recipient credentials, and optionally completing identity verification procedures. The system may maintain the claim link's validity throughout this process using secure session management or persistent state mechanisms. After successful completion of the registration process, the system may automatically initiate the transfer acceptance process.

In accordance with various embodiments, if the digital wallet application is already installed on the recipient's device, the system may streamline the claiming process. Upon activation of the claim link, the system may automatically launch the digital wallet application and initiate the transfer acceptance process. The system may utilize operating system-level deep linking, Universal Resource Locator (URL) schemes, or other mechanisms to facilitate seamless launching of the application and navigation to an appropriate transfer acceptance interface. The system may preserve relevant transfer details across this transition using secure parameter passing mechanisms.

The transfer acceptance process may, in some embodiments, include one or more verification steps to confirm the recipient's identity and authorization to accept the transfer. These steps may include, but are not limited to, biometric verification, password entry, multi-factor authentication, or other authentication mechanisms. The system may implement configurable security policies that determine which verification steps are required based on factors such as transfer amount, recipient history, or risk assessment metrics. Upon successful verification, the system may complete the asset transfer and update relevant account balances and transaction records.

In at least one embodiment, the system may implement expiration policies for unclaimed transfers. The claim link may remain valid for a configurable time period, after which unclaimed funds may be automatically returned to the sender. The system may send reminder notifications to the recipient before expiration and provide status updates to the sender regarding the claim status. Additionally, the system may implement rate limiting or other security measures to prevent automated claiming attempts or other potential abuse of the open transfer mechanism.

### QR Code Formats

In certain embodiments, a blockchain-based system may generate and process anonymous transfer quick response (QR) codes that enable trustless peer-to-peer value transfers while maintaining transaction privacy. The system may employ an anonymous sender record data structure to facilitate secure open transfers, comprising a plurality of fields including: a sender identifier field containing a blockchain address, a public key field containing an elliptic curve public key, an amount field specifying a transfer quantity, a token type identifier indicating a currency or token specification, one or more fee fields defining transaction processing fees, an expiration field containing a block height limit, and a cryptographic signature field containing a digital signature computed over the record data.

The system may encode the anonymous sender record using a uniform resource identifier (URI) format suitable for QR code representation, including domain specification parameters (e.g., “APP_DOMAIN”), application identification parameters (e.g., “APP_NAME”), endpoint routing parameters (e.g., “APP_ENDPOINT”), and a query string parameter (“QUERY_STRING”) containing the Base64-encoded anonymous sender record. Various embodiments may implement private key encoding functionality that processes cryptographic private keys associated with the transfer, optionally encrypting the encoded keys using one or more symmetric or asymmetric encryption algorithms. A Boolean flag field in the UR1 may indicate whether a particular private key is encrypted, which may be used by receiving systems to determine appropriate key handling procedures.

According to certain implementations, the system may incorporate miner specification parameters that influence transaction processing and may implement a hierarchical profile data sharing framework that enables graduated information disclosure. The framework may include a full profile tier that exposes complete entity details, a restricted tier that omits location data, and a privacy-preserving tier that reveals minimal identifying information. Profile data may include blockchain addresses, human-readable names, organizational identifiers, contact mechanisms, and geographic coordinates, serialized using a structured data format optimized for QR code capacity constraints.

Some embodiments may implement QR code generation functionality that produces machine-readable codes according to international standards, selecting appropriate error correction levels based on anticipated scanning conditions and optimizing character encoding to maximize data density while ensuring reliable scanning. Various implementations may include validation subsystems that verify data integrity and format compliance prior to code generation, examining field presence, cryptographic validity, parameter ranges, and adherence to schema requirements. The system may process scanned codes by implementing multi-phase validation and execution logic, extracting encoded fields, verifying cryptographic elements including digital signatures and public keys, validating transaction parameters, and initiating corresponding blockchain operations to execute the anonymous transfer.

### Security Features

Various embodiments of the invention may implement specialized handling procedures for open transfers, also referred to in some implementations as anonymous transfers. These procedures may be particularly relevant when managing different payment methods, recipient verification states, and various access scenarios. The following description presents various optional features and configurations that may be implemented individually or in combination within the system.

According to certain embodiments, the system may implement differentiated claim identifier generation based on payment method type. When card-based payment methods are selected, the system may withhold generation of a claim identifier until receiving payment confirmation from one or more payment processing networks. This temporary withholding may be implemented using a state machine that maintains the transfer in a pending state, monitoring one or more payment status indicators. The pending state may persist until either a successful payment confirmation is received, triggering claim identifier generation, or a configurable timeout period expires, triggering a cancellation workflow. This differs from wallet-based transfers, where claim identifiers may be generated immediately due to the system's ability to confirm fund availability through internal account balance verification.

Some embodiments may implement a multi-channel redistribution framework for claim identifiers. After initial generation, the system may provide senders with a configurable interface for resharing claim identifiers through various communication channels. These channels may comprise, but are not limited to, SMS messaging systems, email delivery services, and social media platform integrations. The redistribution framework may maintain cryptographic signatures or other security tokens linking reshared claims to their original generation event, thereby preventing unauthorized redistribution attempts. The system may optionally maintain an immutable audit log recording each redistribution event, including timestamp, channel type, and recipient information where available.

In at least one embodiment, the system implements a dynamic payment method authorization framework based on user verification status. This framework may apply configurable restrictions to unverified profiles, particularly regarding wallet-based payment methods. The restriction engine may evaluate multiple factors including, but not limited to, verification status, jurisdiction requirements, transaction amount thresholds, and historical account activity. While restricting certain payment methods, the system may maintain availability of alternative payment mechanisms such as card payments or bank transfers, subject to their own verification requirements. The authorization framework may implement a rule engine allowing for dynamic modification of restrictions based on changing regulatory requirements or risk parameters.

Various embodiments may implement a platform-aware claim resolution system that provides different workflows based on the recipient's access method. When claim links are accessed via desktop computing devices, the system may implement an intelligent redirection protocol that transfers the recipient to an appropriate web-based interface while preserving claim context. This web interface may incorporate dynamic content generation, providing customized instructions based on factors including, but not limited to, recipient location, transfer amount, and available claim methods. The system may maintain claim validity across multiple access attempts and device transitions through a persistent state management system, optionally implementing additional security measures for cross-platform access attempts.

Certain embodiments may incorporate a configurable claim lifecycle management system. This system may control claim expiration periods, which may default to 48 hours but may be dynamically adjusted based on multiple factors including payment method characteristics, transfer amount thresholds, recipient verification status, and jurisdictional requirements. The lifecycle management system may implement a notification framework enabling real-time status tracking of claim access attempts and resolution events. This framework may optionally integrate with a cancellation management system, allowing senders to revoke unclaimed transfers subject to configurable business rules and security validations.

According to some embodiments, the system may implement an adaptive recipient processing framework that modifies its behavior based on recipient history and access patterns. This framework may maintain separate workflow engines for new versus returning recipients, implementing different authentication requirements and user experience flows while maintaining consistent security standards. The framework may optionally integrate with existing identity management systems, allowing for progressive enhancement of recipient profiles across multiple transfer events. Additionally, the system may implement device-specific optimizations while maintaining a consistent security model across all access patterns through a unified security policy enforcement layer.

### Special Case Handling

Various embodiments of the invention may implement specialized handling procedures for open transfers, also referred to in some implementations as anonymous transfers. These procedures may be particularly relevant when managing different payment methods, recipient verification states, and various access scenarios. The following description presents various optional features and configurations that may be implemented individually or in combination within the system.

According to certain embodiments, the system may implement differentiated claim identifier generation based on payment method type. When card-based payment methods are selected, the system may withhold generation of a claim identifier until receiving payment confirmation from one or more payment processing networks. This temporary withholding may be implemented using a state machine that maintains the transfer in a pending state, monitoring one or more payment status indicators. The pending state may persist until either a successful payment confirmation is received, triggering claim identifier generation, or a configurable timeout period expires, triggering a cancellation workflow. This differs from wallet-based transfers, where claim identifiers may be generated immediately due to the system's ability to confirm fund availability through internal account balance verification.

Some embodiments may implement a multi-channel redistribution framework for claim identifiers. After initial generation, the system may provide senders with a configurable interface for resharing claim identifiers through various communication channels. These channels may comprise, but are not limited to, SMS messaging systems, email delivery services, and social media platform integrations. The redistribution framework may maintain cryptographic signatures or other security tokens linking reshared claims to their original generation event, thereby preventing unauthorized redistribution attempts. The system may optionally maintain an immutable audit log recording each redistribution event, including timestamp, channel type, and recipient information where available.

In at least one embodiment, the system implements a dynamic payment method authorization framework based on user verification status. This framework may apply configurable restrictions to unverified profiles, particularly regarding wallet-based payment methods. The restriction engine may evaluate multiple factors including, but not limited to, verification status, jurisdiction requirements, transaction amount thresholds, and historical account activity. While restricting certain payment methods, the system may maintain availability of alternative payment mechanisms such as card payments or bank transfers, subject to their own verification requirements. The authorization framework may implement a rule engine allowing for dynamic modification of restrictions based on changing regulatory requirements or risk parameters.

Various embodiments may implement a platform-aware claim resolution system that provides different workflows based on the recipient's access method. When claim links are accessed via desktop computing devices, the system may implement an intelligent redirection protocol that transfers the recipient to an appropriate web-based interface while preserving claim context. This web interface may incorporate dynamic content generation, providing customized instructions based on factors including, but not limited to, recipient location, transfer amount, and available claim methods. The system may maintain claim validity across multiple access attempts and device transitions through a persistent state management system, optionally implementing additional security measures for cross-platform access attempts.

Certain embodiments may incorporate a configurable claim lifecycle management system. This system may control claim expiration periods, which may default to 48 hours but may be dynamically adjusted based on multiple factors including payment method characteristics, transfer amount thresholds, recipient verification status, and jurisdictional requirements. The lifecycle management system may implement a notification framework enabling real-time status tracking of claim access attempts and resolution events. This framework may optionally integrate with a cancellation management system, allowing senders to revoke unclaimed transfers subject to configurable business rules and security validations.

According to some embodiments, the system may implement an adaptive recipient processing framework that modifies its behavior based on recipient history and access patterns. This framework may maintain separate workflow engines for new versus returning recipients, implementing different authentication requirements and user experience flows while maintaining consistent security standards. The framework may optionally integrate with existing identity management systems, allowing for progressive enhancement of recipient profiles across multiple transfer events. Additionally, the system may implement device-specific optimizations while maintaining a consistent security model across all access patterns through a unified security policy enforcement layer.

### Status Tracking

In accordance with various embodiments of the present invention, a system and method may be provided for tracking status of anonymous value transfers within a distributed payment network. The system may comprise one or more digital processing devices configured to implement notification generation modules, state tracking processors, transaction recording components, and user interface elements, operating individually or in combination to maintain comprehensive state information regarding anonymous value transfers between sending and receiving network participants.

The processing devices may, in at least one embodiment, comprise at least one notification subsystem configured to generate and transmit event notifications through multiple redundant communication channels upon creation of an anonymous transfer request. Such notifications may be encrypted and digitally signed, and may be delivered via any combination of short message service (SMS) transmissions, electronic mail messages, mobile device push notifications, in-application alerts, or other electronic communication methods. The notification subsystem may implement queuing mechanisms to ensure reliable delivery of time-sensitive notifications, with configurable retry logic in the event of delivery failures.

In certain embodiments, the system may implement profile-sharing notification protocols triggered when a transfer recipient elects to share identity or profile data with a sender. The profile-sharing notifications may be cryptographically secured and may contain granular details regarding specific profile elements that have been shared. The notification subsystem may enforce profile-sharing rules based on one or more of: recipient privacy settings, jurisdictional requirements, or system-wide sharing policies. Profile data may be shared in encrypted form, with encryption keys transmitted via separate secure channels.

Transfer acceptance events may, according to various embodiments, trigger cascading notification sequences directed to both sending and receiving participants. Such acceptance notifications may include transaction identifiers, timestamp data, cryptographic proofs, and detailed transfer metadata. The metadata may comprise information including, but not limited to: value amounts, currency types, conversion rates, network fees, processing timestamps, and chain of custody details. Acceptance notifications may trigger state changes in associated smart contracts or other on-chain components.

The system may implement, in at least one embodiment, a transaction history subsystem configured to maintain comprehensive transfer state records in secure, distributed data stores. State information may include multiple status indicators such as: initiated, pending, profile-shared, accepted, expired, cancelled, reversed, or completed. In one or more embodiments, said transaction history subsystem may implement Byzantine fault-tolerant consensus mechanisms to maintain consistency across distributed network nodes. Status transitions may be cryptographically signed by authorized participants and may generate immutable audit trails.

Various embodiments may include dynamic user interface components configured to display real-time transfer status information through web-based or native application interfaces. Such interface components may implement WebSocket connections or similar real-time protocols to receive status updates without polling. The interface components may include configurable visualization modules supporting multiple display formats including but not limited to: timeline views, state transition diagrams, or tabular displays. Visual indicators may be supplemented with sound or haptic feedback on compatible devices.

In accordance with certain implementations, the system may provide notification management interfaces allowing participants to define notification preferences on a per-transfer or account-wide basis. Such preference configurations may control notification timing, delivery channels, content detail levels, and aggregation parameters. The notification management system may enforce minimum notification requirements based on security policies or regulatory requirements while allowing participants to opt into additional notification types. Notification preferences may be cryptographically signed to prevent unauthorized modifications.

The status tracking system may, in some embodiments, implement error detection and recovery mechanisms to handle edge cases such as: failed deliveries, network partitions, or race conditions between competing status updates. Such mechanisms may include automated retry logic, conflict resolution protocols, and roll-back procedures to maintain system consistency. The error handling subsystems may generate detailed diagnostic logs to facilitate troubleshooting while maintaining participant privacy.

### Tiered Permission Management

In an embodiment, a tiered permission management system and method are described, enabling the management of user permissions and identity verification within distributed systems, including blockchain-based networks. The system may integrate centralized database controls with blockchain-based authorization filters to provide seamless synchronization of permission data across components. By utilizing domain-specific languages, hierarchical permission structures, and advanced scoring mechanisms, the system may support flexible and precise enforcement of user-specific operational parameters, addressing various challenges in existing permission management frameworks.

Certain embodiments may provide improvements over conventional approaches by dynamically adjusting permission levels based on user behavior, identity verification outcomes, and risk assessments. A bi-directional synchronization mechanism may ensure consistent and reliable permission enforcement between centralized and blockchain components. Additionally, the system may incorporate multi-tiered structures and adaptability to evolving jurisdictional and compliance requirements, enhancing scalability and operational robustness. These features can make such embodiments particularly suitable for applications in high-value transactions, identity management, and regulatory compliance, while offering increased security, efficiency, and user control.

### System Architecture

In accordance with various embodiments of the present invention, a tiered permission management system may be implemented that integrates both blockchain-based authorization filters and centralized database controls. The system may include one or more authorization servers that maintain permissions data in a centralized relational database, with such permissions data being reflected in one or more blockchain-based authorization filters. The authorization filters may be implemented as executable smart contracts deployed on a blockchain network, where such smart contracts may incorporate configurable rule sets that define permissible operations for each permission tier. In at least one embodiment, these rule sets may be expressed using a domain-specific authorization language that supports complex logical operations and hierarchical permission structures.

The system may implement a bi-directional synchronization mechanism whereby permission levels stored within the centralized database are reflected in corresponding blockchain-based authorization filters, and whereby blockchain state changes affecting permissions are reflected back to the centralized database. Such synchronization may be accomplished through the use of one or more server processes that monitor changes to permission data within the centralized database and generate corresponding blockchain transactions to update the authorization filters. These server processes may employ a message queue architecture to ensure reliable delivery and processing of permission updates. In at least one embodiment, these server processes may operate asynchronously, queuing updates to be processed as blockchain transactions reach finality, with finality being defined as a configurable number of block confirmations.

In various embodiments, the system may implement multiple permission tiers, with each tier potentially corresponding to different levels of identity verification and/or Know Your Customer (KYC) validation. A permission tier management module may be provided that interfaces with one or more KYC verification services through standardized APIs to automatically adjust user permission levels based on the extent and quality of identity verification performed. The permission tier management module may maintain mappings between verification status and corresponding permission tiers within the centralized database, where such mappings may incorporate multiple verification factors including, but not limited to, document verification confidence scores, biometric match scores, and external database verification results. These verification factors may be weighted and combined according to configurable scoring algorithms to determine appropriate permission tier assignments.

Authorization of blockchain operations may be controlled through the use of one or more token authorization subroutines implemented within smart contracts deployed on the blockchain network. These subroutines may enforce restrictions based on the permission tier assigned to particular blockchain accounts, where such restrictions may include, but are not limited to, transaction value limits, token type restrictions, counterparty restrictions, and temporal restrictions. The token authorization subroutines may be configured to inspect account annotations and/or key-value store entries associated with blockchain accounts to determine applicable permission tiers and enforce corresponding restrictions. In at least one embodiment, these subroutines may implement caching mechanisms to optimize repeated permission checks while maintaining consistency with the underlying blockchain state.

The system may include one or more blockchain monitoring services that observe the state of permission-related annotations and key-value store entries on the blockchain using event subscription mechanisms. These monitoring services may implement robust synchronization protocols to maintain consistency between blockchain and centralized database components of the system, including handling of blockchain reorganizations and temporary network partitions. The monitoring services may detect permission-related state changes on the blockchain and trigger corresponding updates to permission records maintained within the centralized database, where such updates may be processed atomically to maintain data consistency.

A permission tier enforcement module may be provided that validates blockchain transactions against permission tier requirements before allowing such transactions to be submitted to the blockchain network. The enforcement module may implement a multi-stage validation process that consults both centralized database records and blockchain state data to determine whether particular operations are permitted under the permission tier assigned to the relevant blockchain account. This validation process may incorporate configurable caching mechanisms to optimize performance while maintaining eventual consistency with the underlying blockchain state. In at least one embodiment, the enforcement module may be configured to reject transactions that would violate tier-based restrictions before such transactions are submitted to the blockchain network, thereby conserving network resources.

The system may implement a hierarchical permission model whereby certain permission tiers inherit restrictions from other tiers through a directed acyclic graph structure. Token authorization subroutines may be configured to efficiently traverse these permission hierarchies when determining whether particular operations are permitted, potentially employing caching mechanisms to optimize repeated traversals. The hierarchical permission model may be reflected both in centralized database schemas through the use of adjacency lists or nested set models, and in the structure of blockchain-based authorization filters through linked smart contract deployments.

Permission tier assignments may be implemented through the use of blockchain account annotations that are validated by one or more trusted verification authorities using cryptographic signatures. The system may include verification authority management components that maintain ordered lists of trusted verification authorities and process verification decisions from such authorities according to configurable consensus rules. The verification decisions may trigger automatic updates to permission tier assignments in both centralized database records and blockchain-based authorization filters, where such updates may be processed atomically to maintain system consistency. In at least one embodiment, the verification authority management components may implement rotation mechanisms to securely update the set of trusted verification authorities over time.

### Tier Assignment Mechanism

In accordance with at least one embodiment of the present invention, a multi-tiered identity verification and permissions system may be implemented, whereby user accounts may be assigned to various permission tiers based on one or more verification factors. The system may include an automated document verification subsystem that generates and processes multiple confidence scores, a machine learning-based scoring mechanism that evaluates these scores, and optionally one or more manual review interfaces that permit human oversight of the automated processes.

The automated document verification subsystem may analyze one or more identity documents submitted by a user through a variety of complementary approaches. Such analysis may include, but is not limited to, document classification, authenticity validation, text extraction, and biometric matching. The document classification component may employ one or more machine learning models trained to identify specific document types, issuing jurisdictions, and security features. In various embodiments, the system may maintain a configurable database of supported document types for each jurisdiction, including standardized formats, expected security features, and jurisdiction-specific validation rules.

In at least one embodiment, the document authenticity validation component may analyze multiple security features of the submitted documents using a multi-layered approach. Such analysis may include, but is not limited to: hologram detection using specialized image processing algorithms; pattern matching against known security features; ultraviolet (UV) mark detection when appropriate hardware is available; detection of visual artifacts that may indicate digital tampering or physical forgery; and validation of document-specific security features such as microprint, watermarks, or embossed elements. The system may generate individualized confidence scores for each security feature analyzed, as well as an aggregate authenticity score derived from these individual measurements.

A text extraction and verification component may extract textual information from the submitted documents using multiple optical character recognition (OCR) algorithms operating in parallel. The extracted text may be normalized and compared against expected patterns and formats for the identified document type, including but not limited to: document numbers following jurisdiction-specific formats; name fields conforming to cultural naming conventions; date formats matching jurisdiction standards; and address fields conforming to local postal formats. The system may employ fuzzy matching algorithms to account for OCR errors while maintaining strict validation requirements. Additionally, the system may verify consistency between multiple documents submitted by the same user by cross-referencing extracted fields, generating both field-specific and aggregate consistency scores.

In various embodiments, a biometric matching component may perform multi-factor analysis comparing facial features extracted from a submitted selfie photograph against facial features extracted from submitted identity documents. The biometric matching process may utilize multiple comparison algorithms in parallel, analyzing factors including but not limited to: facial landmark positions, texture analysis, three-dimensional face modeling when multiple angles are available, and age-adjusted comparison metrics. The system may generate separate confidence scores for each comparison algorithm, combining them into an aggregate biometric match score using configurable weighting factors that may vary based on the quality and type of input images.

The system may employ a sophisticated scoring aggregation mechanism to combine the various confidence scores generated during document analysis. In at least one embodiment, the combination may utilize a configurable weighted scoring matrix that accounts for interdependencies between different verification factors. The weighting factors may be adjusted based on jurisdiction-specific requirements, document type reliability ratings, and historical fraud patterns. These aggregate confidence scores may be mapped to appropriate permission tiers through configurable thresholds that may vary by jurisdiction or other factors.

In at least one embodiment, one or more manual review interfaces may be provided, enabling human reviewers to examine submitted documents and override automated tier assignments when necessary. The manual review process may be triggered by various configurable conditions, including but not limited to: confidence scores falling within specified uncertainty ranges; detection of specific risk patterns or anomalies; document types requiring mandatory human review; jurisdictional requirements; random selection for quality assurance purposes; or user appeals of automated decisions. The manual review interface may present reviewers with a comprehensive dashboard showing all automated verification results, confidence scores, and detected anomalies, while also providing tools for detailed document examination and annotation.

The permission tier assigned to a user account may be dynamically adjusted through a multi-factor evaluation process that considers various elements, including but not limited to: changes in confidence scores due to submission of additional or updated documents; results of periodic automated re-verification processes; outcomes of manual reviews; detected patterns in account activity; changes in regulatory requirements; or modifications to system-wide risk thresholds. In at least one embodiment, the system may implement a configurable cool-down period between tier changes, which may vary based on the nature of the change and jurisdiction-specific requirements. The cool-down period may be overridden in certain circumstances, such as detection of suspicious activity or regulatory mandates.

Each permission tier within the system may be associated with a comprehensive set of operational parameters, including but not limited to: transaction value limits; frequency limits; functionality access levels; additional verification requirements; and risk monitoring thresholds. These associations may be managed through a configurable rule engine that allows system administrators to define complex conditional relationships between verification factors and operational permissions. The rule engine may support jurisdiction-specific rule sets and may automatically adjust parameters based on changes in regulatory requirements or risk factors. In various embodiments, the system may maintain a detailed audit trail of all tier assignments and adjustments, recording not only the changes themselves but also the complete set of factors and rules that triggered each change.

The automated scoring system may incorporate multiple machine learning models operating in parallel, each trained on specialized datasets that may include but are not limited to: repositories of known valid and invalid documents; historical user verification data; manually labeled training samples; and anonymized patterns of successful and unsuccessful verification attempts. These models may employ various machine learning approaches including but not limited to: convolutional neural networks for image analysis; recurrent neural networks for sequence analysis; and ensemble methods for score aggregation. The models may be periodically retrained using a continuous learning pipeline that incorporates new training data while maintaining strict data privacy requirements. In at least one embodiment, separate model versions may be maintained for different jurisdictions or document types, allowing for specialized handling of region-specific verification challenges.

The system may implement a comprehensive feedback loop that continuously improves verification accuracy by incorporating multiple data sources, including but not limited to: manual review outcomes; detected fraud patterns; successful and unsuccessful verification attempts; and user behavior patterns following verification. This feedback mechanism may automatically adjust scoring weights, update risk thresholds, and flag potential issues for system administrator review. In various embodiments, the feedback system may also generate periodic reports analyzing verification performance metrics and identifying potential areas for improvement in the verification process.

### Permission Control

In accordance with at least one embodiment of the present invention, a permission control system may be implemented using one or more configurable authorization filters that evaluate and enforce account permissions and transaction capabilities within a blockchain-based financial network. Such authorization filters may be configured through annotations stored within account records on the blockchain, wherein each annotation may contain structured data defining specific authorization parameters, restrictions, and validation rules applicable to that account.

The system may implement a hierarchical tier structure comprising multiple permission levels, wherein a tier manager component may assign and modify tier classifications based on validation events and account metadata. Each tier designation may be recorded as an annotation within the account record and may be cryptographically signed by one or more authorized validation entities. In at least one embodiment, tier assignments may include an unvalidated tier (tier 0), an entry validation tier (tier 1), and multiple enhanced validation tiers (tiers 2-N), where N represents any number of additional tiers. The tier structure may be dynamically configurable, allowing new tiers to be added or existing tiers to be modified based on operational requirements.

Authorization filters may be implemented through one or more executable smart contracts deployed on a blockchain network, with each smart contract containing validation logic that may evaluate transaction requests against multi-dimensional criteria sets. These criteria sets may include, but are not limited to, static value limits, time-based cumulative limits, token type restrictions, jurisdiction-specific rules, and custom validation parameters. The smart contracts may implement a standardized interface that returns authorization decisions through a consistent response format, which may include both a Boolean authorization indicator and supplementary status data explaining the authorization decision.

In at least one embodiment, token-level authorization controls may be implemented through a validation module incorporated within each token's smart contract implementation. This validation module may expose one or more entry points that are automatically invoked during transaction processing, with these entry points being configured to evaluate proposed operations against both global protocol rules and token-specific restrictions. The validation module may access a extensible metadata store associated with each account, wherein this metadata store may contain structured records including, but not limited to, KYC verification status, jurisdiction declarations, custom restrictions, and validation proofs. These metadata records may be cryptographically secured and may only be modified through authorized update procedures.

The system may maintain a dynamically updateable jurisdiction rule registry implemented as a smart contract that maps jurisdiction identifiers to corresponding rule sets. Each rule set may be encoded as a structured data object specifying restrictions including, but not limited to, maximum single transaction values, cumulative transaction limits, required verification levels, prohibited transaction types, and compliance documentation requirements. The authorization filters may integrate with this registry through a standardized interface, automatically enforcing jurisdiction-specific rules based on the declared jurisdictions of all accounts participating in a transaction. The registry may support rule versioning and time-based rule activation, allowing for scheduled regulatory updates.

Transaction limit enforcement may be implemented through a multi-layered validation framework combining static boundary enforcement with dynamic constraint tracking. Static limits may include absolute maximum transaction values and balance thresholds associated with each tier, while dynamic constraints may incorporate temporal restrictions such as rolling time window limits and progressive volume caps. These limits may be tracked through state variables maintained within authorization smart contracts, with these variables being updated atomically during transaction processing to ensure consistent limit enforcement across concurrent operations. The framework may support both hard limits that cannot be exceeded and soft limits that trigger additional validation requirements when exceeded.

In accordance with at least one embodiment, the authorization system may implement a multi-factor threshold mechanism for determining tier assignments based on composite verification confidence scores. Such confidence scores may be calculated using a weighted combination of multiple verification factors, including but not limited to: document authenticity scores, biometric matching confidence levels, external identity service verification results, and proof-of-address validation scores. Each factor may be assigned a configurable weight within the scoring algorithm, with the weights potentially varying by jurisdiction or verification provider. The system may maintain these composite scores as decimal values between 0 and 1, with configurable thresholds defining the boundaries between tiers.

The system may implement a cryptographically secured proposition and decision record framework wherein identity verification results may be recorded on-chain as attestations signed by authorized verifiers. These attestation records may comprise: a proposition record containing hashed identity data and plaintext jurisdiction information, one or more decision records signed by authorized verifiers containing confidence scores and verification timestamps, and supplementary attestation metadata including but not limited to verification provider identifiers and verification method indicators. The authorization filters may evaluate the most recent valid attestations, with configurable expiration periods potentially invalidating older attestations.

In at least one embodiment, the system may implement a role-based hierarchical override capability, wherein designated supervisor accounts may be granted granular modification permissions through a role-based access control (RBAC) smart contract. Such permissions may include, but are not limited to: temporary tier elevation, permanent tier modification, transaction limit adjustments, and restriction exemptions. Override operations may require multi-signature approval based on configurable quorum rules, with required signature counts potentially varying based on the severity of the modification. All override operations may be recorded in an append-only audit log with cryptographic linking between successive entries.

The authorization system may implement a two-layer caching mechanism for permission data, comprising a fast-access memory cache for frequently accessed data and a persistent cache for less frequently accessed data. The caching system may maintain consistency through a combination of time-based invalidation and event-driven updates triggered by relevant blockchain state changes. Cached data may include pre-computed permission matrices, encoded jurisdiction rules, and aggregated transaction statistics used in limit calculations. Cache invalidation may be triggered by block reorganization events or explicit invalidation messages from authorized sources.

In accordance with at least one embodiment, the system may implement an adaptive restriction enforcement mechanism, wherein transaction limits and other restrictions may be automatically adjusted based on a combination of historical behaviors and real-time risk indicators. The adjustment algorithm may evaluate factors including but not limited to: historical transaction volumes, transaction frequency patterns, counterparty risk scores, and velocity of balance changes. These factors may be weighted according to configurable risk models, with the weights potentially varying by jurisdiction or account tier. The adjustment rules may be implemented as executable code within the authorization smart contracts, with state changes requiring consensus among participating nodes.

The authorization system may implement an event-driven notification framework utilizing a publish-subscribe architecture for permission-related events. Notification triggers may be defined through configurable rules evaluating permission state changes, with supported notification types including but not limited to: webhook callbacks, encrypted email messages, and on-chain event logs. Notifications may include cryptographic proofs constructed from relevant blockchain state data, enabling offline verification of the triggering events. The notification system may implement configurable retry logic with exponential backoff for failed delivery attempts.

### Document Management System

According to various embodiments of the present invention, a document management system, apparatus and methods may be provided to facilitate identity verification and permissions management within a distributed computing environment. In at least one embodiment, such a system may implement a configurable verification pipeline comprising one or more document processing modules, wherein each such module may be specifically configured to validate particular document types according to jurisdictional rules. The system may be extensible, allowing for the addition of new document processing modules as jurisdictional requirements evolve or new document types are introduced.

In accordance with at least one embodiment, the document management system may implement a multi-stage verification workflow that processes documents through a series of increasingly rigorous validation steps. Upon initial receipt of a document, the system may first perform preliminary validation of the document structure and format by comparing document characteristics against jurisdiction-specific templates stored in a template database. The system may then employ one or more machine learning models trained on jurisdiction-specific document features to extract relevant data fields using optical character recognition (OCR), computer vision techniques, and/or other document parsing methodologies. The extracted data may be validated against user-provided information using configurable matching algorithms that may account for variations in data format and representation. Additionally, the system may validate security features specific to the document type, such as hologram patterns, microprint features, or other anti-tampering mechanisms, using specialized image processing algorithms designed to detect these security features.

The storage of sensitive document data may be implemented using a hierarchical encryption scheme designed to provide multiple layers of security while maintaining system performance. In at least one embodiment, individual documents may be encrypted using unique symmetric encryption keys generated specifically for each document. These document-specific keys may themselves be encrypted using asymmetric encryption keys associated with specific jurisdictions or document types, creating a two-tier encryption hierarchy. The encrypted documents may be stored in a distributed secure document store, with the encryption keys maintained in a separate hardware security module (HSM) or key management system. Access to documents may require both the document-specific key and the appropriate jurisdiction-level key, thereby implementing the principle of dual control while maintaining system scalability.

An expiration tracking subsystem may be implemented to monitor document validity periods according to a configurable set of jurisdictional rules. In at least one embodiment, the expiration tracking subsystem may maintain a rules engine that references a database of jurisdiction-specific expiration requirements. This rules engine may be dynamically updated as jurisdictional requirements change, without requiring system downtime. The system may implement a notification service that generates alerts at configurable intervals before document expiration, with different notification schedules possible for different document types or jurisdictions. These notifications may be transmitted via multiple communication channels, which may include but are not limited to email, SMS, or in-application notifications.

The system may implement an event-driven re-verification framework triggered by various conditions monitored by the system. In at least one embodiment, these trigger conditions may include: temporal proximity to document expiration dates, detection of changes in user risk profiles, identification of suspicious activity patterns, modifications to jurisdictional requirements, or other configurable events. When a re-verification trigger is activated, the system may automatically initiate a new document verification workflow. This workflow may include requesting updated documents from the user, performing new validation checks, and updating the user's verification status based on the results. The re-verification process may be customized based on the specific trigger condition that initiated it.

In accordance with at least one embodiment, the system may implement a multi-jurisdictional document handling framework through a configurable rule engine. This rule engine may maintain a hierarchy of document requirements, verification procedures, and data retention policies specific to each jurisdiction. The rule engine may reference a dynamic configuration database that defines acceptable document types, required security features, and verification protocols for each jurisdiction. In at least one implementation, the rule engine may support inheritance relationships between jurisdictions, allowing jurisdictions to inherit and extend base requirements while maintaining jurisdiction-specific modifications. The system may automatically validate document submissions against these requirements, ensuring that only acceptable document types are processed for each jurisdiction.

A cryptographically secure audit trail may be maintained to record all document verification activities. In at least one embodiment, each verification event may generate an audit record containing a timestamp, verification status, cryptographic hashes of the documents processed, identifiers of the specific rules applied, and results of individual verification checks. These audit records may be stored in a distributed ledger or blockchain structure, with each record cryptographically linked to previous records to create an immutable chain of verification evidence. The audit trail may implement zero-knowledge proofs to allow verification of document processing without exposing sensitive document data. Access to audit records may be controlled through a role-based access control system that supports jurisdictional restrictions.

The document management system may implement an automated quality assessment pipeline utilizing computer vision and machine learning techniques. When documents are submitted, the system may evaluate multiple quality metrics, which may include but are not limited to: image resolution, contrast, focus, completeness, presence of required security features, and absence of digital manipulation artifacts. These evaluations may be performed using specialized neural networks trained on jurisdiction-specific document characteristics. If a document fails to meet configured quality thresholds, the system may automatically reject the submission and generate detailed feedback specifying the quality issues detected and recommended remediation steps.

A tiered document requirement framework may be implemented to support progressive verification levels. In at least one embodiment, each tier level may be associated with a specific set of required documents and verification procedures defined through the rule engine. The system may maintain a verification state machine for each user that tracks verified documents and outstanding requirements for each tier level. This state machine may automatically update as new documents are verified or existing verifications expire. The system may provide an API allowing external systems to query a user's current verification status and requirements for advancing to higher tiers. Requirements for each tier may be dynamically updated based on changes in jurisdictional regulations or risk assessments.

The system may implement a secure document lifecycle management framework that handles document retention and deletion according to jurisdictional requirements. In at least one embodiment, documents may be associated with multiple retention rules based on document type, jurisdiction, and user tier level. The system may implement a secure deletion protocol that ensures complete removal of document data and associated encryption keys when retention periods expire. This protocol may include multiple passes of secure data wiping, verification of deletion completion, and creation of cryptographically signed deletion certificates. The deletion process may be executed within secure execution environments to prevent unauthorized access to document data during the deletion process. The system may maintain a separate audit trail of deletion events to demonstrate compliance with retention requirements.

### Dynamic Update Mechanisms

In accordance with various embodiments of the present invention, a dynamic tier adjustment system may be implemented to manage user permissions and access levels within the digital wallet platform. The system may comprise a tier management processor operatively connected to one or more databases storing user activity data, compliance data, and tier configuration data. The tier management processor may be configured to evaluate user activity in real-time or near real-time through a continuous monitoring process that may include parallel processing of multiple data streams. The processor may automatically adjust user tier classifications based on a weighted combination of factors stored in a tier criteria database, which may include, but are not limited to, transaction velocity metrics, identity verification levels, account age, historical compliance data, and risk assessment scores. In at least one embodiment, the tier adjustment system may implement a state machine architecture that maintains current tier states and processes state transition events according to configurable rule sets.

A risk scoring engine may be integrated with the tier adjustment system, whereby the risk scoring engine may employ one or more machine learning models to calculate dynamic risk scores for users. These risk scores may be computed using a multi-layer neural network or other machine learning architecture trained on historical user data and known risk patterns. Input features to the risk scoring model may include, but are not limited to: transaction amount distributions, temporal transaction patterns, geolocation data sequences, device fingerprint data, network connection patterns, and historical authentication events. The risk scoring engine may maintain separate models for different user segments or jurisdictions, and may implement an ensemble approach combining multiple model outputs. In some embodiments, the models may be periodically retrained using federated learning techniques to incorporate new data while preserving user privacy.

Various embodiments may include a suspicious activity detection module implementing one or more anomaly detection algorithms operating across multiple time scales. This module may employ both supervised and unsupervised machine learning techniques to identify behavioral anomalies, including but not limited to: sudden changes in transaction patterns, unusual device switching behavior, anomalous geographic movement patterns, and suspicious interaction sequences. The detection module may maintain a hierarchical set of detection models operating at different granularities, from individual transaction-level analysis to long-term behavioral pattern analysis. When suspicious activity is detected, the system may implement a graduated response protocol that may include automatic tier adjustment, temporary feature restrictions, additional authentication requirements, and/or manual review triggers. The response protocol may be defined by a configurable state machine that determines appropriate actions based on the type and severity of detected anomalies.

A compliance monitoring system may be implemented using a distributed architecture that enables real-time tracking of multiple compliance metrics across different jurisdictions and tier levels. The system may comprise multiple monitoring nodes, each responsible for tracking specific compliance requirements and maintaining associated state information. A central compliance coordinator may aggregate data from these nodes and implement a rule engine for evaluating complex compliance conditions. The system may maintain time-series databases tracking compliance metrics over time, enabling both point-in-time compliance verification and trend analysis. In various embodiments, the compliance monitoring system may implement a publish-subscribe architecture for real-time distribution of compliance status updates to relevant system components.

An automated notification system may be integrated with the dynamic tier adjustment mechanism through a message broker architecture that ensures reliable delivery of tier-related communications. The notification system may implement a template engine supporting multiple localization formats and communication channels, with templates stored in a versioned repository that maintains regulatory compliance records. The system may employ a priority queue mechanism for message delivery, with configurable rules for message aggregation and frequency control. In at least one embodiment, the notification system may implement a feedback loop that tracks user response to notifications and adjusts communication strategies accordingly. The system may also maintain a cryptographically secured audit log of all notifications for compliance purposes.

The dynamic update mechanisms described above may be implemented as microservices within a larger distributed system architecture. Each mechanism may expose well-defined APIs that enable flexible integration and reconfiguration. The mechanisms may communicate through an event bus that enables loose coupling while maintaining system consistency. In some embodiments, these mechanisms may implement eventual consistency models that allow for high availability while ensuring that all system components eventually converge to a consistent state. The specific implementation may vary based on operational requirements, with different deployment configurations possible for different scaling needs or regulatory environments.

### Authorization Protocol

In accordance with various embodiments of the present invention, a multi-tiered authorization protocol may be implemented within a distributed ledger system to manage permissions and verify user identities. The protocol may incorporate a configurable validation framework that processes authentication requests through multiple sequential or parallel validation paths, with each path potentially requiring different levels of cryptographic proof or external validation. Each validation path may be assigned a numerical confidence score that can be aggregated to determine the overall authorization level granted to a particular request.

The blockchain-based verification process may, in at least one embodiment, implement a structured annotation system whereby user identity information may be compartmentalized into discrete data objects, each secured via independent cryptographic hashes. These hashes may be organized in a Merkle tree structure, allowing for selective disclosure of specific identity attributes without revealing other components of the identity record. The root hash of this Merkle tree may be stored as an account annotation on the distributed ledger, while supporting documentation and attribute values may be stored off-chain in encrypted form, with encryption keys potentially distributed across multiple secure storage locations.

A multi-factor authentication subsystem may be integrated with the authorization protocol through a pluggable interface architecture that enables dynamic configuration of authentication requirements. The subsystem may implement a weighted scoring algorithm that assigns different trust values to various authentication factors, including but not limited to: knowledge-based factors (e.g., passwords, PINs, security questions), possession factors (e.g., registered devices, hardware security tokens, digital certificates), and inherence factors (e.g., biometric data such as fingerprints, facial recognition, or behavioral patterns). The scoring algorithm may adapt dynamically based on risk factors such as transaction value, geographic location, or unusual activity patterns.

The signature verification subsystem may implement a multi-stage validation process that examines both the cryptographic validity of transaction signatures and the authorization context in which they were generated. In at least one embodiment, this process may include verification of: signature format and algorithm compliance, key validity and revocation status, timestamp freshness, device authorization status, and satisfaction of any additional authorization predicates specified in the account's authorization filter. The system may support multiple signature schemes, potentially including post-quantum cryptographic algorithms, with the specific scheme used for each account potentially being configurable and upgradeable without requiring changes to existing account state.

The key management protocol may implement a hierarchical key derivation system based on standardized algorithms such as BIP32 or similar specifications. This system may enable the generation of multiple key pairs from a single master seed, with each derived key potentially having different usage restrictions or security requirements. The protocol may include mechanisms for secure key backup and recovery, potentially including threshold schemes that require multiple independent parties to cooperate in the recovery process. Keys may be protected at rest using envelope encryption, with the envelope keys potentially stored in secure hardware elements when available.

Security breach prevention mechanisms may be implemented through a real-time risk scoring engine that evaluates multiple risk factors simultaneously. These factors may include, but need not be limited to: authentication attempt patterns, device characteristics, network characteristics, transaction characteristics, and historical behavior patterns. The risk scoring engine may implement machine learning algorithms to adapt to emerging threat patterns, with the scoring weights potentially being adjusted automatically based on observed attack patterns. The engine may trigger additional authentication requirements or implement temporary restrictions when elevated risk is detected.

The administrative override capability may be implemented through a multi-signature smart contract that enforces configurable governance rules. Such rules may require a quorum of authorized administrators to approve high-risk actions, with the specific quorum requirements potentially varying based on the type of action being performed. All administrative actions may be recorded in an append-only audit log secured by the blockchain, with each log entry potentially including cryptographic proof of the authorization decisions that permitted the action.

External identity verification services may be integrated through a standardized adapter interface that normalizes different verification providers' APIs into a common protocol. This interface may support asynchronous verification workflows, allowing for human review steps when required by the verification provider. Verification results may be recorded using a standardized attestation format that includes cryptographic proof of the verification provider's assessment, enabling other participants in the network to independently validate the verification decision.

The progressive security model may be implemented through a state machine that tracks the verification status of each account across multiple independent dimensions. Each state transition may require satisfaction of specific preconditions, which may include both automated checks and manual review steps. The state machine configuration may be upgradeable through a governance process, enabling security requirements to be adjusted as new threats or regulatory requirements emerge.

### Payments and Points of Sale

In accordance with various embodiments of the present invention, methods, systems, and computer-readable media are provided for implementing a comprehensive point-of-sale integration system with multiple payment processing capabilities. The system may incorporate various payment acceptance protocols through a configurable framework, supporting multiple payment methods including, but not limited to: traditional cash and card-based payments, digital wallet integrations, and machine-readable code payments such as QR codes. The system may implement one or more state-based transaction management protocols with comprehensive error handling capabilities, whereby transactions may exist in multiple discrete states with configurable transition rules. Various implementations may include multiple security layers, receipt management subsystems, and specialized handling for different transaction types, potentially incorporating both register flow operations optimized for retail transactions and sale flow operations optimized for service-based transactions. The system may further implement various security measures for protecting sensitive payment information, potentially including distinct security protocols for traditional payment methods and blockchain-based payments.

Embodiments of the present invention may provide numerous technical advantages over conventional point-of-sale systems. The implementation of multiple coordinated payment protocols through a unified framework may enable enhanced flexibility while maintaining robust security controls, potentially reducing integration complexity and implementation costs. Various technical benefits may include, but are not limited to: improved transaction reliability through distributed state management and comprehensive error handling; enhanced security through layered encryption protocols and secure enclaves; streamlined receipt management through configurable templates and multiple distribution channels; and robust protection against system component failures through comprehensive retry mechanisms and reconciliation protocols. The system may further provide technical advantages through its modular architecture, potentially enabling dynamic addition of new payment methods, security measures, and processing capabilities while maintaining operational consistency. Additional benefits may include reduced transaction processing times, enhanced error recovery capabilities, improved audit trail maintenance, and flexible configuration options that may be tailored to specific deployment requirements.

### Payment Methods

In accordance with at least one embodiment of the present invention, a point-of-sale system may implement a plurality of payment acceptance protocols through a configurable payment processing framework. The system may be configured to process each supported payment method through both register flow operations and sale flow operations. Register flow operations may comprise a first set of steps optimized for retail transactions requiring rapid checkout, whereas sale flow operations may comprise a second set of steps optimized for service-based transactions requiring detailed itemization.

The payment methods supported by the point-of-sale system may include, but are not limited to: cash payments requiring physical currency handling and drawer reconciliation; manual card entry payments requiring input of payment card details; digital wallet card payments integrating with virtual payment cards stored in mobile devices; and machine-readable code payments initiated through scanning of dynamically generated codes. One or more of these payment methods may be enabled or disabled through a configuration interface, and additional payment methods may be added through a plugin architecture.

In at least one embodiment, the machine-readable code payment method may incorporate a digital invoice protocol that encodes detailed payment instructions. The point-of-sale system may dynamically generate a machine-readable code, such as a QR code, that encodes transaction parameters including, but not limited to: payment amount; merchant identification; transaction identification; acceptable payment methods; payment routing instructions; and expiration parameters. The code may additionally encode merchant-specified parameters governing which payment methods may be used to satisfy the invoice, including specifications for blockchain-based payment methods, fiat currency methods, or combinations thereof.

When implementing the machine-readable code payment method, the point-of-sale system may generate codes incorporating multiple data fields that enable various payment flows. In at least one embodiment, these fields may include: a merchant identifier that uniquely identifies the recipient of funds; a transaction identifier that uniquely identifies the payment obligation; a payment amount; a currency identifier; an expiration time; and a cryptographic signature that validates the authenticity of the encoded data. The system may also embed within the code one or more uniform resource identifiers that specify endpoints for submitting payment details, along with parameters indicating what payment methods are accepted at those endpoints.

The point-of-sale system may implement differential processing flows for various transaction modifications including refunds, voids, and payment adjustments. These flows may be customized based on the original payment method used and the current transaction state. The system may maintain an audit trail of all transactions that captures payment method details, authorization codes, settlement status, and subsequent modifications. For cash transactions, the system may implement specialized handling including drawer counts, reconciliation, and over/short tracking. For card-based transactions, whether entered manually or processed through a digital wallet, the system may maintain encrypted records of authorization responses, capture status, and settlement confirmation.

A comprehensive security framework may be implemented that applies payment-method-specific security controls. For card-based transactions, this may include point-to-point encryption of card details, secure storage of authorization data, and truncation of displayed account numbers. For machine-readable code payments, this may include cryptographic signing of generated codes, time-based code expiration, device fingerprinting of scanning devices, and validation of payment authorization messages. Each payment method may be associated with a specific security profile that defines required controls, and these controls may be centrally managed through a security administration interface.

The point-of-sale system may incorporate a configurable receipt generation subsystem that produces payment method appropriate documentation. This subsystem may generate receipts containing transaction-specific data fields based on both the payment method employed and merchant-specified preferences. The receipts may be generated in various formats including printed receipts, email receipts, mobile text message receipts, and digital wallet receipts. Delivery preferences may be configured globally or per payment method, and multiple receipt formats may be generated for a single transaction. The receipt content may be customized through templates that specify both required and optional data fields for each payment method and format combination.

### Transaction States & Error Handling

In accordance with various embodiments of the present invention, a point-of-sale (POS) integration protocol may implement a state-based transaction management system with comprehensive error handling capabilities. The protocol may define discrete transaction states and permissible state transitions, while implementing safeguards to maintain transaction integrity during system component failures, communication interruptions, or other error conditions.

The protocol may maintain transaction state information through a distributed state management architecture. In at least one embodiment, state information may be persisted in a local POS terminal database, one or more intermediate transaction processing servers, and a central transaction management system. Each component in the distributed architecture may maintain an independent state record, with state synchronization occurring through a defined reconciliation protocol. The redundant state storage may enable transaction recovery and reconciliation even when arbitrary system components become unavailable.

The initiation of any new transaction may follow a multi-phase commit protocol to ensure transaction consistency. In various embodiments, if server unavailability is detected during transaction initiation, the POS terminal may create a pending transaction record in its local database. This record may include, but is not limited to: a unique transaction identifier, timestamp, transaction type, amount, currency, merchant identifier, terminal identifier, and customer account information. The terminal may implement a configurable retry mechanism that attempts to synchronize pending transactions with the server. The retry mechanism may utilize an exponential backoff algorithm with configurable initial delay, maximum delay, and maximum retry attempts.

For managing refund operations during server unavailability, the system may implement a deferred refund processing mechanism. In at least one embodiment, refund requests may be recorded in an atomic transaction log maintained locally at the POS terminal. Each atomic transaction record may encapsulate the complete refund context, including but not limited to: the original transaction identifier, refund amount, refund reason code, authorization tokens, timestamp, terminal identifier, operator identifier, and any additional transaction metadata. Upon restoration of server connectivity, the system may process queued refund requests according to configurable prioritization rules.

Void transaction handling during server unavailability may implement additional safeguards due to the irreversible nature of void operations. The system may define a “tentative void” state that indicates a void operation has been locally requested but not yet confirmed by the server. In various embodiments, transactions in the tentative void state may be subject to additional restrictions, including but not limited to: prevention of further modifications, blocking of refund operations, and suspension of settlement processing. These restrictions may remain in effect until server connectivity is restored and the void operation is either confirmed or rejected.

A comprehensive transaction audit subsystem may record all transaction events, state transitions, and error conditions. In accordance with at least one embodiment, the audit records may include: transaction identifiers, timestamps, terminal identifiers, operator identifiers, transaction details, error codes, error messages, retry attempt counts, and state transition history. The audit subsystem may implement tamper-evident logging mechanisms to ensure the integrity of the audit trail for reconciliation and compliance purposes.

Transaction monitoring capabilities may be implemented through a dedicated monitoring subsystem. This subsystem may detect transactions that remain in intermediate states beyond configurable time thresholds. In various embodiments, the monitoring subsystem may implement different monitoring rules, thresholds, and alerting mechanisms based on transaction type, amount, current state, merchant category, or other transaction attributes. Detection of stuck transactions may trigger automated recovery procedures and generate alerts through configurable notification channels.

The system may implement automated reconciliation procedures that execute upon restoration of system connectivity. These procedures may perform a hierarchical comparison of transaction records across system components to identify state inconsistencies. In at least one embodiment, the reconciliation process may analyze transaction records, state information, and audit logs to determine the authoritative state of each transaction. The process may then initiate appropriate remediation actions according to configurable business rules, with different rules potentially applying to different transaction types, states, and error conditions.

Various embodiments may include a guaranteed message delivery subsystem that ensures critical transaction messages are not lost during system outages. This subsystem may implement persistent message queues with automatic retry capabilities. In at least one embodiment, each message may be assigned a cryptographically secure unique identifier and may include a digital signature to prevent unauthorized modification. The message queues may survive system restarts and implement deduplication mechanisms to prevent duplicate message processing during retries.

### Receipt Handling

In accordance with at least one embodiment of the present invention, a point-of-sale (POS) system may include a receipt management subsystem configured to generate, process, store and distribute digital transaction records. The receipt management subsystem may include one or more processing modules that operate together to handle various aspects of receipt generation and management for different types of financial transactions, including but not limited to cash transactions, credit card transactions, contactless payments, mobile wallet payments, and other payment methods that may be implemented within the POS system.

The receipt management subsystem may, in various embodiments, implement different receipt handling protocols based on transaction flow type, whereby distinct processing logic may be applied to transactions initiated through a register flow as compared to transactions initiated through a sale flow. A transaction classifier module may analyze incoming transaction data to determine the appropriate flow type, and may route the transaction to appropriate receipt generation logic based on this classification. The classifier may examine various transaction attributes including, but not limited to, the point of initiation, the terminal type, the payment method, the transaction amount, and other relevant characteristics that may influence receipt generation and handling.

In at least one embodiment, the receipt management subsystem may include a template management module configured to maintain and apply different receipt templates based on transaction characteristics. The template management module may store multiple template variations for each supported transaction type, with each template specifying required and optional receipt fields, formatting rules, branding elements, and other presentation characteristics. Templates may be defined hierarchically, with base templates being extended or modified to create specialized templates for specific transaction scenarios.

The receipt management subsystem may, in various implementations, include a distribution orchestration module configured to manage the transmission of receipt data through multiple communication channels. The distribution orchestration module may implement channel-specific formatting and delivery protocols for various distribution methods including, but not limited to, electronic mail transmission, short message service (SMS) delivery, multimedia messaging service (MMS) delivery, near-field communication (NFC) transfer, direct printing, or other suitable delivery mechanisms. The distribution orchestration module may be configured to attempt multiple delivery methods in a specified sequence until successful delivery is confirmed.

In accordance with one or more embodiments, electronic mail distribution may be handled by a specialized email receipt processor that implements various email-specific handling features. The email receipt processor may support multiple email formats including rich text, HTML, and plain text, with automatic format selection based on detected client capabilities. The processor may implement retry logic with configurable retry intervals and maximum attempt limits. Recipients may be specified directly or determined through database lookup based on transaction details such as payment card numbers, loyalty program identifiers, or other customer identification data.

Additionally or alternatively, in some embodiments, SMS/MMS distribution may be handled by a messaging receipt processor that implements various mobile messaging-specific features. The messaging receipt processor may automatically segment long receipts into multiple messages when necessary, with appropriate sequencing and continuation indicators. The processor may support both text-only and multimedia formats, with automatic selection based on device capabilities and user preferences. The processor may implement carrier-specific formatting rules and respect carrier-specific message size limits.

The receipt management subsystem may, in various embodiments, include a storage management module configured to maintain a secure repository of receipt records. Each receipt record may include multiple data elements including, but not limited to, the raw transaction data, generated receipt content in multiple formats, delivery status tracking, and various metadata elements describing the transaction context. The storage management module may implement configurable data retention policies that specify storage duration, archival rules, and deletion protocols for different categories of receipt records. The module may support both online and offline storage, with automatic migration between storage tiers based on age and access patterns.

In at least one embodiment, the receipt management subsystem may implement distinct receipt generation logic for different payment methods, with specialized handling for cash transactions versus card-present transactions versus card-not-present transactions versus mobile wallet transactions. The generation logic may automatically include appropriate payment-method-specific fields such as cash tendered and change returned for cash transactions; card type, truncated card number, and authorization codes for card transactions; or wallet identifiers and confirmation codes for mobile transactions. The generation logic may also apply payment-method-specific formatting and layout rules to optimize receipt readability for each payment type.

### Security Measures

In various embodiments, the point-of-sale integration system implements multiple layers of security measures to protect sensitive payment information. The system may process both traditional payment methods, such as payment cards, and blockchain-based payments, with each payment type potentially having distinct security requirements and implementations.

Settlement accounts associated with traditional payment methods may be secured through various encryption mechanisms. In one embodiment, settlement account numbers stored within the system's database may be encrypted using one or more encryption algorithms, which may include, but are not limited to, AES-256 encryption, RSA encryption, or other suitable encryption protocols. The encryption keys used for securing settlement account data may be stored separately from the encrypted data, potentially in a secure hardware module, dedicated key management system, or hardware security module (HSM).

In certain embodiments, when displaying payment card information in user interfaces, receipts, or other visual presentations, the system may implement automatic number masking. For example, a sixteen-digit payment card number may be displayed with only the final four digits visible (e.g., “xxxx xxxx xxxx 5420”), with the first twelve digits obscured. In contrast, blockchain addresses used for payments may be displayed in their complete form, as these addresses are designed to be publicly visible within the blockchain network and do not present the same security concerns as traditional payment credentials.

Blockchain payment authorization may be implemented through digital signature schemes that require the use of cryptographic private keys. In various embodiments, these private keys may be stored within a secure enclave or trusted execution environment on the user's device. The secure enclave may be implemented in hardware, software, or a combination thereof, and may be designed to prevent unauthorized access to the private keys, even if other portions of the device are compromised. The secure enclave may incorporate various security measures including, but not limited to, memory encryption, secure boot processes, and hardware-based key storage.

One or more embodiments may require physical possession of the device containing the secure enclave for blockchain payment authorization. This requirement may be enforced by implementing a security protocol wherein the private keys never leave the secure enclave, and digital signatures are generated within the secure enclave itself. This approach may ensure that even if a malicious actor gains remote access to the device, they cannot authorize blockchain payments without physical access to the device containing the secure enclave. The secure enclave may additionally implement biometric authentication, personal identification numbers (PINs), or other access controls before permitting key usage.

The system may implement selective encryption based on payment type and data sensitivity. Traditional payment data, including but not limited to payment card numbers, expiration dates, and security codes, may be encrypted both in transit and at rest. Settlement account details may likewise be encrypted when stored in the system's database. In contrast, blockchain payment data such as public addresses and transaction hashes may not require encryption, as these elements are designed to be publicly visible within the blockchain network. Moreover, blockchain records and transactions that embody payments need not be encrypted, as the blockchain protocol itself ensures their integrity through cryptographic mechanisms other than encryption.

All communication channels used for transmitting payment data of any type may be secured using transport layer security (TLS) or similar protocols. The system may implement multiple layers of transport security, potentially including, but not limited to, mutual TLS authentication, certificate pinning, and perfect forward secrecy. These security measures may be applied uniformly across all payment types to ensure consistent protection of communication channels, even when the underlying payment data itself may not require encryption.

In some embodiments, the system may implement additional security measures for blockchain payments, such as transaction amount limits, velocity checking, or multi-signature requirements. These security measures may be configurable and may vary based on factors including, but not limited to, transaction amount, merchant type, user history, time of day, or geographic location. The implementation of these security measures may be managed through smart contracts deployed on the blockchain, through the point-of-sale system itself, or through a combination of both approaches.

The system may maintain audit logs of all security-relevant events, including but not limited to payment authorizations, encryption key usage, secure enclave access attempts, and security parameter modifications. These audit logs may be stored securely and may be encrypted to prevent unauthorized access or manipulation. The audit logging system may be configured to track both successful and unsuccessful attempts to access secured components or authorize payments, potentially providing early warning of attempted security breaches. The audit logs may be stored in a distributed manner across multiple secure storage locations.

Various embodiments may implement different combinations of these security measures, and additional security measures may be added to address specific threats or comply with evolving security requirements. The security measures described herein may be implemented individually or in combination, and may be modified or enhanced based on specific deployment requirements, risk assessments, or regulatory requirements. The system may be designed to allow for the addition of new security measures or the modification of existing measures without requiring significant architectural changes.

### QR Code Integration

In accordance with at least one embodiment of the present invention, a point-of-sale (POS) integration system may include one or more components for generating and processing machine-readable codes. Such machine-readable codes may include, in at least one embodiment, Quick Response (QR) codes that facilitate secure payment transactions. The system may generate such codes dynamically, incorporating various transaction parameters, authentication data, and merchant identification information required to validate and process payment transactions.

A merchant terminal or POS device in accordance with various embodiments may include a code generation module configured to generate machine-readable codes encoding multiple transaction parameters. Such parameters may include, but are not limited to: a transaction amount, a merchant identifier, a terminal identifier, a unique transaction reference, timestamp data, and payment routing information. The generated code may additionally incorporate a transaction type indicator that specifies the nature of the requested operation, where such operations may include one or more of: a sale transaction, a registration transaction, a refund transaction, or other transaction types as may be implemented within the system.

In accordance with at least one embodiment, the system may implement a registration protocol utilizing machine-readable codes. When a merchant device or terminal initiates a registration sequence with the payment processing network, the system generates a registration code incorporating various configuration parameters. Such parameters may include, but are not limited to: device identification data, merchant authentication credentials, network configuration settings, and security certificates. A merchant device may acquire this registration code using an optical scanning module or similar input mechanism to initiate a device registration process.

The system may implement a sales transaction protocol whereby a POS terminal generates a payment code incorporating encrypted transaction details. Such a code may be presented on a display device for acquisition by a customer's mobile device executing a payment application. Upon acquisition of the code, the payment application may extract the embedded transaction parameters and merchant data, presenting such information to the customer for verification before initiating payment authorization procedures.

Machine-readable codes generated by the system may incorporate various security mechanisms. Such mechanisms may include, but are not limited to: encrypted payload data, cryptographic signatures, time-based validation parameters, and unique transaction reference codes. The system may validate these security mechanisms when processing acquired codes to ensure data integrity and transaction authenticity. In at least one embodiment, the security mechanisms may be configured to prevent replay attacks by incorporating time-sensitive validation parameters.

A payment application in accordance with various embodiments may include specialized code processing capabilities. Such capabilities may include automated code detection algorithms, security validation procedures, and transaction parameter extraction functions. The application may process multiple code formats, including but not limited to: payment codes, registration codes, and various other specialized formats implemented within the system. The application may implement different processing workflows based on the detected code type.

The system may implement a multi-stage validation protocol when processing acquired codes. Such protocol may include: validating code structure and format specifications, decrypting encoded data elements, verifying cryptographic signatures, and validating transaction parameters against backend systems. The system may be configured to terminate transaction processing if any validation stage fails, generating appropriate notification messages to relevant parties.

In at least one embodiment, code processing may incorporate origin validation procedures. Upon code acquisition, the system may validate the originating merchant's identity and authorization status. Subsequently, it may process any encrypted elements and verify integrity signatures. The system may then validate transaction parameters against configured limits and restrictions before proceeding with transaction authorization.

The system may maintain transaction records related to code generation and processing operations. Such records may include audit logs of generated codes, acquisition events, validation results, and transaction outcomes. These records may be utilized for various purposes including, but not limited to: transaction reconciliation, system auditing, and performance optimization. The system may implement configurable retention policies for such records.

In accordance with various embodiments, the system may support multiple code formats and standards. The system may generate and process codes conforming to industry-standard specifications while also supporting proprietary formats incorporating enhanced security features or additional transaction parameters. The system may implement format detection and conversion capabilities to ensure compatibility across different implementation standards.

### Transaction States

In accordance with various embodiments of the present invention, transactions processed within the system may exist in multiple states, with state transitions occurring based on specific events and conditions within the blockchain network and associated systems. The specific states and transitions described herein represent non-limiting examples of possible implementations, and different embodiments may incorporate additional states, fewer states, or alternative state configurations.

In at least one embodiment, a transaction may initially enter a “Pending” state upon submission to the system. During this state, the transaction details may be validated and prepared for blockchain inclusion, but the transaction has not yet been submitted to the blockchain network. The pending state may serve as a preliminary validation phase where various checks, including but not limited to balance verification, authentication validation, and format validation may be performed. The specific validation checks performed during the pending state may vary based on transaction type, network configuration, and system requirements.

Following successful preliminary validation, the transaction may transition to an “Added to miner pool” state. In this state, the transaction has been submitted to the blockchain network's transaction pool and awaits inclusion in a block by mining nodes. The duration of this state may vary depending on multiple factors, which may include but are not limited to: network conditions, transaction fees, mining difficulty, network congestion, priority settings, or other factors that may influence mining priority.

Upon inclusion in a blockchain block by a mining node, the transaction may enter a “Mined|Pending” state. This compound state indicates that while the transaction has been included in a block, it has not yet reached finality. The specific criteria for determining finality may vary across different embodiments. In some implementations, finality may be determined based on a configurable number of block confirmations following the block containing the transaction. In other implementations, finality may be determined based on the participation of specific validator nodes in confirming the transaction. Yet other implementations may determine finality based on elapsed time, consensus mechanisms, or combinations of multiple criteria.

By way of non-limiting example, finality determination may include one or more of the following approaches: (a) waiting for a specified number of block confirmations, such as six blocks in some cryptocurrency networks; (b) requiring approval from a threshold percentage of validator nodes, such as two-thirds of active validators; (c) waiting for checkpoint blocks that are specially designated within the blockchain protocol; (d) utilizing time-based finality where transactions are considered final after a specified time period has elapsed; (c) implementing economic finality where the cost of transaction reversal becomes prohibitively expensive; or (f) employing hybrid approaches that combine multiple finality criteria.

In various implementations, a transaction may enter a “Cancelled| Refund in progress” state if cancellation is requested or required. This state may be triggered by various events, including but not limited to: user request, system timeout, detection of irregular activity, insufficient funds, network issues, or compliance concerns. During this state, the system may initiate refund procedures to return funds to the originating account while maintaining transaction records for audit purposes. The specific refund procedure may vary based on the transaction type, the stage at which cancellation occurs, and the underlying payment methods involved.

A transaction may transition to a “Cancelled” state upon successful completion of any required refund processes. In this state, the transaction is considered fully reversed, with all necessary balance adjustments and record updates completed. The system may maintain records of cancelled transactions for historical and compliance purposes. In at least one embodiment, the cancellation records may include metadata indicating the reason for cancellation, timing of the cancellation, and any relevant compliance or audit information.

Upon reaching finality according to the implemented criteria, a transaction may enter a “Success” state. This state indicates that the transaction has been fully validated, confirmed, and finalized on the blockchain. In at least one embodiment, transactions in the Success state may be considered immutable and may serve as a basis for subsequent transactions or operations within the system. The specific implications of the Success state may vary based on the implementation and may include triggering of downstream processes, notifications, or system updates.

The state transition system may include additional validation checks, intermediate states, or parallel state tracking mechanisms depending on the specific requirements of the implementation. These may include, but are not limited to: compliance checks, fraud detection measures, synchronization procedures between various system components, external system validations, or regulatory reporting requirements. The system may maintain multiple state tracking mechanisms simultaneously to satisfy different technical, operational, or regulatory requirements.

In accordance with one or more embodiments, each state transition may trigger notifications to relevant system components, external systems, or user interfaces. These notifications may include, but are not limited to: status updates, confirmation messages, error notifications, requests for additional user action, compliance alerts, or system monitoring updates. The specific notification requirements and mechanisms may be configurable based on system requirements, user preferences, or regulatory obligations.

State transition rules may be implemented through one or more state machines, with configurable transition conditions and validation requirements. The specific requirements for state transitions may be adjusted based on various factors including, but not limited to: transaction type, value, user history, system configuration parameters, network conditions, regulatory requirements, or risk management policies. The state machine implementation may support dynamic updating of transition rules and conditions to accommodate changing system requirements or regulatory obligations.

### Certain Payment Request Encoding Strategies

Various embodiments of the present invention provide systems, methods, and computer-readable media for implementing a universal payment request encoding system. The system may encode payment requests in one or more machine-readable formats, including, but not limited to, UR1 formats, QR code formats, or any suitable combination thereof. In various embodiments, the encoded payment request comprises a plurality of configurable components that may be selectively combined to facilitate interoperable payment processing across heterogeneous payment networks and systems.

In one or more embodiments, the encoded payment request includes at least one payment specification component selected from: a payment amount indicator, a currency or token type identifier, and a unique request identifier. The unique request identifier may comprise a universally unique identifier (“UUID”) or other suitable unique identification mechanism configured to associate subsequent payment transactions with their corresponding payment requests. The payment specification components may be encoded according to one or more standardized formats, and the specific arrangement of components within the encoded payment request may differ among various embodiments.

In certain embodiments, the encoded payment request may further comprise one or more blockchain specification components in certain embodiments. Such blockchain specification components may include at least one blockchain network identifier and at least one account identifier indicating a designated payment destination. In various implementations, the specified account may include one or more capability annotations, wherein such annotations may indicate, for example, payment forwarding capabilities. Account capabilities may be verified through one or more mechanisms, including but not limited to, token issuer verification, blockchain-based verification, or other suitable verification protocols.

In various embodiments, the encoded payment request includes one or more configurable asynchronous payment parameters. Such parameters may include, for example, an asynchronous acceptance indicator configured to specify whether direct blockchain transfers to the designated account are permitted to occur asynchronously. When the asynchronous acceptance indicator is configured to prohibit asynchronous payments, an embodiment may restrict payment processing to synchronous methods, such as payments processed through designated uniform resource identifiers (URIs). In implementations where asynchronous payments are prohibited, an embodiment may require enablement of one or more rapid settlement capabilities, such as payment channel network functionality.

In certain high-traffic or real-time payment environments, an embodiment may require asynchronous payment processing to be disabled. For such embodiments, the asynchronous acceptance indicator (“acceptAsync”) may be explicitly set to false within the encoded payment request. Disabling asynchronous acceptance ensures that payments are processed synchronously through predetermined payment methods, such as direct URI-based payments or integrated payment gateways. This configuration is particularly critical in scenarios where instantaneous confirmation of payment is required to maintain operational efficiency, such as retail checkouts or other high-volume transactional contexts.

When “acceptAsync” is configured as false, the system enforces synchronous payment processing capabilities to support the operational context. In such implementations, the encoded payment request may specify the mandatory inclusion of high-speed settlement mechanisms, such as payment channel network capabilities. This ensures that real-time environments maintain seamless payment operations without delays associated with asynchronous blockchain transaction confirmation. The system may also enforce additional constraints on routing and payment methods to optimize transaction speed and reliability in these scenarios.

One or more payment responsibility parameters may be included in the encoded payment request according to various embodiments. Such parameters may be configured to specify whether a payment amount is to be satisfied by a customer (“customer satisfaction” scenario), or to be paid by a customer (“customer payment” scenario). In customer satisfaction configurations, the system may enable customer selection from among multiple available payment routes based on one or more criteria, such as transaction speed, cost efficiency, or other customizable preferences. In customer payment configurations, the system may enforce merchant-specified restrictions on payment methods and currencies, with various fee and conversion arrangements being determinable based on selected payment methods.

In certain configurations, cost-sharing arrangements between customers and merchants may be implemented to address payment method limitations. When the encoded payment request specifies a “customer to pay” configuration, and the customer does not have access to the specified payment methods or currencies, the system may allocate transaction costs proportionally. Specifically, the customer may incur costs associated with the payment up to the integration point, such as conversion or transaction fees for alternative payment methods.

Beyond the integration point, the merchant may bear any additional costs necessary to complete the payment processing. These arrangements ensure equitable cost distribution while facilitating payment acceptance across diverse methods and currencies.

The encoded payment request may optionally include one or more payment forwarding specifications in certain embodiments. When forwarding specifications are included, the payment request may comprise a cryptographic signature associated with a destination account, wherein the payment request is generated by a designated forwarding account. The destination account may be subject to verification through one or more mechanisms, including but not limited to, blockchain-based annotation, token issuer status verification, or other suitable verification protocols. In embodiments specifying both forwarding information and a processing URI, the system may verify, validate or confirm a destination account consistency through one or more account confirmation APIs.

In various embodiments, the encoded payment request may specify one or more payment processing URIs. Such URIs may be configured to implement multiple payment processing APIs and may declare available services through one or more service discovery mechanisms. The implemented APIs may comprise any combination of: mining APIs, payment sending APIs, payment spending APIs, and account ownership confirmation APIs. In certain implementations, account ownership confirmation APIs may expose account information verifiable through blockchain mechanisms as authorized for payment operations, such verification being achievable through issuer status confirmation, special endorsements, or other suitable verification methods.

In one or more embodiments, the encoded payment request comprises configurable routing specifications. Such routing specifications may indicate one or more preferred payment routes or methods, and may, in certain embodiments, include parameterized instructions regarding route selection in payment channel network negotiations. The encoded payment request includes routing specifications in customer payment configurations; whereas in customer satisfaction configurations, routing may default to customer-selected parameters except in cases involving payment channel network transactions. The routing specifications may further comprise prohibited route indicators configured to exclude specific payment methods, such as cases where payment channel network connectivity is unavailable or unsuitable.

Various embodiments implement multiple payment methods and routes. One such implementation comprises direct on-chain blockchain payments to specified accounts via general network infrastructure, wherein such payments may optionally include request identifiers encoded within transaction metadata when supported by the underlying protocol. Such payments may be restricted to asynchronous processing in certain implementations. The specified destination accounts may be configured for direct merchant control enabling instant settlement, or alternatively, may be controlled by merchant gateway systems implementing off-chain merchant account crediting mechanisms.

Payment forwarding functionality may be implemented via third-party blockchain connectivity in certain embodiments, enabling direct wallet-to-gateway payment transmission. Such forwarding capabilities may be restricted to asynchronous implementations wherein receiving accounts possess verified forwarding capabilities, such verification being established through issuer status confirmation, blockchain-based certification, or other suitable mechanisms. These implementations may require inclusion of cryptographically valid recipient account signatures within the payment request.

Various embodiments may implement enhanced blockchain payment processing, wherein payment-related messages are transmitted to designated endpoints. Such implementations may comprise standard blockchain payments augmented with endpoint-based risk-weighted decision systems for payment acceptance. Asynchronous operations may be enabled based on service profile declarations associated with specified endpoints, and the system may optionally include on-chain payment forwarding as an enhanced capability.

Payment channel network implementations may be processed through various mechanisms according to different embodiments. Such implementations may enable synchronous payments directed to specified on-chain accounts, wherein said accounts may be configured either for direct merchant control enabling instant settlement, or for gateway control implementing off-chain merchant account crediting. Alternative implementations may process payments through gateway systems in a synchronous manner, wherein specified addresses are associated with merchant gateway systems and payment identification is facilitated through request identifier correlation.

In various embodiments, the system implements spend money or send money web service endpoint interactions between user wallet systems and designated servers. Such implementations may be compatible with multiple send money protocols and may comprise various operational modes, including but not limited to: spend-to-wallet operations supporting non-wallet funding sources, wallet-to-external transfers, and send-to-external transactions. These operations may be processed synchronously when involving trusted server implementations, and may require point-of-sale integration in certain configurations.

One or more embodiments may implement custom spend money or send money web service endpoints configured for managed wallet operations. Such implementations may expose any payment methods integrated within the managed wallet infrastructure and may support various forwarding information configurations. The specific configuration of such endpoints of may differ among various embodiments.

In various embodiments, the system supports spendMoney or sendMoney web service interactions through customizable web service implementations. Such implementations enable diverse operational modes to accommodate various payment processing arrangements and configurations. For example, spend-to-wallet operations may facilitate transactions where non-wallet funding sources are utilized to credit the user's wallet account. Similarly, wallet-to-external operations may support direct transfers from a user's wallet to external accounts, including those belonging to merchants or service providers.

Additionally, send-to-external transactions may allow users to initiate payments directly from their wallet systems to designated recipients without intermediary funding operations. These operational modes may support synchronous payment processing in configurations involving trusted server interactions. For example, spend-to-wallet and send-to-external operations may be executed in real-time when integrated with point-of-sale (POS) systems capable of verifying transaction authenticity and completion through predefined APIs.

Custom spendMoney or sendMoney web service endpoints may also include managed wallet operations that expose payment methods available within the wallet's infrastructure. These methods may optionally incorporate payment forwarding specifications, enabling seamless integration with external accounts or systems. In various embodiments, endpoints may be configured in different ways to support enhanced payment flexibility across heterogeneous systems and networks.

Various embodiments implement QR code translation mechanisms capable of processing third-party or non-standard QR codes through server-based interpretation systems, wherein such codes may be processed as payment forwarding instructions. The translation mechanisms may encode such instructions according to one or more standardized formats suitable for payment processing.

In one or more embodiments, the system implements advanced QR code translation mechanisms to handle non-standard or third-party QR codes through server-based interpretation systems. Such QR codes may be treated as forwarding instructions, with translation performed to ensure compatibility with the system's payment request encoding standards. This server-side processing capability enables seamless payment forwarding, ensuring that non-standard QR codes are properly integrated into the universal payment ecosystem.

The QR translation mechanism may support various formats and encodings, transforming third-party QR data into standardized payment request formats. This includes, but is not limited to, parsing encoded instructions for forwarding payments to designated accounts, verifying forwarding capability through blockchain annotations or cryptographic signatures, and generating compliant QR codes for further processing. By leveraging server-side interpretation, the system ensures robust support for non-standard payment scenarios, thereby enhancing interoperability and usability across diverse payment infrastructures.

In one or more embodiments, the system implements a universal connector infrastructure enabling interoperability between heterogeneous wallet systems and merchant systems. Wallet system implementations may include functionality for processing unknown payment QR codes through universal translator interactions, potentially receiving standardized universal QR codes in response. Such universal QR codes may facilitate direct merchant payments, gateway-based payments, or payment processing through alternative provider systems. The system may implement various verification procedures according to various embodiments.

In one or more embodiments, the system implements universal connector functionality enabling interoperability between heterogeneous wallet systems and merchant systems. When a wallet system encounters an unknown payment QR code, it may transmit the code to a designated universal translator endpoint. The universal translator processes the unknown QR code and returns a standardized universal QR code that the wallet system can recognize and process.

The universal QR code may be configured to facilitate one or more payment flows, including direct payments to merchant systems, gateway-based transactions, or payments routed through alternative service providers. The returned QR code is compatible with wallet systems that support universal encoding, ensuring seamless payment processing across diverse platforms.

Verification mechanisms may be implemented to validate universal QR code generation and usage. Such mechanisms may include cryptographic signature validation, blockchain-based annotations, and issuer status verification. These verification steps ensure the integrity and reliability of the universal QR code system, enabling robust payment processing in both synchronous and asynchronous environments.

Merchant system implementations within the universal connector infrastructure may operate through various mechanisms. Such implementations may establish contractual relationships with direct conversion providers or, alternatively, may implement conversion services for payment request encoding transformation. The system may be configured to process transfers through intermediated pathways wherein QR codes reflect third-party forwarding services, or through direct pathways wherein payment details reference merchant or merchant gateway systems.

In various embodiments, the encoded payment request specifies one or more payment processing URIs configured to declare available services. Such URIs may implement a service discovery mechanism through which designated APIs and functionalities are made accessible to external systems. These APIs may comprise, but are not limited to, miner APIs, spendMoney/sendMoney APIs, and ownership confirmation APIs. Each API declaration provides structured access to payment processing capabilities, enabling seamless integration with heterogeneous payment systems.

The miner API may facilitate integration with computational resources necessary for certain blockchain networks, while the spendMoney/sendMoney API supports direct payment interactions between the encoded payment request and managed wallet systems. Ownership confirmation APIs may provide mechanisms for verifying account control through blockchain-based methods, such as cryptographic signatures or issuer verification protocols. Service discovery may include metadata declarations or schema references to ensure compatibility across multiple implementations.

In some implementations, the declared services may be integrated with risk-weighted decision-making systems to enhance payment processing efficiency and security. For example, endpoints publishing these APIs may dynamically evaluate transaction parameters, such as payment source authenticity or route feasibility, before confirming or denying the payment. These mechanisms facilitate robust payment processing while maintaining interoperability across diverse payment infrastructures.

In various embodiments, wallet systems integrate with universal connector infrastructure to enhance payment interoperability. The universal connector infrastructure may comprise server-side logic for processing QR code translations. Upon receiving an unknown QR code, the system may evaluate the encoded payment details, apply standardized formatting rules, and generate a compatible universal QR code in real-time.

The translated universal QR code may comprise parameters specifying the intended payment destination, transaction metadata, and forwarding instructions. These parameters enable seamless payment execution while maintaining interoperability between incompatible systems. For example, the system may handle scenarios involving multi-hop payment flows, where the universal QR code reflects intermediate routing information for payment forwarding or gateway integration.

Additionally, universal connectors may expose configuration options for participating merchant systems, enabling merchants to define acceptance policies, supported payment methods, and integration with third-party processing services. These configurations ensure that the universal QR code aligns with the specific requirements of the merchant and their payment ecosystem.

Various embodiments implement a universal registry system comprising routing infrastructures for mapping payment request patterns to translator URIs. Such implementations may utilize standardized JSON web service services and may be integrated with UR1 shortening APIs in certain configurations. The system may support blockchain account annotation with pattern information and may enable publication of conversion service URIs associated with such accounts.

The system supports various payment modalities, including implementations facilitating transactions between blockchain-enabled recipients and spenders operating blockchain-compatible wallets without direct blockchain access. The system may implement different payment flows and processing mechanisms based on the specific capabilities and requirements of participating entities within the payment ecosystem.

The system supports flexible payment flows to accommodate scenarios where customers or merchants encounter integration-related costs. When a payer's wallet or payment method lacks compatibility with the recipient's required methods, the system may impose conversion or network usage fees on the customer up to a designated integration threshold. Beyond this threshold, additional costs for completing the transaction are assumed by the merchant. This design ensures seamless transaction processing while mitigating compatibility-related challenges in heterogeneous payment ecosystems.

In various embodiments, the system comprises configurable components that may be combined in different arrangements to support diverse payment processing requirements. The specific combination of components may be determined based on implementation-specific requirements, and individual components may be included zero, one, or multiple times within a given implementation.

In one or more embodiments, the universal registry system incorporates regex-based mapping mechanisms for routing payment request patterns to specific translator URIs. These mechanisms enable efficient association of incoming payment requests with their respective universal translator endpoints. Regex mapping allows payment request formats to be defined using standardized pattern recognition, ensuring compatibility with diverse encoding systems and implementation-specific requirements.

According to one or more embodiments, the regex mapping mechanism facilitates seamless interoperability between heterogeneous payment systems by enabling universal translators to dynamically interpret and process non-standard or proprietary request formats. For instance, payment requests encoded in legacy systems or region-specific formats may be matched to appropriate translator URIs based on predefined regex patterns. These patterns may be stored within the registry system and updated dynamically to accommodate evolving payment standards and network requirements.

In certain embodiments, translator URIs mapped via regex may be deployed as standardized web services. These web services may integrate with UR1 shortening APIs or similar mechanisms to enhance system efficiency and reduce data transmission overhead. Blockchain accounts associated with payment requests may optionally include annotations specifying regex patterns and corresponding translator URIs, further streamlining payment request routing and translation processes.

The incorporation of regex mapping within the universal registry ensures scalability and adaptability, enabling the system to support an expansive range of payment modalities and network configurations. By leveraging this approach, the registry can dynamically align diverse payment ecosystems under a unified processing framework.

### Cross-Device Profile Synchronization

Various embodiments of the present invention relate to systems and methods for synchronizing user profile information across multiple computing devices in a distributed network environment. More particularly, but not exclusively, embodiments described herein provide mechanisms for maintaining consistent user profile data and authentication credentials across a plurality of devices while preserving security and data privacy through novel combinations of distributed storage, blockchain-based verification, and secure synchronization protocols.

Traditional approaches to managing user profiles across multiple devices often rely on centralized databases that store complete copies of user profile information, potentially exposing sensitive data to security risks and typically requiring users to manually update their information on each device, leading to inconsistencies and poor user experience. In various implementations, a system for cross-device profile synchronization may address these limitations through one or more centralized servers configured to coordinate profile data synchronization between two or more user devices, wherein each device may maintain local storage of profile information, and one or more blockchain networks for storing validated identity information and maintaining an immutable record of profile verification states.

In one or more embodiments, the system provides mechanisms for automatically propagating profile updates across authorized devices while maintaining cryptographic proofs of identity verification, employing various security measures including, but not limited to, encryption of sensitive data, multi-factor authentication, and blockchain-based validation of identity claims. Benefits provided by various embodiments may include enhanced security through distributed storage of profile data, improved user experience through automatic synchronization, reduced risk of profile inconsistencies, and robust identity verification through blockchain integration. The system may allow for flexible configuration of synchronization policies, enabling organizations to implement varying levels of security and verification requirements based on their specific needs, while also providing mechanisms for managing multiple identity verification states across different contexts or jurisdictions.

### Cross-Device Profile Synchronization Contact Storage Architecture

In accordance with at least one embodiment of the present invention, a cross-device profile synchronization system may comprise a distributed architecture including one or more client storage components and one or more server storage components operating in communication with each other via one or more networks. The client storage components may be implemented within mobile devices, desktop computers, or other computing devices, and may serve as local authoritative sources of contact records, whereby the most current version of contact information is maintained at the client level, with any modifications to contact data occurring primarily through client-side operations.

The server storage component may be implemented using one or more relational databases, distributed storage systems, key-value stores, or other data repositories suitable for maintaining contact records across multiple user accounts and devices. In various embodiments, this server storage functions as a global synchronization point enabling contact record information to be shared among multiple client devices associated with the same user account or with different user accounts having appropriate permissions. The server storage may maintain, for each contact record, both the current state of the record and a history of modifications to enable conflict resolution and audit capabilities.

The system may implement a multi-phase synchronization protocol whereby modifications to contact records in client storage are propagated to the server storage through an atomic transaction process. This synchronization may be triggered through various mechanisms, including but not limited to: periodic automated synchronization events occurring at configurable intervals, manual synchronization triggers initiated by user action, event-driven synchronization triggered by specific types of record modifications, or real-time updates transmitted via persistent network connections. The synchronization process may be bidirectional, enabling changes made through any client device to propagate to other client devices via the server storage, subject to configurable permissions and access controls.

A cryptographic hash-based verification system may be implemented to efficiently detect modifications between client and server contact records while minimizing data transmission requirements. In at least one embodiment, each contact record may have associated with it a unique hash value generated from a standardized representation of the record's contents using a cryptographic hash function. The system may generate and maintain an aggregate hash value derived from the combination of all contact record hashes associated with a user account, which aggregate hash is stored against each user object. This approach enables rapid determination of whether any contact information has been modified without requiring transmission or comparison of complete record data.

The verification system may utilize the contact record hashes to implement an optimistic concurrency control mechanism for server updates similar to those employed in distributed version control systems. In some embodiments, a client may only be permitted to push updates to the server if it has first successfully pulled and incorporated the latest server state, thereby preventing race conditions when multiple devices attempt simultaneous modifications. To enforce this synchronization requirement, the server may withhold the aggregate hash value in its initial responses, requiring clients to independently calculate this value based on the full set of contact records, thus ensuring proper state synchronization before updates are permitted.

Contact records within the system may comprise various data fields including, but not limited to: unique identifiers, personal identification information, communication details, physical and electronic address information, relationship metadata, synchronization timestamps, and modification history. In at least one embodiment, the system may maintain multiple versions or states of contact records through a journaling mechanism, enabling temporal tracking of modifications and facilitating conflict resolution through comparison of record states at different points in time.

The synchronization protocol may incorporate configurable conflict resolution mechanisms for handling cases where contact records have been modified on multiple devices between synchronization events. These mechanisms may employ various strategies including, but not limited to: timestamp-based resolution giving precedence to the most recent modification, priority-based resolution favoring specific devices or users, field-level merging of non-conflicting changes, or manual user intervention through an interactive conflict resolution interface. The specific conflict resolution strategy may be selected based on the type of data being synchronized, the nature of the conflict, and system configuration parameters.

Comprehensive security measures may be implemented to protect the integrity and confidentiality of contact data during synchronization operations. These measures may include, but are not limited to: end-to-end encryption of data in transit, access control mechanisms operating at both record and field levels, cryptographic signing of synchronization messages, and detailed audit logging of all synchronization events. In some embodiments, the system may implement different security policies for different categories of contact data or different types of synchronization operations, with policy enforcement occurring at both client and server levels.

### Cross-Device Profile Synchronization Protocol

Various embodiments of the present invention may provide systems and methods for maintaining synchronized profile and contact information across multiple devices. The synchronization may be accomplished through one or more server systems that coordinate state between devices, enabling consistent data access regardless of which device a user may employ to access their profile or contact information at any given time.

In accordance with at least one embodiment, each contact record within the system may be assigned a universally unique identifier (UUID) at the time of its creation. This UUID may persist throughout the lifecycle of the contact record across all devices and servers. The UUID generation process may incorporate various inputs that may include, but are not limited to: timestamp information, random or pseudo-random values, device-specific identifiers, user-specific identifiers, or combinations thereof. The specific UUID generation algorithm may be selected based on system requirements for UUID collision resistance and deterministic generation capabilities.

The system may maintain an aggregate hash value, referred to herein as a “contacts hash,” that represents the collective state of all contact records associated with a particular user account. This contacts hash may be computed through a multi-step process whereby individual contact record hashes are first calculated, then combined in a deterministic manner. In at least one embodiment, the contacts hash may be generated by: (1) computing a cryptographic hash of each contact record's content, (2) ordering these individual hashes according to their corresponding UUIDs, (3) concatenating the ordered hash values, and (4) computing a final cryptographic hash of the concatenated value. The specific cryptographic hash function utilized may be selected from various available algorithms including, but not limited to: SHA-256, SHA-3, BLAKE2, or other suitable hash functions.

When a synchronization operation is initiated, the system may first perform a preliminary comparison of contacts hash values between the client device and server. This comparison may serve as an optimization mechanism, potentially eliminating unnecessary data transfer when the client and server states are already synchronized. If the contacts hash values match exactly, the system may determine that no further synchronization steps are required for that particular synchronization operation.

In the event that a contacts hash mismatch is detected, the system may proceed with a detailed synchronization process. The client device may transmit to the server a manifest containing, for each contact record: (1) the record's UUID, (2) a hash of the record's current content, and (3) optionally, a timestamp of the record's last modification. The server may process this manifest by comparing it against its own record state to identify specific records requiring synchronization. This comparison may result in identification of: (a) records modified on the client but not the server, (b) records modified on the server but not the client, (c) records deleted from either the client or server, and (d) records with conflicting modifications on both sides.

For each record requiring synchronization, the system may execute one or more synchronization actions based on the specific state discrepancy identified. These actions may include, but are not limited to: (1) uploading modified records from client to server, (2) downloading modified records from server to client, (3) marking records as deleted, or (4) initiating conflict resolution procedures. The selection and ordering of these actions may be determined by configurable synchronization policies that may take into account factors such as timestamp ordering, device priority settings, and user preferences.

The system may implement a deletion tracking mechanism whereby deletion records are maintained for a configurable retention period after a contact record is removed. Each deletion record may comprise: (1) the UUID of the deleted contact, (2) a timestamp of the deletion operation, (3) an identifier of the device that initiated the deletion, and (4) optionally, a reason code or user-provided deletion justification. These deletion records may serve multiple purposes, including: (a) proper handling of race conditions between deletion and modification operations, (b) enabling deletion recovery within the retention period, and (c) maintaining audit trails of deletion operations.

In at least one embodiment, the synchronization protocol may support paginated synchronization operations whereby contact records are processed in bounded sets. This capability may be implemented through a pagination mechanism that accepts parameters including, but not limited to: (1) a starting index or cursor, (2) a maximum number of records to process, and (3) optional filtering criteria. The client may execute multiple synchronization operations with different pagination parameters until all relevant records have been processed. This approach may provide benefits including: (a) reduced memory utilization, (b) improved responsiveness, and (c) more granular error recovery capabilities.

The system may incorporate sophisticated conflict resolution mechanisms to handle scenarios where the same contact record is modified on multiple devices within a given synchronization interval. The conflict resolution process may involve multiple stages, potentially including: (1) conflict detection based on modification timestamps and record hashes, (2) automatic resolution according to configurable policies, and (3) optional user intervention for manual resolution. Resolution policies may incorporate various strategies including, but not limited to: (a) latest modification wins, (b) server state wins, (c) client state wins, (d) merging of non-conflicting field modifications, (e) preservation of multiple record versions, or (f) requiring explicit user selection of the winning version.

Various security measures may be implemented to ensure the integrity and confidentiality of the synchronization process. These measures may include: (1) cryptographic signing of all synchronization messages using device-specific keys, (2) authentication tokens with configurable expiration periods, (3) access control lists specifying synchronization permissions at both device and record levels, (4) optional end-to-end encryption of contact record content, and (5) audit logging of all synchronization operations. The specific security measures activated for any given deployment may be selected based on the deployment's security requirements and performance constraints.

### Cross-Device Profile Synchronization Contact Storage Architecture

In accordance with various embodiments of the present invention, a system and method may be provided for synchronizing contact records across multiple computing devices while maintaining data consistency and integrity. The system may comprise, among other components, at least one client-side storage system and at least one server-side storage system, wherein additional storage systems, processing components, and communication interfaces may be incorporated without departing from the scope of the present invention.

In at least one embodiment, a client storage system may serve as a local source of contact record information, wherein the client storage system may maintain the most current version of contact records as modified by a user of a particular device. The client storage system may comprise one or more local databases, file systems, caching mechanisms, or other storage mechanisms suitable for maintaining contact record information on a client device. In some embodiments, the client storage system may implement a local versioning system to track modifications to contact records.

A server storage system may function as a global source of contact record information in various embodiments, wherein the server storage system may maintain a synchronized version of contact records across multiple client devices associated with a user account. The server storage may comprise one or more centralized databases, distributed storage systems, cloud storage platforms, redundant storage arrays, or other suitable storage mechanisms for maintaining global contact records. The server storage system may, in some embodiments, implement sharding, replication, or other distributed storage techniques to enhance performance and reliability.

In accordance with at least one embodiment, changes made to contact records in the client storage system may be automatically propagated to the server storage system through one or more synchronization processes to maintain consistency across devices. These synchronization processes may be triggered through various mechanisms, including but not limited to: periodic execution according to configurable intervals, on-demand execution in response to user actions, event-driven execution responding to detected changes in the client storage system, or bandwidth-aware execution that adapts to network conditions.

A hash-based verification system may be implemented in various embodiments to efficiently detect changes between client and server contact records while minimizing data transfer requirements. The system may generate and compare cryptographic hash values of contact records to identify modifications without necessarily comparing entire record contents. In at least one embodiment, each contact record may have an associated hash value generated using one or more cryptographic hash functions selected from a group including, but not limited to: SHA-256, SHA-3, BLAKE2, or other suitable hash algorithms.

The hash-based verification system may, in some embodiments, maintain a Merkle tree or similar data structure of contact record hashes associated with a user account. This hierarchical hash structure may enable rapid determination of whether any contact records have been modified by comparing root hash values rather than comparing individual record hashes. The structure may be dynamically updated whenever contact records are modified, added, or deleted, with only affected branches requiring recalculation.

In accordance with various embodiments, the synchronization process may utilize the hash-based verification system to identify records requiring synchronization through an efficient differential synchronization protocol. The process may compare client and server hash values to detect modified records, retrieve full record data only for modified records, and update the server storage system accordingly. This selective synchronization approach may reduce bandwidth consumption and processing overhead compared to full record comparison approaches.

The system may implement configurable conflict resolution procedures in various embodiments when concurrent modifications occur across multiple devices. These procedures may utilize combinations of timestamp data, device priority settings, modification sequence numbers, or other suitable mechanisms to determine which version of a contact record should be preserved. In some embodiments, the system may maintain a versioned history of changes to enable selective rollback of modifications if needed.

Various security measures may be implemented to protect contact record data during synchronization operations. These measures may include, but are not limited to: end-to-end encryption of data in transit, mutual authentication requirements for synchronization requests, access controls restricting synchronization to authorized devices associated with the user account, rate limiting of synchronization operations, and audit logging of synchronization activities.

### Cross-Device Profile Synchronization Conflict Resolution

In various embodiments, a profile synchronization system may implement one or more conflict resolution mechanisms within a distributed data environment. A synchronization management subsystem may be configured to maintain profile consistency across a plurality of client devices while accommodating modification collisions, race conditions, and other data synchronization challenges that may emerge during operation of a distributed system. The synchronization management subsystem may comprise one or more software modules executing on one or more computing devices.

The system may, in at least one embodiment, associate each profile record or contact entry with a persistent unique identifier (UUID) that remains constant throughout the lifecycle of that record. A hash value may be computed for each record based on its content, with the system being configured to perform hash comparisons in parallel with UUID verification during synchronization operations. When the system identifies records sharing identical UUIDs but divergent hash values, such records may be flagged as modifications of a common source record rather than independent entries, enabling the system to differentiate between record modifications and new record creation events.

In various implementations, the synchronization management subsystem may incorporate device tracking functionality that enables precise identification of modification sources at a device-specific level. This tracking capability may be implemented through the assignment of unique device identifiers that are cryptographically incorporated into modification records. Device identifiers may be derived from one or more sources including, but not limited to, hardware-specific identifiers, cryptographically secure random values, device-specific key pairs, or any combination thereof. The device tracking subsystem may maintain a registry of known devices and their associated identifiers.

Temporal tracking of modifications may be implemented through a timestamp management subsystem that maintains precise chronological records of all data alterations. Each record may incorporate multiple timestamp fields that track various temporal aspects of the record's lifecycle, including but not limited to creation time, last modification time, last synchronization time, and deletion time if applicable. The timestamp management subsystem may utilize these temporal markers to establish modification precedence when resolving conflicts according to configurable resolution policies.

The synchronization management subsystem may be configured to maintain synchronization integrity even in scenarios involving external data modifications or deletions. A server-side hash registry may maintain cryptographic hashes of record states, enabling the system to detect and reconcile modifications that occur outside the primary synchronization channels. Upon detection of external modifications, the system may initiate appropriate reconciliation procedures selected from a configurable set of conflict resolution strategies.

Multiple conflict resolution strategies may be implemented and selected based on configurable system policies. These strategies may include, but are not limited to: timestamp-based resolution where most recent modifications take precedence; device-priority systems where designated devices have modification precedence; consensus-based systems where multiple devices coordinate to agree on changes; and hybrid approaches that combine multiple resolution strategies. The selection of resolution strategies may be dynamically adjusted based on factors including transaction type, data sensitivity, network conditions, and user preferences.

A comprehensive modification audit subsystem may maintain detailed records of all synchronization operations and data modifications. These audit records may comprise modification metadata including but not limited to: modification type, originating device information, timestamp data, pre-modification state, post-modification state, and cryptographic proof of modification authenticity. The audit subsystem may support detailed analysis of synchronization events and facilitate recovery operations when necessary.

The synchronization management subsystem may implement a priority-based operation queuing system to manage concurrent synchronization requests from multiple devices. The queuing system may order synchronization operations according to configurable prioritization rules that may incorporate multiple factors including but not limited to: device type, connection quality, operation type, data sensitivity, user preferences, and system load conditions. The queuing system may dynamically adjust priorities based on changing system conditions and policy requirements.

In various embodiments, the system may implement conflict prevention mechanisms that operate in parallel with conflict resolution systems. These prevention mechanisms may include optimistic locking schemes, device coordination protocols, and predictive conflict detection algorithms that identify and mitigate potential conflicts before they occur. The prevention subsystem may work in conjunction with the resolution subsystem to minimize the occurrence and impact of synchronization conflicts.

### Cross-Device Profile Synchronization Web Services

In accordance with one or more embodiments of the present invention, a system and method may be provided for synchronizing profile and contact information across multiple computing devices. The system may comprise one or more server computing devices implementing synchronization endpoints that facilitate bi-directional data exchange with one or more client computing devices, ensuring data consistency while handling potential conflicts that may arise from concurrent modifications. The synchronization endpoints may communicate with client devices via any suitable network protocol including, but not limited to, HTTPS, WebSocket, or other secure communication channels.

In at least one embodiment, a primary synchronization endpoint may comprise a contact list retrieval function that accepts a synchronization request object as input. The synchronization request object may include, but is not limited to, one or more of: a list of client-side contact identifiers, a list of contact hashes, pagination parameters, filtering criteria, and a client-side timestamp indicating when the last synchronization was performed. The function may return a response object containing at least two distinct collections: a first collection comprising one or more contact objects that are present in the server's data store but absent from the client's local storage, and a second collection comprising one or more contact identifiers or hashes that are present in the client's submitted list but absent from the server's data store. This bi-directional comparison enables efficient detection of additions, modifications, and deletions on both client and server sides.

The contact list retrieval function may implement pagination capabilities to efficiently handle large datasets while minimizing network bandwidth consumption and memory utilization. In at least one embodiment, the function may accept pagination parameters including, but not limited to: a starting page identifier, an ending page identifier, a limit value specifying the maximum number of records to return per page, and an optional sorting criteria. A continuation token or similar mechanism may be included in the response to facilitate stateless pagination. Additionally, a Boolean flag or similar indicator may be included to signify whether additional records exist beyond the current result set, enabling clients to implement efficient incremental synchronization strategies without requiring knowledge of the total record count.

In accordance with one or more embodiments, a contact update function may be provided to handle modifications to contact records. This function may accept a contact update request object containing one or more contact objects, with each object potentially comprising: a unique identifier, contact details, metadata including modification timestamps and version information, and an optional operation type indicator (e.g., create, update, delete). The function may process both individual updates and batch modifications, allowing for efficient synchronization of multiple records in a single atomic operation while maintaining consistency guarantees.

The contact update function may implement sophisticated logic to determine the appropriate action for each contact object in the update request. In at least one embodiment, if a contact identifier is not found in the server's data store, the function may validate the provided information and create a new record. If a matching identifier is found, the function may implement a merge strategy that considers field-level modifications, preserving unchanged data while updating modified fields. The function may optionally support partial updates, allowing clients to transmit only modified fields rather than complete contact objects, thereby reducing network overhead.

The system may incorporate comprehensive conflict resolution mechanisms to handle concurrent modifications that may occur in a distributed environment. In at least one embodiment, these mechanisms may include, but are not limited to: timestamp-based resolution, version vectors, operational transformation, or other suitable approaches for determining the precedence of conflicting changes. The conflict resolution strategy may be configurable, allowing different resolution policies to be applied based on the nature of the data or specific application requirements. The contact update function may also support soft deletion of records, maintaining a deletion timestamp and preserving the record data for a configurable retention period, thereby enabling recovery of accidentally removed contacts and maintaining a complete historical audit trail of modifications.

In at least one embodiment, both the retrieval and update functions may implement rate limiting, request validation, and security measures to prevent abuse and ensure data integrity. These measures may include, but are not limited to: authentication token validation, request signing, payload encryption, and throttling based on client identifier or other criteria. The system may also provide mechanisms for bulk operations, allowing clients to efficiently synchronize large numbers of contacts while respecting server-side resource constraints and maintaining system stability.

### Cross-Device Profile Synchronization Race Condition Protection

According to various embodiments of the present invention, a synchronization system may be provided for maintaining consistent profile and contact information across a plurality of devices. The system may comprise, among other components, one or more server computing devices configured to track and manage profile state, and one or more client computing devices configured to maintain local copies of profile data, wherein the server computing devices and client computing devices communicate via one or more computer networks.

In at least one embodiment, the server computing devices may maintain a hierarchical hash verification system comprising at least two levels of cryptographic hashes. A first level may comprise individual hashes computed for each contact or profile record stored in the system. A second level may comprise an aggregate hash value derived from a combination of the first-level hashes. The aggregate hash value may be computed using any suitable cryptographic hash function, including but not limited to SHA-256, SHA-3, BLAKE2, or other existing or future hash algorithms. The specific hash function utilized may be configurable and may be selected based on security requirements, performance characteristics, or other criteria.

The system may implement, in some embodiments, a push-verification protocol wherein client devices verify synchronization state before being permitted to transmit updates. Prior to accepting profile updates from a client device, the server computing devices may require the client device to demonstrate that it has retrieved and incorporated all pending updates. This verification may be accomplished by requiring the client device to transmit its locally-computed aggregate hash value as part of any update request. The server computing devices may compare this client-provided hash against their own aggregate hash to confirm synchronization. Non-matching hashes may result in the update request being rejected, with the client device being required to retrieve and process pending updates before retrying.

According to certain embodiments, the server computing devices may be configured to selectively withhold aggregate hash values from responses to certain API calls, thereby requiring client devices to independently compute aggregate hashes. This computation requirement provides an additional verification layer by confirming that client devices maintain accurate copies of individual contact records and can properly reconstruct the aggregate state. The specific APIs from which aggregate hashes are withheld may be configurable and may vary based on security requirements or other factors.

The system may maintain, in various embodiments, detailed synchronization state information including timestamps, version numbers, and update sequences for each record. This state information may be used to detect and resolve conflicts between concurrent updates from different devices. When conflicts are detected, the system may implement one or more conflict resolution strategies, which may include, but are not limited to: preserving all concurrent versions and marking records for manual resolution, applying automatic resolution rules based on configurable policies, or selecting a winning version based on timestamps or device priority.

In at least one embodiment, the system may implement a time-windowed retry mechanism for failed synchronization attempts. This mechanism may comprise an exponential backoff algorithm with configurable initial delay and maximum retry count parameters. The retry mechanism may be integrated with a notification system that can alert users and/or system administrators of persistent synchronization failures. Different retry policies may be applied based on the nature of the synchronization failure, the affected data types, or other criteria.

According to some embodiments, the synchronization protocol may support partial or filtered synchronization operations. Client devices may be permitted to synchronize specific subsets of records based on configured filters, search criteria, or other selection mechanisms. When partial synchronization is employed, the hierarchical hash verification system may be scoped to the relevant subset of records while maintaining consistency guarantees for the synchronized portion. The server computing devices may maintain separate aggregate hashes for different record subsets to facilitate partial synchronization verification.

The system may implement, in various embodiments, a versioning mechanism that maintains historical records of profile data changes. This version history may be used to support rollback operations, audit trails, or recovery from synchronization failures. The depth of version history maintained may be configurable and may vary based on record type, storage constraints, or other factors. Version records may include, but are not limited to: timestamps, device identifiers, user identifiers, and complete or differential copies of changed data.

### Cross-Device Profile Synchronization Security Considerations

In various embodiments, a cross-device profile synchronization system may be configured to implement one or more security protocols for maintaining profile consistency across a plurality of authenticated devices. The system may comprise a secure authentication module that maintains separate cryptographic keys for device authentication and profile data encryption. Device authentication keys may be generated using a deterministic key derivation function that accepts, as inputs, device-specific hardware identifiers, user authentication credentials, and a master key maintained by a trusted platform module.

According to certain embodiments, before permitting a new device to be added to a user's profile, the authentication module may enforce a multi-stage verification protocol comprising: (a) generation and validation of an ephemeral device keypair used to establish a secure communication channel, (b) verification of a time-based one-time password transmitted via an out-of-band communication channel to a previously verified user contact point, (c) validation of biometric data captured by the new device against previously stored biometric templates, and (d) cryptographic attestation of the device's security capabilities, which may include secure element presence, biometric sensor specifications, and operating system security level.

In various embodiments, the system may maintain an immutable audit log of device-related events using a cryptographically-linked data structure. Each log entry may comprise a cryptographic hash of the previous entry, ensuring that the event history cannot be modified without detection. Log entries may include, but are not limited to: device identifiers, event timestamps, geographic coordinates, network identifiers, hardware attestation data, authentication proof records, and digital signatures from all participating devices. The log structure may be replicated across multiple authenticated devices to prevent tampering.

According to some implementations, the system may implement a challenge-response protocol for sensitive profile operations that require participation from multiple previously authenticated devices. The challenge protocol may comprise: (a) generation of a cryptographic challenge by the initiating device, (b) broadcast of the challenge to all authenticated devices, (c) collection of signed responses from a configurable quorum of devices, and (d) verification of the collected signatures against stored device public keys. The challenge may include a nonce to prevent replay attacks and a time limit for response collection.

Some embodiments may implement a secure notification system utilizing a publish-subscribe architecture with end-to-end encryption. Each notification message may comprise: (a) an encrypted payload containing details of the profile modification event, (b) a set of cryptographic signatures from participating devices, (c) a message authentication code derived from the encrypted payload and device keys, and (d) metadata including message timestamps and sequence numbers. The notification system may implement automatic retransmission and acknowledgment protocols to ensure reliable delivery.

Various implementations may enforce adaptive security timeouts using a risk scoring algorithm that considers multiple factors including: (a) historical device usage patterns, (b) geographic movement velocity between authentication attempts, (c) time intervals between profile operations, (d) device hardware characteristics, and (e) network connection properties. The risk score may be used to dynamically adjust timeout durations and authentication requirements. The scoring algorithm may be updated based on observed attack patterns and security incidents.

According to certain embodiments, the system may implement a weighted quorum protocol that assigns different trust levels to devices based on factors including, but not limited to: device age, usage frequency, hardware security capabilities, and historical risk scores. The quorum requirement for a given operation may be expressed as a minimum sum of device weights rather than a simple device count. Device weights may be automatically adjusted based on observed behavior patterns and explicit user trust assignments.

Some implementations may include an anomaly detection system utilizing multiple machine learning models trained on device interaction patterns. The models may analyze features including: temporal patterns of device activities, geographic distribution of authentication attempts, concurrent device usage signatures, and profile operation sequences. The system may maintain separate models for different classes of anomalies and may implement an ensemble approach for final classification decisions. Upon detecting suspicious patterns, the system may automatically escalate security requirements and initiate additional verification procedures.

### URL Shortener Security Protocol

In accordance with various embodiments of the present invention, a URL shortening protocol enhances the security of user authentication and session establishment while mitigating the risk of phishing attacks and account compromise. The protocol may include, but is not limited to, a web browser interface presenting a QR code containing a URL, one or more WebSocket connections between the web browser and server, and a mobile application or other client device configured to scan and process the QR code. The URL encoded within the QR code may contain multiple data elements, including but not limited to: an application identifier indicating a preferred mobile application for processing the QR code, a reference to a login endpoint on the server, a session identifier, an IP address corresponding to the device that requested the QR code, geolocation data associated with the requesting device, an expiration timestamp, and one or more preference indicators specifying the type and scope of personal information to be shared during authentication.

The URL shortening protocol described herein provides various advantages over conventional authentication systems. By incorporating multiple security factors including device location verification, expiration timing, and request origin validation, the protocol significantly reduces the possibility of successful man-in-the-middle and phishing attacks. The protocol may also enhance user experience by providing visual indicators comparing the displayed URL with the expected URL format, optionally including device-specific browser chrome representations to assist users in validating legitimate authentication requests. Furthermore, the protocol's modular design allows for flexible implementation of additional security measures, such as velocity limits on QR code generation requests from individual IP addresses, mandatory location services verification, and configurable information sharing preferences that can be tailored to specific deployment requirements while maintaining a consistent and intuitive user experience across different implementations of the system.

### URL Shortener QR Code/URL Content

In accordance with at least one embodiment of the present invention, a URL shortener security protocol may incorporate various security elements and parameters within generated URLs and QR codes to facilitate secure authentication processes while mitigating risks of malicious attacks, spoofing attempts, and man-in-the-middle exploits. The protocol may define specific data fields and validation procedures that work in combination to establish authenticity and maintain security throughout the authentication process.

In at least one embodiment, the generated URL or QR code may contain an application origin identifier that uniquely associates the authentication request with a specific application, system, or entity. This origin identifier may serve multiple purposes: enabling recipient systems to identify and launch the appropriate mobile application for handling the request; facilitating automated application downloads when the required application is not present on a user's device; and providing a mechanism for verifying that the authentication request originated from an authorized source. The origin identifier may be formatted according to one or more standardized schemas that may be extended to accommodate various identification requirements across different platforms and implementations.

The protocol may further specify the inclusion of one or more login API endpoint references within the URL or QR code. These endpoint references may be encoded either as complete URLs incorporating all necessary routing information, or as relative paths that can be constructed using additional contextual information contained within the QR code or URL. In at least one embodiment, the protocol may support the specification of multiple API endpoints to provide redundancy and fallback options in scenarios where the primary endpoint becomes unavailable or unreachable. The structure and format of these endpoint references may be configured according to the specific requirements of the implementing system, potentially including additional routing or load balancing parameters.

Personal information sharing preferences may be encoded within the URL or QR code to indicate the scope and type of personal information that the requesting system seeks to obtain during the registration or login process. These preferences may define various levels of information sharing, potentially including but not limited to: “login only/pseudonymous” where minimal personal information is shared; “email only” where only email verification is required; or “email, address and phone” where complete contact information is requested. These preference levels may be represented using standardized codes or identifiers that can be efficiently encoded while maintaining clarity and unambiguous interpretation when decoded by receiving systems.

To prevent replay attacks and ensure the timeliness of authentication requests, the URL or QR code may incorporate an expiration timestamp specified in Coordinated Universal Time (UTC). This timestamp may define the precise moment after which the authentication request should be considered invalid and rejected by receiving systems. The duration of validity may be configured according to specific security requirements and may vary between different implementations, use cases, or risk levels. The timestamp encoding may follow standardized formats that ensure consistent interpretation across different time zones, calendar systems, and computing platforms.

The protocol may specify the inclusion of the originating IP address-specifically, the IP address of the system that initially requested the generation of the authentication URL or QR code. This IP address information serves as an additional verification factor, enabling receiving systems to validate that the authentication request originated from an expected and authorized source. The protocol may support both IPv4 and IPv6 address formats, ensuring compatibility with various network configurations and addressing schemes. Additional network addressing information may also be included to support various routing or verification requirements.

Geographical location data may be incorporated within the URL or QR code, comprising both political jurisdiction information (such as country, region, city, or other administrative boundaries) and precise geographical coordinates expressed as latitude and longitude values. This location data may be derived from GeoIP database queries associated with the requesting IP address, potentially supplemented with additional location verification data. The inclusion of this geographical data enables receiving systems to perform location-based verification, potentially comparing the origination location of the authentication request with the current location of the device attempting to authenticate. This comparison may trigger additional security measures or elevated authentication requirements if the locations differ by more than a configured threshold.

The protocol may define specific encoding methods for combining and representing these various elements within the URL or QR code structure. These encoding methods may be selected to balance multiple competing requirements: maintaining comprehensive security information, adhering to practical limitations on URL length and complexity, ensuring compatibility with standard URL and QR code processing systems, and potentially accommodating future protocol extensions. The specific encoding methods used may vary between implementations while maintaining interoperability with standard URL and QR code parsing systems.

### URL Shortener Attack Prevention Measures

In accordance with various embodiments of the present invention, a secure URL shortening system and protocol may be implemented that incorporates multiple integrated security measures configured to prevent malicious attacks. The system may be configured to implement a multi-layered security approach that combines cryptographic verification, geographic validation, and various other security mechanisms to ensure the authenticity of login attempts and prevent man-in-the-middle attacks, session hijacking, phishing attempts, and other potential security breaches.

In at least one embodiment, the system may implement a QR code verification protocol whereby a cryptographic hash of each generated QR code's contents is recorded within a secure database, associated with a temporarily valid session identifier. A mobile device scanning such a QR code may be required to extract this contents, generate an identical cryptographic hash using a standardized hashing algorithm, and include this generated hash value within its signed authentication request transmitted back to the server. The server may be configured to validate that the hash value included within the authentication request exactly matches the hash value previously recorded when the QR code was originally generated. This verification step ensures that the QR code being used for authentication is identical to the QR code that was generated by the server, has not been substituted or modified, and has not expired. In at least one embodiment, the hash value may be generated using a cryptographically secure hashing algorithm such as SHA-256, SHA-3, or other suitable algorithms.

The system may implement, in accordance with at least one embodiment, an enhanced domain verification protocol that incorporates multiple verification steps to confirm the authenticity of the login attempt. When a user scans a QR code, the mobile application may be configured to extract and prominently display the domain name encoded within the QR code, along with clear instructions directing the user to verify that this domain matches the domain shown in their web browser's address bar. The system may be configured to generate and display a device-specific visual representation of how the browser's address bar should appear on the user's particular device and browser combination. This visual representation may include browser-specific chrome, SSL certificate indicators, and other visual elements that would be difficult for an attacker to accurately spoof. In at least one embodiment, the system may maintain a database of browser chrome appearances for different device and browser combinations, allowing it to generate highly accurate visual representations.

A location verification subsystem may be implemented in at least one embodiment, incorporating multiple geographic validation mechanisms. The QR code may include encrypted location metadata comprising the IP address of the system that requested it, along with comprehensive geolocation data for that IP address including political location (country, region, city) and precise latitude-longitude coordinates. A mobile device attempting authentication may utilize its location services capabilities to determine its current location with high precision. The system may be configured to calculate the geographic distance between these two locations and may implement graduated security responses based on the calculated distance. These responses may range from displaying informational notices for small discrepancies to presenting prominent warning messages for larger discrepancies, up to blocking the authentication attempt entirely if the geographic disparity exceeds configured thresholds. In some embodiments, the system may display an interactive map showing both locations, along with the calculated distance between them, to help users make informed decisions about whether to proceed with authentication.

To prevent automated attacks and broad-spectrum phishing attempts, the system may implement, in at least one embodiment, a sophisticated rate-limiting mechanism incorporating multiple validation criteria. The server may be configured to track and analyze patterns of QR code requests from individual IP addresses across various time windows ranging from seconds to days. The system may implement graduated response thresholds that become progressively more restrictive as request volumes increase. When a velocity threshold is exceeded, the server may be configured to temporarily suspend the ability of that IP address to request new QR codes, with the suspension duration increasing exponentially with repeated violations. In at least one embodiment, the system may also track and limit the total number of pending authentication attempts across all IP addresses to prevent distributed attacks.

The system may implement, in accordance with at least one embodiment, comprehensive Cross-Origin Resource Sharing (CORS) protections and frame-ancestry restrictions to prevent various forms of content embedding attacks. The server may be configured to implement strict CORS policies that reject requests for QR code resources originating from unauthorized domains. Additionally, the server may implement Content-Security-Policy headers that prevent QR code content from being loaded into iframes or other embedded contexts. The server may be configured to verify the origin header of WebSocket connections to ensure they originate from legitimate web pages generated by the server itself, and may implement additional validation of WebSocket messages to prevent replay attacks.

In at least one embodiment, the system may implement a comprehensive session security protocol incorporating multiple session identifier rotation mechanisms. The session identifier initially included in the QR code may be configured for single use and limited duration, used only to track the pending authentication attempt. Upon successful authentication, the system may be configured to generate a new cryptographically secure session identifier with high entropy. This new session identifier may be transmitted to the client browser via the authenticated WebSocket connection, with the original session identifier being immediately invalidated. The system may be configured to maintain an audit trail of session identifier rotations to detect potential session fixation attempts. In some embodiments, the system may implement additional session security measures such as binding session identifiers to specific IP addresses or device fingerprints.

### URL Shortener Key Protections

In accordance with at least one embodiment of the present invention, a secure URL shortening system and protocol may be implemented that incorporates multiple layers of security measures designed to prevent unauthorized access and potential attacks. The system may comprise a web server configured to generate shortened URLs, a WebSocket server for managing real-time communications, one or more security validation components, and various security monitoring subsystems that work in concert to provide comprehensive protection against different classes of attacks.

With respect to WebSocket security, the system may implement a rigorous origin verification protocol. Specifically, the WebSocket server may be configured to perform a multi-step validation of incoming connection requests, beginning with inspection of the origin header that contains the hostname of the server that served the HTML and JavaScript code initiating the WebSocket connection. This origin header, which cannot be modified programmatically by client-side code due to browser security restrictions, may be compared against a configurable whitelist of authorized domains. The WebSocket server may be configured to immediately terminate any connection attempt from non-whitelisted origins, thereby preventing cross-site WebSocket hijacking attacks. Additionally, the WebSocket server may implement a challenge-response mechanism requiring the client to demonstrate possession of certain session-specific cryptographic tokens before establishing a persistent connection.

The system may further implement a comprehensive set of iframe protection mechanisms that work in concert to prevent clickjacking and other iframe-based attacks. Such protection may include, but not be limited to, multiple complementary security headers configured on the web server. In at least one implementation, the system may be configured to send an X-Frame-Options header with a value of “SAMEORIGIN”, while simultaneously implementing Content Security Policy (CSP) directives including frame-ancestors restrictions. This dual-header approach provides robust protection even in browsers that may not fully support one or the other header. The CSP configuration may be dynamically generated to include only specifically authorized parent domains, with such authorization potentially being managed through a separate administrative interface. The system may also implement JavaScript-based frame busting code as an additional defense-in-depth measure against sophisticated clickjacking attempts.

The session management subsystem may implement a secure session lifecycle that maintains strict separation between different authentication phases. Upon initial QR code generation, the system may create a temporary session identified by a cryptographically secure random identifier of sufficient length to prevent guessing attacks. This temporary session may be strictly time-limited and may contain only the minimal information required for the QR code display phase. Upon successful authentication via the mobile device, the system may generate an entirely new session with a different identifier, different encryption key, and expanded session data appropriate for an authenticated user. The original QR code session may be immediately invalidated upon successful authentication or upon timeout, whichever occurs first. This separation helps prevent various session-based attacks including session fixation, session hijacking, and replay attacks.

To prevent automated abuse, the system may implement a sophisticated rate limiting subsystem that considers multiple factors beyond simple request counting. In at least one embodiment, the rate limiting logic may maintain sliding windows of various durations (e.g., per-minute, per-hour, and per-day) for each client identifier, where such identifier may be derived from combinations of IP address, browser fingerprint, and other request characteristics. The rate limiting thresholds may be dynamically adjusted based on observed traffic patterns and threat intelligence. When a client exceeds configured thresholds, the system may implement a graduated response that begins with temporary request delays, progresses to requiring additional verification, and ultimately may result in complete blocking of the offending client identifier. The duration and severity of such restrictions may increase exponentially with repeated violations.

In various embodiments, the system may include a machine learning subsystem trained to detect patterns indicative of automated attacks or abuse attempts. This subsystem may analyze various request characteristics including, but not limited to, timing patterns, geographic distribution, browser fingerprints, and historical usage data. When suspicious patterns are detected, the system may dynamically inject additional verification requirements such as CAPTCHA challenges, device fingerprinting checks, or proof-of-work requirements. The specific nature and difficulty of these challenges may be automatically adjusted based on risk scores computed from the observed behavior patterns and threat intelligence data.

### URL Shortener User Interface Requirements

In accordance with at least one embodiment of the present invention, the system may implement a security-focused user interface for URL shortener authentication that incorporates multiple verification mechanisms and user guidance features. The interface may present a comprehensive authentication display wherein users are guided through a multi-step domain verification process. This process may include explicit instructions prompting users to verify the authenticity of the shortened URL by comparing the domain name displayed in their web browser's address bar with the domain name encoded within a machine-readable optical label, such as a quick-response (QR) code or similar encoding. To facilitate this comparison, the interface may generate and display a visual representation of the expected browser address bar appearance, which representation may be dynamically customized according to the specific browser application and operating system configuration detected on the user's device.

The system may further implement, in at least one embodiment, a location-aware security verification interface incorporating various geolocation visualization components. A dynamic map interface may be rendered to display the geographic origin point of the URL shortening request, which point may be determined based on the Internet Protocol (IP) address associated with the shortening request, or through other location determination methods. This map display may be configured to simultaneously present multiple geographic data points, potentially including, but not limited to: the origination location of the URL shortening request, the current location of the user's device as determined through various positioning technologies such as Global Positioning System (GPS) coordinates or cellular network triangulation, and optionally, the known geographic locations of legitimate service endpoints associated with the domain.

In various embodiments, the interface may implement an intelligent warning system comprising multiple categories of security alerts with corresponding display mechanisms. These warning interfaces may be triggered by various security conditions including, but not limited to: geographic distance exceeding configurable thresholds between the URL request origin and the user's current location, mismatches between expected and actual domain names, detection of potential spoofing attempts, or determination that the URL request originated from a previously flagged or suspicious IP address range. The warning displays may incorporate various visual elements such as color-coded indicators, warning iconography, modal dialog interfaces, or full-screen warning overlays, with the specific display mechanism potentially being selected based on the severity of the detected security condition.

The system may implement, in accordance with at least one embodiment, a progressive location services integration framework within the user interface. This framework may begin with a pre-authorization interface that educates users about the security benefits of enabling location services, potentially including specific examples of attack scenarios that location verification can help prevent. The interface may be configured to adjust its security verification requirements and warning display thresholds based on the level of location access granted by the user. When full location access is enabled, the interface may suppress certain warning displays for operations that pass geographic verification checks, while defaulting to a more conservative security posture with enhanced warnings when location services are disabled or when location verification cannot be completed.

In at least one embodiment, the interface may incorporate a comprehensive timing and validity verification system with corresponding visual indicators. This system may track multiple timing-related security parameters including, but not limited to: the remaining validity period of the shortened URL as determined by an encoded expiration timestamp, the time elapsed since the URL was generated, the duration of the current user session, and configurable timeout periods for various security-critical operations. These temporal security constraints may be represented through various interface elements such as animated countdown displays, segmented progress indicators, or textual representations of time remaining. The interface may be configured to proactively prevent access to expired URLs and may implement graceful degradation of functionality as various timing thresholds are approached or exceeded. URL Shortener Mobile-Specific Considerations

In accordance with at least one embodiment of the present invention, authentication mechanisms implemented for mobile devices may incorporate distinct processing paths based on the specific manner in which a shortened URL is accessed. When a mobile device user employs a camera to scan a Quick Response (QR) code, such scanning necessarily occurs using a first device while the QR code is displayed on a second device, thereby maintaining visibility of the original authentication interface throughout the authentication process. Conversely, when authentication is initiated through direct interaction with a Universal Resource Locator (URL) link on the mobile device itself, the mobile operating system may cause the displaying browser window to become occluded upon launching a corresponding mobile wallet application, potentially impeding certain security verification steps.

In at least one embodiment, the system may implement context-aware authentication flows that adapt based upon the method of initiation. The authentication system may determine whether initiation occurred via QR code scanning or URL interaction by examining one or more contextual parameters including, but not limited to: the presence of camera-sourced data, the temporal proximity of camera activation to authentication initiation, the presence of decp-linking parameters, and/or the correspondence between the requesting device's Internet Protocol (IP) address and the IP address that originally requested the shortened URL. When the system determines that authentication was initiated via direct URL interaction rather than QR code scanning, the system may modify its security verification flow to account for the possibility that the originating browser window is no longer visible to the user.

The authentication system may leverage mobile operating system deep linking capabilities to implement additional security verifications. When a mobile operating system initiates an application via deep link, the operating system may provide the application with origin domain information indicating the domain of the resource that initiated the deep link. In at least one embodiment, the authentication system may validate that this origin domain corresponds to an expected domain associated with the URL shortening service. The deep linking origin validation may be implemented as a primary security check or as a supplemental verification mechanism operating in parallel with other security measures. The system may be configured to require successful deep linking origin validation before permitting certain high-risk operations or before accepting certain authentication responses.

Various embodiments may implement specialized window and state management protocols to facilitate security verification on mobile devices. The authentication system may provide programmatic interfaces enabling temporary minimization or background placement of the mobile wallet application, allowing users to access and verify information displayed in the originating browser window. Additionally or alternatively, the system may implement a state preservation mechanism that captures and cryptographically signs relevant security parameters from the browser window before it becomes occluded, subsequently presenting these preserved parameters within a trusted interface provided by the mobile wallet application. The specific window and state management protocols implemented may be selected based upon one or more criteria including, but not limited to: the authentication initiation method employed, the mobile operating system type and version, device capability parameters, and configurable security requirements.

To mitigate potential security vulnerabilities specific to mobile web browser environments, various embodiments may implement additional security measures when processing authentication requests originating from mobile web browsers rather than from QR code scanning operations. The system may employ user-agent validation protocols that examine reported mobile browser characteristics against expected parameters to identify potential spoofing attempts. Additionally, the system may implement mobile-specific Cross-Origin Resource Sharing (CORS) policies and iframe security directives that prevent malicious websites from embedding or intercepting the authentication flow within a compromised mobile browser context. The system may also implement specialized HTTP security headers tailored to mobile browser security capabilities including, but not limited to, Content-Security-Policy directives optimized for mobile browser implementations.

### Proposition System

In various embodiments, a blockchain system may implement a proposition processing structure capable of managing multiple proposition types, including Boolean propositions evaluating to true or false outcomes and non-Boolean propositions accommodating arbitrary data values. The system may include configurable parameters governing proposition behavior and lifecycle, including decision mode indicators, reward distribution parameters, timing parameters, and access control parameters. Propositions within the system may be implemented as either attached propositions linked to specific accounts or detached propositions existing independently within the system, wherein each proposition may comprise statement components, optional reward components, and extensible data structures to accommodate additional information and configuration options.

The described system may provide benefits including flexible decision processing frameworks, configurable reward distribution mechanisms, and robust authentication filtering capabilities. The system may enable efficient management of proposition lifecycles while maintaining security through various validation mechanisms, potentially allowing for scalable deployment of complex decision-making processes within distributed networks. The implementation may support multiple reward types, extensible reward pools, and sophisticated cleanup procedures that may help ensure proper resource management and system stability.

### Proposition System Basic Structure

In various embodiments, the system may implement a proposition processing structure capable of managing multiple proposition types. The proposition types may include, but are not limited to, Boolean propositions evaluating to true or false outcomes, and non-Boolean propositions accommodating arbitrary data values, wherein said non-Boolean propositions may include, but are not limited to, numeric values, string values, structured data values, and combinations thereof.

Each proposition within the system may comprise a plurality of components, including at least one statement component defining the subject matter or query of the proposition. The statement component may be formatted according to a predefined syntax that supports both Boolean and non-Boolean expressions. In some embodiments, each proposition may optionally include one or more reward components, wherein said reward components may be configured to provide incentives to participating entities, and wherein said reward components may specify one or more types of rewards, quantities of rewards, and distribution parameters for said rewards.

According to at least one embodiment, the system may support multiple proposition association modes, including but not limited to: attached propositions and detached propositions. Attached propositions may be linked to one or more specific accounts within the system, wherein said accounts may include, but are not limited to, user accounts, smart contract accounts, token accounts, and special-purpose accounts. Detached propositions may exist independently within the system without direct account association, wherein said detached propositions may be uniquely identified through one or more identification mechanisms, including but not limited to, cryptographic hashes of proposition content, transaction identifiers, and system-generated identifiers.

In various embodiments, each proposition may include a configurable set of processing parameters that govern its behavior and lifecycle. These parameters may include, but are not limited to: one or more decision mode indicators specifying how decisions are collected, validated, and evaluated; one or more reward distribution parameters defining the timing, quantity, and allocation of rewards; one or more timing parameters governing the proposition lifecycle; and one or more access control parameters specifying participation requirements. The decision mode indicators may support multiple evaluation methodologies, including but not limited to: immediate decision processing, consensus-based decision processing, time-bounded decision processing, and combinations thereof.

According to at least one embodiment, the system may implement temporal controls through various block-based parameters. These parameters may include, but are not limited to: a decision block parameter indicating when the decision collection process initiates; a closing block parameter specifying when the decision process concludes; an expiration block parameter determining when the proposition becomes invalid; and one or more intermediate block parameters governing specific phases of the proposition lifecycle. In some embodiments, these block parameters may be optional, allowing for propositions with undefined temporal boundaries.

Access control within the proposition system may be implemented through one or more configurable decision filters. These filters may specify participation criteria through various mechanisms, including but not limited to: account-based restrictions, token-based restrictions, reputation-based restrictions, and combinations thereof. The decision filters may be evaluated dynamically throughout the proposition lifecycle and may be implemented using one or more authentication mechanisms, including but not limited to: cryptographic verification, capability-based authorization, role-based access control, and combinations thereof.

The reward system associated with propositions may support multiple distribution mechanisms and timing patterns. These may include, but are not limited to: immediate rewards distributed after individual decisions are recorded; threshold-based rewards distributed after specific conditions are met; conclusion-based rewards distributed after proposition closure; and hybrid reward schemes combining multiple distribution patterns. Each proposition may independently configure its reward parameters, including but not limited to: reward types, quantities, distribution criteria, and timing constraints.

Propositions within the system may include extensible data structures to accommodate additional information and configuration options. These structures may include, but are not limited to: descriptive metadata providing context about the proposition's purpose; external reference data linking to related information; supplementary configuration parameters extending the base proposition functionality; and custom data fields supporting application-specific requirements. The extensible nature of these data structures may allow for future expansion of proposition capabilities without requiring fundamental system modifications.

### Decision Process

In various embodiments, a blockchain-based proposition system may include a plurality of timing parameters that govern the progression of a decision process through multiple phases. Each proposition may specify a decision block parameter indicating a block height at which the decision process may commence. The decision block parameter may, In some embodiments, default to a current block height when not explicitly specified in the proposition data structure.

According to at least one embodiment, the system may further include a closing block parameter associated with each proposition, wherein the closing block parameter defines a block height at which the decision process concludes. In one or more embodiments, the absence of a specified closing block parameter may result in the proposition remaining active indefinitely, subject only to an optional expiration block parameter or other termination conditions defined within the system.

Various embodiments may incorporate an expiration block parameter that determines a block height at which a proposition becomes invalid and is designated for removal from the system state. Upon reaching the expiration block height, the system may initiate cleanup procedures to manage the disposition of accumulated rewards, record archival, and state cleanup. In some embodiments, the system may employ lazy evaluation techniques, wherein expiration processing is deferred until the next access attempt of the proposition after the expiration block height has been reached.

Implementations may include one or more configurable decider filters that regulate participation in the decision process. These decider filters may comprise executable authorization filters or other programmatically defined criteria that should be satisfied for an account to qualify as an eligible decider. According to at least one embodiment, the system may perform dynamic evaluation of the decider filters upon submission of each decision to verify the submitting account's eligibility at the time of decision submission.

According to at least one embodiment, the system may implement a plurality of decision modes that define the operational parameters of the decision process. A default decision mode may require resolution of the proposition by the specified closing block height. An immediate decision mode may restrict decision-making authority to a predetermined set of named deciders, with the proposition being resolved upon participation of the specified deciders according to defined resolution criteria.

Certain embodiments may support a consensus-based decision mode wherein the proposition may be resolved prior to the designated closing block height upon achieving a configurable level of consensus among participating deciders. According to at least one embodiment, the system may include parameterized consensus thresholds and evaluation criteria for determining when sufficient consensus has been achieved to trigger early resolution.

For propositions accepting non-Boolean decisions, the system may provide a unique decision mode enforcing distinctness among submitted decisions. In this mode, the system may implement validation logic to ensure each newly submitted decision is unique relative to all previously recorded valid decisions. The unique decision mode may be combinable with other decision mode parameters to create composite decision processes with multiple operational constraints.

Various embodiments may support specification of decision modes and associated operational parameters during proposition creation or modification prior to commencement of the decision period at the decision block height. The selected decision mode may influence reward distribution mechanisms, decision validation criteria, proposition lifecycle management, and other aspects of proposition processing within the system.

### Modifying Propositions During Different Phases

In various embodiments, the system may implement a phase-based modification control framework for propositions, wherein modification permissions are determined by combining multiple factors including, but not limited to: the current phase of the proposition lifecycle, the specific parameter targeted for modification, the authorization level of the requesting account, and one or more system-wide configuration parameters. The modification control framework may be implemented through one or more state machines that track permitted modifications based on the current proposition state.

Embodiments may enforce a pre-decision modification period that extends from proposition creation until the decision block is reached. During this period, the system may selectively permit modifications to non-fundamental parameters while maintaining immutability of core proposition attributes including, but not limited to: the proposition statement, the receiver type, the decision mode, and any specified decider filters. According to at least one embodiment, the system may implement a validation layer that enforces these restrictions through programmatic rules.

Various embodiments may differentiate modification permissions based on proposition attachment status. In some embodiments, attached propositions-those associated with specific accounts—may support modification of temporal parameters including the expiration block value until the closing block is reached. According to at least one embodiment, the system may implement specialized authorization logic for attached propositions that validates both the requesting account's relationship to the proposition and their permission level within the system's authorization framework.

Some embodiments may include an extension framework for detached propositions, wherein propositions may be configured at creation time to permit deadline extensions through a binary configuration flag or more complex configuration parameters. When extensions are permitted, the system may implement controls including, but not limited to: maximum extension periods, required authorization levels for extension requests, minimum intervals between extensions, and aggregate extension limits to prevent indefinite proposition persistence.

Embodiments may enforce a post-decision phase beginning at the decision block, during which the system implements heightened immutability guarantees for proposition parameters that could impact decision integrity or reward distribution. According to at least one embodiment, the system may maintain an immutable audit log of all permitted modifications that includes, but is not limited to: the modified parameters, the requesting account, the block number of the modification, and cryptographic proof of authorization.

Various embodiments may include a configurable authorization filter framework for modification control. The framework may support the creation and evaluation of complex authorization rules that consider multiple inputs including, but not limited to: account metadata, system state, temporal parameters, and cryptographic proofs. The authorization filters may be specialized for different proposition types while maintaining a consistent evaluation interface.

According to at least one embodiment, the system may implement atomic modification handling for parameters that affect active processes, particularly those related to reward distribution. In some embodiments, modifications to reward parameters may trigger a multi-phase validation process that verifies reward availability, analyzes impact on existing participants, and ensures conformance with system-wide economic constraints before committing the modification.

Various embodiments may include a modification policy specification framework that allows propositions to declare allowed modifications through a structured policy definition. The policy definition may specify permitted modifications for each lifecycle phase using a declarative format that supports both simple Boolean flags and complex conditional rules. The modification policy itself may be immutable after proposition creation to provide deterministic behavior throughout the proposition lifecycle.

### How Decisions Are Validated And Recorded

In various embodiments, a system for processing proposition decisions may implement a multi-stage validation process to verify each decision's eligibility and correctness. The validation process may begin with temporal validation, wherein the system verifies that the submitted decision occurs within valid time parameters-specifically, after a designated decision block has been reached but before any specified closing or expiration blocks. According to at least one embodiment, the system may be configured to automatically reject decisions submitted outside these temporal bounds.

Each validated decision may be recorded in a data structure that maintains both the decision payload and associated metadata. The recorded metadata may include, but is not limited to, a unique identifier for the deciding account, a cryptographic signature validating the decision's authenticity, one or more timestamps or block numbers indicating when the decision was submitted and recorded, and optionally, references to prior decisions from the same deciding account. For Boolean propositions, the decision payload may comprise a determination value selected from a predefined set of valid responses, while for non-Boolean propositions, the decision payload may incorporate contextual data conforming to proposition-specific schemas or formats.

According to at least one embodiment, the system may implement an ordered sequence of decisions for each proposition, maintaining temporal ordering that can be cryptographically verified. When a deciding account submits an updated decision, the system may be configured to atomically remove the account's previous decision from the sequence while appending the updated decision at the current terminus of the sequence. This ordered record may be crucial for deterministic reward distribution and proper proposition resolution.

Various embodiments may enforce type-specific validation rules based on the proposition's classification. For Boolean propositions, the system may verify that decisions contain valid deterministic choices from the allowed set of responses. For non-Boolean propositions, the system may implement comprehensive validation of decision payloads, ensuring all required parameters are present and that each parameter satisfies any constraints or requirements specified in the proposition definition.

According to at least one embodiment, the system may execute a configurable decider filter evaluation process before recording each decision. This evaluation process may verify multiple aspects of the deciding account's eligibility, including but not limited to: account authorization levels, historical participation metrics, current account state, and satisfaction of any proposition-specific criteria. The evaluation may be performed against the current state of the system at the time of decision submission.

One or more index structures may be maintained to enable efficient access to and analysis of proposition decisions. These index structures may track participating accounts, maintain aggregated decision statistics, facilitate unique decision enforcement, and support efficient querying of decision states. According to at least one embodiment, the system may update these indices atomically with decision recording to maintain consistency.

For non-Boolean propositions accepting contextual decision data, the system may implement a context validation framework that verifies structural correctness, completeness, and constraint satisfaction of the provided context. This framework may enforce proposition-specific rules regarding context format, required fields, and value constraints. According to at least one embodiment, the system may be configured to reject decisions with invalid or incomplete context data.

The decision recording process may adapt its validation and authorization requirements based on the proposition's configured decision mode. Propositions operating in immediate decision mode may enforce strict validation of deciding account authorization through cryptographic proofs or other mechanisms, while propositions in other modes may implement more flexible validation schemes that prioritize broader participation while maintaining security through decider filters.

### Reward System

In various embodiments, a distributed ledger system may implement configurable reward distribution mechanisms for proposition-based decision processes. Such mechanisms may control allocation of digital assets to participating decision makers (“deciders”) who provide decisions on propositions. According to at least one embodiment, the system may support multiple reward distribution types, including but not limited to, an immediate per-decision reward distribution and a delayed closing-block reward distribution.

According to some embodiments, an immediate reward distribution mechanism may allocate rewards upon receipt of each valid decision (“per-decision rewards”). The per-decision reward distribution may comprise automatically transferring a predetermined quantity of digital tokens from a proposition reward pool to a decider's account upon validation of the decider's submitted decision. The reward amount may be configured to be independent of the decision content, such that deciders receive equal rewards regardless of whether their decisions align with or differ from other submitted decisions.

Embodiments may support decision updates, wherein a decider may modify a previously submitted decision. In embodiments supporting decision updates, the system may be configured to allocate additional rewards for each valid decision update, subject to rate-limiting constraints. The reward amount for decision updates may be equal to or different from the reward amount for initial decisions.

To prevent potential exploitation of the per-decision reward mechanism, embodiments may implement temporal constraints between successive decisions or updates. Such constraints may include a minimum block interval requirement, wherein the system enforces a predetermined number of blocks that should be processed between a decider's consecutive decision submissions or updates on the same proposition. The block interval requirement may be configurable per proposition and may vary based on proposition type, total reward pool size, or other parameters.

In various embodiments, the system may implement reward pool validation prior to decision acceptance. Upon receipt of a decision or decision update, the system may verify that the proposition's reward pool contains sufficient digital assets to cover the predetermined reward amount. If the reward pool balance is insufficient, the system may be configured to either reject the decision submission or hold the decision in a pending state until the reward pool is replenished.

According to some embodiments, a delayed reward distribution mechanism may allocate rewards upon reaching a predetermined block height (“closing-block rewards”). Such implementations may generate and store job records within decider accounts upon receipt of valid decisions. Each job record may comprise data elements including, but not limited to: proposition identifiers, decision content, submission block height, closing block height, and reward parameters.

Embodiments implementing closing-block rewards may evaluate the aggregate set of decisions upon reaching the specified closing block height to determine reward allocation. According to at least one embodiment, the system may employ various distribution algorithms based on decision outcomes. In some embodiments, the system may identify a majority decision and allocate rewards to deciders whose decisions align with the majority. Alternative implementations may allocate rewards to minority decision makers or implement other distribution criteria.

According to at least one embodiment, the system may support configurable beneficiary limitations for closing-block rewards. Embodiments may implement a maximum beneficiary parameter N, wherein rewards are distributed only to the first N deciders who submitted valid decisions. According to at least one embodiment, the system may be configured to validate that N does not exceed a global maximum decider limit for the proposition. When N is set to zero or is unspecified, the system may distribute rewards to all eligible deciders.

Various embodiments may implement different reward distribution methodologies for tied decisions. In one implementation, the system may automatically detect decision ties and initiate equal reward distribution among all participating deciders. Alternative implementations may apply weighted distribution based on factors including, but not limited to: decision submission timing, decider historical accuracy, decider stake amount, or pseudorandom selection.

According to some embodiments, the system may implement reward pool segregation, wherein multiple reward pools containing different types of digital assets may be associated with a single proposition. According to at least one embodiment, the system may apply configurable rules to determine which reward pool to utilize based on factors including, but not limited to: decision timing, decision content, decider preferences, or global system parameters.

Embodiments may support dynamic reward pool management, wherein authorized entities may add digital assets to proposition reward pools during the proposition lifecycle. According to at least one embodiment, the system may implement access controls to determine which entities may replenish reward pools and may enforce minimum and maximum reward pool size constraints. In some embodiments, reward pool replenishment may automatically extend proposition expiration parameters.

### Cleanup and Maintenance/Storage and Cleanup

In various embodiments, the system may implement specific procedures for handling remaining rewards during cleanup operations. When an annotation reaches expiration, the system may first determine the reward type and execute appropriate procedures. For rewards configured for distribution after each decision, the system may calculate remaining balances and initiate refund operations to respective owners. For rewards configured for distribution after closing block, the system may trigger all pending jobs and distribute remaining rewards among eligible beneficiaries before cleanup.

According to at least one embodiment, the system may, In some embodiments, employ distinct cleanup behaviors for detached propositions. When processing detached annotations during decoding, the system may apply similar cleanup procedures as those applied to attached propositions, including but not limited to, checking for closing conditions, processing pending rewards, and managing expiration. In certain embodiments, the system may maintain separate tracking mechanisms for detached propositions to optimize cleanup operations.

Various embodiments may incorporate optimization techniques for managing proposition storage. According to at least one embodiment, the system may implement methods to minimize storage overhead, including but not limited to, removing unnecessary data structures, consolidating similar propositions, and implementing efficient indexing mechanisms. In some embodiments, the system may maintain only essential data while archiving or removing redundant or expired information.

According to at least one embodiment, the system may, in certain embodiments, implement procedures for processing multiple pending jobs during cleanup operations. When multiple jobs are pending on a decider's account, the system may process these jobs according to configurable priorities or ordering mechanisms. In some embodiments, the system may batch process multiple jobs to optimize computational resources while maintaining correct reward distribution sequences.

Various embodiments may incorporate mechanisms for handling proposition modifications during cleanup operations. According to at least one embodiment, the system may implement methods to track and process modifications to propositions, including but not limited to, extending expiration periods, updating reward configurations, and managing associated data structures. In one or more embodiments, the system may maintain modification histories while cleaning up outdated or superseded data.

According to at least one embodiment, the system may, in some embodiments, implement specialized cleanup procedures for propositions with complex reward structures. When processing cleanup operations for propositions with multiple reward beneficiaries or varying reward types, the system may execute appropriate distribution calculations and refund operations based on configurable rules or parameters. In one or more embodiments, the system may maintain separate tracking mechanisms for different reward types to optimize cleanup operations.

Various embodiments may incorporate mechanisms for managing proposition data during cleanup operations. According to at least one embodiment, the system may implement methods to maintain data integrity while removing unnecessary information, including but not limited to, consolidating related data structures, removing redundant information, and optimizing storage utilization. In some embodiments, the system may maintain configurable retention policies for different types of proposition data.

According to at least one embodiment, the system may, in certain embodiments, implement procedures for handling partial cleanup operations. When processing cleanup operations that affect only portions of a proposition's data or associated structures, the system may maintain appropriate references and relationships while removing unnecessary components. In some embodiments, the system may implement versioning mechanisms to track partial cleanup operations and maintain data consistency.

Various embodiments may incorporate mechanisms for managing cleanup operations across multiple accounts or propositions. According to at least one embodiment, the system may implement methods to coordinate cleanup operations affecting multiple entities, including but not limited to, synchronizing reward distributions, managing shared resources, and maintaining consistency across related data structures. In one or more embodiments, the system may maintain transaction boundaries to ensure atomic execution of related cleanup operations.

According to at least one embodiment, the system may, in some embodiments, implement procedures for handling cleanup operations during system recovery or maintenance. When processing cleanup operations during system recovery or maintenance periods, the system may execute appropriate validation and verification procedures to maintain data integrity and consistency. In one or more embodiments, the system may maintain recovery points or checkpoints to ensure reliable execution of cleanup operations.

### Decision Records

In various embodiments, a system for managing distributed consensus may implement one or more decision records associated with propositions. Each decision record may comprise a structured data element containing multiple fields that define both the content of the decision and its relationship to a proposition maintained within the system.

According to certain embodiments, each decision record may include a receiver field identifying an account on which the associated proposition exists, a receiver type field indicating whether the receiver is an external account, standard account, or token type account, and a proposition hash field containing a cryptographic hash of the referenced proposition. According to at least one embodiment, the system may be configured to validate these fields during decision record processing to ensure proper association between decisions and their corresponding propositions.

In various embodiments, each decision record may include a decision type parameter indicating the nature of the decision. This parameter may be configured to store at least three distinct values: a first value indicating a positive decision, a second value indicating a negative decision, and a third value indicating a destructive decision. According to at least one embodiment, the system may process these different decision types according to configurable rules that may vary based on the proposition type and system implementation.

The decision record structure may optionally include an annotation context field configured to store arbitrary data related to the decision. In some embodiments, this annotation context may be encoded in a standardized format and may contain one or more key-value pairs representing decision-specific parameters or variables. According to at least one embodiment, the system may be configured to validate and process this annotation context during decision evaluation.

When processing non-Boolean propositions, the system may implement specialized validation rules requiring that each decision record includes either a valid annotation context or a decision reference pointer. In embodiments where a decision reference is provided, it may contain an address or identifier associated with another decider's determination. According to at least one embodiment, the system may be configured to verify the validity of referenced decisions during the validation process.

According to certain embodiments, the system may implement configurable uniqueness constraints for non-Boolean proposition decisions. When such constraints are enabled, the system may execute validation procedures to ensure that each decider's annotation context is unique among all decisions associated with the target proposition. This uniqueness verification may analyze the content and structure of annotation contexts to prevent duplicate or substantially similar decisions from being recorded.

According to at least one embodiment, the system may enforce a cardinality constraint wherein each decider is permitted to maintain no more than one active decision per proposition. However, the system may be configured to process decision updates, allowing deciders to modify their existing decisions through a controlled update mechanism. This update process may include validation steps to ensure consistency and maintain appropriate historical records while marking only the most recent decision as active for processing purposes.

In one or more embodiments, the decision record management system may implement a position-sensitive update mechanism. When processing decision updates, the system may be configured to remove the previous decision from its original position in a chronologically-ordered sequence and append the updated decision at the terminal position of the sequence. This reordering mechanism may be implemented to maintain proper temporal ordering and ensure accurate processing of time-sensitive operations such as reward distributions or decision-dependent calculations.

According to at least one embodiment, the system may optionally include verification mechanisms to ensure that decision records conform to any constraints specified in the associated proposition. These constraints may include, but are not limited to, temporal limitations, decider eligibility requirements, and format restrictions for annotation contexts. The verification process may be executed before accepting new decision records or processing updates to existing decisions.

### Configuration Options

In various embodiments of the present disclosure, a blockchain-based system may implement propositions having configurable parameters that govern their behavior and lifecycle. Each proposition may include a plurality of configuration settings, which may be stored as part of a proposition record data structure within the system.

According to certain embodiments, the proposition record may include a configuration field that stores one or more control flags, which may be implemented as a bitmap data structure. The bitmap structure may contain a plurality of Boolean indicators that define permitted operations on the proposition. In some embodiments, a first indicator within the bitmap may comprise an extensibility flag that, when set to a positive value, permits entities other than an original proposition creator to augment a reward pool associated with the proposition by contributing additional reward tokens. A second indicator within the bitmap may comprise a deletion permission flag that, when set to a positive value, enables an account that originally transmitted the proposition to subsequently delete the proposition and any associated annotation data structures from the system.

In various embodiments, the proposition record may include a description field configured to store metadata about the proposition's semantic meaning. The description field may be implemented as a variable-length data structure containing human-readable text that describes one or more aspects of the proposition, including but not limited to: the meaning of variables used within the proposition, conditions for proposition resolution, expected outcomes, and other contextual information that may aid system participants in understanding the proposition's purpose. The description field may be optional, such that a valid proposition record may be created with an empty description field.

According to certain embodiments, the proposition record may include a parameter that defines an upper bound on the number of decision records that may be associated with the proposition. This maximum decider parameter may be implemented as a numeric field that constrains the total quantity of unique accounts permitted to submit valid decision records for the proposition. When this maximum is reached, the system may be configured to reject subsequent attempts to submit additional decision records, while still permitting updates to existing decision records according to other applicable rules and permissions.

Various embodiments may implement reward mechanics through configurable token settings stored within the proposition record. These settings may specify one or more token identifiers corresponding to user-defined token types supported by the system. In some embodiments, the token settings may explicitly exclude system fuel tokens from being used as rewards. The token configuration may include fields defining initial reward amounts, distribution algorithms, vesting schedules, claim conditions, and other parameters governing how rewards are allocated among participants.

In one or more embodiments, the reward token configuration may be designed to interact with other configuration settings through a set of predefined rules. For example, when the extensibility flag is set to permit reward pool additions, the token settings may define parameters controlling how multiple reward contributions are tracked and attributed to their contributors. The settings may specify rules for reward refunds in the event of proposition deletion or expiration, including but not limited to: proportional refund ratios, minimum refund thresholds, refund timing constraints, and priority ordering among multiple contributors. According to at least one embodiment, the system may enforce these rules through automated smart contract functionality that manages the reward pool according to the specified parameters.

### Data Utility Function (Auth Filter)

In various embodiments, systems and methods may be provided for implementing a data utility function within an authentication filter framework, wherein the data utility function may be configured to process and filter proposition data according to multiple configurable criteria. The data utility function may be configured to accept at least three input parameters: (i) an interface identifier that may specify the source of propositions to be filtered, (ii) a filter node that may define filtering criteria, and (iii) a voter list that may specify relevant decision makers, wherein the interface identifier may comprise one or more of: a blockchain account address, a base-32 encoded string identifier, a token type identifier, or a set of proposition annotations.

The data utility function may be configured to evaluate the filter node parameter against proposition metadata to determine proposition eligibility. In some embodiments, the filter node may comprise a logical expression tree that may reference one or more proposition attributes including, but not limited to: block numbers associated with proposition creation, modification, or closure; current proposition status indicators; voter participation metrics; temporal data; and proposition-specific metadata fields. The filter node evaluation may be performed using recursive traversal of the expression tree, with leaf nodes comparing specific attribute values against defined criteria.

In certain embodiments, the data utility function may implement separate processing pathways for Boolean and non-Boolean propositions, with each pathway optimized for the specific requirements of its proposition type. For Boolean propositions, the function may implement a binary decision evaluation process that may determine validity based on the aggregation of positive and negative votes. The evaluation process for Boolean propositions may be configured to consider either all recorded decisions or only decisions from specified voters, depending on whether a voter list parameter is provided.

The data utility function may be configured to implement flexible decision validation logic that may adapt based on proposition characteristics and input parameters. For Boolean propositions without a specified voter list, the function may validate propositions by comparing aggregate positive and negative vote counts across all recorded decisions. When a voter list is provided for Boolean propositions, the function may be configured to calculate validity metrics using only the decisions originating from the specified voter set, potentially implementing different thresholds or weighting schemes for the restricted voter set.

In various embodiments, the data utility function may implement specialized processing for non-Boolean propositions that may include support for unique decision requirements. When unique decision constraints are enabled, the function may be configured to verify that each voter's annotation context is unique among all recorded contexts. The uniqueness verification may be performed using cryptographic hashing of annotation contexts or other suitable comparison methods. The function may be configured to reject or invalidate propositions where duplicate annotation contexts are detected among voters.

The data utility function may be configured to support decision reference tracking for non-Boolean propositions, wherein voters may indicate endorsement of previous decisions through explicit reference mechanisms. In some embodiments, the function may maintain reference counts or graphs to track decision relationships and may implement algorithms to identify most-referenced decisions. The reference tracking system may support both direct references and transitive reference chains, wherein one decision may reference another decision that itself references a third decision.

For non-Boolean propositions with specified voter lists, the data utility function may implement multi-phase evaluation logic. In a first phase, the function may analyze all recorded decisions to build a comprehensive reference map. In a second phase, the function may filter the reference map to consider only decisions from listed voters. The function may be configured to return decision data only when a clear reference plurality exists among the specified voters, implementing configurable thresholds for what constitutes a sufficient plurality.

The data utility function may support advanced decision data processing capabilities that may include transformation and compilation of voter-provided annotation contexts. In some embodiments, the function may perform variable substitution, constraint unification, and other transformations on annotation contexts to produce executable decision data. The function may maintain both original and transformed versions of decision data to support various query and validation operations. The transformation process may be configured to validate syntax, type constraints, and semantic rules specified for the proposition.

### Proposition System Cost and Economic Model

A blockchain-based proposition system may implement various economic mechanisms for managing proposition operations. These economic mechanisms may include, but are not limited to: a gas consumption model for operation execution, an initial reward structure for incentivizing participation, an extensible reward pool system for ongoing operations, and one or more anti-spam protections that may regulate system utilization.

According to at least one embodiment, the system may calculate gas consumption for proposition-related operations based on multiple discrete factors. These factors may include: computational complexity measured in processor cycles, storage requirements measured in bytes of persistent storage, and network utilization measured in bytes transmitted. The gas calculation may implement a base cost combined with one or more variable components. The variable components may scale with the size of the proposition data, the complexity of associated authentication requirements, or other measurable attributes of the proposition.

Propositions may be created with an optional initial reward allocation. The initial reward allocation may be specified in terms of one or more token types, which may include system tokens, user-defined tokens, or any combination thereof, but may specifically exclude fuel tokens. The reward allocation, when present, may be automatically locked upon proposition creation. The locked rewards may be held in one or more segregated accounts that may be associated with the proposition through cryptographic links.

According to at least one embodiment, the system may implement a reward pool extension mechanism that enables modification of proposition reward amounts after initial creation. When enabled for a particular proposition, the extension mechanism may permit additional rewards to be added through one or more contribution transactions. The ability to extend rewards may be controlled through a configurable permission system that may specify which accounts are authorized to contribute additional rewards. The extension mechanism may implement contribution limits that may be specified in terms of minimum amounts, maximum amounts, or both.

Anti-spam protections may be implemented through a slot-based resource allocation system. Under this system, each proposition may be required to consume one or more slots from a finite pool of system resources. The number of slots required may be calculated based on the proposition's storage requirements, computational complexity, or other measurable attributes. Slots may be automatically released when propositions expire or are completed, making them available for reuse by new propositions.

Resource utilization may be managed through a dynamic pricing mechanism that adjusts operational costs based on system load. The pricing mechanism may implement an algorithmic market maker that increases costs as resource utilization approaches system limits. The algorithm may consider multiple factors including, but not limited to: current slot utilization, historical usage patterns, and rate of new proposition creation. Cost adjustments may be applied to gas prices, slot acquisition costs, or both.

According to at least one embodiment, the system may implement a storage deposit mechanism that requires proposition creators to lock resources proportional to their storage utilization. The storage deposits may be denominated in fuel tokens and may be automatically refunded when storage is released. The deposit amount may be calculated based on the size of the proposition data, the expected storage duration, and a configurable base rate that may be adjusted through system governance mechanisms.

A proposition's reward distribution may be controlled through configurable distribution rules that specify how rewards are allocated among participants. The distribution rules may implement multiple reward types including, but not limited to: fixed participation rewards that may be distributed immediately upon valid participation, conditional rewards that may be distributed based on decision outcomes, and time-based rewards that may be distributed according to participation order. The reward types may be combined within a single proposition to create complex incentive structures.

According to at least one embodiment, the system may implement automated cleanup mechanisms that process expired propositions according to configurable rules. These mechanisms may execute when propositions reach their expiration time or when they are explicitly closed. The cleanup process may include multiple stages that may execute in a predetermined order, including: reward distribution to qualified participants, refund of unused rewards to contributors, and release of consumed slots back to the system resource pool.

### Data Utility Functions

In various embodiments, the blockchain system may include one or more data utility functions configured to provide selective access to proposition data stored within the blockchain. These functions may implement filtering mechanisms that can process multiple proposition types and may return filtered results based on configurable criteria. The data utility functions may be particularly adapted to handle the distinct requirements of both Boolean and non-Boolean propositions through specialized evaluation logic.

According to certain embodiments, the data utility functions may be structured to accept three primary input parameters. A first parameter may comprise an interface input that can accept multiple data types including, but not limited to, blockchain addresses represented as common. Address types, zBase32 encoded strings, token name identifiers, or annotation data structures. The interface input may determine the scope of propositions to be evaluated, where a special “Prop” utility function may be employed to specifically access detached propositions within the system.

Various embodiments may implement a filter node as a second parameter, which may define a hierarchical structure of filtering criteria. The filter node may evaluate multiple factors present in the annotations or propositions including, but not limited to, block height parameters, proposition status indicators, decision state markers, temporal constraints, or other metadata attributes. The filter node may be configured to combine multiple criteria using logical operators to create complex filtering conditions.

In some embodiments, a third parameter comprising a voter list may be included to enable filtering based on specific decider participation. The voter list may contain zero or more decider identifiers, where the presence or absence of listed deciders may affect the evaluation strategy employed by the data utility functions. The processing methodology may be automatically selected based on both the proposition type (Boolean or non-Boolean) and the voter list composition.

According to certain embodiments, Boolean proposition evaluation may implement distinct processing paths based on voter list status. When processing Boolean propositions without a provided voter list, the data utility functions may perform a comprehensive evaluation of all recorded decisions, calculating the differential between positive and negative votes to determine inclusion in the result set. In contrast, when a voter list is provided, the functions may restrict their evaluation scope to only those decisions made by the specified deciders, potentially applying different threshold criteria for result inclusion.

Various embodiments may implement specialized decision processing logic for non-Boolean propositions. In implementations where unique decision constraints are active and no voter list is provided, the functions may be configured to return a null result to maintain system consistency. When non-unique decisions are permitted, the functions may employ reference counting mechanisms to identify the most frequently referenced decision, potentially incorporating weighting factors based on decider characteristics or temporal proximity.

In some embodiments involving non-Boolean propositions with specified voter lists, the data utility functions may employ a multi-stage evaluation process. This process may first evaluate all decisions from the specified voters, then apply finalization criteria to identify a singular authoritative decision. The finalization criteria may include, but are not limited to, consensus thresholds, temporal validations, stake-weighted measurements, or combinations thereof. The functions may be configured to return decision data only when a single decider's input can be definitively identified as finalized according to the system's rules.

### Propositions and Authentication Filters (Auth Filters)

In various embodiments, the blockchain system may implement one or more authentication filters (“auth filters”) as executable validation mechanisms within the blockchain protocol. Auth filters may comprise computer-executable instructions that, when executed by one or more processors of the blockchain network, implement programmable validation rules. These validation rules may be stored within the blockchain's state data and may be referenced by various blockchain components including, but not limited to, propositions, accounts, smart contracts, and transaction processors.

According to certain embodiments, auth filters may be associated with propositions to implement decider validation logic. When associated with a proposition, the auth filter may receive a context data structure containing information about a potential decider and their proposed decision. The context data structure may include, but is not limited to, the decider's account information, historical participation data, current stake amounts, associated identity assertions, and transaction-specific parameters. The auth filter may evaluate this context against its programmed criteria and return a Boolean result indicating whether the decision should be permitted.

In some embodiments, auth filters may implement transaction validation logic through a multi-phase evaluation process. During a first phase, the auth filter may perform static analysis of transaction parameters before execution to determine minimum gas requirements and basic validity. During a second phase, the auth filter may perform dynamic validation during transaction execution, potentially accessing current blockchain state data. The auth filter may examine various transaction aspects including, but not limited to: source account permissions, destination account restrictions, token transfer rules, smart contract interaction permissions, and compliance with global protocol rules.

Various embodiments may implement special-purpose blockchain accounts (“p2sh accounts”) that are programmatically controlled by associated auth filters. These accounts may be created by generating a cryptographic address through a deterministic process that incorporates: (i) the auth filter's executable code, (ii) optional configuration parameters, and (iii) a unique differentiator value. The differentiator value may be derived from various sources including, but not limited to: transaction hashes, atomic record container identifiers, or other unique blockchain references. When transactions interact with p2sh accounts, the associated auth filters automatically execute to validate the interaction.

According to certain embodiments, auth filters may implement type-aware access control through account type analysis. The auth filter may receive typed account references that include metadata indicating the account's classification (e.g., user account, smart contract, p2sh account, token contract). Based on these types, the auth filter may selectively permit or restrict interactions according to protocol-level rules. The type analysis may be combined with other validation criteria to implement sophisticated access control policies that maintain protocol invariants while enabling controlled interaction between different account types.

Various embodiments may implement precise gas accounting for auth filter execution. The gas cost may be calculated through static analysis of the auth filter's executable code combined with runtime metrics. Static costs may be derived from instruction counting, complexity analysis, and worst-case execution path calculation. Runtime costs may account for actual computational resources consumed, including but not limited to: CPU cycles, memory allocation, storage access, and external data queries. The gas accounting system may implement a multi-tier pricing model where different types of operations have different gas costs based on their resource consumption profiles.

In some embodiments, the system may optimize auth filter execution through various caching and pre-compilation mechanisms. Frequently used auth filters may be compiled to native code and cached in memory by validator nodes. According to at least one embodiment, the system may implement a tiered caching architecture where different caching strategies are applied based on the auth filter's characteristics including, but not limited to: execution frequency, state access patterns, and resource requirements. Cache invalidation may be triggered by relevant state changes or block boundary events.

According to certain embodiments, auth filters may support compositional logic through a hierarchical combination system. Multiple auth filters may be composed using logical operators including, but not limited to: conjunction (AND), disjunction (OR), negation (NOT), and more complex combinations. The composition system may implement short-circuit evaluation to optimize gas consumption. Composite auth filters may define their gas costs as functions of their component filters, potentially implementing sophisticated cost models that account for evaluation order and short-circuiting opportunities.

### Non-Boolean Propositions Structure & Context

In various embodiments, a blockchain system may support non-Boolean propositions that enable determinations beyond binary true/false outcomes. Such non-Boolean propositions may be implemented through a proposition record structure that includes, but is not limited to, a statement field containing one or more placeholder variables, optional metadata fields describing the expected structure or constraints of potential values, and one or more configuration fields that may govern how decisions and their associated data are processed. The placeholder variables within the statement may be denoted using any suitable syntax or markup that allows them to be unambiguously identified and processed by the system.

According to certain embodiments, decisions on non-Boolean propositions may require supplementary contextual information to be considered valid. According to at least one embodiment, the system may enforce this requirement through a decision record structure that may include either: (1) an annotation context field containing data that resolves placeholder variables, or (2) a decision reference field containing a pointer to another decider's previously submitted context. The annotation context, when present, may be encoded in various formats including, but not limited to, key-value pairs, hierarchical structures, or serialized data objects that map variables to their resolved values. The decision reference, when utilized, may comprise a blockchain address, transaction identifier, or other suitable reference mechanism that unambiguously identifies the referenced decision record.

In some embodiments, the system may execute a multi-stage validation and processing sequence when a decision record containing an annotation context is submitted. This sequence may include, but is not limited to: (1) parsing the annotation context data according to its encoded format, (2) validating that values are provided for all required placeholder variables, (3) verifying that provided values conform to any type constraints or value restrictions specified in the proposition, (4) performing variable replacement within the proposition statement using the provided values, and (5) executing any necessary unification operations on the replaced variables to ensure logical consistency. The results of this processing sequence may be stored as decider data associated with the decision record.

Various embodiments may implement a structured data model for managing the relationships between proposition statements, placeholder variables, and their resolved values. This model may include, but is not limited to: (1) a variable registry that tracks all placeholder variables within a proposition, (2) a validation framework that enforces data type constraints and relationship rules between variables, (3) a resolution mechanism that manages the replacement of variables with their provided values, and (4) a reference system that maintains the integrity of relationships between decisions that reference each other's contexts. The data model may support various validation rules including, but not limited to, type checking, range validation, pattern matching, and relationship constraints between multiple variables.

According to certain embodiments, the system may accommodate proposition statements with varying levels of complexity in their variable structure and relationships. According to at least one embodiment, the system may support, but is not limited to: (1) simple single-variable propositions where one value may be determined, (2) multi-variable propositions where several values may be provided and may have interdependencies, (3) propositions with optional variables that may be omitted under certain conditions, (4) propositions with nested or hierarchical variable structures, and (5) propositions with variables that should maintain mathematical, logical, or other defined relationships with each other. The validation system may enforce any constraints or relationships between variables through configurable rule sets that may be specified as part of the proposition record.

### Non-Boolean Propositions Decision Process

In various embodiments, a blockchain system may implement mechanisms for processing non-Boolean propositions through one or more decision records. Each decision record may include both the decider's decision and an annotation context. The annotation context may be structured as a map containing key-value pairs, where each key corresponds to a placeholder variable in the proposition statement, and each value represents the decider's proposed value for that variable.

According to certain embodiments, when a decision record is received, the system may execute a multi-stage validation and processing sequence. In a first stage, the system may decode the annotation context map using one or more predefined decoding algorithms. The decoding process may convert the context from its transmitted format into an internal representation suitable for further processing. The internal representation may maintain type information for the variable values, which may include, but is not limited to, numeric types, string types, Boolean types, and composite types.

Various embodiments may implement verification mechanisms to ensure context completeness. These mechanisms may analyze the decoded context against the original proposition's requirements, verifying that values are provided for all mandatory placeholder variables. The verification process may generate one or more error conditions if required variables are missing or if provided values fail to meet type constraints or other validation rules specified in the proposition.

According to certain embodiments, after successful verification, the system may perform variable replacement operations. These operations may systematically substitute each placeholder variable in the proposition statement with its corresponding value from the decoded context. The replacement process may maintain semantic consistency while handling various value types and ensuring proper escaping or encoding of special characters. In some embodiments, the system may maintain a log of replacements to facilitate debugging or audit processes.

In various embodiments, following variable replacement, the system may initiate one or more unification processes. The unification processes may analyze the replaced variables to ensure logical consistency and detect potential conflicts or contradictions. The unification algorithms may implement pattern matching, constraint satisfaction, or other logical inference methods. According to at least one embodiment, the system may maintain unification state information that can be used in subsequent processing stages or referenced by other system components.

Various embodiments may generate structured annotation data based on the unified and processed context. This annotation data may be organized as an array of one or more maps, where each map may contain processed variable assignments, metadata about the unification process, and any derived or inferred values. According to at least one embodiment, the system may store this annotation data in association with the decision record as “DeciderData”. The DeciderData structure may be optimized for efficient retrieval and comparison operations while maintaining all necessary information for subsequent decision processing.

### Non-Boolean Propositions Unique Decisions Mode

In various embodiments, a blockchain system may implement one or more specialized decision modes for handling non-Boolean propositions, wherein at least one such decision mode may comprise a unique decision mode that enforces uniqueness constraints while maintaining other operational characteristics of a default decision mode. The unique decision mode may be specified through one or more configuration values in a proposition record, and may govern how decisions and their associated data are processed and validated within the system.

According to certain embodiments, the system operating in unique decision mode may enforce uniqueness of annotation contexts across all decisions submitted for a given proposition. An annotation context may comprise one or more sets of variable assignments, wherein each variable assignment may include, but is not limited to, a variable identifier and a corresponding value. According to at least one embodiment, the system may implement one or more validation mechanisms that compare newly submitted annotation contexts against existing contexts to ensure uniqueness is maintained. The validation mechanisms may operate at various stages including, but not limited to, at transaction acceptance, during block processing, or during proposition evaluation.

In some embodiments, the system may implement real-time validation to prevent different deciders from providing identical annotation contexts for the same proposition. When a decider submits a decision record containing an annotation context, the system may compare the submitted context against a set of existing contexts using one or more comparison algorithms. If a match is detected between the submitted context and any existing context, the system may reject the transaction and optionally generate one or more error codes or messages indicating the reason for rejection.

Various embodiments may implement the unique decision mode as an extension of a default decision mode, inheriting one or more base behaviors while adding uniqueness constraints. The inherited behaviors may include, but are not limited to, closing block mechanics, decision timing rules, and reward distribution mechanisms. The uniqueness constraints may be implemented through one or more additional validation steps that occur during normal proposition processing without fundamentally altering the underlying decision mechanics.

According to certain embodiments, the system may maintain one or more specialized data structures for tracking decision uniqueness efficiently. These data structures may include, but are not limited to, hash tables, ordered maps, or specialized indices optimized for context comparison operations. The data structures may be updated atomically with decision processing to maintain consistency between the uniqueness tracking and the overall proposition state. According to at least one embodiment, the system may implement various optimization techniques to minimize the computational overhead of uniqueness validation while maintaining security guarantees.

In some embodiments, the system may provide one or more mechanisms for handling edge cases in uniqueness validation. These mechanisms may address scenarios including, but not limited to, simultaneous submission of identical contexts, partial context matches, or context modifications. According to at least one embodiment, the system may implement deterministic rules for resolving such edge cases, which may be based on factors including, but not limited to, submission timing, decider stakes, or other measurable criteria. These resolution rules may be configurable through one or more parameters in the proposition record.

### Non-Boolean Propositions Data Function Behavior

In various embodiments, a blockchain system may implement a data function configured to process non-Boolean propositions through multiple evaluation pathways based on input parameters and proposition state. The data function may accept an interface identifier, a filter node, and an optional voter list as input parameters, where the interface identifier may comprise a common address, a base32-encoded string, a token name, or annotation data structures. The filter node may define proposition selection criteria, while the voter list may specify authorized decision evaluators.

According to certain embodiments, when processing a non-Boolean proposition with unique decision mode enabled and receiving an empty voter list parameter, the data function may be configured to enforce strict uniqueness by returning a null result. This behavior may serve to prevent ambiguous data states by requiring explicit voter specification for unique decision mode propositions, thereby maintaining deterministic evaluation paths.

In some embodiments, the data function's processing of non-Boolean propositions with non-unique decision mode and empty voter lists may involve comprehensive decision evaluation procedures. The function may analyze the complete set of decisions, tracking reference patterns through a reference counting mechanism. When a particular decision accumulates the highest reference count across all decisions, the function may return the complete decision data package associated with the most-referenced decider, including but not limited to the decider's context data and any associated annotation data.

Various embodiments may implement a voter-list-driven evaluation pathway that processes decisions through multiple validation stages. Upon receiving a non-empty voter list, the data function may evaluate all decisions while applying voter authorization constraints derived from the voter list. The function may be configured to return decision data exclusively in scenarios where the evaluation process results in deterministic finalization of a single decider's contribution. In cases where the evaluation maintains multiple valid decider states or fails to achieve single-decider finalization, the function may return a null result to maintain system consistency.

According to certain embodiments, the data function may maintain internal state tracking structures optimized for decision evaluation. These structures may include, but are not limited to, reference count maps, voter participation indices, decision state trees, and finalization markers. The tracking system may be implemented using efficient data structures that optimize for quick lookup and modification operations while maintaining consistency with the blockchain's state management principles.

In some embodiments, the data function may expose configurable parameters that govern its evaluation behavior. These parameters may include, but are not limited to, reference count thresholds, finalization criteria, voter participation requirements, and decision mode flags. The parameters may be specified through system-level configurations, proposition-specific settings, or dynamic computation based on proposition state and participant actions. The configuration system may support runtime adjustment of these parameters within bounds defined by the blockchain's consensus rules.

### Non-Boolean Propositions Decision References

In various embodiments, a blockchain system may implement a decision record structure that includes a decision reference capability, particularly useful for non-Boolean propositions. The decision record may include one or more fields including, but not limited to: a receiver field identifying the account on which the proposition exists, a receiver type field indicating whether the receiver is external, account-based, or token-based, a proposition hash field containing the hash of the relevant proposition, a decision field indicating the decision type, an optional annotation context field, optional external data, and an optional decision reference field (“DecisionRef”) that may contain a pointer or reference to another decider's address.

According to certain embodiments, when processing decisions for non-Boolean propositions, the system may implement multiple decision pathways. In a first pathway, a decider may provide an annotation context containing specific values for required placeholder variables, which the system processes through variable replacement and unification operations to generate decision data. In a second pathway, the decider may alternatively provide a DecisionRef pointing to another decider's decision, effectively incorporating that decider's processed annotation context and resulting decision data.

According to at least one embodiment, the system may, in various embodiments, implement specialized authentication filter functionality for accessing referenced decision data. Such functionality may include, but is not limited to: the ability to traverse decision reference chains, access to the complete decision context of referenced decisions, and mechanisms to verify the validity of referenced decisions. Authentication filters may be configured to evaluate conditions such as reference chain length, temporal relationships between referencing decisions, or other constraints on reference patterns.

In some embodiments, the system may provide practical mechanisms for aggregating and analyzing chains of decision references. For example, in an oracle context, a primary oracle might submit a decision including comprehensive market data. While subsequent oracles could either validate this exact data through decision references or submit modifications through their own annotation contexts.

According to certain embodiments, the system may implement various algorithms for weighting and counting decisions that involve references. Such algorithms may include, but are not limited to: methods for calculating the total support for particular decision outcomes considering both direct and referenced decisions, mechanisms for determining the relative weight of referenced versus direct decisions, and approaches for resolving conflicts between competing reference chains. In some embodiments, the system may maintain reference graphs to enable analysis of decision patterns and influence networks.

Various embodiments may include mechanisms for managing the complexity of decision reference relationships. According to at least one embodiment, the system may implement one or more of: maximum reference chain length limits, temporal ordering requirements for references, cycle detection algorithms, and conflict resolution rules. In some embodiments, the system may also provide mechanisms for efficiently storing and retrieving reference chain data, potentially including optimization techniques such as caching frequently traversed reference paths or maintaining pre-computed aggregates of reference-based support levels.

### Detached Propositions

In various embodiments, a blockchain system may implement detached propositions as autonomous blockchain objects that exist independently within the global state without requiring attachment to any account, token, or other blockchain object. Such detached propositions may maintain independent state information including, but not limited to, decision records, reward pools, configuration parameters, and lifecycle status indicators within the blockchain's global state architecture.

According to certain embodiments, the system may implement detached propositions without associating ownership or control rights to any particular account after creation. While the originating account may be recorded for certain purposes, such recording does not confer special privileges unless explicitly granted through configuration parameters. Multiple entities may interact with a detached proposition through various mechanisms including, but not limited to, submitting decisions, contributing rewards, extending expiration periods where permitted, or triggering deletion where authorized, with all such interactions being governed by the proposition's configuration parameters rather than account ownership.

Some example implementations may support multiple independent instances of propositions containing identical content, statements, or parameters. Each such instance may be uniquely identified through various mechanisms including, but not limited to, transaction hashes, creation block numbers, or cryptographic combinations thereof. Each instance, regardless of content similarity to other propositions, may maintain entirely separate state information including, but not limited to, independent reward pools, decision sets, participant records, and lifecycle states.

Various embodiments may implement proposition configuration options through one or more bitmap fields or similar data structures within the proposition record. The configuration options may define operational parameters including, but not limited to, extensibility permissions, deletion authorizations, reward distribution rules, and lifecycle management policies. These configuration parameters may be immutably set upon proposition creation and may govern all subsequent proposition operations and state transitions.

In some embodiments, a proposition's configuration may include an extensibility parameter that, when enabled, permits any account to augment the proposition's reward pool through additional token contributions. According to at least one embodiment, the system may implement reward pool extension mechanisms that track contribution sources, maintain contribution histories, and manage refund distributions. Extended reward pools may modify proposition lifespans through various mechanisms including, but not limited to, expiration block adjustments, reward rate modifications, or participation incentive updates.

According to certain embodiments, proposition configurations may include deletion authorization parameters that, when enabled, permit the original sending account to trigger proposition deletion. Deletion mechanisms may incorporate various safeguards including, but not limited to, reward distribution completion requirements, participant notification systems, and state cleanup procedures. According to at least one embodiment, the system may implement different deletion pathways based on proposition states, reward distribution progress, and configuration parameters while ensuring consistent global state management.

In various embodiments, proposition configurations may interact with multiple system components including, but not limited to, reward distribution mechanisms, decision processing systems, expiration handlers, and state transition managers. Configuration parameters may influence component behaviors through various mechanisms including, but not limited to, permission gates, state transition rules, reward calculation modifiers, and lifecycle event triggers. According to at least one embodiment, the system may ensure configuration enforcement through multiple validation layers while maintaining proposition independence and system consistency.

### Detached Propositions Reward Pool Handling

In various embodiments, a blockchain system may implement detached propositions that can include one or more reward pools. Each reward pool may be configured to maintain a store of tokens designated for distribution to proposition participants. According to at least one embodiment, the system may enforce restrictions on the types of tokens that can be accepted into reward pools, including but not limited to limiting contributions to user-defined tokens while excluding system fuel tokens from being used as rewards.

According to certain embodiments, detached propositions may include one or more configuration parameters that control reward pool behavior. These parameters may include, but are not limited to, an extensibility flag that, when enabled, permits the reward pool to receive additional token contributions after initial creation. When configured as extensible, the reward pool may accept contributions from any account on the blockchain, regardless of whether that account was involved in the proposition's creation. According to at least one embodiment, the system may maintain detailed records for each contribution, including but not limited to contributor identifiers, contribution amounts, and timestamps, to enable accurate tracking and potential refund processing.

Various embodiments may implement reward distribution mechanisms that operate according to one or more configurable reward types. In one implementation, a reward type may specify distribution after each decision (“AfterEveryDecision”), wherein rewards are allocated immediately upon receipt of valid decisions. In another implementation, a reward type may specify distribution after a closing block (“AfterClosingBlock”), wherein rewards are held until the proposition reaches a designated closing state. The selection of reward type may influence various system behaviors including, but not limited to, the timing of distributions and the handling of remaining rewards.

In example implementations utilizing the AfterEveryDecision reward type, the system may implement refund mechanisms that operate when the proposition concludes with undistributed rewards. Such mechanisms may include, but are not limited to: calculating each contributor's proportional share of the remaining rewards based on their original contribution amounts; verifying the current reward pool balance; and executing refund distributions to the original contributors according to their calculated shares. According to at least one embodiment, the system may maintain contribution records throughout the proposition's lifecycle to ensure accurate refund calculations.

According to certain embodiments, implementations utilizing the AfterClosingBlock reward type may employ different refund behaviors depending on the proposition's state at closure. When valid decisions exist at the time of closure, the system may be configured to allocate the entire remaining reward pool to eligible deciders according to the proposition's distribution rules, without issuing refunds to original contributors. In the absence of valid decisions, the system may instead return the full reward amount to the proposition creator. According to at least one embodiment, the system may implement verification mechanisms to confirm the presence or absence of valid decisions before determining the appropriate refund behavior.

Various embodiments may include reward pool management mechanisms that operate during different proposition states including, but not limited to, active operation, expiration, early termination, or deletion. These mechanisms may ensure proper handling of rewards through atomic processing of distributions and refunds, validation of pool balances, and maintenance of accurate contribution records. According to at least one embodiment, the system may implement safeguards to prevent unauthorized access to reward pools and ensure that all distributions and refunds conform to the proposition's configured parameters.

### Attached Propositions

In some embodiments, the blockchain system may implement attached propositions that can be directly associated with one or more blockchain accounts. Such attached propositions may be linked to various types of accounts including, but not limited to, wallet accounts, token accounts, smart contract accounts, or combinations thereof. The attachment mechanism may create a direct relationship between the proposition and its associated account, where the proposition becomes an integral part of the account's state data.

According to certain embodiments, attached propositions may be owned and controlled by their associated accounts. This ownership structure may establish that the account to which a proposition is attached maintains complete control over the proposition's lifecycle. In some embodiments, this control mechanism ensures that only the account owner or entities authorized by the account owner may perform operations on the attached proposition.

Various embodiments may implement modification restrictions for attached propositions. These restrictions may specify that modifications to an attached proposition can only be performed by the account owner or entities properly authorized by the account owner. The modification capabilities may be further constrained by temporal and state-based conditions, including but not limited to, block heights, decision states, and expiration parameters.

In some embodiments, the system may enforce specific rules regarding which fields of an attached proposition can be modified and when such modifications are permitted. For example, the expiration block value may be modifiable only before the proposition's closing block is reached. According to at least one embodiment, the system may prevent modifications to other fields both before and after the decision block, ensuring the integrity of the proposition's core parameters once established.

According to certain embodiments, the modification rules may be enforced through validation mechanisms that verify the source of modification requests. These validation mechanisms may confirm that modification attempts originate from the owning account or its authorized representatives. According to at least one embodiment, the system may reject modification attempts that fail to meet these validation requirements or that attempt to modify restricted fields.

Various embodiments may implement state tracking mechanisms to monitor the lifecycle stages of attached propositions. These mechanisms may maintain information about key blocks including, but not limited to, the creation block, decision block, closing block, and expiration block. The state tracking may be used to enforce modification restrictions appropriate to each stage of the proposition's lifecycle.

In some embodiments, the system may include fallback mechanisms for handling invalid modification attempts. These mechanisms may generate appropriate error messages, maintain modification logs, or implement other responses to unauthorized or invalid modification attempts. The fallback mechanisms may provide feedback to help users understand why particular modification attempts were rejected.

### Blockchain Trading Systems

In various embodiments, systems and methods may be provided for implementing a blockchain-based trading system incorporating a permanent order book (POB) architecture that manages and processes trade orders through a combination of persistent and ephemeral order handling mechanisms. The system may maintain sale orders persistently within the POB while processing purchase orders ephemerally, implementing sophisticated slot management protocols, comprehensive validation frameworks, and settlement record functionality that enables complex trade matching and atomic execution. The system may incorporate multiple concurrent rate calculation mechanisms, fee management architectures, and automated token conversion capabilities, wherein such mechanisms may operate independently or in coordinated fashion to facilitate price discovery and efficient trade execution across various trading pairs and market conditions.

The described systems and methods may provide numerous advantages, including but not limited to: optimized system resource utilization through sophisticated slot management, enhanced market efficiency through atomic settlement execution, improved price discovery through multiple concurrent rate calculation mechanisms, and flexible fee handling capabilities that can accommodate various token types while maintaining system stability. The system may enable complex trading operations while implementing comprehensive security measures, validation protocols, and audit mechanisms that may work in concert to maintain system integrity and provide transparent, verifiable trading operations.

### The Order Book System

In accordance with various aspects of the present invention, a blockchain-based trading system may be configured to implement a permanent order book (POB) architecture that manages and processes trade orders through a novel combination of persistent and ephemeral order handling. The POB may be implemented within the global state of the blockchain system and may be configured to maintain sale orders in a manner that optimizes system resources while ensuring efficient trade execution.

In at least one embodiment, the system may employ a dual-nature order handling mechanism whereby sale orders are maintained persistently within the POB while purchase orders are processed ephemerally. Such sale orders may persist within the global state until the occurrence of one or more terminating events, such events potentially including, but not limited to: the successful matching of the sale order with one or more compatible purchase orders; the reaching of a predetermined expiration time associated with the sale order; or the receipt of a cancellation instruction from an authorized entity.

The system may incorporate, in various embodiments, a sophisticated slot management protocol that governs the allocation and maintenance of order slots within the POB. Each sale order maintained within the POB may be assigned one or more slots, with the precise number of slots potentially being determined through a dynamic calculation based on the order's specified time-to-live duration. This duration may be measured, in at least one embodiment, as the temporal interval between the initial acceptance of the sale order into the blockchain and its designated expiration time.

In one or more embodiments, the system may implement a global slot limitation mechanism that maintains system stability and prevents resource exhaustion. This mechanism may enforce a system-wide maximum number of available slots, potentially implemented as a configurable parameter that can be adjusted based on network conditions and requirements. The slot allocation process may be managed through sophisticated tracking mechanisms that monitor both the occupation and release of slots throughout the system's operation.

The system may incorporate, in various embodiments, multiple automated mechanisms for slot recovery and reallocation. Such mechanisms may operate based on various triggering events, potentially including, but not limited to: the automatic expiration of sale orders; the successful matching and execution of trades; the voluntary cancellation of orders by their originators; and the modification of order parameters that affect their temporal duration. These mechanisms may work in concert to ensure optimal utilization of system resources.

In at least one embodiment, the system may implement a dynamic pricing protocol for slot allocation that responds to market conditions and system utilization. This protocol may calculate slot allocation costs based on multiple variables, potentially including: the quantity of slots being requested; the current system-wide slot availability; the requested duration of slot occupation; and the prevailing demand for slot resources. Such pricing mechanisms may serve to optimize resource allocation and prevent system abuse.

The system may maintain, in various embodiments, one or more sophisticated indexing structures designed to facilitate efficient order management and matching. These structures may be organized according to multiple criteria, potentially including: price points, expiration timing, token type specifications, account associations, and other relevant parameters. Such indexing may enable rapid access and efficient matching operations while maintaining system scalability.

In accordance with certain embodiments, the system may implement comprehensive order modification capabilities that enable the adjustment of existing sale orders within specified parameters. Such modifications may encompass various aspects of the order, potentially including: price adjustments, quantity modifications, duration alterations, and parameter updates. These modification capabilities may be implemented with appropriate validation mechanisms to maintain system integrity.

The system may incorporate, in various embodiments, robust validation protocols that ensure the consistent operation of the POB. Such protocols may perform multiple verification operations, potentially including: confirmation of slot availability for new orders; validation of order parameters against trading rules and restrictions; verification of modification legitimacy; and maintenance of system-wide consistency constraints. These protocols may work in concert to maintain the integrity and reliability of the trading system.

In at least one embodiment, the system may implement sophisticated fee structures associated with slot utilization and order management. Such fee structures may incorporate various components, potentially including: initial slot allocation fees; ongoing maintenance fees; modification fees; and early termination fees. These fee structures may be designed to incentivize efficient resource utilization while maintaining system sustainability.

### Order Types and Matching

In accordance with various embodiments described herein, systems and methods are provided for implementing advanced trading order management within blockchain-based trading environments. The systems and methods may incorporate multiple distinct order classifications, sophisticated matching algorithms, and configurable order parameters that enable efficient and flexible trading operations.

According to one or more embodiments, the trading system may be configured to process at least two fundamental categories of trading orders: permanent orders and ephemeral orders. Each category may incorporate distinct characteristics relating to persistence, matching requirements, and price specifications. The system may be further configured to manage additional order categories and subcategories as may be required for particular implementations.

In certain embodiments, permanent orders may be configured to function as resting orders within the system, typically serving as sale offers within a persistent order book data structure. These permanent orders may be characterized by their enduring presence within the order book until matched, expired, or explicitly cancelled. Each permanent order may include, but is not limited to, parameters specifying a digital asset quantity, a limit price threshold, an expiration time, and various optional configuration elements.

According to various implementations, permanent orders may be structured exclusively as limit orders, requiring explicit specification of both quantity and price parameters. One or more validation components may be configured to verify the completeness and validity of these specifications before accepting a permanent order for inclusion in the order book. The validation process may incorporate multiple verification stages, including but not limited to, parameter validation, balance verification, and compliance checking.

In some embodiments, the system may maintain multiple independent order books organized by trading pair, with each order book implementing efficient data structures optimized for order insertion, matching, and retrieval operations. The order book structure may incorporate various indexing mechanisms to facilitate rapid price-level matching and order prioritization based on one or more criteria including price, time, and other configurable parameters.

According to certain embodiments, ephemeral orders may be implemented as transient trading instructions requiring immediate execution. These orders may typically function as purchase orders within the system and may support multiple execution models including market orders, limit orders, and other specialized order types. Unlike permanent orders, ephemeral orders may be processed without persistent storage in the order book.

In various implementations, ephemeral market orders may be configured to execute at prevailing market prices as determined by existing permanent orders, while ephemeral limit orders may specify maximum acceptable execution prices. The system may incorporate sophisticated matching engines capable of processing these different order types according to their specific requirements and constraints, while optimizing for various execution criteria such as price improvement and minimal market impact.

According to some embodiments, the matching engine may implement a multi-stage matching process for ephemeral orders. This process may include, but is not limited to: identifying candidate matches from the permanent order book, validating price conditions, verifying available quantities, and executing atomic swaps of digital assets. The matching algorithm may be configured to support partial fills, multiple counterparties, and various order execution strategies.

In certain implementations, the system may incorporate order validation components configured to perform comprehensive verification of both permanent and ephemeral orders. This validation may encompass multiple aspects including, but not limited to: digital signature verification, balance adequacy, price reasonability checks, compliance with trading restrictions, and conformance with any applicable regulatory requirements.

According to various embodiments, the system may implement sophisticated order lifecycle management capabilities for both order categories. For permanent orders, this may include status tracking, partial fill management, expiration handling, and automated order book cleanup operations. For ephemeral orders, this may include immediate matching attempts, timeout handling, and status notification mechanisms. The system may be further configured to maintain comprehensive audit trails of all order processing operations.

### Trade Settlement Process

Various embodiments described herein provide systems and methods for implementing settlement record functionality in blockchain-based trading systems. The settlement record functionality enables complex trade execution and documentation through computer-implemented processes that may be executed by one or more processors configured according to stored instructions. While specific embodiments are described, it should be understood that these represent non-limiting examples, and various modifications and alternatives are possible within the scope of the disclosed technology.

In one or more embodiments, the system maintains a permanent order book comprising standing trade orders. The system implements settlement records that serve as wrapper mechanisms for matching ephemeral orders with these permanent orders. An ephemeral order, in various implementations, comprises a trade order designated for immediate execution rather than placement in the permanent order book. The settlement record may reference specific permanent orders against which the ephemeral order is to be matched, enabling atomic execution of the trade. The settlement record structure provides flexibility in matching orders while maintaining transaction integrity.

Settlement records may, in various embodiments, implement sophisticated order aggregation functionality. When an ephemeral order's size exceeds the liquidity available in any single matching order, the settlement record can reference and combine multiple permanent orders to fulfil the trade requirement. The system may employ configurable algorithms to identify and aggregate compatible orders based on parameters including, but not limited to: price requirements, token types, order age, and participant preferences. This aggregation capability enables efficient execution of larger trades while maintaining price discovery mechanisms.

In certain implementations, settlement records capture and process price spreads between matched orders. When an ephemeral order's maximum acceptable price exceeds the asking price of a permanent order, the settlement records documents and manages this price differential. The system may implement configurable rules for allocating such price spreads, including but not limited to: distribution to settlement record creators, proportional division among trading parties, contribution to protocol fees, transfer to designated beneficiaries, or any combination thereof. These allocation rules may be modified through system governance mechanisms.

Various embodiments enable settlement records to process complex multi-token transfers and trades. A single settlement record may facilitate sophisticated exchange patterns including, but not limited to: direct token-pair trades, trades requiring intermediate token conversions, multi-party token exchanges, atomic swaps between multiple token types, and compound trades involving multiple token transfers. The settlement record maintains atomic execution guarantees across all component transfers, ensuring trading integrity.

The system may implement multiple mechanisms for settlement record generation. In various embodiments, settlement records may be generated through automated system processes, by authorized market participants, by designated market makers, or through hybrid approaches combining multiple generation methods. Each generation mechanism may implement distinct validation requirements, permissioning schemes, and execution rules while maintaining consistency with the system's overall settlement framework.

Settlement records may comprise extensible metadata structures describing trade execution details. This metadata may include, but is not limited to: cryptographically secure timestamps, unique transaction identifiers, hierarchical order references, price calculation methodologies, fee computation frameworks, participant identification schemes, and supplementary trade-relevant data fields. The system maintains these records in secure, auditable data structures that facilitate trade verification and analysis while preserving participant privacy where required.

In various implementations, settlement records employ multi-layer validation frameworks. These frameworks may govern aspects including, but not limited to: permissible token type combinations, order size boundaries, price tolerance bands, participant authorization levels, timing constraints, fee calculation methodologies, and cross-reference integrity requirements. The validation frameworks may evolve through system governance processes while maintaining backward compatibility with existing settlement records.

The system may provide configurable settlement record templates facilitating common trading patterns. These templates may support, but are not limited to: atomic token swaps, multi-party settlements, intermediated trades, complex settlement arrangements, and hybrid trading structures. Template frameworks may be extended through governance processes to support emerging trading requirements while preserving consistent settlement record architectures.

Settlement records may integrate with multiple components of the system's trading infrastructure. These components may include, but are not limited to: hierarchical order books, decentralized price oracles, token registry systems, participant directories, and governance mechanisms. This integration enables settlement records to access real-time market data, enforce evolving trading rules, and maintain system-wide consistency throughout the settlement lifecycle while adapting to changing market requirements.

The settlement record system may implement configurable fee structures for trade execution and settlement. These fee structures may account for factors including, but not limited to: trade complexity, token types involved, settlement urgency, market conditions, participant status, and system resource utilization. Fee calculations may be adjusted through governance mechanisms while maintaining predictable cost structures for market participants.

Various embodiments may provide mechanisms for settlement record monitoring and analysis. These mechanisms may enable capabilities including, but not limited to: real-time settlement tracking, historical analysis, pattern detection, anomaly identification, and performance optimization. The monitoring systems may integrate with external analysis tools while maintaining appropriate security and privacy controls.

### Trade Fee Management

In various embodiments, the system comprises a multi-layered fee management architecture that processes transaction fees through configurable pathways. The system may be configured to accept and process fee payments denominated in one or more token types, including but not limited to: native system tokens, user-defined tokens, staked tokens, and various combinations thereof. The fee management subsystem may dynamically perform token type conversions according to configurable rules, current market conditions, and system parameters.

In at least one embodiment, the system utilizes a native token type, which may be designated as “FUEL,” although other designations may be employed in various implementations. The FUEL token type may function as both a medium of exchange and a unit of account within the fee management subsystem. The system may be configured such that all fee payments, regardless of their original denomination, are ultimately converted to FUEL tokens before distribution to network participants. This conversion process may occur through one or more intermediary stages, depending on market conditions and system optimization parameters.

The system may incorporate an automated token conversion mechanism that interfaces with one or more order books maintained within the system. These order books may contain standing offers for token exchanges, including but not limited to: direct exchanges between user-defined tokens and FUEL tokens, cross-pair exchanges involving multiple token types, and various conditional exchange offers. The system may employ sophisticated routing algorithms to identify and execute the most advantageous exchange pathways, taking into account factors such as exchange rates, liquidity depths, and transaction urgency.

In at least one embodiment, the fee calculation subsystem determines total fee requirements based on a weighted combination of multiple factors, which may include but are not limited to: computational resource utilization metrics, current market exchange rates between token pairs, network congestion indicators, historical transaction patterns, and various system-wide parameters. The fee calculation mechanisms may incorporate adaptive algorithms designed to maintain equilibrium between network participant compensation and user transaction cost predictability.

When processing transactions involving fee payments in user-defined tokens, the system may employ a multi-step validation and execution process. This process may include: calculating the required FUEL token amount based on resource utilization projections, determining current market exchange rates through order book analysis, validating the availability of sufficient user-defined tokens in the sender's account, and reserving tokens for both the primary transaction and associated fee conversions. The system may implement various optimization strategies to minimize the total cost of these operations while maintaining system stability.

In various embodiments, the system incorporates a sophisticated fee refund mechanism capable of handling complex scenarios involving multiple token types. This mechanism may include functionality for determining optimal refund pathways, calculating refund amounts across different token types, and executing refund transactions in a manner that minimizes additional conversion costs. The system may maintain state information about original fee payments to inform refund processing decisions.

The system may include market stabilization mechanisms designed to minimize fee volatility despite underlying exchange rate fluctuations. These mechanisms may employ various techniques including, but not limited to: configurable rate-limiting parameters, time-weighted average price calculations, liquidity pool management, and dynamic fee adjustment algorithms. The system may continuously monitor market conditions and adjust these parameters according to predetermined optimization criteria.

In at least one embodiment, the system incorporates a comprehensive fee analytics subsystem that monitors and analyses various fee-related metrics. This subsystem may track and analyse patterns in fee payment methods, exchange rate movements, refund frequencies, resource utilization, and various other system parameters. The analytics subsystem may provide feedback to other system components, enabling automated optimization of fee-related parameters based on observed patterns and system performance metrics.

The system may include advanced liquidity management mechanisms designed to handle scenarios involving limited market liquidity for specific token pairs. These mechanisms may incorporate features such as: multi-hop exchange routing, emergency liquidity reserves, automated market making functions, and configurable fallback fee payment pathways. The system may dynamically adjust its routing strategies based on real-time liquidity conditions and system-wide optimization parameters.

### Market Rate Mechanism

Various embodiments of the present invention relate to systems and methods for determining, maintaining, and utilizing market rates within decentralized blockchain trading environments. The systems and methods described herein may be implemented using one or more processors executing computer-readable instructions stored in one or more memory devices, wherein the processors may be configured to perform various operations related to market rate determination and management.

According to certain embodiments, the system may implement a comprehensive market rate determination framework that maintains multiple concurrent rate calculation mechanisms. These mechanisms may operate independently or in coordinated fashion to provide market participants with multifaceted views of current trading conditions, thereby enabling sophisticated price discovery across various trading pairs and market conditions.

In one or more embodiments, the system may employ weighted average rate calculations derived from completed trading activities, wherein such calculations may incorporate various weighting methodologies. The weighting factors applied to these calculations may include, but are not limited to, transaction volume, temporal proximity, market depth, and other trading metrics that may be relevant to accurate price discovery. The system may maintain these weighted averages across multiple, configurable time horizons, ranging from instantaneous calculations to extended temporal periods, with the specific time horizons being determined by system parameters, market conditions, or participant requirements.

The system may, in various embodiments, maintain a permanent order book structure that serves as a comprehensive repository of active trading orders. This order book may be continuously monitored to extract and make available the most advantageous rates, including highest bid prices and lowest ask prices, for each trading pair. The extracted rates may be utilized by various system components to facilitate efficient trade execution and to provide market participants with accurate price signals. The permanent order book may be structured to maintain historical depth while simultaneously providing rapid access to current market conditions.

According to certain embodiments, the system may incorporate sophisticated pool rate calculations specific to individual trading pairs or groups of trading pairs. These pool rates may be derived from dedicated liquidity pools that implement automated market making functions through various mathematical formulas. The formulas may incorporate multiple factors including, but not limited to, pool depth measurements, historical trading activity patterns, current token balance ratios, and dynamic liquidity metrics. The pool rate calculations may be automatically adjusted based on changing market conditions or liquidity requirements.

In one or more embodiments, the system may implement comprehensive global price calculations spanning multiple blockchain blocks. These calculations may be designed to provide broader market perspectives by aggregating diverse trading activities across configurable block ranges. The global calculations may incorporate various types of trading activities including, but not limited to, direct token exchanges, automated pool swaps, cross-pair arbitrage activities, and other forms of token exchange mechanisms supported by the system. The block range for these calculations may be dynamically adjusted based on market conditions or system requirements.

The system may, in various embodiments, maintain separate and parallel rate calculations for different categories of trading activities. These parallel calculations may include, but are not limited to, rates derived from spot trading activity, rates specific to particular smart contract implementations, rates calculated for automated market making pools, and rates specific to particular token pairs or token categories. The system may be configured to maintain these calculations independently while providing mechanisms for their aggregation, comparison, and collective analysis when required for specific trading or analysis purposes.

According to certain embodiments, the system may implement dynamic weighting mechanisms that determine how different rate calculations are combined and utilized for various system functions. These weighting mechanisms may incorporate multiple factors including, but not limited to, historical reliability metrics, current market conditions, trading volumes, and various other parameters that may affect the accuracy or utility of different rate calculation methodologies. The weighting mechanisms may be automatically adjusted based on changing market conditions or system requirements.

In one or more embodiments, the system may incorporate sophisticated anomaly detection mechanisms designed to identify and manage irregular rate calculations that may result from unusual market conditions or potential market manipulation attempts. These mechanisms may include, but are not limited to, statistical analysis of rate variations, cross-methodology rate comparisons, volatility analysis, and temporary exclusion protocols for outlier values. The anomaly detection mechanisms may be configured to adapt to changing market conditions while maintaining system stability.

The system may, in various embodiments, maintain comprehensive historical records of rate calculations across different methodologies and time periods. These historical records may serve multiple purposes including, but not limited to, market analysis, compliance verification, system optimization, and parameter refinement. The system may implement configurable retention policies for historical data, balancing analytical requirements with resource utilization considerations. The historical data may be structured to facilitate efficient retrieval and analysis while maintaining data integrity and accessibility.

### Core Purpose and Structure of Settlements Record

In various embodiments of the present invention, systems and methods are provided for implementing settlement records within a distributed ledger environment, wherein such settlement records facilitate complex trade matching and settlement operations between multiple participating parties. The settlement records described herein may be implemented within any suitable distributed ledger or blockchain system that supports trading operations, and may be particularly advantageous in systems requiring atomic execution of multiple related trading activities.

A settlement record, in accordance with one or more embodiments, may comprise a specialized data structure configured to encapsulate and coordinate multiple constituent elements related to trading activities. The settlement record may be generated by various system participants, including but not limited to network nodes, miners, trading parties, automated trading systems, or designated market makers, and may be processed as an integral component of block validation operations within the distributed ledger system.

In some embodiments, the settlement record may be configured to include one or more constituent elements of varying types, wherein the constituent elements work in concert to execute complex trading operations. These constituent elements may include, but are not limited to: standalone signed transactions, unsigned arbitrageur purchases, references to a permanent order book, or any combinations thereof. The settlement record may be advantageously configured to accommodate any number of such constituent elements, and the specific combination and quantity of constituent elements may vary dynamically based on the particular trading scenario being facilitated.

According to certain embodiments, standalone signed transactions that may be included within a settlement record may comprise various types of trading activities, including but not limited to sale orders, purchase orders, token transfer orders, multi-token exchange orders, or other suitable transaction types. These standalone signed transactions may be cryptographically secured by their respective originating parties through digital signatures and may maintain their cryptographic integrity within the settlement record structure while participating in atomic operations.

In various embodiments, the settlement record may incorporate one or more unsigned arbitrageur purchases, which may represent specialized trading activities initiated by system participants seeking to capture price differentials across different trading pairs, venues, or token types. The unsigned nature of these purchases may advantageously allow for flexible settlement processing while maintaining system security through other validation mechanisms, including but not limited to atomic execution guarantees and settlement record integrity checks.

According to some embodiments, the settlement record may include one or more references to entries within a permanent order book maintained within the distributed ledger system. These references may identify specific orders within the permanent order book that are to be considered as part of the settlement operation, and may be implemented through various reference mechanisms including but not limited to direct order identifiers, cryptographic hash references, block height references, or other suitable reference mechanisms that maintain referential integrity within the system.

In certain embodiments, the settlement record structure may be implemented to maintain consistency with other system components while supporting atomic execution of its constituent elements. The structure may be advantageously designed to facilitate comprehensive validation operations, ensure proper ordering of execution steps, maintain system integrity throughout the settlement process, and guarantee atomicity of complex multi-step trading operations.

The settlement record structure, according to various embodiments, may be extensible to accommodate additional constituent element types that may be developed or required as the system evolves. This extensibility may be implemented through various mechanisms, including but not limited to extensible type fields, version indicators, feature flags, capability indicators, or other suitable extensibility mechanisms that allow for future enhancement while maintaining backward compatibility with existing system components.

### Settlement Mechanism

A blockchain system in accordance with one or more embodiments of the present invention may implement a settlement mechanism configured to facilitate complex trading operations between multiple parties. The system may maintain an arbitrage register data structure within the blockchain state, wherein said arbitrage register may be configured to track and maintain token balances throughout a settlement process independently from permanent account balances maintained elsewhere within the system.

In accordance with various embodiments, a settlement record processing module may execute an ordered sequence of trades, wherein said sequence may begin with an initial order selected according to one or more predetermined criteria. Such criteria may include, but are not limited to, price optimization parameters, temporal priority indicators, transaction urgency metrics, or other configurable parameters that may be implemented within the blockchain network protocol.

The system may perform, in accordance with one or more embodiments, a comprehensive verification procedure for each trade within the settlement sequence. Such verification may include analysing token balances within the arbitrage register, validating exchange rates against current market conditions, and ensuring maintenance of minimum balance requirements. In some embodiments, the verification procedure may incorporate additional validation steps based on customizable protocol parameters.

Various embodiments may implement multiple distinct settlement methodologies, including but not limited to deterministic approaches and miner-controlled approaches. The deterministic methodology may follow immutable, predefined rules for trade matching and execution, while the miner-controlled methodology may permit dynamic optimization of trade execution based on configurable parameters that may be adjusted according to network conditions and trading requirements.

The arbitrage register, in accordance with certain embodiments, may maintain discrete balance tracking for multiple token types, wherein said register may be configured to accommodate both positive and negative balance states during settlement processing. Temporary negative balances may be permitted within defined parameters, provided that all balances resolve to non-negative values upon completion of the settlement sequence. The system may implement sophisticated balance reconciliation procedures to ensure proper resolution of all transactions.

In some embodiments, one or more validation modules may be implemented within the settlement mechanism to ensure transaction integrity throughout the settlement process. Such validation modules may execute various verification procedures, including but not limited to cryptographic signature validation, token ownership verification, and protocol compliance confirmation. Additional validation requirements may be implemented based on specific network security requirements.

The system may implement, in accordance with various embodiments, a sophisticated settlement queue management system configured to optimize the processing of multiple concurrent settlement records. Said queue management system may incorporate various optimization algorithms designed to maximize parameters such as gas efficiency, price improvement, and network throughput, while minimizing network congestion and transaction latency.

Various embodiments may include functionality for processing partial settlements, wherein the system may execute fractional portions of trades based on available balances, market conditions, or other constraining factors. The system may implement multiple strategies for managing such partial settlements, including but not limited to the generation of replacement orders, the implementation of refund mechanisms, or the creation of residual order records. Such strategies may be configurable based on network requirements and trading protocols.

In accordance with certain embodiments, the settlement mechanism may incorporate real-time monitoring and adjustment capabilities, enabling dynamic optimization of settlement processes based on current network conditions, market states, and trading parameters. Such monitoring may facilitate immediate response to changing conditions while maintaining system integrity and transaction security throughout the settlement process.

### Implementation Requirements

Various embodiments of the invention may provide systems and methods for implementing blockchain-based settlement records that facilitate the matching and execution of digital asset trading operations. Such settlement records may be configured to coordinate multiple trading activities while maintaining system integrity through various implementation requirements and validation mechanisms.

According to certain embodiments, the system may enforce execution state validation for all transactions referenced within a settlement record. This validation process may include, but is not limited to, verification that each referenced transaction has not been previously executed within the blockchain system. The system may maintain one or more transaction state databases that track execution status, wherein such databases may be consulted during the validation process to prevent duplicate execution of transactions.

Some embodiments may implement price protection mechanisms within the settlement system to ensure market integrity and fair trading conditions. Such mechanisms may enforce that any exchange rate provided through a settlement record meets or exceeds the most favorable price available among existing sales orders within the system's order book. The price protection mechanism may continuously monitor and compare rates to prevent settlement at unfavorable prices, thereby protecting market participants from potential price manipulation or disadvantageous execution conditions.

According to various implementations, the settlement system may incorporate enhanced price requirements for market orders processed through settlement records. Such requirements may mandate that market orders matched via the settlement mechanism receive execution prices more favorable than those contemporaneously available on the permanent order book. This price improvement requirement may be implemented through comparison algorithms that evaluate multiple price points before allowing settlement execution.

Certain embodiments may employ multi-faceted validation procedures that examine various aspects of proposed settlement records. These procedures may include, but are not limited to, verification of transaction validity, confirmation of price calculations, evaluation of trading parameters, and assessment of market conditions. The validation process may be executed prior to settlement finalization and may be configured to require successful completion of all validation steps before proceeding with constituent transaction processing.

In some implementations, the system may maintain one or more price monitoring mechanisms that track and record available prices, executed transactions, and market conditions. Such mechanisms may utilize distributed ledger technology to maintain an immutable record of pricing data, which may be used to validate compliance with established price requirements. The price monitoring system may be configured to update in real-time as new transactions are processed and market conditions evolve.

Various embodiments may incorporate configurable pricing parameters that define acceptable thresholds for price variation and execution conditions. Such parameters may be dynamically adjusted based on market conditions, trading volumes, volatility levels, or other relevant factors. The system may implement automatic parameter adjustment mechanisms that respond to changing market conditions while maintaining overall system stability.

According to certain implementations, the settlement system may include exception handling mechanisms for cases where price requirements cannot be satisfied. Such mechanisms may implement various responses including, but not limited to, transaction rejection with appropriate notification, automatic price adjustment within predefined boundaries, or routing to alternative settlement pathways. The exception handling system may be configured to maintain market integrity while minimizing disruption to ongoing trading activities.

Some embodiments may maintain comprehensive audit trails of all settlement activities, including price validations, execution decisions, and settlement outcomes. These audit trails may be implemented using cryptographic techniques to ensure data integrity and may include detailed information about price comparisons, validation results, and settlement execution. The audit system may be configured to support various functions including system monitoring, compliance verification, and dispute resolution processes.

### Validation Process

Embodiments of the present invention may provide systems and methods for implementing comprehensive validation processes for settlement records within a blockchain-based trading and settlement environment. The validation processes described herein may comprise multiple verification steps and conditions that should be satisfied before a settlement record can be considered valid and suitable for inclusion in a block of the blockchain.

According to various embodiments, the system may execute signature verification procedures on settlement records and their constituent elements. These procedures may include cryptographic validation of one or more digital signatures associated with constituent transactions contained within or referenced by the settlement record. The system may verify that each constituent transaction's signature corresponds to its purported source account and maintains cryptographic validity according to the system's established signature verification protocols. In some embodiments, the system may implement additional signature verification steps for settlement records that reference transactions from external sources.

Embodiments of the present invention may implement comprehensive token balance verification procedures throughout the settlement process. The system may maintain one or more arbitrage registers or similar data structures configured to track token balances as settlement proceeds. These tracking mechanisms can ensure that sufficient token balances exist in source accounts before allowing transfers or trades to proceed, while monitoring token movements between accounts to prevent negative balances. The system may implement various balance verification algorithms that can be customized based on token type, transaction type, and other relevant parameters.

In various embodiments, the system may provide specialized handling mechanisms for partial matches of constituent records within settlement records. When the system identifies a partial match of a constituent record, it may implement one of several possible procedures based on configuration parameters and record characteristics. According to one procedure, the system may automatically generate a replacement order representing the unmatched portion while maintaining relevant characteristics of the original order. According to another procedure, the system may initiate a refund process to return unmatched tokens to their source account. The selection between these procedures may be determined by various factors including, but not limited to, order type, token type, account parameters, and system configuration settings.

According to certain embodiments, the validation process may implement distinct validation rules for different categories of constituent records. The system may apply specialized validation logic to market orders to ensure they receive pricing at least as favorable as the best available price on the permanent order book. Similarly, limit orders may be subject to validation against their specified price constraints and other relevant parameters. The validation framework may be extensible to accommodate additional order types while maintaining appropriate rule enforcement mechanisms for each type.

Embodiments of the present invention may incorporate temporal validation mechanisms to ensure proper sequencing of settlement record processing. These mechanisms may verify that referenced transactions have not been previously executed and that temporal dependencies between constituent records are appropriately observed. The system may implement various algorithms for detecting and preventing duplicate settlements while ensuring correct ordering of interdependent transactions according to system requirements and configurations.

The system may implement multi-phase validation procedures for partial matches, wherein each phase may be individually configured according to system requirements and constraints. These procedures may include, but are not limited to: evaluating partial match permissibility based on record type and parameters; calculating matchable portions of constituent records; validating maintenance of price advantages specified in original orders; and implementing appropriate handling mechanisms for unmatched portions through replacement orders or refund processes.

Various embodiments may incorporate validation mechanisms against system-wide constraints and limitations. These mechanisms may verify compliance with block gas limits, constituent record quantity restrictions, and settlement record structural requirements. Such validation procedures may be implemented to ensure settlement records do not adversely impact system performance or stability while maintaining efficient processing capabilities.

According to certain embodiments, the validation process may be implemented through modular validation components that can be updated or modified as system requirements evolve. These components may be configured to execute validation checks in parallel where possible while maintaining appropriate sequencing where dependencies exist. The modular architecture may facilitate future expansion and modification of validation rules and procedures while maintaining system stability and performance.

Embodiments of the present invention may maintain detailed validation records including specific failure reasons and validation paths. These records may be utilized for system monitoring, optimization, and debugging purposes while providing transparency into the validation process for system participants and operators. The system may implement various mechanisms for storing, accessing, and analyzing these validation records according to system requirements and configurations.

### Fee Handling

A settlement record system may implement a comprehensive fee management architecture that processes and allocates transaction fees through distinct pathways, enabling efficient compensation for both settlement processing and arbitrage activities. This fee management architecture may be integrated with various components of the blockchain system to ensure proper incentivization of network participants while maintaining system stability and security.

When processing constituent transactions contained within a settlement record, the system may automatically redirect transaction fees to designated arbitrageur accounts, departing from standard fee distribution mechanisms. The arbitrageur account association may be established through cryptographic signatures, verifiable account identifiers, or other secure identification mechanisms integrated within the settlement record structure. This redirection of constituent fees can serve to incentivize arbitrage activities that enhance market efficiency and liquidity.

Independent of constituent transaction fees, the settlement record itself may incorporate a discrete processing fee structured to compensate for the computational complexity of settlement execution. This settlement-level fee structure may dynamically adapt to various operational parameters, including but not limited to: computational resource utilization, settlement complexity metrics, constituent transaction volume, token type diversity, and network state variables. The system may employ sophisticated algorithms to calculate appropriate compensation levels that reflect the true computational cost of settlement processing.

The settlement-level fee allocation mechanism may implement atomic distribution protocols that ensure proper compensation of mining nodes responsible for settlement validation and execution. This allocation system operates independently from constituent fee processing, creating a stratified incentive framework that properly compensates both mining operations and arbitrage activities. The allocation protocols may incorporate various security measures to prevent fee manipulation or unauthorized redistribution.

The system may implement adaptive fee calculation mechanisms that respond to network conditions and settlement requirements in real-time. These mechanisms may incorporate multiple calculation methodologies, including but not limited to: dynamic resource-based pricing, fixed-schedule fee tables, hybrid pricing models, and market-driven fee adjustment protocols. Such flexibility enables the system to maintain optimal fee levels that appropriately reflect settlement processing costs while ensuring network stability.

To address settlement execution variations, the fee management architecture may implement sophisticated fee adjustment protocols. These protocols can handle various settlement scenarios, including partial execution, settlement reversal, and execution failure. The adjustment mechanisms may incorporate features such as proportional fee returns, conditional fee redistribution, and automated recalculation based on actual settlement outcomes. These features ensure fair compensation while maintaining system integrity under various operational conditions.

The system may incorporate advanced optimization algorithms that automatically calibrate fee distributions based on multiple network parameters. These optimization mechanisms may analyze factors such as network congestion, settlement complexity metrics, historical execution data, and current market conditions to determine optimal fee levels and distribution patterns. The optimization protocols may implement various adjustment methodologies to maintain efficient network operation while ensuring fair compensation for participants.

To ensure accurate fee processing, the system may maintain segregated accounting mechanisms for settlement-level and constituent transaction fees. These accounting systems may implement robust tracking protocols, atomic execution mechanisms, and comprehensive audit trails. The segregated accounting structure enables precise fee attribution while maintaining system transparency and facilitating efficient fee distribution operations.

The fee management architecture may incorporate multiple security layers to ensure the integrity of fee-related operations. These security measures may include cryptographic verification protocols, atomic execution guarantees, and comprehensive validation mechanisms. The security framework may be designed to prevent unauthorized fee manipulation while ensuring proper fee distribution under various settlement scenarios. Additionally, the system may implement various monitoring mechanisms to detect and prevent potential fee-related attacks or system abuse.

Specific Provisions for Handling: Partial Matches and Leftover Orders, Market Orders Versus Limit Orders, Token Price Spreads and Arbitrage Opportunities, Integration with the Permanent Order Book, Transaction Validation and Replay Protection

In various embodiments, a distributed ledger system implementing settlement functionality may include specialized mechanisms for processing and reconciling partially matched trading orders. When processing settlement records containing constituent orders that cannot be completely matched, the system may be configured to automatically generate and publish replacement orders representing the unmatched portions. Such replacement orders can preserve essential characteristics of their originating orders, including but not limited to price constraints, execution parameters, and temporal limitations, while appropriately adjusting quantities to reflect the partially executed amounts. The system may implement configurable rules governing how such replacement orders are prioritized and sequenced within the order book.

The settlement system may employ differentiated processing methodologies for market orders and limit orders within settlement records. In particular embodiments, market orders submitted through settlement records may be matched against the permanent order book only when the available execution price represents an improvement over the best currently available market price. The system may implement sophisticated matching algorithms ensuring that limit orders are executed strictly in accordance with their specified price constraints, with any price improvements potentially distributed among participating parties according to predetermined allocation rules that may be configured through governance mechanisms.

The settlement system may incorporate specialized components configured to identify, analyze, and facilitate the capture of arbitrage opportunities arising from price differentials across various trading pairs. In certain embodiments, these components may employ graph-theoretic algorithms to automatically detect profitable trading paths by analyzing price relationships between multiple token pairs. Settlement records may be structured to incorporate sequences of constituent trades that, when executed atomically, capture these price differentials while implementing appropriate risk controls and ensuring market integrity through fair price discovery mechanisms.

Various embodiments may maintain sophisticated integration between settlement operations and a permanent order book system, which may serve as an authoritative source of liquidity and price discovery. The permanent order book may be continuously queried during settlement processing to establish reference prices, validate market orders, and identify matching opportunities. The system may implement atomic update mechanisms that maintain strict consistency between settlement operations and the order book state, preventing race conditions and ensuring deterministic execution across distributed nodes.

Settlement records may incorporate multi-layered transaction validation and replay protection mechanisms. These mechanisms may include, but are not limited to, cryptographic nonce tracking for constituent transactions, configurable validation windows based on block timestamps or sequence numbers, and cryptographic linking of related trades through hierarchical hash structures. The system may implement comprehensive validation procedures encompassing signature verification, balance adequacy confirmation, and order book state validation, which may be performed both at the individual transaction level and at the aggregate settlement record level.

The settlement system may implement sophisticated priority and sequencing mechanisms for managing multiple concurrent settlement records. In various embodiments, these mechanisms may enable parallel processing of settlement records while maintaining strict transaction atomicity and preventing interference between independent settlement operations. The system may employ advanced queuing and scheduling algorithms that optimize settlement record execution while implementing fairness constraints and preventing various forms of front-running or transaction reordering attacks.

Certain embodiments may expose configurable system parameters governing various operational aspects of the settlement system. Such parameters may include, but are not limited to, maximum settlement record size, timeout intervals, validation thresholds, fee computation formulae, and incentive structures. These parameters may be adjustable through distributed governance mechanisms, enabling the system to adapt to evolving market conditions and requirements while maintaining operational stability and security guarantees.

The settlement system may implement comprehensive failure handling and recovery mechanisms. In various embodiments, these mechanisms may enable controlled rollback of partially executed settlements when complete settlement cannot be achieved, potentially implementing compensating transactions or state reversions through atomic commitment protocols. The system may provide configurable recovery procedures to handle edge cases and ensure continued operation under adverse conditions, while maintaining consistency guarantees and transaction finality requirements.

One or more embodiments may implement specialized data structures for tracking and managing the state of in-progress settlements. These data structures may maintain detailed execution histories, intermediate state transitions, and rollback markers enabling the system to recover from various failure scenarios while preserving transaction atomicity and consistency. The system may employ sophisticated caching and state management mechanisms to optimize performance while ensuring correctness under concurrent execution.

### Integration Points

In various embodiments, a settlement record system can be implemented within a blockchain-based trading environment to facilitate interaction between multiple system components. The settlement record system may comprise one or more communication interfaces configured to enable bilateral data exchange with other system components including, but not limited to, a permanent order book subsystem, individual trading account management modules, authentication protocols, and authorization frameworks.

The settlement record system may establish and maintain continuous communication channels with a permanent order book component through one or more dedicated interfaces. These communication channels can enable real-time data exchange operations including, but not limited to, order status queries, price condition validation requests, trade matching verifications, and order state updates. The permanent order book component may expose application programming interfaces through which the settlement record system can access current market conditions, enabling dynamic evaluation of trade matching opportunities and execution parameters.

The system may implement atomic transaction processing capabilities, wherein multiple distinct trading operations can be combined into unified, indivisible transaction units. Such atomic transaction units may encompass various combinations of operations including, but not limited to, multiple trade orders, settlement records, balance transfers, and associated validation steps. In some embodiments, these atomic transaction units can be configured with rollback capabilities, ensuring that all constituent operations either execute successfully or trigger a complete transaction reversal.

In certain embodiments, the settlement record system can integrate with a hierarchical authentication framework implementing multiple authentication filters. These authentication filters may be invoked at configurable checkpoints throughout the settlement lifecycle, including but not limited to: initial order submission, trade matching evaluation, settlement record creation, and final execution. The authentication framework can be configured to verify multiple transaction attributes including, but not limited to, cryptographic signatures, account permissions, token transfer authorities, and trading privileges.

The system may maintain detailed state information for trading accounts involved in settlement operations. This state information can comprise various data elements including, but not limited to, current token balances, outstanding orders, permission sets, trading histories, and account flags. In some embodiments, the system implements atomic state updates ensuring that all account state changes within a settlement operation are processed as a single, consistent unit.

One or more authorization subsystems may be implemented within the settlement record system, coordinating with blockchain-wide authorization protocols through standardized interfaces. These authorization subsystems can perform various verification operations including, but not limited to, token ownership validation, trading permission verification, account authorization checks, and transaction limit enforcement. The authorization process may implement multiple validation stages with configurable checkpoint locations throughout the settlement execution flow.

The settlement record system may implement a priority-based queueing mechanism for managing concurrent settlement record processing. This queueing mechanism can coordinate with multiple system components through dedicated synchronization interfaces, ensuring proper sequencing of settlement operations while maintaining consistency with the permanent order book and other system states. The queueing system may implement various ordering strategies including, but not limited to, price-time priority, size priority, or custom prioritization rules.

In some embodiments, the system may expose external integration interfaces enabling secure communication with other blockchain networks, trading platforms, or financial systems. These integration interfaces can implement various security protocols including, but not limited to, encryption, authentication, rate limiting, and access control. The interfaces may support multiple data exchange formats and communication protocols while maintaining system security boundaries.

The settlement record system may maintain comprehensive audit records documenting component interactions. These audit records can capture various types of interaction data including, but not limited to, permanent order book communications, authentication results, authorization decisions, account state modifications, and settlement execution steps. In some embodiments, the audit records may be cryptographically secured and stored within the blockchain's immutable ledger structure, enabling verification and reconstruction of settlement operations.

### Other Blockchain System Improvements

Various embodiments of the present invention generally relate to the field of blockchain technology, also known as a distributed electronic ledger for storing data that multiple parties may access, modify, update, maintain, and verify. More specifically, an embodiment pertains to blockchains that support custom tokens, cryptographic features such as key rotation, multi-signature arrangements, and post-quantum signatures. Additionally, the system pertains to atomic record chains and, through multiple types of records, natively supports advanced features, including trade, proposition determination, and more.

### Account Activation

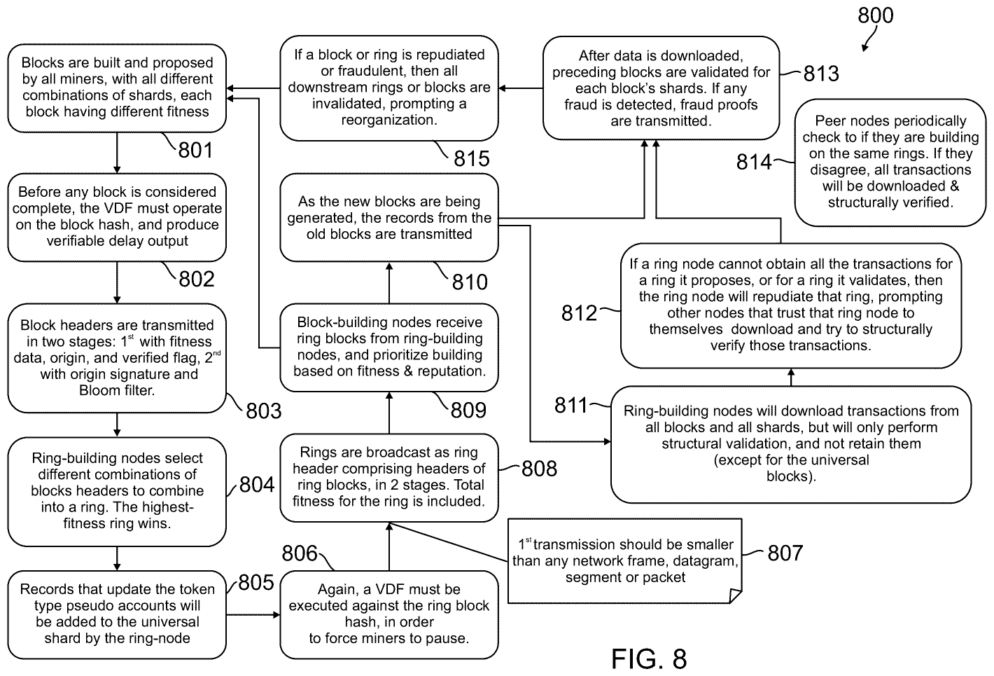

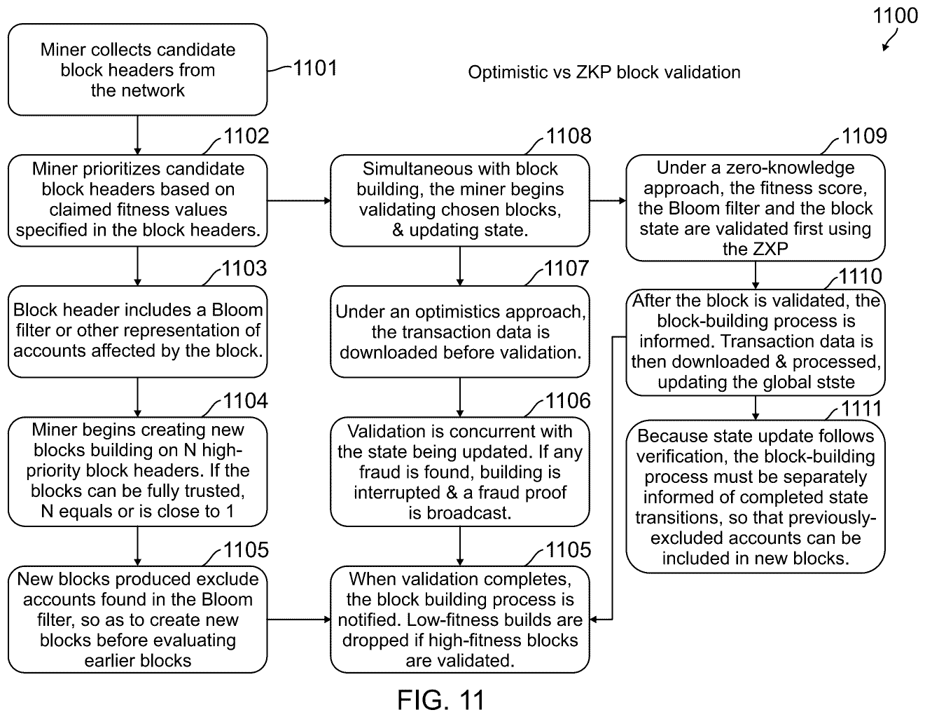

Referring to FIGS. 1-19B, in at least one embodiment, the present embodiment provides a computing system and method for implementing a distributed electronic ledger or blockchain 2000 that introduces the concepts of accounts (e.g. 1045, 1050, 92A), devices (e.g. 50, 60, 1303, 1804, 201), and authentication filters (e.g. 1314, 1314). Each account may be represented by a byte array of length 20. Each account may also contain a number of devices, and each device includes a configuration that, among other things, contains a signing public key.

In at least one embodiment, the embodiment claims a new account. The first 20 bytes of the key's hash may match the corresponding account address. This means that the first device added to an account may not be chosen arbitrarily. Users may create an account by generating a key pair using an algorithm of their choice, and then use it to sign a device configuration record that claims the account associated with the public key. This process guarantees that accounts may not be cherry-picked.

In at least one embodiment, the account configuration may be implemented through the statistics collection switch. The statistics collection switch may be implemented in hardware/software/firmware, e.g. 50, 60, 70, 92A, 92B, 1313, 1314. The statistics collection switch may enable the collection of statistics for accounts and devices in a customizable and efficient manner. Through a blockchain interface, users may define the token type and statistic type collected for each statistic collection, and wildcards may be used to match all tokens or specific types of tokens. The interface may be configured to allow restricting statistics to specific transaction types and using authentication filters to impose velocity limits on accounts and devices. The implementation of this feature takes into account the additional storage and computational burden and adjusts the fee calculation accordingly.

In one embodiment, the statistics collection switch” may be specifically configured to actively gather data about blockchain accounts and transactions flowing through it, essentially acting as a central point for collecting account and transaction information on packets, flows, and other account and network metrics, which can then be analysed to monitor transaction activity and performance, identify potential issues, and gain insights into account usage patterns.

### Validation

In at least one embodiment, as part of the validation process, the blockchain may be configured to enable tracking of the origin of different transactions may be performed, if the transactions originate from the network as a whole. The origin of a transaction is described as the peer node that each transaction in the pool originates from. As network-originating transactions are validated, the blockchain may be configured to quantify statically invalid transactions, with a rolling tally being kept for each peer. The blockchain may be configured to cause any peer that produces too many invalid transactions (or too high a proportion of invalid transactions) to be rate-limited or disconnected, according to the configuration.

In an embodiment, the blockchain or a node thereof may be configured to implement a ‘Disable Default Verification’ field, which may disable the default verification behavior for cryptographic key verification. The flag is also used to turn off the primary signature's key validation against the data, a process that is performed by default, and instead, only perform key verification in the authentication filter. In this context, key verification refers to the comparison of the valid signature against the data and the associated devices with the sender's account. The blockchain or a node thereof may be configured to perform structural validation to confirm that the signature matches the keys and the message, without comparing it to the global state.

At least one embodiment implements Atomic Record which is a collection of records. The individual records in a record chain are called constituent records. These records are verified and validated together. This may allow some unique use cases in which structure is maintained by creating a chain in a manner very similar to blockchain.

In at least one embodiment of the cancellation record, the blockchain network can be configured to verify the authenticity of the record and whether it meets the necessary conditions for cancellation. The validation process typically involves confirming the authority or permissions of the entity submitting the cancellation and verifying the integrity of the cancellation record itself. Once the cancellation record is successfully validated and accepted by the blockchain network, the effects of the original transaction can be automatically reversed. This may involve updating account balances, reverting changes to data or smart contracts, or restoring the blockchain state to its previous configuration. The cancellation record can play a crucial role in maintaining the integrity and reliability of our blockchain system by providing a mechanism to rectify errors, address fraudulent activities, or mitigate undesired consequences of previous transactions or actions.

In an embodiment, the system may define validation as per the protocol rules. All the records may be validated by changing the state at the end of the record and passing it to the next record. In case of encountering a smart contract record, it may be assumed to be run successfully without running it and validate the further records, because if it were to fail, further records won't be processed anyway so there is no problem with state. In other settings, All the records are validated by changing the state at the end of the record and passing appropriate state to the next record. If a smart contract record is encountered, state modification stops and only nonces and signatures are checked further. The reasoning is that if a smart record were a failure, unlike all or nothing it takes a different path and ends in a different state if following records were executed. So, in case of a nested ARC the process follows an appropriate path. This is only the protocol rules which defines when ARC is valid and may be included. A pool validation might be more stricter/looser and different than this and also vary from block-building node to block-building node.

In an embodiment, state based validation in ARC may be performed. All the records may be validated by changing the state at the end of the record and passing it to the next record. In case of encountering a smart contract record, it may assume to be run successfully without running it and validate the further records, because if it were to fail, further records won't be processed anyway so there is no problem with state. If the execution of smart contract may make any modifications such that any following record which is invalid may become valid, it may not be detected and arc may be rejected as invalid. In order to support those use cases we have to stop validating further records on encountering any smart contract records and only validate nonces and signatures further. All the records are validated by changing the state at the end of the record and passing appropriate state to the next record. If a smart contract record is encountered, state modification stops and only nonces and signatures are checked further. The reasoning is that if a smart record were a failure, unlike all or nothing it takes a different path and ends in a different state if following records were executed. So, in case of a nested ARC this may follow an appropriate path. The above state based validation may be able to trigger retry functionality if any of the records trigger the retry functionality during validation. A certain pool implementation may also allow smart contracts to execute up to a certain limit (configurable in certain embodiments by block-building node based on a configured risk appetite) for validating when auth subroutines or small contracts are involved. User may in the computer systems go to the completely opposite end, to do validation on gas sufficiency, nonce and signature on the records which are both standalone and ARC.

In some embodiments, auth subroutines may not be evaluated at the permanent validation level, due to the potential expense incurred through their execution. Auth subroutines may be completely paid for by the transaction's gas purchase, and therefore may be evaluated at execution time only. Any auth subroutine failure may result in the transaction being added to the blockchain in a failed state. Any execution-time failure that is not deemed invalid at the structural, permanent or conditional validation stages may result in the transaction being added to the blockchain in a failed state. The most important example of this is that any atomic transaction that succeeds in passing the initial validation may be added to the blockchain, even if some portion of the atomic transaction fails validation at execution time, or the whole atomic transaction fails. Some portion of the “conditional validation” failures are added to the blockchain in a failure state, rather than simply being discarded. The determinations of the question are an assessment of the computational overhead of the conditional validation step.

In an embodiment, the transactions added to the blockchain in the “failed” state may effectively be deemed “passing” conditional validation after the last retry failure, and may proceed to inclusion in block building. In block building, the conditional validation failure may prevent the global state being changed, except for the gas consumption. The transactions that may not be added to the blockchain in the “failed” state may be discarded after the last retry failure. Because correctly identifying the discrepancy may track the state change between the fee consumption and the purchase execution, it is not possible to do at the permanent validation stage. Any validation that may prevent a transaction from being added to the blockchain effectively causes the protocol to consider any block that contains the invalid transaction to itself be invalid and outside the scope of the protocol.

In an embodiment, the system implements a variety of configurations pertaining to some of the low-level functionality of transaction validation, transaction ordering, and token economics. These configurations may be interrelated. Records may effectively be nonceless; replay prevention is done through the use of account Bloom filters, which are cycled every N number of blocks, where N is the maximum time that records may remain valid without expiring (N determines the maximum expiration block number; N may be as long as a week or a month or longer). Some configuration-oriented record types require that an ordering be enforced; for these records, a transaction index that permits skipping may be included, so that the relative ordering may be determined when a new record is introduced. A re-configuration that is sent with a lower index than the current configuration may be treated as permanently invalid. However, this is fully under the control of the client; the index is only used for conflict resolution (not for any other reason), and any index may be specified. Records sent from P2SH accounts and some smart contracts (which may be marked upon creation as managing their own replay protection internally) do not have a maximum time to live and may be created with an extremely high expiration block; they may be exempt from the Bloom-filter-based replay prevention.

### Auth Filter

In at least one embodiment, an authentication filter, referred to as an account authentication filter, is implemented. All records may be signed by a given account and are inspected by the authentication filter of that account. The authentication filters may then accept or reject any given record. This process may be used to modify account and device configurations by utilizing specific records for that purpose.

In at least one embodiment, techniques and systems are provided that facilitate the Account Auth Filter, which may be invoked when a record originating from a given account is being processed. The auth filter has knowledge of every aspect of the record being processed and the details of the account in question. As a result, a wide range of customization options for permissioning are easily achievable by the user. The Account Auth Config is an arbitrary key-value map, which may be configured by sending appropriate records. The key-value map is available inside the account auth filter during execution and allows users to set custom configurations for each account. The key is of string type and supports a variety of values.

In at least one embodiment, signatures are represented by a Signature Pack object that contains three pieces of information: Signature Type, Signature, and Signing Public Key. The cryptographic signature may not contain any information about the signing public key, but this broader interpretation of the signature provides the necessary information to verify its validity.

In at least one embodiment, multi-sig arrays consist of signatures originating from different devices associated with the original account. Primary signatures rely on the sender account field of the transaction/CRC and may not contain information about the signing account. The auth filter context contains the entire transaction structure, which may include the necessary signature information as well as the sender account's state entry, which includes device configurations and other relevant information. In some cases, the auth filter may inspect arrays of signatures to identify accounts contributing to the signatures; however, the lack of loops may be limiting in some situations. The link between the sender account and device public keys is arbitrarily maintained in a map within the sender account's state entry. In some cases, the ECDSA signature may be used to derive the signing public key, effectively making the signature itself contain the signing public key.

### Key Rotation

In at least one embodiment, a Key Rotation procedure is presented. Each record may contain a new public key that replaces the current public key of the device signing that record. This procedure ensures that off-chain counterparties are aware of the validity of private keys and may take appropriate actions before the off-chain ARCs they hold are invalidated. As First step, Initial configuration for expiration duration is set to D blocks within the original device create message. The expiration duration configuration of the device is stored with the device config and is copied to each key's own config as it is created. The key data preserves the copy even after the main device config is modified; the key config is what is used when a key's final expiration is calculated. In the Second step, Configuration for expiration duration is modified from D blocks to d blocks. The configuration record is further added at block B. In the third step, any keys that were generated (added keys/new keys) before block B may have expiration timeout of D blocks and any keys that were generated (added keys or new keys) after may have expiration timeout of d blocks. In fourth step, first key replacement at block R1 may remain valid for certain records until E1. The new key may have the expiration timeout configuration set to d blocks, so the countdown may start only when that specific key is replaced. In the fifth step, a new key is replaced at R2, which is valid until block E2—so R3 it may be valid till E3.

In at least one embodiment implementation Off-chain Counterparties may confirm the private key is active and detect when the key is replaced. If a key is currently active, the counterparty may consider the worst case for expiration to be current block+1+d, which may be the case if the key were replaced in the next block. A user shall typically accept an off-chain record if their counter-party's device's expiration duration is configured on-chain to be longer than a sufficiently large number (say, 100 blocks), and if the key being used for the off-chain signature is currently active on-chain. At the moment when the key rotation occurs, the counterparty may either request the record be re-signed with the new key or may have to unilaterally add the record to an atomic transaction and add it to the blockchain.

In at least one embodiment the key rotation procedure ensures the availability of old keys for off-chain transactions. By following the procedure, off-chain counterparties may avoid being surprised. One of the key advantages of post-quantum cryptography algorithms is the ability to provide security even against attacks from quantum computers. The algorithms are designed to be resistant to attacks based on the mathematical problems that quantum computers are good at solving. The importance of using post-quantum cryptography algorithms is becoming increasingly crucial due to the rise of a new type of attack called store now decrypt later (SNDL). The strategy involves hackers intercepting and storing encrypted data while waiting for future quantum computers to decrypt it. Banking details, medical records, and social security numbers are just a few examples of valuable data that may be compromised with the method. By adopting advanced cryptographic features like key rotation, multi-signature arrangements, and post-quantum signatures, the new blockchain took a step towards addressing these concerns.

In an embodiment, a typical instance of key rotation may proceed as follows. First the Initial configuration for expiration duration is set to 50 blocks within the original device create message. The expiration duration configuration of the device is stored with the device config and is copied to each key's own config as it is created. Second, the key data preserves the copy even after the main device config is modified; the key config is what is used when a key's final expiration is calculated. Configuration for expiration duration is modified from 50 blocks to 2 blocks. The configuration record is added at block 1000. Any keys that were generated (added keys/new keys) before block 1000 may have expiration timeout of 50 and any keys that were generated (added keys or new keys) after may have expiration timeout of 2.

In one aspect of an embodiment, first key replacement at block may remain valid for certain records until the original key was generated. The new key may have expiration timeout configuration set to 2 blocks, but the countdown may start only when that specific key is replaced. Next step is if a new key (that has setting as 2) is replaced at 1080, it may be valid until block 1082-meaning that it may expire before the first key it originally replaced. Off-chain counterparties may confirm if a private key is active, and may also detect if and when it is replaced. When a key is replaced, a counterparty may also know up to what block it is going to validate. If a key is currently active, the counterparty may consider the worst case for expiration to be current block+1+expiration timeout, which may be the case if the key were replaced in the next block. A user and/typically only accepts an off-chain record if their counter-party's device's expiration duration is configured on-chain to be longer than a sufficiently large number (say, 100 blocks), and if the key being used for the off-chain signature is currently active on-chain. At the moment when the key rotation occurs the counterparty may either request that the record be re-signed with the new key, or may have to unilaterally add the record to an atomic transaction and add it to the blockchain. The process may ensure that off-chain counterparties may not be surprised and unable to act in a timely way to close their positions on-chain before the off-chain ARCs they hold are invalidated.

In one embodiment, the number of different situations when private keys are created: 1. When an account is first created. 2. When an account rotates its private/public key (which may happen in any transaction, but may always happen in device acceptance messages) 3. When an anonymous recipient is sent a transfer via text or email. The anonymous transfer may be locked with a new private/public key pair, and the recipient may be able to unlock the transfer by signing it using an envelope. 4. When a new device is added to an account, and the device creates a message is sent to the new device for acceptance. 5. When a backup is taken of the account (which uses the new device creation process). Each of these have different security requirements, and may be handled differently by the client. The first and second cases are situations where the private key never leaves the device. Because of multi-device functionality, it is not ever required for the private key to be shared or copied. In the first and second cases listed above, hardware-level security may be used to generate and protect the keys. Secure enclave stores the private key in a space that is not accessible to the application—the key pair is generated by the hardware itself, and is accessible via an OS abstraction: When the type of API is available on a phone, then it may be used. If the API is not available, then a software stand-in may be used, following the same abstraction. It may make sense to create an abstract Api around these platform-specific implementations, following the In the third and fourth cases, the private key actually may be transmitted via email or text to the recipient. The recipient uses the private key to sign the wrapper transaction that is actually added to the blockchain, matching the public key listed in the inner record. In these cases, the seed does not may be preserved, because the key is transient (short expirations being part of the blockchain records themselves, making the keys useless after a certain amount of time has passed). This enhances the maximum level of security possible in the generation of these keys, even though they may be sent over the wire in the clear. The fourth case is the only situation where a key may be long-lived, and also may be stored outside of the secure enclave. However, it may be stored on paper only, and may not be “hackable” from that perspective. In this case, the lead taken by existing tools like Metamask for generating a seed that consists of a certain number of human-language words (we have options for the seed to be in certain different languages—at least English and Spanish, and maybe Hindi). Note there are choices to add some choice to the client to determine the digital signature algorithm that is used. If we are using hardware-based cryptographic signatures, we may have to accept whatever algorithm the hardware system implemented. Over time, new algorithms may be imposed by hardware manufacturers; old and new hardware may be supported at the same time. Also, old algorithms after some time may prove to be less secure, and may not be used for new accounts and new signatures & key pairs, but still, old accounts that still use old algorithms may be simultaneously supported. This is done to add a field to the signature/public key configuration describing specific algorithm is used to generate the key pair and to sign records

### Multiple Signatures

In at least one embodiment the software uses a modular approach with regards to support of signature algorithms. This may allow flexibility in adding and removing support for various algorithms. Open Quantum Safe support is a modular approach. The objective of the Open Quantum Safe (OQS) project may encourage the advancement and experimentation of quantum-resistant cryptography through an open-source approach. The project comprises two key initiatives: liboqs, a C library for quantum-resistant cryptographic algorithms and prototype integrations into various protocols and applications, such as the OpenSSL library which may be widely utilized.

In at least one embodiment, Multiple mode-Follows three modes that are available in ARC. The first approach is All-or-nothing, in this approach the state for the entire chain is reversed if any failure occurs. Second approach is Halt-on-failure, in this approach state of the failing record is reversed in case of a failure, but the preceding state transitions are kept; In third approach, Ignore failure, The block-building node attempts to execute all records, and if any record fails, only the state for that record is reversed while previous successful records' state transitions are kept. A separate configuration may control whether the ARC may be considered a success or not for purposes of any outer ARC if none of the constituent records succeed.

In at least one embodiment, Optimization in signature verifications is verified. This option may explore the potential for constructing a single omnibus transaction record that may encapsulate all constituent records, eliminating may be for redundant signatures. This means that if all constituent records have the same originating account or address, the transaction record only may be signed using the private key of that sending account, rather than requiring each constituent record to be independently signed. But if the constituent records have different originating accounts or addresses, the transaction record may be signed by multiple accounts or addresses. This approach may not replace Atomic Record Chains with individually signed records. The arrangement of back references and signatures ensures that no man-in-the-middle may modify any aspect of a transaction on the blockchain network without invalidating its signature(s). This is advantageous as it's not possible to alter critical transaction components, such as gas price, gas amount, replacement public key, and any data element included with the wrapper/container, without triggering a signature mis-match. In the case of ARC constituent record containers, it is also impossible to change the back reference without invalidating the signature, while multi-signature records may not have any signature removed without invalidating the” final” signature.

In at least one embodiment, additional signature requirements (for instance, a final multi-sig requirement) or other structural requirements may be imposed on ARCs. This guarantees to the participants that the ARC they are contributing may only be executed if certain pre-defined expectations are met as to its outcome.

In at least one embodiment, rather than specifying either no signature requirement (anonymous header) or (ii) a single specific signature requirement, the auth filter may handle these requirements as well as any other requirements. This may replace the signature validation requirement for the atomic record as currently specified in the header and may not change the signature validation requirement for the individual atomic records, however, and wouldn't otherwise alter atomic record validation. The syntax and semantics of the multi-signature checking are the same as has been described with regards to the account/device auth filter behaviour.

According to some embodiments, Bloom filters are used to prevent transaction replay, rather than relying on sequential transactions. Since pending transactions are provided with mempool expiration which results in particular transactions being replayed. In case if the record is re-signed, this may have a different signed hash. This may result in the original keypair being expired and both transactions be executed, resulting in a double spend. Since the transaction resigning may happen long before the original key pair would expire, the window for such a double spend would be very large. In order to prevent this, we may be to replace the previous version of the transaction with the newly re-signed version. When a new smart contract is added to the blockchain, it should be possible to indicate that invocations may be nonceless. Smart contracts may be implemented in such a way to use internal logic within the smart contract itself to prevent the risk of a double-spend from occurring, rather than relying on a nonce (i.e. transaction counter). Such smart contracts may maintain an internal activity counter, and require a nonce to be passed into each method invocation, or methods may be constructed in such a way. In at least one embodiment, Arc Apply Light Validation is defined which is

considered as the lite version of the application with no EVM for the execution of non-Turing complete changes that are required for validation in ARC. Apply Light may not execute contracts and considers subroutines output as true. Apply Light is currently implemented in token_config, redeem, stake, transfer, and mint records. In Arc, Apply Light is used to execute validation on each constituent transaction, which includes nonce validation, signature validation, wallet auth-filter validation, and execution of apply Light implemented on all the records depending on a few conditions.

In other preferred embodiment is to check nonce validation. In case of public key renewal there is a process to check if it refers to a key used in an old account or not. Another factor to check if both valid keys and expired keys are present. If any of the above cases provides an error, then the state may be reverted.

In an embodiment, A well-defined programmatic API should be specified that may be shared by all implementations. In the future, it should be able to drop-in additional digital signature variants. A facade may be implemented that accepts the integer code representing the digital signature scheme, and the signature verification data, and encapsulates the selection and execution of the verification algorithm. In addition, the facade should differentiate between historical (possibly deprecated) validation, and current (new block) validation. The question of which algorithm is currently supported or deprecated (and at which block number each algorithm is supported or deprecated) should be provided within a high-level, easy-to-identify constants code file within the application codebase. In order to support the above, the facade are e given information as to the block number of the record(s) being verified, so that it may properly verify whether or not the specified algorithm is supported at the time of that block. Multiple signature schemes may have the same signature length. Each signature in the signature list may have its own signature scheme. The signature scheme is intended to identify only the algorithm used to make the signature. There is no difference between multi-signature ChainID which is the chain identifier so that transactions may be replayed against multiple chains. Like any transactions from testnet may not be able to be replayed on the main chain as both have different chainID. User transactions on Ethereum or Ethereum classic or Ethereum testnets have to use different chainIDs.

In an embodiment, auth filter applied to the ask token of the sale order are applied to any transaction based on the token used to pay fees it was discussed that there may be a flag added to the genesis record controlling whether the token may be used for fee payments or not A problem with the approach is that fee payments may be all-or-nothing. There may be no way to stop a particular recipient from receiving tokens that they may otherwise be prohibited from receiving. So, when auth filters execute on purchase records and sale records, all the ancestor tokens in the chain of authority are also authorizing as well, The auth filter may execute on the token specified in the wildcard, and its ancestors. The descendants may be skipped, but some control logic may be implemented in the ancestor to create some limitations. Whether or not the match is a wildcard match is something that may be part of the auth filter context data. So, in some cases, the ancestor may construct a special-case within its auth filter to prevent wild card matches from being implemented at all in certain cases. Users may restrict wild-card matches so that only issuers are able to issue wild-card match sale records, blocking ordinary users from doing so. This may solve the current problem.

In an embodiment, A block account is a pseudo account where index is block. may be tracked in such a block account and such account may contain all the information that is necessary to process the activity during block processing. A block account may be deleted after serving its purpose, in the Close or Commit block hook of corresponding number. Some use cases: A block account may store all the references Propositions that may be closed (List of such proposition indexes) Propositions that may be removed due to expiry (List of such annotation indexes) Smart contract invocations that are delayed (List of such tx or account references). The Key Properties are (1) Block account may be retrieved from the merkletrie using block number. (2) The information may be written to the block account using block number (subjected to (4)) (3) Block account may be deleted (if it exists) at a block that it corresponds to after processing. (4) A block account may not exist with a number <=latestBlockNumber and >latestBlockNumber+K in any scenario. (K may be decided).

In an embodiment, it is possible to pay for any transaction (not just transfers) with user tokens. This may make it less necessary to use atomic transactions to pay fees when the sending account does not have fuel, because no separate trade order may be required to acquire fuel. However, there are other situations where an atomic transaction may be required to allow some accounts without any token balance to sign and send atomic transactions. A variety of functionalities within the system may make this difficult: Smart contracts may not be statically evaluated, so smart contact invocation may be a problem. If the atomic transaction were to fail for any reason before sufficient tokens were granted, then that may mean that any records that are required to pay fees may not be executed. Complex auth filters may slow down the gas evaluation, and incur computational load before it is confirmed that gas is available to pay for the auth filter evaluation. However, if auth filter complexity is capped the compute cost may be capped.

### Gas Fee

In at least one embodiment, Concept of Gas and Fuel is defined which determines the fees that users may pay to execute the transactions. When a user pays for gas, they are essentially making two purchases: fuel and gas. The fuel is bought in exchange for the user tokens, and the gas is bought in exchange for the fuel. The gas auction is a mempool mechanic that ranks pending transactions based on the gas price bid in terms of fuel. If the gas price were specified directly in terms of user tokens, then the block-building node may treat the fee purchase as a market order and match it appropriately with a trade order. This allows for a determinable gas price denominated in fuel by combining the rate with the user-token-to-gas rate.

In at least one embodiment, Auction is defined. This is how transactions on the blockchain network pay for their gas budget using user tokens. When this happens, two purchases may happen. The fuel may be purchased in exchange for user tokens, and gas may be purchased in exchange for fuel. While it is conceivable that the transaction may specify both prices for fuel and gas, it is sufficient for it to specify only the price for gas in exchange for user tokens. The gas auction is implemented as a mechanic of the mempool, which ranks pending transactions based on the gas price bid in terms of fuel, although the specific algorithm is more sophisticated. This algorithm is customized on a per-block-building node basis and may not be deterministic throughout the network.

In at least one embodiment, the gas price was specified directly in terms of the user tokens used to pay fees, then the block-building node may treat the fee purchase as a market order and match it with a trade order. The gas price is denominated in fuel which is determinable by combining that rate with the user-token-to-gas rate. However, there are two different approaches to consider when a user wants to pay for fuel or purchase fuel with USD. In the first approach, the user is selling USD at market rate, whereas in the second approach, the user is buying FUEL at market rate or paying USD for FUEL at market rate. In the second approach, the effective gas price is fixed, but it would change in the first approach. To match the order, the same approach is used in both cases as the market rate is from the same order book that sells FUEL.

In at least one embodiment, Auth filter gas calculation is an important aspect of determining the appropriate gas price for executing actions controlled by an auth filter. Gas prices for each operator controlled by an auth filter, such as transfer or trade, is assigned and aggregated. This may allow for the gas utilization of records which is statically determined in advance, enabling gas-utilization validation. The gas cost of each operation is based on empirical measurement of the time each operation takes in real conditions. The gas price is an approximation of the real cost of execution of the operation. When an auth filter is created, it is evaluated to determine its gas cost, which is included with the minimum gas cost calculation of any transaction that references the auth filter. A limit is specified for every function available in auth filters, in order to properly account for the cost of iterating over dynamic data within the global state. The cost of functions that may include a dynamic iteration is specified assuming that the number of iterations may be maxed out with every invocation. In order to make the work, the compiled byte code may be parsed, and the abstract syntax tree is analysed at the time that the auth filter is first uploaded. This may be necessary because the gas price of a transaction may be statically determined when it is first validated, at the beginning of the validation process, before the auth filter is executed. Overall, auth filter gas calculation is an essential aspect of determining the appropriate gas price for executing actions controlled by an auth filter and is carefully considered in any blockchain implementation.

### Cleanup Function

In at least one embodiment Storage Economics is implemented, which may be referred to as the cost of storing data on a blockchain network. The gas cost for storage and smart contracts are handled differently, and no storage limitations are placed on genesis tokens. At a transaction level, gas cost for storage is aggregated together with execution gas cost, but within the validation, mempool, and block building logic, the costs are separated into three gas categories: compute gas, storage gas for block-building nodes, and future-rebate gas. 50% of the gas budget for storage goes to the block-building node, while the other 50% goes to rebate, and these values are consumed separately during smart contract execution. All gas is fungible with regard to the block gas limit, and gas is always paid for in the aggregate by the sender, although the block-building node calculates a portion of gas that goes to storage rebate and discounts that from the ranked amount. Ultimately, the storage fee is consumed 50% by the initial block-building node, and 50% at the time of rebate. Regarding trade orders, 50% of the gas budget for trade orders may be awarded to the initial block-building node who adds it to the order book, and the other 50% may be awarded to the block-building node who settles it. This allows block-building nodes to settle orders proactively and reduce order book slots. If trade order slots are reduced, the appropriate proportion may be refunded from future-rebate to the trader. If a trade order drops due to expiry, it may either be refunded back or burnt. The storage gas cost curves of smart contracts and Wallet accounts are handled differently, and no storage limitations are placed on genesis tokens. External proposition storage would be handled separately as well, with separate rules. At a transaction level, gas cost for storage is aggregated together with execution gas cost. However, within the validation, mempool and block building logic, the costs are separated out. Three gas categories: there is compute gas, there is storage gas for block-building nodes, and there is future-rebate gas. 50% of the gas budget for storage goes to the block-building node; this is storage gas for the block-building node. 50% goes to rebate; this is future-rebate gas. smart contract invocation specifies a gas budget for execution and a gas budget for storage/rebates. During validation and mempool processing, these values are assumed to be accurate. During smart contract execution, the two values are consumed separately as the smart contract executes. Storage operations consume the storage gas budget, while compute operations consume the compute gas budget. all gas is fungible with regard to the block gas limit. This means that no distinction is made between compute gas and storage gas when evaluating the block limit. Storage gas has the potential to push out compute gas from the block. gas is always paid for in the aggregate by the sender, however the block-building node may calculate a portion of gas that goes to storage rebate, and discount that from the ranked amount. The rebate portion is stored as a fuel-token denominated deposit on the account. If storage space is reclaimed as part of deterministic cleanup (automatic invocation of cleanup function) the rebate fuel is burned. If storage space is reclaimed as part of a specific single record execution, within the execution of that record, not on a delayed basis later in cleanup, then the rebate is given to the signer. This provides an incentive for accounts and block-building nodes to look for storage savings proactively, but does not require it. The fuel received as rebate is normal fuel, treated as equivalent to fuel received as part of mining reward (even if not received by the block-building node itself). The block-building node wants to maximize the earnings per gas occupied within the block, not the fee paid per block. Transactions with high storage may have to pay a higher gas price to be included.

In at least one embodiment, the objective of the slot pricing approach is to inflate the gas cost of users who occupy too many slots, which in turn makes the cost of slots go up higher for everyone else. The gas requirement related to space may change dramatically within a block, and if gas used by a transaction is a function of the space requirement, then every transaction within a block may properly account for the gas it consumes. This is because a block-building node has an incentive to exclude any transactions that might be under-paying for gas that is consumed.

In at least one embodiment the proposed system supports a variety of different records to provide advanced features, the first one being delayed execution. The feature may allow for the lazy execution of state changes, which shall be applied when one of the affected accounts is touched after the effective block has passed. The state updating may happen before any state change that may result from the account being” touched. The delayed execution may allow for the possibility of a state change failure, as the final state-modifying validation which is delayed until the effective block has passed and one of the affected accounts is touched. Gas payment may not be delayed in its execution, so the storage gas requirement may be anticipated. The feature is useful for nearly all record types, such as delaying changes made to the genesis configuration of a token, delaying transfers, and delaying smart contract invocations.

In at least one embodiment the concept depends on ‘mutually exclusive’. The concept of mutually exclusive is important in blockchain technology to ensure the validity and consistency of transactions within a bounded window. In this context, a bounded window refers to a specific range of block numbers, denoted by X and Y. A transaction T is marked as dependent on another transaction D, which means that T may only be considered valid if D has been added to the blockchain in a block numbered X or later, prior to T being added to any block. If D has been added to any block preceding X, then T may not be valid. This ensures that T may not be added to the blockchain until the required dependent transaction has been successfully added. On the other hand, a transaction T may be marked as mutually exclusive with another transaction E, which means that T may only be considered valid if E has not been added to the blockchain in any block numbered X or later, up until the point at which T is added to a block. If T is added to any block, then E may be invalid in any block following the point at which T is added to a block, up until block numbered Y. To ensure the validity and consistency of these transactions, the block numbers X and Y are dynamically determined based on an offset O from the block number N in which the transaction T is added to the blockchain. The gas cost associated with these dependencies and exclusions for the additional computational requirements of performing the search at the time the transaction is added

In at least one embodiment the new tokens are created using the token config record. The token config record contains important information about a token which may include details such as the token's label, and the base token for derived token types. The record specifies the account that holds the tokens, the type of token supply (fixed, unlimited, or original issuer), and the maximum supply limit for fixed supply tokens Additional fields define the token's type, symbol, full name, precision, immutability, and authentication settings. The settings control the token's authorization, verification, fee payment, and effective block information.

In at least one embodiment, the basic functionality of transfer of tokens and added advanced features are provided by transfer record. The transfer record may contain essential details for a transaction involving token transfers. The value and label of the token being transferred to the primary receiver, as well as the address of the receiver. Additional information which may include details about multiple tokens transfer order, an effective block for processing, a contract payload for smart contract interactions, the gas budget for contract invocations, and any extra transfers associated with the transaction. The components collectively facilitate the execution and monitoring of token transfers, allowing for flexible and comprehensive transaction management within the system. Anonymous transfers are facilitated through a specialized record type designed exclusively for this purpose.

In an embodiment, certain record types (and perhaps all record types) have an effective block number as an optional field. The effective block of the record may be specified on the record, and then the account(s) that may be affected by that record may be updated not with the actual requisite state change, but with a pointer to the pending transaction, and the block number when the record is effective. Actual state transformation may be executed in a lazy manner. Only in the event that one of the affected accounts is touched by some record may the pending change be applied. The state change may be applied to all affected accounts at the moment that any one of the affected accounts is touched after the effective block has passed. The state updating happens before whatever state change may result from said account being “touched”. If there is more than one pending state change that may take place, the pending state changes may all be executed in order for all affected accounts (meaning, even if an account A has a state change that is unrelated to the account B that was “touched”, the account A pending state change may be executed anyway, provided that account A also has another state change pending that is related to account B. Because the state change may not be executed until the effective block, the transformation may be delayed, and therefore the final state-modifying validation may also be delayed until the effective block has passed and one of the affected accounts is touched (or at least, the validation may be re-run). This means that the state change may ultimately fail, but that the failure may not be known until the cleanup function is called and the state change executes. However, gas may be evaluated and consumed at the time the original transaction is executed. Gas payment may not be delayed in its execution. Somehow the storage gas requirement may be anticipated, due to the fact that the full gas payment may be made before the actual execution. One possible way for this to happen may be for the modification to be applied in an anticipatory way, so as to obtain the specific effect in terms of storage cost, but not have it be applied. If any additional mutations are inserted between the current state and any pending state modification before the pending modification is applied, then a sort of average cost may be computed. The new inserted intervening modification may be applied, and then the subsequent modification. The storage charge for the inserted intervening modification may be the delta between the original cost of the existing pending change, and the total cost of both the new and the originals combined. The new inserted intervening modification may not pay the price precisely attributable to its storage requirement, but may also pay the price of the implicated increase in cost of the pending changes.

In an embodiment, the feature may be implemented for Account Configuration records. However, the feature may also be beneficial for nearly all other records as well. For instance: There is a possibility e to delay execution of changes made to the genesis configuration of a token. It may be beneficial to be able to optionally delay execution of transfers. Such a feature may be useful in order to configure a wallet account to reject high-value transfers that are executed without a sufficient delay. If a proposition decision or definition record may be delayed, then it may make it easier to ensure that all deciders are able to contribute to an updated proposition all at once. For instance, in the case of an identity proposition that may be updated with new identity information, it may be necessary to write the proposition record to the blockchain, even though the original annotation may to remain active for some time after, even while the deciders' decisions are added to the chain. Delayed execution of any smart contact invocation, including invocation of auth subroutines, may not be done using the above lazy-execution approach.

In an embodiment it is impossible to know in advance all the accounts that may be touched by a smart contract, so it may be impossible to register the delayed execution with all accounts touched by the delayed transaction. That being said, if it were possible to list with the smart contract invoking record all of the accounts affected by that execution (listing them in an array on the transaction or constituent record envelope) such that the smart contract record may fail if it attempted to touch any other account, then it may be possible to delay execution of such a smart contract.

In an embodiment the following steps are performed:
a) A new account is created in a client application which is not yet written to the blockchain.
b) The new account constructs an ARC and sends it to the identity verifier.
c) Identity verifier places the ARC into an atomic transaction and signs it.
d) Atomic transactions are added to the blockchain. An identity proposition is created.

In an embodiment, the cleanup function may be called each time that an account is accessed, before the account is used. Under normal circumstances, it may inspect the pending portion of the account data and discover that there is nothing that may be updated. When this occurs, if any space is reclaimed (space utilization reduced), some gas may be released from the AMM, which may be used to reduce the gas requirement (improve the gas budget) of the transaction that triggered the cleanup.

Additionally an embodiment defines cleanup record type that does nothing but cause cleanup to be performed on a particular account (wallet account or any other account). By performing this cleanup operation, the net gas utilization of the record may be negative—the record itself may some quantity of gas to be spent, but the cleanup may likely free up more gas than is actually used by the record. A cleanup function may be used, for instance, to reduce the cost of an atomic transaction, by offsetting the gas requirement of constituent records. The equivalent smart contract EXT function may also be used to offset gas utilization, by offsetting the gas used by a smart contract. However, the primary intended use of the record may be by block-building nodes engaged in MEV. These block-building nodes may seek out cleanup opportunities, and themselves add high-priority transactions that perform cleanup and that add negative gas to any block produced. This negative gas may expand the size of the blocks that such block-building nodes may produce, allowing such block-building nodes to increase profits by adding more fee-paying transactions into each block than the block may normally accept.

In an embodiment, a transaction is used to express the transaction's dependency on other transactions which may themselves be dependent on some other transactions. These transactions may have already been added to the chain or may be present in the pool.

In an embodiment, the storage gas cost curves of smart contracts and Wallet accounts are handled differently, and no storage limitations are placed on genesis tokens. External proposition storage may be handled separately as well, with separate rules. At a transaction level, gas cost for storage is aggregated together with execution gas cost. However, within the validation, mempool and block building logic, the costs are separated out. There are three gas categories which comprise compute gas, storage gas for block-building nodes, and future-rebate gas. 50% of the gas budget for storage goes to the block-building node; this is storage gas for the block-building node. 50% goes to rebate; this is future-rebate gas. During validation and mempool processing, these values are assumed to be accurate. During smart contract execution, the two values are consumed separately as the smart contract executes. Storage operations consume the storage gas budget, while compute operations consume the compute gas budget. All gas is fungible with regard to the block gas limit. This means that no distinction is made between compute gas and storage gas when evaluating the block limit. Storage gas has the potential to push out compute gas from the block. If storage space is reclaimed as part of deterministic cleanup (automatic invocation of cleanup function) the rebate fuel is burned. If storage space is reclaimed as part of a specific single record execution, within the execution of that record, not on a delayed basis later in cleanup, then the rebate is given to the signer. This provides an incentive for accounts and block-building nodes to look for storage savings proactively, but does not require it. The fuel received as rebate is normal fuel, treated as equivalent to fuel received as part of mining reward (even if not received by the block-building node itself). The block-building node wants to maximize the earnings per gas occupied within the block, not the fee paid per block. Transactions with high storage may have to pay a higher gas price to be included. with regards to the predictability concern: as long as the Wallet knows the current storage state of an account, the Wallet may be able to calculate on its own what the storage price is.

In an embodiment, accounts that have been dormant for a certain number of blocks (not “touched” or modified or accessed for a certain period of time) are able to shrink into a single hash value, whose hash value represents the data object that had occupied the account. In addition to the hash value, the account may also contain the block number in which the account was shrunken, in order to know how to form the account data into the proper format upon restoration. Shrinking accounts may occur when an account shrinking record is added to the blockchain. An account shrinking record may cause the sender to receive the rebate of the deposit remaining on the account. A shrinking record that is attempting to shrink an account that has not reached the dormancy threshold may be valid on the blockchain (meaning it may consume gas fees) although it may not actually effectuate the shrinkage operation.

In another an embodiment, an account being touched within the same block that the account shrinking block has been added (in which case the shrinkage record may be treated as invalid). This may disincentivize users from spamming account shrinkage records immediately before an account is ready to be shrunken. An account shrinkage record that is attempting to shrink an account that has been shrunken may be invalid in the blockchain (a block that includes such a record may be invalid). An account restoration record is used to restore a record to its former state. The account restoration record may contain the account object in its original embodiment (RLP encoded) which may match the hash that has been saved to the blockchain in replacement of the account data. The fee to perform the restoration may equal the aggregate storage cost, and thereby also restore the deposit to the original state. The appropriate portion of the gas cost may be paid to the block-building node. Some additional fuel may also be paid to the block-building node to incentivize inclusion. When restoration occurs, the cleanup function appropriate to the block when the account was shrunken (given that software upgrades may have changed its behavior) may be executed prior to re-inclusion. The hash may not match exactly the version of the account data held by the restorer, but the cleaned up version of the data held by the restorer may match the hash. The cleanup may be categorized as a deterministic cleanup, and may destroy the rebate fuel. One implication of taking the approach is that a shrunken account may not be an information source. Once an account has been shrunken, all information queries may fail. Another implication is that each account may have to keep track of the blocks in which the account was read or accessed, not just modified (although due to the requirement, every account read may also be an account update). The cleanup function may update the block number field of the account. Another implication is that block-building nodes and MEV operators may have an incentive to shrink dormant accounts, because they may receive the rebate. The remaining rebate is a necessary feature in order to incentivize the MEV activity.

In another embodiment, the user defines gas economics and storage economics. When a transaction is added to the pool, the space requirement and the state-independent computational gas requirement may be structurally evaluated and attached to the transaction in the pool. The state-dependent computational gas requirement, and the aggregate gas requirement may be dynamically computed each block based on the state. For every account type, there are two storage-economics functions that may be defined: First being the gasRequirement and second being the fuelRefund (current_storage, storage_decrease, current_deposit, is_destroy_account). Every account type may have very different outputs for the above two functions. Also each account type may have very different behaviors with regards to which account receives a storage-related fuel refund in different situations: The gas requirement related to space may change dramatically within a block; if one of the early block transactions utilizes much of the space of an account, then the gas requirement of a subsequent transaction may be re-evaluated. In addition, if an auth filter changes from one transaction to another within a block, the gas requirement may change. The block-building node has an incentive to exclude any transactions that may be under-paying for gas that is consumed. If gas used by a transaction is a function of the space requirement of that transaction, then every transaction within a block may properly account for the gas it consumes as a function of the space utilized, otherwise the block may be validated as being invalid. A block may be invalid if the gas limit is exceeded, or if the gas utilized by each transaction is somehow inconsistent with the rules.

In an embodiment, the first gas utilization calculation (performed with pool sorting) may be an estimate only. If the final gas requirement calculation performed on the transaction results in a gas price that is too low, or that deviates too much from the original calculation (say, if the gas price is off by N %, or if the gas price is less than the effective gas price of the lowest-cost transaction to be included in the block/the last item in the pool queue) then the transaction may be excluded from the block, and may be added back into the queue to be re-evaluated later. If it is too expensive to re-run the entire gas cost evaluation, a cache list may be kept of the accounts that have been affected by the block so far as it is being evaluated. The cache list may potentially make the reevaluation of the gas requirement more efficient than re-running the entire evaluation over again. In any event, it is only the state-dependent gas requirement and the storage-requirement-translation-to-gas that may be re-evaluated. The storage requirement itself, and the state-independent gas requirement may not be re-evaluated at block-building time.

In an embodiment, eliminating an account from the global state database is to be rewarded. Creating an account on the global state database incur a cost. The gas cost constants file include definitions for the cost of account creation and account deletion (the latter being negative). These costs are incurred whenever an account is added to the global state, or whenever an account is removed. There may be an account abstraction that encapsulates the management of the question, so that code is not duplicated. When validating transactions for gas utilization, if there is any possibility that a recipient account does not yet exist in the global state, then the “max gas requirement” of the overall transaction incorporates the full cost of account creation. The account deletion reward may not be taken into account by gas validation, as there is no way to know within the gas validation process whether or not the account may be destroyed or not. This may ensure that there is sufficient gas at the time of execution, even if not all of the gas provided in the transaction ends up being used.

### Fee Payments

In at least one embodiment, the transfer record includes information about the source of funds, the transfer amount, and the specified fees. The record is signed by the sender but does not indicate a specific destination. The fees associated with the transaction container match those of anonymous transfer. The account that signs the transaction container becomes the ultimate recipient of the tokens transferred through the anonymous transfer. During validation, the gas fees are not evaluated based on the sender's account but instead rely on the sending account specified in the anonymous transfer record. Both the recipient's transaction container signature and the sender's anonymous record sig nature are verified. If the validation process succeeds, upon final execution, the tokens are transferred to the recipient's account (the transaction container signer), while the sender's account (the anonymous record signer) is debited the transferred tokens and the corresponding fuel. A critical aspect of this process is that the initial inner object created by the sender should include a public key. This public key is shared with the recipient via off-chain means. The recipient's added envelope is signed using the key pair that includes this public key. Additionally, an optional authentication feature may allow the sender to include a hashed passcode within the inner object. The passcode serves as a short numerical code shared from the sender to the recipient. The outer envelope may include the passcode pre-image or, ideally, a zero-knowledge proof (ZKP) to demonstrate that the recipient possesses the pre-image.

In at least one embodiment, while fees are mentioned in terms of USD as it is a currency, it also may be a limit to prevent more USD from being deducted than expected. The market rate fluctuations may be managed by implementing multiple heaps of transactions for each fee payment type. Each heap is relatively stable internally, as a change in the market rate would change the gas price proportionally to all elements in the same heap. The heap o heads determines which heap to consider for the next operation, and when there is a change in the market rate, only the particular heap heads in the outer heap may be updated.

In at least one embodiment of the concept of context of incorporating external off-chain information into the blockchain. The proposition records are utilized to enable smart contracts and specialized records within the blockchain to make use of this information. The process of proposition determination involves two phases. In the initial reward collection phase, proposition records and supporting reward allocation records assign the initial reward to be distributed among the accounts that correctly determine the outcome of the proposition. In the determination phase, votes in the form of token assignments are cast either for or against the proposition through decision records. The truth or falsehood of a proposition is determined based on the side that it may be able to risk the highest value in tokens. Rewards are allocated and distributed to the winning side, while penalties are imposed on the losing side, providing incentives for participants to vote in favour of or against the proposition based on their knowledge or trust in other participants.

In at least one embodiment the proposition determination process has a defined time frame, typically measured in terms of blocks added to the blockchain. The time frame is specified in the original proposition record, which also includes the decision block and optionally the closing block. The determination process concludes when the closing block is reached, or when a certain number of blocks pass without additional votes, depending on the specified conditions. Decision records and proposition records may incorporate evidence or references to external evidence to assist participants in assessing the validity of the proposition. These references may point to various types of files such as images, PDFs, or cryptographically signed files. The process of proposition determination involves the acceptance of a proposition record to the blockchain, assigning supporting rewards, broadcasting initial decision records, adding decision records to new blocks, and determining the outcome of the proposition based on aggregation and patterns matching the decision records. Restrictions are imposed on the inclusion of decision records based on specified accounts or addresses, either for the entire decision process or only at the beginning.

### Proposition Annotations

In at least one embodiment, a proposition record includes a list of permitted accounts to generate the initial set of decision records, and possibly restrict all decision records for the proposition to those accounts. A proposition record may also be self-determined, marked as already decided when included in the blockchain, and automatically regarded as true without undergoing the proposition determination process. The gas payment is made from the remaining unspent quantity from the initial spend when the record is created. Alternatively, a separate gas amount may be specified in a separate field within the record, which may be necessary in atomic transactions. To ensure that the block limit is not exceeded, the proposition determination process is executed at the beginning of each block before other transactions may be added. When accepting propositions, it is important to analyse the maximum gas to be spent on the payload in relation to the upcoming decision block to prevent exceeding the gas limit. If the gas limit is exceeded in the decision block, the proposition should be rejected. The block limits would be freed up when propositions expire, and the data falls out of the global scope. Accounts and tokens may be annotated by anyone, but those annotations are not stored with individual account or token type records.

In at least one embodiment the concept of” staking” fuel tokens are defined. Staking defines locking the fuel tokens with a user token until the token is redeemed. The following additions are made to support the functionality, In First step, A″ stake” record and an associated extension function may allow users to send new fuel tokens to increase the stake of a particular token type. In Second step, A″ redeem” record and extension function enable users to destroy a user token and unlock the underlying stake. The process involves reducing the token balance of the redeeming user, calculating a proportional amount of staked fuel based on the redeemed token's ratio to the total outstanding tokens of that type, deducting the staked fuel from the total stake balance, and adding it to the fuel balance of the user. Additionally, the global token amount decreases by the redeemed amount. In the third step,” Staking” and” redemption” subroutines are added to the token configuration record. These subroutines act as permissioning systems, controlling whether staking and redemption are permitted.

In at least one embodiment, they may also distribute additional tokens based on staking actions. The redemption subroutine may update a record indicating the user who performed the redemption. In the fourth step, a″ minimum stake ratio” or” minimum stake” configuration may also be added to the token configuration record. The configuration enforces a relationship between token minting and fuel staking. The initial value for the number of allowed token types is zero and may not be increased beyond zero. For” authorized” tokens, staking has a different impact compared to” open” tokens, as discussed earlier. Derived token types are separate staking balances from their parents, and over-staking the parent token type which may not benefit derived token types individually. Each derived token type satisfies its own staking requirement, if any. The developments enhance the functionality of staking fuel tokens with user tokens, providing more flexibility and control over token transactions and stake management within the blockchain ecosystem.

In at least one embodiment the cancellation record is a mechanism used to nullify or invalidate a previous transaction or action within the blockchain system. This may serve as a formal notice of cancellation, revoking the effects of a specific event or operation that has previously taken place on the blockchain. The cancellation record contains essential information such as the identification of the transaction which may be cancelled via the transaction hash. The purpose of a cancellation record is to ensure that any erroneous or undesired transactions or actions may be rectified or reversed within the blockchain system. By submitting a cancellation record, users or authorized entities may initiate the process of nullifying the effects of the original transaction, effectively reverting the blockchain state to its previous state before the transaction occurred.

In at least one embodiment, the decision record may be added to the annotation. The record process differs from the Boolean propositions and non-Boolean propositions. If the existing annotation is a Boolean proposition, only the Boolean decisions are required and allowed. In case of a non-Boolean proposition, an annotation context or a decider reference may be.

In at least one embodiment, for the non-Boolean proposition, in case of annotation context, User may decode the map and check if the context has values for all the required placeholder variables. Subsequently, the replacement process and unification is initiated for the replaced variables. The process may return an annotation data using the decider's context, which may be stored with the decision on the annotation as Decider Data along with the Annotation Context.

In at least one embodiment, each decider's annotation context may be unique. Different deciders may not have the same annotation context. A new field is added to the decision record to reference the decision made by another decider. The Decisions are used when working with a non-boolean proposition, where each decider provides their decision to replace the placeholder variables and create a specific decision data. The address may be stored with the decision such that it may be used to reference the decider of another decider within the auth filter (data utility function). A decision shall have a reward depending on the reward type. After every decision a pre-specified amount may be rewarded to the decider without depending on the side, or the first N decider may get the reward after closing the block depending on the side. If any existing decision is updated, then that decision is removed from the block where it was added earlier and may be added to the end of the list (i.e. in the current block). This is done to track reward distribution orders. Each decider may have only one decision on any annotation, which may be updated. If a decider filter is provided, then each decider may satisfy that filter otherwise the decision won't be accepted.

In at least one embodiment, any user may add tokens to the reward pool. The token provided may match with the token mentioned in the annotation. Token Rewards are only to the user tokens. Fuel is not a valid reward token. Information of each token owner may be stored within annotation with the amount contributed within the pool, which may be used in case if refund of the remaining pool is to be returned to their respective owners. Each owner gets a refund depending on the pool's pending balance.

In at least one embodiment, the attached proposition may only be deleted by its owner. For a detached proposition configuration may be specified when creating an annotation to allow deletion from the user who created it. The detached proposition is not explicitly owned by any account, which may help in deleting the annotation. There are no changes in the structure of annotation_archive record. The updates are related to the refund of the remaining reward present in the pool.

In at least one embodiment, there are two types of decision made. In the first scenario, each decider is rewarded after every decision, this may fetch a fair share of the rewards. If annotation is not extended and deletion happens, then all the refund is returned to the original author. If an annotation is extended and other token owners have contributed to the pool, then the reward may return to all the respective owners based on the remaining amount. In the second type which is defined as After Closing, each decide gets their reward after the closing block, once the pending job is lazily triggered on their account. If decisions are present at the time of deletion, users trigger jobs present on the deciders account to provide them their fair share of rewards. There is no refund for the proposition owner. The proposition owner may get a full refund if the annotation is deleted before the closing block is provided.

In at least one embodiment, the first input is an interface which may be common. Address, zBase32 string, token name, or Annotations (as input), that may be used to retrieve annotations present on any account or detached ones. The second input is a filter node which is used to filter annotations based on several factors present in an annotation. For example, this may depend on the proposed block, whether the annotation is decided or not, and some others. The last input parameter is filter annotations based on the list of voters (currently a list of deciders).

In at least one embodiment, if the list of voters is empty, then each annotation is evaluated based on all the decisions provided on that annotation and if positive votes are greater than negative votes then only annotation is filtered. Otherwise, the process continues to the next annotation. If the list of voters is present, then each annotation is evaluated based on the boolean decisions of these deciders. If annotations have the decision of any mentioned deciders and on evaluation the positive side is winning, then only the user may filter data. If it is negative, the process continues to the next annotation.

In at least one embodiment, the list of voters is empty, and decision mode is unique mode, users are returned as nil. If decisions are not unique then Users may decide on the basis of all the decisions. If the list of voters is present, then annotation may be evaluated based on all the decisions but if the decision is made then only its data may be returned. In other cases, the data function may return nil.

In at least one embodiment, the system may define Lazy Evaluation. During lazy evaluation, the user may check if the decoded account is a wallet account. If the current block exceeds the effective block, all filtered pending jobs are triggered. All other jobs, except these filtered jobs may be added back to the wallet jobs. If the pending jobs are related to the reward distribution, the decider may get the reward depending on the conventions). The reward of annotation is calculated to be distributed among specific deciders or all the deciders depending on reward detail. If the current decider triggers the job then the reward may be distributed evenly, else exit the process and the pending job may be cleaned up.

In at least one embodiment, the decider may receive the reward if the annotation may not expire. If a job is triggered first by any account after the expiration block and before the annotation expiration, the decider may receive the reward, and the annotation is not expired. If annotation is triggered first, all the pending deciders jobs are triggered and then expire. Users after applying for pending jobs, may also check on the same wallet account if any attached annotation is not closed though it reached the closing block or still exists even if it reached its expiration block. If an annotation reaches the closing block, the annotation is decided at this point. If annotation reaches its expiration, before expiration, the user may first check the reward type. If the type isAfterClosing Block, all the pending jobs are triggered, and the reward may be distributed evenly among all the eligible beneficiaries. The same process is followed for detached annotation while decoding detached annotations.

In at least one embodiment, there are two types of reward distribution. The First type is called After evaluation/decision. In one scenario each decider may receive a pre-specified amount without depending on the side of the decision. Each updated decision may also be rewarded separately with the specified amount. A block number field is added in the reward object along with the specified amount field to prevent misuse. The block number may act as a limit on the decision frequency, the next decision update may only be made once it crosses the defined limit of N block between both decisions. In one scenario, if the block number limit is not reached then an error may be returned, prompting the system to wait till the decision limit is reached. There are sufficient balance in the reward pool. If the reward pool balance is less than the specified amount, the decision may not get added/updated on the annotation.

In at least one embodiment, a job is created on the decider account. Once the closing block is reached and a job on the decider account is triggered, the reward for the user may be evaluated depending on the side of the decision. If there's a positive/highest count side with a majority then the reward may be distributed among the winners, and if there's a losing side then the reward may be distributed among them. If there's a tie, all the deciders may get the rewards, evenly distributed among them. There is a unique decision requirement in place; the reward may be distributed among all the deciders. The reward beneficiary number may be defined within the reward object which specifies only first N deciders may get the reward. If N==0, then the reward may be distributed among all the deciders. The value of N may not exceed the MaxDeciders value.

In at least one embodiment, a new decision is added with the settings same as the default decision mode, this may include unique choices only. To enable unique decisions for non-boolean propositions, a new decision mode is added with the settings same as the default decision mode, but this may always include unique choices only. The configuration field for the detached propositions, are represented as a bitmap. There are two available configurations, first one shall be used to extend the reward pool. This may be done to keep an annotation alive by add tokens to the reward pool. This method defines modification may only be made on the attached proposition, where changes may be done on the expiration block value before the closing block. No modifications are done other than this, before or after the decision block.

### Open Transfer

In at least one embodiment, a special record type is defined only for anonymous transfers. The anonymous transfer record may define a source of funds and an amount to be sent. The record may specify fees and be signed by the sender. This may not specify a destination, and it's not added into the blockchain on its own, because it would be a record. The inner object may be signed by the sender. The anonymous record then may be sent by the sender to the recipient via of-chain means.

In at least one embodiment, the sender may encode the record and transmit it to the recipient via SMS, email or scanned QR code. The recipient may generate a transaction container which contains the anonymous record. The fees of the transaction container may be to match with the fees of anonymous transfer. The account which may sign the transaction container is the ultimate recipient of the tokens being transferred by the anonymous transfer.

In at least one embodiment, validation may not look at the sender account for the gas fees but may instead look at the sending account defined in the anonymous transfer record. Both the signatures may be verified which are the transaction container signature of the recipient, and the anonymous record signature of the sender. Both the signatures are compared and if everything is valid, upon final execution the recipient account (tx container signer) may receive the transferred tokens, and the sender account (anonymous record signer) are deducted the transferred tokens and fuel. A key authentication concept is the initial inner object generated by the sender may contain a public key. This public key is sent along with the transfer object via off-chain means from the sender to the recipient. The envelope is added by the recipient which may be signed using the key pair that includes this public key. An optional authentication feature allows the inner object built by the sender to contain a hashed passcode. The passcode pre-image is a short numerical passcode that may be shared verbally from the sender to the recipient. The outer envelope includes the pre-image (or better, a ZKP proving that the recipient has the pre-image.

In at least one embodiment, Data passed into auth filters are referenced by variable names with initial capitalization. Auth filters may be allowed to follow a convention whereby variable names referring to data passed into auth filters have an initial capitalization. If the variable names comprise multiple separately identifiable words, the initial letters of each word are capitalized, but the other letters of all the words have the lower-case (camel case). Function names within auth filters may all be lower-case.

In at least one embodiment, auth filters are added optionally to the ARC header, which may operate only on the data of the ARC, and also of the Atomic Record that encapsulates the ARC. By this whole Atomic Record is passed into the ARC header auth filter. In case if auth filter determines as false value, the Atomic Record which may encapsulate the ARC are deemed invalid. The cost of the auth filter is statically determined on static validation of the Atomic Record (i.e. when the total gas requirement of the Atomic Record is being determined). As with any auth filter, certain functions that are potentially long-running are capped in terms of their complexity (for instance, by handling only a certain amount of data), and the gas cost used for calculation have the maximum amount.

### Device Activation

In an embodiment, activation process for new devices that involves two messages: first “device creation” message from an existing device, which establishes a key pair for the new device, and a second “confirmation” message from the new device, which should replace the key for the new device with another key pair (with the private key only known by the new device). Certain variations on this approach are optional. A single create+accept message areavailable, to be signed by two keys: one key from an existing device that has permissions to add a device to the account, and the second key from the new device that is being created. The message would be generated by the existing device and passed somehow to the second device in a private manner. The second device would sign the message and add it to the blockchain. The first signature are sufficient to validate the message & fee paid; the second signature would be included to confirm and activate the new public key. An additional optional confirmation message may be required to be added to the blockchain as a final step in order to force the original device to confirm that the acceptance was performed by the intended user or device.

In an embodiment, When the acceptance is performed by the new device, the device would add a hash to the message. This hash result of hashing a random 6-digit number, which 6-digit number would need to be entered into the first (original) device. The confirmation message added by the first device would contain a hash of this 6-digit number, which hash may need to match the hash originally added to the acceptance by the second device. The risk is that without this additional confirmation message, the acceptance may be hijacked by an unauthorized user who may add a private key surreptitiously. Forcing the number generated by the second device to be entered into the first device blocks a number of possible attack vectors. The requirement for a final confirmation message may be specified in the original “create” message signed by the original device; if the requirement is specified by the original device, then the “accept” may include the hash. In any event, however, if the confirmation hash is included with the acceptance (regardless as to whether the “create” message specified a requirement), then the new device may not be usable until the final confirmation is added to the blockchain.

In at least one embodiment, there are multiple different issues to be addressed, when there are multiple nonces within the same record. The issues go against all the three parties which are Constituent record creator, ARC record creator and also block-building node. When a user considers a single nonce, they may be to maintain a nonce manager for tracking offchain transactions so that proper nonces are used. As there are multiple senders involved, completion of tx is asynchronous in nature and nonce management becomes too messy and complicated to manage which may result in horrible UX.

The merchant may be able to authorize payment before finality based on a risk assessment made regarding the transfer. If the merchant has a high confidence that the sender may not try to double spend-or if negative balance configuration of the token may allow double spending to take place, in favour of the merchant, such that there is not a risk of the open transfer somehow failing, then the merchant may act as if the transaction is final, even if it are reorganized out of existence.

In at least one embodiment, the risk of the nonce value specified in the particle may collide with a separate transaction nonce. By this way, the sender may block an open transfer record from being added to the blockchain, even if there are sufficient funds in the sender's token ledger. The sender sends a blocking transaction to the blockchain simultaneously with the open transfer. A partial solution for open transfers may require confirmation not to contain a nonce. The nonce may only be specified for transactions that are immediately completed. The confirmation record may contain the sender nonce to prevent a replay attack. The problem with this is that while this may prevent the open transfer from being blocked, the open transfer confirmation is blocked, allowing the sender to stop the recipient from getting the money.

In at least one embodiment, the problem may be intractable, such that each transaction is at risk of being blocked in the event of a reorganization on a fundamental level. This means that the merchant may perform some kind of risk-rating with regards to each, in order to assess how likely a particular sender is to attempt a double-spend attack, given the amount of money that has been transferred.

In at least one embodiment, Smart contracts may be implemented in such a way to use internal logic within the smart contract itself to prevent the risk of a double-spend from occurring-rather than relying on a nonce (i.e. transaction counter). Such smart contracts may maintain an internal activity counter and require a nonce to be passed into each method invocation, or methods may be constructed in such a way as to be idempotent, whereby multiple invocations of the same method may result in the contract having same internal state as after only a single invocation. If such a smart contract is implemented, the author, when uploading the contract to the blockchain, may specify that the contract may be invoked without the use of a nonce (i.e. transaction counter) within an atomic transaction chain. This setting comprises to be a part of the record that is used to upload and register the smart contract which is “register SC” record should be implemented on the application side.

In at least one embodiment, the smart contract creator may take responsibility for declaring the smart contract capable of being nonceless or not, with default being nonce required. The point of this is to prevent replay attacks. If a smart contract author permits nonceless transactions, then it's possible that some users may use it in nonceless form and suffer a replay attack. If all smart contracts are nonceless, then any user may make the mistake of releasing a nonceless invocation, and then suffer a replay attack against any transaction.

In at least one embodiment, when a new transaction is evaluated, its transaction hash is looked up in the older Bloom filter. If a user is found in the Bloom filter, then the sender may choose a different nonce value for the transaction to avoid a collision, which may also force the sender to re-sign the transaction. However, if the Bloom filter is properly constructed, this may happen only a certain percentage of the time. The nonce selected may be any byte value; the nonce may not be any larger than a byte, and it may be sequential. Also, a client application may keep track of the Bloom filters and may only propose transactions that it verifies do not create collisions in the Bloom filter; even multiple off-line transactions are verified in this way while they remain off-line. When the transaction is accepted to the blockchain, its transaction hash is added to both Bloom filters. After it is added to the Bloom filters, it is impossible to replay that transaction without modifying the nonce and re-signing the transaction, up until the point when the block expires.

In at least one embodiment, the tokens are simultaneously moved out of the sender's token ledger, or, alternately, the tokens are kept in the token ledger, only to be moved when the open transfer is finalized. Again, this behaviour may be controlled by a Boolean configuration on the particle (probably a bitmap field to contain all the Boolean configurations). The WalletConfig record may be implemented over wallet accounts and devices. A record comprising an AUTH filter which may be applied over an account, called a wallet AUTH filter. AUTH Bitmap is required which won't depend on device and may be used to execute the evaluation of wallet AUTH filter on a particular record.

In at least one embodiment, the block-building node may be able to collect statistics not only for individual devices, but also for accounts as a whole. To maintain consistency, the configuration may be the same as with devices (bitmap, where the individual bits signify that the same data is being captured as is specified in the device bitmap). If an account is configured to collect a certain statistic, that statistic is collected regardless as to whether any devices are also collecting that statistic.

In at least one embodiment, configuration flag is included on wallet accounts, which configuration flag may allow third-party signatures to sign transactions, without automatically being rejected, even without the primary signature being one of the account devices. With such a configuration, an account signature may be validated using the auth filter, or the account may be wide-open and signed by anyone without any validation. Wallet accounts may have two modes of operation: auth-filter-oriented operation, and device-oriented operation. As long as the data objects pertaining to each type of operation are optional, and do not occupy space when the other mode of operation is in play, then this may be a low-cost or no-cost way of providing users the choice of defining their own authorization strategy via signature-checking auth filters, or using the more-optimized built-in approach of defined devices. To clarify, auth filters may still be in-use with the device-oriented approach, and they may be used to verify signatures in that case as well, but by convention wallet accounts that configure and store data pertaining to third-party signatures may be distinct from wallet accounts that use the multi-device functionality.

In an embodiment, creating a record in device activation incorporates a fee for including accept and confirm records. The confirmation message may only be valid if it refers to valid create and accept messages that are already on the blockchain. A confirm message may only be included on the blockchain if there is already a confirm and accept. The creator may have paid fees for its own inclusion. One additional possibility may be that the create also includes the fee for the inclusion of the accept, and the inclusion of the create. These separate fees specified may be extracted from the signing account, but may only be included in the block reward after the accept message (and then later, after the confirm message) is added to the blockchain. If the create and/or accept expire before the new device is finally activated, then the reserved fees are added back to the fuel ledger of the account in question. This approach may mean that a user creating a device may be presented with a single fee for the whole enterprise, rather than separate fees for everything. It may also mean that if a separate entity (say, a bank) were to pay the fee for creating a device on behalf of this account via an ARC, then the acceptance and confirmation may be performed directly by the new device without may be, included in an ARC. The complexity here may be that fee handling may escape the envelope/header and enter into the body of the record data, which may be different from what we are doing elsewhere. For this reason, doing this may not be a good idea.

In an embodiment, forcing the number generated by the second device to be entered into the first device blocks a number of possible attack vectors. The requirement for a final confirmation message may be specified in the original “create” message signed by the original device; if the requirement is specified by the original device, then the “accept” may include the hash. In any event, however, if the confirmation hash is included with the acceptance (regardless as to whether the “create” message specified a requirement), then the new device may not be usable until the final confirmation is added to the blockchain. Separate create and accept messages may be physically required if there is no way for complex encoded data to be shared between the user of the original device and the user of a second device that is being added to the account.

In further embodiments, to activate a device with a number of different handshaking processes: 1. A single create+accept message, signed by the existing device's key, passed privately to the second device (via QR code) and signed by the second (new) device, which keeps its new key to itself, and which posts the message to the blockchain. Activation is complete when the message is accepted by the blockchain. 2. A first create+accept message, signed by the existing device's key, passed semi-privately to the second device via email or SMS encoded in URL form, and signed by the second (new) device. When the create+accept message is signed by the second device, the confirmation hash may be added, and then the message may be added to the blockchain. However, the device is not usable until the original device adds the final confirmation message containing the confirmation hash. 3. A create message is generated by the first device, which may specify a new device and includes a new public key (or partial public key) for that new device; the message is added to the blockchain. The new public key is generated with a passphrase seed. The second device constructs an accept message using the passphrase seed+account information. After the accept message is added to the blockchain, the second device is usable, because no confirmation hash is required or specified within the create or accept messages. 4. As in process description 3 immediately preceding, a create message may be added by the first device, and an accept message may be added by the second device. However, in the original create message a confirmation hash is specified as being required, so the confirmation hash is added to the accept message. The 6-digit code is shared by the second device user and is used by the first device to generate the confirmation hash and to send the confirmation message to the blockchain.

In an embodiment, when the acceptance is performed by the new device, the device may add a hash to the message. The hash may be the result of hashing a random 6-digit number, which 6-digit number may be entered into the first (original) device. The confirmation message may be then added by the first device to contain a hash of the 6-digit number, which may be to match the hash originally added to the acceptance by the second device. 2. The risk is that without the additional confirmation message, the acceptance may be hijacked by an unauthorized user, who may add a private key surreptitiously.

### Nounces and Transaction Replay

In one embodiment pending transactions in a mempool expiration (which expiration should be included in the transaction hash. Also a need to have some maximum time-to-live constant that controls the maximum expiration block for each transaction. Transactions may not remain in the pool longer than this maximum time-to-live, T, which is a system-wide constant. Each account (or possibly, each device) may carry a pair of Bloom filters (or other probabilistic data structure). Each Bloom filter stores the transaction hash of all transactions that are sent by the account within a certain span of time 2T (expressed in number of blocks), and would reset to empty at the end of this period. The span of time covered by the two Bloom filters would be offset by time T, such that the older Bloom filter may always contain information about all the transactions for that account that may still be vulnerable to a replay attack-meaning, that still be re-added to the mempool because they are not yet expired. In one embodiment to avoid storing timestamps and block numbers within each account record, all accounts may reset their Bloom filters according to a unified schedule, which would be system-wide and based on block numbers which are multiples of T. The reset/deletion of the Bloom filters occur at the time that a transaction is processed for the account, by comparing the current block number to the block number of the last-processed transaction of that account; this would happen before the transaction is processed. By consulting the “recent transaction” list, the block number is determined in the last-processed transaction for the account.

In an embodiment, when a new transaction is evaluated, the transaction hash is looked up in the older Bloom filter. If the transactions are found in the Bloom filter, then the sender may need to choose a different nonce value for the transaction in order to avoid a collision, which would also force the sender to re-sign the transaction. However, if the Bloom filter is properly constructed, this may happen only a certain percentage of the time. The nonce may be any byte value; the nonce may to be any larger than a byte, and it wouldn't need to be sequential (although maybe it should be, see below). Also, a client application may keep track of the Bloom filters, and may only propose transactions that it verifies do not create collisions in the Bloom filter; even multiple off-line transactions may be verified in this way while they remain off-line. When the transaction is accepted to the blockchain, its transaction hash is added to both Bloom filters. After it is added to the Bloom filters, it becomes impossible to replay that transaction without modifying the nonce and re-signing the transaction, up until the point when the block expires.

In an embodiment, this is a generalized approach that may cover many interactive use cases for records that we are working with; it would work best with transfers, for instance. However, to ensure sequential execution of transactions, which is a requirement for some record types that pertain to over-writable settings. Settings changes would still need to carry a sequence number, so that a newer state may not be overwritten by an older state. When two transfers are executed out-of-order, if there is a large-enough balance to cover both transfers, the end result is the same; when two settings changes are executed out-of-order, however, the end result may be very different.

In an embodiment, a way that sequence ordering may be ensured is for the nonce to be selected sequentially by the client, only to be reset when all previously-pending transactions would have expired. With regards to multiple devices on the same account avoiding nonce collision, plan is to build and use a trick that is used in multi-master database replication to set ID numbers for database records. For this trick to work, however, we would need to decide on a constant maximum number of devices that may be configured per account

In at least one embodiment, if an auth filter is defined by a wallet account, the signature checking may be explicit, not implicit. (If the auth filter is not defined, then one signature from a device on the account is enough to authorize; meaning, it is implicit if the auth filter is not defined). Explicit authorization means that the auth filter checks that the signature is one of the signatures of the wallet account itself. If the signature is not explicitly checked, then transactions & records may conceivably be sent by anyone. If the auth filter checks signature before a transaction is approved, then the auth filter is used to implement multiple separate accounts having control over a shared account, by the shared account only checking signatures of the multiple accounts, not of itself. Also, N-signature approval is implemented in this way. Signature verification is structural validation, but signature matching to account is permanent validation, as is auth filter checking. This falls under that category.

In at least one embodiment, some records are validated against the Account auth filter only. Every record may be signed by a device of the sender account. That signature is validated first, and then the account auth filter may also be used to further restrict the authorization of each transaction. Rather than a two-part validation of (a) account signature; and (b) wallet auth filter, instead there may only be the validation of the wallet auth filter (b). This may allow account transactions to be signed/authorized based on a variety of factors, enabling a variety of authorization workflows, including multi-signature, but also including open wallets (which are re-used as pivot points within atomic transactions), faucets, rotating-access accounts, or anything else that may somehow be authorized using auth filters. The functionality may not be enabled by default. However, perhaps a configuration bit may be used (within a bitmap representing configurable Booleans for the account) to switch to this behaviour.

In at least one embodiment, the following are some use cases whereby this functionality may be used to generate NFT tokens using a generic NFT token as a base. A base “NFT” token type may have been issued to the network and one instance of this token is held by a particular EOA account. The account user wants to encode a particular asset they own—for instance, a fine art painting—as a specific token. The user holds one “NFT” base token in their account, and they are able to transform it into a token that represents the painting. This shall be done through an HTTPS call to the block-building node that sends a genesis record to the network.

In at least one embodiment, a smart contract is set up to control the minting of digital art NFTs that are algorithmically generated. A fixed number of “NFT” type tokens are passed to the smart contract, after which point no more base “NFT” type tokens are accepted. This ensures that there is a limited run of digital art. One function defined on the smart contract algorithmically generates a set of features for the new digital art and a random seed.

In at least one embodiment, A third-party purchaser (EOA or SC) invokes the generator function, which generates the feature description, and then in turn invokes the smart contract EXT genesis function for the new bearer derived token with the name “NFT>ART123”, passing in this features dictionary, minting a single instance. Finally, the generator function transfers the newly-generated “NFT>ART123” token to the purchaser account. The recipient (art owner) may then use the feature description (including the random seed) to generate the art work using an external off-chain server set up for that purpose. This off-chain server may validate the ownership of the art by validating the signature of the request it receives to the on-chain public key of the owner of the “NFT>ART123” token. The server would use the same signature-based HTTP authentication algorithm.

In at least one embodiment, various validation strategies are followed. Gas costing are statically determinable for both the validation stage and the execution stage. Validation gas costs are separately-calculable for every transaction, apart from execution gas cost, and both should be calculable during static evaluation. The flag exists on every transaction, which may allow the transaction to be valid on chain even in the event that the transaction, provided that both the execution and validation gas cost is sufficiently paid for by the transaction.

In at least one embodiment, Initial state-based validation is validation that happens in any event even if the “execute without validation” flag is set. Complete state-based validation, which executes the remainder of the validation, are validation steps subject to re-try based on block-building node configuration. When a conditional validation fails after the indicated number of retries are completed without success the failed transaction is added to the blockchain in a failed state. A minimum threshold is configurable on a per-block-building node basis, based on that block-building node's preference. If the statically determined validation cost is above the threshold, then the transaction may set the “execute without validation” flag to true, or the transaction fails static validation. If static validation fails, the transaction is discarded and not broadcast. The Initial validation includes fuel sufficiency.

In at least one embodiment, the fuel specified or user tokens specified for the gas purchase may be present in the sender's token ledger If user tokens are specified for the gas purchase, then either: (a) there may be offers on the order-book sufficient to convert the user tokens specified into some fuel amount or (b) the block-building node itself may be configured with some auto-trading capability to generate so that it is able to accept the user tokens as payment. In case If initial validation fails, the transaction is discarded. Complete state-based validation may only occur if the “execute without validation” flag is set to true, and if the validation cost threshold is not exceeded by the validation gas cost determined at the static validation stage. State-based validation should be completed before broadcast of the transaction. If conditional validation is handled synchronously, then if it fails the transaction be immediately discarded and not be broadcast.

In at least one embodiment, in case, if the event that the “execute without validation” flag is set to true, the full validation may nonetheless happen before execution; however, if validation fails, then the transaction may be added to the blockchain in a failed state. In the event that the transaction is subject to conditional validation, the block-building node may discard or include the transaction based on its own configuration. The block-building node configuration includes a retry configuration specifying how many retries that it may attempt before adding the transaction into the blockchain or discarding it. It is possible for the block-building node to be configured to perform zero retries, in which event it may drop any transaction that fails conditional validation with an add-to-blockchain-on failure block number in the future and may immediately add any transaction that fails conditional validation with an add-to blockchain-on-failure block number in the past.

In at least one embodiment, Structural validation is applied synchronously before adding to the mempool, and should include any evaluation that may be made only from the structure of the transactions & records. Permanent validation may be configured to be applied synchronously before adding to the mempool, or to only be applied immediately before executing the transaction (default would be to be applied synchronously). If it is applied synchronously, it would also have to be applied at the time of execution. Conditional validation may also be configured to be applied synchronously, but by default would only be applied at the time of execution. The retry logic is specified elsewhere.

If validation (excluding some conditional validation) occurs before broadcast, and if all computation costs that happen after broadcast (including some conditional validation) result in transactions being added to the blockchain, then DoS attacks are avoided, regardless of how high the cost of validation may be. An additional feature that may help in this may be if peers shared their validation cost threshold with each other, and if transactions were only shared if the transaction's validation gas cost is below the recipient's threshold.

In at least one embodiment, Transaction validation involves the following procedures

1. The checking transaction is replay protected across chains 2. checking transaction expiration 3. signature and public key validation 4. checking sender is not a SC 5. nonce validation 6.

record specific structural validation 7. transaction fee available 8. record specific state based validation 9. sender's account auth filter validation.

In at least one embodiment, Structural validation involves checking if all fields of a record are taking expected values. For example, token labels are alphabetic, bid and ask token values are positive etc. State based validation involves both permanent and conditional validation. Its purpose is to ensure if states of all accounts involved in processing of a given record are valid. To avoid spam/dos attack possibility core principle is as follows: Any transaction that may slow the network or cause it to fail if it is broadcast to the network in large numbers may impose a cost on the sender. The fee paid by the sender is collected whenever the expensive portion of the transaction is evaluated, even if the transaction fails.

In at least one embodiment, users may be to do the following to prevent dos attack on the protocol 1. Auth filter capping: system may to cap search operation both depth and breadth wise. This may ensure auth filter execution may not be too costly. To achieve this cap compilation time gas cost and/or size of list it operates on Limit constituent elements. In transfer record, during state-based validation, the system may not update the order book which is problematic as it may lead to multiple purchase orders processed against the same entry in order which is defined as transfer record validation.

In at least one embodiment, Max Validation Gas is which defines a new concept called validation Gas which may be updated for each constituent record used in validation and auth filter validation. If validation Gas exceeds maximum validation gas allowed, block-building nodes may not do validation at all. To calculate gas used during validation, there is a method which gets gas Cost for each record which may be slightly modified to separate static gas consumption and dynamic gas consumption. In purchase order/sale order, If tx fee token is same as bid token, during validation user may explicitly deduct tx fee from sender account and at the end of validation process if no errors occurs add tx fee back into the sender account so the state doesn't change. During validation users may Apply excluding Subroutine execution by adding a flag in context to determine if subroutine may be executed or not.

In at least one embodiment, It may be configurable whether to allow transactions to be broadcast when they are conditionally invalid. If this configuration is set to not permit such transactions to be broadcast while it is conditionally invalid, it may be broadcast after it is successfully retried and added to the blockchain. This setting may by default be configured to permit conditionally invalid transactions to be broadcast. These configurations shall prevent a denial-of-service attack from propagating over the network, although care may be taken to ensure that such settings may not contribute to the emergence of a network partition. A tit-for-tat strategy that is relatively forgiving should be employed so that peers do not stay disconnected for longer than is necessary to prevent propagation of denial-of-service data, and to ensure that only the true origin points of the denial-of-service attack are disconnected from the network as a result.

In at least one embodiment, this is done via “borrowing” against the atomic transaction itself, which is authorized via a flag on the atomic transaction. An atomic transaction that terminates with tokens still borrowed may be invalid at the point of termination, unless the atomic transaction is nested and the parent atomic transaction allows borrowing, in which event the borrowed ledger is transferred to the parent. All other validity constraints may retain current implementations unchanged.

In at least one embodiment, there are a number of places where arbitrary amounts of data are added to transactions. Some of these things produce side effects within the state db, which means that the storage economics system may presumably cause some of these fields to be limited in size. However records that fail may still be added to the blockchain, even if they do not affect state, for instance, if the record is inside an atomic transaction that allows partial execution, the whole atomic transaction may be added to the blockchain, including the constituent records that fail or that never execute. User data is unbound in the user data field of the transaction or record. Even if the transaction or record fully succeeds, this is unlikely to have any impact on the global storage DB. The constraints of storage economics may never come into play.

In at least one embodiment, there should be some manner for token ledger balances to somehow go negative during the execution of the atomic transactions, without causing the atomic transaction to necessarily fail, unless those ledger balances remained inappropriately negative at the end of the atomic transaction's execution. This should be done via “borrowing” against the atomic transaction itself, which is authorized via a flag on the atomic transaction.an atomic transaction that terminates with tokens still borrowed may be invalid at the point of termination, unless the atomic transaction is nested and the parent atomic transaction allows borrowing, in which event the borrow ledger is transferred to the parent. All other validity constraints may retain current implementations unchanged.

In at least one embodiment, there are two ways to implement trade order matching: deterministic, and block-building node controlled. Deterministic is simpler and may not require the implementation of settlement records. Block-building node-controlled are implemented in different ways by different block-building nodes, which conceivably may use different strategies in order to maximize their returns. Potentially both may be implemented: deterministic first, and then block-building node-controlled after.

### Trade

In at least one embodiment, each purchase order has at most one possible way of being matched to any sale order. Specifically, the purchase order is matched to the best-priced sales order(s) listed in the permanent order book. When a purchase order is processed, either it is fulfilled fully by the outstanding sales orders, or it may not be fulfilled at all. If it is fulfilled, the sales orders are retired in best-price-order until the purchase is fully satisfied. A partial fulfilment of the purchase order is not permitted; however, any sale order may be fully or partially matched with any purchase order or may be matched in combination with any other sale orders, provided that the group of sales orders represent the best prices currently added to the order book. No arbitrage may be possible. If the sales order does not specify the same token types specified in the matched purchase order, then a match may not occur. Both market and limit trades may be permitted: a market trade may simply settle at the price specified in the sale order; a limit trade may settle if the sales price is lower than the purchase price, with the spread benefit being given to the purchaser. This approach is deterministic, in that it is known exactly which sales orders may match the purchase order that is added to a block at a given moment. Always, the best-priced group of sales orders on the order book that satisfy the purchase order are chosen. The contents of the order book may be deterministically known based on the prior execution of records on-chain. Because this approach is deterministic, no explicit settlement record may be included with any purchase order, transfer, or fuel for-fees purchase that is performed. Any transaction that includes any trade operation requirement like these may be settled automatically based on the deterministic principle described above. As the records requiring trades execute, the outstanding sales orders are sequentially retired from the order book on a best-price basis.

In at least one embodiment, AMM pools are a common occurrence in blockchain ecosystems. Typically, AMM pools are built entirely using smart contracts, this creates a limitation whereby the information represented by AMM pools may not be used by the underlying L1 protocol. The underlying L1 protocol may not know what is happening inside the AMM without somehow peeking inside the smart contract. There are a number of useful data elements within an AMM that are potentially useful at the L1 layer. Specifically: The volume of tokens swapped By introducing a core L1 primitive implementing AMM concepts, the above information may potentially be extracted by the L1 protocol. There are two possible ways to implement such an L1 primitive: 1. The AMM smart contract may register itself as an AMM, complying with a pre-defined API that provides access to the desired information. 2. The AMM smart contract may instantiate L1 AMM pool objects, which low-level pool objects encapsulate and provide access to the desired information.

In at least one embodiment, there may be network connectivity providers that accept transactions from wallets, but under an arrangement in which neither the wallet nor the connectivity provider have any tokens to pay fees directly on the blockchain. Potentially, one or both of the wallet and the connectivity provider are paying a monthly subscription (presumably, paid off-chain via credit card or bank wire) to a subscription provider for a certain number of transactions to be processed by (i.e. added to) the blockchain. The following may be a technical implementation supporting this approach, every record may be sent by the wallet as an ARC with a null header, each record is then added to the mempool by the connectivity provider as an Atomic Tx with no fee. The subscription provider is watching the mempool for transactions signed by the connectivity provider the zero-fee atomic transactions are then picked up by the subscription provider (copied from the mempool).

In at least one embodiment, the subscription provider unpacks the Atomic Tx and re-forms it with the required fee added, the subscription provider adds the new Atomic Tx (which contains the original wallet ARC) to the mempool In my mind, this approach should already be possible in our system, but it may be tested. Network tests may be created that undertake this procedure, and to demonstrate the following assumptions to be true, If an atomic transaction contains an ARC with a header that does not point to any account. If an atomic transaction that pays a fee is added to the mempool at the same time as an atomic transaction that does not pay a fee (and may or may not have a different expiration block), and which also contains an identical ARC (literally the same ARC/Both atomic transactions may exist on the mempool at the same time to fee-paying atomic transaction may be accepted into the blockchain before the non-fee-paying atomic transaction. After the fee-paying atomic transaction is accepted into the blockchain, the non-fee-paying atomic transaction may be blocked from being executed due to nonce conflict in its constituent records/Once the conflict is detected, the non-fee-paying atomic tx may be dropped from the mempool.

In at least one embodiment, a block-building node account blacklist causes a block-building node to drop transactions involving certain accounts. This is possible for a block-building node's configuration to contain a list of accounts that are blacklisted by the block-building node. Any transaction that involves any such account may be dropped from the mempool by the block-building node. One way to implement this may be to encode this list as a Bloom filter, and only perform a direct lookup if the Bloom filter returns true indicating that the account is present.

In at least one embodiment, when a reorganization occurs, transactions that may otherwise have been discarded should be added back into the mempool. The new blocks may not contain the same transactions as the old blocks, so some transactions may no longer exist on the blockchain. Such transactions, if they have not yet expired, should not be discarded. Instead, they should be re-introduced to the mempool, so that they may possibly be added into future blocks (if they may compete in terms of priority with other transactions in the pool).

Validation of blocks and transactions after mining Separate from the above considerations (which pertain to new transactions that inhabit the mempool) may also address the question of how validations are performed on blocks after mining, when new blocks are being validated and accepted by other nodes in the network. In this case, static validation should also be run on every transaction within the block.

In at least one embodiment, the implementation happens as follows. The structural evaluation may be performed first. If the structural evaluation fails for any transaction in the block, then the block is invalid and is rejected. No transaction should be included in any block that is structurally invalid.

In an embodiment, the maximum load incurred by operations that iterate over collections is only knowable if the maximum number of iterations is knowable. By capping the total number of iterations, the maximum computational cost may be assumed for that operation, so that the cost may be calculated statically and used to price and prioritize any related transaction without executing any element of the transaction. There are two ways to cap the number of iterations.

In some embodiments, Firstly, in some cases, the operator may stop iterating after the limit is reached. The operator may simply operate on only the first N number of elements of the collection and leave alone any elements of the collection greater than N number of elements. Depending on the input type to the operator, the iteration limits (and statically computed maximum cost) are different. Secondly, in other cases, the actual data that is being passed into the iterator may be capped at the source. For instance, the number of elements that may be created at all may be limited, or the number of elements retrieved may be limited.

In some embodiments, the difference between a local, single-node DoS and a network-wide DoS attack is whether a problematic transaction is propagated or not. Any transaction that fully pays its fees may not be considered problematic, even if it fails. Any transaction that fully pays its fees may be welcome on the blockchain, even if the only change to the global state is the payment of fees. However, any transaction that may not pay its fees, or is otherwise invalid, may not be propagated across the blockchain. As long as this is true, a DoS attack shall be limited to the node directly receiving transactions from clients Other things may make a transaction invalid and unable to propagate. For some record types, a flag on the record data may decide whether a failed transaction is also invalid. Any block that contains an invalid transaction (as opposed to a failed transaction) is itself invalid.

In some embodiments, transactions may have an “allow invalid” flag, with a default value of false, which in one way may permit the transaction to be added to the blockchain even if it is invalid. An invalid transaction may be discarded from the mempool immediately, and may not be propagated across the network, unless the flag is set to true. If the flag is set to true, the transaction may be propagated, and it may be added to a block whether it is valid or not.

In some embodiments, auth subroutines may not be evaluated at the permanent validation level, due to the potential expense incurred through their execution. Auth subroutines may be completely paid for by the transaction's gas purchase, and therefore may be evaluated at execution time only. Any auth subroutine failure may result in the transaction being added to the blockchain in a failed state. Any execution-time failure that is not deemed invalid at the structural, permanent or conditional validation stages may result in the transaction being added to the blockchain in a failed state. The most important example of this is that any atomic transaction that succeeds in passing the initial validation may be added to the blockchain, even if some portion of the atomic transaction fails validation at execution time, or the whole atomic transaction fails. Some portion of the “conditional validation” failures are added to the blockchain in a failure state, rather than simply being discarded. The determinations of the question are an assessment of the computational overhead of the conditional validation step.

In an embodiment, the transactions added to the blockchain in the “failed” state may effectively be deemed “passing” conditional validation after the last retry failure, and may proceed to inclusion in block building. In block building, the conditional validation failure may prevent the global state being changed, except for the gas consumption. The transactions that may not be added to the blockchain in the “failed” state may be discarded after the last retry failure. Because correctly identifying the discrepancy may track the state change between the fee consumption and the purchase execution, it is not possible to do at the permanent validation stage. Any validation that may prevent a transaction from being added to the blockchain at all effectively causes the protocol to consider any block that contains the invalid transaction to itself be invalid and outside the scope of the protocol.

According to various embodiments, a system may limit the number of items in every individual array that an auth filter may iterate over, in order to define a hard limit to the computational overhead of every auth filter. A potential alternative to the, however, may be to allow arrays to be of arbitrary size, while limiting the number of elements that may ever be evaluated. The global approach may be an alternative to defining a custom max length for each possible array that may be included in the auth filter context on a case-by-case basis. If each possible array has a different maximum length, the gas cost calculator may have to have an awareness of each separate array's maximum length. A global approach (same max number of iterations no matter the array being used) may simplify the gas cost calculation for auth filters. A third alternative may be to use a mixture of these approaches: a global maximum, but then some specific arrays that have different limits, defined as exceptions.

In an embodiment, the applications are standardized such that each application defines a “pendingCleanup account, block)” function that returns a list of pending jobs of an account that may be executed as of the indicated block. The applications then implement the applyCleanUp function that may accept a pending job and apply that job to the global state. The pending job implements a standard interface that may allow it to be ordered deterministically among all such jobs emitted by other applications. Upon the retrieval of an account, the various pending cleanup functions may be invoked for each application, and the pending jobs returned may be ordered and executed (with the account being updated) before the account is returned.

In an embodiment, there are different classes of statistics that may be collected. Different collection categories may be controlled by a different Boolean on the device configuration. If the Boolean is set to false, the statistic may not be collected. Total value sent (3-month, month and day) Total value received (month and day) Total value spent, including trades, rewards, and fees paid (month and day) Total number of transfer records sent (3-month, month and day) Total number of transfers received (month and day) Total number of account configuration records (month and day) and the total number of transactions (month and day).

According to various embodiments, the instance of token (if non-fungible, and maybe also if fungible) may carry a local state within the account where it is represented. Something like a nested data-structure that is carried by the token. The genesis record & configuration may carry a schema that defines the shape of what that local state may be (potentially optional, so that the state may potentially be restricted or unrestricted) When a token is transferred (although, not traded, as these tokens may be non-fungible), it carries to the new account's token ledger the same state that it held in the prior account's token ledger. Transformations to the state may be performed by the owner of the token. But those transformations are restricted by state transition rules attached to the genesis record.

In an embodiment, state transitions may be performed by sending a record that knows how to make the modification. The record type may accept some kind of transformation instruction that may affect the nested data structure of the transaction. The token auth filter may be built to encode the valid state transitions, rejecting the state-modification transaction if it does not conform to the intended rules of the token. Alternatively, some specific transition functions may be implemented on the auth smart contract that is registered with the token, which may be explicitly called in order to perform the transformations on the data. Possibly, the token may be sent to the transformation sub-routine, which may then transform the token and send it back. Alternately, the transform/modification record may somehow be told to execute the transformation sub-routine on the token, and that subroutine may somehow have the permission to operate on the data of that token only within the context of that transformation. Within the implementation, the transform/modify record may transfer the token temporarily to the auth smart contract, and then after execution transfer it back.

In an embodiment, there may be network connectivity providers that accept transactions from wallets, but under an arrangement in which neither the wallet nor the connectivity provider have any tokens to pay fees directly on the blockchain. Potentially, one or both of the wallet and the connectivity provider are paying a monthly subscription to a subscription provider for a certain number of transactions to be processed by the blockchain.

According to various embodiments, the following may be a technical implementation supporting the approach, every record may be sent by the wallet as an ARC with a null header, each record is then added to the mempool by the connectivity provider as an Atomic Tx with no fee the subscription provider is watching the mempool for transactions signed by the connectivity provider the zero-fee atomic transactions are then picked up by the subscription provider the subscription provider unpacks the Atomic Tx and re-forms it with the required fee added The subscription provider adds the new Atomic Tx (which contains the original wallet ARC) to the mempool. If an atomic transaction contains an ARC with a header that does not point to any account (null header), then the ARC may be extracted from the atomic transaction and added to another atomic transaction. If an atomic transaction that pays a fee is added to the mempool at the same time as an atomic transaction that does not pay a fee (and may or may not have a different expiration block), and which also contains an identical ARC (literally the same ARC).

According to various embodiments, the atomic transaction is accepted into the blockchain, the non-fee-paying atomic transaction may be blocked from being executed due to nonce conflict in its constituent records Once the conflict is detected, the non-fee-paying atomic tx may be dropped from the mempool.

### Atomic Transactions

One embodiment explains how any transaction that may slow the network or cause it to fail if it is broadcast to the network in large numbers may impose a cost on the sender. The fee paid by the sender may be collected whenever the expensive portion of the transaction is evaluated, even if the transaction fails. Some important principals that should be embraced to ensure are Structural validation and permanent validation steps may never be so expensive that a high volume of transactions would bring down the network. As an example, auth filters may be executed at the permanent validation phase, so the execution expense of auth filters are capped. For instance, any searching performed in auth filters, and any list operations, may be capped so that there is a maximum cost of such operations. Although auth filter failure may not incur a cost for the auth filter transaction, but still gas costs to discipline the creation of auth filters. List and search operations may be capped (meaning, no lists larger than x or searches more than y elements), so that a maximum gas cost may be calculated. Whenever the gas of the auth filter is evaluated, h operations assumed to have the maximum cost. If such gas calculations are accurate, system may impose a maximum total gas cost on auth filters, limiting their complexity by limiting the total cost such a filter may incur, and further reducing the spam risk of expensive auth filters.

Another an embodiment explains whether purchase orders may be added to the blockchain if they ultimately fail. This largely depends on whether it is expensive to check if a purchase order may be matched or not. Depending on how expensive it is to reject an out-of-the-money purchase order, maybe such transactions may be discarded at the conditional validation stage without being for them to be added to the blockchain when they ultimately fail. One situation that has come up previously in conversation is the case where the fees of a purchase order transaction and the purchase order itself are paid for by the same tokens (such that the total tokens used exceeds the tokens of the sender account). Because correctly identifying the discrepancy may track the state change between the fee consumption and the purchase execution, it is not possible to do at the permanent validation stage. Whether the discrepancy may even be detected at the conditional validation stage depends on whether there is some state-modification tracking at the conditional validation stage. If there is no state tracking available in any validation stage, then these transactions may be added to the blockchain at the execution stage in an invalid state, with the fees consumed by the block-building node.

Another an embodiment explains how transactions that fail permanent validation may not be broadcast across the network, even if the permanent validation is not performed at the API level and is performed. Any validation step that is expensive enough to bring the network down at high volume may be implemented either as part of conditional validation or transaction execution. For instance, auth subroutines may not be evaluated at the permanent validation level, due to the potential expense incurred through their execution. Auth subroutines may be completely paid for by the transaction's gas purchase, and therefore may be evaluated at execution time only. Any auth subroutine failure may result in the transaction being added to the blockchain in a failed state. Any execution-time failure that was not deemed invalid at the structural, permanent or conditional validation stages may result in the transaction being added to the blockchain in a failed state.

In at least one embodiment, an attacker sends many expensive transactions that may use computational resources without paying any fee, overwhelming the network. Two specific examples of this are as follows: An atomic transaction that is statically valid-meaning that each individual element is valid at the time of initial validation, but where the individual elements become invalid due to the execution of the whole atomic transaction at the time it is to be added to the blockchain. A transaction that triggers an auth subroutine that engages in a very expensive computation routine. This may consume gas purchased with the transaction—but only if the transaction is added to the blockchain so that the gas payments are collected.

In at least one embodiment, The fee paid by the sender may be collected whenever the expensive portion of the transaction is evaluated, even if the transaction fails. Some important principles that should be embraced to ensure that the above is true are as follows: Structural validation and permanent validation steps may never be so expensive that a high volume of transactions may bring down the network. As an example, auth filters may be executed at the permanent validation phase, so the execution expense of auth filters may be capped. For instance, any searching performed in auth filters, and any list operations, may be capped so that there is a maximum cost of such operations.

In at least one embodiment, auth filter failure may not incur a cost for the auth filter transaction, users still want to use gas costs to discipline the creation of auth filters. List and search operations may be capped (meaning, no lists larger than x or searches more than y elements), so that a maximum gas cost is calculated. Whenever the gas of the auth filter is evaluated, such operations may be assumed to have the maximum cost. o If such gas calculations are accurate.

In at least one embodiment, as part of the validation process of different transactions should be performed, if the transactions originate from the network as a whole. The origin of a transaction is described as the peer node that each transaction in the pool originates from. As network-originating transactions are validated, statically invalid transactions should be counted, with a rolling tally being kept for each peer. Any peer that produces too many invalid transactions (or too high a proportion of invalid transactions) should be rate-limited or disconnected, according to the configuration. Depending on the setting, a disconnected peer may be re-connected on a probationary basis, a certain number of times, before it is permanently disconnected if it is a repeat offender.

In at least one embodiment, another setting may control a minimum gas price to accept transactions from network peers (which configuration may be different from the minimum gas price specified for transactions directly added to the pool by the block-building node itself via its console or HTTP network API). In addition, a peer blacklist should be maintained in-memory. The automatic permanent ban may place a peer on this blacklist, which may be updatable manually by the user. To prevent a block-building node from being rate-limited or disconnected from its peers, it should be configurable within the block-building node config (i.e. not requiring recompilation) as to whether the block-building node may broadcast statically invalid transactions. No structurally invalid transactions may ever be broadcast by the block-building nod. It may be configurable to allow transactions to be broadcast before state-based validation is performed; however, if a transaction is found to be permanently invalid vis-a-vis state-based validation, it may not be broadcast. This configuration may by default be set to require state-based validation to execute before transmission.

Alternative of p2sh Account

In some embodiments, users shall create an atomic record chain with the following elements, and share it in any public forum. The first element is an anonymous header, configured with all-or-nothing set to True. The second element is a standalone auth filter (no account, no token transfer) that evaluates to true if account. A third party that may discover the ARC may then construct an atomic transaction with the following features, which it may then potentially add to the blockchain. A header that points to the account of the third party account B. The header also contains an all-or-nothing setting of Truc. The second element is a transfer of more than N instances of token X from account B to account A. Third element is an atomic record that wraps the ARC that was created by account A. A fourth element is a transfer of M instances of token Y from the p2sh account of the third element of the sub-chain into account B When the atomic transaction is added to the blockchain, it may be valid because the tokens transferred from account B to account A may satisfy the second element of the sub-chain.

In another embodiment, the standalone auth filter is satisfied, the p2sh transfer is allowed to happen. The p2sh account then is the source that is used by the final element of the outer chain in order to receive the tokens. Of course, the auth filters/subroutines of the token types involved, and of the accounts involved, may also be satisfied. The wallet/EOA account that creates the initial ARC may actually limit the types of transfers it may receive, for instance prohibiting certain types of originating accounts based on their annotations. Due to the all-or-nothing settings on the ARC headers, a failure to satisfy an auth filter or subroutine may result in the whole thing failing (auth filter may result in a failure before chain inclusion, auth subroutine may result in a failure after chain inclusion).

In an embodiment explained, the key concept here is that any transaction that is discarded in the validation stages, if it were included in the blockchain in a failed state, would cause the block to be invalid. Any validation that prevents a transaction from being added to the blockchain at all effectively causes the protocol to consider any block that contains the invalid transaction to itself be invalid and outside the scope of the protocol. In addition to the above, it may make sense to implement some kind of blacklist system that would cause the block-building node to protect itself from spam attacks. Users shall create a separate ticket to track the consideration of that concept, which may be a protocol-independent solution, and optional, unlike the above.

In at least one embodiment, it's possible to access the key-value store data of the object from inside the auth filter of the object. These key value-store variables are used as an alternative to hard-coding data within the auth filter. If there is less may be to include hard-coded information inside auth filters, then it may be possible for auth filters to be hard-coded on the application side and re-used across a variety of separate wallets, tokens and atomic transactions without any variation. This has a few benefits. First, if a hash of the auth filter is stored or calculated, the hash is used as a cache index for precompiled auth filters loaded into memory, speeding up execution. More importantly, the auth filter hash of one object is referenced by the auth filter of another object and is used to verify that the given object implements certain required permissions. The token filter may restrict transfers, so they only happen inside auth filters, and so that the auth filter of the atomic transaction matches a prespecified hash. The royalty payment itself may be verified in the atomic transaction auth filter. A particular token may verify that any wallet account it interacts with implements proper social recovery, and proper restrictions on reconfiguration, to ensure that statistics are always kept (with wallet auth filter not permitting statistics collection being turned off). The token auth filter may verify the hash of the Wallet auth filter, to ensure that it matches the required standard. The token filter may also restrict transfers that exceed certain usability thresholds.

In an embodiment, a generalized approach to the permissioning architecture system-wide, among the three object types that form the basis of that architecture. There are reusable struct types that may implement the key-value storage in a way that may be re-used among all three things. The struct type may encapsulate encoding and decoding functionality, and add/modify/delete functionality within its own methods. The Atomic header may contain an instance of the struct, as well as the account data of the Wallet and of the Token. In all cases, it may be possible to access the key-value store data of the object from inside the auth filter of the object. These key-value-store variables may then be used as an alternative to hard-coding data within the auth filter.

In some other embodiment, If the first record of the ARC that has All Or Nothing set to false, is successful, then ARC may be considered successful. While implementing validation based on mutating a copy of state, this seems to create an issue, because the execution may take multiple path ways depending on which of the constituents in All or Nothing==False ARC have executed. Suppose in the outermost ARC, there is an ARC that has all or nothing set to false, and some other records. And the nested ARC contains records r1, r2, r3, r4. If r1 fails, the case is simple: the inner ARC is a failure and so is outer ARC. Suppose that r1 doesn't fail and r2 may possibly fail then we may not know if r3 and r4 may be executed. Depending on the actual execution, the state available to other records may be different. So there may be no way to validate the outermost records with proper state (The objective was to generate proper state for validation).

In some other embodiments, Atomic Transactions may have 3 modes: First being All-or-nothing, where any failure reverses state for the whole chain. Second is the Halt-on-failure: with any failure, reverse the failing record state, but keep all preceding state transitions, but if any one record fails, only reverse the state for that one failing record, keep the state transitions of previous successful records, and continue attempting to execute the remaining records.

### DoS Protection

In some other embodiments, the difference between a local, single-node DoS and a network-wide DoS attack is whether a problematic transaction is propagated or not. Any transaction that fully pays its fees may not be considered problematic, even if it fails. Any transaction that fully pays its fees may be welcome on the blockchain, even if the only change to the global state is the payment of fees. However, any transaction that may not pay its fees, or is otherwise invalid, may not be propagated across the blockchain. As long as this is true, a DoS attack shall be limited to the node directly receiving transactions from clients Other things may make a transaction invalid and unable to propagate. For some record types, a flag on the record data may decide whether a failed transaction is also invalid. Any block that contains an invalid transaction (as opposed to a failed transaction) is itself invalid

In some other embodiment, a system may limit the number of items in every individual array that an auth filter may iterate over, in order to define a hard limit to the computational overhead of every auth filter. A potential alternative to the, however, may be to allow arrays to be of arbitrary size, while limiting the number of elements that may ever be evaluated. The global approach may be an alternative to defining a custom max length for each possible array that may be included in the auth filter context on a case-by-case basis. If each possible array has a different maximum length, the gas cost calculator may have to have an awareness of each separate array's maximum length. A global approach (same max number of iterations no matter the array being used) may simplify the gas cost calculation for auth filters. A third alternative may be to use a mixture of these approaches: a global maximum, but then some specific arrays that have different limits, defined as exceptions.

In some other embodiments, the maximum load incurred by operations that iterate over collections is only knowable if the maximum number of iterations is knowable. By capping the total number of iterations, the maximum computational cost may be assumed for that operation, so that the cost may be calculated statically and used to price and prioritize any related transaction without executing any element of the transaction. There are two ways to cap the number of iterations.

### Miner Scripts

In an embodiment, a block-building node may wish to prioritize certain transactions to be included in the next block before any other transactions are added. For instance, the block-building node may wish for a specific smart contract to be executed, or for a specific series of sale and purchase orders to be matched. The block-building node may wish for certain transactions to be added to the mempool and included for broadcast, or the block-building node may wish for certain transactions to be added directly to the next block that the block-building node may build. So, two sets of javascript-accessible functions may be available: one set of functions that instantiate records for addition to the mempool and broadcast, and another set of functions that instantiate records that are intended to preempt the transactions that may be taken from the mempool when the next block is built. The records that are intended to be added to the next block that is built may be added to the block before any transactions that may be taken from the mempool. However, those transactions may only ever be added to the blockchain if the block-building node itself builds the next block that is accepted by the rest of the network. If these block-building node-priority transactions are not accepted to the blockchain (i.e. if the block containing these transactions that is built by the block-building node is not accepted by the network) then these priority transactions may simply be discarded. Any record or transaction type may be constructed and added to the priority list for the block-building node. The next block mined by that block-building node may take all the transactions from the priority list (up until the gas limit) before drawing from the mempool.

In an embodiment, it is trivial for a block-building node's controller/host to script the block-building node's behavior to some extent for each block that is being created. The capability may be implemented in the form of a javascript file that is automatically loaded and executed by the block-building node at the beginning of the block-building process, before the block-building process kicks off. The file may have access to all console functions. The script may not interfere with the block-building process itself, per se, but if used in combination with console functionality described in block-building node-550 Resolved it may be used to control the inclusion of certain records into the next block. Alternatively, the functionality may be used to modify dynamic configuration elements of the block-building node before the mining process begins. If a network API is provided to the console (for instance, the JS fetch API, or similar), then the block-building node script may pull in data from external sources as well. A more comprehensive strategy beyond the execution of a script at the beginning of the block-building process, other phases of the block-building or reorganization lifecycle may also be made scriptable in the fashion, by defining lifecycle callbacks that on a customized basis are able to manipulate the block-building node environment, or which may manipulate data elements of the block being mined. For instance, a callback within the block-building node script may be used to control the allocation of the block reward to different accounts based on certain logic (for instance, in a pooled block-building node scenario). Or a script may be used to manipulate the ordering of transactions in the mempool; conceivably, the mempool itself may be implemented within JS, which may be invoked via the pool interface.

### AMM Idea

In an embodiment, users may define pseudo-tokens called “space”. The “space” tokens represent available storage units on a 1-to-1 basis. Space tokens represent available space that has not been used. Users define an initial allocation of these tokens (representing initial available space) and a growth rate per block (storage growth per block). Users may use a standard AMM curve, and standard AMM functionality, the difference being that it is implemented in Go, instead of Solidity. Also, the object is not publicly accessible, in the sense that users are not able to directly use it to buy and sell space tokens. When a new transaction may be processed, the following happens: A storage requirement is calculated, expressed in storage units The gas requirement in order to purchase the correct number of space pseudo-tokens is determined. If space is being freed up, gas is returned, so the operation is basically as a negative gas requirement. An additional storage surcharge is calculated for purchases (some percentage or multiple of the gas price calculated by the AMM). The gas surcharge disincentivizes people from wastefully occupying space if they are only planning to free it up when space is more expensive later on. When the transaction is processed, the required number of storage tokens are purchased from the AMM using the gas. The gas is added to the AMM, and the space is removed, just as any swap performed using an AMM. As a result, the price of storage goes up relative to gas. The gas consumed is part of the total gas consumption of the block, and is subject to the block gas limit. All the fuel used to pay for the total gas is paid to the block-building node. The AMM actually holds only the gas used to purchase the space pseudo-tokens; it has a gas tracker as well as a space tracker. The space tokens that are sold are immediately used up/burned in the processing of the transaction, because of the additional storage space the transaction may vary.

In another embodiment, if the transaction fails in a way that does not require additional storage to be used, no AMM transaction takes place. More importantly, if the transaction being undertaken results in a net reduction in space utilization, this brings new space pseudo-tokens into existence, and the space psuedo-tokens are swapped for gas via the AMM. The gas returned (i.e. negative gas) is then applied to the transaction, to reduce the gas requirement of the transaction. If the total gas requirement of a transaction is net negative as a result of the transaction not consuming the full gas released when storage is freed up, then that negative gas may be used by the block-building node to increase the size of the block. The fee of such a transaction may effectively be negative; the average gas price of the block may be used to assign some of the reward tokens to the sender of the negative-gas transaction. In the event that the negative-gas transaction is created as MEV, there may be a mechanism for the block-building node to increase its earnings on the block by filling it with some additional transactions that mayn′t otherwise fit in the block. As long as the block-building node is the sender of the negative-gas transaction, the block-building node's earnings if it includes the transaction are higher than if it doesn't. As storage is consumed, the AMM collects a larger and larger balance of gas. Like any AMM, this causes the cost of storage to go up over time. However, the trend is counteracted by the increase in storage that takes place each block. The new space pseudo tokens created by each block are all added to the AMM directly, pushing down the exchange rate. The new space pseudo-tokens do not purchase gas; rather, they are added directly to the AMM's storage token balance, which has some impact on the pricing. Note that most AMMs only allow liquidity providers to add liquidity by adding proportional amounts of both tokens such that the exchange rate is maintained. Space pseudo-tokens may never be destroyed (although the growth rate may go down over time). The number of space pseudo-tokens plus the amount of actual storage used by the system may equal the maximum available storage that is available if it were fully utilized. Gas units measure compute, not Fuel tokens. Fuel tokens are used to purchase gas units, and gas units are priced in terms of Fuel tokens, but there is no predictable price that expresses the relationship between them. As discussed in another comment, if they were not independent from each other, speculative interest in Fuel may potentially cause compute to become less expensive.

In an embodiment, Users may still have to pay dynamic fees based on the demand. In order to accommodate that, users may instead have gas prices defined over AMM curve for each resource, For suppose there are two different resources, execution and storage, it is advisable to restrict each resource. Users may still pay the old TxFee mentioned in the transaction. Transaction may only be valid if TxFee is greater than the PriceOfExecution*totalgascostExection+gasPriceOfStorage In order to be predictable we may have the following properties on prices: they may be the same in the whole block if the resource usage is capped per block, their variation across may also be limited. (Like one may predict that at max 20% increase in next 10 blocks in the worst case).

According to one aspect of an embodiment, the transaction counter is a necessary feature to prevent replay attacks. The transaction counter for an account-device increases by one each time an account-device generates a transaction, and that forces all transactions that an account-device may generate to be executed in sequence. The same transaction may not ever be re-used more than once. When tokens are first sent to an account that didn't exist before, the default account-device is created, and the transaction counter for that device is set at zero. Furthermore, the account-device may have an identifier that is a hash that incorporates the hash of the transaction that creates that device. Even if effectively the same account-device is re-created, it mayn′t have the same source hash. Therefore, removing a device and recreating the device may not permit a replay-attach to happen. However, if the approach were not followed, a replay attack may happen if a device were deleted and re-created. If an account were deleted, which may happen after its balances went to zero, and after all but one of its devices were removed, then the global state may no longer retain any knowledge of any transaction counter related to that account. If an account is deleted, and then some tokens are re-sent to that balance, then the account may be recreated, with a transaction counter reset to zero. If the initial transaction counter is tied to the account-device, and if the account-device has an identifier derived from the transaction that was sent to that account to reinstantiate the account, then that account is not susceptible to a replay attack, even if it had been deleted previously. Any past transactions that send out of that account may reference a device identifier that no longer exists, and may not be valid or executable given the new state.

In one embodiment, there are other risks of deleting accounts: 1. If an account is deleted, with all devices deleted, then if anyone sends to that account, the public key may be reset to the original public key that originally corresponded to that account. If that public-private key pair was discarded due to public key cycling (and key cycling is most likely not optional in the case of post-quantum cryptography), then the private key may have been discarded and the tokens may not be retrievable. 2. Even if the original private key was retained (which may likely not be possible if a secure enclave was used, and may be unadvisable in the case of post-quantum signature schemes), any long-lived key may be assumed to be less secure. 3. If someone holds an account address from a contact and sends to that contact's address after the address has been deleted on-chain, then the other person may not have access to the funds. The sender may have no idea that the transaction had been deleted. It may be better if the sender experienced explicit failure after So, either complete deletion may not be possible (even if the account data is deleted, some rump placeholder are be left to illustrate that the account has been abandoned), or accounts may be explicitly created with completely random keys that do not correspond to any signature, and may be to exist before receiving any transfer (any attempt to transfer to an account not yet created may fail). There is a space-saving advantage for deleting accounts, and for incentivizing account deletion (perhaps, account-device deletion may also be incentivized). It improves the long-term viability of the system.

In one aspect of an embodiment, the user gives pending transactions a mempool expiration to know how long a particular transaction may be replayed. Also, there are some maximum time-to-live constant that controls the maximum expiration block for each transaction. Transactions may not remain in the pool longer than the maximum time-to-live, T, which is a system-wide constant. Each Bloom filter may store the transaction hash of all transactions that are sent by the account within a certain span of time 2T (expressed in number of blocks), and may reset to empty at the end of the period. The span of time covered by the two Bloom filters may be offset by time T, such that the older Bloom filter may always contain information about all the transactions for that account that may still be vulnerable to a replay attack which is defined as that still be re-added to the mempool because they are not yet expired. At the time that the older Bloom filter resets, In order to avoid storing timestamps and block numbers within each account record, all accounts may reset their Bloom filters according to a unified schedule, which may be system-wide and based on block numbers.

In another aspect of an embodiment, the reset/deletion of the Bloom filters may occur at the time that a transaction is processed for the account, by comparing the current block number to the block number of the last-processed transaction of that account which may happen before the transaction is processed. By consulting the “recent transaction” list, it may be possible to determine the block number of the last-processed transaction for the account. When a new transaction is evaluated, its transaction hash is looked up in the older Bloom filter. If it is found in the Bloom filter, then the sender may be to choose a different nonce value for the transaction in order to avoid a collision, which may also force the sender to re-sign the transaction. However, if the Bloom filter is properly constructed, they may happen only a certain percentage of the time. The nonce selected may be any byte value; the nonce may not be any larger than a byte, and it may not be sequential. Also, a client application may keep track of the Bloom filters, and may only propose transactions that it verifies do not create collisions in the Bloom filter; even multiple off-line transactions may be verified in the way while they remain off-line. When the transaction is accepted to the blockchain, its transaction hash is added to both Bloom filters. After it is added to the Bloom filters, it becomes impossible to replay that transaction without modifying the nonce and re-signing the transaction, up until the point when the block expires. The is a generalized approach that may cover many interactive use cases for records that we are working with; However, it may not be able to ensure sequential execution of transaction, which is a requirement for some record types that pertain to over-writable settings. Settings changes may still may be to carry a sequence number, so that a newer state may not be overwritten by an older state. When two transfers are executed out-of-order, if there is a large-enough balance to cover both transfers, the end result is the same; when two settings changes are executed out-of-order, however, the end result may be very different. One way that sequence ordering may be ensured is for the nonce to be selected sequentially by the client, only to be reset when all previously-pending transactions may have expired. With regards to multiple devices on the same account avoiding nonce collision, we may potentially use a trick that is used in multi-master database replication to set ID numbers for database records.

In an embodiment, for example, let's assume that the number is eight (8). The idea is that the device number may be used to offset the index number chosen. Device one may have the index numbers 0, 8, 16, 24, . . . available to it. Device two may have the index numbers 1, 9, 17, 25, . . . available to it, etc. The nonce may be selected in this way as generalized behavior, and all record types may rely on the Bloom filter approach to prevent replay attacks. Certain records may further rely on the actual ordering of the nonce in order to determine sequence validity, with a logic that decides that a record is invalid if the most recent re-configuration was transmitted within the same expiration time window T, and if the sequence number is out-of-order with the most recent re-configuration record.

### Web Services API

In at least one embodiment, another setting may control a minimum gas price that may accept transactions from network peers (which configuration may be different from the minimum gas price specified for transactions directly added to the pool by the block-building node itself via its console or HTTP network API). In addition, a peer blacklist may be maintained in-memory. The automatic permanent ban is placing a peer on this blacklist, which may be updatable manually by the user. Each IP address in the blacklist is specified along with a subnet mask, in order to permit the user to ban certain subnets or networks from establishing a peering connection. In order to prevent a block-building node from being rate-limited or disconnected from its peers, it may be configurable within the block-building node config (not requiring recompilation) as to whether the block-building node may broadcast statically invalid transactions.

### Boom Filter and Double Spend Protection

In at least one embodiment, if nonces are required of the records within the transaction, then the interaction between the entities may be synchronous, or at least may have a short timeout. Both parties may exchange the final signed atomic transaction at the end, and both parties are in a position for adding the transaction chain at the end. The problem is that if the record is re-signed, then it may have a different signed hash. Up until the moment that the original keypair expired both transactions may conceivably be executed, resulting in a double spend. Because the transaction resigning may happen long before the original key pair may expire, the window for such a double spend may be very large. In order to prevent this, there may be a way to somehow replace the previous version of the transaction with the newly re-signed version.

In at least one embodiment, the system may use the unsigned hash as the back-reference within an ARC. By using this multiple accounts are used to sign various records within an ARC, by which entity that has rotated its key may re-sign its records in the ARC. By using the unsigned hash for the back-reference, a change in the signature of one of the early records may not invalidate the back references of later records. Up until the moment that the original keypair expired both transactions may conceivably be executed, resulting in a double spend. In this particular case all other constituents too also may have signature updates or some other content changes.

In at least one embodiment, from this description it looks like nonce may be maintained by the passive party, constituents may set an expiry time if there is any risk of blocking. The system may need to mention his nonce to stop any malicious record construction by ARC than he agreed with. This statement, both parties may exchange the final signed atomic transaction at the end, and both parties may be in a position for adding the transaction to the chain at the end, is not compulsory and is determined by ARC signer. The constituent records which follow the user's constituent record may only be controlled by ARC signer. Only the order of the constituent records that come before a record are enforced that too because of the backreference not because of nonce. Maybe in most of the cases this might not be an issue, something to be noted.

### Storage Economics

In at least one embodiment, within an atomic transaction is possible to send to and receive from account numbers that correspond to abstractions within the atomic transaction. These account numbers may be mutually exclusive with any wallet or smart contact accounts, such that there is no ambiguity between them. In addition, there should be an account number that means “send to the block-building node's address, whatever it is as specified in the block header.

In at least one embodiment, the generalized approach to the permissioning architecture system-wide, among the three object types that form the basis of that architecture. There should be a reusable struct type that may implement the key-value storage in a way that is re-used among all three things. This struct type may encapsulate encoding and decoding functionality and add/modify/delete functionality within its own methods. The Atomic header contains an instance of this struct, as well as the account data of the Wallet and of the Token.

In at least one embodiment, block-building nodes and wallets may pull third-party trade order records (or multi-token transfers) from the network (I.c. from the transaction pool and from the permanent order pool) via available APIs, and match them. Such matched trade orders and transfers may be taken from the pool(s) and may not be re-used (transaction ids and nonces may be tracked). Such trade orders and transfers may be included in the blockchain as components of the settlement record transaction and may be discoverable as such. Signatures in the trade orders and transfers may be to match the source accounts of the trade orders and transfers, but may not have to match the account that generated the settlement record, which may be the same as one or more of the constituent components, or may be different. Matched trade orders may be “settled”, meaning the appropriate balances may be set in the relevant accounts per the trade order and transfer records. If there is an unmatched portion within one of the trade orders, then a replacement trade order may be generated and added to the pool (partial transfers may not be permitted, although multiple trade orders may be combined to satisfy the requirements of a transfer or trade order). This replacement order may reverence the settlement record, and the settlement record may reference this replacement order. The replacement order may share all the features of the original order, except the trade quantity may be reduced by the amount that was consumed within the settlement record. The replacement order may be signed by the same account as which generated the settlement record.

In at least some implementations, the fees attached to the replacement order may be reduced by whatever portion of the fees that might have been claimed cut the referenced settlement record. An open question is how the settlement record may lay claim to the fees found in a trade order that is being matched. One rule may be that a full exhaustive match (no remaining quantity) may cause the fees to be added to the settlement record, while none of the fees of the partial match may be added to the settlement record (so that the replacement order may have the advantage of all of the fees from that order). This way a block-building node or wallet may take advantage of arbitrage opportunities or create trade matches for trading pairs that are not frequently traded, by bridging trading pairs via an intermediary token.

In at least one embodiment, the behaviour may be optional for block-building nodes: they may not be obligated to perform these matches. Any functionality like this may be configurable and are disabled. Any block-building node that acts to generate trade orders and settlement orders that pull from the pools may effectively be acting as a wallet, proposing transactions to the network (or simply adding them to their local pool(s). The process of matching may be outside the block-building node protocol, although the protocol may include the recognition of and validation of settlement records and the constituent parts. The validation may to consult the permanent order book. Also, sale orders may not be matched by a settlement order; rather, a settlement order may be matched against another purchase order (ephemeral order), the permanent order book, or a combination thereof, but not against a sale order. The behaviour is distinct from other trade order and permanent order book matching operations of the block-building node which may not be configurable or optional in the mayonical implementation including matching trade order records with the permanent order book.

In at least one embodiment, transactions have an “allow invalid” flag, with a default value of false, which may permit the transaction to be added to the blockchain even if invalid, provided that enough fuel is provided to pay for the transaction, and provided that the signature is valid. An invalid transaction may be discarded from the mempool immediately, and may not be propagated across the network, unless this flag is set to true. It should be possible to configure tokens so that token balances may go negative.

In at least one embodiment, when high-priority transactions (typically, MEV transactions) are added to the high-priority queue in the mempool, those transactions might only be viable or meaningful in the current block being mined. It may be possible to indicate how long priority transactions in the mempool are viable. This may probably be accomplished through the use of the expiration block field on the transaction. Conversely, transactions added to the high priority mempool may be re-tried for multiple blocks up until they expire or are shown to be permanently invalid. Tests may be constructed to prove that this requirement is being met. block-building node scripts are able to call out to the network, so that remote web services may also be invoked programmatically from within the block-building node scripts.

In at least one embodiment, there should be some maximum time-to-live constant that controls the maximum expiration block for each transaction. Transactions may not remain in the pool longer than this maximum time-to-live, T, which is a system-wide constant. Each account (or possibly, each device) may carry a pair of Bloom filters (or other probabilistic data structure). Each Bloom filter may store the transaction hash of all transactions that are sent by the account within a certain span of time 2T (expressed in number of blocks), and may reset to empty at the end of this period. The span of time covered by the two Bloom filters may be offset by time T, such that the older Bloom filter may always contain information about all the transactions for that account that may still be vulnerable to a replay attack-meaning, that still be re-added to the mempool because they are not yet expired. In order to avoid storing timestamps and block numbers within each account record, all accounts may reset their Bloom filters according to a unified schedule, which may be system-wide and based on block numbers which are multiples of T.

In at least one embodiment, The reset/deletion of the Bloom filters may occur at the time that a transaction is processed for the account, by comparing the current block number to the block number of the last-processed transaction of that account; this may happen before the transaction is processed. By consulting the “recent transaction” list, it may be possible to determine the block number of the last-processed transaction for the account. When a new transaction is evaluated, its transaction hash is looked up in the older Bloom filter. In case if a user is found in the Bloom filter, then the sender may be to choose a different nonce value for the transaction in order to avoid a collision, which may also force the sender to re-sign the transaction. However, if the Bloom filter is properly constructed, this may happen only a certain percentage of the time. The nonce selected may be any byte value; the nonce may not may be any larger than a byte, and it mayn′t may be sequential (although maybe it should be, see below). Also, a client application may keep track of the Bloom filters, and may only propose transactions that it verifies do not create collisions in the Bloom filter.

In at least one embodiment, even multiple off-line transactions are verified in this way while they remain off-line. When the transaction is accepted to the blockchain, its transaction hash is added to both Bloom filters. After it is added to the Bloom filters, it becomes impossible to replay that transaction without modifying the nonce and re-signing the transaction, up until the point when the block expires. This is a generalized approach that may cover many interactive use cases for records that we are working with; However, it may not be able to ensure sequential execution of transaction, which is a requirement for some record types that pertain to over-writable settings.

In at least one embodiment, There are potentially three opportunities that exist for validation which we should be aware of: 1. Static validation immediately before a transaction is added to the mempool. 2. Static validation immediately before a transaction is processed for inclusion in the blockchain 3. Error detection within the execution of the transaction as the state is being updated as part of the insertion into the blockchain. Regarding the first static validation, may synchronously return some kind of error response to the client. The validations performed at this initial stage may be those validations that are completely independent from state, and instead pertain to structure of the records and the transaction. The static state verification may be performed within the second static validation. Regarding the second static validation, there is full evaluation of the transaction.

In at least one embodiment, some auth filters may be evaluated within this phase (for instance, permissioning auth filters associated with token types and with wallet accounts). If auth filters attached to token types and accounts fail, then the transaction may fail (may confirm that this may work in the general sense). However, standalone auth filters and p2sh account auth filters may not be evaluated here due to the fact that they may depend on the global state data for evaluation. There may be differences between record validation within an ARC and validation of a standalone transaction. The reason for this is that in the context of the ARC the state is more likely to be changing as the ARC is evaluated, making static validation against the original state less likely to be successful.

In at least one embodiment, anything in the preceding static analysis stages may be limited in its ability to anticipate whether the record may be in compliance with the global state. There are a variety of circumstances where a statically-valid transaction may fail in the middle of actual execution. Ultimately, if a transaction that reaches this stage is executed, it may be added to the blockchain, even if it fails somehow.

In an embodiment, when NFTs are sold, the royalty may be enforced by the marketplace, with the NFT creator may being to trust the marketplace. Some marketplaces have stopped enforcing the royalty. The protocol allows the NFT creator to enforce royalties in a decentralized way, and to list the NFT in any number of marketplaces. The NFT token is configured with an auth filter that forces transfers to take place inside of atomic transactions. Stand-alone transfers are prohibited, and may be blocked by the token auth filter The token auth filter may require that the auth filter of the atomic transaction match exactly a particular format of auth filter (by comparing auth filter hash values), which atomic transaction auth filter may be pre-defined. The atomic transaction auth filter may access some elements on the token configuration itself in order to retrieve execution variables such as royalty amount, etc. They may permit the atomic transaction auth filter to be standard and static.

According to various embodiments, the atomic transaction auth filter may enforce a specific ARC structure: the ARC header may be null and not point to any account, allowing any account to complete the ARC and add it to the blockchain which may also be all-or-nothing. The first element of the ARC may be a transfer to a null account (no receiver) allowing the next transfer in the chain to send the token anywhere. A more complicated version may send the tokens to a p2sh account, or to an account with an open auth filter allowing anyone to grab the tokens; both are less desirable approaches. The second element of the ARC may be a transfer of the NFT to any account. The sender may be empty, because the token may be “floating” inside the atomic transaction. The third element of the ARC may be a transfer to the sender of the NFT (or other designated account), at minimum at the price indicated. The fourth/last element of the ARC may be the royalty payment, which may be validated by the ARC auth filter to transfer to the NFT creator (as defined in the token config) an amount not less than the royalty ratio (defined in the token config) times the price. (Alternatively, the fourth element may be a second transfer instruction within the third element.) Alternatively, rather than these being enforced by the ARC auth filter, they may be forced directly by the token auth filter, if it has access to the atomic transaction elements. However, that approach may result in the sender being dependent on the token issuer being benign; In case if the token issuer modifies its auth filter, it may cause the seller to be unable to enforce its price. The dual enforcement of both auth filters allows both the seller and the issuer to protect their interests.

In an embodiment, the protocol may be used in two ways. First the seller may generate the incomplete ARC and post it publicly, which may be matched by anyone who satisfies the minimum price, the buyer may post the complete atomic transaction to the blockchain; or the seller may hold an auction off-chain, and then send the winning bidder the incomplete ARC. The winning bidder may then complete the ARC and add the transaction to the blockchain. The key elements of the protocol are the ability for transfers inside of ARCs to send to null accounts, and the ability to construct an anonymous ARC header, which together allow the partial ARC to be used by anyone. In the event that a buyer tries to evade the royalty by paying a portion of the price off-chain, the buyer is exposed to the possibility of the transaction being hijacked by an MEV operator. In other words, any payment off-chain may result in the whole transaction being gazumped, with the buyer losing their off-chain money, with no NFT received in exchange. Also, if a legitimate buyer is gazumped, they may not successfully complete the purchase, but they also have not spent any money, unlike the royalty cheat.

In an embodiment, the alternative to the concept of a P2SH accounts for some of its use cases. If a transfer is inside of an ARC (and only in this case) the transfer may be able to be sent to an empty account. In this case, the tokens transferred may “float” within the atomic transaction, permitting a subsequent transfer or other record to consume the tokens by transferring from an empty or null account. There are two possible behaviours, which may conceivably be controlled by the configuration of the ARC in the header: The atomic transaction may only be valid if all “floating” tokens are consumed before the transaction finishes executing. Any floating tokens that are not consumed before the completion of the transaction are returned to the original sender. For instance, purchase records may “float” the purchased tokens inside the ARC. Deferred reversals may create a problem. Deferred execution may not be compatible with null/empty accounts.

In an embodiment, there are some kinds of cost paid by smart contracts and/or auth filters for the consumption of decision data. There is some mechanism for users to pay for data they consume, which payment may go to benefit the providers of the data.

In an embodiment, the validation does not automatically depend on a valid signature. The auth filter may take over the validation—the default token validation may be overridden so that token balances may go negative within individual accounts. In the case, a setting, when set on the token configuration, may override the default behaviour enforcing positive balances, so that balances of the token may go negative. The token auth filter may be used to enforce how and when the account is able to go positive. One use case is where a token issuer is managing off-chain real-time debits to the account of the user (for instance, card network payments) and the conflicting debits hit at the same time. An auth filter may be configured that for negative-balance transfers, in addition to the standard signature elements, the issuer account may also have to sign the transaction as an additional signature.

According to various embodiments, this may a change that allows signatures to be added to transactions after the primary signature has already been added, In some circumstances, the already-signed-by-the-user transaction that are rejected from the mempool due to balance conflict (i.e. auth filter rejection) may have the issuer account signature added, without further modifying the transaction. The additional signature may cause the transaction to execute an alternate authorization pathway in the auth filter, so that negative balances may be allowed. Conflicts may still emerge due to two transactions potentially containing the same nonce, but they may be unlikely to be ever happening if conflicting transactions are being emitted by different devices.

In another embodiment explains, the most important example of this is that any atomic transaction that succeeds in passing the initial validation may be added to the blockchain, even if some portion of the atomic transaction fails validation at execution time, or the whole atomic transaction fails. Some portion of the “conditional validation” failures are added to the blockchain in a failure state, rather than simply being discarded. The determination of this question should be an assessment of the computational overhead of the conditional validation step. If the conditional validation is very expensive, then its going to be very cheap and may not contribute to a spam attack, then the transaction may simply be discarded. This concept would be implemented by following methods, The transactions that may be added to the blockchain in the “failed” state would effectively be deemed “passing” conditional validation after the last retry failure, and would proceed to inclusion in block building. In block building, the conditional validation failure prevents the global state being changed, except for the gas consumption. The transactions that are not added to the blockchain in the “failed” state would be discarded after the last retry failure.

In an embodiment, the proposition statements are effectively expressions that output a boolean value. A proposition is true or false, and the various information recorded in the annotation is assessed by extracting the truth values from the Boolean statement.

In an embodiment, If a proposition statement may act as an expression with a string or number output type as well, then more open-ended propositions may be created. In these cases, the annotation and its data values wouldn't be constructed purely from the proposition statement (modified as it is by the voting, which may act to negate the statement t). Rather, the annotation data would combine a variable or set of variables or perhaps some other expression from the statement, with some non-Boolean data specified in the decision records (such as numbers, strings, objects or expressions). Rather than simply controlling whether the proposition statement is negated, the decision process would determine which decision record may be combined with the proposition statement to populate the annotation data.

According to various embodiments, decisions and votes in this case would may be clearly separated from each other. Initial decisions may be added in one set of messages, and those decisions may be voted on in a different set of messages. The outcome of the voting may be determined by a similar algorithm to the current implementation, but an algorithm that accounts for more than two possible alternatives.Annotations may function in a similar method, but the process of adding annotations after a proposition has been determined may be changed and potentially simplified. The reason to take this approach is that certain use cases may potentially be better accommodated by this process than by the current process. For instance, events that have a non-binary outcome may be anticipated in advance of the event actually taking place, so that the decision block may be specified in the future when the event is actually scheduled to take place. As it stands, by limiting proposition statements to only binary outcomes, any non-binary event may only be incorporated into a proposition that is created after the event has itself taken place.

In an embodiment, there are some kinds of cost paid by smart contracts and/or auth filters for the consumption of decision data. There are some mechanisms for users to pay for data they consume, which payment may go to benefit the providers of the data.

In an embodiment, the validation does not automatically depend on a valid signature. The auth filter may take over the validation—the default token validation may be overridden so that token balances may go negative within individual accounts. In this case, a setting, when set on the token configuration, may override the default behavior enforcing positive balances, so that balances of the token may go negative. The token auth filter may be used to enforce how and when the account is able to go positive. One use case is where a token issuer is managing off-chain real-time debits to the account of the user (for instance, card network payments) and the conflicting debits hit at the same time. An auth filter may be configured that for negative-balance transfers, in addition to the standard signature elements, the issuer account may also have to sign the transaction as an additional signature.

According to various embodiments, this may a change that allows signatures to be added to transactions after the primary signature has already been added, In some circumstances, the already-signed-by-the-user transaction that are rejected from the mempool due to balance conflict (i.e. auth filter rejection) may have the issuer account signature added, without further modifying the transaction. The additional signature may cause the transaction to execute an alternate authorization pathway in the auth filter, so that negative balances may be allowed. Conflicts may still emerge due to two transactions potentially containing the same nonce, but they may be unlikely to ever happen if conflicting transactions are being emitted by different devices.

In an embodiment, A setting on an account or on a device causes statistics to be collected for that account or device with regards to daily and monthly transactions. All values may be translated into the specified token type based on the exchange rate at the time that the transaction occurred. Separate statistics may be collected for different user token types The statistics configuration struct are allow the user to define the token type(s) and statistic type(s) collected as part of that statistic collection. Wild card may be used in a similar manner as with trades; for instance, “ ” may match all tokens, while “USD” may match USD tokens. The type of statistic may be “value last month”, “value today”, “count last mont”, “count today”, etc. Different configurations may have different costs for collection and for setup (both gas and storage). Default value for the field may be an empty configuration object may be false, and the field are be optional on the account object. Either it are be a bit within a bitmap storing a variety of static fields, or it are be an optional field at the end of the object, so as to minimize the space taken up when it is not turned on. Statistics may aggregate by transaction type and currency type for transactions sent by the account. All fees may be aggregated together regardless of transaction type. The additional storage burden and computational burden of statistics collection are be taken into account when computing fees for transactions originating from an account. The fee calculation may increase based on the additional load for accounts (or devices) that collect statistics. The feature is a requirement that may allow auth filters to be used to impose velocity limits on accounts and on devices. An additional auth filter function is required that may access the current exchange rate between two token types. This may be used to translate a statistic from one value to another.

In an embodiment, If a proposition statement may act as an expression with a string or number output type as well, then more open-ended propositions may be created. In these cases, the annotation and its data values may not be constructed purely from the proposition statement (modified as it is by the voting, which may act to negate the statement t). Rather, the annotation data may combine a variable or set of variables or perhaps some other expression from the statement, with some non-Boolean data specified in the decision records (such as numbers, strings, objects or expressions). Rather than simply controlling whether the proposition statement is negated, the decision process may determine which decision record may be combined with the proposition statement to populate the annotation data.

In an embodiment, a special record type may be defined exclusively for anonymous transfers. The anonymous transfer record shall include a source of funds and the amount to be transferred. The record may also specify applicable fees and may be signed by the sender. However, it shall not specify a destination and, in isolation, shall not be eligible to be added to the blockchain, as it is considered a non-transactional record. The anonymous transfer record may be transmitted by the sender to the recipient via off-chain means. For example, the sender may encode the record and deliver it to the recipient through SMS, email, or a searchable QR code. Upon receipt, the recipient may generate a transaction container that incorporates the anonymous transfer record. The fees associated with the transaction container may match the fees indicated in the anonymous transfer record. The account that signs the transaction container shall be deemed the ultimate recipient of the tokens being transferred through the anonymous transfer. Validation of the transaction shall not consider the sender's account for gas fees; instead, it shall reference the sending account as defined within the anonymous transfer record. Both signatures shall be subject to verification: the signature on the transaction container, which is executed by the recipient, and the signature on the anonymous transfer record, which is executed by the sender. If both signatures are validated and all conditions are met, upon final execution, the recipient account (transaction container signer) shall receive the transferred tokens, and the sender account (anonymous record signer) shall be debited the corresponding tokens and associated gas fees.

In an embodiment, users may assign a small signature size (1120 bytes) compared to other ones we have (like). and public key size (32 bytes). It is quantum safe but may only be used once for maximum safety. If it is used more than once, its private key is vulnerable to some attacks.

In an embodiment, it is possible to add additional device signatures to any record through some standard means. This may be implemented somehow at the ARC record wrapper (container) level, or at the Tx wrapper (container) level. One implementation approach may allow additional signatures to be appended to the container object, so that the container object contains a list of device-key/signature pairs, rather than a single device-key/signature pair. Before the final container is created, the record (and container) may be passed to the other devices that may be to sign it, and signatures may be generated by those devices. When the full list is created, then the final container is generated, which is then added either (i) to the blockchain as a transaction, or (ii) to an ARC. The potential issue with this approach is that in the context of an ARC record container, there is the question as to how subsequent records reference prior records. With this arrangement, the signatures can not reference themselves when signing. A partial ARC may be passed between untrusted parties. In one of the examples ARC participants strip signatures from the container before the ARC is added to the blockchain. In case if it is added, the original intent of the signers of that record may be subverted, an unacceptable result.

In an embodiment, another issue is that if the individual record signers only sign the record hash, and do not sign a hash that incorporates the back reference, then only the final signer may have any confidence that the record may actually be attached to the ARC in question. The other signers may have to trust that the final signer may include the record in the ARC, unless the thing they are signing includes the back reference. One possible mitigation of these issues may be that (1) the individual record signers may be to sign a combination of the record and the wrapper data, and (2) the list of record signatures may be incorporated into the data that is ultimately signed by the final signer. This may mean that the data being signed by the multi-sig signers may be different from the data being signed by the final signers.

An algorithm for this approach may be as follows:
a) The full wrapper/container may be created, including the record and any other ancillary fields required by the wrapper/container (the whole container including TX gas price/cost and ARC back references), but not containing any signatures. This may then be passed to the first signer.

b) The first signer may then encode the whole object using RLP, obtain the hash, and then sign the hash. The first signer may append the hash to the signature list, and pass the object to the next signer.
c) The next signer may encode the whole object, including the signatures already added, using RLP, then obtain the hash, and sign the hash. Then this signer may append that hash to the signature list, and pass to the next signer.

This whole process may be repeated until all the signers had signed the object, and appended their signatures to the list. Each signature may be associated with a different hash-a hash that represents the version of the container+record that is only missing its own signature in the list.

When verifying these signatures, the first thing to do may be to pop the last signature from the list, and then encode and hash the remainder, and verify that against the signature that was popped only at that moment. Verification may involve iterating over the list of signatures, re-encoding and re-hashing the object for each signature, and verifying each signature against a different hash.

In an embodiment, One thing that the above does not address is the question of recycling device public keys. Per the current requirements, recycling device public keys (i.e. resetting the key pair for a device) happens using a particular field of the container, which is used to change the public key (or partial public key) of the device. (In the future the public key reset should also specify the signature algorithm used to sign. One way to handle this may be to have the last signature of the whole list be added directly as a field of the container, as it is now. The signature list may only be populated if there were more than one signature.

In an embodiment, In addition, it may be beneficial if each item in the signature list may specify a replacement public key (and signature algorithm indicator) along with its signature and account-device code, as an optional additional field. This may permit each participating device to reset its private key with every signature. Post-quantum hashing algorithms may require that public keys for any device or account happen at any time, so this requirement cannot be skipped without undermining the requirement to support post-quantum signature algorithms.

In an embodiment, note that it cannot work for the final signature and its own public key replacement to be added to the signature list, because per the signature-confirmation algorithm above the final object in the list may be popped from the list before the whole object is encoded, hashed and signed. The public-key-replacement field for the final signature may be part of the container object, along with the account-device indicator, so it makes sense that the final signature itself be added to the container object, keeping the signature list empty unless it may be non-empty.

In an embodiment, the wrapper may ultimately contain the final signature, and the final signature may only have a transaction hash that includes all the other signatures (not including the final signature). So, if the penultimate (i.e. second-to-final) signature (i.e. the top one on the list) were to be popped, the final signature (i.e. the one attached directly to the wrapper) may be invalid. It may be invalid because the hash without the penultimate signature may be different from the hash with the penultimate signature.

In an embodiment, If they may be done parallely, the originator device may broadcast transaction contents separately to each device, each device may sign on its own send to the first device. The first device collects them parallely (somewhat like some pool or aggregator). Once all the signatures are pooled it may broadcast it to the blockchain. It's more like a parallel voting as contents are not manipulated.

In an embodiment, there are two possible ways to do the verification. The aggregate the public keys verify the aggregated public key with the given signature. In other ways the collective signature is verified against each public key. The public key validity, public keys may be hashed and may be tallied if it is in fact allowed for the given account.

In other embodiments, users may combine multiple signatures from the block and compress it into one single signature. Verification may verify this collective signature with each message digest and public key.

In an embodiment, each record envelope may specify a new public key (or partial public key) that may replace the current public key of the device signing that record. All subsequent records may be signed by a private key corresponding to that public key.

In an embodiment of specifying the public key, the record envelope may include a reference to the digital signature strategy used by the wallet to sign the record wrapper. Because these algorithms have different space and time requirements (especially the post-quantum signature approaches, which require much more space), the gas requirement to use each of these different algorithms should be different. A specific gas requirement is specified for each algorithm, to be specified in the global gas price constants code file.

In an embodiment, users may add Genesis records to define user base token types under Authorized token strategy. A Genesis record is a type of record resident within a blockchain system. Within the present embodiment, genesis records are added to the blockchain in order to declare and define new user token types. Genesis records may contain all or some portion of the following data which are grouped as follows: Label, Value, Base token type (Optional), Derived token label (Optional), Home Account, Issuer Account, Stake/min_stake_ratio, Fee, Fractional, Unit fraction, Supply, New Issuance, Authorization Subroutine (Optional), Authorization filters (Optional), Authorization Cascade (Optional), auth_method_id, create_dex, permit_listing, type, max_supply, symbol_src, full_name, unicode, multiplier, immutable

In an embodiment, each of the groups have their own definitions Label defined as the unique string that distinguishes one token from another, and which identifies different token balances within an account. Value, defined as the aggregate token value created as a result of the inclusion of the genesis record. Value may be 0 in the case of a genesis record being used to increment the stake associated with an already-declared token type, in the case of a record that in some manner modifies the configuration of an existing token type, or in the case that the home account is granted authority to generate an unlimited number of derived tokens. Base token type, defined as Optional. In at least one embodiment, a derived type may explicitly reference its base token type. Derived token label, defined as Optional. In at least embodiment, the labels of derived tokens may be restricted according to the derived token label field. This field may specify a pattern that the label may satisfy for the derived type to be valid, which pattern may be implemented as a regular expression, or in a similar language.

In one embodiment, Home Account is the account that receives the newly-generated user tokens, and is thus able to distribute these tokens. Issuer Account defined as the account that cryptographically signs the genesis record; in the case of an “open” token issuance scheme, this is the source account for the original stake; in the case of an “authorized” token issuance scheme, this is the account that has authority to issue new tokens with the indicated label. This is the originating account that cryptographically signs the genesis record with its private key. Stake, defined as in the case of an “open” token issuance scheme, the native token value staked (i.e. locked) in support of this user token; field not present under the “authorized” issuance scheme Fee defined as the amount that may be included among the block rewards to incentivize inclusion of the record in the blockchain. Fractional which is defined as a setting that controls whether fractional or decimal values are permitted to be held by an account, or whether only whole number values may be transferred for the token type. Options are “fractional” and “whole”; default is “fractional”. An alternative to the “unit fraction” field below. Unit fraction defined as-setting that controls how many fractional tokens make up a single unit of the token. In an embodiment that implements the Unit Fraction field instead of the Fractional field, each token represents the smallest possible fraction of the asset represented by the token. Each token represents a fraction equal to 1/“unit fraction” of one unit of the asset. “unit fraction” number of tokens equals one unit of the asset. Supply defined as in the case of an “authorized” token issuance scheme, controls whether the home account or the issuer account may arbitrarily increase the aggregate value available for a particular token, or whether the value is permanently fixed upon initial issuance. Options are “fixed”, “unlimited” and “original issuer”; default is “fixed”. New Issuance defined as in the case of an “authorized” token issuance scheme, controls whether the home account or the original issuer account may issue subordinate derived tokens-or, whether an account that is the bearer of a token may transform a token into new derived token types. Options are “original issuer”, “home” and “bearer”; default is “original issuer”. Authorization Subroutine, A smart contract subroutine to be executed whenever tokens of this type are included in any record. In at least one embodiment, this subroutine, when invoked, may receive as input all data records subject to authorization as arguments, along with the token type that originally linked to the authorization subroutine. The subroutine may return False in the case that the proposed record is not authorized, and True in the case that the record is authorized.

In an embodiment, Authorization Filters may be defined as A list of filters that may be used to exclude conforming accounts from holding, sending or receiving tokens of the given type, or that may be used to require that accounts that hold, send or receive tokens of the given type conform to a certain profile. Filters may consist of a pattern that records or accounts may conform to, and may reference details of a given account, including details that are attached to an account through the use of a proposition record. In at least one embodiment, each authorization filter may also specify which specific third-party accounts may be to have created, confirmed or decided any proposition record used or referenced by the authorization filter. Authorization Cascade may be defined as Boolean value that indicates whether or not the authorization subroutine should be invoked, and/or authorization filters should be enforced for instances of token types derived from the token in question. Options are “True” or “False”, depending on whether or not the authorization subroutine and/or authorization filters of this particular user token type may be applied in the case of derived tokens as well as this token type itself.

In an embodiment, Authorized Token Strategy defines as In contrast to “open” token types, the number of “authorized” token types is unlimited. While the number of possible “authorized” token types is unlimited, however, any new “authorized” token generation may proceed through an account-authorization path via a chain of genesis records that originates with the account that ultimately has authority to issue any new token type with any label: the “root” account, which may be the “home account” specified in the first genesis record within the blockchain. In at least one embodiment, this “root” account may be designated through the issuance of a genesis record using the empty string “ ” as a label, which the genesis record may convey to the root account ultimate authority over the issuance of all other accounts. Authorized token types may be generated via the following “issuance” process involving genesis records. As per this process, in at least one embodiment, new tokens may only be issued, and new token types may only be declared and defined if these tokens and token types are issued and declared and defined by individual accounts that are explicitly authorized to do so. As per the process described below, given two token types, one may be deemed to be a “derived” token type and the other a “base” token type if the existence and configuration of the “derived” token type is in some manner dependent upon the existence and configuration of the “base” token type. A new token type is deemed to derive from a base token type if the genesis record of the derived type in some manner references a base token type. Other than token types declared and defined by the “root” account, all authorized token types are derived from some base token type, including base token types within this reference chain.

In an embodiment, the issuer account indicated in a genesis record may be authorized to issue derived tokens as per the base token's “new issuance” setting. Additionally, this issuer account may cryptographically sign the genesis record of the derived token type. In another embodiment, one token type may be is deemed to be the “base” of another “derived” token type if the home account of the base token type is counted as the issuer account used to issue the derived token type and if the genesis record of the derived token type references the base token type. This alternate system may be useful in the case where no specific constraints are placed on the labels to be used by derived tokens. A base token's “new issuance” setting determines which account is authorized to issue a new token type derived from that base token. A derived token's issuer account is the account that is authorized to issue new derived tokens as per its base token's “new issuance” setting.

In an embodiment, some of the definitions which are explained in the an embodiment are follows Issuance: the act of declaring, defining and configuring NEW derived tokens (ALL tokens are, effectively, derived tokens), which affects the token type objects, but not account balances.New issuance may be defined as the permissions configuration pertaining to the issuance of tokens derived from the given token. Minting may be defined as the act of creating new tokens of a given type, which affects the token ledger balances. Value, which is defined as the current max number of tokens that MAY be minted for a given type, but which does not affect ledger balances (except to limit them).Supply. which may be defined as the permissions configuration pertaining to the modification of the value number. Tokens outstanding/token count are defined as the number of tokens that have been minted and that have not yet been redeemed/destroyed; i.e., the aggregate number of tokens recorded within account ledgers, which number should also be tracked on a denormalized basis as an aggregate value on the token type object. Users may be to consider having separate records, maybe to simplify things a bit, we also should stick as close to the specification as possible, where possible. Users may be to separate genesis, configuration, reconfiguration, and issuance records. All seem to pertain to the configuration of token types (i.e. creation or modification of token type objects within the global state) and there may be more than one record type for that. There is no potential benefit in separating minting of tokens from the configuration of token type. User create a “mint” record type for this purpose. In this approach, the “mint” record may be valid if signed by the home account of the genesis record for that token type. Only a number of tokens up to the quantity specified within the “value” setting may be allowed to be minted. The genesis record may be focused entirely on modifying token type configuration, but without affecting balances on any account. The “value” field may not actually mint new tokens (i.e., it mayn′t add any tokens to any account's token ledger) but it may instead set the max value of tokens allowed to be minted. A genesis record may interact with token balances in the sense that in no case may the “value” field be set lower than the total tokens minted (i.e. the total aggregate value of the token type on all accounts' token ledgers); however, this interaction with balances may be read-only for validation purposes. Genesis records may operate on token type object configurations, and minting records may operate on token ledger balances.

In one embodiment, “Staking” is defined as providing “authorized” tokens, staking has a completely different impact compared to “open” tokens. Stake may be added to a token type using a record separate from all the other record types. The redeem record may dispose of stake, and the genesis record may configure the staking and redemption subroutines. Systems may need to consider a “minimum stake ratio” or “minimum stake” configuration as part of the genesis record, which may potentially enforce some relationship between the minting of tokens of the type and the staking of fuel for the type. These may be used with the trade order records and settlement records: each such record may be associated with a DEX that has been instantiated by a token issuer. Only token issuers that have the legal authority to operate a DEX may be authorized to create one at the time the token is issued. The permit listing setting governs whether the token may be included in trade orders that reference a different separate account as the dex. If the setting is false, then the token either may only be traded with its own home account as the dex, or may not be traded at all. Which specific tokens are permitted to trade against the token in question, whether the token is creating the dex or only being listed in another dex, may be further controlled with auth filters, etc. The listing setting may be redundant to auth filters, and it is possible that it may not be, because the same behavior may potentially be controlled only via trade order auth filters.

In another embodiment, the an embodiment defines what is the meaning of delegated chain-of-authority tokens and staking. For most cases of delegation, the stake associated with parent & ancestor tokens have little or no effect on delegated tokens. Staking is something that is associated with tokens that are minted (i.e. tokens counted in the token ledger), which is a concept that we are keeping separate from the issuance of new delegated tokens via the genesis record (token type objects). Staking updates a stake balance within the token type object, but it only interacts conceptually with the minted tokens (i.e. when the minted tokens are redeemed)—otherwise, it isn't very concerned with the chain of authority. One thing to keep in mind is how the max value interacts with delegated tokens. The max value takes into account two things: 1) the count of tokens of that particular type that have been minted, and 2) the max value of the delegated tokens that have been issued, regardless of the number that have been minted. If the sum of these two numbers exceeds the value configuration of the parent token type, then no additional minting or issuance of delegated tokens may be permitted. This may result in a token type's max value being reached without the same number of tokens being minted. For instance, if parent token A has a value configuration (max value) of 100 k, and it mints 50 k tokens, and then does a genesis delegation to token A2 with a value configuration (max value) of 50 k, then no more tokens of type A may be minted, and no more new token types may be issued derived from A, even if zero tokens of type A2 have been minted.

In another an embodiment, one possible configuration may be to give a new token type B a fixed supply with value 100 k, which then may be used to issue new token types B2 and B3, each with unlimited supply. In this case, when tokens of type B, B2 and B3 are minted, then they may all be competing for the same 100 k available supply: if B mints 50 k, and B2 mints 50 k, then zero tokens may be minted of type B3. This may be something that does create some interaction between genesis configuration and the behavior of staking, minting, and redemption. The minimum staking ratio is allowed to be zero, and may be zero by default. If there is a staking ratio specified, then the fuel requirement may be staked before tokens are minted (it may be done within the same atomic transaction, provided the staking record is included before the minting record). Redemption may keep the current staking ratio constant. Any minimum staking ratio greater than 100% may require more fuel to be staked for a token than the number of tokens that may be minted. Delegated token types may probably*be required to have a minimum staking ratio greater than or equal to the parent token type. In other words, if token B has a minimum staking ratio of 100%, then the derived token type B2 may have a minimum staking ratio of 100% or more. Derived token types may have a separate staking balance from their parents. If a parent or ancestor token type is over-staked (meaning, has more fuel staked than the minimum staking requirement) then that extra stake does NOT benefit any derived token type. Each derived token may satisfy its staking requirement (if any) on its own.

In an embodiment, system may configure the device, using a single Create+Accept Message In an embodiment, a single ‘create+accept’ message, signed by the key of the existing device, is transmitted privately to the second device (via QR code) and subsequently signed by the second (new) device. The second device retains its new key in confidence and posts the signed message to the blockchain. The activation is considered complete when the message is accepted by the blockchain. A first ‘create+accept’ message, signed by the key of the existing device, is transmitted semi-privately to the second device via email or SMS, encoded in URL format, and signed by the second (new) device. Upon signing of the ‘create+accept’ message by the second device, a confirmation hash may be appended, and the message may be submitted to the blockchain. However, the device remains unusable until the original device submits the final confirmation message, which includes the confirmation hash.

In an embodiment, a ‘create’ message is generated by the first device, specifying a new device and including a new public key (or partial public key) for that new device. The ‘create’ message is subsequently added to the blockchain. The new public key is generated using a passphrase seed. The second device constructs an ‘accept’ message utilizing the passphrase seed in combination with the account information. Upon the addition of the ‘accept’ message to the blockchain, the second device becomes usable, as no confirmation hash is required or specified within either the ‘create’ or ‘accept’ messages. In a process similar to the preceding one, a ‘create’ message may be added by the first device, and an ‘accept’ message may be added by the second device. However, in this instance, the original ‘create’ message specifies that a confirmation hash is required. Consequently, the confirmation hash is appended to the ‘accept’ message. A 6-digit code, shared by the user of the second device, is used by the first device to generate the confirmation hash. The confirmation message, containing the confirmation hash, is then transmitted to the blockchain.

In an embodiment, a special record type may be defined only for anonymous transfers. The anonymous transfer record may define a source of funds and an amount to be sent. The record may specify fees, and may be signed by the sender, but may not specify a destination, and it may not be something that may be added to the blockchain on its own, because it may be a record. This inner object may be signed by the sender. This anonymous record may be sent by the sender to the recipient via of-chain means. For instance, the sender may encode the record and transmit it to the recipient via SMS, email or smayned QR code. The recipient may generate a transaction container that may contain the anonymous record. The fees of the transaction container may be to match the fees of anonymous transfer. The account that signs the transaction container may be the ultimate recipient of the tokens being transferred by the anonymous transfer.

In an embodiment, a validation may not look at the sender account for the gas fees, but may instead look at the sending account defined in the anonymous transfer record. Both signatures may be verified: the transaction container signature of the recipient, and the anonymous record signature of the sender. If everything is valid, upon final execution the recipient account (tx container signer) may receive the transferred tokens, and the sender account (anonymous record signer) may be deducted the transferred tokens and fuel. A key authentication concept here is that the initial inner object generated by the sender may contain a public key. This public key may be sent along with the transfer object via off-chain means from the sender to the recipient. The envelope that is added by the recipient may be signed using the key pair that includes this public key.

In an embodiment, an optional authentication feature may allow the inner object built by the sender to contain a hashed passcode. The passcode pre-image may be a short numerical passcode that may be shared verbally from the sender to the recipient. The outer envelope may then include the pre-image (or better, a ZKP proving that the recipient has the pre-image). However, this may not be required, and may only be used in practice for transfers above a certain value.

In an embodiment, as first step apre-image is created (say, a 6 digit number or alphanumeric), The pre-image is hashed and the hash is added to the inner object that is signed by the sender and transmitted to the recipient. The sender shares the 6-digit code off-line (say, via voice over the phone). The recipient enters the 6-digit code on their device, and the device creates the ZKP. Two possible options are that the ZKP simultaneously proves that the recipient knows the private key associated with the recipient account, and the pre-image associated with the hash. The device then signs the pre-image with its private key (the private key associated with the recipient account) and then ZKP proves that the recipient knows the signed pre-image of the hash. Depending on how the ZKP is constructed, if somehow it only incorporates the recipient account in an irreversible way (in the same way that a hash of aggregated strings incorporates both strings), then an attacker may be to re-construct the ZKP somehow after extracting the account. Like, maybe the ZKP verifier somehow accepts the account number and the security hash as inputs along with the ZKP, and then only succeeds if all are correct, including the account number.

In one an embodiment, users may define a possible two-stage open-transfer authorization approach. Open transfers are implemented in such a way that an explicit approval is required for payment to be completed. This may allow an open transfer to be produced without a fixed token amount, such that the transfer recipient may specify a token amount, and the sender may confirm that token amount in a second, separate record. Certain details of this approach are that an open transfer record may contain a field specifying whether the amount specified in the particle is final, or is non-final. If the configuration says that the amount specified in the particle is non-final, then the amount specified in the particle may function as a “maximum” amount, or it may indicate that “any” amount is valid for the transfer (like, if the max amount is 0, or null, or maybe −1).

In one an embodiment, if the amount is non-final, then the envelope may specify an amount that differs from the amount specified in the particle. The amount specified in the envelope is the actual amount that may be transferred. If the particle specifies no maximum, then the envelope may take as many tokens as are allowed by transfer validation (potentially even allowing a negative balance if the token configuration permits a negative balance). Also if the initial amount is non-final, then it is possible for the particle to be configured so as to specify that “confirmation is required” or “confirmation is not required”. If “confirmation is not required”, then the recipient may claim any amount that they want (subject to the possible auth filter limitation described below). If a “confirmation is required” configuration is specified on the particle, the completed open transfer record (meaning, the open transfer record that includes both the initial particle and the envelope) may not move the funds when processed. Instead, in that case, the open transfer may be added to the delayed execution object on the sending account, indexed by the hash value of the open transfer. The tokens may be simultaneously moved out of the sender's token ledger, or, alternately, the tokens may be kept in the token ledger, only to be moved when the open transfer is finalized. Again, this behavior may be controlled by a boolean configuration on the particle (probably a bitmap field to contain all the boolean configurations).

In one an embodiment, the delayed execution data may include the expiration block number, after which the pending open transfer may be mayceled. The cleanup function may remove any expired open transfers from the delayed execution object if the expiration has completed. In order to finalize a pending open transfer, a separate “Open Transfer Confirmation” record may be added to the blockchain, signed by the original sender. This confirmation may refer explicitly to the identifier of the pending transfer as it is indexed in the delayed execution object on the sending account; this explicit reference may be the “depends on” field of the Tx or CRC, so as not to add a redundant field. When the “Open Transfer Confirmation” record is processed, the pending open transfer is completed, moving the tokens to the recipient's token ledger. Lastly, the open transfer particle may specify an auth filter. This auth filter may operate on the open transfer record, in order to restrict aspects of the open transfer record, including the envelope. For instance, this auth filter may be used to restrict the type of recipient in some way, or any other aspect of the transaction that may be available to the auth filter. This new functionality added to open transfer may allow open transfers to be used flexibly for payments.

In one an embodiment, the wallet may generate a QR code that holds the open transfer particle, configured to allow any amount to be charged against the account, but requiring confirmation; an auth filter may optionally require that the recipient is an ID-verified business account. Alternatively, the QR code URL may be stored in the URL-shortener. The merchant mayscan the QR code (or visit the shortened URL) in order to retrieve the particle. The merchant may then specify the amount of money to charge against the account, and then generate an open transfer wrapper that specifies that amount. The merchant may create a transaction (or an ARC particle) that is signed by the merchant account. The sender wallet (i.e. customer wallet) may wait to retrieve the completed open transfer record. Either the sender wallet may pull the record from the blockchain state (i.e. from its own account's delayed execution object), or from the mempool, or the sender wallet may somehow obtain the transaction of CRC from its own issuer server. The API used to retrieve this transaction should look like the standard block-building node API. This is may be better if there were not a dedicated issuer api for this that may not also be implemented on the block-building node. If there is issuer server retrieval, rather than direct blockchain retrieval, then the issuer server may be part of how the merchant sends the open transfer record. The merchant may be to read the wallet's preferred issuer server from the QR code URL, where it may be specified. The merchant may be to send its signed open transfer Tx or CRC to its own processor, and the user's issuer server both, so that both have the transfer.

In one an embodiment, the issuer server may have some kind of lookup or retrieval protocol for the user to retrieve pending transactions like this one. The retrieval may be performed on a prioritized basis, first look at the issuer server specified in the QR code URL; if that doesn't work, then look at the issuer server specified in the sending token configuration; if that doesn't work, interact with the blockchain directly. The sender/customer wallet may then present the sender with the details of the actual payment, including the final payment amount, and the account that processed the open transfer. If the account is a business account, the merchant details (at least, the merchant name) should be on-chain and retrievable. The customer may be given the opportunity to approve the transaction; if the customer approves, then the open transfer confirmation may be generated. After the sender (i.e. customer wallet) generates the confirmation, the sender may send the confirmation to the blockchain, or to the merchant's preferred block-building node.

In one embodiment, the merchant may be able to authorize payment before finality based on a risk assessment made regarding the transfer. If the merchant has a high confidence that the sender may not try to double spend-or if negative balance configuration of the token may allow double spending to take place, in favor of the merchant, such that there is not a risk of the open transfer somehow failing, then the merchant may act as if the transaction is final, even if it may be reorganized out of existence. The risk here may be that the nonce value specified in the particle may collide with a separate transaction's nonce. This way, a sender may block an open transfer record from being added to the blockchain, even if there are sufficient funds in the sender's token ledger. The sender may send a blocking transaction to the blockchain simultaneously with the open transfer.

In one an embodiment, a partial solution to this may be for open transfers that require confirmation not to contain a nonce. The nonce may only be specified for transactions that may be immediately completed. The confirmation record may contain the sender nonce to prevent a replay attack. The problem with this is that while this may prevent the open transfer from being blocked, the open transfer confirmation may be blocked, allowing the sender to stop the recipient from getting the money. This problem may be intractable, such that each transaction is at risk of being blocked in the event of a reorganization on a fundamental level. This means that the merchant may perform some kind of risk-rating with regards to each, in order to assess how likely a particular sender is to attempt a double-spend attack, given the amount of money that has been transferred. A very simple risk-management approach may be to wait for finality for large purchases, but allow small purchases to happen without finality being reached.

In an embodiment, the system may be able to pay for gas with user tokens. The functionality is dependent on the existence of the trade-order subsystem and the permanent order book [POB]. In order to implement the, the transaction wrapper (application side) may permit the inclusion of some fields specific for the purpose: token type (“ ” for native “Fuel” token type) fuel price (optional; if specified, the price may have to be equal to or higher than the best offer to buy fuel using the token type currently listed on the order book; if not specified, the fuel may be purchased at minimum at the best rate specified within the permanent order book [POB] at the time of execution). In the event that an alternate token type is specified, an additional calculation may be performed, which may be to determine the max amount of user token that may be required to execute the transaction. Once the max amount of fuel is known, then the max amount of user token may be calculated, using either the “best-of-order-book” market rate or using the specified fuel price. The transaction may be valid if the amount were available within the sender's token ledger, and may not be valid if the amount were not available within the sender's token ledger. Upon completion of the execution of the transaction, the actual gas used may be used to calculate the actual fuel for the transaction, which may then be used to calculate the actual user token to purchase that fuel via the POB. The outstanding order(s) on the POB may be reduced by the specified amount, and the appropriate balance within the sender's token ledger may be reduced; the utilized fuel may be accreted to the block reward.

In an embodiment, the receipt of the transaction may have to specify the order book trade order(s) that were used to complete the gas purchase. In the event that the specified fuel price is lower than what is available on the order book, then the transaction may be considered invalid at that moment, and may be to roll-over within the pool to wait a certain number of blocks (>=1) to see if a conformant trade order has been added to the permanent order book that may allow the transaction to commence; a limited number of retries may be permitted. Note that the trade order authorization filter on a user token may impose a limit on the size of the trade. Trade orders offering fuel may be unlimited in size, but trade orders bidding for fuel may be limited in some way potentially to some multiple of the most recent block(s)′ gas utilization as expressed in terms of fuel. In addition, it may be that trade orders bidding for fuel are prohibited, but that transactions paying for fuel are permitted to be matched. Auth filter may allow the order.offer_token to be fuel, permitting token sales, but prohibiting token purchases except when incorporated into transaction gas payments. The amount of fuel actually purchased to fund gas payments may naturally be limited by the block gas limits and by the limited usage within each transaction (only as much fuel may be purchased as it may be in order to undertake the transaction-no more). More complete trading of fuel may take place using “registered” fuel tokens that are implemented as user tokens that stake the fuel (and may release the fuel tokens via redemption). Such user-tokens wrap fuel tokens may allow for the registration of users via identity propositions.

### NFT Royalties

In an embodiment, a protocol for the enforcement of NFT royalties is defined d. When NFTs are sold, the royalty is enforced by the marketplace, with the NFT creator may be to trust the marketplace. Some marketplaces have stopped enforcing the royalty. The protocol allows the NFT creator to enforce royalties in a decentralized way, and to list the NFT in any number of marketplaces. The NFT token is configured with an auth filter that forces transfers to take place inside of atomic transactions. Stand-alone transfers are prohibited, and may be blocked by the token auth filter. The token auth filter may require that the auth filter of the atomic transaction match exactly a particular format of auth filter (by comparing auth filter hash values), which atomic transaction auth filter may be pre-defined. The atomic transaction auth filter may access some elements on the token configuration itself in order to retrieve execution variables such as royalty amount, etc. This may permit the atomic transaction auth filter to be standard and static. The atomic transaction auth filter may enforce a specific ARC structure. The ARC header may be null and not point to any account, allowing any account to complete the ARC and add it to the blockchain; it may also be all-or-nothing.

In an embodiment, the first element of the ARC may be a transfer to a null account (no receiver) allowing the next transfer in the chain to send the token anywhere. Pricing may be specified in the sender data of the transfer record, which may be validated by the ARC auth filter to contain a minimum price for the NFT being transferred: alternately the price may validated as part of the token's mutable data. The second element of the ARC may be a transfer of the NFT to any account. The sender may be empty, because the token may be “floating” inside the atomic transaction. The third element of the ARC may be a transfer to the sender of the NFT (or other designated account), at minimum at the price indicated. The fourth/last element of the ARC may be the royalty payment, which may be validated by the ARC auth filter to transfer to the NFT creator (as defined in the token config) an amount not less than the royalty ratio (defined in the token config) times the price. Alternatively, rather than these being enforced by the ARC auth filter, they may be forced directly by the token auth filter, if it has access to the atomic transaction elements. However, that approach may result in the sender being dependent on the token issuer being benign; if the token issuer modifies its auth filter, it may cause the seller to be unable to enforce its price. The dual enforcement of both auth filters allows both the seller and the issuer to protect their interests. This protocol may be used in two ways: the seller may generate the incomplete ARC and post it publicly, which may be matched by anyone who satisfies the minimum price, which buyer may post the complete atomic transaction to the blockchain; or the seller may hold an auction off-chain, and then send the winning bidder the incomplete ARC. The winning bidder may then complete the ARC and add the transaction to the blockchain.

In an embodiment the key elements of this protocol are the ability for transfers inside of ARCs to send to null accounts, and the ability to construct an anonymous ARC header, which together allow the partial ARC to be used by anyone. In the event that a buyer tries to evade the royalty by paying a portion of the price off-chain, the buyer is exposed to the possibility of the transaction being hijacked by an MEV operator. In other words, any payment off-chain may result in the whole transaction being gazumped, with the buyer losing their off-chain money, with no NFT received in exchange. There is a risk that even compliant buyers may lose out on their purchase, but the risk of this is reduced by the operation of the auction: any competing buyer may be paid the same amount or more may simply bid slightly more, and win the auction. Also, if a legitimate buyer is gazumped, they may not successfully complete the purchase, but they also have not spent any money, unlike the royalty cheat.

In an embodiment, there is support for multiple account nonces present in the same ARC. In addition to the “local queued transaction list” and the “remote queued transaction list”, there may be a “reorganized transactions queue list”. Each transaction from a cancelled/invalidate block may be added to the third reorganized transactions list. When rebuilding the pool (which may conceivably be rebuilt), the reorganized queue list may be given priority over the other two lists, until the reorganized queue list is exhausted. The data structure may be designed in such a way to make such removals low-cost. Conceivably, each node in the heap may know how to remove itself (by reorganizing its surrounding connected nodes) in O (1) time. References to the nodes in the heap may be stored in a hash map that indexes such references according to the block number+transaction hash, for quick lookup.

In an embodiment, state based validation in ARC, For validating records in an arc appropriately may be in appropriate state. But we cannotguess what the appropriate state may be when there is presence of smart contracts without running them, following may be the approach to valid arc.

In an embodiment, key rotation always keeps the former key alive until its designated expiration; new keys always immutably configure how long they may take to expire after they are replaced; an old key cannotbe used to rotate/replace a new key. If somehow two records are sent at the same time that both try to replace the same key, whichever one executes first may invalidate the other. Rather than being explicitly included as a fee within transactions, gas price is derived from other fields specified with the transaction: gas budget and fee (although gas budget itself is dynamically calculated based on the structural analysis of the transaction and is only an actual field on smart contracts). Although gas price is derived, it is nonetheless the sole deterblock-building node of priority within the mempool. High-gas-price transactions are given the top priority. If fee is specified in terms of a user token, then the gas price is derived by also using a weighted average exchange rate of the user token to fuel, as determined by aggregating trade orders settled in recent blocks. Because the exchange rates change with every block, the gas price of each transaction may potentially change each block, so the mempool may be explicitly sorted into each block before that block may be generated.

In an embodiment, the underlying mempool data structure is a simple list, and insertions into the mempool do not trigger re-sorting. This means that new transactions entering the pool while the block is being built may likely not be available to be processed until the next block. While transactions are being evaluated during the sorting process, expired transactions may be removed. There are three forms of static validation, each of which is dealt with differently: structural, permanent state-based, and conditional state-based. Some records (and their corresponding smart contract EXT functions) utilize all three, and some utilize only one or two. If a record fails conditional validation, then it may be placed on a retry queue a certain number of times with a certain delay, to allow the state to potentially change. However, a block-building node may arbitrarily choose to override this retry period, and simply add a record that fails conditional validation to the blockchain, where it may fail, although gas may be spent. Evaluation of gas utilization comprises both structural and permanent validation. Internally to the transaction itself, the gas budget is evaluated to determine that the structure of the transaction conforms to the gas budget. However, the question as to whether the sending account has sufficient fuel or user tokens to pay the gas fee is something that may depend on the state at the time that the validation is performed. Signature evaluation comprises both structural and permanent validation. Whether the specified signature in fact does sign the record in question is to be decided based on the internal structure of the transaction, without relation to the global state. But the question as to whether the public key is a currently-valid public key for the account is something that depends on the current state.

In an embodiment, There are potentially three opportunities that exist for validation which we should be aware of: Static validation immediately before a transaction is added to the mempool. Static validation immediately before a transaction is processed for inclusion in the blockchain. Error detection within the execution of the transaction as the state is being updated as part of the insertion into the blockchain.

In an embodiment, regarding the first static validation, which may be interactive in that it may synchronously return some kind of error response to the client. This may be limited in terms of what it may validate, due to the fact that the global state it is validated against may change before it is accepted to the blockchain. One compromise in this regard may be to issue an interactive “warning” to the user if the auth filter fails, but to not cause the transaction to fail. A flag on the JSON-RPC message may suppress this warning message, or it may cause the “warning” to be treated as an actual failure. If only a warning occurs, the transaction may be placed in the mempool. The validations performed at this initial stage may be those validations that are completely independent from state, and instead pertain to structure of the records and the transaction. The static state verification may be performed within the second static validation. That being said, giving interactive warnings to the user when there is a state violation may be useful, just as it may be useful to give warning when there is an auth filter failure.

### Validation

In an embodiment, regarding the second static validation. This is somewhat redundant with the full evaluation of the transaction. There is a benefit, however, of keeping it separate because it acts as a way to prevent a failing transaction from being incorporated into the blockchain. This is the point at which a transaction may be “temporarily rejected” and placed back into the pool, to be retried a certain number of times; this may only happen if the way that the transaction failed may be remedied by a separate future transaction. This is the point-of-no-return before gas is actually spent, the global state is changed and the transaction is permanently added to the blockchain, even if it fails. Some auth filters may be evaluated within this phase (for instance, permissioning auth filters associated with token types and with wallet accounts). If auth filters attached to token types and accounts fail, then the transaction may fail (may confirm that this may work in the general sense). However, standalone auth filters and p2sh account auth filters may not be evaluated here due to the fact that they may depend on the global state data for evaluation. There may be differences between record validation within an ARC and validation of a standalone transaction. The reason for this is that in the context of the ARC the state is more likely to be changing as the ARC is evaluated, making static validation against the original state less likely to be successful.

In an embodiment, one approach may be to know in advance all of the accounts affected by a transaction, and make a local copy of only those accounts, so that the impact on data processing is more localized, and not so much memory may be consumed for only the temporary processing. Regarding the final transaction execution: This is the final stage where the record is interpreted and verified against the global state. It is evaluated by actually executing the transaction's code; there is no static analysis. This is the only stage at which the actual compliance of the record with the current global state may be measured. Anything in the preceding static analysis stages may be limited in its ability to anticipate whether the record may be in compliance with the global state. There are a variety of circumstances where a statically-valid transaction may fail in the middle of actual execution. Ultimately, if a transaction that reaches this stage is executed, it may be added to the blockchain, even if it fails somehow. Some polymorphic concepts that may help with the implementation of this idea: Each record type may have a function that returns the accounts that are modified by it. Most records modify at least one account, but do so in different ways. A single interface to retrieve this information may simplify the search algorithm. Each application/record type may have two static validation interfaces which may be generically called. The first-stage validation may not have access to the global state. The second-stage validation may have access to the global state, which may encapsulate the cloned account data objects. In order to not make any change to the global state trie, a wrapper that re-implements the same interface as the state trie may be used, but which also stores the cloned objects, and uses them instead of the actual data whenever they are accessed. This way, the same api may be used for record validation regardless as to whether or not the record is part of a standalone transaction or is part of an ARC.

In an embodiment, there are three types of static evaluation that may be performed. Structural evaluation, which evaluation does not require access to any data or information outside the boundaries of the record or transaction itself. Some things that are evaluated at this stage include the signature, the structural arrangement of ARC records (back-references, etc.), or the proper formation of bytecode within a smart contract declaration. Permanent state-based evaluation, which may determine whether the record may possibly succeed given the current state, regardless of any changes that may be made to the state in the future. For instance, verifying whether the public key used to sign the transaction is still active (or is currently active) is not something that may change (or that we want to change) in future versions of the state such that re-trying the record execution may make any difference. Permissioning auth filters associated with transaction types and accounts may fit within this sort of evaluation. Conditional state-based evaluation, which may determine whether the record may currently succeed or not, but if it does not may possibly succeed in the future if the global state changes. Examples of this kind of evaluation include trades that are out-of-the-money, or transfers where the token balance is currently insufficient. Static evaluation is incomplete as a general rule (due to it not being able to execute possibly non-terminating code), so each of these evaluations may be optimistic in the sense that if the transaction or record may possibly succeed at the time of final execution, then the validation should succeed.

In an embodiment, each of the different validation phases may handle these types of static evaluation differently. The first static validation may treat a structural failure as an error and stop any transaction or record having a structural failure from entering the mempool. A structural validation may not be re-executed at any other stage, because failed records or transactions may be discarded at the first stage. The first static validation may treat both permanent and conditional state-based validation failures as warnings to be returned to the client. Depending on whether the client has specified whether or not to ignore warnings (which may be a flag within the JSON-RPC request), records that fail these validation modes may or may not be passed to the mempool. The block-building node may also be configured to treat permanent validation failures and/or conditional validation failures as errors within the first static validation, as separate configurations; this may allow the block-building node to control the behavior of its pool. If there is no preference, permanent validation failures should be rejected by default and conditional failures should be accepted by default.

In an embodiment, the second static validation may always treat permanent state-based failure as a fatal error, but conditional state-based-failure may trigger the retry functionality. However, if a possible retry opportunity is detected pertaining to a record within an ARC, the evaluation of that ARC should nevertheless complete, because a failed validation of a record later-on in the ARC may invalidate the whole atomic transaction, making the retry attempt futile. In both the case of the first static validation and the case of the second static validation, the whole global state may be passed into the validation function; however, any account data objects that might be mutated during the course of static analysis may be temporarily cloned as described in the preceding comment, so as to avoid changes being made to the global state object (which may have to be discarded subsequently). In the case of an atomic transaction, the second validation may be redundantly executed. First, it may be executed against the whole chain, iterating over each record, without executing any of the records. Then, static validation may occur again within the final execution phase as the ARC is executed.

In an embodiment, during final execution each record may be statically validated, then it may be executed, before proceeding to the next record or transaction. As a result, the static validation function may have evaluated typical constituent records three separate times before they are added to the blockchain along with the ARC that contains them. In the case of atomic transactions, the static validation function may actually fail in final execution, when previously it had already succeeded twice. This may be due to the global state being changed by a preceding constituent record within the ARC as it is executed. Even though some changes are temporarily made to the state as static validation is performed, those changes are minimal.

In an embodiment, when standalone records are finally executed, however, the second static validation may happen immediately before the final execution, such that the global state may not have been modified between these two events. For standalone records, the validation only may execute twice.

In an embodiment, static validation may also be run on every transaction within the block. The way this may happen is as follows:
a) The structural evaluation may be performed first. If the structural evaluation fails for any transaction in the block, then the block is invalid and is rejected. No transaction should be included in any block that is structurally invalid.
b) The permanent state-based evaluation is performed second. If the permanent state-based evaluation fails for any transaction in the block, then the block is invalid and is rejected. No transaction should be included in any block that violates the state-modification rules related to “permanent state” (such transactions shouldn't even be included as having “failed”).
c) The conditional state-based evaluation is performed third. If the conditional evaluation fails, then the transaction is permitted to be added to the blockchain, provided that the transaction is marked as having failed (meaning that it did not modify any state except for the gas payment) and provided that the gas is paid for.
d) Finally, the final execution of the transaction proceeds. Whatever the outcome of execution, it may match the results recorded in the receipt, regarding the modification to the global state, and the success-state of the transaction itself.

In an embodiment, static transaction validation may verify gas sufficiency. As a general rule, static transaction validation should only verify that the gas provided by the transaction wrapper is sufficient to pay for the constituent record(s) within the transaction. The minimum gas requirement of the record(s) may be statically determinable by inspecting the records on an individual basis. The aggregate minimum gas cost of the record(s) as a whole may be matched or exceeded by the gas to be purchased by the transaction. From a software architecture/design perspective, each record type (or each affiliated application) should specify a method that may return the minimum gas requirement of any given record instance of that type. The logic of how to determine gas for a record may be localized with and coupled to the record implementation itself., there should be a central, single constants file that specifies all of the gas that each record type and operation may. For smart contract invocations, the “gas budget” value may be specified, which “gas budget” may be treated as the “minimum gas requirement” of that smart contract invocation, which may be aggregated with any other gas requirements that attach to that particular transaction.

In an embodiment, for any transaction that implicates an auth filter, the auth filter gas requirement may have been pre-calculated and written by the block-building node to the associated object (token type, account, transaction) at the time that the auth filter was first configured and verified (both performed by the block-building node when the configuring transaction is first accepted). Different elements of the auth filter carry a different gas cost. This auth filter gas requirement may be discovered and added to the minimum gas requirement of the particular record. When it executes, each auth filter may consume exactly as much gas as was pre-determined when the auth filter was configured. The minimum gas requirement of atomic records (which encapsulate atomic record chains) may be statically validated by first recursively iterating over the elements of the ARC to determine the minimum gas requirement of each. Then, the aggregate of these values should be added to whatever other gas requirement accrues to the transaction itself, so as to calculate a single, statically determinable minimum gas cost for the atomic record.

In an embodiment, the console functions may exist that allow records and transactions to be instantiated, and then for the aggregate minimum gas requirement to be calculated for these record and transaction arrangements. It should be possible to author automated tests using the console, and with the web service API, in order to verify this functionality, by querying what the minimum gas price may be for a given record or transaction (including atomic records and atomic transactions). Besides the above gas validation, as a high-level general rule no other validation should be performed on the content of the transaction. That being said, this prohibition may be a convention followed by the implementation of each individual application and record type validation function. This prohibition may not be explicitly enforced system-wide. If an existing application or record type validation function were to attempt to do a validation on other elements of the transaction, the system may permit this code to execute. In practice, the end result is that individual applications may be individually implemented in such a way that no other validations are performed. However, if it is called for by the specific circumstances of a given application, additional validation may be performed. In the event that a record has passed gas-validation, it is possible that a transaction may still fail initial validation. For instance, a transfer record may be valid because it has sufficient gas, but it may fail if the source account does not have sufficient funds to transfer the full amount. Such transactions may not be added to the blockchain.

In an embodiment, It is necessary to permit this kind of behavior because of the ambiguity of atomic records. Within an atomic record chain a transfer-to-EOA record may be included after an SC invocation that may add funds to an otherwise-empty EOA account. If the transfer-to-EOA record were evaluated statically based on the state of the account before the execution of the ARC, then it may be rejected. Every transaction may have different gas requirements based on the transaction type. This minimum requirement may be calculated without any dependency on state. (Simplifies both client and block-building node implementations). For e.g in case of contract creation or proposition this requirement is different based on payload where storage costs are also present but they may be state to calculate but gas cost may be calculated deterministically based on only transaction contents. In other words minimum gas requirement may be static or dynamic but may be easily calculatable from the contents within.

In an embodiment, any transaction that has gas specified lower than minimum is invalid and may never be made into any block. A transaction sender should be able to pay any gas specified. A transaction that has gas specified greater than sender funds is invalid. A transaction that has gas specified greater than the minimum gas requirement and having sufficient funds to pay for may always be accepted into any block, it is up to the client implementations or block-building node implementations to do any validations beyond this, but blocks containing such transactions may be valid (of course only if they perform valid state transitions as described in the protocol).

In an embodiment however such functionality may only be known at the block-building node because it may state. For estimation a simple binary search is used to estimate the gas may be for getting a transaction to be processed. In general only the user has the permission to modify the state that invalidates transactions (like reducing funds etc) that were valid. Some smart executions are not estimable, like pattern linkage where the use case is simply executed until depleting all the gas or expiry. Users may be able to specify gas budget using different heuristics. On block-building node gas estimation API may be implemented for this estimation. Note that this functionality is only usable to the users that are maying to run full nodes or using a web service offering such API. because the transaction at this step is unsigned.

In an embodiment, an AMM pool primitive at the L1 layer is available to smart contract. AMM pools are a common occurrence in blockchain ecosystems. Typically, AMM pools are built entirely using smart contracts; this creates a limitation whereby the information represented by AMM pools may not be used by the underlying L1 protocol. The underlying LI protocol may not know what is happening inside the AMM without somehow peeking inside the smart contract. There are a number of useful data elements within an AMM that are potentially useful at the L1 layer. Specifically these are the current exchange rate between tokens, the value of locked tokens and the volume of tokens swapped.

In an embodiment, there are two possible ways to implement such an L1 primitive. The AMM smart contract may register itself as an AMM, complying with a pre-defined API that provides access to the desired information. The AMM smart contract may instantiate L1 AMM pool objects, which low-level pool objects encapsulate and provide access to the desired information. The benefit of the first option is flexibility of implementation, but there is a risk that the implementer of the smart contract might return false or misleading information via the API, undermining its purpose.

In an embodiment, each smart contract may be able to instantiate a single pool for its own use. The pool data may be stored as part of the smart contract data in the account trie. Each pool may be a (non-mandatory) feature of the smart contract it is associated with. The pool object may only be possible to instantiate via a smart contract EXT function. Each pool may be instantiated with a specific configuration. The configuration may include the spread (i.e profit margin) that accrues to the smart contract, as well as the AMM curve shape. In addition, at instantiation, the smart contract may provide the initial liquidity at a ratio specified in the initial configuration (via tokens held by the smart contract itself). Adding and removing liquidity to the pool may be accomplished by a smart contract EXT function, only from within the smart contract that encapsulates the pool object. When locking additional liquidity, “maximum” values of each token contributed are specified in the smart contract EXT function—the amount moved out of the smart contract's token ledger is determined by keeping the current exchange rate(s) constant, and taking no more than the maximum of any token.

In an embodiment, token swaps may happen by users interacting directly with the pool data structure, outside the control of the smart contract that instantiated the pool. The instantiating smart contract may not be able to control or limit the participation of users that might want to perform swaps using the pool. That being said, the individual tokens may use auth filters or auth subroutines to limit the functionality of those tokens vis-a-vis swaps of this kind. Pre-defined curve types may be available to the pool at instantiation (as a pre-defined list of curve types), with each curve type having a slightly different behavior when determining price. Margin may automatically accrue to the smart contract that instantiated the pool, recorded as a margin ledger that is recorded together with the pool data. An indexing data structure may be formed which keeps track of all pool objects, the contents and status of the pool objects, and which smart contracts they belong to. This indexing data structure may be used in responding to data queries pertaining to the data embodied within these pools.

In an embodiment, users may define Multi-stage data in propositions. There should be some way for the data available in a proposition annotation to evolve as the state of the thing in the real world changes over time. For instance, as election returns roll in, the number of votes that each side holds changes over time, until in the final event the final number is decided. Similarly, in a sporting event, the score earned by each side changes as the event proceeds, until the final score is reported. This progress may be time based, or there may be arbitrary stages defined by the operation of the event. The big question to answer, however, is how this data may and should be consumed. It may make sense to see what APIs look like within existing DeFi oracles, so as to ensure that similar capabilities exist within our system, even though the actual implementation may be dramatically different.

In an embodiment, user defines implementing bitwise record type verification in auth filters. If the record type is represented as an int 16, each bit may represent a different record type, up to 15 separate record types, plus a null value to be used for unpopulated fields. It may be more efficient within auth filters to confirm that a record is one The reason this matters is that in cases where auth filters may be to evaluate more than one transaction type, at least one sub-expression within the filter may be of this form. Every single auth filter defined may contain a membership test like this. For instance: (transaction.type==TRANSFER && transaction.transfer.amount <200) | (transaction.type & (TRADE_ORDER | PROPOSITION))

In an embodiment, the final membership test is necessary in the above example because otherwise permission may be denied for any other types that are not transferred. Note that static typing in auth filters may be accomplished by defining a separate field on transaction for each record type. The field may only be populated if the transaction contains the record of that type. If more than 15 record types may be implemented (or even if we get somewhat close to that number), then the record type may be implemented as a larger int, which may reduce the overall system-wide efficiency of this approach. It may be necessary to count all of the possible records contemplated which are subject to auth filter evaluation: atomic record, device setup/config, genesis/config, mint (merge with transfer), stake, redeem, transfer, standalone invocation (includes SC creation, merge with transfer), proposition definition, proposition decision, trade order, settlement, balance locking.

In an embodiment, the user defines Delayed execution smart contracts. A payload option may be specified as part of a proposition definition record; the payload may be executed when the proposition is ultimately decided. Most importantly for this ticket, it should also be possible to specify an “execution block” with a standalone smart contract invocation. If no execution block is specified, then the invocation may be executed immediately. However, if an execution block is specified, then the payload may be evaluated as a delayed execution smart contract invocation, much like a proposition determination payload. The gas utilization of such delayed-execution smart contracts has been discussed elsewhere in other tickets related to refunds, which tickets should also be consulted prior to implementation of this ticket. To summarize the gas requirement may be purchased at the time that the original transaction is added to the block chain. The gas price for future execution may be the price paid for the record itself that contains the future execution payload. In other words, the gas price of the SC executed in the future may be the gas price of the past, because the gas is paid for in the past, not in the future block. Unlike immediate-execution payloads, delayed execution invocations may consume the entire gas budget specified, even if the smart contract execution does not consume the entire budget.

In an embodiment, there may be an upper limit or “cap” in terms of gas that may be pre-purchased with regards to each future block. After that cap is reached, any attempt to pre-purchase execution may be invalid. In addition to the above, a gas-cost algorithm should be devised to augment pricing of delayed-execution payloads. The base gas pricing may be the gas price of the original record. The gas price should increase as a function of how far in the future the future block actually is the future execution is at block X+10, that may cost less than a future execution at block X+100, all else being equal, even if both delayed execution payloads are scheduled within block X. The gas price should also increase as a function of how close to the cap the target block happens to be. So, if the execution is at a block that has already been filled to 50%, that may be more expensive than a block that has already been filled to 10%. A side effect of this policy may be that a delayed-execution payload with a gas budget of 100 may have a higher gas price than a delayed-execution payload with a gas budget of 20, all else being equal (block number, originating transaction gas price, etc.)

In an embodiment, most likely, the rate of increase of cost while approaching the cap should be exponential in some way, so that actually reaching the cap is impractical, or even impossible for all intents and purposes. Similarly, it should be impractical or even impossible to schedule delayed execution blocks too far in the future. Again, the curve of the function should attempt to enforce this limitation. On a practical basis, this price-increase function described above may output a coefficient that may be applied to the gas cost of each item that executes within the smart contract that is invoked (or the total gas cost in the aggregate). In other words, the gas cost of the smart contract goes up as a multiple of the function output. Either that, or perhaps better, the gas amount purchased may be divided by the coefficient immediately before the smart contract is executed.

In at least one embodiment, authentication filters (“Auth Filters”) may be parsed and statically analyzed upon the configuration of a token type. Each operator within such filters shall be subject to analysis in order to determine the specific cost of execution for each individual element. A gas price shall be assigned to each operation, and such gas prices shall be aggregated as applicable. The gas price corresponding to each operation governed by an Auth Filter (including, but not limited to, operations such as transfer, trade, etc.) shall be recorded within the configuration. This recorded gas price may subsequently be utilized to determine the appropriate gas price required to execute the respective action, either by processing the record or by executing the corresponding EXT function. Such gas costs may be predetermined, thereby enabling the static determination of gas utilization in advance, which in turn facilitates the validation of gas utilization. It is expressly understood that this method shall not supersede or replace any costs that may arise from the utilization of an authentication subroutine, the gas cost of which may be dynamically computed at runtime in a manner consistent with the execution of any smart contract. Gas prices shall be determined based on empirical measurement of the time each operation takes under real-world conditions, and such gas price shall represent an approximation of the actual cost of executing the operation.

In at least one embodiment, it is acknowledged that different signatures for the data ( ) function may incur differing gas costs. The data ( ) and test ( ) functions are anticipated to be among the most computationally expensive functions within the Auth Filter language. Since Auth Filters are evaluated during static validation, the computational complexity of these functions may be constrained. One approach to limiting such complexity includes imposing restrictions on the size of propositions or annotations upon which these functions may operate. Furthermore, for propositions subject to external voting, it may be prudent to restrict invocation of the data ( ) function until after the proposition has been finalized.

In at least one embodiment, the gas cost for these functions shall be calibrated to account for the maximum computational cost of executing such functions under worst-case scenarios. While the specific usage of these functions may not be controllable, the conditions under which they are used may be regulated. This may be accomplished through the imposition of limits, including but not limited to size and complexity restrictions, on the data (e.g., propositions) upon which these functions operate. At the time of gas-cost evaluation, it shall be feasible to distinguish between various input-value use cases, thereby enabling the assignment of differentiated gas costs for the evaluation of each case.

In at least one embodiment, Smart Contracts may be able to contribute to their own gas budget. If a smart contract is executing, the caller of the smart contract may be to pay for the gas. However, in the case of SC execution that is invoked on a delayed basis, the caller may not know the full cost of execution at the time that the invocation record is created. For instance in the case of a pattern matching record, or in the case of a payload attached to the outcome of a proposition determination process, the state of the smart contract may have changed substantially by the time that it has executed. If a smart contract is programmed to contribute some portion of its own tokens (fuel or user tokens) to the pool available to pay for gas, the gas budget may be augmented after-the-fact in the case of delayed execution.

In at least one embodiment, users may be used to allow some smart contracts to subsidize the cost of their own execution in situations where gas prices are too high for normal users. It is not useful only for delayed execution smart contracts. The execution of this gas contribution may happen via an invocation to the smart contract EXT function: EXT.addGas (<quantity>, <optional token type>, <optional exchange rate>, <strict execution>)

In at least one embodiment, the operation may give the EVM the ability to exceed the gas budget specified in the smart contract execution record. The smart contract execution record specifies the gas budget as the maximum amount of gas that the smart contract may consume, and contributes to the minimum amount of gas that the transaction sender may have available in its gas pool at the beginning of the execution of the transaction. EXT.addGas ( ) in a smart contract may allow the smart contract to continue executing after the gas budget has been reached, by expanding the gas budget available.

In at least one embodiment, some kind of annotations may be added to the state with regards invocations to EXT.addGas ( ) in a smart contract, to preserve information that may be used when re-applying the smart contract's gas utilization. When revert is invoked, it also knows how much gas has been consumed so far. From this value, it should be possible to know how much the gas has been consumed “over the limit”. If any gas was consumed over the limit, then that shows that EXT.addGas ( ) in a smart contract has been utilized to keep the contract going past the limit. After the state has been reverted, how much gas has been spent over the limit. This information may be used to re-apply the modification to the state required to consume the gas of the smart contract. In other words, if the initial EXT.addGas ( ) in a smart contract modification to the SC token ledger is reversed, then the modification may potentially be re-applied after the reversion. The most complication may come from nested invocations. It may be appropriate to limit the gas contribution to only the function that is being invoked when the gas contribution is made; after the function returns, the gas contribution may not carry forward after the function returns. The state of the smart contract's token ledger may not be finally updated until the function actually returns, so the call opcode may probably also, may be modified.

In at least one embodiment, trade orders have two flavors: permanent orders, and ephemeral orders. Ephemeral orders reside in the transaction pool until they expire as records (i.e. until the transaction/record expiration is surpassed, and they are removed from the pool) or until they are matched by the block-building node or other matchmaker against permanent orders, or against other ephemeral orders, subject to various rules Permanent trade orders may (perm orders) carry an explicit expiration block number, separate and apart from the mempool expiration field of the transactions or records that encapsulate each payment order. After a perm order expires, it is removed from the global state, and the offered tokens are returned to the token ledger of the selling account. There is a maximum time-to-live for all perm orders (i.e. a maximum expiration date that each perm order may carry); the expiration date may not be null. This max time-to-live (TTL) should be specified as a system-wide constant in the same constant file as the system gas prices.

In at least one embodiment, when an outstanding permanent trade order is matched, the remaining amount outstanding of the order is updated along with the balances of the accounts involved. Once the remaining amount outstanding reaches zero, the outstanding trade order is deleted. Also, once a permanent trade order expires, it is removed from the account data. A maximum number of slots within the whole system are available for permanent trade orders to fill. A single slot represents the existence of an open, non-expired perm order at the time of a block. Every time a perm order is accepted to the blockchain, a certain number of slots may be allocated to that perm order, equal to the total number of blocks until that order expires. If an insufficient number of slots is available at the time that a perm order is being evaluated for inclusion, then the perm order may be treated as temporarily invalid, and added to the retry queue, to be retried after N blocks, at which point the if the number of available slots has sufficiently increased, it may be accepted. Slots are freed up in several ways. Every block, the number of available slots is increased by the count of open trade orders at that block. The most recent block has passed, so the slots may be reallocated to the future. For all trades that are fully matched and exhausted, a number of slots that may have been reserved until expiration are returned to the pool, and are available again for utilization. For all trades that are modified to reduce the TTL, those slots that may have been used until the prior-specified expiration are reclaimed. Expiring trades do not free up slots, because naturally-expiring trades' slots are already reclaimed as part of #1 above.

In at least one embodiment, the price to add a perm order to the blockchain should somehow be a function of the number of slots that are used by that perm order. There are two ways to implement this. In a natural auction, users that are bidding the highest price-per-slot are included first in the blockchain. Participants may choose to bid anything they want, and may be included as per determination by the block-building node. This is preferred because it is consistent with what is described in the original specification]. Potentially, the actual price paid may be determined in a sort of Dutch auction. Using an algebraic price function that outputs a coefficient, which coefficient is multiplied against a standardized baseline gas price per slot, and where the coefficient increases towards infinity as the number of slots available approaches zero (and where the coefficient is one (1) when zero slots are currently occupied). The gas price that may be paid by a perm order may equal the output of this function.

In at least one embodiment, one of these two approaches may be selected. First one is the slot fees for any given perm order should accrue to the block reward of each block during which that order remains open (i.e. not expired). The block reward of the first block in which the perm order is added to the blockchain may only include fees for a single slot within that order's lifetime (alternately, it may include 2 times or some other amount times the slot fees for the first block, in order to incentivize inclusion, with future fees reduced proportionally). In order to make this calculation more efficient and effective: . A total pool (int value) of slot fees are be maintained, and the slot fees for all currently-open perm orders should be added to that pool when the perm orders are first accepted to the blockchain. A current “block-slot-fees” value are also maintained, which represents the slot fees that are taken from the total slot fee pool and added to the block reward each block.

In at least one embodiment, every time a new perm order is added to the chain, the total pool and the block-slot-fees values are updated; the total pool is incremented by the total value of all slot fees to be paid over the lifetime of the perm order, while the block-slot-fees value is incremented by the per-slot fee specified by that perm order. Every time a perm order is matched, or when it reduces its expiration time, some portion of the total pool is rebated to the perm order, and the block-slot-fees value is reduced appropriately. If a perm order is fully matched and deleted prior to its expiration, or if it is modified to shorten its expiration, then a rebate are given for the fees paid. The rebate should be a function of the number of slots being released and the price paid for the allocation of new slots to new trade orders within that same rebate block. Each slot being reclaimed should result in a rebate equal to 50% of the price paid for new perm order slots within the rebate block. The rebate amount offset the total fees earned by the block reward at each block corresponding to the reclaimed and rebated slots. However, the 50% portion of the fees not rebated should nonetheless accrue to the block reward that may have been paid had the perm order not been removed.

### Trade Order

In at least one embodiment, any modification that extends the expiration of a trade order may be paid for, and may be subject to the same slot auction that exists for new perm orders within any block. The price paid for new perm orders and for increased-duration perm order modifications should be specified within the block that the new perm order is added (or within the same block that an existing perm order is extended). The slot reward added to the block reward may effectively be constant for each individual perm order, and may not fluctuate after it is first set even if slot reward pricing fluctuates generally. That being said, if the life of a perm order is extended by modification, then it is likely that the slots consumed by the extension may be priced differently than slots consumed before the extension, and care may be taken to price them accordingly. A perm order that is accepted to the blockchain may not be matched against another perm order that has already been added to the blockchain. However, a perm order may indicate via its type field that it is able to also be treated as if it were an ephemeral trade order. In such an event, a perm order may be matched against an existing open perm order, if the pricing spread permits it. Perm orders of the “permanent only” type may only be matched after they are accepted to the blockchain and the EOA account data has been updated.

In at least one embodiment, a permanent trade order may be updated to modify its expiration date, token amount or price at any time, but if the open perm order is otherwise modified (ex., because of a settlement match) in such a way as to invalidate the update record, then the update may not be executed and the perm order may remain unmodified. An open perm order may be modified (and not removed) by a match because partial matches are allowed. A partial match by its natural operation may reduce the number of tokens offered for sale within an outstanding trader order preserved within an EOA account. Trade orders sell a token held by the seller, in exchange for another token type. A trade order that sells token A in exchange for token B may match against a trade order that sells token B in exchange for token A. Permanent trade orders may only be “limit orders”, explicitly specifying a quantity and price. They may be matched against ephemeral limit orders and ephemeral market orders. Limit order matches are valid if the spread is zero or greater. Market order matches are only valid if the price of the perm order equals the lowest price on offer for sale. In other words, a market order (unpriced order) may be matched against any perm trade order that sells at the same price as the lowest-priced perm trade order on sale for that pair. While perm orders have to be prioritized by price, the specific order of execution of trade orders all having the same price doesn't matter, and may be decided randomly by the block-building node.

In at least one embodiment, in addition to being stored within the seller wallet accounts, outstanding perm trade orders may be indexed by two values: the sale price, and the expiration date. When one node first comes online, and fast-syncs with the other node, the account tree may be traversed in order to discover the orders outstanding within the state tree at the time. The price-prioritization queue (heap) and the expiration-prioritization queue (heap) may be built from scratch. Thereafter, the two heaps should be updated as the global state is modified when new records are added to the chain. These indexes should probably be cached locally to disk in order to avoid may being to rebuild them when a block-building node reboots; however, the indexes may NOT be part of the global state, and modifications to these indexes should NOT have any impact on the global state hash (i.e. the account trie hash). Different block-building nodes may have different implementations of these indexes, and that should not have any impact on block validation. The only requirement is that the block-building node index implementations may prioritize and sort perm orders identically, so that validation that depends on various changes (price matching, expiration) agree across different block-building nodes.

In at least one embodiment, a settlement order may be required to match a permanent order with another permanent order. Note that a permanent order that is still in the mempool may be taken off the mempool and processed as part of a settlement record, but only if that sale order may be fully matched by sales orders already sitting on the other side in the permanent order book, or if the sale order exactly matches the other trade order(s) on the other side of the trade. Every settlement order may consume the entire value of all of the trades it references, unless it is referencing sale order(s) already on the order book (in which case partial matches are permitted). As noted elsewhere, a settlement order may only be used to match a market purchase order (i.e. unpriced purchase order, or purchase order with only a “worst price” specified, rather than a fixed price) if the other side of the trade has a better price than the best price on the permanent order book. If the order book is empty (and no comparison may be made), then the market purchase order may not be matched at all. When the original sale order was placed, it was contributing a fixed block reward/block slot fee, let's say 1000 per block until its original expiration, let's say block 29. Now at (current) block 20, an update was made to shorten the expiration and set it to block 25. The new block pricing (as per slots availability in the system) is at 1200 per block at the current block (i.e. at block 20). Once a sale-order is expired, it is removed from the state-trie and there is no way to track the changes to the block-slot-fees contribution after that. As per my understanding this implies that the rebate may simply be as per the price originally paid (and not based out of the current slot pricing) for the slots being freed up and a full refund (and not 50%) may be processed for all the freed up slots at once in the current block at which the update is made.

In at least one embodiment, a block-building node may want to build a block that is maximally profitable for the block-building node. Fuel that is withheld from the block reward because that fuel may be rebated (either as part of a storage or as part of the order book) is not fuel that contributes to the initial block-building node's profits. The initial block-building node may have an incentive to discount the refundable portion of the gas price from the ranking within the mempool. In other words, if the rebate-able fuel is paying for gas that does not contribute to block-building node profits, then the inclusion of rebate-able fuel in a block may negatively affect the block-building node's profits, and block-building nodes may tend to drop or exclude such transactions, even if an example implementation does not do so. LIFO means “Last in First Out”. For instance, this may be extended through a record that modifies the expiration setting—but such a transaction may be to pay for the additional slots that the order may now consume.

In at least one embodiment, because a single trade order might exist on the chain for a duration where the duration is partially paid for by multiple separate transactions, then we have to think about which fuel is used to pay the block-building node, and which fuel is rebate-able. The fuel that is used to pay the block-building node should be consumed on a FIFO basis, and the fuel that is rebate-able if the time-to-expiration is shorted should be consumed on a LIFO basis.

In at least one embodiment, The sale order record has a field FeeReserve (“the aggregate fee in native tokens that are segregated and available to be contributed as block slot fees”). Users may believe that this FeeReserve was the portion that gets deducted from the TxFee and was available to be paid as block reward till the lifetime of the sale order i.e. until the sale order is matched/expired/removed. The actual slot fee depends on the current slot pricing and the number of slots the sale order wants to occupy. The remaining portion i.e. TxFee-FeeReserve may be the initial block-building node's reward for adding the sale-order to the order-book. And the portion of the FeeReserve not consumed (i.e. not added to the slot fee pool) may be refunded to the author immediately. The initial block-building node may have an incentive to discount the refundable portion of the gas price from the ranking within the mempool. For instance, it may be extended through a record that modifies the expiration setting—but such a transaction may be to pay for the additional slots that the order may now consume.

In at least one embodiment, users may purchase additional slots (in case of an extension) starting from a future block point (i.e. after the original expiration) at the current slot price simply because we may not predict the slot price at a future block.

In at least one embodiment, there are two primary methods for implementing trade order matching: deterministic and block-building node-controlled. The deterministic method is generally simpler and may not necessitate the creation or maintenance of settlement records. The block-building node-controlled method, by contrast, may be implemented in various ways by different block-building nodes, each of whom may adopt distinct strategies aimed at optimizing their returns. It is conceivable that both methods may be implemented sequentially, with the deterministic approach employed initially, followed by the adoption of the block-building node-controlled method thereafter.

In at least one embodiment, the system records as follows: Purchase Record wrapped in some kind of constituent record container. Sale Record wrapped also in some kind of constant record container. The container may specify how much of the sale we are using—the remaining unused amount may be added to the order book during the settlement record processing. Settlement constituent record representing a Pob Reference and settlement Record, which (among other things) contains a list of the above constituent records. Users may define a “position table” that records the current token position of the arbitrageur (i.e. the signer of the settlement record). The position table may initially be populated with zero values for every token, or it may not contain any balance for any token, and may be empty; it may NOT reflect the actual current token ledger of the arbitrageur account. The position table may record a negative or positive position for each token type. This keeps track of what surplus or deficit is being created as we process the settlement record. Only at the end of the process may the position table be reconciled against the signer/arbitrageur's token ledger. After this user iterates over the constituent records. They may be processed in the order specified in the settlement record's constituent record array. For record in settlement.constituent_records: switch record:
a) case record.type==POB_REFERENCE:
b) process_pob_reference (record, position_table)
c) case record.type==PURCHASE:
d) process_purchase (record, position_table)
c) case record.type==SALE:
f) process_sale (record, position_table)

In some embodiments, each type of record is processed a bit differently: Processing a Job reference may perform a transaction matching the order book against the position table. If the position table doesn't already have a positive balance in a token, or if the trade may bring a token balance into negative (for the token being “purchased” by the order book, or “sold” by the arbitrageur), then the balance of the token may go negative. One token amount may go up, one token amount may go down on the position table. The order book may be modified as any purchase order may be processed against it. Processing a purchase order may perform an all-or-nothing operation against the position table in much the same way that the job reference may. The purchase order may be traded against the position table, decreasing one token (potentially putting that tokens in negative), and increasing another token. A partial match may not be allowed. Processing a sale order may perform a transaction in the amount specified in the container. As with the other records, the trade may be performed against the position table, and may result in a negative value for one of the tokens (i.e. for the token being sold by the arbitrageur, or purchased by the sale record). After the position table is updated, the remaining amount of the sale order may be updated on the order book.

In some embodiments, after all the transactions are processed, the position table may have positive values for some tokens, and it may have negative values for some tokens. These values may then be offset against the arbitrageur (i.e., against the token ledger of the wallet account or subcontract executing the settlement transaction—as an aside, note that a smart contract EXT function should be defined to perform the same activity as the transaction, which may require the smart contract accepting some whole transactions in RLP format as function inputs). If there is insufficient balance for a token on the token ledger of the signer wallet account or of the smart contract, then the operation should fail. The nature of this failure is important, however—the failure should be detected in conditional validation, and if the retry quantity is exhausted, the transaction should be added to the blockchain in a manner that consumes the gas of the settlement record, but not of the constituent records. It should also permit the constituent records to be separately executed, as applicable-meaning, the nonces of the constituent records should not be updated in the event of a failure of the settlement record that contains them. If there is sufficient balance on the part of the arbitrageur, then the evaluation of the record may continue. The balances in the position table may be used to update the arbitrageur's token ledger-negative balances in the position table may decrease balances in the token ledger, and positive balances may increase balances.

In some embodiments, some of the additional validation is required. Auth filter validation, specifically. A negative balance in the position table may function as a trade selling that token on behalf of the arbitrageur, and a positive balance in the position table may function as a trade purchasing that token on behalf of the arbitrageur. The appropriate auth filters may be evaluated for wallet, tokens, and possibly atomic transaction. Note that the constituent records may be to also be evaluated against auth filters, but only for the signers of those constituent purchase and sale records, in the same way that they may be evaluated if they were actually processed in the standard way. There is no reason to involve the arbitrageur wallet in evaluating those constituent trade orders; the signing wallet of the settlement record may only be evaluated against the position table, which may operate as a collection of trades performed by the signer/arbitrageur. Some tokens may be used in the intermediary steps of the settlement record, which the arbitrageur is not authorized to use-because the arbitrageur never takes possession of those tokens, no auth filter may be applied.

In some embodiments, the constituent element in the Settlement Record array which bids tokens held by the sender of the Settlement Record (sourced from the sender's token ledger). The price used should be the price specified by the sender. This is currently named ArbPurchase. There should be a constituent element in the Settlement Record which draws from the order book (for example bids something from the order book, and asks for something from the settlement record ledger, or vice-versa)-currently named POBReference. Both of these are not transactions and are not standalone records. If they were standalone records, they may be removed from a settlement record in the mempool and re-wrapped by an attacker, and executed separately and individually, which is not desired behaviour. A purchase record added to the settlement record array may NOT be matched against the order book. It may only operate on the settlement record ledger. If it is priced, the exact price may be used. If it is not priced (if only bid amount or ask amount specified), then the order book price is used.

In some embodiments, a blockchain system may configure a sign-in option for to web service. An authorized “hosted” account (or any account, if “require api signatures” is false) may also be able to transmit transactions signed by other parties. However, a second block-building node setting, “accept third party transactions”, if false, may cause the block-building node to only accept transactions signed by “hosted” accounts via the web service API. In other words, if “accept third party transactions” is true, then the “forward signed third-party transactions” functionality may be enabled to accept transactions signed by any third party, but if it is false, only transactions signed by accounts on the list may be accepted by this API. Unlike centralized server systems, key rotation is not synchronous, that is current network request may not rotate the key immediately like OAuth or JWT. So, the new keys may not be usable until such rotation is registered into global state. There may be a few cases of reorg where a new key may suddenly become invalid because a transaction became pending. So new keys may be used carefully for signing network requests. Any protected network APIs won't function if the block-building node is out of sync.

In some embodiments, during the initial sync (first ever) when the state is not available. Network requests that require authentication may directly get rejected as there is no public key available to lookup. This shall be handled within the logic of the authentication system described herein. The purpose of this authentication system should have no impact on the security of the blockchain, because the blockchain is secured by the signed RLP-encoded records. The purpose of the authentication system is just to control the computational load on public blockchain block-building node instances. This is why it should be configurable, and why there should be a number of special cases with regards to implementation. For instance, the restrictions should not be imposed on the endpoints which relate to retrieving block headers (at least in most cases), because systems want clients to be able to pull from a variety of public block-building nodes in order to have various confirming sources for the block header data. This may allow a variation of the light client protocol to be implemented on top of HTTP. If there are some corner cases where the system may be more permissive in order to allow transactions to pass through because otherwise the system may be in a kind of deadlock, then that may be appropriate. Accounts are created before they open up their firewall to expose that block-building node.

In at least one embodiment, it may be feasible for third-party systems to authenticate a specific blockchain web token (used for authenticating requests directed to the issuer server and to the block-building node) via an API published by the block-building node. Such an API may potentially serve as a shortcut, thereby obviating client systems to independently perform the complete parsing, key verification, and account confirmation procedures. These processes, in the absence of the API, may necessitate separate requests to the block-building node.

### HTTP Authentications

In at least one embodiment, an approach to authenticating web service requests is described, wherein the request is signed in the HTTP header as a token. The issue with the current implementation lies in its dependence on the presence of a body in the request. While relying solely on the HTTP body may be sufficient for JSON-RPC requests, it is not applicable for all protocols. Certain types of HTTP requests, such as most GET requests, do not include a body, which introduces limitations. The underlying issue is that more elements of the HTTP message may be included in the pre-image that is hashed and subsequently signed. The challenge arises in determining which additional elements should be incorporated into the hash pre-image and establishing a canonical representation of the HTTP message that may be consistently reconstructed across various application development environments. It is noteworthy that web frameworks, such as Django and similar platforms, typically do not provide the raw HTTP request directly to the application. Instead, these frameworks decode the message and instantiate an HTTP Request object or other platform-specific representations of the message. While all fields of the HTTP message should be accessible, the method and location at which they are accessible may differ across platforms. Furthermore, certain non-standard fields may be suppressed, modified, or even added to the request object, affecting the structure and representation of the HTTP message as received by the application.

In other embodiments, for instance, if the sender sends a request as part of a REST protocol, where that request is sent matters very much (the endpoint), but so does the verb. If a request includes only the body and the endpoint in the hash pre-image, but leaves out the verb, then conceivably an attacker may intercept the message and replace GET for DELETE, for instance, without that modification being detected. System may do the following:
a) Review all of the HTTP fields and decide which fields may be included in the protocol
b) Decide on a new Canonical format of the HTTP request object so that it may be hashed and signed consistently by every system that uses this authentication protocol.

In another embodiment, the issue arises from the fact that users may sign each message consistently with the currently-active keypair associated with the account on the blockchain. This approach is straightforward and simple to implement. Additionally, as the private key is typically stored within a secure enclave by the client, the secret used to generate the token is inherently more secure than any temporary token that may be created and subsequently renewed. The secure enclave provides a high level of security, which reduces the additional complexity. Users may utilize this feature for finalization and implementation as soon as possible.

In certain embodiments, the system recognizes and supports the following signature algorithms for use within its framework: ED25519, SECP256K1, DiLithium2, BLS. These signature algorithms are available for implementation in accordance with relevant cryptographic standards and protocols, as applicable. The use of these algorithms within the system is subject to compliance with the requirements and specifications set forth by such standards.

### Description Terms And Language Are Non-Limiting

Any references herein to specific technologies, systems, or protocols are intended to provide context and are not to be construed as limiting. The invention is applicable to any environment or system that can achieve substantially the same results, whether or not such technologies or systems are specifically referenced in this document. Additionally, where specific embodiments are described in detail, the inventions are intended to extend to any other embodiments that fall within the same principles and claims.

The descriptions, terms, and embodiments provided in this specification are illustrative and are not intended to limit the scope of the invention. Any mention of specific examples, configurations, or implementations is provided solely for the purpose of enabling understanding of the invention and its potential applications. The scope of the invention is intended to encompass all equivalents, modifications, and adaptations that fall within the scope of the claims.

The terminology used in this specification is chosen to best describe the concepts and mechanisms of the invention and should not be interpreted as restrictive. Words and phrases such as “includes,” “comprises,” “such as,” “for example,” and “may” are intended to indicate non-limiting inclusion and should be construed to encompass additional elements, processes, or features that are not explicitly listed or described herein. Furthermore, any description of a specific component or functionality may encompass variations, alternatives, and equivalents that perform substantially the same function in substantially the same way.

Where methods or processes are described in a particular sequence of processes, it should be understood that such sequences are illustrative and not restrictive. Unless explicitly stated otherwise, the processes may be performed in any logical order, simultaneously, or with intervening processes that do not materially affect the purpose or outcome of the method or process. The invention is intended to encompass all variations and rearrangements of processes that achieve substantially the same results.

It should be noted that any figures referenced herein are provided merely by way of example, and should not be construed as limiting the present disclosure to the specific embodiment(s) illustrated therein. In particular, the depicted structures, components, and configurations may be adapted, modified, or substituted in numerous ways without departing from the scope and spirit of the invention as defined by the claims. The figures and their accompanying descriptions are intended to assist those skilled in the art in understanding certain illustrative implementations, but the inventive concepts, functionalities, and principles described herein may be embodied in other forms, arrangements, and variations that achieve similar results.

The use of specific examples, values, or ranges is intended solely to illustrate possible implementations of the invention and should not be interpreted as limiting the scope of the invention to these examples or ranges. In particular, the numerical ranges disclosed herein should be interpreted to include all sub-ranges and intermediate values therein unless specifically excluded. The invention encompasses variations and equivalents that fall within the broader conceptual framework described herein.

While example embodiments have been particularly shown and described, it will be understood by those skilled in the art that various changes in form and details may be made therein without departing from the scope of the embodiments encompassed by the appended claims.

Example embodiments are disclosed in U.S. Provisional Application No. 63/608,018, filed on Dec. 8, 2023, including Appendices 1-7, which are incorporated herein by reference in their entirety.

1. A computer-implemented method for accepting electronic payment, the system comprising:
executing a point-of-sale computer device, at least one authorization computer devices, and a consumer smartphone with at least one camera, and a processor and memory with computer code instructions stored thereon, the processor and the memory configured to cause the system to:
connect the point-of-sale computer device to a packet-switched computer network;
connect the at least one authorization computer devices to the packet-switched computer network;
connect the consumer smartphone to the packet-switched computer network;
configure the point-of-sale computer device with at least one graphical display;
configure the point-of-sale computer device to share a session identifier with the at least one of the one or more authorization computer devices;
display, on the point-of-sale consumer device graphical display, a graphical encoding of a payment request, wherein the graphical encoding of the payment request comprises an encoding of the session identifier;
capture, via the at least one camera of the consumer smart phone, an image of the graphical encoding of the payment request;
display, on the consumer smart phone, a user-acceptance message, wherein the message requests acceptance of the payment request by a user of the consumer smart phone;
indicate acceptance of the payment request via an indication of acceptance of the user of the consumer smart phone;
construct a data record configured to encode a payment instruction to conform to the payment request, wherein the data record encoding of the payment instruction encodes the session identifier; and
transmit the data record to at least one of the one or more authorization computer devices via the packet-switched computer network;
the at least one of the one or more authorization computer devices configured to perform a verification of the correctness and authenticity of the payment instruction encoded in the data record;
the point-of-sale computer device configured to receive, via the packet-switched computer network, a confirmation that the correctness and authenticity of the payment instruction encoded in the data record has been verified.

2. The computer-implemented method of claim 1, further comprising:
a cryptographic signature of the data record attached to the data record prior to transmission to the one or more authorization computer devices;
wherein the cryptographic signature is generated using an asymmetric cryptographic signature algorithm; and
wherein the cryptographic signature is generated using a private key corresponding to a public key stored in a data storage of at least one of the one or more authorization computer devices.

3. The computer-implemented method of claim 2, wherein the public key corresponds to a money balance stored in at least one of the one or more authorization computer devices; and wherein the verification of the correctness and authenticity of the payment instruction encoded in the data record comprises a verification that the cryptographic signature is valid and was generated with a private key corresponding to said public key.

4. The computer-implemented method of claim 2, wherein:
at least one of the one or more authorization computer devices is a blockchain validation computer device hosting a blockchain validation software program;
wherein the blockchain validation software program is configured to maintain a connection to one or more additional blockchain validator computer devices hosting one or more additional blockchain validation software programs;
wherein the blockchain validator computer devices are connected to the packet-switched computer network; and
wherein the data record is a blockchain data record, the acceptance of which by the blockchain configured to effectuate a change to a global state of the blockchain.

5. The computer-implemented method of claim 4, wherein the data storage comprises an encoding of the blockchain's global state, and wherein the data record is configured to encode a transformation to the blockchain's global state.

6. The computer implemented method of claim 1, wherein the point-of-sale computer device is configured to open a socket connection to at least one of the one or more authorization computer devices before displaying on the graphical display the graphical encoding of the payment request.

7. The computer-implemented method of claim 1, wherein the point-of-sale computer device, after displaying the graphical encoding of the payment request on the graphical display, is configured to poll at least one of the one or more authentication computer devices, sending in reference to the session ID.

8. The computer-implemented method of claim 1, wherein the point-of-sale computer device is configured as part of a cash-register system at a physical retail location.

9. The computer-implemented method of claim 1, wherein the point-of-sale computer device is a personal computer, the personal computer being configured to execute a web browser software, and wherein the graphical representation of the payment request is displayed in a graphical-user-interface window of the web browser software.

10. An electronic system comprising:
an interconnected network of a plurality of computers, each including a processor executing computer instructions stored in an electronic memory of each computer for implementing and maintaining a distributed electronic ledger system implemented as a backward-linked blockchain of multiple interconnected blockchain blocks;
a block-building node on said network of computers, wherein the processor of the block-building node executes peer-to-peer software to create blocks or blockchain segments to be added to the blockchain, the block-building node being associated with a first account on the blockchain, wherein the first account is configured to generate and sign a blockchain record.

11. The computer-implemented method of claim 10, wherein the blockchain system includes at least one of the following software system components: digital payment systems, user authentication systems, decision and coordination systems, digital security systems, and systems to store and trade value.

12. An electronic payment system, the system comprising:
a point-of-sale computer device, at least one authorization computer devices, and a consumer smartphone with at least one camera, and a processor and memory with computer code instructions stored thereon, the processor and the memory configured to cause the system to:
connect the point-of-sale computer device to a packet-switched computer network;
connect the at least one authorization computer devices to the packet-switched computer network;
connect the consumer smartphone to the packet-switched computer network;
configure the point-of-sale computer device with at least one graphical display;
configure the point-of-sale computer device to share a session identifier with the at least one of the one or more authorization computer devices;
display, on the point-of-sale consumer device graphical display, a graphical encoding of a payment request, wherein the graphical encoding of the payment request comprises an encoding of the session identifier;
capture, via the at least one camera of the consumer smart phone, an image of the graphical encoding of the payment request;
display, on the consumer smart phone, a user-acceptance message, wherein the message requests acceptance of the payment request by a user of the consumer smart phone;
indicate acceptance of the payment request via an indication of acceptance of the user of the consumer smart phone;
construct a data record configured to encode a payment instruction to conform to the payment request, wherein the data record encoding of the payment instruction encodes the session identifier; and
transmit the data record to at least one of the one or more authorization computer devices via the packet-switched computer network;
the at least one of the one or more authorization computer devices configured to perform a verification of the correctness and authenticity of the payment instruction encoded in the data record;
the point-of-sale computer device configured to receive, via the packet-switched computer network, a confirmation that the correctness and authenticity of the payment instruction encoded in the data record has been verified.

13. The electronic payment system of claim 12, further comprising:
a cryptographic signature of the data record attached to the data record prior to transmission to the one or more authorization computer devices;
wherein the cryptographic signature is generated using an asymmetric cryptographic signature algorithm; and
wherein the cryptographic signature is generated using a private key corresponding to a public key stored in a data storage of at least one of the one or more authorization computer devices.

14. The electronic payment system of claim 12, wherein the public key corresponds to a money balance stored in at least one of the one or more authorization computer devices; and wherein the verification of the correctness and authenticity of the payment instruction encoded in the data record comprises a verification that the cryptographic signature is valid and was generated with a private key corresponding to said public key.

15. The electronic payment system of claim 14, wherein:
at least one of the one or more authorization computer devices is a blockchain validation computer device hosting a blockchain validation software program;
wherein the blockchain validation software program is configured to maintain a connection to one or more additional blockchain validator computer devices hosting one or more additional blockchain validation software programs;
wherein the blockchain validator computer devices are connected to the packet-switched computer network; and
wherein the data record is a blockchain data record, the acceptance of which by the blockchain configured to effectuate a change to a global state of the blockchain.

16. The c electronic payment system of claim 15, wherein the data storage comprises an encoding of the blockchain's global state, and wherein the data record is configured to encode a transformation to the blockchain's global state.

17. The electronic payment system of claim 12, wherein the point-of-sale computer device is configured to open a socket connection to at least one of the one or more authorization computer devices before displaying on the graphical display the graphical encoding of the payment request.

18. The electronic payment system of claim 12, wherein the point-of-sale computer device, after displaying the graphical encoding of the payment request on the graphical display, is configured to poll at least one of the one or more authentication computer devices, sending in reference to the session ID.

19. The computer-implemented method of claim 1, wherein the point-of-sale computer device is configured as part of a cash-register system at a physical retail location.

20. The computer-implemented method of claim 1, wherein the point-of-sale computer device is a personal computer, the personal computer being configured to execute a web browser software, and wherein the graphical representation of the payment request is displayed in a graphical-user-interface window of the web browser software.
